(19) United States
(12) Patent Application Publication
(10) Pub. No.: US 2026/0045043 A1
(43) Pub. Date: Feb. 12, 2026

(54) DEVICES, METHODS, AND GRAPHICAL USER INTERFACES FOR DISPLAYING MOVEMENT OF VIRTUAL OBJECTS IN A COMMUNICATION SESSION

(71) Applicant: Apple Inc., Cupertino, CA (US)

(72) Inventors: Shih-Sang CHIU, San Francisco, CA (US); Jonathan PERRON, Felton, CA (US); Jordan A. CAZAMIAS, San Francisco, CA (US); Tong CHEN, Bellevue, WA (US); Jesse CHAND, San Francisco, CA (US); Wesley M. HOLDER, Union City, CA (US); Giancarlo YERKES, San Francisco, CA (US); Jason D. RICKWALD, Santa Cruz, CA (US); Rupert BURTON, San Francisco, CA (US); Lee S. BROUGHTON, Santa Cruz, CA (US); Stephen O. LEMAY, Palo Alto, CA (US); William A. SORRENTINO, III, Mill Valley, CA (US)

(21) Appl. No.: 18/733,740

(22) Filed: Jun. 4, 2024

Related U.S. Application Data
(60) Provisional application No. 63/506,119, filed on Jun. 4, 2023.
(60) Provisional application No. 63/506,115, filed on Jun. 4, 2023.
(60) Provisional application No. 63/515,122, filed on Jul. 23, 2023.
(60) Provisional application No. 63/578,962, filed on Aug. 25, 2023.

(51) Int. Cl. G06T 19/00; G06F 3/16; G06T 13/20; G06T 15/20

(52) U.S. Cl. CPC G06T 19/00; G06F 3/167; G06T 13/205; G06T 15/20; G06T 2219/024

(57) ABSTRACT

A computer system displays a representation of a user poses in a three-dimensional environment in response to movement of the current viewpoint of the user. The computer system displays different representations of movement of a virtual representation of a user based on the type of the virtual representation. The computer system reduces a visual prominence of virtual representations while changing a spatial arrangement of a virtual object shared in a communication session. The computer system displays different visual feedback while moving a virtual object in accordance with the virtual object being shared or not shared in a communication session. The computer system displays visual feedback indicating audio provided by another user. The computer system displays feedback indicating participants will correspond to positions. The computer system displays a visual transition sequence when displaying a visual representation of a participant in a communication session.

### CROSS-REFERENCE TO RELATED APPLICATIONS

This application claims the benefit of U.S. Provisional Application No. 63/578,962, filed Aug. 25, 2023, U.S. Provisional Application No. 63/515,122, filed Jul. 23, 2023, U.S. Provisional Application No. 63/506,119, filed Jun. 4, 2023, and U.S. Provisional Application No. 63/506,115, filed Jun. 4, 2023, the contents of which are hereby incorporated herein by references in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays a virtual representation of a user at one or more poses in a three-dimensional environment in response to movement of the current viewpoint of the user. In some embodiments, the computer system displays different representations of movement of a virtual representation of a user based on the virtual representation being a virtual representation of a first type or a virtual representation of a second type. In some embodiments, the computer system reduces a visual prominence of one or more virtual representations while changing a spatial arrangement of a virtual object shared in a communication session. In some embodiments, the computer system displays different visual feedback while moving a virtual object in accordance with the virtual object being shared or not shared in a communication session. In some embodiments, the computer system displays visual feedback corresponding to audio provided by another user.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7S illustrate example techniques for displaying movement of virtual representations of a user at different poses in response to movement of a current viewpoint of the user in accordance with some embodiments.

FIG. 8 is a flowchart illustrating an exemplary method of displaying a virtual representation of a user at one or more poses in a three-dimensional environment in response to movement of the current viewpoint of the user in accordance with some embodiments.

FIG. 9 is a flowchart illustrating an exemplary method of displaying different representations of movement of a virtual representation based on the virtual representation being a virtual representation of a first type or a virtual representation of a second type in accordance with some embodiments.

FIGS. 10A-10AA illustrate example techniques for changing the spatial arrangement of virtual objects in a three-dimensional environment in accordance with some embodiments.

FIG. 11 is a flowchart illustrating an exemplary method of reducing a visual prominence of one or more virtual representations while changing a spatial arrangement of a virtual object shared in a communication session in accordance with some embodiments.

FIG. 12 is a flowchart illustrating an exemplary method of displaying different visual feedback while moving a virtual object in accordance with the virtual object being shared or not shared in a communication session, in accordance with some embodiments.

FIGS. 13A-13F illustrate examples techniques for providing visual feedback indicating audio provided by a participant of a communication session in accordance with some embodiments.

FIG. 14 is a flowchart illustrating an exemplary method of displaying visual feedback indicating audio provided by a participant of a communication session in accordance with some embodiments.

FIGS. 15A-15M illustrate examples of a computer system providing feedback indicating spatial positions of communication session participants in accordance with some embodiments.

FIG. 16 is a flowchart illustrating an exemplary method of providing feedback indicating spatial positions of communication session participants in accordance with some embodiments.

FIGS. 17A-17I illustrates examples techniques for facilitating visual transitions of spatial representations of participants in a communication session in accordance with some embodiments.

FIG. 18 is a flowchart illustrating an exemplary method of displaying visual transitions of spatial representations of a participant of a communication session in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a first computer system associated with a first user, while in a communication session with a second computer system associated with a second user, displays a first virtual object representing a pose of a current viewpoint of the second user relative to a three-dimensional environment at a first pose representing a first viewpoint of the second user. In some embodiments, while displaying the first virtual object at the first pose in the three-dimensional environment, the first computer systems receives an indication from the second computer system corresponding to a pose of the current viewpoint of the second user relative to the three-dimensional environment. In some embodiments, in response to receiving the indication, and in accordance with a determination that movement of the current viewpoint of the second user from the first viewpoint to a second viewpoint satisfies one or more criteria, including a criterion that is satisfies when movement of the current viewpoint of the second suer exceeds a threshold relative to the three-dimensional environment, the first computer system displays the first virtual object at a second pose, different from the first pose, in the three-dimensional environment representing the second viewpoint of the second user. In some embodiments, in accordance with a determination that the movement of the current viewpoint of the second user does not satisfy the one or more criteria because the movement of the current viewpoint of the second user does not exceed the threshold relative to the three-dimensional environment, the first computer system maintains display of the first virtual object at the first pose in the three-dimensional environment.

In some embodiments, while in a communication session with a second computer system, a first computer system displays a virtual representation of a pose of a current viewpoint of a user of the second computer system relative to a three-dimensional environment at a first location in the three-dimensional environment. In some embodiments, while displaying the virtual representation at the first location, the first computer system receives an indication from the second computer system corresponding to a pose of the current viewpoint of the user relative to the three-dimensional environment. In some embodiments, in response to receiving the indication, in accordance with a determination that the virtual representation of the user of the second computer system is a virtual representation of a first type, displaying a first representation of movement of the virtual representation of the user corresponding to a change of the current viewpoint of the user from a first pose in the three-dimensional environment to a second pose in the three-dimensional environment. In some embodiments, in accordance with a determination that the virtual representation of the user is a virtual representation of a second type different from the first type, the first computer system displays a second representation, different from the first representation, of movement of the virtual representation of the user corresponding to the change of the current viewpoint of the user from the first pose in the three-dimensional environment to the second pose in the three-dimensional environment.

In some embodiments, while in a communication session with one or more computer systems, a first computer system displays a three-dimensional environment from a first viewpoint of a first user of the first computer system, wherein the three-dimensional environment includes one or more virtual objects including one or more virtual representation of one or more users of the one or more computer systems. In some embodiments, while displaying the three-dimensional environment from the first viewpoint of the first user, the first computer system receives a first input corresponding to a request to change a spatial arrangement of a first virtual object of the one or more virtual objects from a first spatial arrangement to a second spatial arrangement relative to the first viewpoint of the first user in the three-dimensional environment. In some embodiments, while receiving the first input, the first computer system reduces a visual prominence of the one or more virtual representations of the one or more users and changes the spatial arrangement of the first virtual object relative to the first viewpoint of the first user in accordance with the first input while the one or more virtual representations of the one or more users have the reduced visual prominence relative to the three-dimensional environment.

In some embodiments, while in a communication session with one or more computer systems, a first computer system displays a three-dimensional environment including a first virtual object. In some embodiments, while displaying the three-dimensional environment including the first virtual object at a first location relative to a first viewpoint of the first user of the first computer system, the first computer system detects a first input corresponding to a request to move the first virtual object from the first location to a second location, different from the first location, relative to the first viewpoint of the first user in the three-dimensional environment. In some embodiments, while detecting the first input, in accordance with a determination that the first virtual object is shared with the one or more computer systems in the communication session the first computer system displays first visual feedback in the three-dimensional environment while moving the first virtual object from the first location to the second location. In some embodiments, in accordance with a determination that the first virtual object is not shared with the one or more computer systems in the communication session, the first computer system displays second visual feedback, different from the first visual feedback, in the three-dimensional environment while moving the first virtual object from the first location to the second location.

In some embodiments, a computer system displays a visual representation of another user of another computer system while the computer systems are engaged in a communication session. In some embodiments, the computer system obtains information, such as from the other computer system. In some embodiments, in accordance with a determination that one or more criteria are satisfied, the computer system maintains display of the visual representation of the other user, and displays visual feedback corresponding to audio obtained from the other user. In some embodiments, the visual appearance of the visual feedback is changed in accordance with a spatial relationship between a current direction of attention of the other user and a current orientation of the visual representation of the other user. In some embodiments, the computer system moves the visual representation of the other user in accordance with information obtained from the other user.

In some embodiments, a computer system generates feedback indicating a position of visual representation of another user of another computer system while the computer systems are engaged in a communication session. In some embodiments, the computer system displays a simulated glow effect indicating the relative position of the other user, at times referred to herein as a participant of the communication session. In some embodiments, the computer system additionally or alternatively generates audio mimicking the effect of an physical audio source playing the audio, thus lending a spatial quality to the audio relative to the user's viewpoint of a three-dimensional environment. In some embodiments, the computer system plays one or more tones included in such audio. In some embodiments, the computer system plays a sequence of sounds to indicate that a plurality of participants will correspond to positions in the three-dimensional environment. In some embodiments, the simulated position of the audio source corresponds to a position of the participant when the position is not within the viewport of the computer system. In some embodiments, the simulated position of the audio source corresponds to a region that the position corresponds to, the region defined relative to the viewpoint of the user. In some embodiments, the audio is played irrespective of whether the position is within the viewport of the user. In some embodiments, the computer system generates non-localized audio indicating that one or more representations of the participants will be included within and/or will no longer be included within the three-dimensional environment. In some embodiments, the computer system forgoes separately providing feedback for events associated with different participants in accordance with a determination that similar feedback has relatively recently been presented.

In some embodiments, a computer system displays a visual representation of another user of another computer system while the computer systems are engaged in a communication session. In some embodiments, when the visual representation is initially displayed by the computer, it is visually transitioned into a displayed three-dimensional according to a transition sequence that includes initially displaying the visual representation according to a low-fidelity visual model and gradually transitioning the visual representation to being displayed according to a high-fidelity visual model. In some embodiments, both the low-fidelity visual model and the high-fidelity visual model are configured to provide the user with a visual indication of the status of the visual representation. For instance, the low-fidelity visual model includes displaying the visual representation with noise and with colors selected from a pre-determined color palette so as to indicate that the visual representation has not been fully rendered (for example due to the computer system still acquiring information about the visual representation). In some embodiments, the high-fidelity visual model includes displaying the visual representation according to one or more images associated with the participant that the visual representation is meant to represent. For instance, the high-fidelity representation can include portions of the visual representation that bear a resemblance to the participant associated with the visual representation.

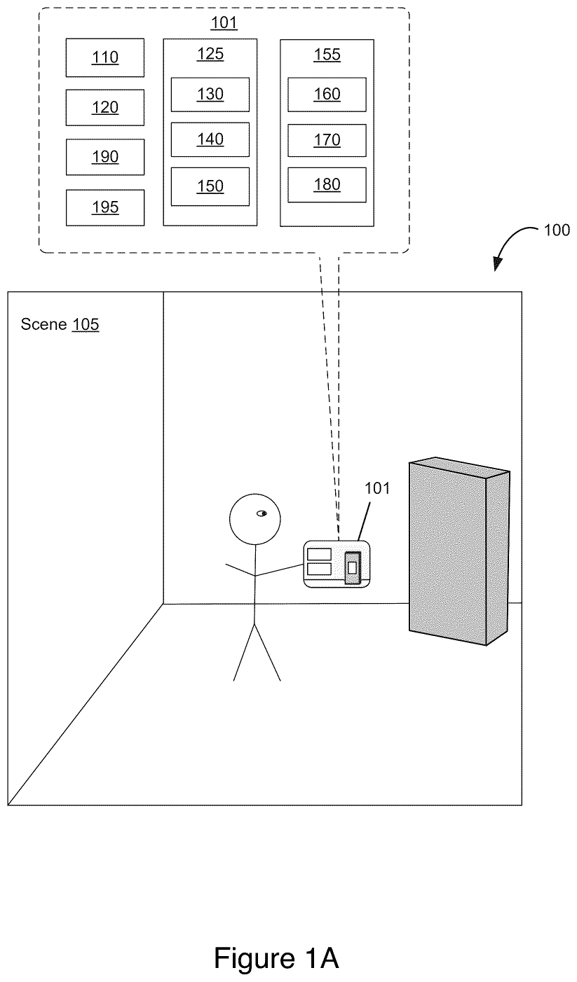

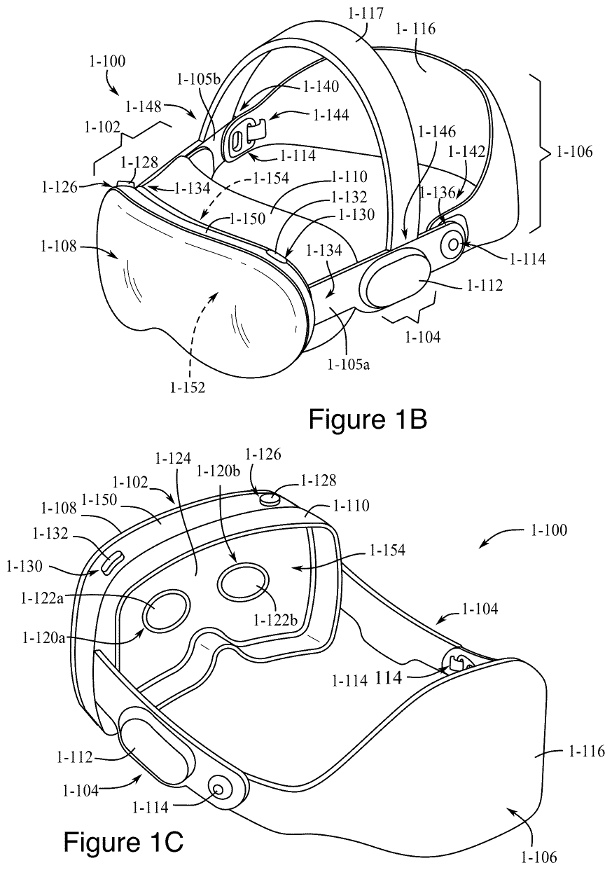

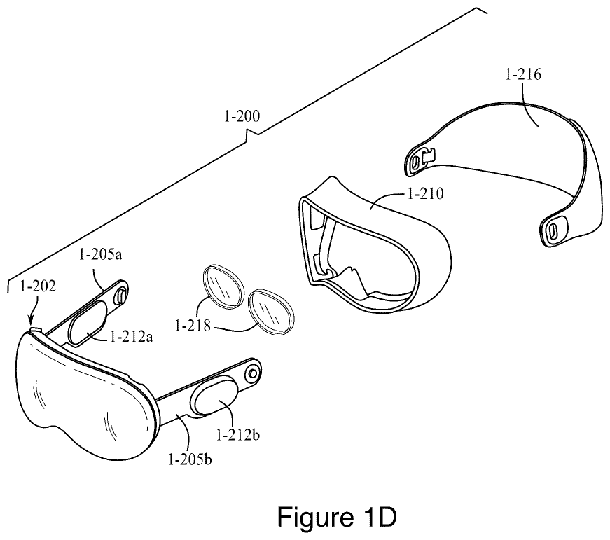

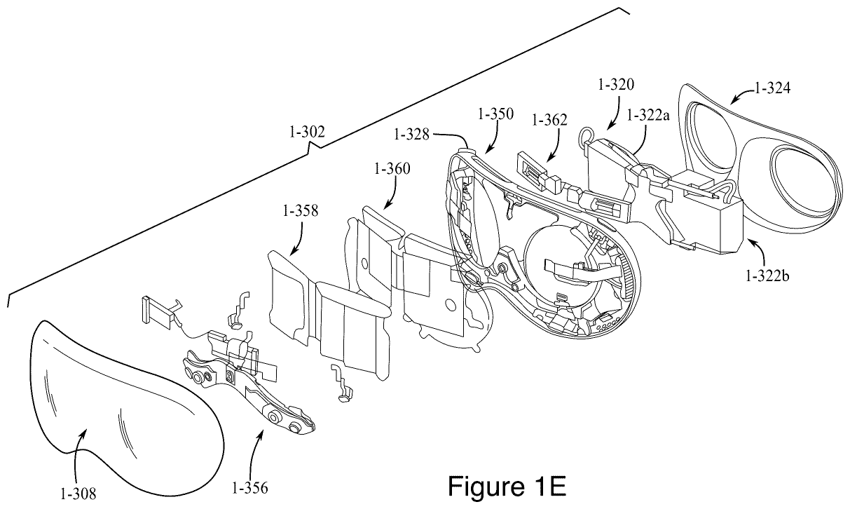

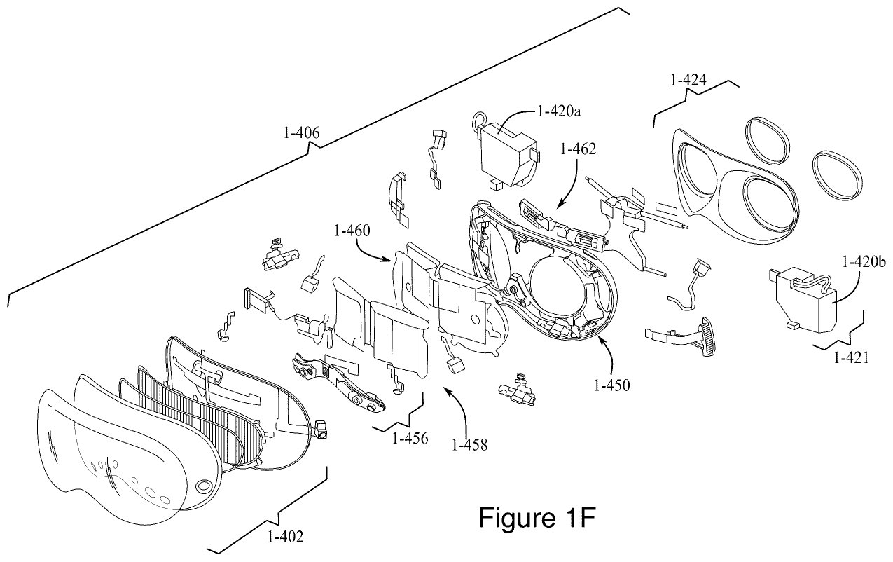

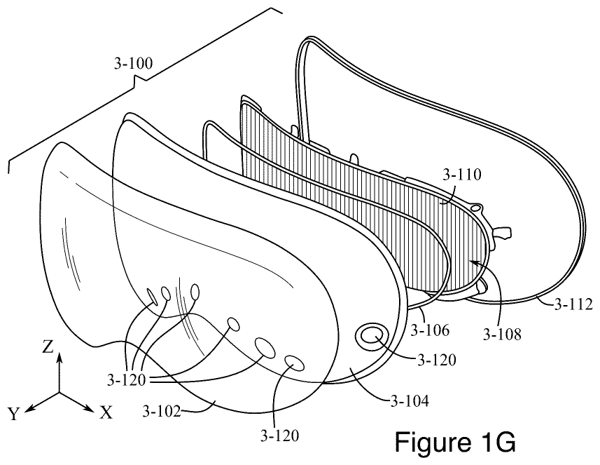

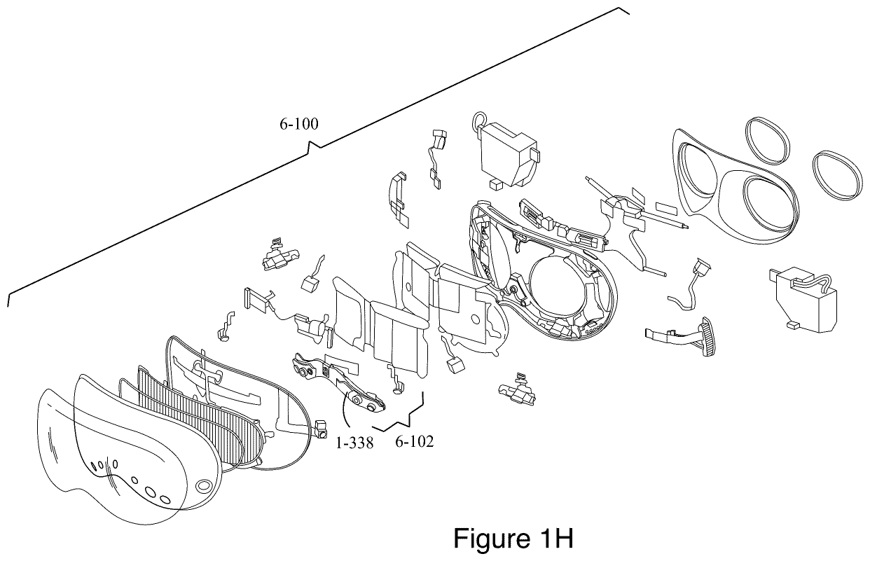

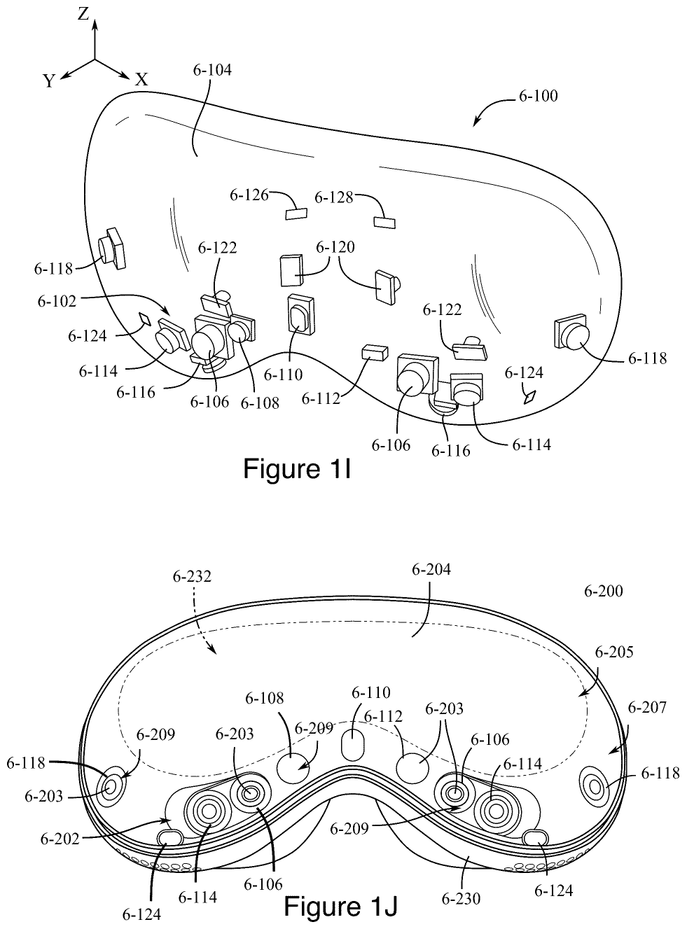

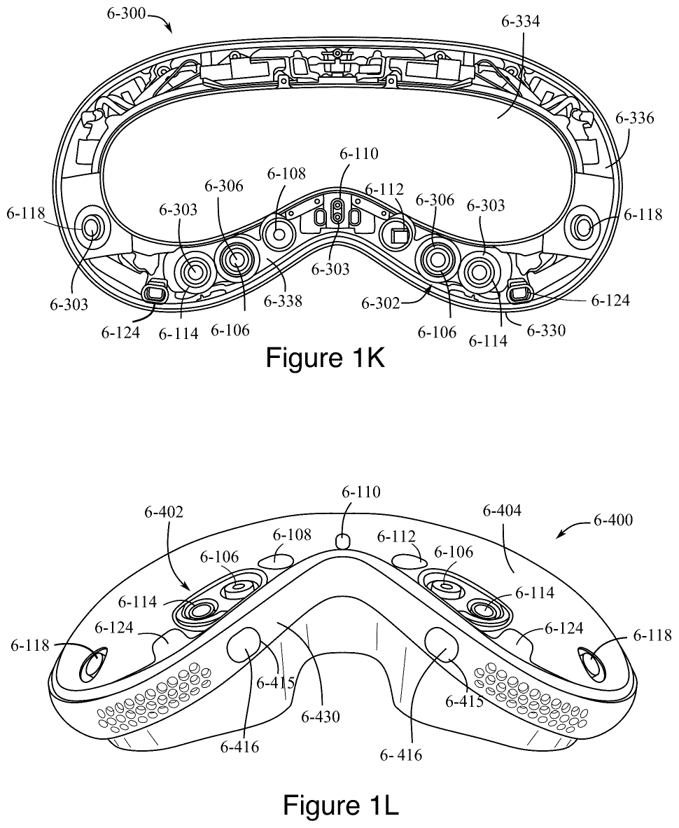

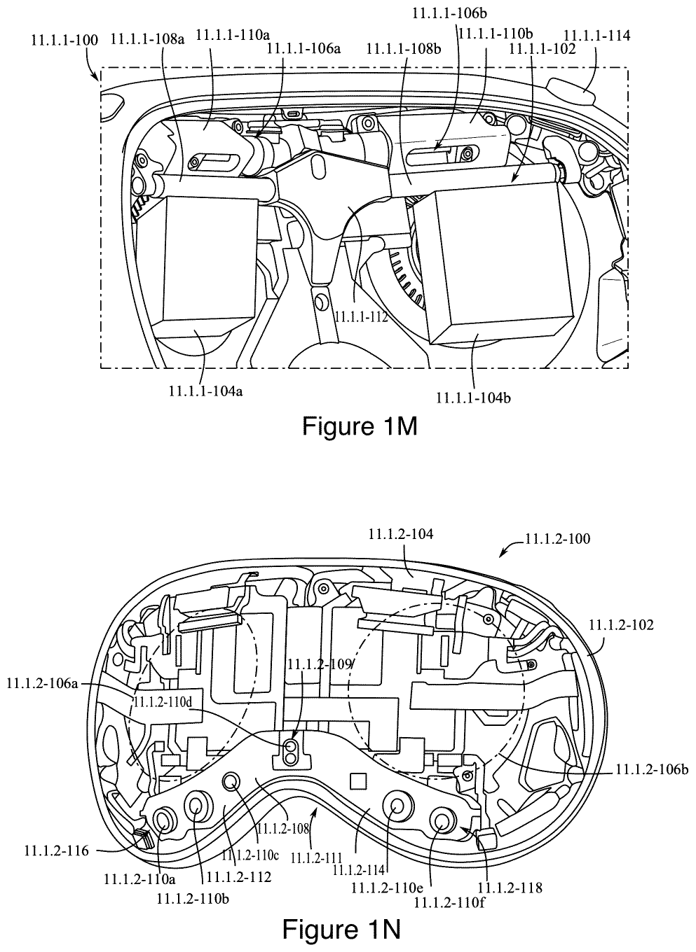

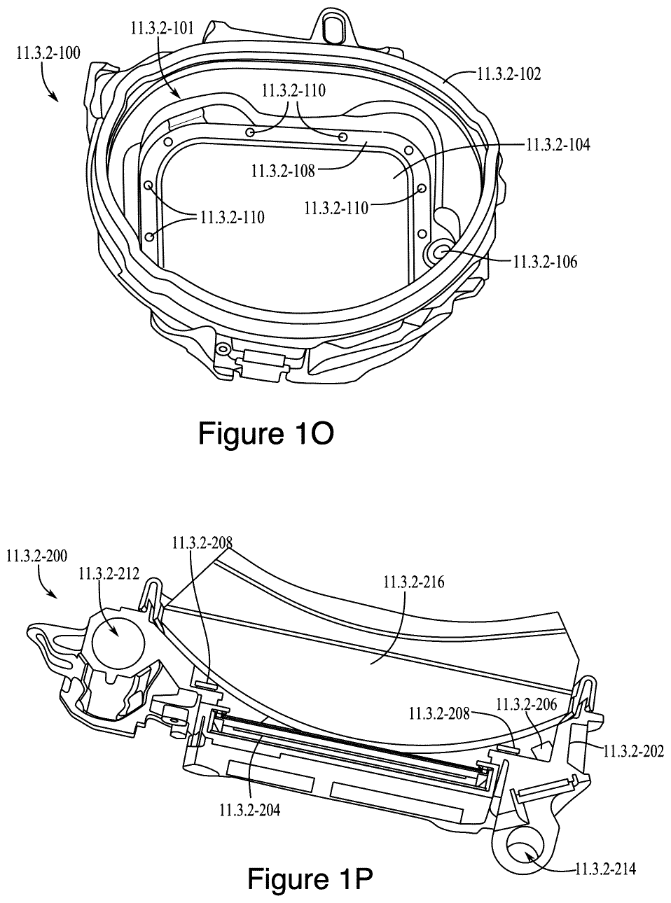

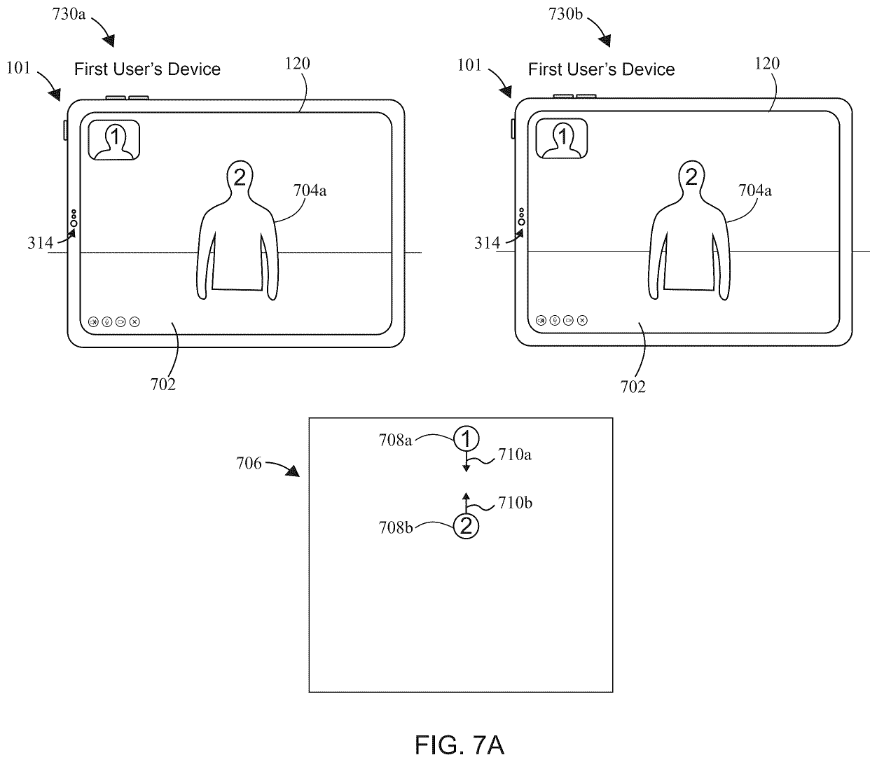

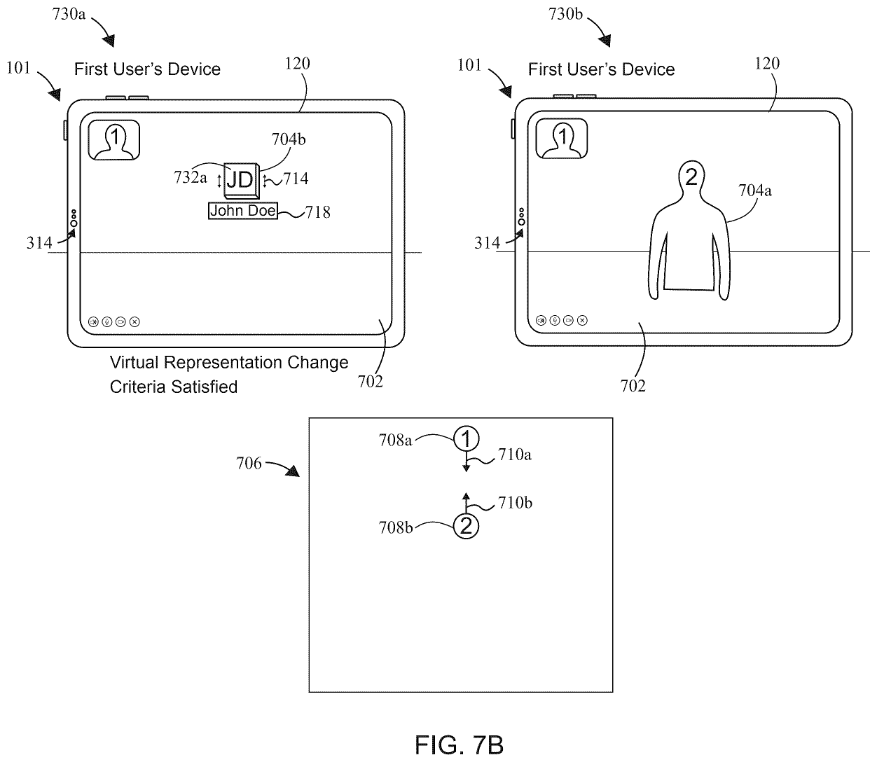

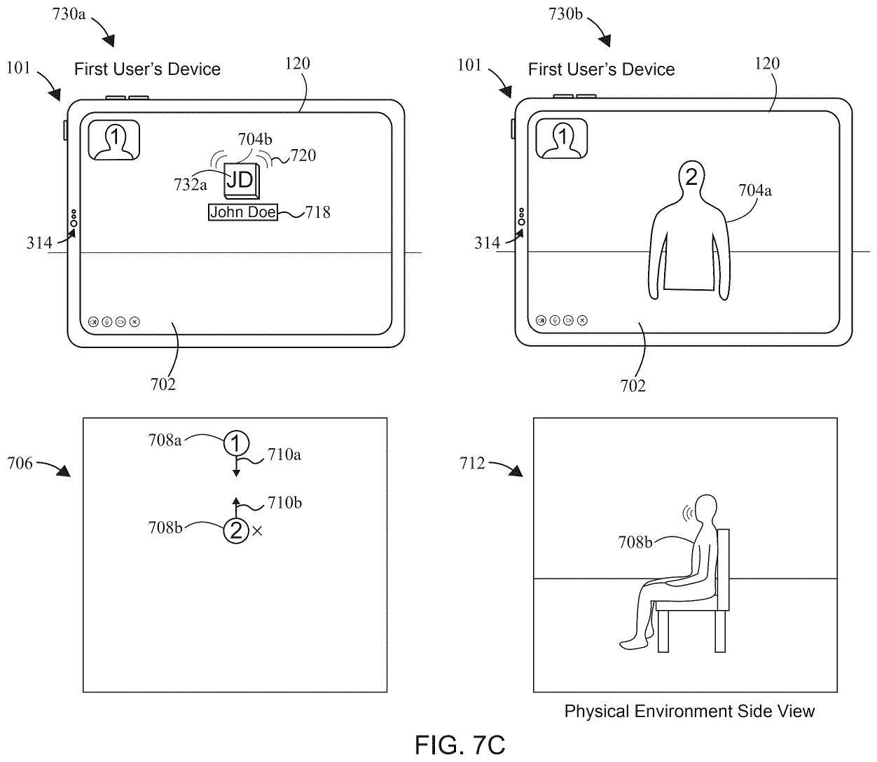

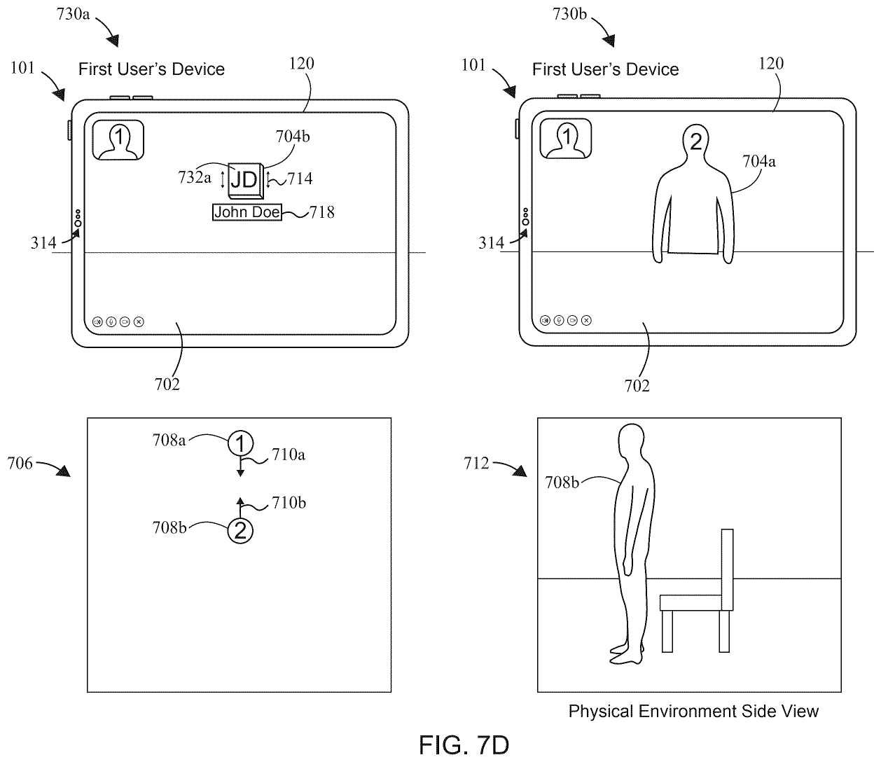

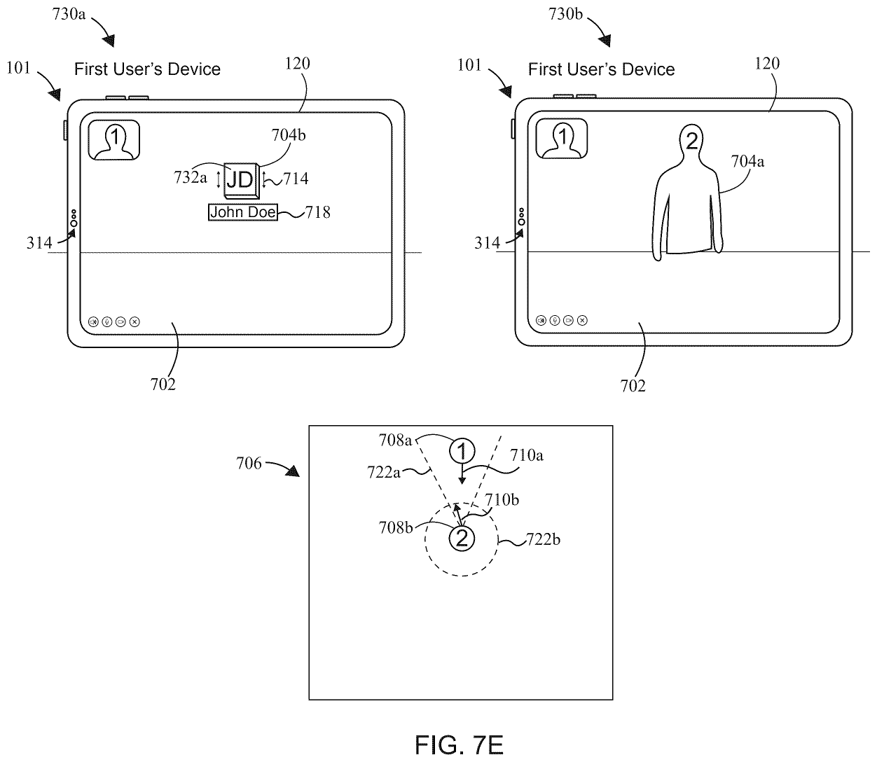

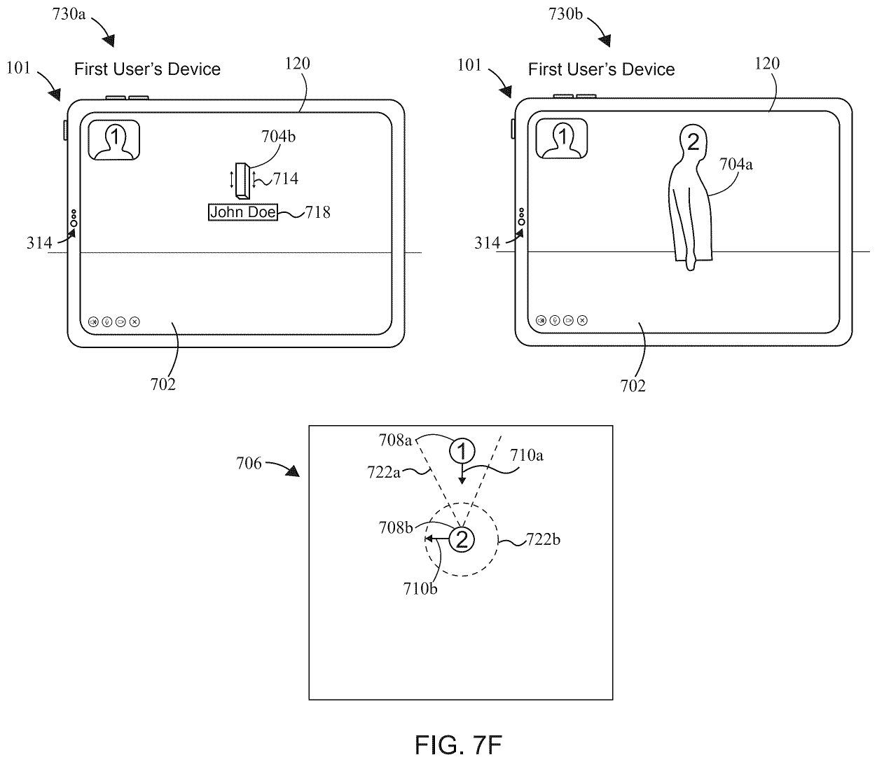

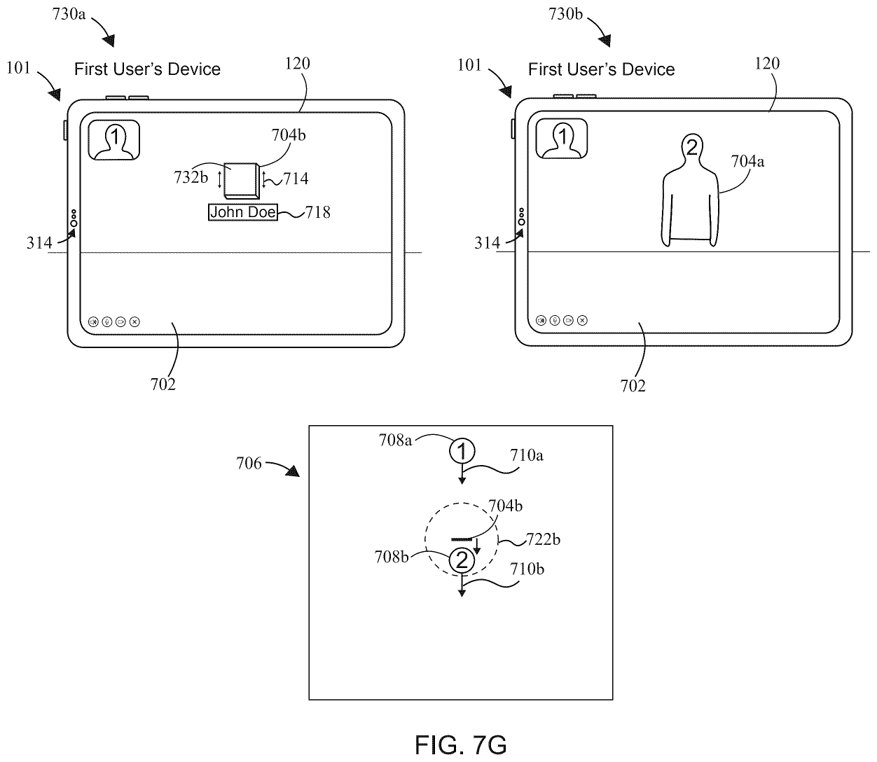

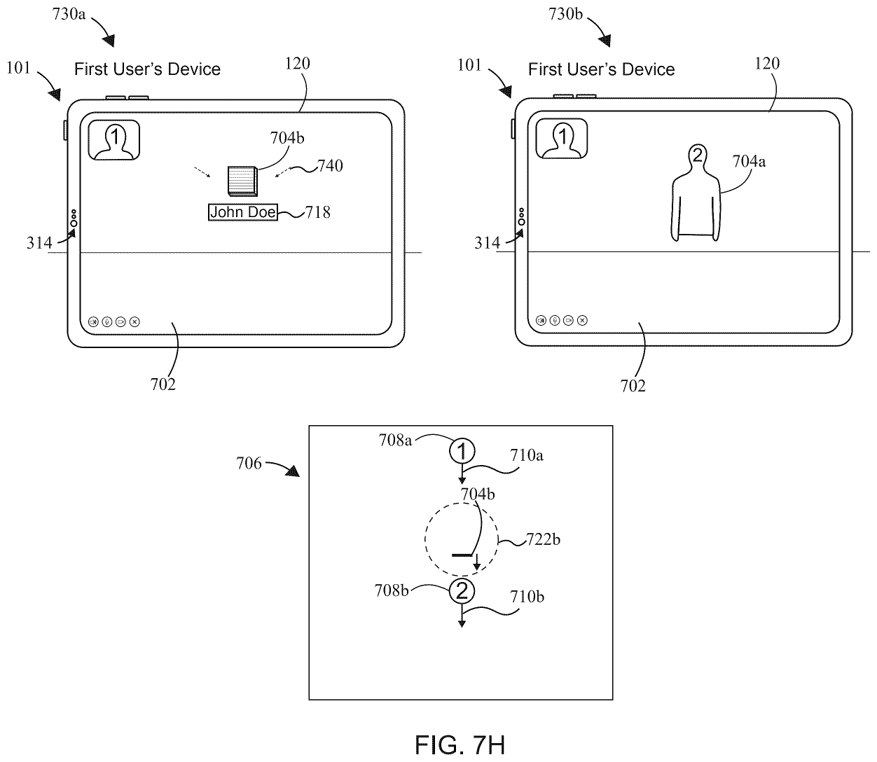

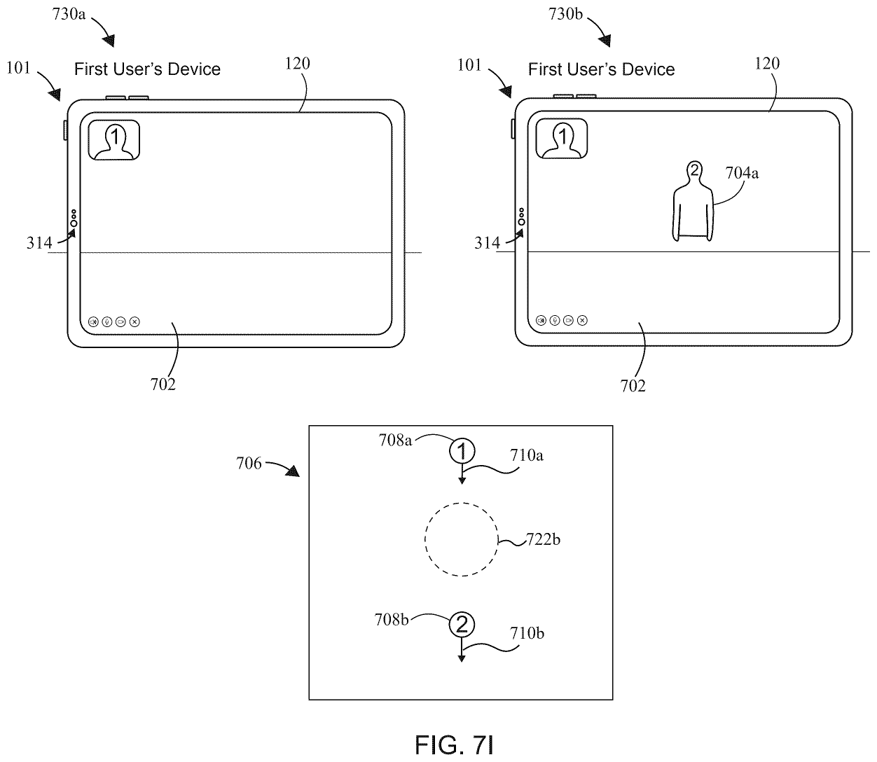

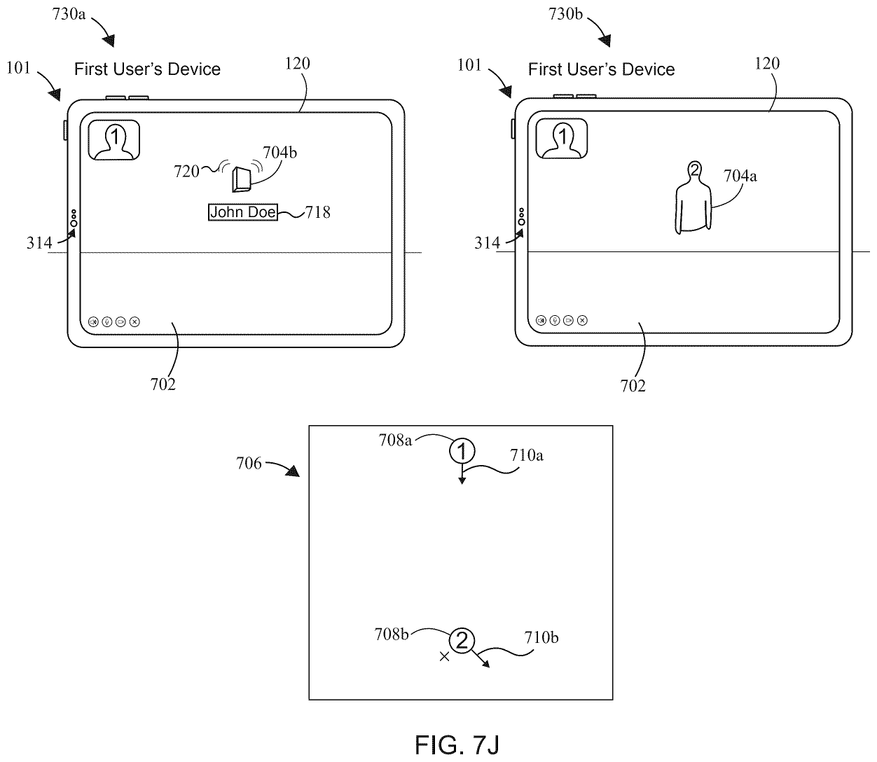

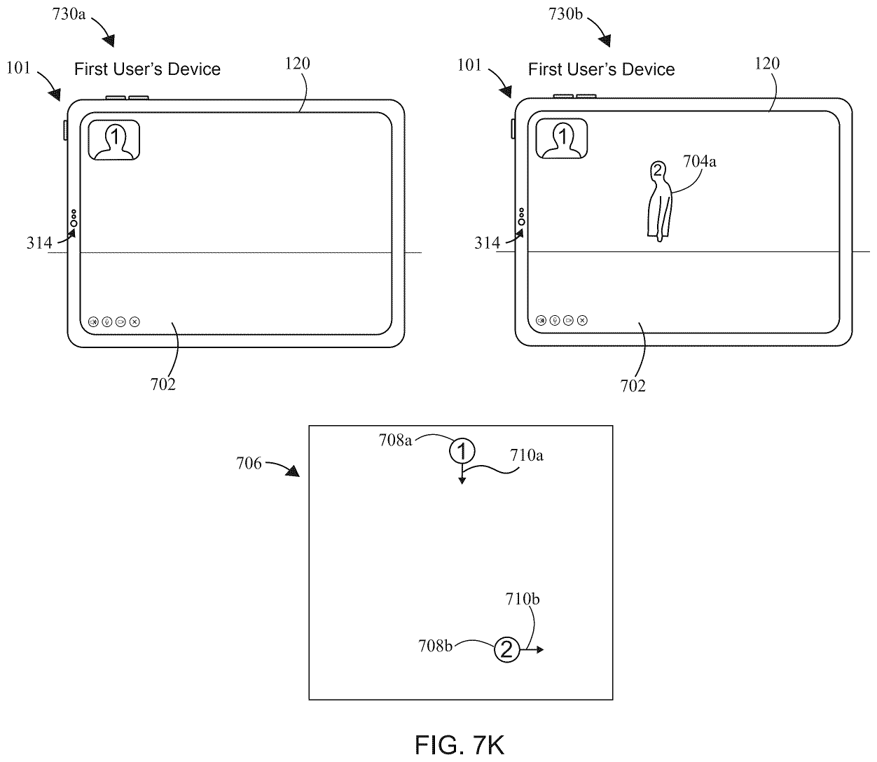

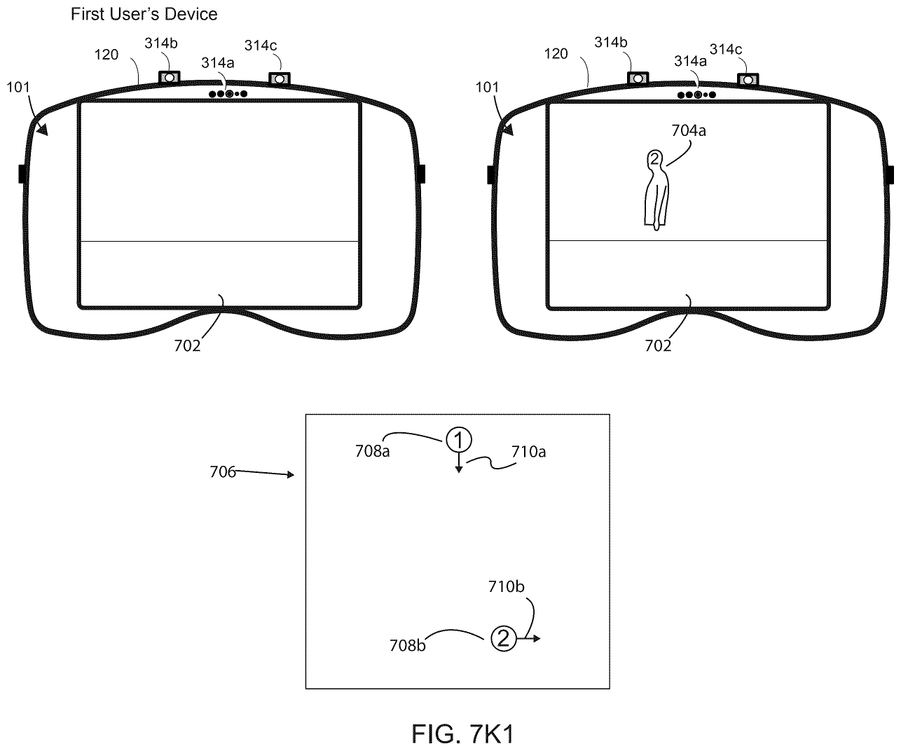

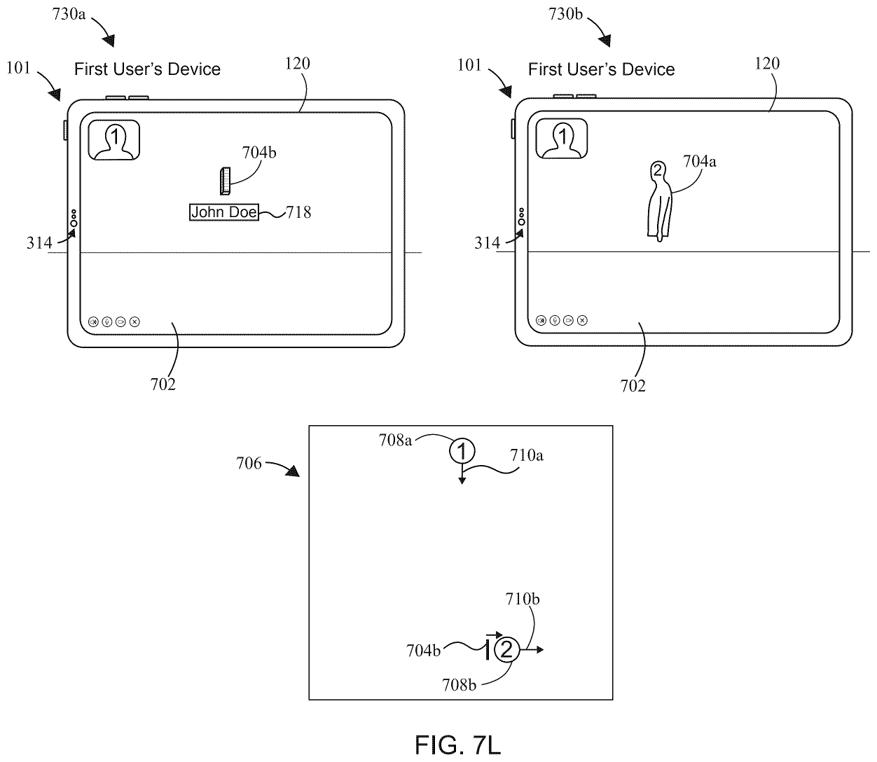

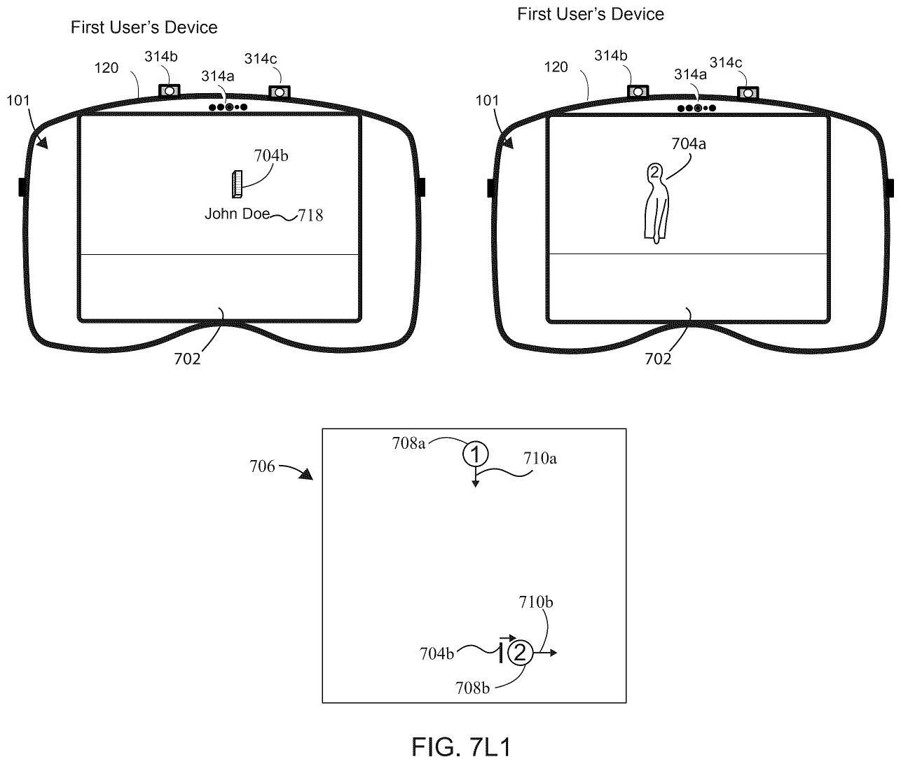

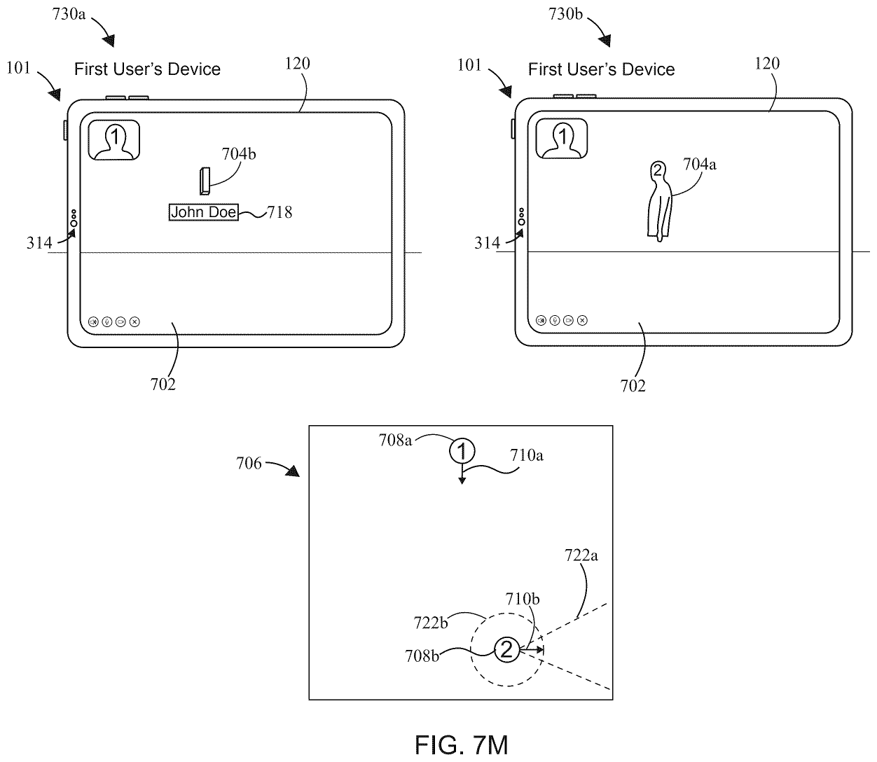

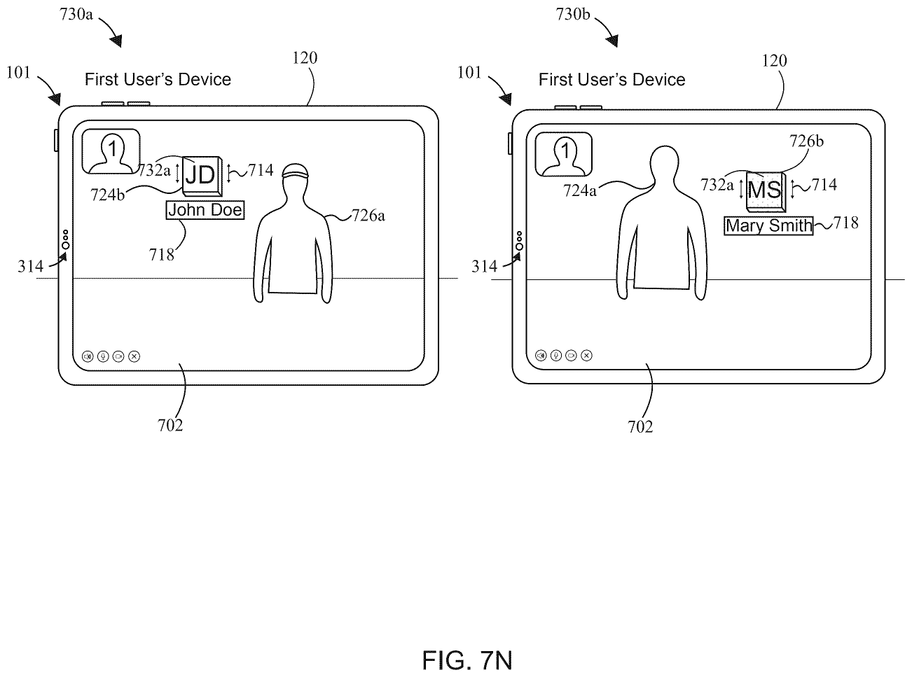

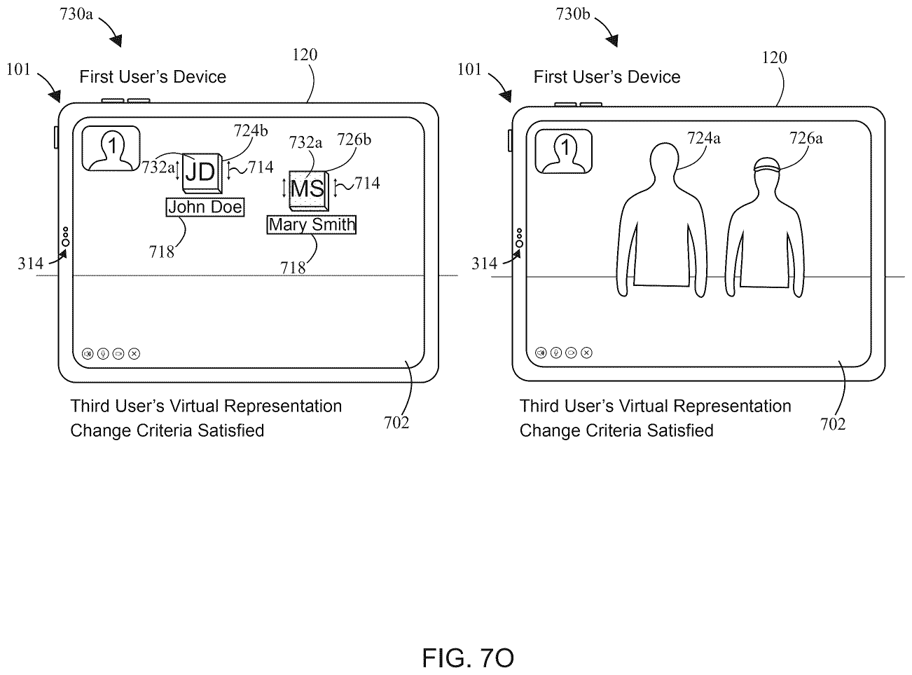

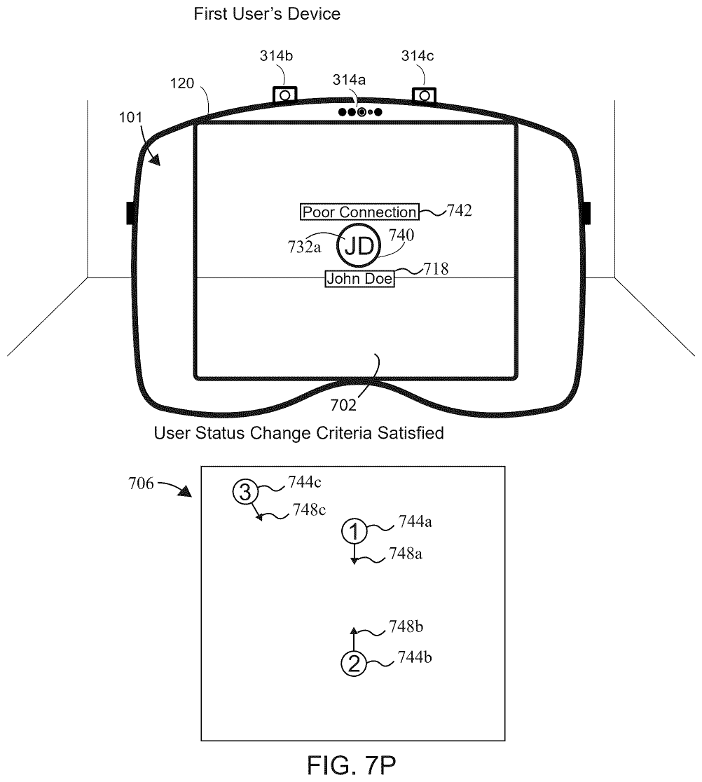

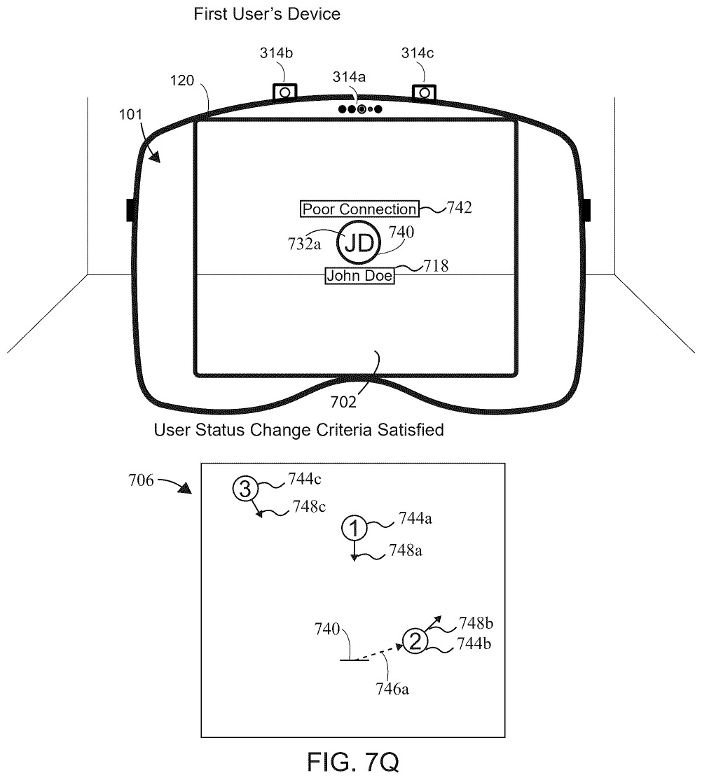

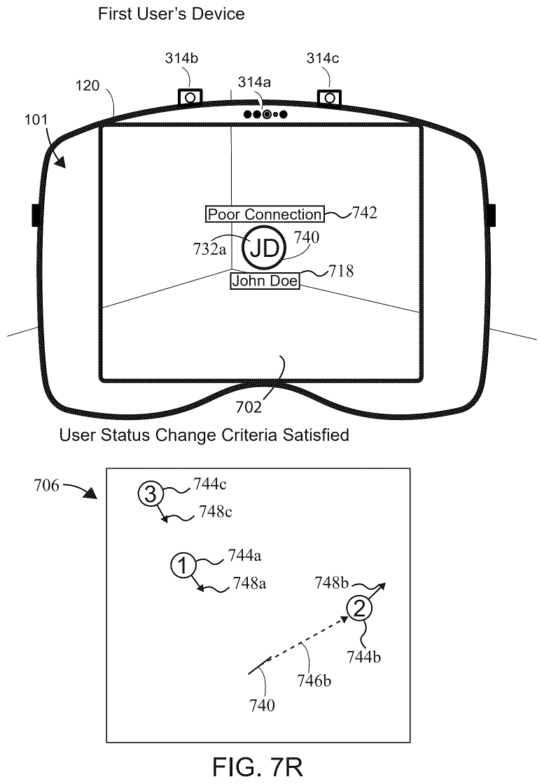

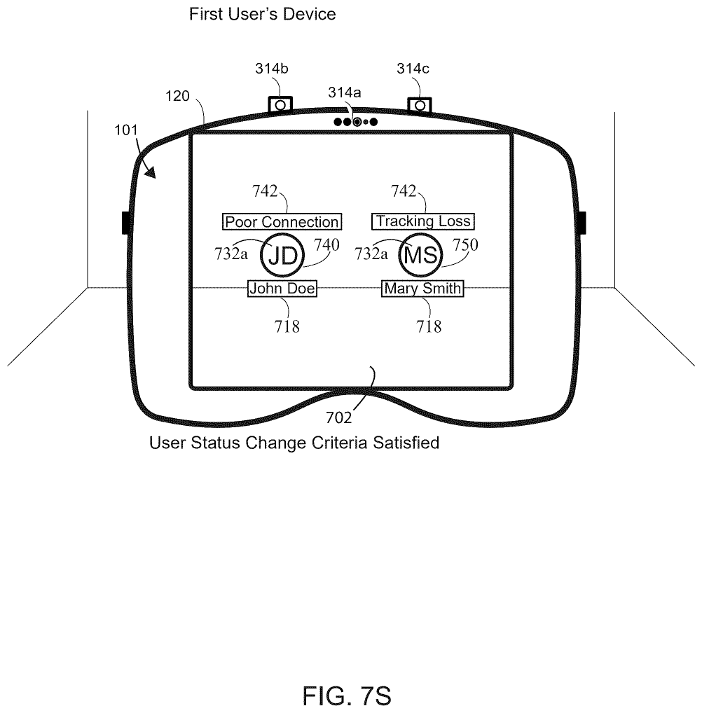

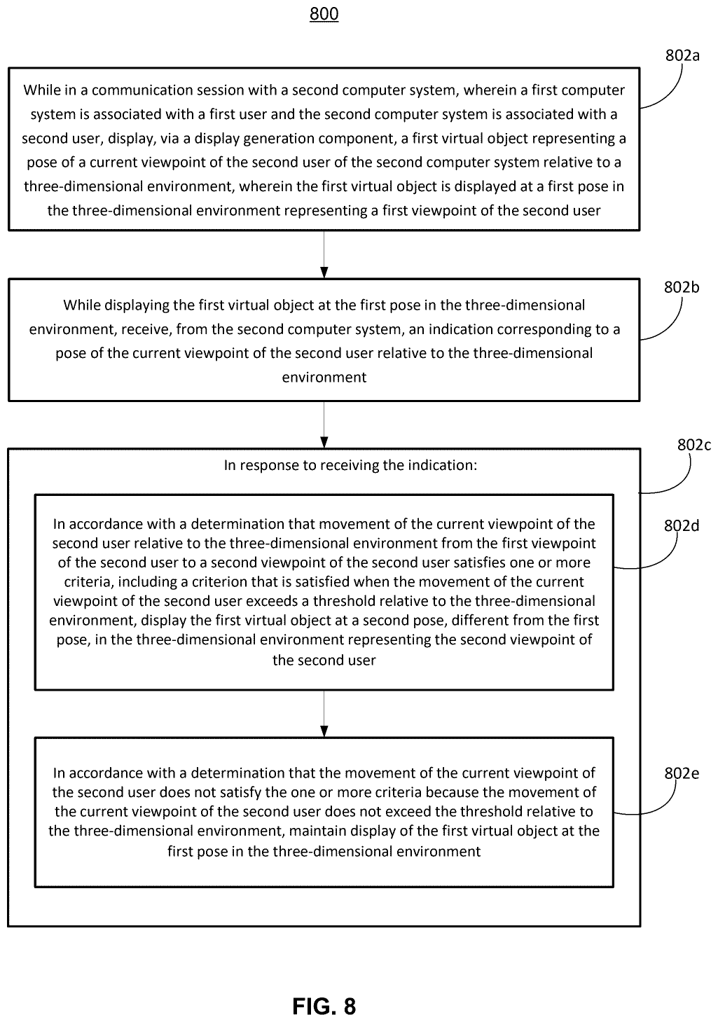

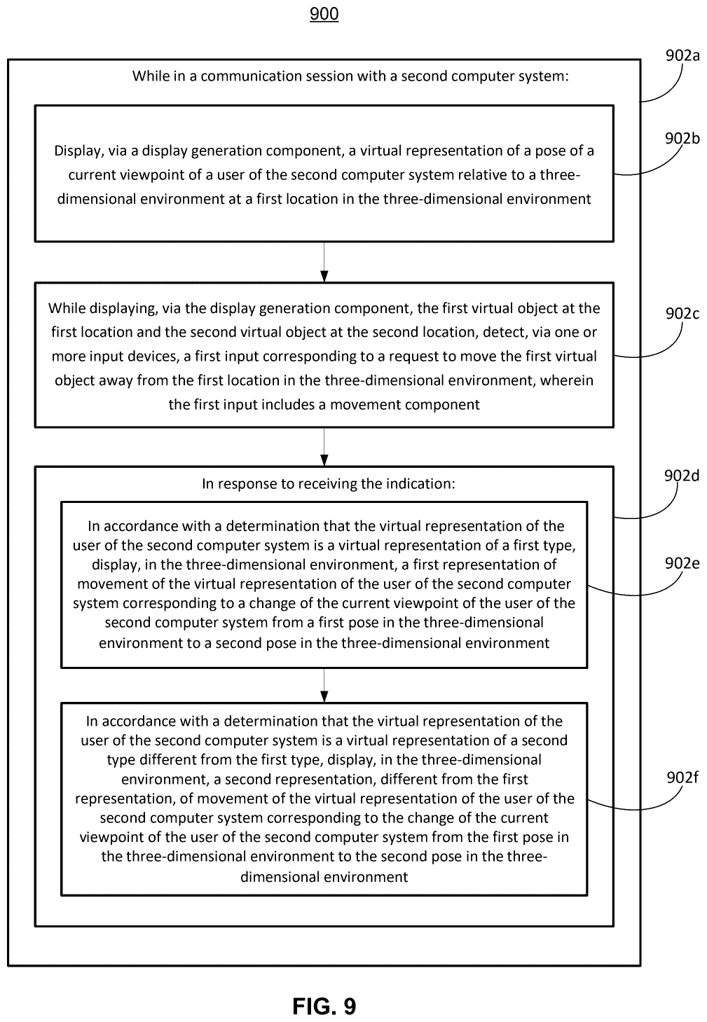

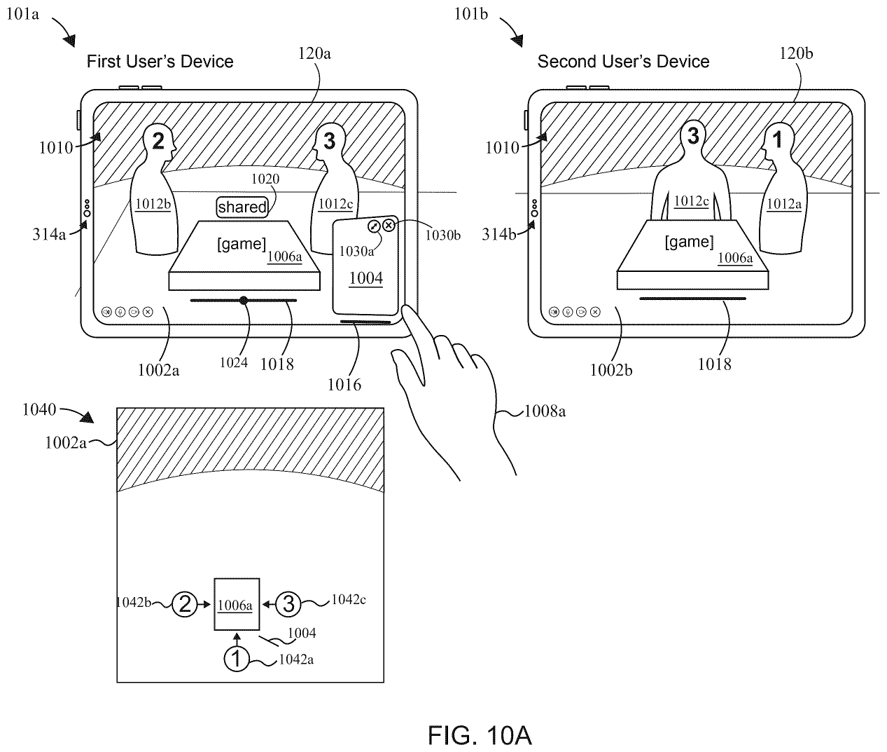

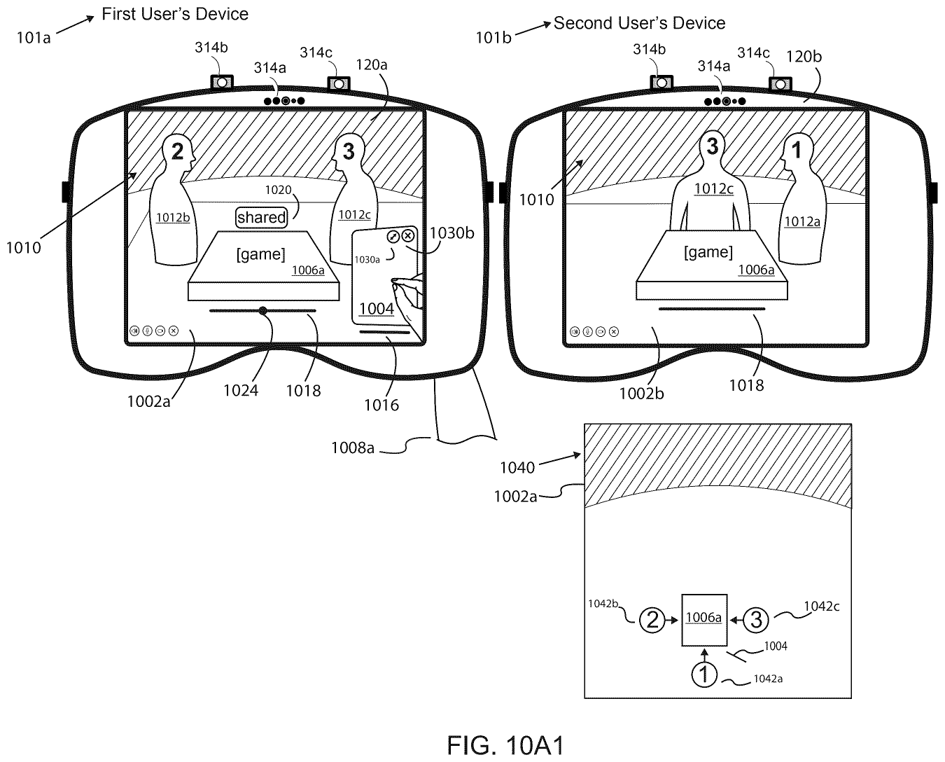

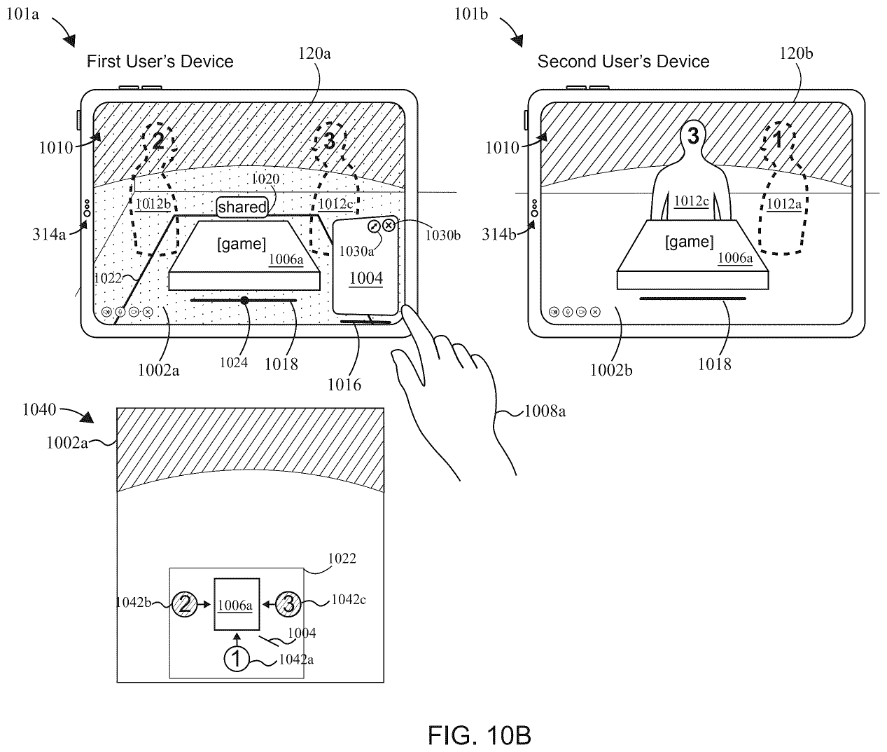

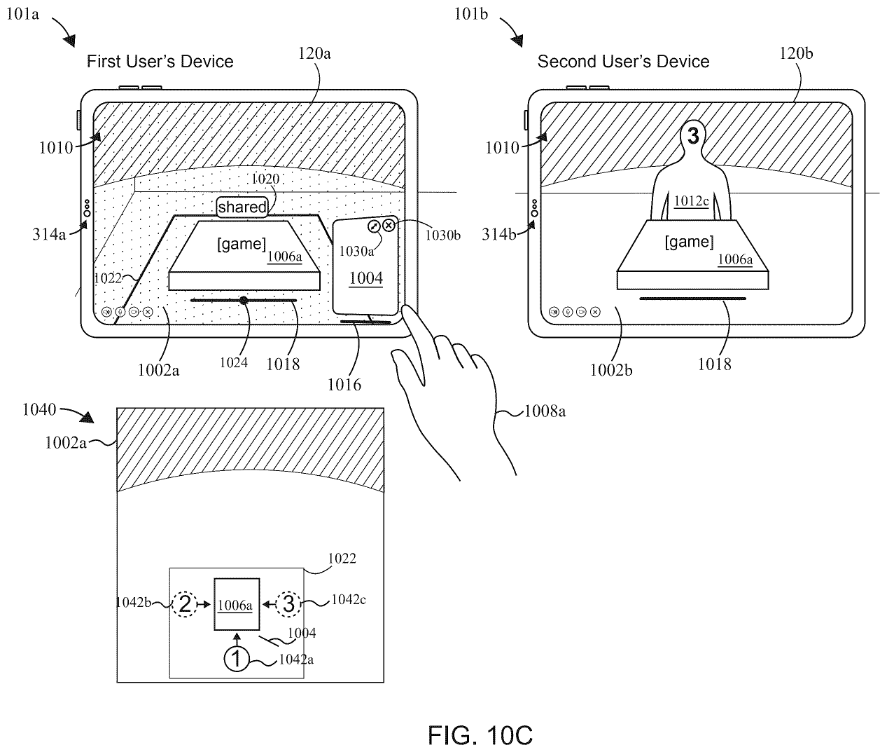

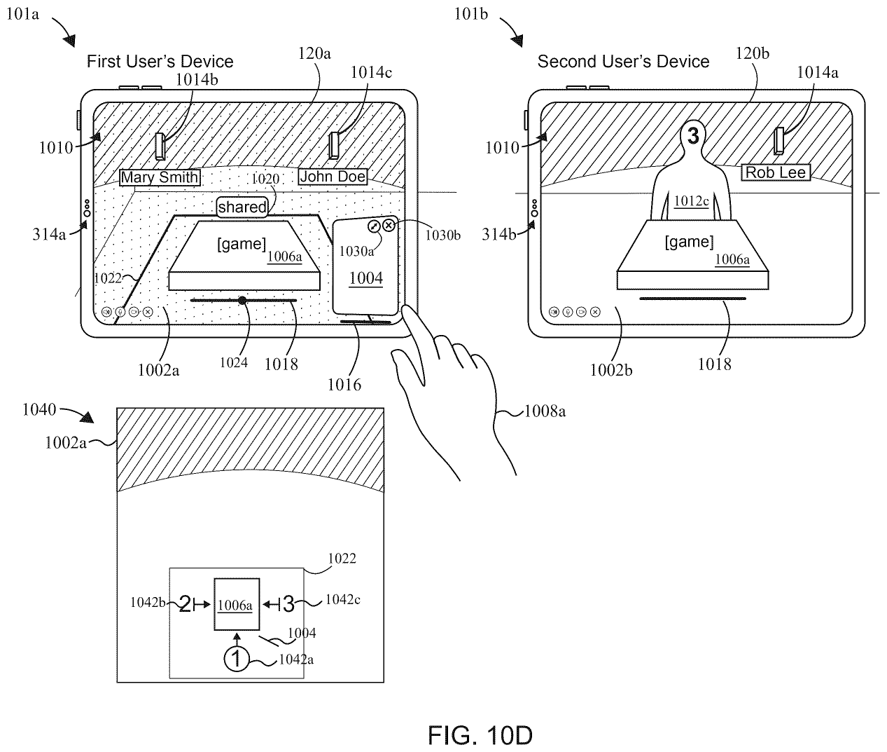

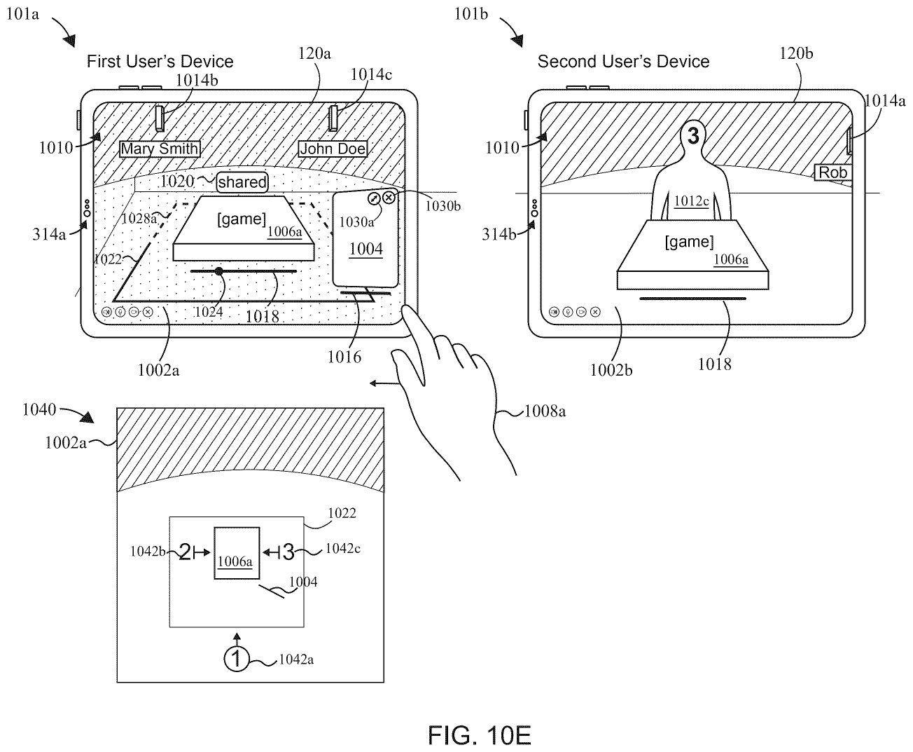

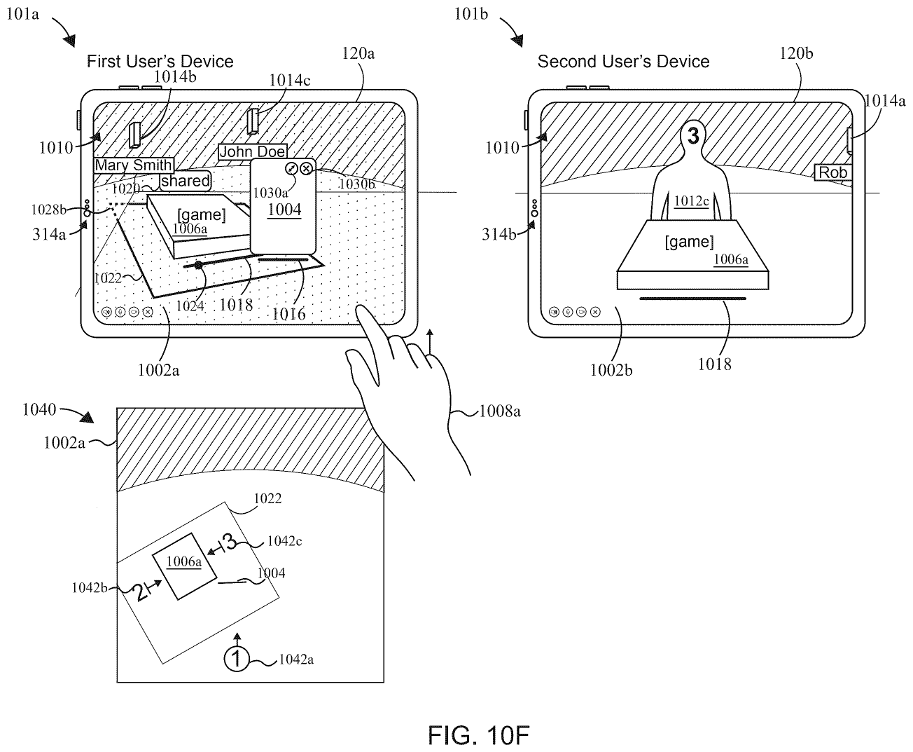

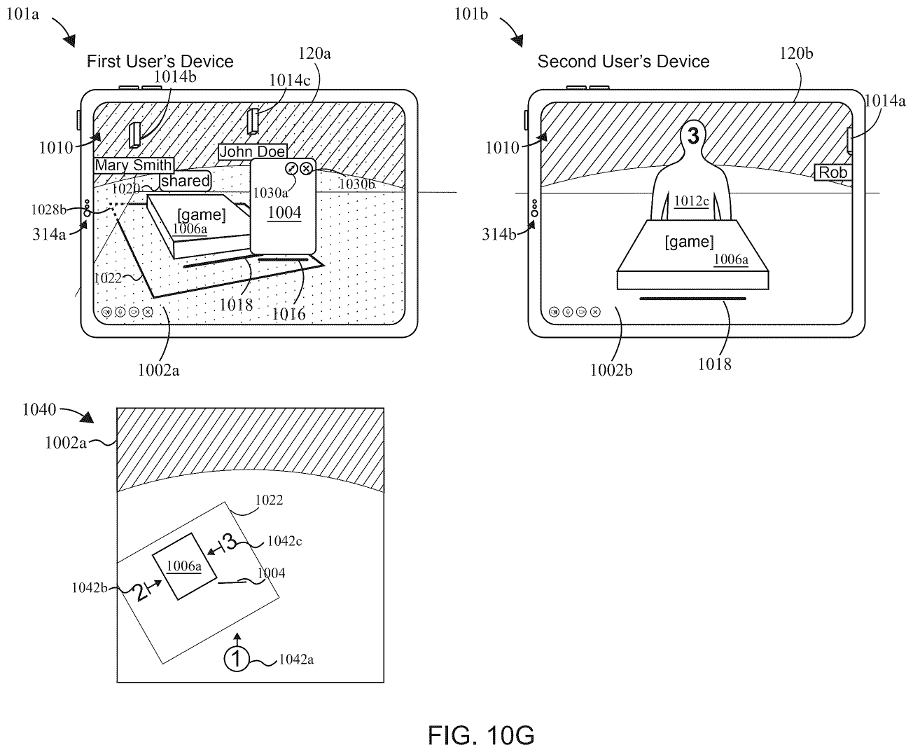

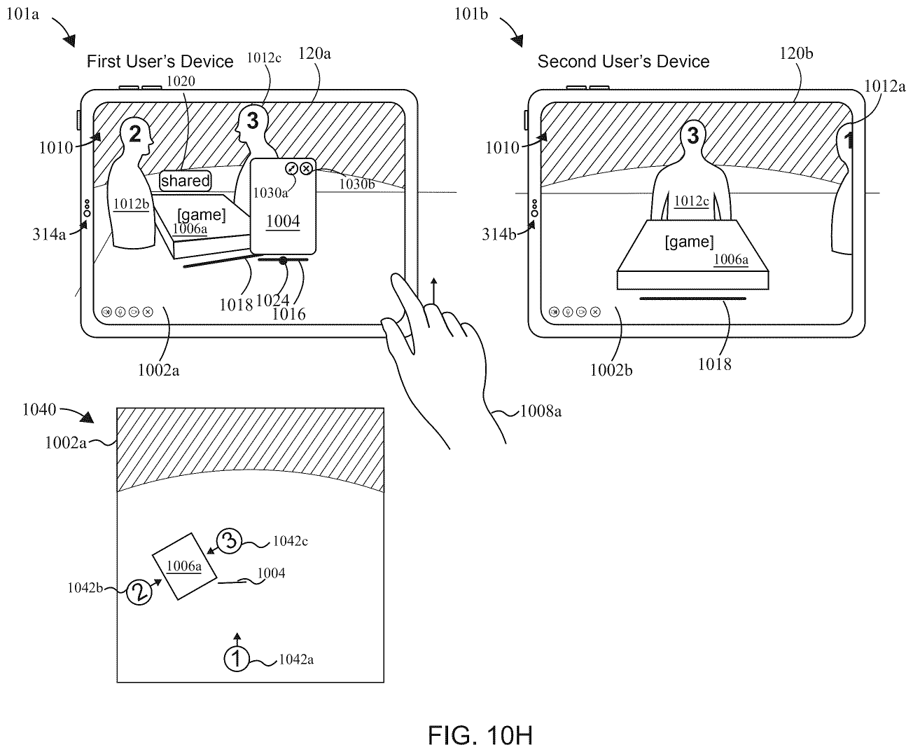

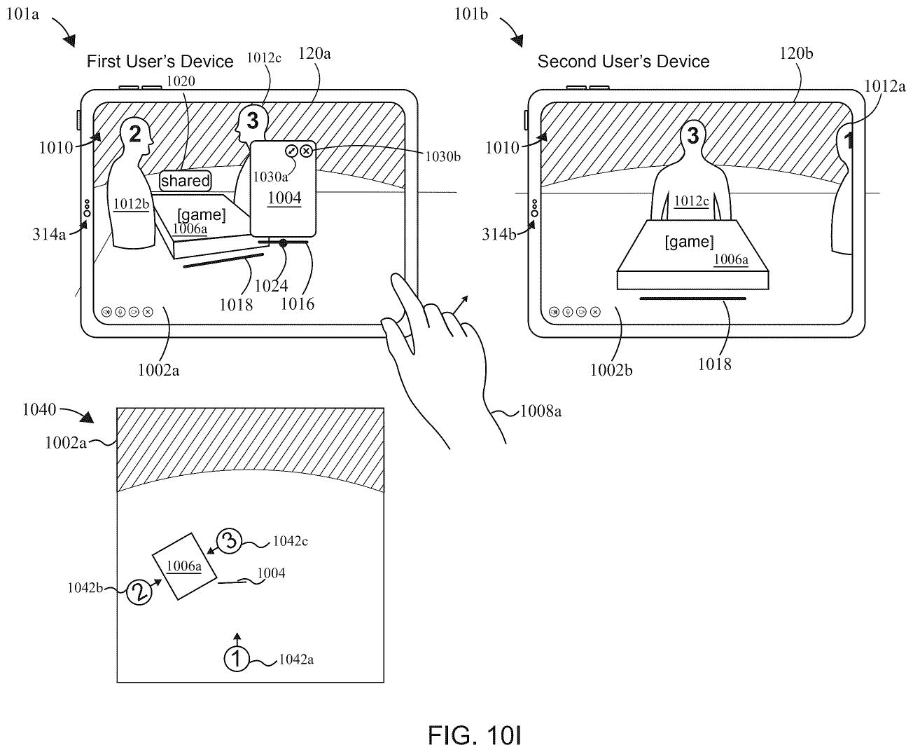

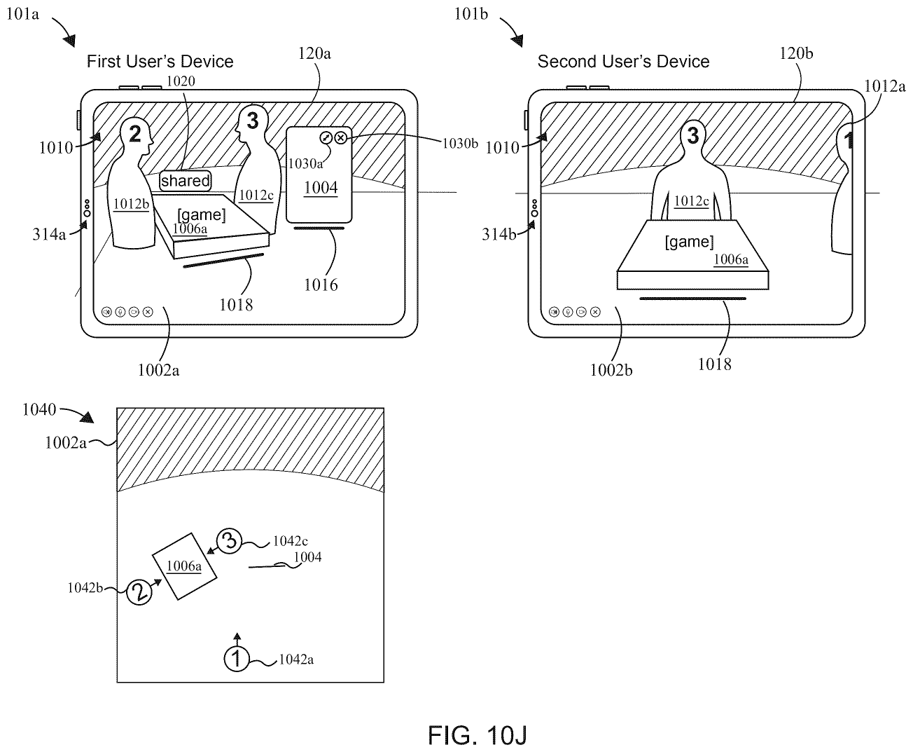

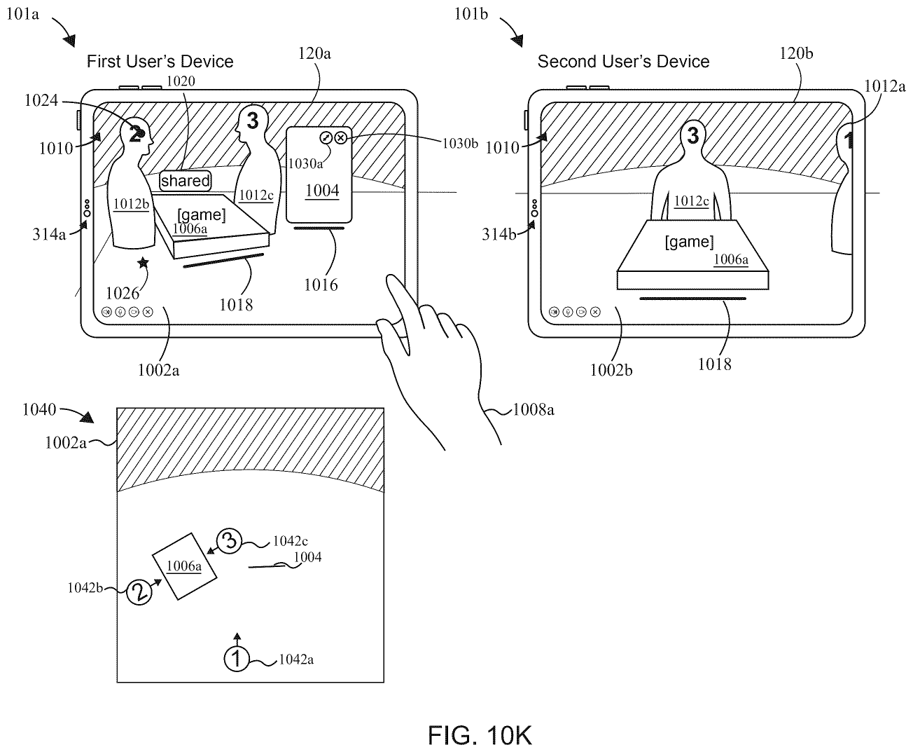

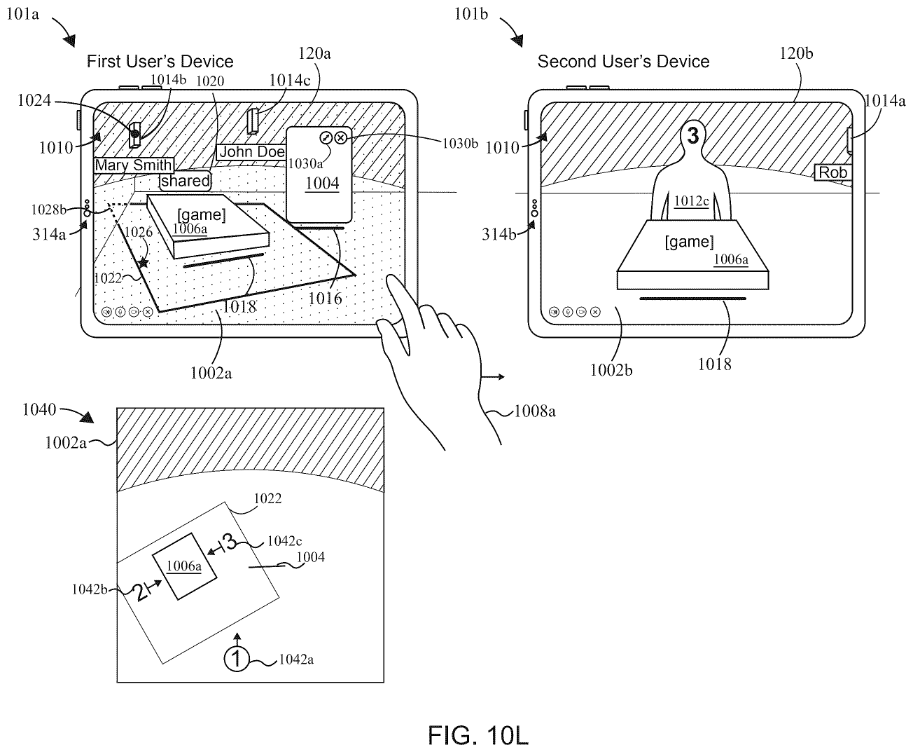

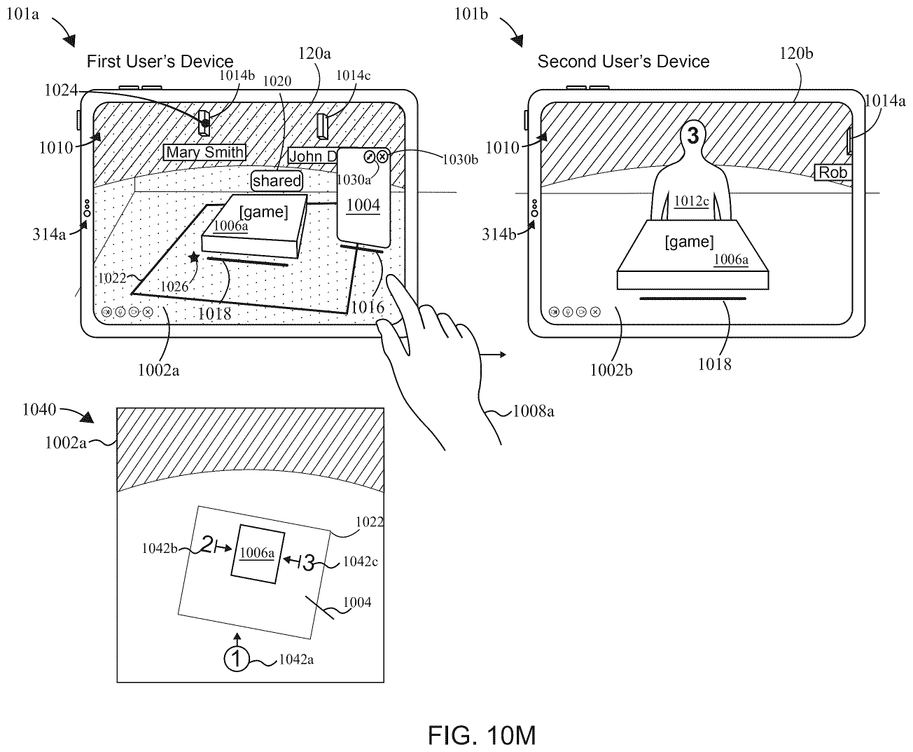

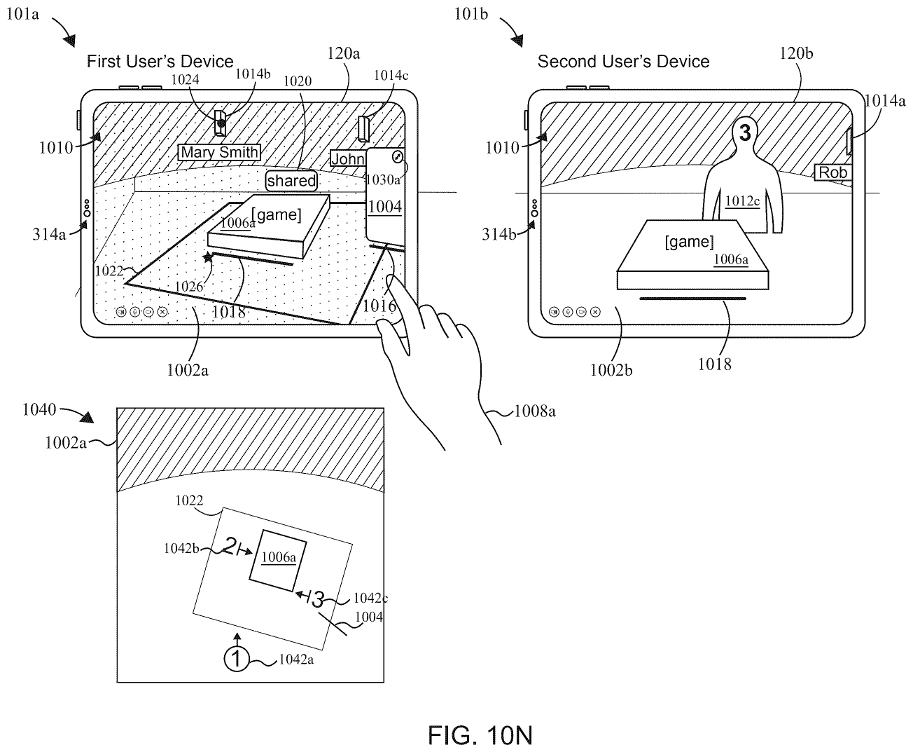

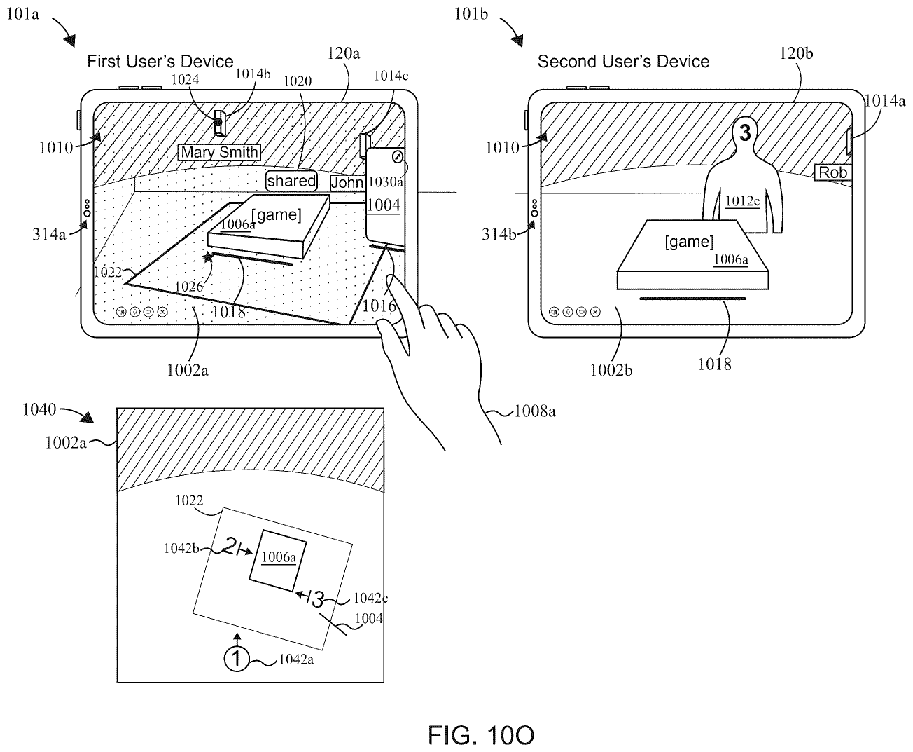

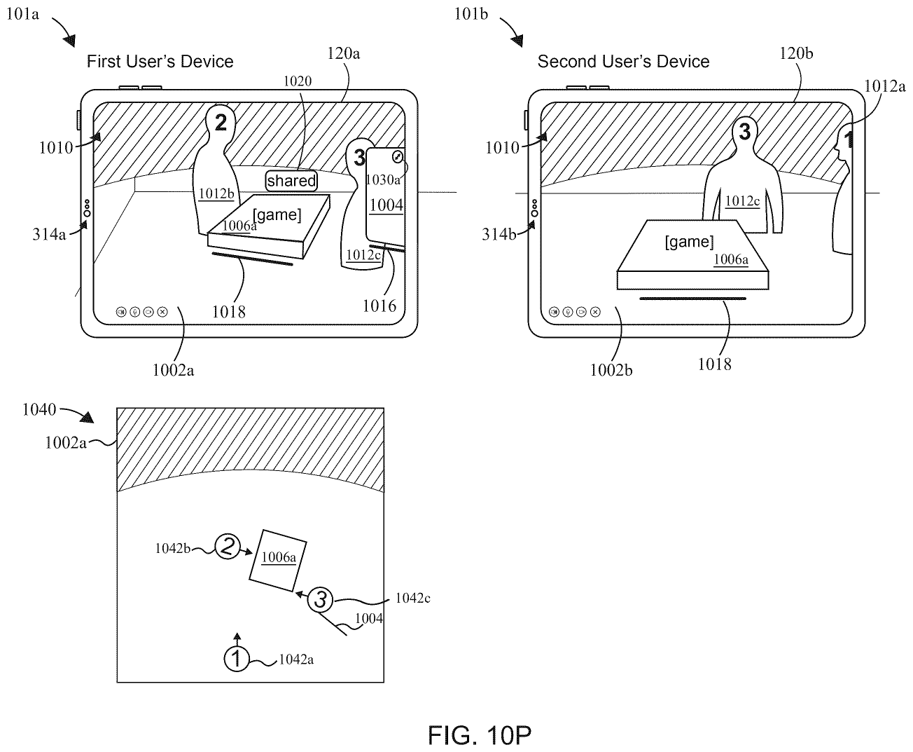

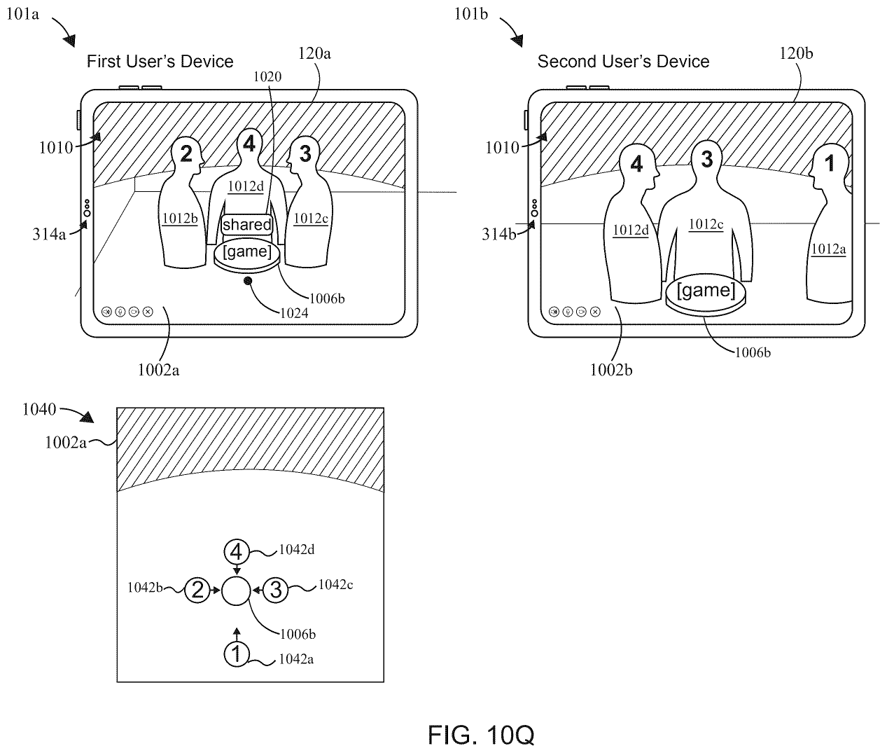

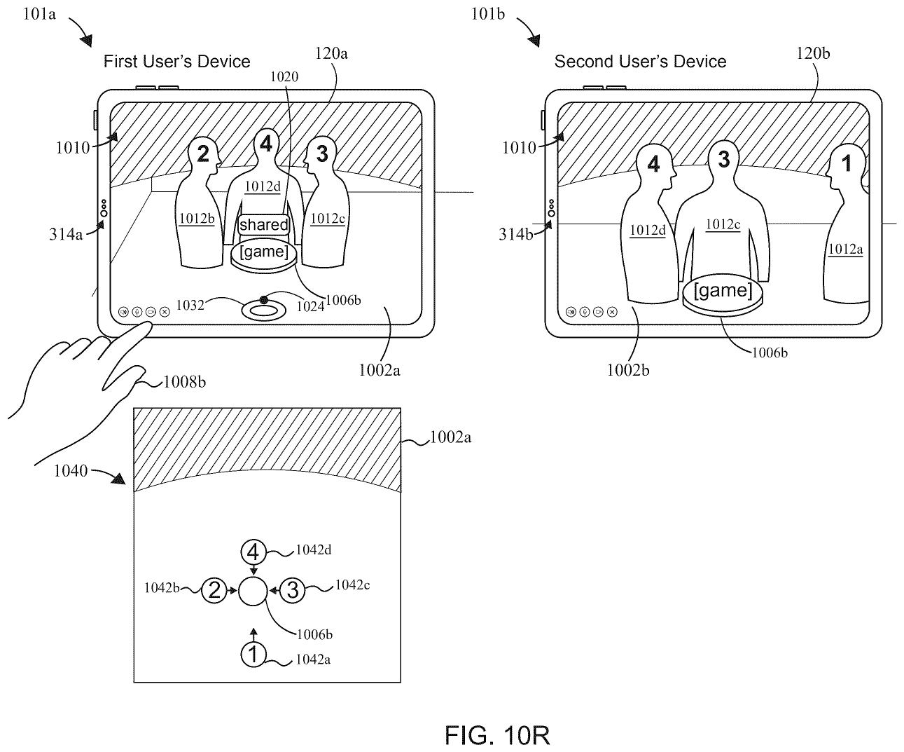

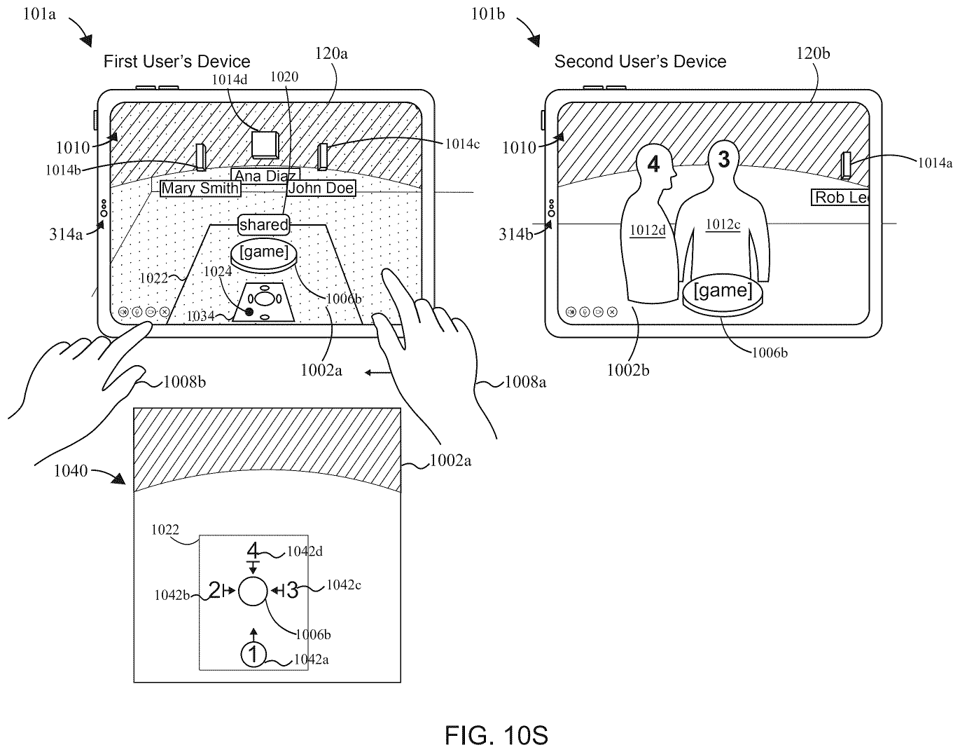

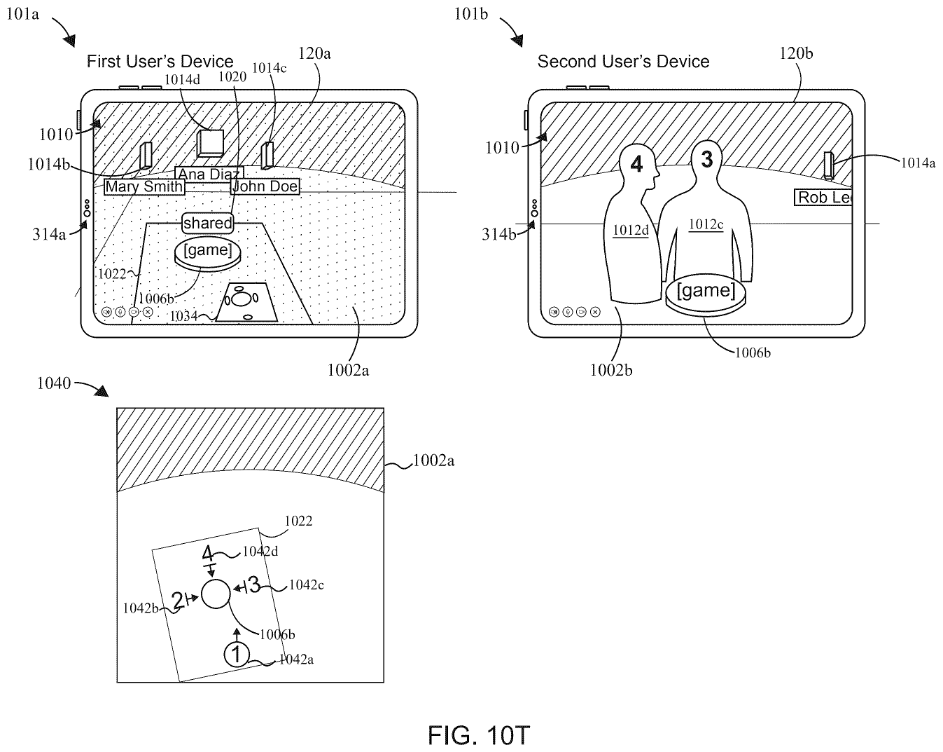

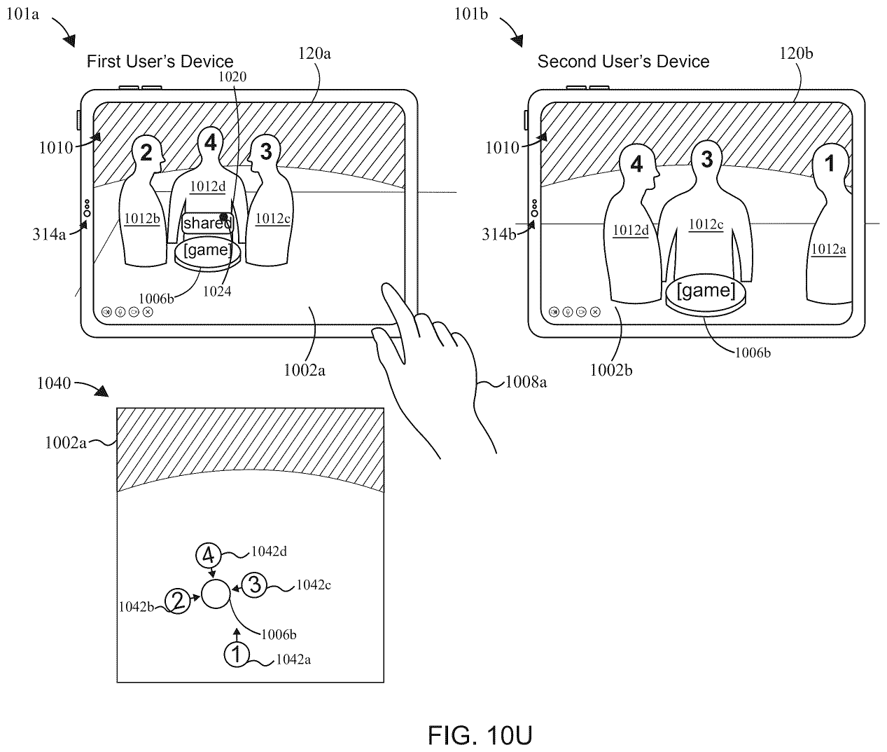

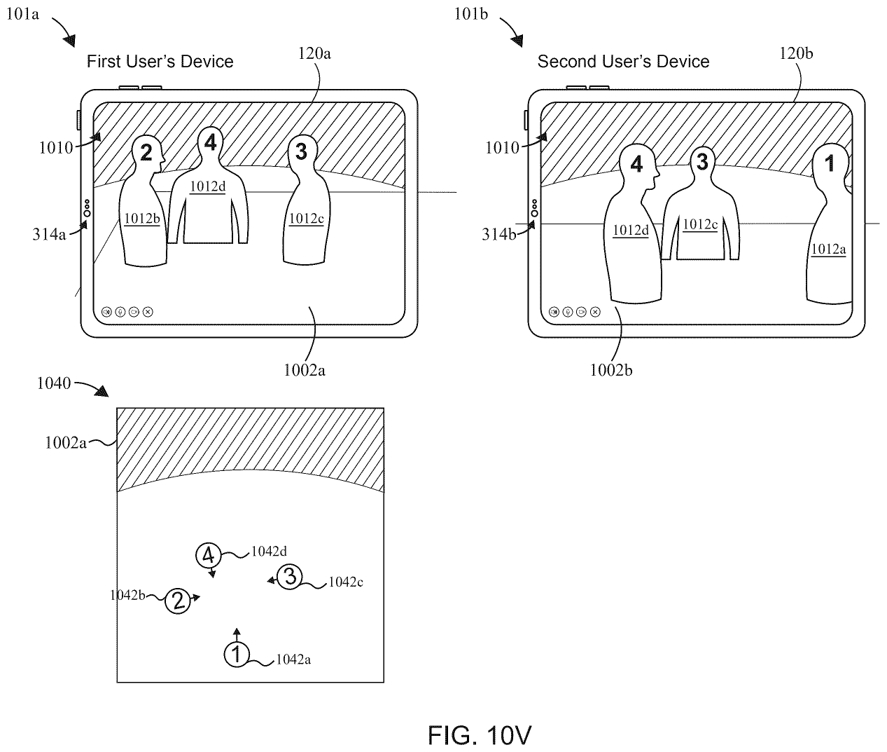

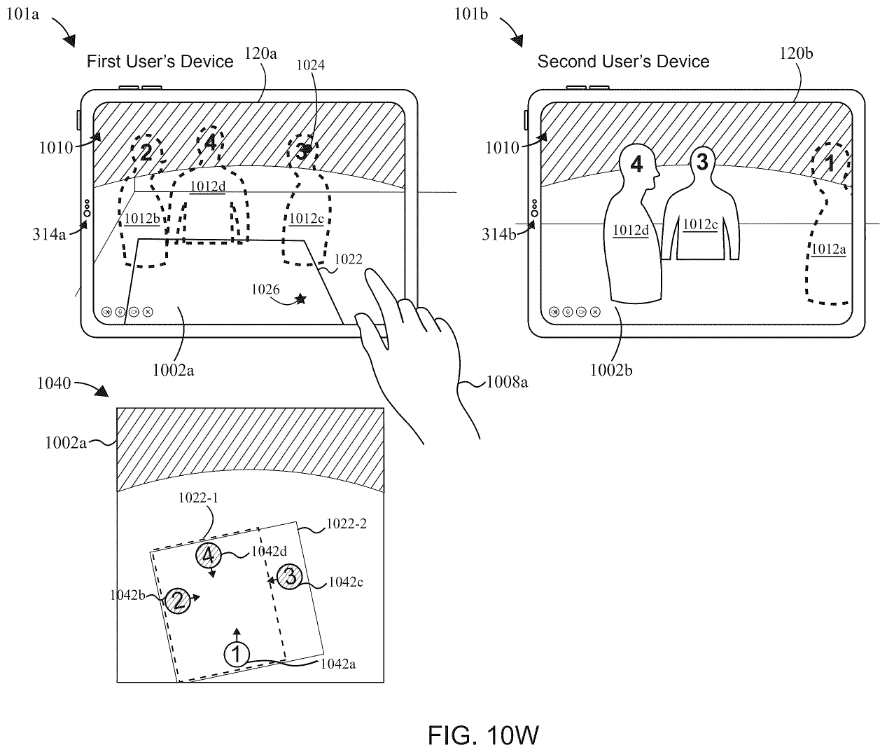

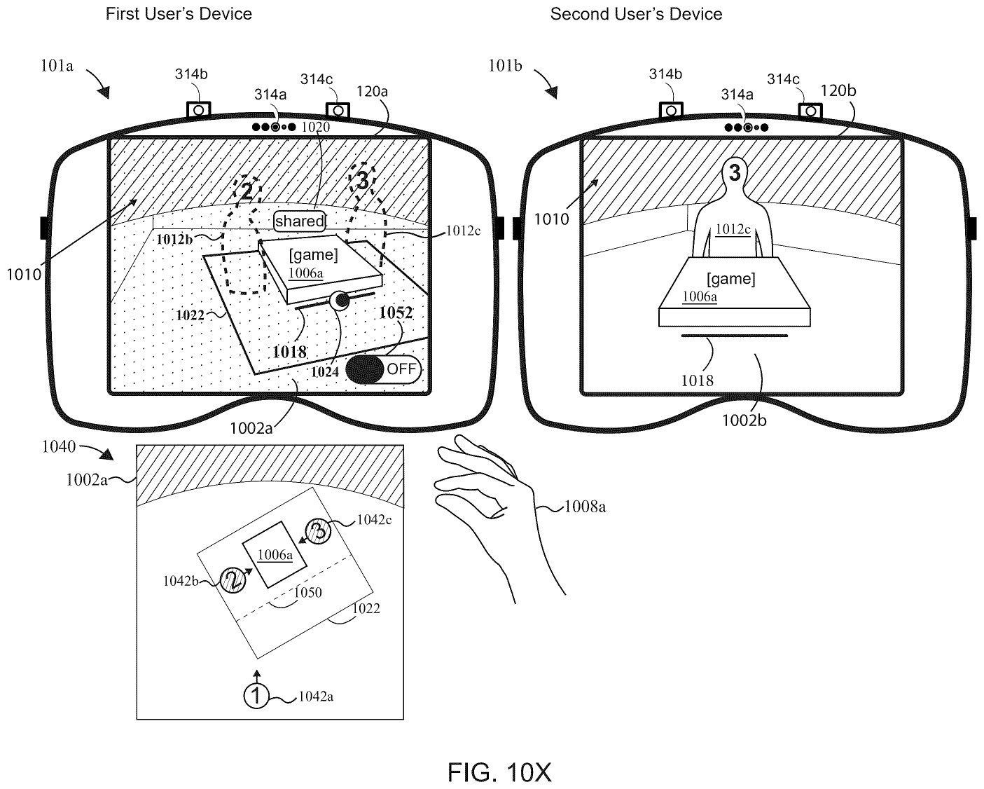

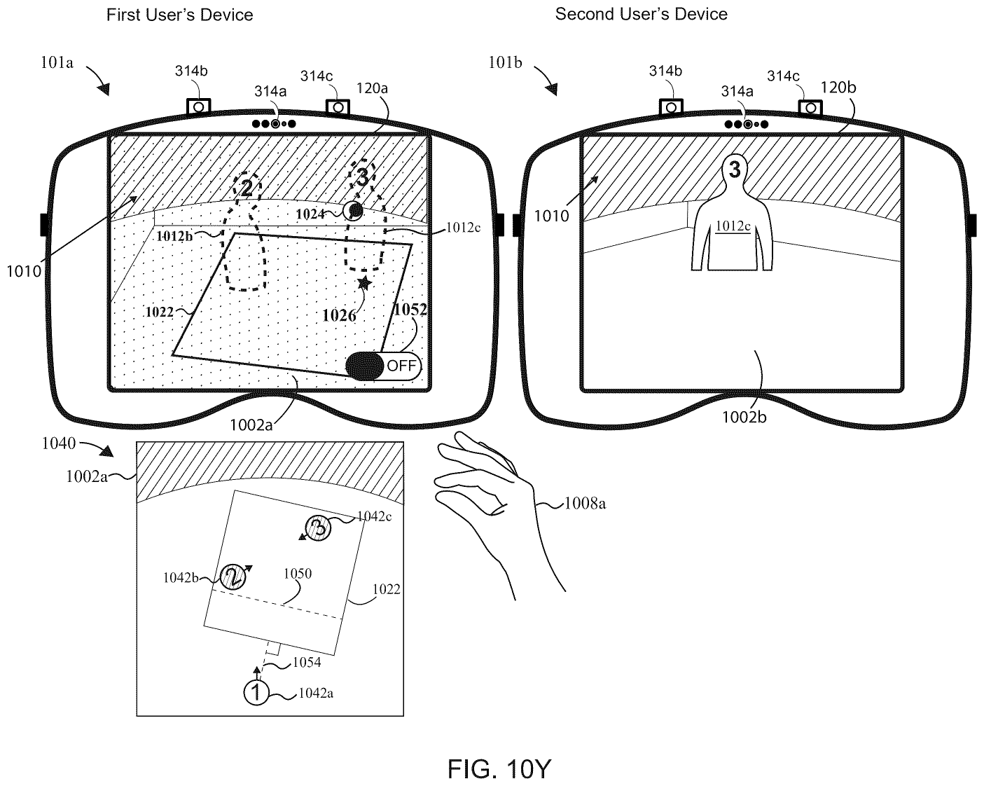

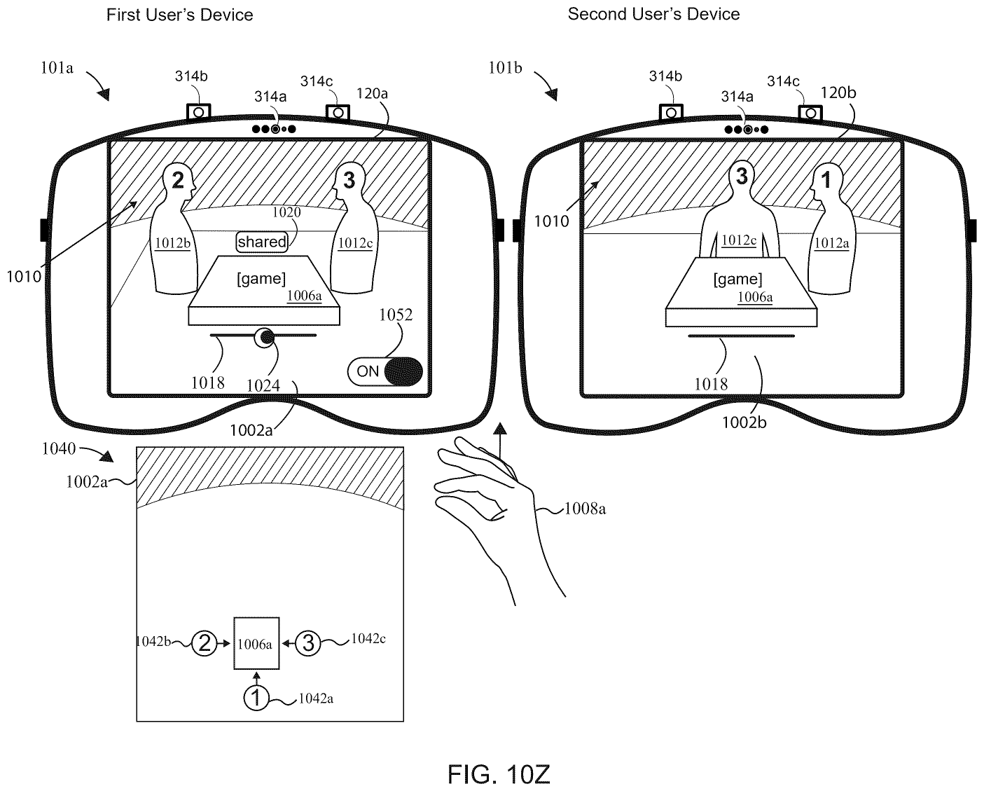

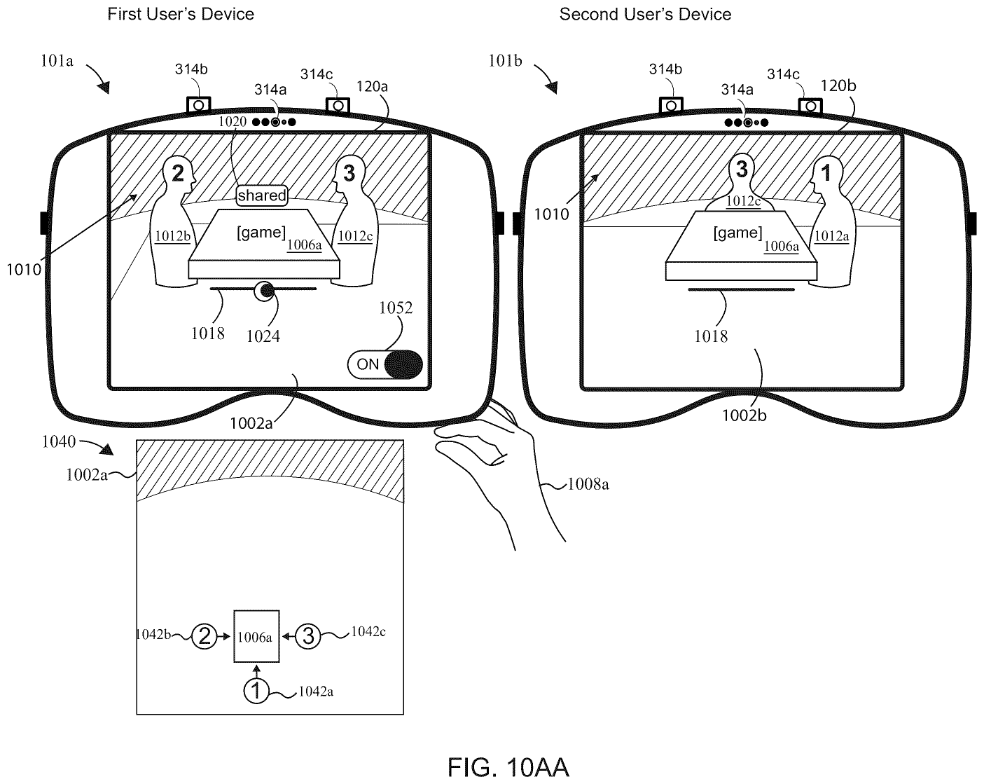

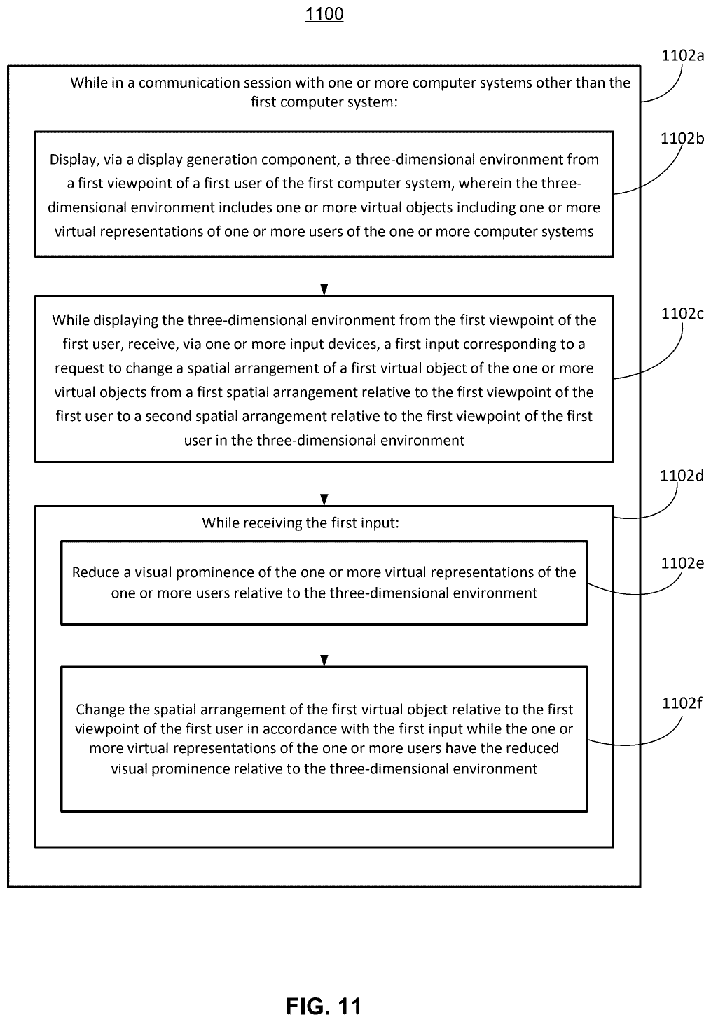

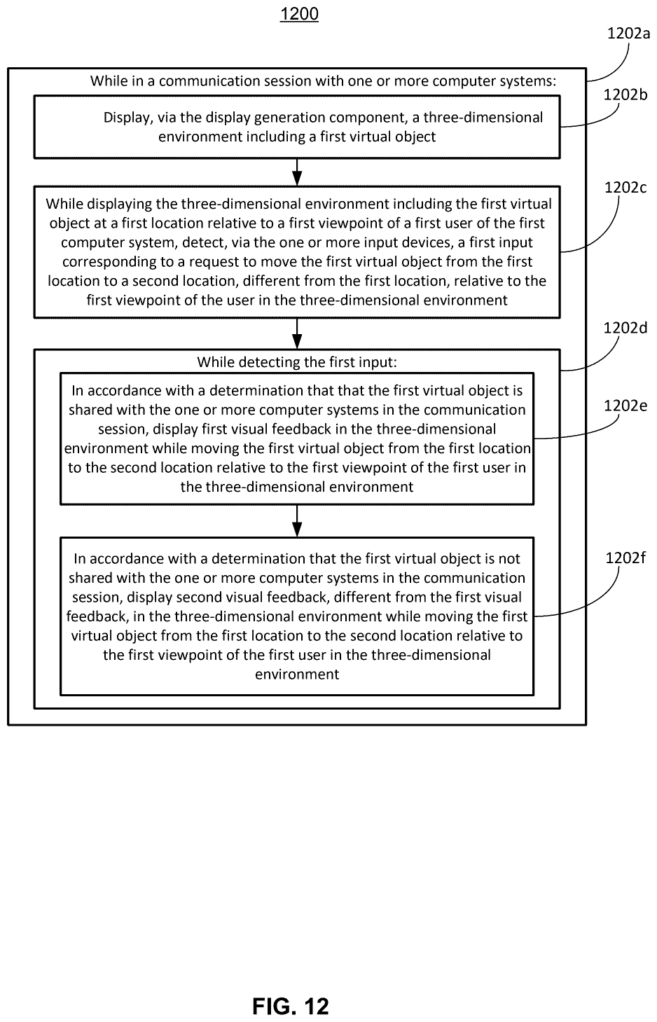

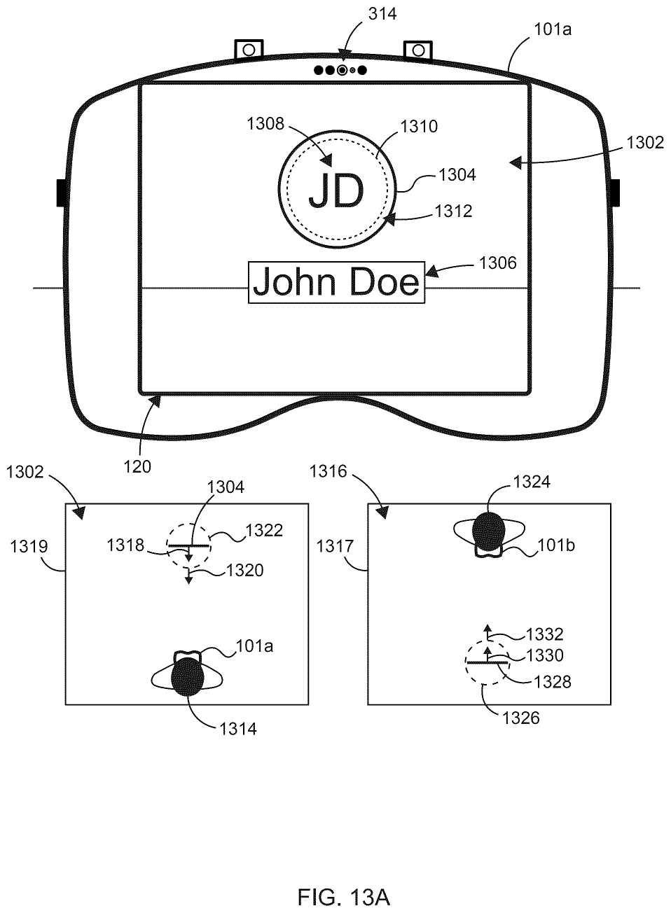

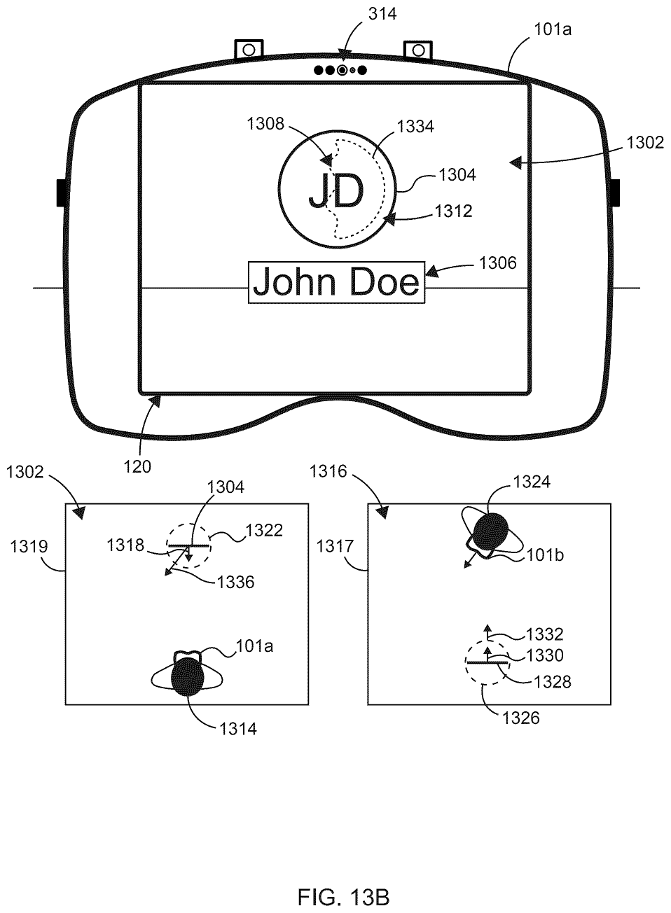

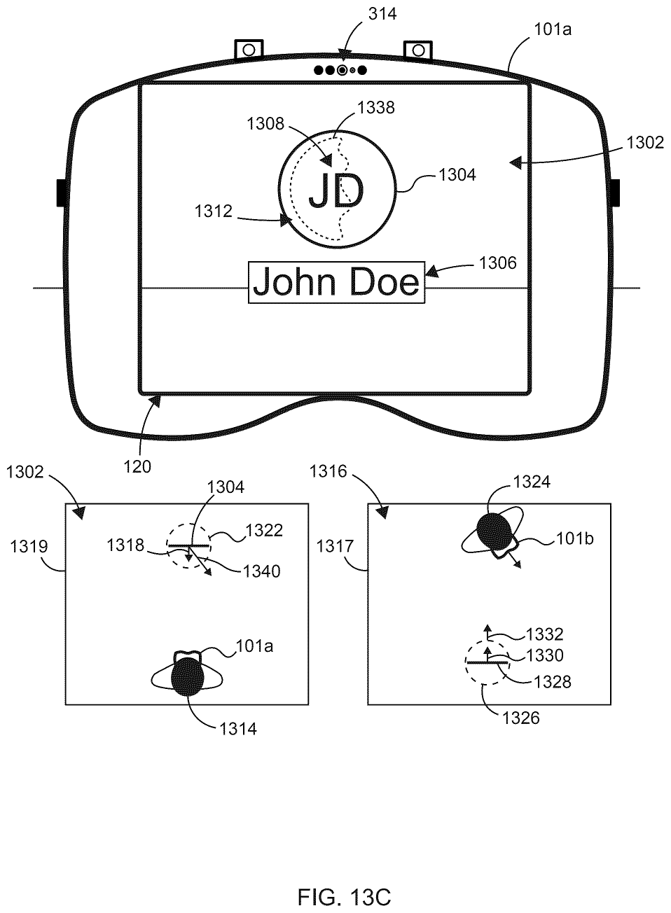

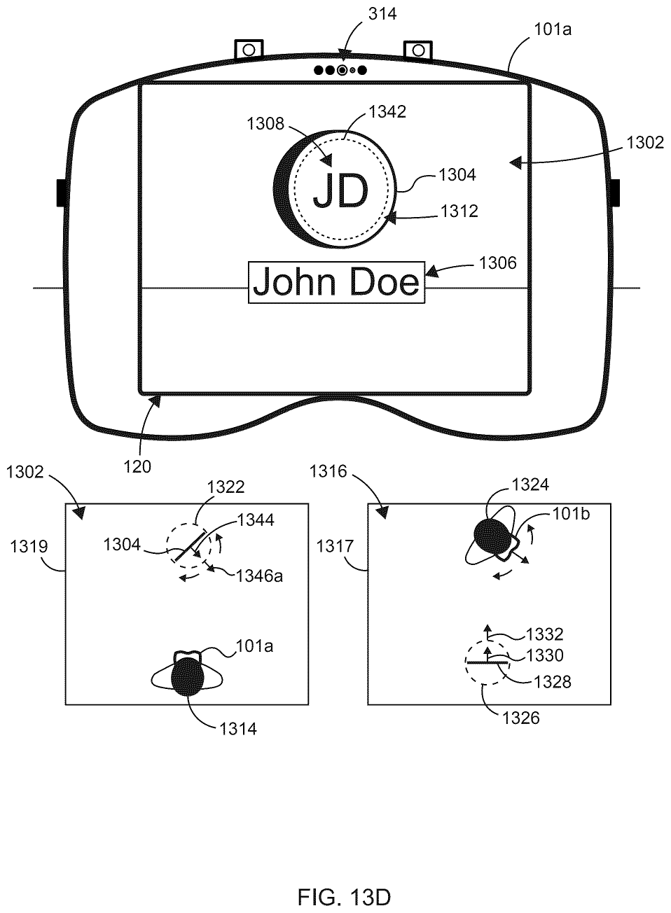

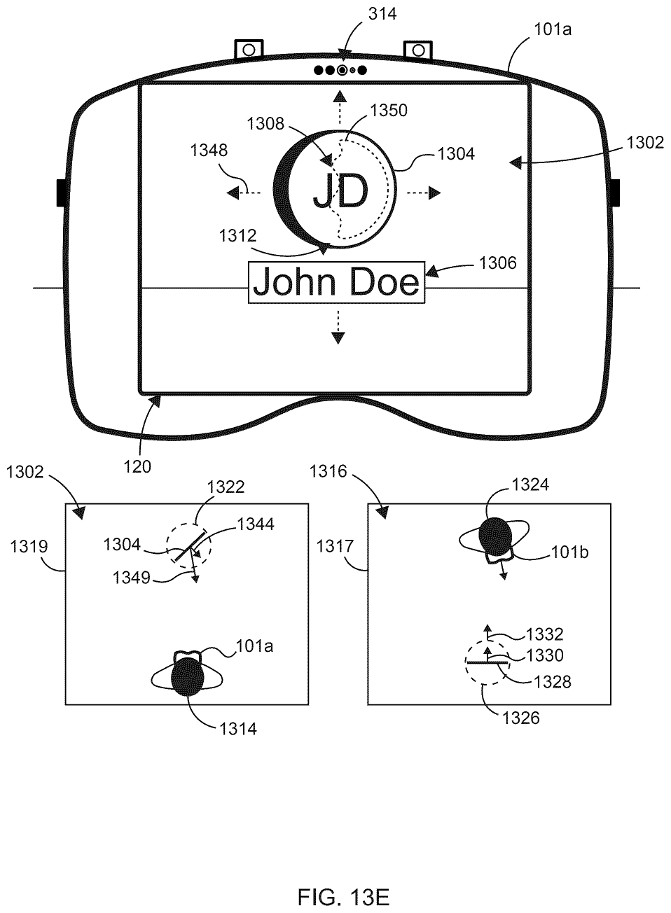

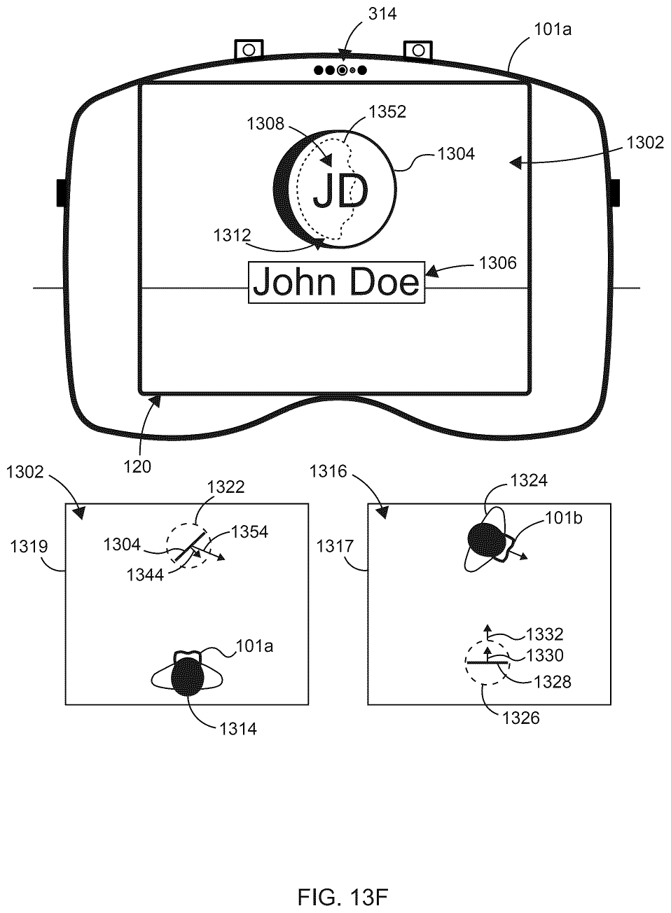

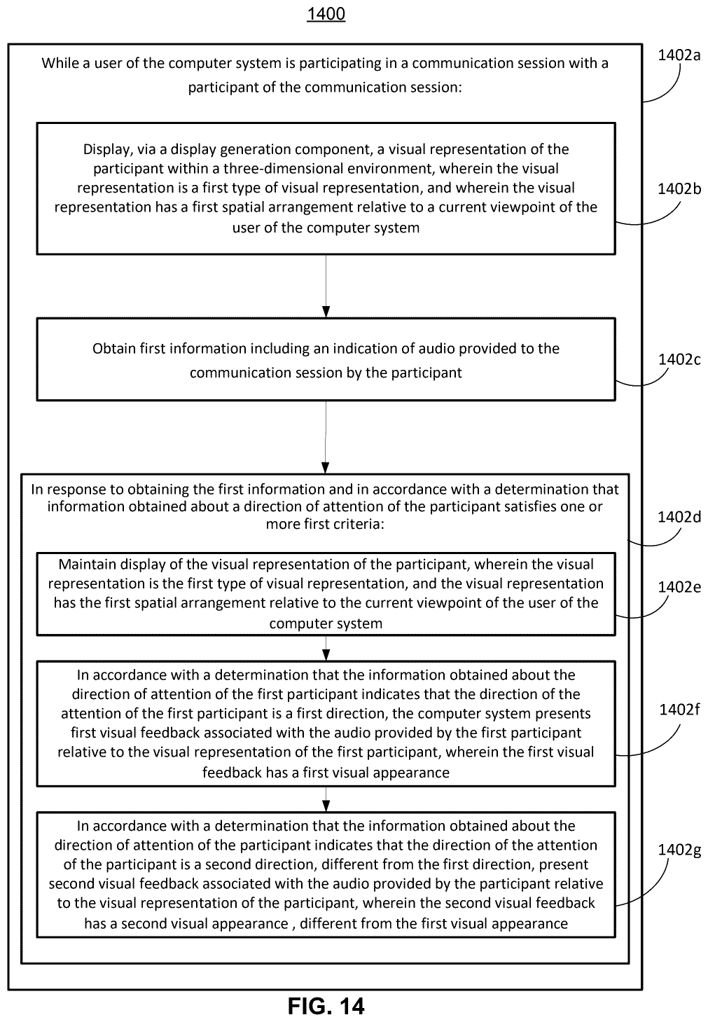

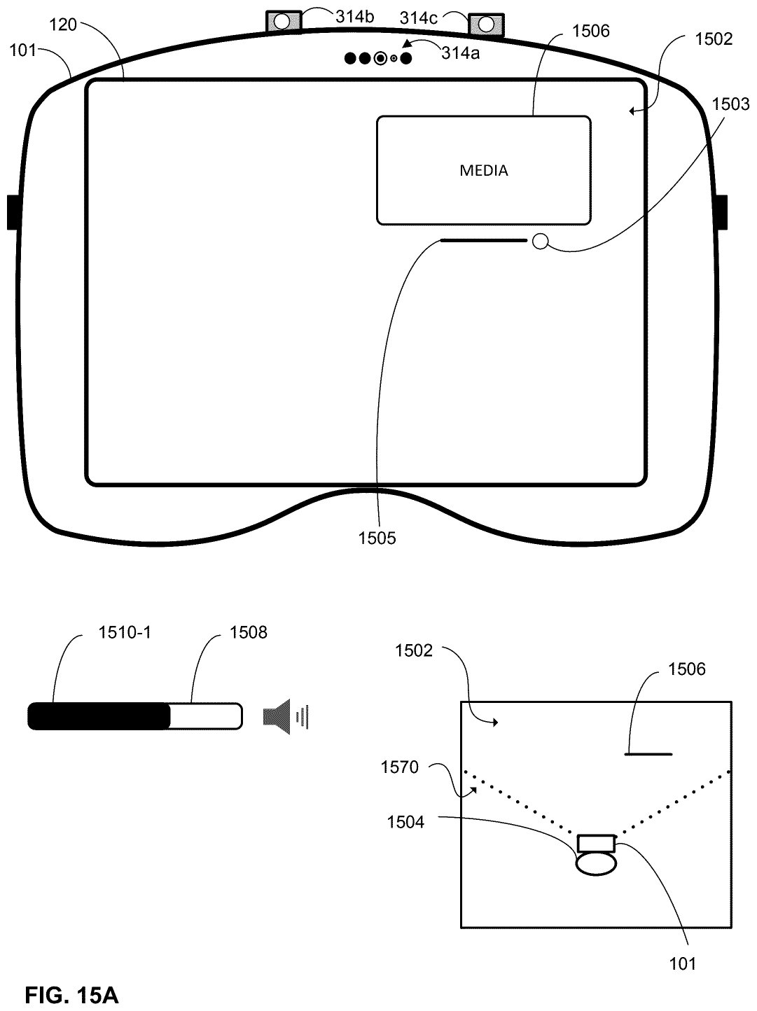

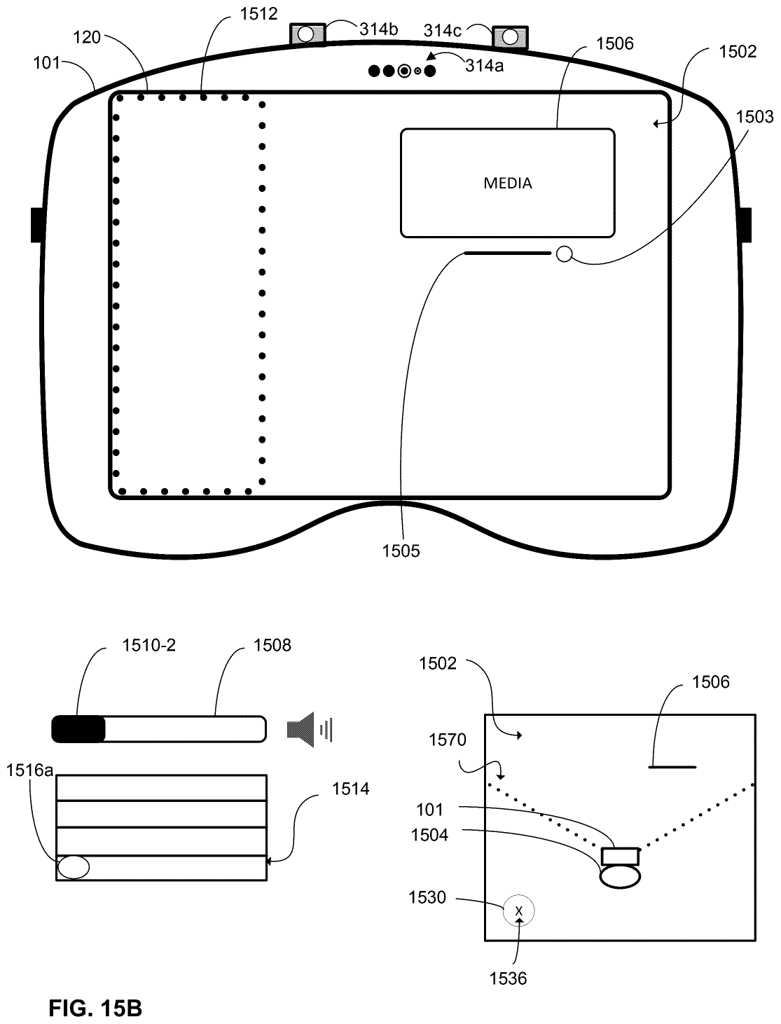

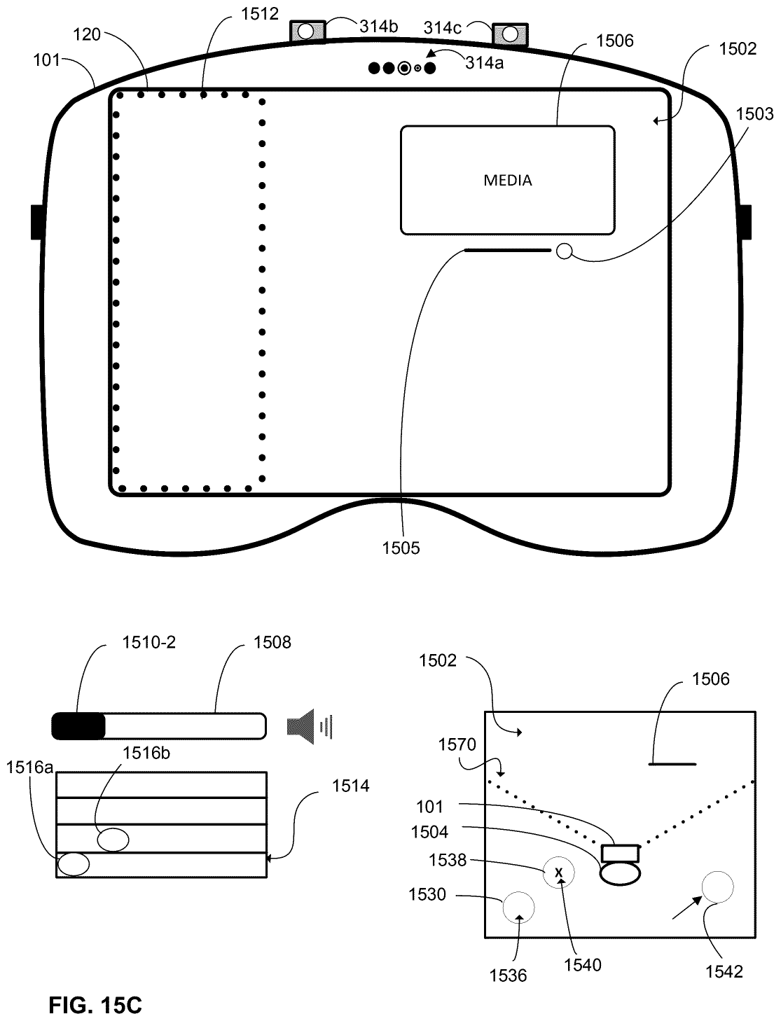

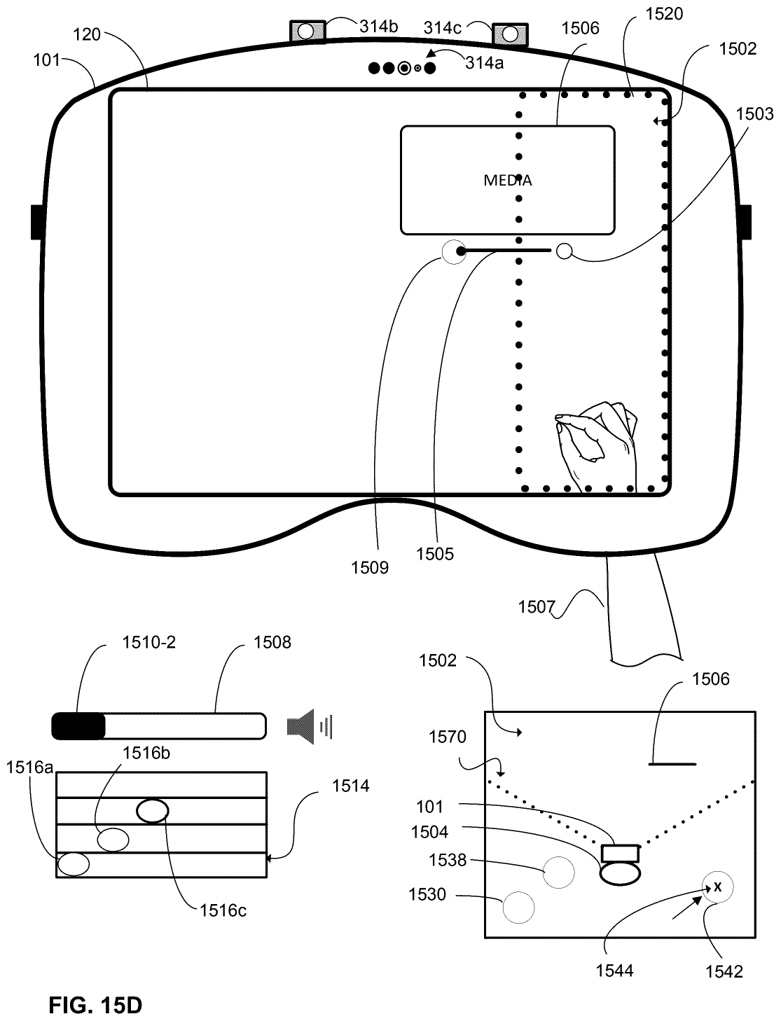

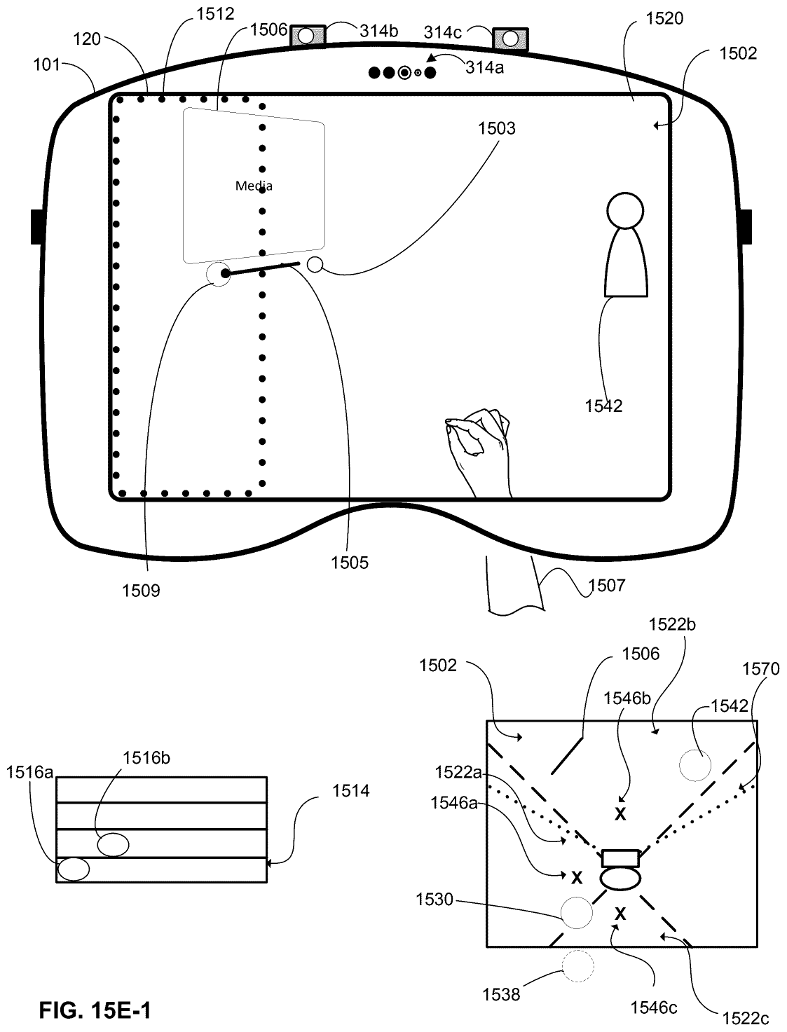

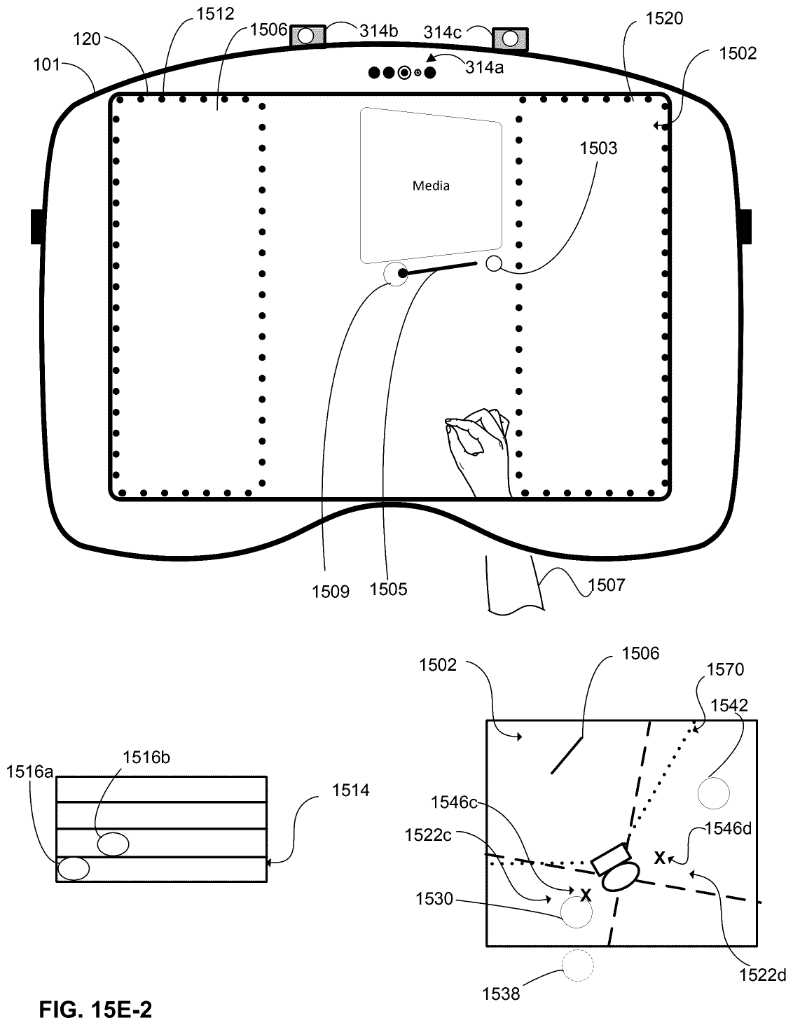

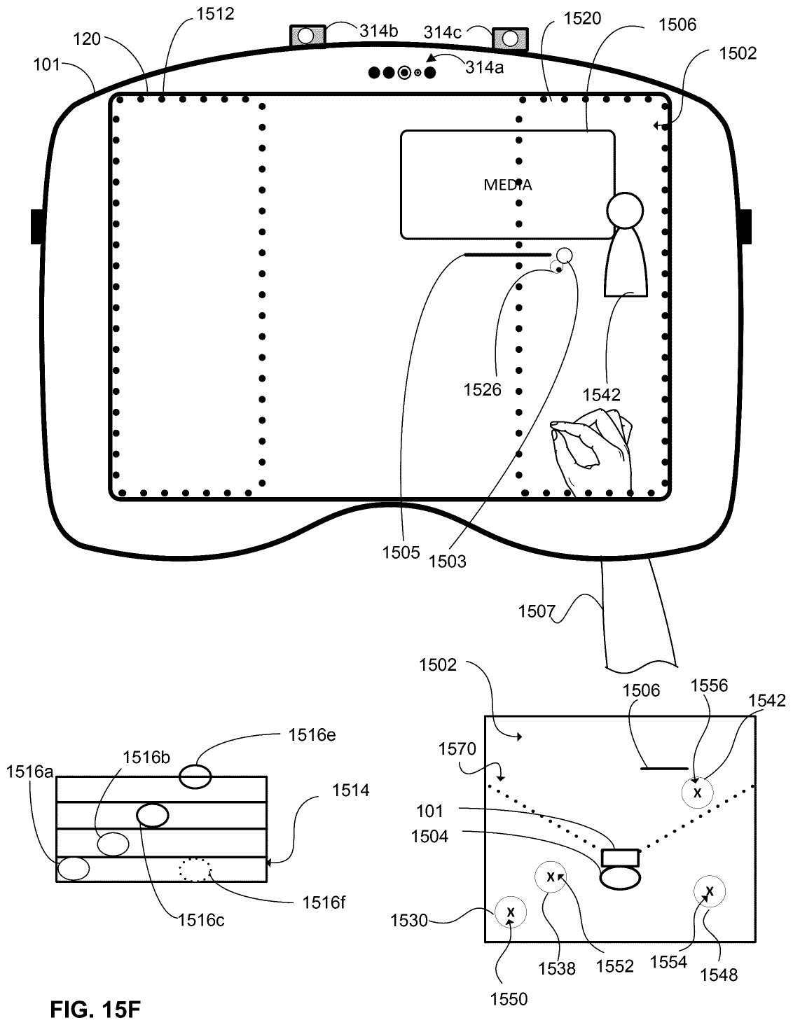

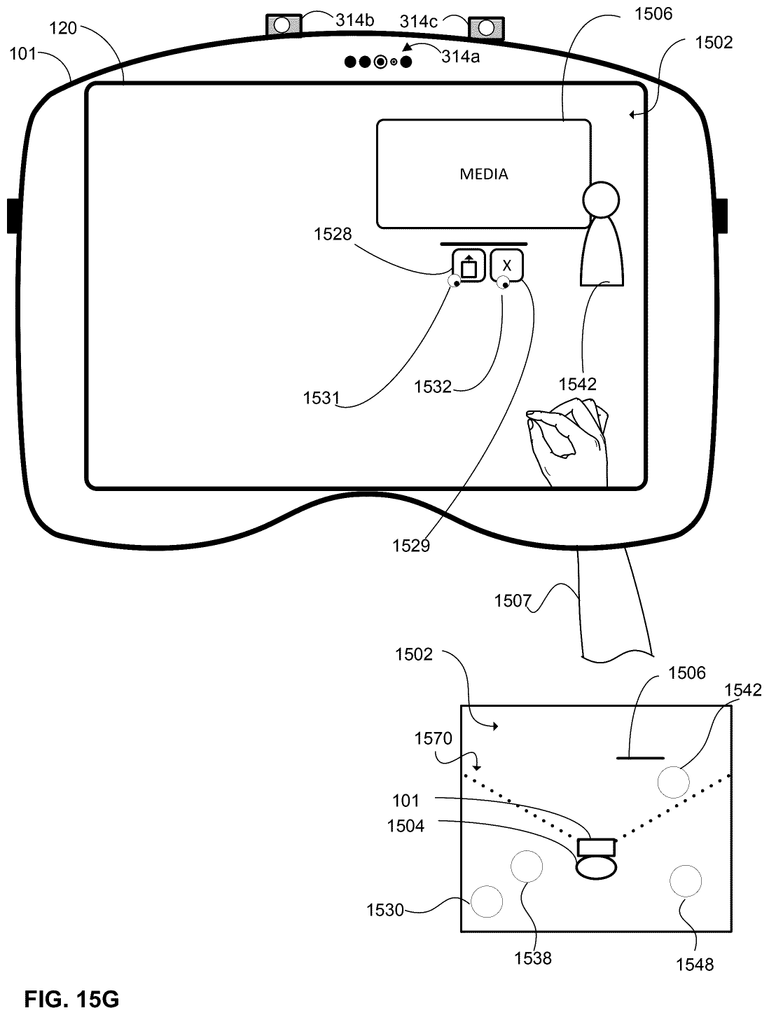

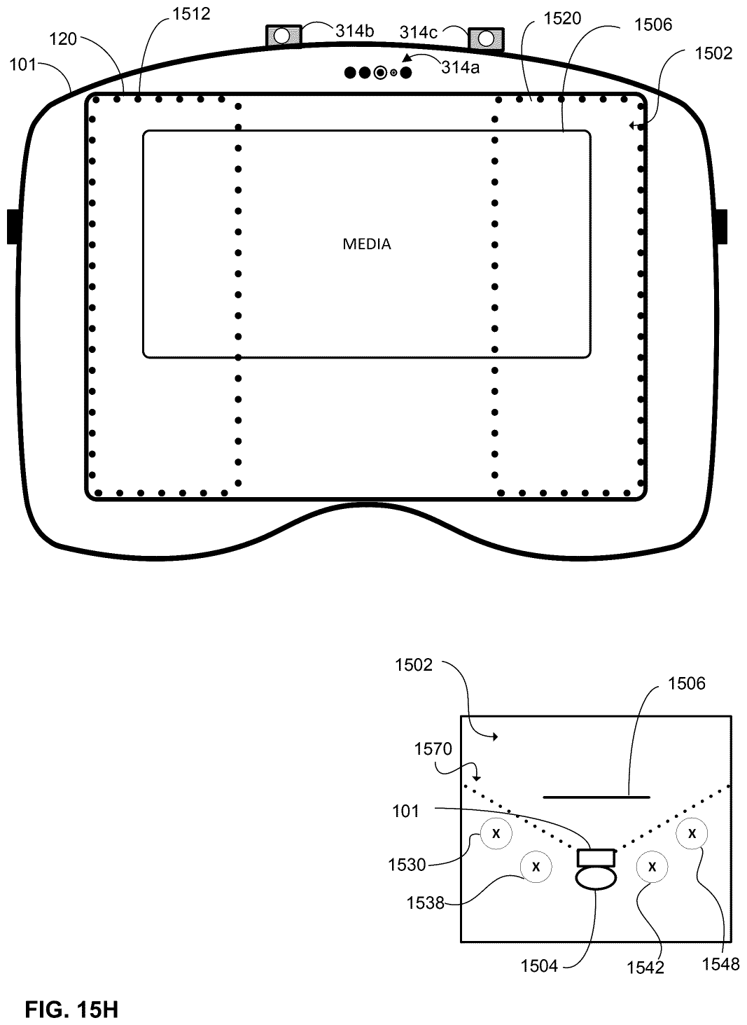

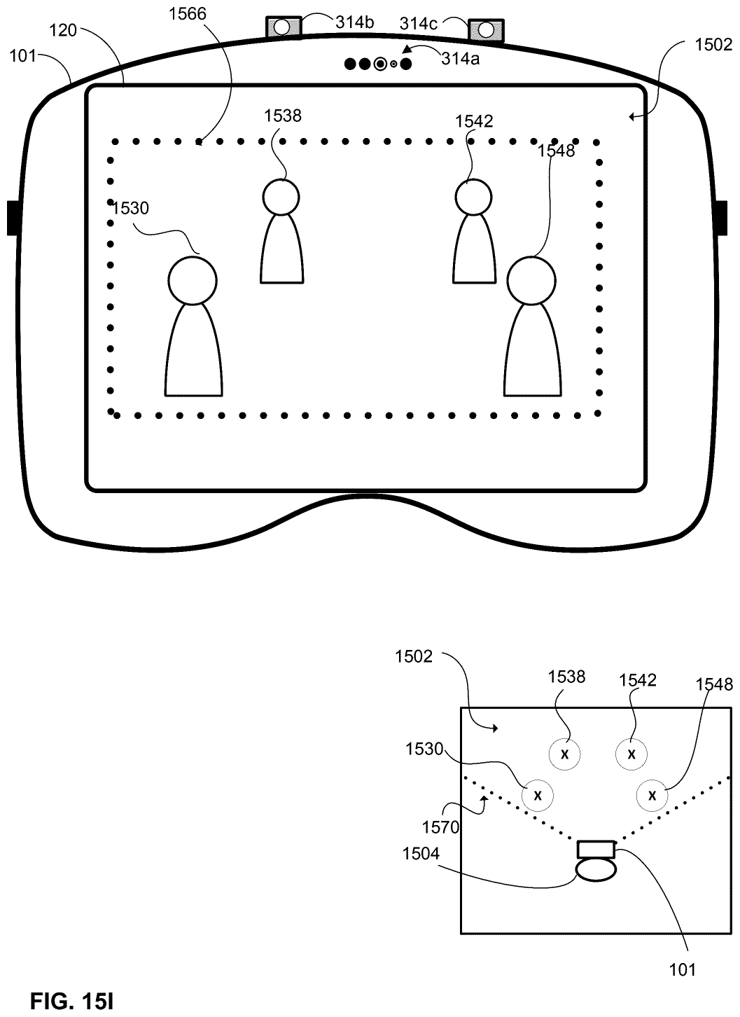

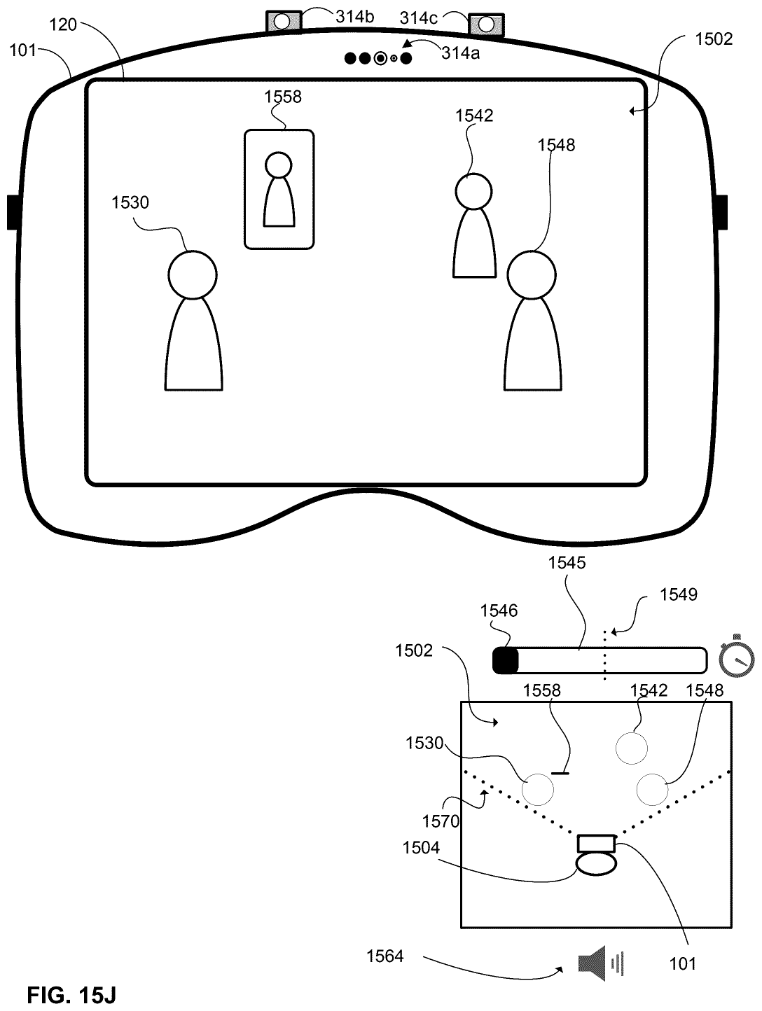

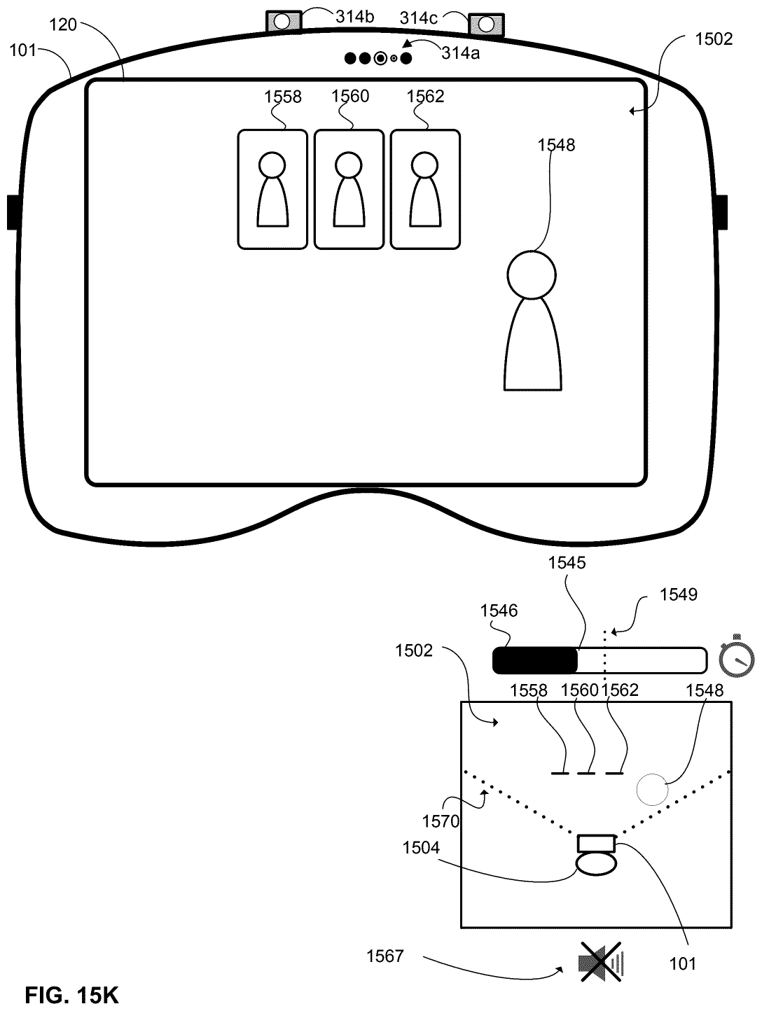

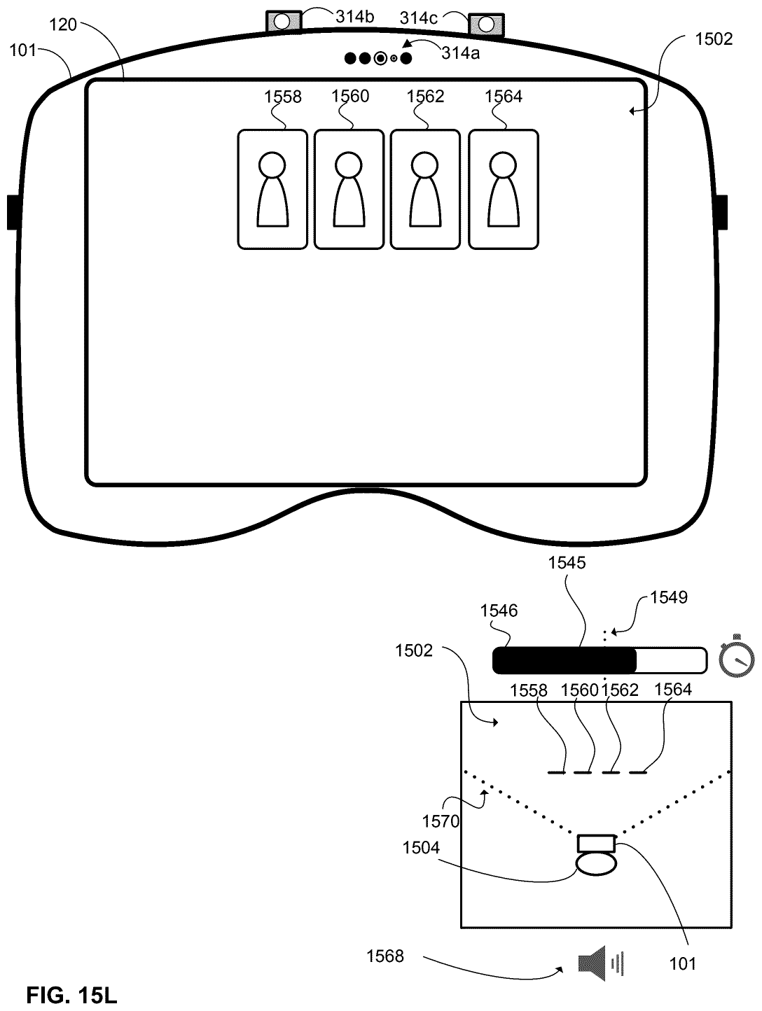

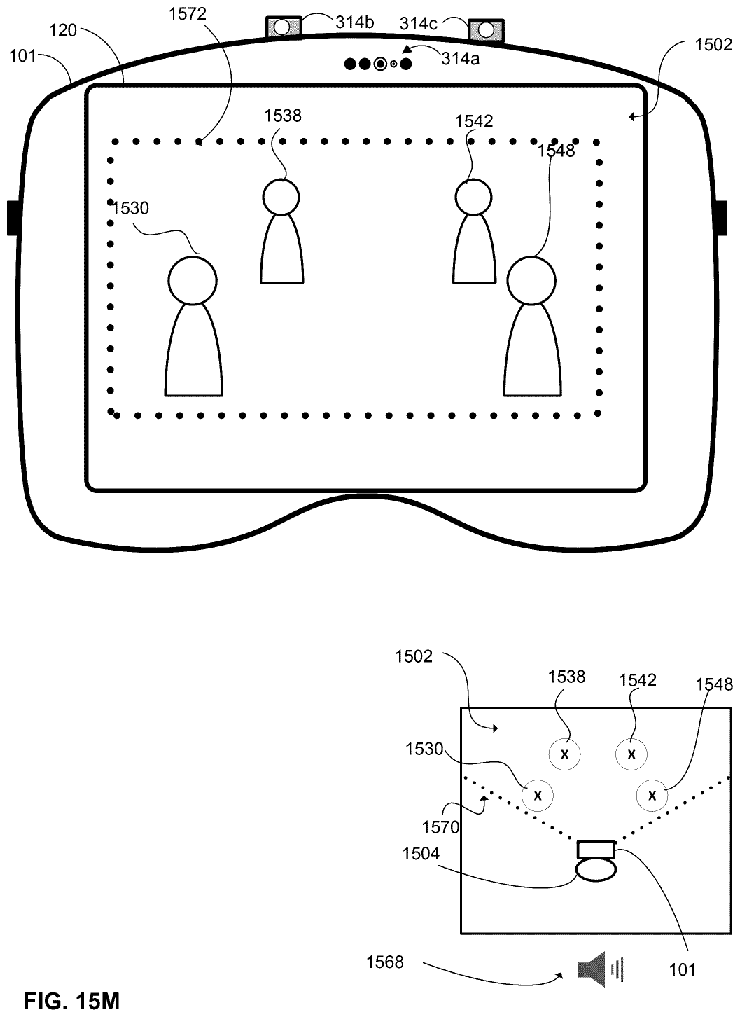

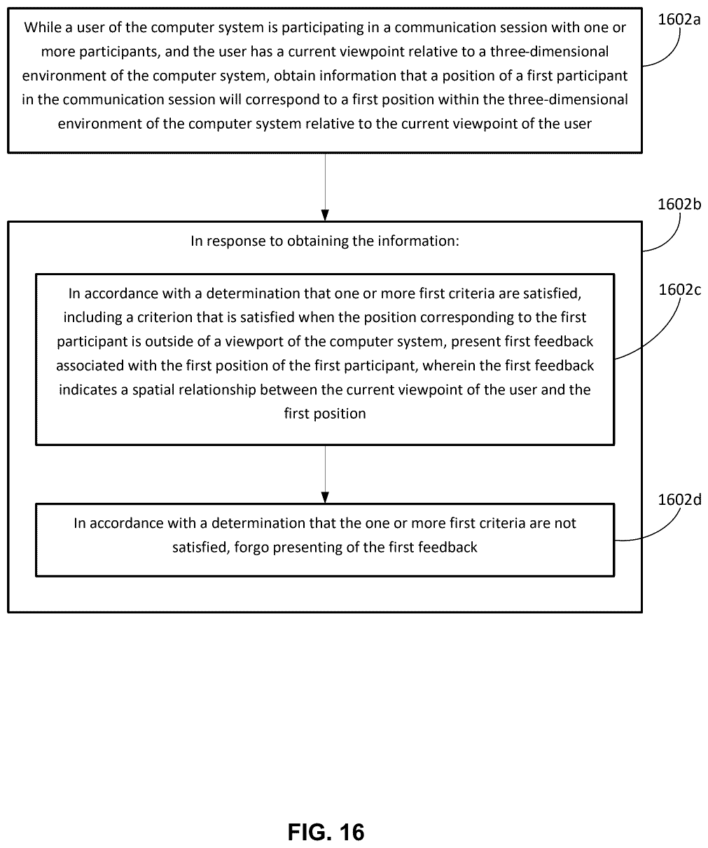

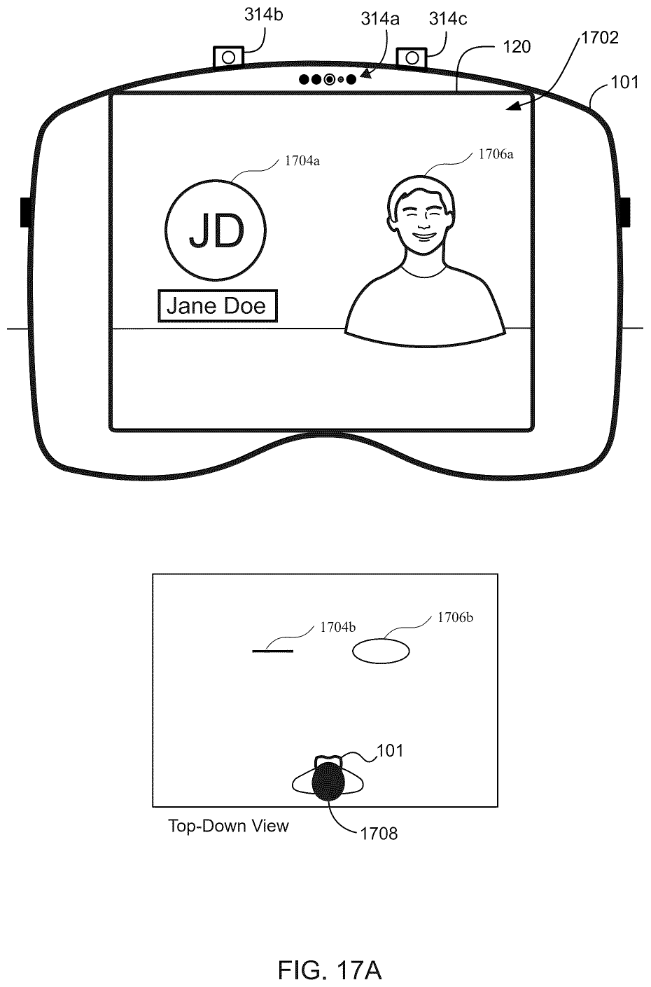

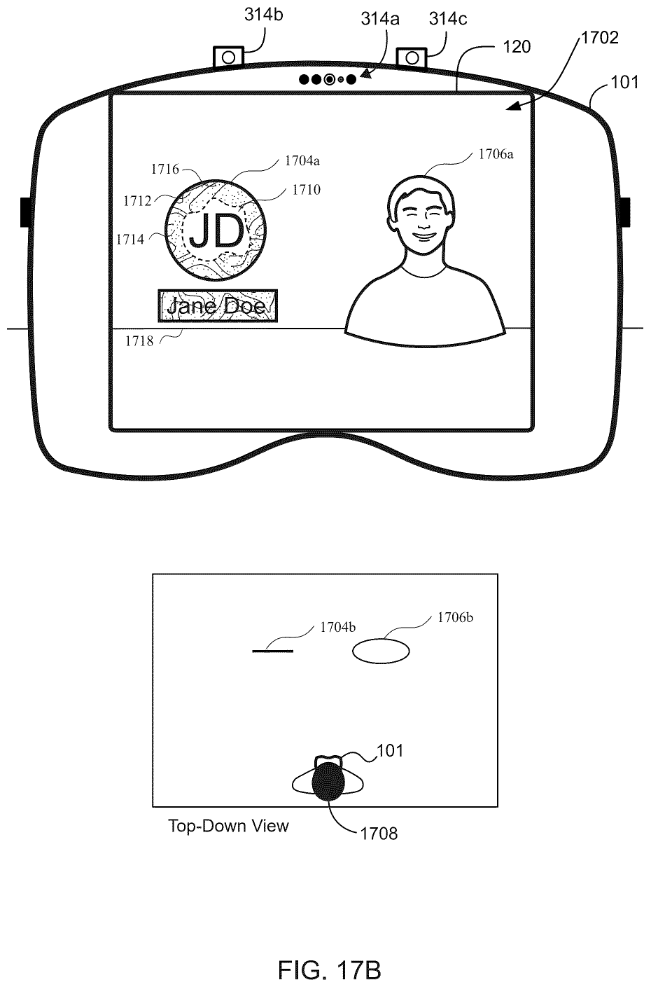

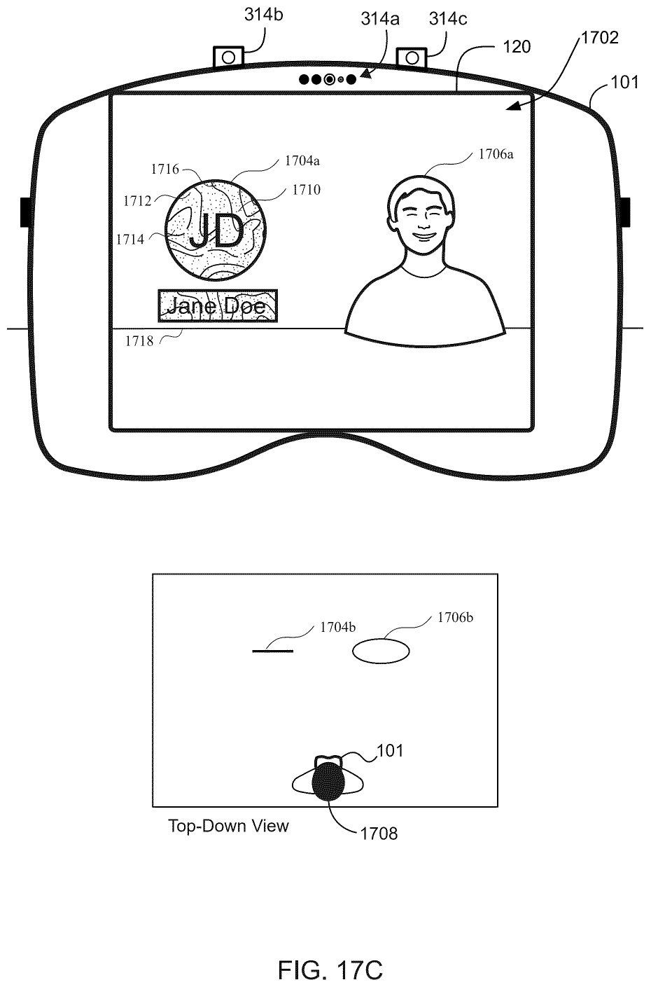

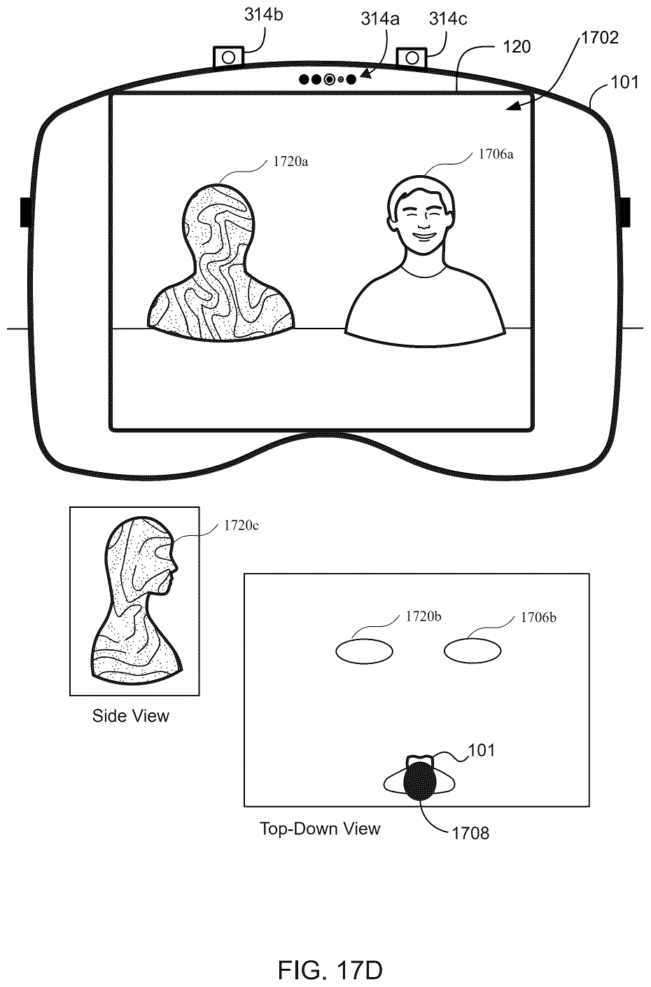

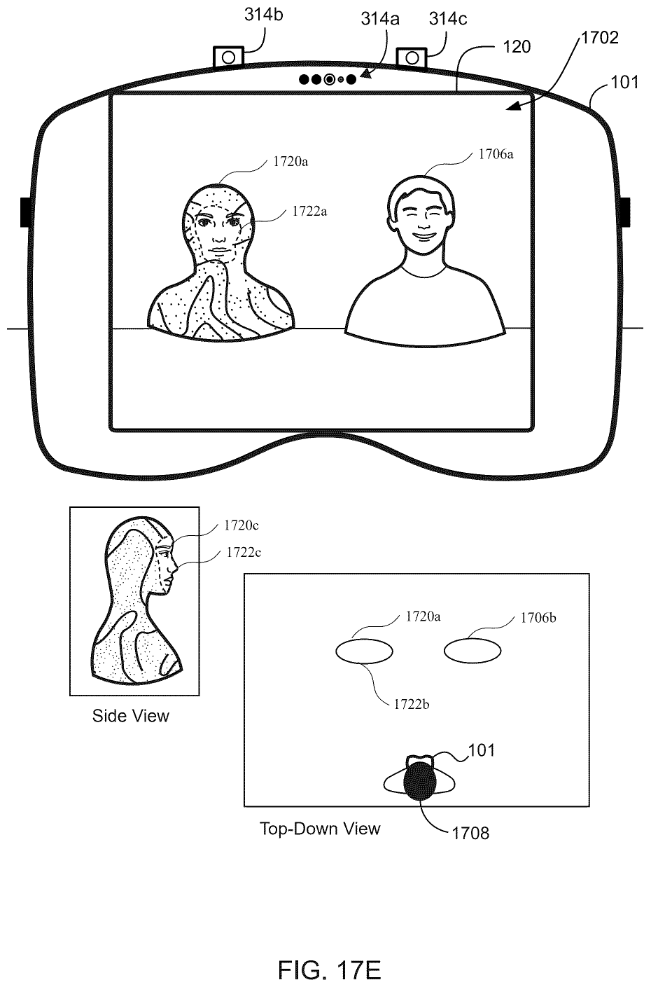

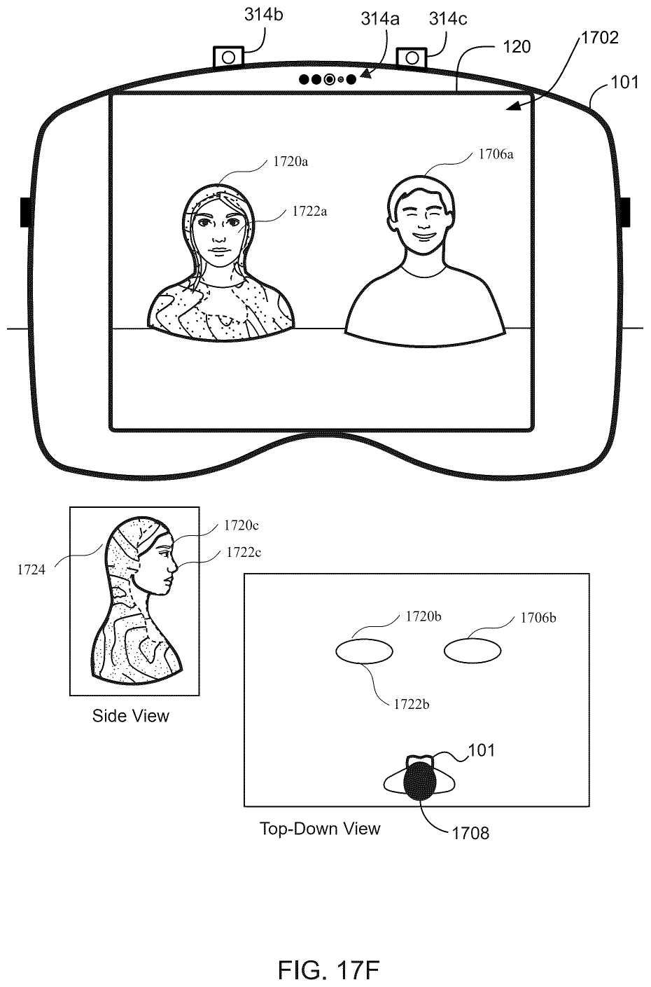

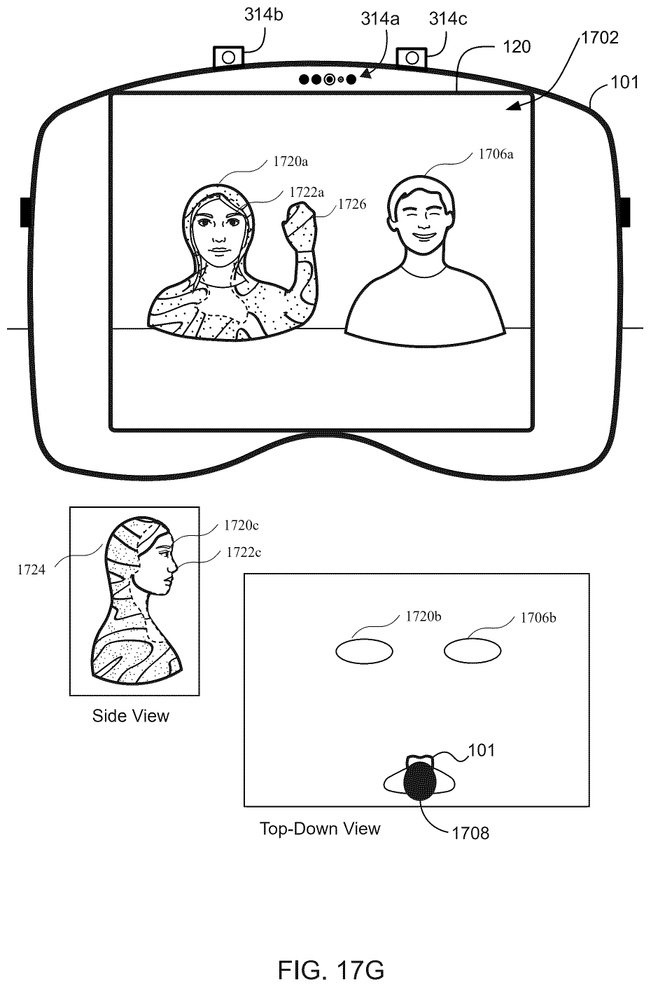

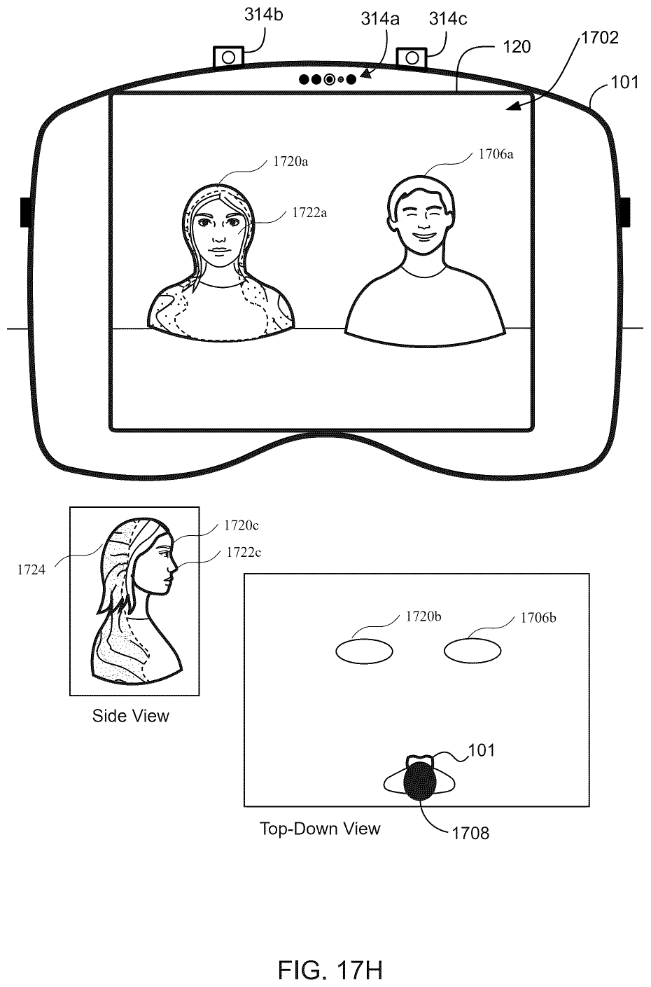

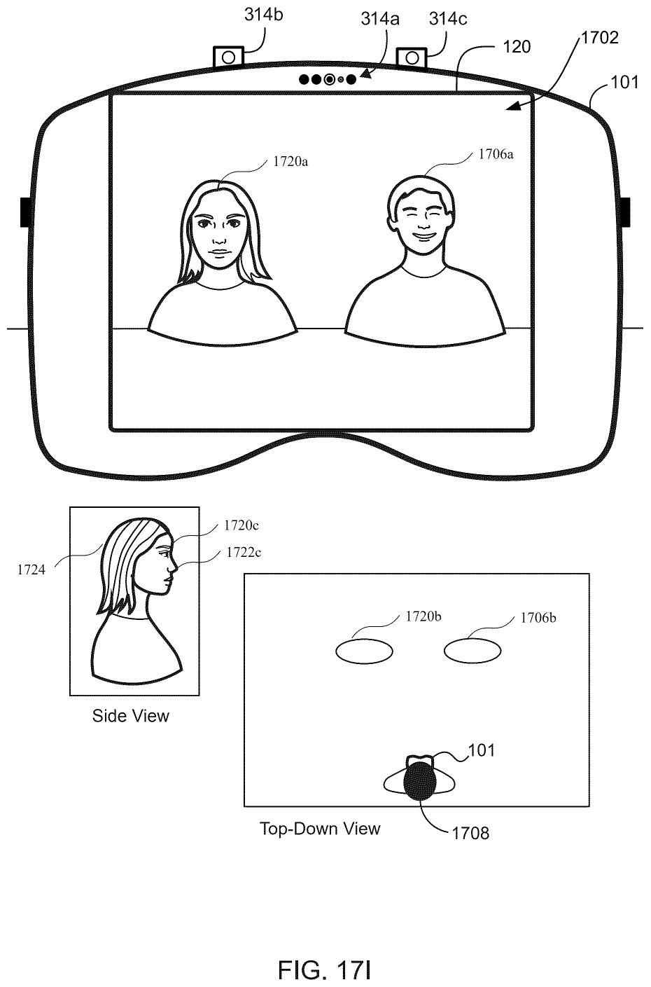

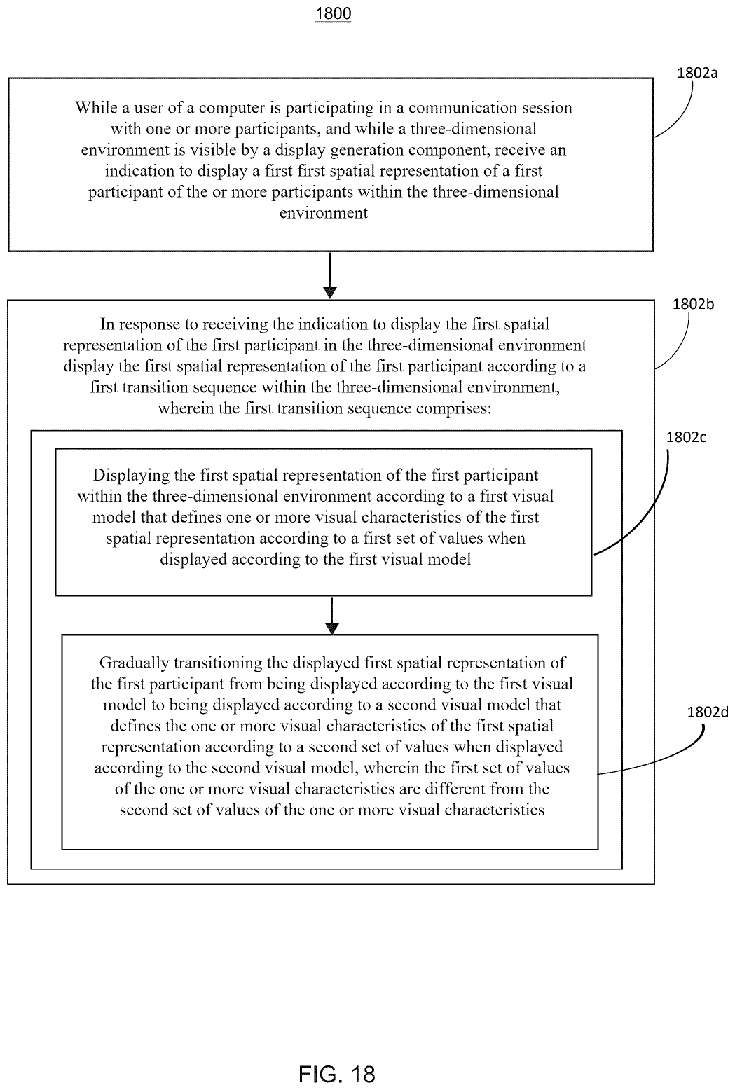

FIGS. 1A-6 provide a description of example computer systems for providing XR experiences to users (such as described below with respect to methods 800, 900, 1100, 1200, 1400, 1600, and/or 1800). FIGS. 7A-7S illustrate example techniques for displaying movement of virtual representations of a user at different poses in response to movement of a current viewpoint of the user, in accordance with some embodiments. FIG. 8 is a flowchart illustrating an exemplary method of displaying a virtual representation of a user at one or more poses in a three-dimensional environment in response to movement of the current viewpoint of the user, in accordance with some embodiments. The user interfaces in FIGS. 7A-7S are used to illustrate the processes in FIG. 8. FIG. 9 is a flowchart illustrating an exemplary method of displaying different representations of movement of a virtual representation based on the virtual representation being a virtual representation of a first type or a virtual representation of a second type, in accordance with some embodiments. The user interfaces in FIGS. 7A-7S are used to illustrate the processes in FIG. 9. FIGS. 10A-10AA illustrate example techniques for changing the spatial arrangement of virtual objects in a three-dimensional environment, in accordance with some embodiments. FIG. 11 is a flowchart illustrating an exemplary method of reducing a visual prominence of one or more virtual representations while changing a spatial arrangement of a virtual object shared in a communication session, in accordance with some embodiments. The user interfaces in FIGS. 10A-10AA are used to illustrate the processes in FIG. 11. FIG. 12 is a flowchart illustrating an exemplary method of displaying different visual feedback while moving a virtual object in accordance with the virtual object being shared or not shared in a communication session, in accordance with some embodiments. The user interfaces in FIGS. 10A-10AA are used to illustrate the processes in FIG. 12. FIGS. 13A-13F illustrate example techniques for providing visual feedback indicating audio provided by a participant of a communication session in accordance with some embodiments. FIG. 14 is a flowchart illustrating an exemplary method of displaying visual feedback indicating audio provided by a participant of a communication session in accordance with some embodiments. The user interfaces in FIGS. 13A-13F are used to illustrate the processes in FIG. 14. FIGS. 15A-15M illustrate examples of a computer system providing feedback indicating spatial positions of communication session participants in accordance with some embodiments. FIG. 16 is a flowchart illustrating an exemplary method of providing feedback indicating spatial positions of communication session participants in accordance with some embodiments. The user interfaces in FIGS. 15A-15M are used to illustrate the processes in FIG. 16. FIGS. 17A-17I illustrate example techniques for visually transitioning in and out spatial representations of participants in a video communication session in accordance with some embodiments. FIG. 18 is a flowchart illustrating an exemplary method of visual transitioning spatial representations of participants in and out of a video communication session in accordance with some embodiments. The user interfaces in FIGS. 17A-17I are used to illustrate the processes in FIG. 18.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

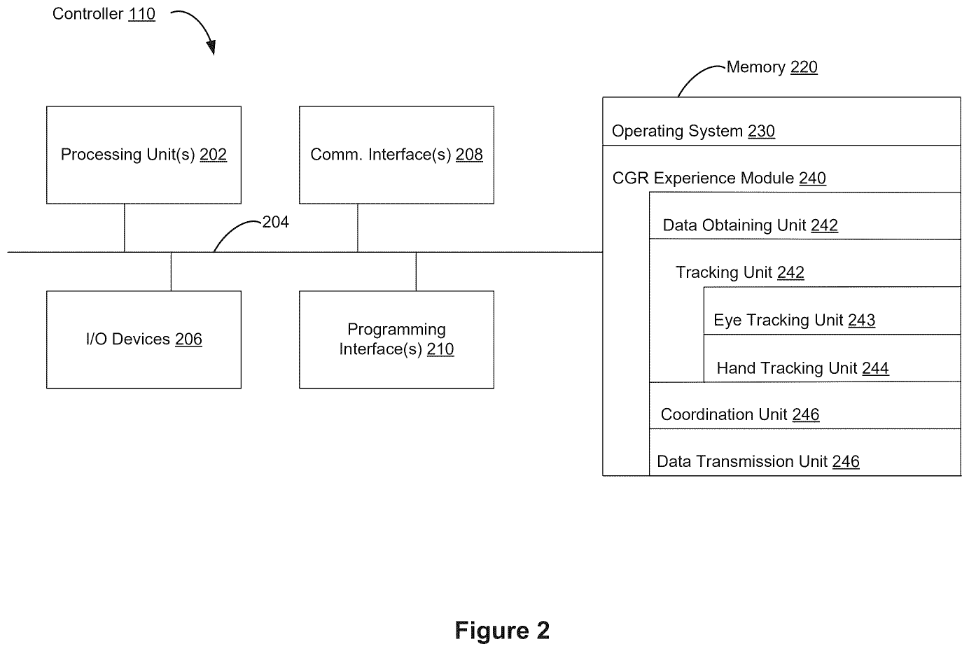

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

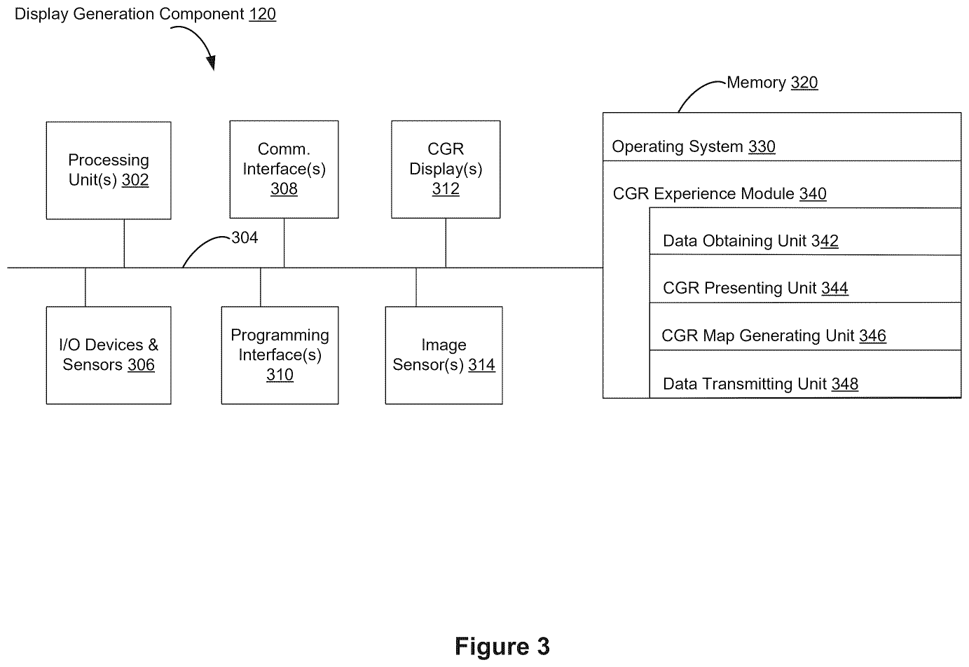

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 11) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, cither alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, cither alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, cither alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-IL and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, cither alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 1I and 1K-1L can be included, cither alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, cither alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, cither alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

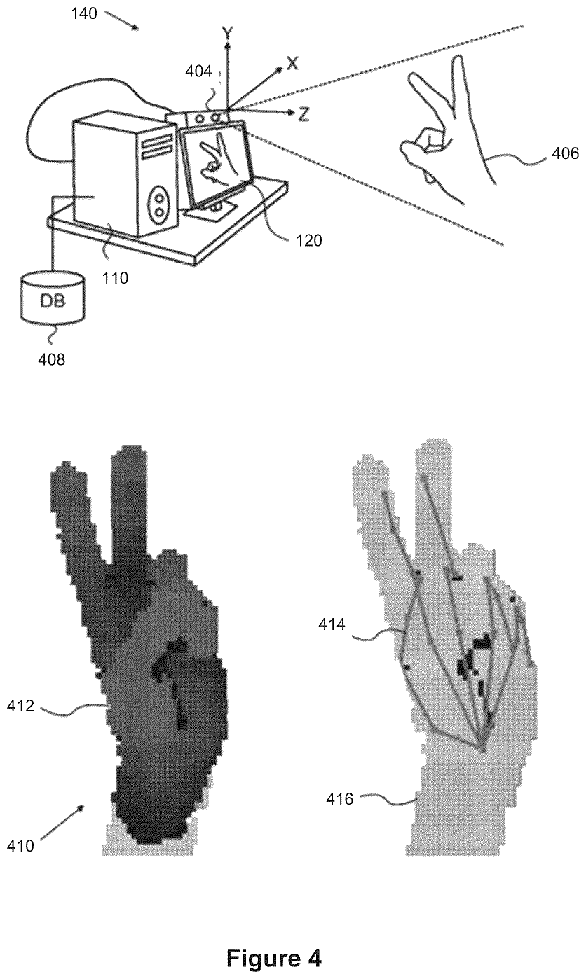

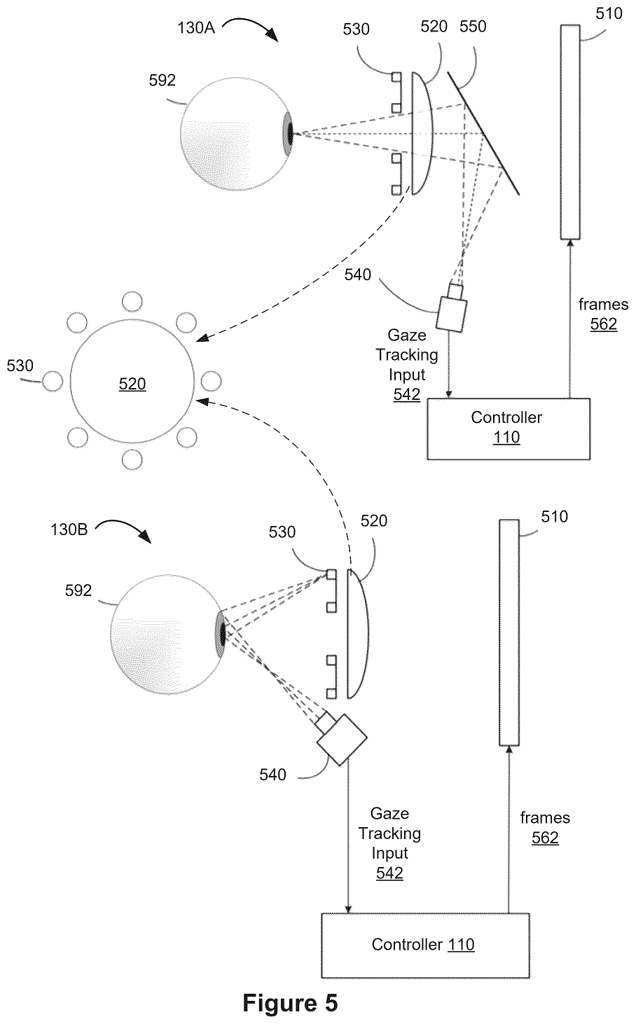

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

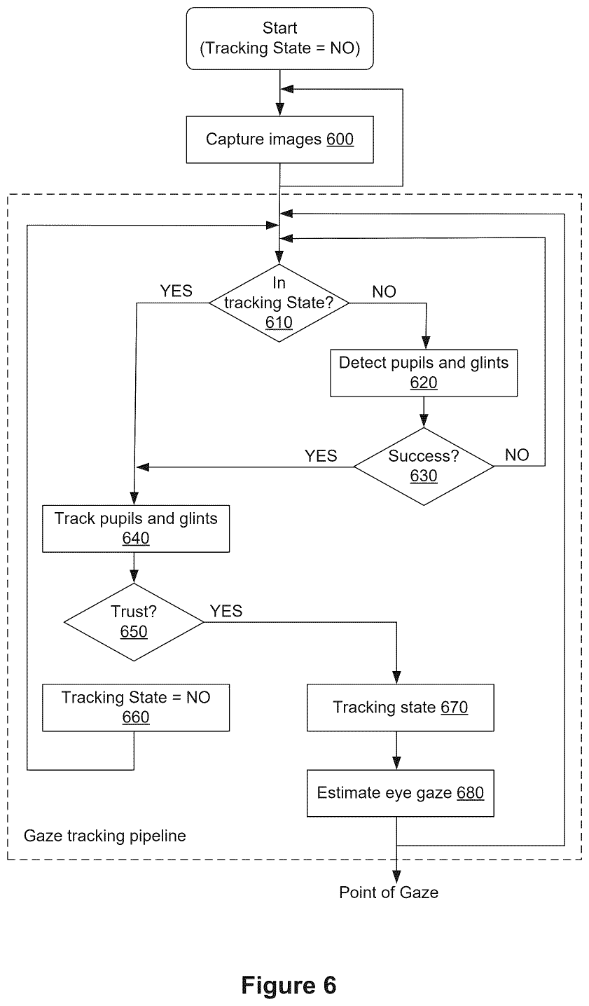

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7S illustrate examples of a first computer system displaying a virtual representation of a pose of a current viewpoint of a user of a second computer system in communication with the first computer system at a plurality of poses in a three-dimensional environment in response to movement of the current viewpoint of the user. FIGS. 7A-7S illustrate examples of the first computer system displaying different representations of movement of the virtual representation based on the virtual representation being a virtual representation of a first type or a virtual representation of a second type.

FIG. 7A illustrates a first computer system (e.g., an electronic device) 101 displaying, via a display generation component (e.g., display generation component 120 of FIG. 1), a three-dimensional environment 702 from a viewpoint of a first user (e.g., user 708a) of the first computer system 101 (e.g., facing the back wall of the physical environment in which first computer system 101 is located). In some embodiments, first computer system 101 includes a display generation component (e.g., a touch screen) and a plurality of image sensors (e.g., image sensors 314 of FIG. 3). The image sensors optionally include one or more of a visible light cameras, an infrared camera, a depth sensor, or any other sensor the first computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

FIGS. 7A-7S illustrate alternative views (e.g., first alternative view 730a and second alternative view 730b) of a three-dimensional environment 702 displayed by first computer system 101. In some embodiments, first alternative view 730a and second alternative view 730b of three-dimensional environment 702 include alternative types of virtual representations of one or more users of one or more computer systems in a communication session with first computer system 101 (e.g., the communication session has one or more characteristics of the communication session described with reference to methods 800 and/or 900). In some embodiments, first alternative view 730a and second alternative view 730b of three-dimensional environment 702 in FIGS. 7A-7S include alternative representations of movement of a virtual representation of a user of a second computer system in the communication session with first computer system 101 in response to movement of a current viewpoint of the user of the second computer system relative to three-dimensional environment 702.

FIGS. 7A-7M show an overhead view 706 of three-dimensional environment 702. As shown in overhead view 706, three-dimensional environment 702 is a shared environment between a first user 708a of first computer system 101 and a second user 708b of the second computer system in communication with first computer system 101. For example, first user 708a views three-dimensional environment 702 from a first perspective (e.g., from a first viewpoint relative to three-dimensional environment 702), and second user 708b views three-dimensional environment 702 from a second perspective (e.g., from a second viewpoint relative to three-dimensional environment 702). In some embodiments, three-dimensional environment 702 is shared between first computer system 101 and the second computer system in the communication session. For example, first computer system 101 displays, from the current viewpoint of first user 708a, a first version of three-dimensional environment 702 and the second computer system displays, from the current viewpoint of second user 708b, a second version of three-dimensional environment 702 (e.g., first user 708a and second user 708b view and/or interact with the same shared three-dimensional environment while in the communication session (e.g., including one or more virtual objects displayed in the three-dimensional environment that are shared in the communication session). In overhead view 706, the location of first user 708a corresponds to a location of the current viewpoint of first user 708a relative to three-dimensional environment 702. Overhead view 706 further shows a representation of an orientation 710a of the current viewpoint of first user 708a relative to three-dimensional environment 702 (e.g., orientation 710 is represented by an arrow (e.g., illustrating a direction of the current viewpoint of first user 708a relative to three-dimensional environment 702)). In overhead view 706, the location of second user 708b corresponds to a location of the current viewpoint of second user 708b relative to three-dimensional environment 702. Overhead view 706 further shows a representation of an orientation 710b of the current viewpoint of second user 708b relative to three-dimensional environment 702 (e.g., orientation 710b is represented by an arrow (e.g., illustrating a direction of the current viewpoint of second user 708b relative to three-dimensional environment 702)).

FIG. 7A illustrates first computer system 101 displaying a virtual representation 704a of user 708b in three-dimensional environment 702 (e.g., from both first alternative view 730a and second alternative view 730b). In some embodiments, the user interfaces illustrated in FIG. 7A and described below are implemented on a head-mounted display that displays three-dimensional environment 702 (e.g., as an AR, VR, MR, XR or AR environment) to first user 708a. As shown in FIG. 7A, the alternative views of three-dimensional environment 702 include a same type of virtual representation of second user 708b. In some embodiments, virtual representation 704a is an avatar (e.g., including one or more characteristics of a virtual representation of the second type as described with reference to method 900). Virtual representation 704a is displayed at a spatial arrangement (e.g., location and/or orientation) in three-dimensional environment 702 (e.g., from the current viewpoint of first user 708a) corresponding to a pose (e.g., corresponding to the location and/or orientation) of the current viewpoint of second user 708b relative to three-dimensional environment 702.

FIG. 7B illustrates, in first alternative view 730a of three-dimensional environment 702, first computer system 101 displaying a virtual representation 704b of second user 708b in three-dimensional environment 702 in response to virtual representation change criteria being satisfied. In some embodiments, the user interfaces illustrated in FIG. 7B and described below are implemented on a head-mounted display that displays three-dimensional environment 702 (e.g., as an AR, VR, MR, XR or AR environment) to first user 708a. In some embodiments, the location and/or orientation of virtual representation 704b of second user 708b corresponds to a current pose of the current viewpoint of second user 708b relative to three-dimensional environment 702 (e.g., virtual representation 704b is an alternative representation of the current pose of the current viewpoint of second user 708b compared to virtual representation 704a). In second alternative view 730b, the virtual representation change criteria is not satisfied, and first computer system 101 continues to display virtual representation 704a of user 708b. In some embodiments, virtual representation 704b is a representation of user 704a different from an avatar. In some embodiments, virtual representation 704b includes one or more characteristics of the first virtual object described with reference to method 800 and/or the virtual representation of the first type as described with reference to method 900. In some embodiments, virtual representation 704b is displayed as a three-dimensional shape in three-dimensional environment 702 (e.g., including one or more shapes as described with reference to method 800). In some embodiments, virtual representation 704b includes one or more surfaces (e.g., a first surface and/or a second surface as described with reference to method 800). As shown in FIG. 7B, a first surface 732a of virtual representation 704b (e.g., including one or more characteristics of the first surface of first virtual object as described with reference to method 800) is displayed directed toward the current viewpoint of first user 708a (e.g., first surface 732a corresponds to a front surface of virtual representation 704b because, as shown in overhead view 706, the current viewpoint of second user 708b is directed (e.g., oriented) toward the current viewpoint of first user 708a). In first alternative view 730a, first surface 732a is displayed with an identifier of second user 708b (e.g., the initials “JD”). In some embodiments, the identifier of second user 708b displayed on first surface 732a includes one or more characteristics of the identifier of the second user displayed on the first surface of first virtual object as described with reference to method 800.

As shown in FIG. 7B, virtual representation 704b is displayed concurrently with an indication 718. In some embodiments, indication 718 includes one or more characteristics of the indication corresponding to an identifier of the second user as described with reference to method 800. As shown in FIG. 7B, indication 718 includes a name of second user 708b (e.g., “John Doe”). In some embodiments, the name included in indication 718 is associated with a user profile of second user 708b and/or is associated with a username of second user 708b. As shown in second alternative view 730b of three-dimensional environment 702, virtual representation 704a is not displayed concurrently with indication 718.

In some embodiments, virtual representation 704b is displayed in three-dimensional environment 702 with an animation that is independent of movement of the current viewpoint of second user 708b relative to the three-dimensional environment 702 (e.g., including one or more characteristics of displaying the first virtual object with an animation that is independent of movement of the current viewpoint of the second user relative to the three-dimensional environment as described with reference to method 800 and/or one or more characteristics of displaying the animation including periodic movement of the virtual representation of the user of the second computer system as described with reference to method 900). As shown in FIG. 7B, virtual representation 704b is displayed with an animation 714 (e.g., represented by double-arrows on either side of virtual representation 704b in first alternative view 730a) corresponding to oscillation of virtual representation 704b about the current location of virtual representation 704b in three-dimensional environment 702 (e.g., including one or more characteristics of displaying the first virtual object oscillating about a current location of the current viewpoint of the second user relative to the three-dimensional environment as described with reference to method 800). As shown in second alternative view 730b of three-dimensional environment 702, virtual representation 704a is not displayed with animation 714.

In some embodiments, the virtual representation change criteria that is satisfied to change the respective virtual representation of second user 708b from virtual representation 704a (e.g., as shown in first alternative view 730a in FIG. 7A) to virtual representation 704b includes one or more criterion (e.g., the one or more criterion are optionally used to change a respective virtual representation of second user 708b from virtual representation 704b to virtual representation 704a). For example, a criterion includes receiving an indication of user input (e.g., from first user 708a or second user 708b (e.g., the second computer system sends the indication to first computer system 101)) for changing the display of the respective virtual representation of second user 708b from virtual representation 704a to virtual representation 704b, or optionally from virtual representation 704b to virtual representation 704a (e.g., the indication of user input has one or more characteristics of the indications of user input described with reference to method 900). For example, a criterion includes receiving an indication that is independent of user input (e.g., including one or more characteristics of the indication that one or more criteria are satisfied independent of user input as described with reference to method 900). In some embodiments, in accordance with first computer system 101 and/or second computer system detecting loss of tracking of the current viewpoint of second user 704b relative to three-dimensional environment 702, first computer system 101 optionally changes the display of the respective virtual representation of second user 708b from virtual representation 704a to virtual representation 704b (e.g., or optionally from virtual representation 704b to virtual representation 704a).

FIG. 7C illustrates second user 708b providing an audio input (e.g., represented by the “x” shown adjacent to second user 708b in overhead view 706) while in the communication session with first user 708a. In some embodiments, the user interfaces illustrated in FIG. 7C and described below are implemented on a head-mounted display that displays three-dimensional environment 702 (e.g., as an AR, VR, MR, XR or AR environment) to first user 708a. In some embodiments, second computer system sends an indication to first computer system corresponding to the audio input received by second computer system (e.g., from second user 708b), including one or more characteristics of the indication corresponding to the audio input received by the second computer system from the second user as described with reference to method 800. As shown in FIG. 7C, in response to second user 708b providing the audio input, virtual representation 704b is displayed with an animation 720 (e.g., displaying virtual representation 704b with animation 720 includes one or more characteristics of displaying the first virtual object in the three-dimensional environment with the animation based on the audio input received by the second computer system as described with reference to method 800). As shown in alternative view 730b of three-dimensional environment 702, virtual representation 704a is not displayed with animation 720 based on the audio input provided by second user 708b. As shown in FIG. 7C, virtual representation 704b is not displayed with animation 714 while virtual representation 704b is displayed with animation 720. Optionally, first computer system 101 displays virtual representation 704b with animation 720 concurrently with animation 714 in response to receiving an indication corresponding to an audio input received by the second computer system.

In FIG. 7C, a side view 712 of a physical environment of second user 708b is shown. In some embodiments, physical environment of second user includes one or more physical environment described with reference to methods 800, 900, 1100 and/or 1200. As shown in side view 712, user 708b is currently sitting (e.g., on a chair) in the physical environment (e.g., the current viewpoint of second user 708b is currently located and/or oriented at a first height relative to three-dimensional environment 702).

FIG. 7D illustrates vertical movement of the current viewpoint of second user 708b relative to three-dimensional environment 702. In some embodiments, the user interfaces illustrated in FIG. 7D and described below are implemented on a head-mounted display that displays three-dimensional environment 702 (e.g., as an AR, VR, MR, XR or AR environment) to first user 708a. As shown in side view 712 of the physical environment of second user 708b, second user 708b has changed their vertical position (e.g., second user is standing as opposed to sitting) in the physical environment compared to as shown in FIG. 7C. In some embodiments, in accordance with the current viewpoint of second user 708b being represented in three-dimensional environment 702 by virtual representation 704a (e.g., as shown in second alternative view 730b of three-dimensional environment 702), first computer system 101 displays movement of virtual representation 704a in accordance with the vertical movement of the current viewpoint of second user 708b relative to three-dimensional environment 702. For example, as shown in FIG. 7D, virtual representation 704a is displayed at a new height in three-dimensional environment 702 relative to the current viewpoint of first user 708a compared to as shown in FIG. 7C. In some embodiments, in accordance with the current viewpoint of second user 708b being represented in three-dimensional environment 702 by virtual representation 704b (e.g., as shown in first alternative view 730a of three-dimensional environment 702), first computer system 101 forgoes displaying movement of virtual representation 704b in accordance with the vertical movement of the current viewpoint of second user 708b relative to three-dimensional environment 702. For example, as shown in FIG. 7D, virtual representation 704b is displayed at the same height in three-dimensional environment 702 relative to the current viewpoint of first user 708a compared to as shown in FIG. 7C. In FIG. 7D, second user 708b ceases to provide the audio input provided by second user 708b in FIG. 7C. Accordingly, first computer system 101 ceases display of animation 720 in three-dimensional environment 702 (e.g., and optionally redisplays animation 714).

FIG. 7E illustrates movement of the current viewpoint of second user 708b relative to three-dimensional environment 702. In some embodiments, the user interfaces illustrated in FIG. 7E and described below are implemented on a head-mounted display that displays three-dimensional environment 702 (e.g., as an AR, VR, MR, XR or AR environment) to first user 708a. In some embodiments, in response to movement of the current viewpoint of second user 708b relative to three-dimensional environment 702, in accordance with the respective virtual representation of second user 708b being virtual representation 704b, first computer system 101 displays virtual representation 704b with a first representation of movement (e.g., as described with reference to method 900), and in accordance with the respective virtual representation of second user 708b being virtual representation 704a, first computer system 101 displays virtual representation 704a with a second representation of movement (e.g., as described with reference to method 900). In some embodiments, displaying virtual representation 704b with the first representation of movement includes displaying movement of virtual representation 704b in accordance with movement of the current viewpoint of second user 708b exceeding a threshold amount relative to three-dimensional environment 702 (e.g., the threshold amount has one or more characteristics of the threshold amount described with reference to method 800). In FIG. 7E, overhead view 706 includes orientation threshold 722a (e.g., corresponding to a threshold amount of change in orientation of the current viewpoint of second user 708b relative to three-dimensional environment 702) and distance (e.g., or optionally magnitude) threshold 722b (e.g., corresponding to a threshold amount of distance of movement of the current viewpoint of second user 708b relative to three-dimensional environment 702). In some embodiments, first computer system 101 changes a location and/or orientation (e.g., a pose) of virtual representation 704b in three-dimensional environment 702 (e.g., relative to the current viewpoint of first user 708a) in accordance with the movement of the current viewpoint of second user 708b exceeding orientation threshold 722a and/or distance threshold 722b relative to three-dimensional environment 702. In some embodiments, in accordance with the respective virtual representation of user 708b being virtual representation 704a, first computer system 101 changes the location and/or orientation (e.g., a pose) of virtual representation 704a in three-dimensional environment 702 (e.g., relative to the current viewpoint of first user 708a) independent of whether the movement of the current viewpoint of second user 708b relative to three-dimensional environment exceeds orientation threshold 722a and/or distance threshold 722b. In FIG. 7E, movement of the current viewpoint of second user 708b does not exceed the orientation threshold 722a (e.g., the orientation 710b of the current viewpoint of second user 708b is within orientation threshold 722a in overhead view 706) and/or distance threshold 722b (e.g., the location of the current viewpoint of second user 708b is within distance threshold 722b in overhead view 706). Accordingly, in first alternative view 730a of three-dimensional environment 702, first computer system 101 does not change the orientation of virtual representation 704b in three-dimensional environment 702 based on the movement of the current viewpoint of second user 708b, and in second alternative view 730b of three-dimensional environment 702, first computer system 101 changes the orientation of virtual representation 704b in three-dimensional environment 702 based on the movement of the current viewpoint of second user 708b.

FIG. 7F illustrates movement of the current viewpoint of second user 708b that exceeds orientation threshold 722a relative to three-dimensional environment 702. In some embodiments, the user interfaces illustrated in FIG. 7F and described below are implemented on a head-mounted display that displays three-dimensional environment 702 (e.g., as an AR, VR, MR, XR or AR environment) to first user 708a. In some embodiments, movement of the current viewpoint of second user 708b shown in FIG. 7F is a continuation of movement of the current viewpoint of second user 708b from FIG. 7E. As shown in overhead view 706, movement of the current viewpoint of second user 708b causes orientation 710b of second user 708b to not be within orientation threshold 722a. In accordance with the movement of the current viewpoint of second user 708b exceeding orientation threshold 722a relative to three-dimensional environment 702, first computer system 101 (e.g., in first alternative view 730a) changes the orientation of virtual representation 704b in three-dimensional environment 702 (e.g., relative to the current viewpoint of first user 708a). As shown in second alternative view 730b, first computer system 101 changes (e.g., or optionally continues to change) the orientation of virtual representation 704a in three-dimensional environment 702 (e.g., relative to the current viewpoint of first user 708a). In some embodiments, first computer system 101 displays continuous movement of virtual representation 704a (e.g., first computer system 101 does not cease display of virtual representation 704a and/or cease to display movement of virtual representation 704a) based on the movement of the current viewpoint of second user 708b shown in FIGS. 7E-F.

As shown in first alternative view 730a of three-dimensional environment 702 in FIG. 7F, virtual representation 704b continues to be displayed with animation 714 during the movement of virtual representation 704b in accordance with the movement of the current viewpoint of second user 708b relative to three-dimensional environment 702. In some embodiments, in accordance with movement of virtual representation 704b being displayed based on movement of the current viewpoint of second user 708b in three-dimensional environment 702 (e.g., relative to the current viewpoint of first user 708a), first computer system 101 ceases to display virtual representation 704b with animation 714.

In FIG. 7F, indication 718 continues to be displayed with virtual representation 704b during the movement of virtual representation 704b in three-dimensional environment 702 (e.g., relative to the current viewpoint of first user 708a). As shown in first alternative view 730a, indication 718 is displayed with the same orientation in three-dimensional environment 702 (e.g., relative to the current viewpoint of first user 708a) as shown in FIGS. 7B-7E. In some embodiments, first computer system 101 maintains the orientation of indication 718 relative to three-dimensional environment 702 (e.g., relative to the current viewpoint of first user 708a) when displaying movement (e.g., a change in orientation and/or location relative to the current viewpoint of first user 708a) of virtual representation 704b. In some embodiments, maintaining the orientation of indication 718 when displaying movement of virtual representation 704b includes one or more characteristics of maintaining display of the indication corresponding to the identifier of the second user in the three-dimensional environment at the first orientation relative to the three-dimensional environment in response to receiving the indication as described with reference to method 800.

FIG. 7G illustrates movement of the current viewpoint of second user 708b relative to three-dimensional environment 702. In some embodiments, the user interfaces illustrated in FIG. 7G and described below are implemented on a head-mounted display that displays three-dimensional environment 702 (e.g., as an AR, VR, MR, XR or AR environment) to first user 708a. In some embodiments, movement of the current viewpoint of second user 708b is continued movement of the current viewpoint of second user 708b shown in FIGS. 7E-7F. In some embodiments, movement of the current viewpoint of second user 708b continues to exceed orientation threshold 722a (e.g., shown in FIGS. 7E-7F). Accordingly, in first alternative view 730a of three-dimensional environment 702, first computer system 101 changes (e.g., or optionally continues to change) the orientation of virtual representation 704b in three-dimensional environment 702 (e.g., from the current viewpoint of first user 708a). As shown in first alternative view 730a of three-dimensional environment 702, a second surface 732b of virtual representation 704b is shown (e.g., because orientation 710b of the current viewpoint of second user 708b is directed away from the current viewpoint of first user 708a). In some embodiments, second surface 732b is a surface of virtual representation 704b that includes an orientation opposite from the orientation of first surface 732a (e.g., as shown in FIGS. 7B-7E) and does not include the identifier of second user 708b shown on first surface 732a (e.g., as described with reference to FIG. 7B). In second alternative view 730b of three-dimensional environment 702, first computer system 101 changes (e.g., or optionally continues to change) the orientation of virtual representation 704a based on the change in orientation of the current viewpoint of second user 708b relative to three-dimensional environment 702 (e.g., and relative to the current viewpoint of first user 708a). In some embodiments, first computer system 101 displays continuous movement of virtual representation 704a (e.g., first computer system 101 does not cease display of virtual representation 704a and/or cease to display movement of virtual representation 704a) based on the movement of the current viewpoint of second user 708b shown in FIGS. 7E-7G.

As shown in overhead view 706 in FIG. 7G, movement of the current viewpoint of second user 708b relative to the three-dimensional environment 702 includes a change in location of the current viewpoint of second user 708b relative to three-dimensional environment 702 (e.g., compared to the location of the current viewpoint of second user 708b as shown in overhead view 706 in FIGS. 7A-7F). Overhead view 706 shows that the change in location of the current viewpoint of second user 708b does not exceed distance threshold 722b. Accordingly, in first alternative view 730a of three-dimensional environment 702, first computer system 101 does not change the location of virtual representation 704b relative to three-dimensional environment 702 (e.g., relative to the current viewpoint of first user 708a) based on the change in location of the current viewpoint of second user 708b. In overhead view 706, virtual representation 704b is shown at a location (e.g., and an orientation as represented by an arrow shown adjacent to virtual representation 704b in overhead view 706) in three-dimensional environment 702 to represent the difference in location of virtual representation 704b compared the current viewpoint of second user 708b in three-dimensional environment 702. In second alternative view 730b of three-dimensional environment 702, first computer system 101 changes the location of virtual representation 704b relative to three-dimensional environment 702 (e.g., relative to the current viewpoint of first user 708a) based on the change in location of the current viewpoint of second user 708b.

FIG. 7H illustrates movement of the current viewpoint of second user 708b that exceeds distance threshold 722b relative to three-dimensional environment 702. In some embodiments, the user interfaces illustrated in FIG. 7H and described below are implemented on a head-mounted display that displays three-dimensional environment 702 (e.g., as an AR, VR, MR, XR or AR environment) to first user 708a. In some embodiments, the movement of the current viewpoint of second user 708b shown in FIG. 7H is a continuation of the movement of the current viewpoint of second user 708b shown in FIGS. 7E-7G. As shown in overhead view 706 in FIG. 7H, movement of the current viewpoint of second user 708b causes the location of the current viewpoint of second user 708b to not be within distance threshold 722b. Accordingly, in first alternative view 730a of three-dimensional environment 702, first computer system 101 displays an animation 740 of movement of virtual representation 704b based on the movement of the current viewpoint of second user 708b relative to three-dimensional environment 702 (e.g., relative to the current viewpoint of first user 708a). In some embodiments, displaying virtual representation 704b with animation 740 includes one or more characteristics of displaying first virtual object with the animation corresponding to movement of the first virtual object from the first pose to the second pose based on the movement of the current viewpoint of the second user as described with reference to method 800. As shown in first alternative view 730a of three-dimensional environment 702 in FIG. 7H, animation 740 includes movement (e.g., represented by arrows displayed on either side of virtual representation 704b) corresponding to movement of the current viewpoint of second user 708b while concurrently changing a visual prominence of virtual representation 704b (e.g., represented by the change in visual appearance of virtual representation 704b) relative to three-dimensional environment 702. For example, displaying animation 740 includes increasing the transparency of virtual representation 704b relative to three-dimensional environment 702 (e.g., such virtual representation 704b appears to be fading away from the current viewpoint of first user 708a). As shown in second alternative view 730b of three-dimensional environment 702, first computer system 101 changes the location of virtual representation 704a based on the movement of the current viewpoint of second user 708b. In some embodiments, first computer system 101 displays continuous movement of virtual representation 704a (e.g., first computer system 101 does not cease display of virtual representation 704a and/or cease to display movement of virtual representation 704a) based on the movement of the current viewpoint of second user 708b shown in FIGS. 7E-7H.

As shown in FIG. 7H, while first computer system 101 displays animation 740 (e.g., including movement of virtual representation 704b to a greater distance from the current viewpoint of first user 708a), first computer system 101 maintains the size of virtual representation 704b relative to three-dimensional environment 702 (e.g., the display size of virtual representation 704b is reduced as virtual representation 704b is moved to a greater distance from the current viewpoint of first user 708a). While displaying animation 740, first computer system 101 maintains the display size of indication 718 relative to the current viewpoint of first user 708a (e.g., the size of indication 718 is changed by first computer system 101 relative to three-dimensional environment 702 such that indication 718 is displayed with a consistent display size while displaying movement of virtual representation 704b).

FIG. 7I illustrates further movement of the location of the current viewpoint of second user 708b relative to three-dimensional environment 702. In some embodiments, the user interfaces illustrated in FIG. 7I and described below are implemented on a head-mounted display that displays three-dimensional environment 702 (e.g., as an AR, VR, MR, XR or AR environment) to first user 708a. In some embodiments, movement of the current viewpoint of second user 708b relative to three-dimensional environment 702 shown in FIG. 7I is a continuation of the movement of the current viewpoint of second user 708b shown in FIGS. 7E-7H. In some embodiments, displaying the first representation of movement of virtual representation 704b includes ceasing display of virtual representation 704b in three-dimensional environment 702 and redisplaying virtual representation 704b in three-dimensional environment 702 based on the movement of the current viewpoint of second user 708b (e.g., including one or more characteristics of ceasing display of the first virtual object in the three-dimensional environment before the first virtual object reaches the second pose and subsequently redisplaying the first virtual object in the three-dimensional environment as described with reference to method 800). As shown in first alternative view 730a of three-dimensional environment 702, first computer system 101 ceases display of virtual representation 704b in three-dimensional environment 702 during the movement of virtual representation 704b (e.g., from a first pose to a second pose as described with reference to method 800) based on the movement of the current viewpoint of second user 708b. As shown in second alternative view 730b of three-dimensional environment 702, first computer system 101 maintains display of virtual representation 704a and changes the location of virtual representation 704a based on the movement (e.g., change in location) of the current viewpoint of second user 708b relative to three-dimensional environment 702 (e.g., relative to the current viewpoint of first user 708a). In some embodiments, first computer system 101 displays continuous movement of virtual representation 704a (e.g., first computer system 101 does not cease display of virtual representation 704a and/or cease to display movement of virtual representation 704a) based on the movement of the current viewpoint of second user 708b shown in FIGS. 7E-7I.

FIG. 7J illustrates further movement of the current viewpoint of second user 708b that includes a change in location and a change in orientation relative to three-dimensional environment 702 (e.g., as shown in overhead view 706). In some embodiments, the user interfaces illustrated in FIG. 7J and described below are implemented on a head-mounted display that displays three-dimensional environment 702 (e.g., as an AR, VR, MR, XR or AR environment) to first user 708a. In some embodiments, movement of the current viewpoint of second user 708b relative to three-dimensional environment 702 shown in FIG. 7J is a continuation of the movement of the current viewpoint of second user 708b shown in FIGS. 7E-71. In some embodiments, displaying the first representation of movement of virtual representation 704b includes displaying virtual representation 704b in three-dimensional environment 702 at one or more intermediate poses (e.g., including locations and/or orientations relative to three-dimensional environment 702) during the movement of virtual representation 704b (e.g., from a first pose to a second pose as described with reference to method 800). For example, first computer system 101 displaying virtual representation 704b at an intermediate pose in three-dimensional environment 702 in accordance with the movement of the current viewpoint of second user 708b exceeding a threshold distance (e.g., 0.1, 0.2, 0.5, 1, 2, 5 or 10 meters) relative to three-dimensional environment 702. First alternative view 730a of three-dimensional environment 702 shown in FIG. 7J shows virtual representation 704b displayed at an intermediate pose (e.g., location and orientation relative to three-dimensional environment 702) corresponding to a pose of the current viewpoint of second user 708b during the movement of the current viewpoint of second user 708b relative to three-dimensional environment 702 (e.g., the intermediate pose corresponds to the location and orientation of the current viewpoint of second user 708b as shown in overhead view 706). In some embodiments, displaying virtual representation 704b at the intermediate pose includes one or more characteristics of displaying the first virtual object at one or more intermediate poses in the three-dimensional environment between the first pose and the second pose in accordance with the movement of the current viewpoint of the second user from the first viewpoint from the second viewpoint exceeding the threshold distance relative to the three-dimensional environment as described with reference to method 800. As shown in second alternative view 730b of three-dimensional environment 702, first computer system 101 maintains display of virtual representation 704a and changes the location of virtual representation 704a based on the movement (e.g., change in location and orientation) of the current viewpoint of second user 708b relative to three-dimensional environment 702 (e.g., relative to the current viewpoint of first user 708a). In some embodiments, first computer system 101 displays continuous movement of virtual representation 704a (e.g., first computer system 101 does not cease display of virtual representation 704a and/or cease to display movement of virtual representation 704a) based on the movement of the current viewpoint of second user 708b shown in FIGS. 7E-7J.

In FIG. 7J, second user 708b provides an audio input to the second computer system. In some embodiments, the second computer system transmits an indication to first computer system 101 corresponding to the audio input provided by second user 708b. As shown in FIG. 7J, in response to receiving the audio input (e.g., represented in overhead view 706 as an “x” shown adjacent to second user 708b), first computer system 101 displays animation 720 with virtual representation 704b (e.g., as shown in first alternative view 730a of three-dimensional environment 702). In some embodiments, in response to receiving an indication from the second computer system corresponding to the audio input provided by second user 708b, first computer system 101 provides an audio output to first user 708a that is spatialized to the current pose (e.g., location and/or orientation) of virtual representation 704b in three-dimensional environment 702 (e.g., including one or more characteristics of providing audio output corresponding to the audio input received by the second computer system that is spatialized to the first pose (e.g., or second pose) of the first virtual object in the three-dimensional environment as described with reference to method 800). For example, in accordance with virtual representation 704b being displayed in three-dimensional environment 702 at a location different from the current viewpoint of second user 708b (e.g., such as shown in FIGS. 7G-7H), the audio output is spatialized to the location of virtual representation 704b in three-dimensional environment 702 (e.g., and not to the location of the current viewpoint of second user 708b relative to three-dimensional environment 702).

FIG. 7K illustrates further movement of the current viewpoint of second user 708b including a change in location and orientation relative to the three-dimensional environment 702. In some embodiments, movement of the current viewpoint of second user 708b relative to three-dimensional environment 702 shown in FIG. 7K is a continuation of the movement of the current viewpoint of second user 708b shown in FIGS. 7E-7J. In some embodiments, the user interfaces illustrated in FIG. 7K and described below are implemented on a head-mounted display that displays three-dimensional environment 702 (e.g., as an AR, VR, MR, XR or AR environment) to first user 708a. As shown in FIG. 7K (e.g., in first alternative view 730a of three-dimensional environment 702, first computer system 101 ceases to display virtual representation 704b in three-dimensional environment 702 during the movement of virtual representation 704b based on the movement of the current viewpoint of second user 708b relative to three-dimensional environment 702 (e.g., the continued movement of the current viewpoint of second user 708b relative to three-dimensional environment 702 causes first computer system 101 to cease display of virtual representation 704b in accordance with displaying the first representation of movement (e.g., as described with reference to FIG. 7I)). As shown in second alternative view 730b of three-dimensional environment 702, first computer system 101 maintains display of virtual representation 704a and changes the location and orientation of virtual representation 704a in three-dimensional environment 702 based on the movement of the current viewpoint of second user 708b relative to three-dimensional environment 702 (e.g., relative to the current viewpoint of first user 708a). In some embodiments, first computer system 101 displays continuous movement of virtual representation 704a (e.g., first computer system 101 does not cease display of virtual representation 704a and/or cease to display movement of virtual representation 704a) based on the movement of the current viewpoint of second user 708b shown in FIGS. 7E-7J.

In some embodiments, in FIG. 7K, second user 708b settles the movement of their current viewpoint relative to three-dimensional environment 702 (e.g., second user 708b ceases movement (e.g., change in location and/or orientation) relative to three-dimensional environment 702 (e.g., optionally corresponding to less than a threshold amount of movement (e.g., distance and/or change of orientation of movement) for a threshold period of time (e.g., 0.1, 0.5, 1, 2, 5 or 10 seconds)). In some embodiments, the current viewpoint second user 708b settles at an updated pose relative to three-dimensional environment 702 (e.g., including one or more characteristics of the second pose as described with reference to method 800). In some embodiments, detecting movement of the current viewpoint of second user 708b settling relative to three-dimensional environment 702 includes one or more characteristics of detecting the event that includes less than the threshold amount of movement of the current viewpoint of the second user for longer than a time threshold as described with reference to method 800.

FIG. 7K1 illustrates similar and/or the same concepts as those shown in FIG. 7K (with many of the same reference numbers). It is understood that unless indicated below, elements shown in FIG. 7K1 that have the same reference numbers as elements shown in FIGS. 7A-7N have one or more or all of the same characteristics. FIG. 7K1 includes computer system 101, which includes (or is the same as) display generation component 120. In some embodiments, computer system 101 and display generation component 120 have one or more of the characteristics of computer system 101 shown in FIGS. 7A-7N and display generation component 120 shown in FIGS. 1 and 3, respectively, and in some embodiments, computer system 101 and display generation component 120 shown in FIGS. 7A-7N have one or more of the characteristics of computer system 101 and display generation component 120 shown in FIG. 7K1.

In FIG. 7K1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7N.

In FIG. 7K1, display generation component 120 is illustrated as displaying content that optionally corresponds to the content that is described as being displayed and/or visible via display generation component 120 with reference to FIGS. 7A-7N. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7K1.

Display generation component 120 has a field of view (e.g., a field of view captured by external image sensors 314b and 314c and/or visible to the user via display generation component 120) that corresponds to the content shown in FIG. 7K1. Because display generation component 120 is optionally a head-mounted device, the field of view of display generation component 120 is optionally the same as or similar to the field of view of the user.

In some embodiments, computer system 101 responds to user inputs as described with reference to FIGS. 7A-7N. It is understood than one or more or all aspects of the present disclosure as shown in, or described with reference to FIGS. 7A-7N and/or described with reference to the corresponding method(s) are optionally implemented on computer system 101 and display generation unit 120 in a manner similar or analogous to that shown in FIG. 7K1.

FIG. 7L illustrates first computer system 101 redisplaying virtual representation 704b in accordance with the movement of the current viewpoint of second user 708b settling relative to three-dimensional environment 702 in FIG. 7K. In some embodiments, the user interfaces illustrated in FIG. 7L and described below are implemented on a head-mounted display that displays three-dimensional environment 702 (e.g., as an AR, VR, MR, XR or AR environment) to first user 708a. As shown in first alternative view 730a of three-dimensional environment 702, first computer system 101 redisplays virtual representation 704b in three-dimensional environment 702 (e.g., first computer system 101 gradually increases the opacity (e.g., represented by the visual appearance of virtual representation 704b in FIG. 7L) of virtual representation 704b relative to three-dimensional environment 702). In some embodiments, while increasing the visual prominence of virtual representation 704b, first computer system 101 displays animation 740 (e.g., as shown and described with reference to FIG. 7H). For example, first computer system 101 displays movement of virtual representation 704b toward a location in three-dimensional environment 702 corresponding to the updated pose of the current viewpoint of second user 708b relative to three-dimensional environment 702. As shown in overhead view 706, virtual representation 704b is redisplayed at a location in three-dimensional environment 702 that does not correspond to the updated pose of the current viewpoint of second user 708b (e.g., because the first representation of movement of virtual representation 704b includes redisplaying virtual representation 704b with an animation corresponding to movement of virtual representation 704b toward the location in three-dimensional environment 702 corresponding to the updated pose of the current viewpoint of second user 708b). In some embodiments, redisplaying virtual representation 704b in three-dimensional environment 702 includes one or more characteristics of displaying movement of the first virtual object toward the second pose that corresponds to movement of the current viewpoint of the user toward the second viewpoint as described with reference to method 800. As shown in second alternative view 730b of three-dimensional environment 702, first computer system 101 maintains display of virtual representation 704a at the location and orientation in three-dimensional environment 702 shown in FIG. 7K (e.g., because the pose of virtual representation 704a in three-dimensional environment 702 shown in FIG. 7L currently reflects the updated pose of the current viewpoint of second user 708b relative to three-dimensional environment 702 in accordance with displaying the second representation of movement of virtual representation 704a).

FIG. 7L1 illustrates similar and/or the same concepts as those shown in FIG. 7L (with many of the same reference numbers). It is understood that unless indicated below, elements shown in FIG. 7L1 that have the same reference numbers as elements shown in FIGS. 7A-7N have one or more or all of the same characteristics. FIG. 7L1 includes computer system 101, which includes (or is the same as) display generation component 120. In some embodiments, computer system 101 and display generation component 120 have one or more of the characteristics of computer system 101 shown in FIGS. 7A-7N and display generation component 120 shown in FIGS. 1 and 3, respectively, and in some embodiments, computer system 101 and display generation component 120 shown in FIGS. 7A-7N have one or more of the characteristics of computer system 101 and display generation component 120 shown in FIG. 7L1.

In FIG. 7L1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7N.

In FIG. 7L1, display generation component 120 is illustrated as displaying content that optionally corresponds to the content that is described as being displayed and/or visible via display generation component 120 with reference to FIGS. 7A-7N. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7L1.

Display generation component 120 has a field of view (e.g., a field of view captured by external image sensors 314b and 314c and/or visible to the user via display generation component 120) that corresponds to the content shown in FIG. 7L1. Because display generation component 120 is optionally a head-mounted device, the field of view of display generation component 120 is optionally the same as or similar to the field of view of the user.

In some embodiments, computer system 101 responds to user inputs as described with reference to FIGS. 7A-7N. It is understood than one or more or all aspects of the present disclosure as shown in, or described with reference to FIGS. 7A-7N and/or described with reference to the corresponding method(s) are optionally implemented on computer system 101 and display generation unit 120 in a manner similar or analogous to that shown in FIG. 7L1.

FIG. 7M illustrates virtual representation 704b displayed at an updated pose in three-dimensional environment 702 corresponding to the updated pose of the current viewpoint of second user 708b (e.g., in first alternative view 730a of three-dimensional environment 702). In some embodiments, the user interfaces illustrated in FIG. 7M and described below are implemented on a head-mounted display that displays three-dimensional environment 702 (e.g., as an AR, VR, MR, XR or AR environment) to first user 708a. In some embodiments, in accordance with the movement of the current viewpoint of second user 708b settling relative to three-dimensional environment 702, first computer system 101 updates the threshold amount of movement (e.g., for displaying the first representation of movement of virtual representation 704b) relative to the updated pose of the current viewpoint of second user 708b. Accordingly, in overhead view 706 in FIG. 7M, orientation threshold 722a and distance threshold 722b are shown relative to the updated pose of the current viewpoint of second user 708b relative to three-dimensional environment 702. In some embodiments, in accordance with second user 708b being represented by virtual representation 704b in three-dimensional environment 702 and second user 708b initiating movement of their current viewpoint relative to three-dimensional environment 702 that exceeds orientation threshold 22a and/or distance threshold 722b represented in overhead view 706, first computer system 101 displays the first representation of movement of virtual representation 704b in accordance with the movement of the current viewpoint of second user 708b. As shown in second alternative view 730b of three-dimensional environment 702, first computer system 101 maintains display of virtual representation 704a at the location and orientation in three-dimensional environment 702 shown in FIGS. 7K-7L (e.g., because the pose of virtual representation 704a in three-dimensional environment 702 shown in FIGS. 7K-7L already reflect the updated pose of the current viewpoint of second user 708b relative to three-dimensional environment 702 in accordance with displaying the second representation of movement of virtual representation 704a).

In some embodiments, displaying virtual representation 704b at the updated pose relative to three-dimensional environment 702 in FIG. 7M includes displaying the animation 714 (e.g., as shown and described with reference to FIG. 7B). In some embodiments, displaying virtual representation 704b at the updated pose relative to three-dimensional environment 702 in FIG. 7M displaying indication 718 at the same orientation (e.g., compared to as shown in FIGS. 7B-7H) and with the same display size (e.g., compared to as shown in FIGS. 7B-7H) relative to the current viewpoint of first user 708a.

FIG. 7N illustrates a first respective virtual representation of a second user of a second computer system in communication with first computer system 101 and a second respective virtual representation of a third user of a computer system in communication with first computer system 101. In some embodiments, the user interfaces illustrated in FIG. 7N and described below are implemented on a head-mounted display that displays three-dimensional environment 702 (e.g., as an AR, VR, MR, XR or AR environment) to first user 708a. In some embodiments, virtual representations 724a (e.g., shown in second alternative view 730b) and 724b (e.g., shown in first alternative view 730a) are respective virtual representations of the second user. In some embodiments, virtual representations 726a (e.g., shown in first alternative view 730a) and 726b (e.g., shown in second alternative view 730b) are respective virtual representations of the third user. In some embodiments, virtual representations 724a and 726a have one or more characteristics of virtual representation 704a shown in FIGS. 7A-7M and described above. In some embodiments, virtual representations 724b and 726b have one or more characteristics of virtual representation 704b shown in FIGS. 7B-7M and described above.

FIG. 7O illustrates first computer system 101 changing the display (e.g., in both first alternative view 730a and second alternative view 730b of three-dimensional environment 702) of the respective virtual representation of the third user in response to virtual representation change criteria being satisfied. In some embodiments, the user interfaces illustrated in FIG. 7O and described below are implemented on a head-mounted display that displays three-dimensional environment 702 (e.g., as an AR, VR, MR, XR or AR environment) to first user 708a. In some embodiments, the virtual representation change criteria have one or more characteristics of the virtual representation change criteria described with reference to FIG. 7B. Particularly, in first alternative view 730a of three-dimensional environment 702, first computer system 101 changes the display of the respective virtual representation of the third user from virtual representation 726a (e.g., as shown in FIG. 7N) to virtual representation 726b. In second alternative view 730b of three-dimensional environment 702, first computer system 101 change the display of the respective virtual representation of the third user from virtual representation 726b (e.g., as shown in FIG. 7N) to virtual representation 726a.

As shown in FIG. 7O (e.g., in first alternative view 730a), virtual representation 724b and virtual representation 726b are displayed in three-dimensional environment 702 with different visual characteristics (e.g., including color, brightness and/or saturation), as represented by the difference in appearance of virtual representation 724b in first alternative view 730a of three-dimensional environment 702 and of virtual representation 726b in second alternative view 730b of three-dimensional environment 702. In some embodiments, displaying virtual representation 724b and virtual representation 726b with different visual characteristics includes one or more characteristics of displaying the first virtual object with a respective visual characteristic having a first value, and displaying the second virtual object with the respective visual characteristic having a second value, different form the first value, as described with reference to method 800. In FIG. 7O, indications 718 displayed respectively with virtual representation 724b and virtual representation 726b include different identifiers 718 (e.g., corresponding to different names of the second user and the third user). In FIG. 7O, respective first surfaces 732a of virtual representation 724b and virtual representation 726b include different identifiers (e.g., optionally corresponding to different initials of the second user and the third user).

As shown in FIG. 7O (e.g., in second alternative view 730b), virtual representation 724a and virtual representation 726a correspond to avatars that are displayed in three-dimensional environment 702 with different visual characteristics (e.g., virtual representation 726a is displayed with a hat and virtual representation 724a is not displayed with a hat). In some embodiments, virtual representation 726a is an avatar that has one or more visual features customizable by the third user (e.g., virtual representation 726a has features corresponding to physical features of the third user (e.g., a preferred visual appearance of virtual representation 726a (e.g., is associated with a user profile of the third user and) is stored in a memory of the third computer system)). In some embodiments, virtual representation 724a is an avatar that has one or more visual features customizable by the second user (e.g., virtual representation 726a has features corresponding to physical features of the second user (e.g., a preferred visual appearance of virtual representation 726a (e.g., is associated with a user profile of the second user and) is stored in a memory of the second computer system)).

FIG. 7P illustrates first computer system 101 displaying a virtual representation 740 of a user 744b in three-dimensional environment 702 at a pose that is independent of a current viewpoint of user 744b. In some embodiments, virtual representation 740 corresponds to a placeholder representation that first computer system 101 displays in three-dimensional environment 702 in accordance with one or more criteria being met (e.g., as shown in FIG. 7P, user status change criteria are satisfied). For example, the one or more criteria includes a criterion that is met when a second computer system (e.g., the second computer system is in communication with first computer system 101 in the communication session) can no longer detect and/or is not expecting to detect movement of the current viewpoint of user 744b relative to three-dimensional environment 702 (e.g., relative to a second three-dimensional environment corresponding to three-dimensional environment 702 that is visible to user 744b and displayed by the second computer system). For example, the second computer system no longer tracks (e.g., due to one or more errors with one or more input devices of the second computer system) one or more portions of user 744b (e.g., corresponding to one or more physical portions of the body of user 744b (e.g., head, eyes, hands, arms and/or torso)). For example, the second computer system loses network connectivity, causing a current pose of the current viewpoint of user 744b to not be communicated (e.g., through an indication as described with reference to methods 800 and/or 900) to first computer system 101. In some embodiments, virtual representation 740 has one or more characteristics of the virtual representation of the third type as described with reference to method 900. In some embodiments, in accordance with the one or more criteria no longer being satisfied (e.g., due to first computer system 101 receiving an indication from the second computer system corresponding to a pose of the current viewpoint of user 744b (e.g., corresponding to movement of the current viewpoint of user 744b)), first computer system 101 ceases to display virtual representation 740 and displays a virtual representation different from virtual representation 740 (e.g., such as virtual representation 704a and/or 704b). For example, first computer system 101 displays one or more representations of movement of the virtual representation different from virtual representation 740 corresponding to movement of the current viewpoint of user 744b based on the indication received from the second computer system.

As shown in overhead view 706 in FIG. 7P, user 744a (e.g., which is the user associated with first computer system 101) views virtual representation 740 of user 744b from a direct viewing angle (e.g., the viewing angle of user 744a, 744b and 744c are represented by arrows 748a, 748b and 748c, respectively). Further, as shown in overhead view 706, a third user 744c (e.g., associated with a third computer system in communication with first computer system 101 and the second computer system) is represented in three-dimensional environment 702 by a virtual representation (e.g., virtual representation 750 shown and described with reference to FIG. 7S). In some embodiments, the virtual representation of user 744c is not the same type of virtual representation as virtual representation 740 (e.g., the virtual representation of user 744c is displayed as a virtual representation of the same type as virtual representations 704a and/or 704b shown and described with reference to FIGS. 7A-7M). In FIG. 7P, based on a location of the current viewpoint of user 744c relative to the current viewpoint of user 744a in three-dimensional environment 702, the virtual representation of user 744c is not visible in the field of view of user 744a of three-dimensional environment 702.

In FIG. 7P, virtual representation 740 is displayed with indication 718. In some embodiments, indication 718 includes one or more characteristics of indication 718 shown and described with reference to FIGS. 7A-70. As shown in FIG. 7P, an indication 742 is displayed with virtual representation 740. In some embodiments, indication 742 includes information regarding a status of user 744b in the communication session. For example, as shown in FIG. 7P, indication 742 includes information regarding why user 744b is being represented by virtual representation 740 in three-dimensional environment 702 (e.g., indication 742 includes information that user 744b has poor network connection (e.g., and thus first computer system 101 does not receive one or more indications from the second computer system corresponding to a location and/or orientation of the current viewpoint of user 744b). In FIG. 7P, indication 742 is displayed above virtual representation 740. In some embodiments, indication 742 is displayed at a different location in three-dimensional environment 702 (e.g., below and/or to the side of virtual representation 740 from the current viewpoint of user 744a). In some embodiments, indication 742 has one or more characteristics of the indication corresponding to the current status of the user of the second computer system in the communication session as described with reference to method 900.

In some embodiments, virtual representation 740 is displayed at a location in three-dimensional environment 702 that is independent from a pose (e.g., location and/or orientation) of the current viewpoint of user 744b. For example, the location and/or orientation of virtual representation 740 in three-dimensional environment 702 is not based on a current location and/or orientation of the current viewpoint of user 744b relative to three-dimensional environment 702. In some embodiments, the location and/or orientation of virtual representation 740 in three-dimensional environment 702 is based on a current location and/or orientation of the current viewpoint of user 744a relative to three-dimensional environment 702. For example, virtual representation 740 is displayed at an orientation in three-dimensional environment 702 such that user 744a has a direct viewing angle to first surface 732a from the current viewpoint of user 744a. For example, virtual representation 740 is displayed at a height relative to three-dimensional environment 702 that is based on a height of the current viewpoint of user 744a relative to three-dimensional environment 702 (e.g., virtual representation is not displayed at a height in three-dimensional environment 702 corresponding to a height of the current viewpoint of user 744b relative to three-dimensional environment 702).

FIG. 7Q illustrates first computer system 101 maintaining display of virtual representation 740 of user 744b at the same pose relative to three-dimensional environment 702 in response to a change in the current viewpoint of user 744b. As shown in overhead view 706, user 744b moves relative to three-dimensional environment 702 (e.g., the movement of user 744b from the position shown in FIG. 7P is represented by arrow 746a). In response to the movement of the current viewpoint of user 744b relative to three-dimensional environment 702, first computer system 101 maintains display of virtual representation 744 at the same location and/or orientation in three-dimensional environment 702 (e.g., overhead view 706 shows virtual representation 740 does not change position and/or orientation compared to as shown in FIG. 7P). In some embodiments, the movement of the current viewpoint of user 744b exceeds the threshold amount of movement (e.g., threshold 722a and/or 722b shown and described with reference to FIGS. 7E-7I). In some embodiments, the second computer system is unable to detect the movement of the current viewpoint of user 744b that exceeds the threshold amount of movement and/or does not provide indication to first computer system 101 corresponding to the movement of the current viewpoint of user 744b. Accordingly, first computer system 101 maintains display of virtual representation 740 at a pose in three-dimensional environment 702 that is independent from the movement of the current viewpoint of user 744b (e.g., in accordance with a virtual representation different from virtual representation 740 (e.g., virtual representation 704a and/or 704b) being displayed in three-dimensional environment to represent user 744b, first computer system 101 displays a representation of movement of the virtual representation corresponding to the movement of the current viewpoint of user 744b). In some embodiments, maintaining display of virtual representation 740 at the pose in three-dimensional environment 702 that is independent form the movement of the current viewpoint of user 744b includes maintaining display of virtual representation 740 at the same height relative to three-dimensional environment 702 (e.g., the height is based on the height of the current viewpoint of user 744a relative to three-dimensional environment 702).

FIG. 7R illustrates first computer system 101 displaying virtual representation 740 at the same orientation relative to the current viewpoint of user 744a as a result of a change in the current viewpoint of user 744a relative to three-dimensional environment 702. As shown in overhead view 706, user 744a moves to a different location relative to three-dimensional environment 702 (e.g., causing a change in the current viewpoint of user 744a relative to three-dimensional environment 702). Additionally, as shown in overhead view 706, user 744b continues to move relative to three-dimensional environment 702 (e.g., as represented by the length of arrow 746b compared to arrow 748a shown in FIG. 7Q). In response to the movement of the current viewpoint of user 744a relative to three-dimensional environment 702, first computer system 101 changes the orientation of virtual representation 740 relative to three-dimensional environment 702 such that first surface 732a is displayed at the same orientation relative to the current viewpoint of user 744a as was displayed prior to the movement of the current viewpoint of user 744a (e.g., at the orientation relative to the current viewpoint of user 744a shown in FIG. 7Q). For example, as shown in FIG. 7R, user 744a has a direct viewing angle (e.g., as represented by a direction of arrow 748a) to virtual representation 740 from the current viewpoint of user 744a. Further, as shown in FIG. 7R, in response to the movement of the current viewpoint of user 744b relative to three-dimensional environment 702, first computer system 101 continues to maintain display of virtual representation 740 at a pose in three-dimensional environment 702 that is independent of the change in the current viewpoint of user 744b (e.g., the change in orientation of virtual representation 740 is based on the change in the current viewpoint of user 744a and is not based on the movement of the current viewpoint of user 744b).

FIG. 7S illustrates first computer system 101 displaying virtual representation 740 concurrently with a virtual representation 750 in three-dimensional environment 702. In some embodiments, virtual representation 750 corresponds to a virtual representation of user 744c (e.g., of a user different from user 744b that is associated with a computer system in the communication session with first computer system 101). In some embodiments, virtual representation 750 corresponds to the same type of virtual representation as virtual representation 740 (e.g., virtual representation 740 and virtual representation 750 have one or more characteristics of the virtual representation of the third type as described with reference to method 900). In some embodiments, virtual representation 750 is a representation of user 744c (e.g., shown in overhead view 706 in FIGS. 7P-7R), and user 744c is associated with a third computer system in the communication session with first computer system 101 and the second computer system. In some embodiments, the third computer system is unable to track movement of one or more portions (e.g., corresponding to the head, eyes, arms, hands and/or torso) of user 744c. Accordingly, first computer system 101 displays representation 750 in three-dimensional environment 702 at a pose that is independent of a current viewpoint of user 744c (e.g., because the third computer system cannot detect movement of the current viewpoint of user 744c relative to three-dimensional environment and/or does not communicate a position and/or orientation of the current viewpoint of user 744c with first computer system 101). As shown in FIG. 7S, virtual representation 750 is displayed with indication 742 including information regarding a current status of the user represented by indication 742 (e.g., indication 742 includes information that the third computer system cannot currently track the one or more portions of user 744b). Further, as shown in FIG. 7S, displaying virtual representation 740 and virtual representation 750 in three-dimensional environment 702 includes displaying virtual representation 740 and virtual representation 750 at the same height relative to three-dimensional environment 702 (e.g., virtual representation 740 and virtual representation 750 are displayed at a height in three-dimensional environment 702 that is based on a height of the current viewpoint of user 744a (e.g., the user viewing three-dimensional environment 702) relative to three-dimensional environment 702). Additionally, as shown in FIG. 7S, displaying virtual representation 740 and virtual representation 750 in three-dimensional environment 702 includes displaying virtual representation 740 and virtual representation 750 with an orientation relative to three-dimensional environment 702 that enables user 744a (e.g., the user viewing three-dimensional environment 702)) to have a direct viewing angle to virtual representation 740 and virtual representation 750 from the current viewpoint of user 744a.

FIG. 8 is a flowchart illustrating an exemplary method 800 of displaying a virtual representation of a user at one or more poses in a three-dimensional environment in response to movement of the current viewpoint of the user in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a first computer system in communication with a display generation component, one or more input devices, and a second computer system. In some embodiments, the first computer system is or includes an electronic device, such as a mobile device (e.g., a tablet, a smartphone, a media player, or a wearable device), or a computer. In some embodiments, the display generation component is a display integrated with the first computer system (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller. In some embodiments, the second computer system has one or more characteristics of the first computer system (e.g., and is in communication with a display generation component and one or more input devices having one or more characteristics of the display generation component and the one or more input devices described with reference to the first computer system).

In some embodiments, while in a communication session with the second computer system, wherein the first computer system is associated with a first user and the second computer system is associated with a second user, the first computer system displays (802a), via the display generation component, a first virtual object representing a pose (e.g., location and/or orientation) of a current viewpoint of the second user of the second computer system relative to a three-dimensional environment, wherein the first virtual object is displayed at a first pose (e.g., position and/or orientation) in the three-dimensional environment representing a first viewpoint of the second user, such as virtual representation 704b displayed in three-dimensional environment 702 in FIG. 7B. In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment includes one or more virtual objects and/or representations of objects in a physical environment of a user of the computer system. In some embodiments, the three-dimensional environment has one or more characteristics of three-dimensional and/or virtual environment described with reference to methods 900, 1100, 1300 and/or 1500. In some embodiments, the communication session is a real-time (e.g., or nearly real-time) communication session that includes audio (e.g., real-time voice audio from the first user and/or the second user, and/or audio content from media shared between the first user and the second user), video (e.g., real-time video of the environment of the first user and/or second user, and/or video content from media shared between the first user and the second user) and/or other shared content (e.g., images, applications, and/or interactive media (e.g., video game media)). In some embodiments, the first computer system optionally initiates and/or receives a request to join the communication session with the second computer system. In some embodiments, in response to initiating and/or receiving the request to join the communication session, the first and/or second computer system initiates display of the three-dimensional environment to facilitate communication between the first user of the first computer system and the second user of the second computer system. In some embodiments, the first virtual object is a virtual representation of the second user that is not an avatar (e.g., the virtual object does not include virtual representations of one or more physical characteristics of the second user, a person and/or an animal). In some embodiments, the first virtual object includes a virtual representation of a shape, such as a circle (e.g., a coin), oval, square, diamond, triangle, sphere, cylinder, cube, cone or cuboid. For example, the shape of the first virtual object includes three dimensions (e.g., length, width and depth relative to the three-dimensional environment). In some embodiments, the first virtual object has one or more standard visual characteristics (e.g., shape and/or size) used by the computer system to represent one or more different users in the three-dimensional environment (e.g., the size, shape, color and/or brightness of the first virtual object is not different based on, and/or customizable to, different users in the communication session (e.g., the communication session includes the first user, second user and optionally one or more additional users)). In some embodiments, displaying the first virtual object includes displaying an annotation adjacent to (e.g., above, below or to the side of) the first virtual object. For example, the annotation includes the name of the second user of the second computer system. In some embodiments, the first pose of the first virtual object corresponds to a pose (e.g., including location and/or orientation) of the current viewpoint of the second user of the computer system relative to the three-dimensional environment. For example, the position of the first virtual object includes an orientation (e.g., based on spherical or polar coordinates) relative to the three-dimensional environment (e.g., relative to a reference location in the three-dimensional environment) that is based on the orientation of the pose of the current viewpoint of the second user of the second computer system relative to the three-dimensional environment. For example, the position of the first virtual object includes an orientation relative to the current viewpoint of the first user of the first computer system that is based on the orientation of the pose of the current viewpoint of the second user of the second computer system relative to the current viewpoint of the first user of the first computer system.

In some embodiments, while displaying the first virtual object at the first pose in the three-dimensional environment, the first computer system receives (802b), from the second computer system, an indication corresponding to a pose (e.g., position and/or orientation) of the current viewpoint of the second user relative to the three-dimensional environment, such as a change in pose of the current viewpoint of second user 708b as shown in overhead view 706 in FIGS. 7E-7K1. In some embodiments, the indication is a signal received from the second computer system (e.g., through a network such as a personal, local, or wide area network), or from one or more servers in communication with the first computer system and the second computer system, corresponding to an input received by one or more input devices of the second computer system. In some embodiments, the indication includes information regarding movement of the current viewpoint of the second user to the pose. For example, the input received by the one or more input devices of the second computer system optionally includes physical movement of at least a portion (e.g., head, neck and/or torso) of the second user relative to the second user's physical environment from a first pose of the portion of the second user to a second pose of the portion of the second user (e.g., the second user's physical environment is optionally not the first user's physical environment). In some embodiments, physical movement of the second user corresponds to movement of the second viewpoint of the user relative to the three-dimensional environment. In some embodiments, movement of the current viewpoint of the second user to the pose includes movement of the second user's head and/or eyes relative to the three-dimensional environment. In some embodiments, movement of the current viewpoint of the second user to the pose includes physical movement of the second user relative to the second user's physical environment (e.g., the second user sits or stands, the second user rotates one or more portions of their body, or the second user moves from a first location in their physical environment to a second location in their physical environment). In some embodiments, movement of the current viewpoint of the second user to the pose optionally does not include physical movement of the second user relative to the second user's physical environment. For example, movement of the current viewpoint of the second user to the pose is caused by an input received by the second computer system corresponding to a request by the second user to move their current viewpoint relative to the three-dimensional environment (e.g., the input is a touch-input provided on a touch-sensitive surface of the second computer system, or the input is an audio input (e.g., a voice command) provided by the second user of the second computer system). In some embodiments, the first computer system receives the indication from the second computer system if the position and/or orientation of the pose corresponds to movement (e.g., based on position and/or orientation) of the current viewpoint of the second user relative to the three-dimensional environment from a previous that satisfies one or more criteria (e.g., as described below). For example, the second computer system determines if the pose of the current viewpoint of the second user satisfies one or more criteria prior to sending the indication to the first computer system. In some embodiments, the indication received by the first computer system from the second computer system optionally does not include movement information. For example, the second computer system sends one or more indications to the first computer system (e.g., routinely during the communication session) corresponding to a current pose (e.g., relative to the three-dimensional environment) of the current viewpoint of the second user, and based on the one or more indications received, the first computer system optionally determines if a change in the current pose of the current viewpoint of the second user satisfies one or more criteria (e.g., such as the one or more criteria described below) and displays the first virtual object at a second pose different from the first pose (e.g., as described below).

In some embodiments, in response to receiving the indication (802c), in accordance with a determination that movement of the current viewpoint of the second user relative to the three-dimensional environment from the first viewpoint of the second user to a second viewpoint of the second user satisfies one or more criteria, including a criterion that is satisfied when the movement of the current viewpoint of the second user exceeds a threshold (e.g., of position and/or orientation) relative to the three-dimensional environment, the computer system displays (802d) the first virtual object at a second pose (e.g., position and/or orientation), different from the first pose (e.g., position and/or orientation), in the three-dimensional environment representing the second viewpoint of the second user, such as displaying virtual representation 704b at the updated pose in FIG. 7M. In some embodiments, the threshold of the current viewpoint of the user includes a threshold distance of the location of the second viewpoint in the three-dimensional environment from the location of the first viewpoint in the three-dimensional environment. For example, the threshold amount distance of the location of the second viewpoint from the location of the first viewpoint in the three-dimensional environment is optionally 0.1, 0.2, 0.5, 0.1, 0.2 0.5, 1, 2, 5, or 10 m. In some embodiments, the threshold includes a threshold change in orientation of the second viewpoint relative to the first viewpoint in the three-dimensional environment. For example, the threshold change in orientation of the second viewpoint is optionally −90, −75, −60, −45, −30, −15, 15, 30, 45, 60, 75, or 90 degrees relative to the orientation of the first viewpoint in the three-dimensional environment. In some embodiments, displaying the first virtual object at the second location includes displaying the first virtual object with a new orientation relative to the three-dimensional environment (e.g., relative to a reference location in the three-dimensional environment, or relative to the current viewpoint of the first user in the three-dimensional environment). For example, the change in orientation of the first virtual object optionally corresponds to the change in orientation of the current viewpoint of the second. In some embodiments, displaying the first virtual object at the second location in the three-dimensional environment includes displaying an annotation associated with the first virtual object (e.g., the name or other identifier of the second user) at the second location in the three-dimensional environment. In some embodiments, the determination that the movement of the current viewpoint of the second user relative to the three-dimensional environment satisfies the one or more criteria is made at the second computer system (e.g., optionally before the first computer system receives the indication). For example, the indication is sent by the second computer system in accordance with the determination that the movement of the current viewpoint of the second user relative to the three-dimensional environment satisfies the one or more criteria. For example, the indication received by the first computer system includes information regarding the determination made by the second computer system.

In some embodiments, in accordance with a determination that the movement of the current viewpoint of the second user does not satisfy the one or more criteria because the movement of the current viewpoint of the second user does not exceed the threshold (e.g., of position and/or orientation) relative to the three-dimensional environment, the computer system maintains display (802e) of the first virtual object at the first pose (e.g., position and/or orientation) in the three-dimensional environment, such as maintaining virtual representation 704b at the same pose in three-dimensional environment 702 as shown in FIG. 7E compared to FIG. 7D in response to movement of the current viewpoint of second user 708b that does not exceed orientation threshold 722a and/or distance threshold 722b. In some embodiments, the one or more criteria are not satisfied because the location of the second viewpoint relative to the three-dimensional environment does not differ from the location of the first viewpoint relative to the three-dimensional environment by the threshold amount of distance. In some embodiments, the one or more criteria are not satisfied because the orientation of the second viewpoint relative to the three-dimensional environment does not differ from the orientation of the first viewpoint relative to the three-dimensional environment by the threshold orientation amount. In some embodiments, the one or more criteria are not satisfied because the movement of the current viewpoint does not exceed the threshold speed, threshold magnitude of movement criterion, threshold change in orientation and/or threshold distance of movement described below. In some embodiments, maintaining display of the first virtual object at the first location in the three-dimensional environment includes maintaining the same position and/or orientation (e.g., including polar or spherical coordinates) relative to the three-dimensional environment (e.g., and/or optionally relative to the current viewpoint of the first user of the first computer system). In some embodiments, maintaining display of the first virtual object at the first location in the three-dimensional environment includes maintaining display of an annotation associated with the first virtual object at the first location in the three-dimensional environment. In some embodiments, the determination that the movement of the current viewpoint of the second user relative to the three-dimensional does not satisfy the one or more criteria is made at the second computer system (e.g., optionally prior to the first computer system receiving the indication). For example, the indication received by the first computer system includes information regarding the determination made by the second computer system. In some embodiments, in accordance with the determination that the movement of the current viewpoint of the second user does not satisfy the one or more criteria because the second viewpoint of the second user differs from the first viewpoint of the second user by less than the threshold, the second computer system forgoes sending the indication to the first computer system. Changing a location (e.g., and/or orientation) of a virtual object representing a pose of a viewpoint of a user of a computer system in a three-dimensional environment when the computer system detects movement of the viewpoint of the user relative to the three-dimensional environment that exceeds a threshold amount ensures that a respective user of a respective computer system in communication with the computer system is provided visual feedback of a change of location (e.g., and/or orientation) of the viewpoint of the user without providing unnecessary distraction from the three-dimensional environment when movement that exceeds the threshold is not detected, thereby avoiding unnecessary consumption of computing resources and improving user device interaction.

In some embodiments, the threshold includes a threshold speed of the movement of the current viewpoint of the second user from the first viewpoint of the second user to the second viewpoint of the second user relative to the three-dimensional environment (e.g., the speed of movement of the current viewpoint of second user 708b in FIGS. 7E-7K1). In some embodiments, the threshold speed of movement of the current viewpoint of the second user is 0.5, 0.1, 0.2, 0.5, 1, 2, or 5 meters per second relative to the three-dimensional environment. Detecting movement of the current viewpoint of the second user relative to the threshold speed optionally includes detecting the speed of movement of a portion (e.g., head) of the second user relative to the second user's physical environment. In some embodiments, movement of the current viewpoint of the second user that exceeds the threshold speed of movement is independent of a distance and/or magnitude of the movement of the current viewpoint of the second user relative to the three-dimensional environment (e.g., the first computer system does not take into account the distance and/or magnitude of movement of the current viewpoint of the first user when determining if the movement of the current viewpoint of the second user exceeds the threshold speed of movement). For example, movement of the first viewpoint of the second user that exceeds the threshold speed of movement is independent of a distance and/or magnitude of movement from the first viewpoint of the second user relative to the three-dimensional environment. In some embodiments, the threshold includes a threshold velocity of the movement of the current viewpoint of the second user from the first viewpoint of the second user to the second viewpoint of the second user relative to the three-dimensional environment. Detecting movement of the current viewpoint of the second user relative to the threshold velocity optionally includes detecting the velocity of movement of at least a portion (e.g., head, torso and/or shoulders) of the second user relative to the second user's physical environment. In some embodiments, the threshold includes speed of movement and one or more of the thresholds described below. Changing a location (e.g., and/or orientation) of a virtual object representing a pose of a viewpoint of a user of a computer system in a three-dimensional environment when the computer system detects movement of the viewpoint of the user relative to the three-dimensional environment that exceeds a threshold speed of movement ensures that a respective user of a respective computer system in communication with the computer system is provided visual feedback of a change of location (e.g., and/or orientation) of the viewpoint of the user without providing unnecessary distraction from the three-dimensional environment when movement that exceeds the threshold speed of movement is not detected, thereby avoiding unnecessary consumption of computing resources and improving user device interaction.

In some embodiments, the threshold includes a threshold magnitude of the movement of the current viewpoint of the second user from the first viewpoint of the second user to the second viewpoint of the second user relative to the three-dimensional environment, such as distance and/or magnitude threshold 722b shown in overhead view 706 in FIG. 7E. In some embodiments, the threshold magnitude of the movement of the current viewpoint of the second user is 0.5, 0.1, 0.2, 0.5, 1, 2, 5 or 10 meters relative to the three-dimensional environment. In some embodiments, detecting the magnitude of the movement of the current viewpoint of the second user includes determining the displacement of the current viewpoint of the second user from a first location in the three-dimensional environment associated with the first viewpoint of the second user to a second location in the three-dimensional environment associated with a second viewpoint of the second user. Detecting movement of the current viewpoint of the second user relative to the threshold magnitude optionally includes detecting the magnitude of movement of at least a portion (e.g., head, torso and/or shoulders) of the second user relative to the second user's physical environment. In some embodiments, detecting movement of the current viewpoint of the second user relative to the threshold magnitude of movement of the current viewpoint includes detecting the magnitude of movement of the second user relative to a location in the three-dimensional environment (e.g., the first location) associated with the first viewpoint of the second user (e.g., relative to the respective viewpoint of the second user that the second user moved from). In some embodiments, the threshold includes magnitude of movement and one or more of the thresholds described above and below. Changing a location (e.g., and/or orientation) of a virtual object representing a pose of a viewpoint of a user of a computer system in a three-dimensional environment when the computer system detects movement of the viewpoint of the user relative to the three-dimensional environment that exceeds a threshold magnitude of movement ensures that a respective user of a respective computer system in communication with the computer system is provided visual feedback of a change of location (e.g., and/or orientation) of the viewpoint of the user without providing unnecessary distraction from the three-dimensional environment when movement that exceeds the threshold magnitude of movement is not detected, thereby avoiding unnecessary consumption of computing resources and improving user device interaction.

In some embodiments, the threshold includes a threshold change in orientation of the current viewpoint of the second user from the first viewpoint of the second user to the second viewpoint of the second user relative to the three-dimensional environment, such as orientation threshold 722b shown in overhead view 706 in FIG. 7E. In some embodiments, the threshold change in orientation of the current viewpoint of the second user is 1, 2, 5, 7, 10, 15, 20, 25, 30, 35, 40, 45, 50, 60, 70, 80 or 90 degrees relative to the three-dimensional environment. In some embodiments, detecting the threshold change in orientation of the current viewpoint of the second user includes determining the difference between a first orientation (e.g., using spherical or polar coordinates) relative to the three-dimensional environment (e.g., relative to a reference location in the three-dimensional environment) associated with the first viewpoint of the second user and a second orientation relative to the three-dimensional environment associated with the second viewpoint of the second user. Detecting change in orientation of the current viewpoint of the second user relative to the threshold change in orientation optionally includes detecting the change in orientation of at least a portion (e.g., head, torso and/or shoulders) of the second user relative to the second user's physical environment. In some embodiments, detecting a change in orientation of the current viewpoint of the second user relative to the threshold change in orientation includes detecting a change in orientation of the current viewpoint of the second user relative to an orientation associated with the first viewpoint of the second user (e.g., relative to the respective viewpoint of the second user that the second user moved from). In some embodiments, the threshold includes change in orientation and one or more of the thresholds described above and below. Changing a location (e.g., and/or orientation) of a virtual object representing a pose of a viewpoint of a user of a computer system in a three-dimensional environment when the computer system detects movement of the viewpoint of the user relative to the three-dimensional environment that exceeds a threshold change of orientation ensures that a respective user of a respective computer system in communication with the computer system is provided visual feedback of a change of location (e.g., and/or orientation) of the viewpoint of the user without providing unnecessary distraction from the three-dimensional environment when movement that exceeds the threshold change in orientation is not detected, thereby avoiding unnecessary consumption of computing resources and improving user device interaction.

In some embodiments, the threshold includes a threshold distance of the movement of the current viewpoint of the second user from the first viewpoint of the second user to the second viewpoint of the second user relative to the three-dimensional environment, such as distance threshold 722b shown in overhead view 706 in FIG. 7E. In some embodiments, the threshold distance of the movement of the current viewpoint of the second user is 0.5, 0.1, 0.2, 0.5, 1, 2, 5 or 10 meters relative to the three-dimensional environment. In some embodiments, detecting the distance of the movement of the current viewpoint of the second user include determining the distance of overall movement (e.g., based on a path of movement) from a first location in the three-dimensional environment associated with the first viewpoint of the second user to a second location in the three-dimensional environment associated with the second viewpoint of the second user. Detecting movement of the current viewpoint of the second user relative to the threshold distance optionally includes detecting the distance of movement of at least a portion (e.g., head, torso and/or shoulders) of the second user relative to the second user's physical environment. In some embodiments, detecting a change in distance of the current viewpoint of the second user relative to the threshold change in distance includes detecting a change in distance of the current viewpoint of the second user relative to a location (e.g., the first location) associated with the first viewpoint of the second user (e.g., relative to the respective viewpoint of the second user that the second user moved from). In some embodiments, the threshold includes distance of movement and one or more of the thresholds described above. Changing a location (e.g., and/or orientation) of a virtual object representing a pose of a viewpoint of a user of a computer system in a three-dimensional environment when the computer system detects movement of the viewpoint of the user relative to the three-dimensional environment that exceeds a threshold distance of movement ensures that a respective user of a respective computer system in communication with the computer system is provided visual feedback of a change of location (e.g., and/or orientation) of the viewpoint of the user without providing unnecessary distraction from the three-dimensional environment when movement that exceeds the threshold distance of movement is not detected, thereby avoiding unnecessary consumption of computing resources and improving user device interaction.

In some embodiments, displaying the first virtual object at the first pose in the three-dimensional environment includes displaying the first virtual object at a first orientation relative to the three-dimensional environment that corresponds to an orientation of the first viewpoint of the second user relative to the three-dimensional environment (e.g., the orientation of virtual representation 704b relative to three-dimensional environment 702 shown in FIGS. 7B-7D), and displaying the first virtual object at the second pose in the three-dimensional environment includes displaying the first virtual object at a second orientation, different from the first orientation, relative to the three-dimensional environment that corresponds to an orientation of the second viewpoint of the second user relative to the three-dimensional environment (e.g., the orientation of virtual representation 704b relative to three-dimensional environment 702 shown in FIG. 7F or FIG. 7G. In some embodiments, the first orientation and the second orientation correspond to spherical or polar coordinates relative to a reference location in the three-dimensional environment. In some embodiments, displaying the first virtual object at the first pose includes displaying the first virtual object at a first orientation relative to the three-dimensional environment and at a first location in the three-dimensional environment, and displaying the first virtual object at the second pose includes displaying the first virtual object at a second orientation relative to the three-dimensional environment and at a second location, different from the first location, in the three-dimensional environment. In some embodiments, displaying the first virtual object at the first orientation includes displaying a first surface (e.g., including one or more characteristics of the first surface described below) of the first virtual object oriented in a first direction associated with the first viewpoint of the second user relative to the three-dimensional environment, and displaying the first virtual object at the second orientation includes displaying the first surface of the first virtual object oriented in a second direction associated with the second viewpoint of the second user relative to the three-dimensional environment. In some embodiments, displaying the first virtual object at the second pose includes displaying the first virtual object at the second orientation in accordance with a determination that the movement of the current viewpoint of the second user relative to the three-dimensional environment exceeds the threshold change in orientation as described above (e.g., in accordance with a determination that the movement of the current viewpoint of the second user exceeds a distance and/or magnitude threshold (e.g., including one or more characteristics of the threshold distance of movement and/or threshold magnitude of movement as described above) and does not exceed the change in orientation threshold (e.g., including one or more characteristics of the change in orientation threshold as described above), displaying the first virtual object at the second pose includes displaying the first virtual object at a different location in the three-dimensional and does not include displaying the first virtual object at a different orientation in the three-dimensional environment compared to displaying the first virtual object at the first pose). In some embodiments, displaying the first virtual object at the first orientation relative to the three-dimensional environment includes displaying the first virtual object at a first orientation relative to the first viewpoint of the first user. In some embodiments, displaying the first virtual object at the second orientation relative to the three-dimensional environment includes displaying the first virtual object at a second orientation, different from the first orientation, relative to the first viewpoint of the first user (e.g., displaying the first virtual object at the second orientation includes changing the orientation of the first virtual object relative to the first viewpoint of the first user). Displaying a virtual object representing a pose of a viewpoint of a user of a computer system in a three-dimensional environment at an orientation relative to the three-dimensional environment that represents an orientation of the pose of the viewpoint of the user relative to the three-dimensional environment ensures that a respective user of a respective computer system in communication with the computer system is provided visual feedback of the current orientation of the user's viewpoint relative to the three-dimensional environment and is informed of an area of the three-dimensional environment that is viewable by the second user, thereby reducing errors in interaction during the communication session.

In some embodiments, while displaying the first virtual object at the first pose in the three-dimensional environment, the computer system displays an indication in the three-dimensional environment corresponding to an identifier of the second user at a first orientation relative to the three-dimensional environment (e.g., indication 718 displayed with virtual representation 704b in Fig. E), wherein the first orientation is based on a current viewpoint of the first user relative to the three-dimensional environment. In some embodiments, in response to receiving the indication, the computer system maintains display of the indication corresponding to the identifier of the second user in the three-dimensional environment at the first orientation relative to the three-dimensional environment, such as shown by the orientation of indication 718 in FIG. 7F or FIG. 7G. In some embodiments, the identifier corresponds to a name of the second user (e.g., the name is associated with a user profile of the second user (e.g., optionally stored by the second computer system and/or shared in the communication session), or the name corresponds to a username created (e.g., in the communication session) by the second user). In some embodiments, the indication corresponding to the identifier of the second user is displayed adjacent to the first virtual object (e.g., above or below the first virtual object relative to the first viewpoint of the first user). In some embodiments, the indication corresponding to the identifier of the second user includes a virtual container (e.g., the identifier of the second user is displayed within the virtual container). In some embodiments, when displaying the indication corresponding to the identifier of the second user at the first orientation relative to the three-dimensional environment, the first user has a direct viewing angle to the indication corresponding to the identifier of the second user (e.g., from the first viewpoint of the first user). For example, the viewing angle is perpendicular (e.g., or within 0.1, 0.5, 1, 2, 5, or 10 degrees of perpendicular) to a center of a surface of the indication corresponding to the identifier of the second user. In some embodiments, the computer system maintains display of the indication corresponding to the identifier of the second user at the first orientation in the three-dimensional environment if the computer system ceases display of the first virtual object in the three-dimensional environment while changing the display of the first virtual object from the first pose to the second pose. In some embodiments, the computer system does not maintain display of the indication corresponding to the identifier of the second user in the three-dimensional environment if the computer system ceases display of the first virtual object in the three-dimensional environment while changing the display of the first virtual object from the first pose to the second pose (e.g., the computer system redisplays the indication corresponding to the identifier of the second user at the first orientation when redisplaying the first virtual object in the three-dimensional environment). Maintaining an orientation of an indication corresponding to an identifier of a user of a computer system with a virtual object that changes orientation relative to the three-dimensional environment enables the indication corresponding to the identifier of the user to be consistently viewed by a respective user of a respective computer system in communication with the computer system independent of a current orientation of the virtual object relative to the three-dimensional environment, thereby reducing errors in interaction during the communication session (e.g., caused by the respective user not correctly identifying the user).

In some embodiments, displaying the first virtual object in the three-dimensional environment includes displaying the first virtual object with a first surface oriented in a first direction corresponding to the current viewpoint of the second user relative to the three-dimensional environment, wherein the first surface is displayed with a first visual appearance (e.g., such as first surface 732a shown in FIG. 7B), and displaying the first virtual object with a second surface oriented in a second direction, opposite from the first direction, wherein the second surface is displayed with a second visual appearance, different from the first visual appearance (e.g., such as second surface 732b shown in FIG. 7G). In some embodiments, the first virtual object is shaped as a three-dimensional coin, and the first surface corresponds to a first side of the three-dimensional coin, and the second surface corresponds to a second side of the three-dimensional coin opposite of the first side. In some embodiments, the first virtual object is a three-dimensional shape different from a coin (e.g., including one or more of the three-dimensional shapes described with reference to step(s) 802, and the first surface and the second surface are different sides of the shape. In some embodiments, the first visual appearance and the second visual appearance share one or more visual features (e.g., the first surface and the second surface are the same relative size, are the same shape and/or are displayed with the same color and/or brightness). In some embodiments, the first surface has one or more features that the second surface does not include (e.g., an annotation and/or icon). Displaying a virtual object representing a pose of a viewpoint of a user of a computer system in a three-dimensional environment with a first surface with a first visual appearance and a second surface, opposite the first surface, with a second visual appearance different from the first visual appearance provides visual feedback of the current orientation of the user's viewpoint (e.g., by distinguishing a first side of the first virtual object and a second side of the first virtual object) to a respective user of a respective computer system in communication with the computer system and informs the respective user of an area of the three-dimensional environment that is viewable by the second user from their current viewpoint, thereby reducing errors in interaction during the communication session.

In some embodiments, displaying the first surface with the first visual appearance includes displaying an identifier of the second user on the first surface, such as the identifier displayed on first surface 732a in FIG. 7B, and displaying the second surface with the second visual appearance includes displaying the second surface without including an identifier of the second user on the second surface, such as second surface 732b displayed without an identifier in FIG. 7G. In some embodiments, the identifier includes a monogram (e.g., including letters and/or symbols). For example, the monogram includes initials corresponding to a name of the second user (e.g., associated with a user profile of the second user or a username). In some embodiments, the identifier is created by the second user (e.g., through the second computer system). In some embodiments, the identifier is created based on information in a user profile of the second user (e.g., optionally stored in a memory of the second computer system). In some embodiments, when entering the communication session, the second computer system shares information from the user profile with the first computer system (e.g., and the first computer system uses the information from the user profile to display the identifier on the first surface of the first virtual object). In some embodiments, the identifier has one or more features of an avatar (e.g., including one or more characteristics of a virtual representation of the second type as described with reference to method 900). For example, the identifier has one or more features of the face of the avatar of the second user. Displaying a virtual object representing a pose of a viewpoint of a user of a computer system in a three-dimensional environment with a first surface that includes an identifier of the user and a second surface that does not include the identifier provides visual feedback of the current orientation of the user's viewpoint (e.g., by distinguishing the direction of the user's viewpoint with the identifier) to a respective user of a respective computer system in communication with the computer system and informs the respective user of an area of the three-dimensional environment that is viewable by the second user from their current viewpoint, thereby reducing errors in interaction during the communication session.

In some embodiments, the first virtual object at the first pose is a first distance from the first viewpoint of the first user, and has a first size relative to the three-dimensional environment, such as displaying virtual representation 704b with the size and distance from the current viewpoint of first user 708a in FIG. 7E. In some embodiments, the first virtual object at the second pose is a second distance, different from the first distance, from the first viewpoint of the first user, and has the first size relative to the three-dimensional environment, such as displaying virtual representation 704b with the size and distance from the current viewpoint of first user 708a in FIG. 7M. In some embodiments, the first virtual object at the first pose includes a first size relative to the first viewpoint of the first user, and the first virtual object at the second pose includes a second size relative to the first viewpoint of the first user (e.g., because the size of the virtual object relative to the three-dimensional environment is maintained as the first virtual object is moved to a different location in the three-dimensional environment (e.g., a location closer or farther to the first viewpoint of the first user)). For example, if the second distance is a distance relative to the three-dimensional environment that is farther from the first viewpoint of the first user compared to the first distance, the display size of the first virtual object is smaller at the second pose compared to the first pose from the first viewpoint of the first user. In some embodiments, the computer system maintains the shape and/or color of the first virtual object at the second distance from the current viewpoint of the first user compared to at the first distance from the current viewpoint of the first user. Maintaining a size of a virtual object representing a pose of a current viewpoint of a user of a computer system relative to a three-dimensional environment in response to a change in viewpoint of the user relative to the three-dimensional provides a respective user of a respective computer system in communication with the computer system perspective of the distance of their respective viewpoint from the current viewpoint of the user and informs the respective user of an area of the three-dimensional environment that is viewable by the second user from their current viewpoint, thereby reducing errors in interaction during the communication session.

In some embodiments, the first virtual object at the first pose includes an indication corresponding to an identifier of the second user, wherein the indication corresponding to the identifier of the second user is a first distance from the first viewpoint of the first user, and has a first size relative to the three-dimensional environment, such as the size of indication 718 shown in FIG. 7E. In some embodiments, the indication corresponding to the identifier of the second user has one or more characteristics of the indication corresponding to the identifier of the second user corresponding to the identifier of the second user as described above. The indication corresponding to the identifier of the second user is optionally the same distance from the first viewpoint of the first user as the first virtual object at the first pose. In some embodiments, the indication corresponding to the identifier of the second user has the first orientation relative to the three-dimensional environment, as described with reference to the first orientation of the indication corresponding to the identifier of the second user above, while the first virtual object is at the first pose. In some embodiments, the first size is different from the size of the first virtual object relative to the three-dimensional environment. In some embodiments, the indication corresponding to the identifier of the second user is displayed at a first spatial arrangement relative to the first virtual object when the first virtual object is at the first pose (e.g., the indication corresponding to the identifier of the second user is displayed in a location in the three-dimensional environment below the first virtual object relative to the first viewpoint of the first user).

In some embodiments, the first virtual object at the second pose includes the indication corresponding to the identifier of the second user, wherein the indication corresponding to the identifier of the second user is a second distance from the first viewpoint of the first user, and has a second size, different from the first size, relative to the three-dimensional environment, such as the size of indication 718 shown in FIG. 7M. The indication corresponding to the identifier of the second user is optionally the same distance from the first viewpoint of the first user as the first virtual object at the second pose. In some embodiments, the computer system dynamically changes the size of the indication corresponding to the identifier of the second user relative to the three-dimensional environment to maintain the indication corresponding to the identifier of the second user at the same display size relative to the first viewpoint of the first user when the indication corresponding to the identifier of the second user changes location in the three-dimensional environment. In some embodiments, the indication corresponding to the identifier of the second user has the first orientation relative to the three-dimensional environment, as described with reference to the first orientation of the indication corresponding to the identifier of the second user above, while the first virtual object is at the second pose (e.g., as the indication corresponding to the identifier of the second user changes distance in the three-dimensional environment from the first viewpoint of the first user, the indication corresponding to the identifier of the second user maintains its orientation relative to the three-dimensional environment.) In some embodiments, the indication corresponding to the identifier of the second user is displayed with the first spatial arrangement relative to the first virtual object when the first virtual object is at the second pose (e.g., the indication corresponding to the identifier of the second user maintains the same spatial arrangement relative to the first virtual object when the computer system changes the pose of the first virtual object relative to the three-dimensional environment from the first pose to the second pose). In some embodiments, the first virtual object and the indication corresponding to the identifier of the second user include different size behavior when moved in the three-dimensional environment. For example, in accordance with a change in spatial arrangement of the first virtual object and the indication corresponding to the identifier of the second user relative to current viewpoint of the first user, the size of the first virtual object is maintained relative to the three-dimensional environment (e.g., the display size of the first virtual object changes based on the change of spatial arrangement of the first virtual object relative to the current viewpoint of the first user) while the size of the indication corresponding to the identifier of the second user is changed relative to the three-dimensional environment (e.g., the display size of the indication corresponding to the identifier of the second user is maintained despite a change in spatial arrangement of the indication corresponding to the identifier of the second user relative to the current viewpoint of the first user). Changing a size of an indication corresponding to a identifier of a user of a computer system that is displayed concurrently with a virtual object representing a pose of a current viewpoint of the user in response to a change in viewpoint of the user relative to the three-dimensional environment enables the indication corresponding to the identifier of the user to be consistently viewed by a respective user of a respective computer system in communication with the computer system (e.g., by maintaining the same size of the indication corresponding to the identifier of the user relative to a current viewpoint of the respective user) when the virtual object is moved in the three-dimensional environment based on the change in the viewpoint of the user, thereby reducing errors in interaction during the communication session (e.g., caused by the respective user not correctly identifying the user).

In some embodiments, while displaying the first virtual object in the three-dimensional environment, the computer system displays a second virtual object in the three-dimensional environment representing a pose of a current viewpoint of a third user of a third computer system in the communication session relative to the three-dimensional environment, wherein the first virtual object is displayed with a respective visual characteristic having a first value, and the second virtual object is displayed with the respective visual characteristic having a second value, different from the first value, such as shown by the difference in visual appearance between virtual representation 724b and virtual representation 726b in FIG. 7O. In some embodiments, the second virtual object has one or more characteristics of the first virtual object as described above. In some embodiments, the respective visual characteristic includes color. For example, the first virtual object is displayed in the three-dimensional environment with a first color and the second virtual object is displayed in the three-dimensional environment with a second color different from the first color. In some embodiments, the respective visual characteristics includes brightness. For example, the first virtual object is displayed in the three-dimensional environment with a first brightness (e.g., relative to the first viewpoint of the first user) and the second virtual object is displayed in the three-dimensional environment with a second brightness different from the first brightness. In some embodiments, the respective visual characteristic includes an identifier (e.g., including one or more characteristics of the identifier of the second user as described above). For example, the first virtual object is displayed in the three-dimensional environment with a first identifier, and the second virtual object is displayed in the three-dimensional environment with a second identifier different from the first identifier. Displaying a first virtual object representing a pose of a current viewpoint of a first user of a first computer system with a first visual appearance (e.g., including a visual characteristic of a first value), and a second virtual object representing a pose of a current viewpoint of a second user of a second computer system with a second visual appearance (e.g., including a visual characteristic of a second value) in a three-dimensional environment while the first computer system and the second computer system are in communication with a respective computer system enables a respective user of the respective computer system to identify and distinguish the pose of the current viewpoint of the first user from the pose of the current viewpoint of the second user in the three-dimensional environment, thereby reducing errors in interaction during the communication session (e.g., caused by the respective user not correctly distinguishing the first user from the second user).

In some embodiments, displaying the first virtual object in the three-dimensional environment includes displaying the first virtual object with an animation (e.g., a slight jiggling, waving, bobbing, or other periodic, random, or pseudo random movement) that is independent of movement of the current viewpoint of the second user relative to the three-dimensional environment, such as animation 714 shown in FIG. 7B. In some embodiments, the animation of the first virtual object is displayed even if there is no movement of the current viewpoint of the second user relative to the three-dimensional environment (e.g., the animation is not displayed in response to an indication received from the second computer system corresponding to a pose of the current viewpoint of the second user). In some embodiments, the first virtual object is displayed concurrently with an indication corresponding to an identifier of the second user (e.g., including one or more characteristics of the indication corresponding to the identifier of the second user as described above), and displaying the first virtual object with the animation does not include displaying the indication corresponding to the identifier of the second user with the animation. In some embodiments, displaying the first virtual object in the three-dimensional environment does include displaying the indication corresponding to the identifier of the second user with the animation. The first virtual object is optionally displayed with the animation while the first virtual object changes pose relative to the three-dimensional environment (e.g., from the first pose to the second pose). In some embodiments, while the first virtual object changes poses relative to the three-dimensional environment, the computer system ceases to display the first virtual object with the animation (e.g., movement of the first virtual object from the first pose to the second pose is not displayed concurrently with the animation). In some embodiments, the animation corresponds to movement of the first virtual object relative to the first viewpoint of the first user in the three-dimensional environment (e.g., the movement associated with the animation includes less movement (e.g., relative to distance, magnitude, speed and/or change of orientation) of the first virtual object relative to the three-dimensional environment compared to movement of the first virtual object from the first pose to the second pose). Displaying a first virtual object representing a current pose of a current viewpoint of a user of a computer system in a three-dimensional environment with an animation that is independent of movement of the current viewpoint of the user increases comfort of a respective user of a respective computer system in communication with the computer system by displaying movement of the virtual object when the virtual object is not changing location and/or orientation in the three-dimensional environment (e.g., by preventing the virtual object from appearing locked in a position in the three-dimensional environment relative to a viewpoint of the respective user), thereby improving user device interaction.

In some embodiments, displaying the animation includes displaying the first virtual object oscillating (e.g., with periodic, random, or pseudo-random motion) about a current location of the current viewpoint of the second user (and/or the current location of the first virtual object) relative to the three-dimensional environment, such as virtual representation 704b oscillating about a location in three-dimensional environment 702 as shown in FIG. 7B. In some embodiments, displaying the first virtual object oscillating about the current location of the current viewpoint of the second user relative to the three-dimensional environment includes displaying vertical movement of the first virtual object in the three-dimensional environment. For example, the computer system moves the first virtual object to a first position above the current location of the current viewpoint of the second user relative to the three-dimensional environment, and, after moving the first virtual object to the first position, the computer system moves the first virtual object to a second position below the current location of the current viewpoint of the second user relative to the three-dimensional environment (e.g., the first virtual object passes the current location of the current viewpoint of the second user while moving from the first position above the current location of the current viewpoint of the second user to the second position below the current location of the current viewpoint of the second user). In some embodiments, displaying the first virtual object oscillating about the current location of the current viewpoint of the second user relative to the three-dimensional environment includes displaying lateral movement of the first virtual object in the three-dimensional environment For example, the computer system moves the first virtual object to a first position on a first lateral side of the current location of the current viewpoint of the second user in the three-dimensional environment, and after moving the first virtual object to the first position, the computer system moves the first virtual object to a second position on a second lateral side of the current location of the current viewpoint of the second user relative to the three-dimensional environment (e.g., the first virtual object passes the current location of the current viewpoint of the second user while moving from the first position on the first lateral side of the current location of the current viewpoint of the second user to the second position on the second lateral side of the current location of the current viewpoint of the second user). Displaying the first virtual object oscillating about the current location of the current viewpoint of the second user relative to the three-dimensional environment optionally includes vertical and/or lateral movement of the first virtual object in the three-dimensional environment. In some embodiments, displaying the animation includes displaying consistent oscillation of the first virtual object about the current location of the current viewpoint of the second user (e.g., when the first virtual object is displayed at a pose in the three-dimensional environment). In some embodiments, displaying the animation includes displaying periodic oscillation of the first virtual object about the current location of the current viewpoint of the second user (e.g., the first virtual object is displayed with oscillating movement in the three-dimensional environment every 0.1, 0.2, 0.5, 1, 2, 5, or 10 seconds). Displaying a first virtual object representing a current pose of a current viewpoint of a user of a computer system in a three-dimensional environment with oscillation that is independent of movement of the current viewpoint of the user increases comfort of a respective user of a respective computer system in communication with the computer system by displaying movement of the virtual object when the virtual object is not changing location and/or orientation in the three-dimensional environment (e.g., by preventing the virtual object from appearing locked in a position in the three-dimensional environment relative to a viewpoint of the respective user), thereby improving user device interaction.

In some embodiments, displaying the first virtual object in the three-dimensional environment includes displaying the first virtual object with a first surface oriented in a first direction relative to the three-dimensional environment, the first surface including a flat surface with a first value of a dimension (e.g., width or diameter) relative to the three-dimensional environment, such as the width first surface 732a shown in FIG. 7B. In some embodiments, displaying the first virtual object with a second surface oriented in a second direction, opposite from the first direction, relative to the three-dimensional environment, the second surface including a flat surface with the first value of the dimension relative to the three-dimensional environment, such as the width second surface 732b shown in FIG. 7G, wherein the first surface is arranged at a first distance from the second surface, the first distance having a second value, less than the first value, relative to the three-dimensional environment, such as a width of a side surface (e.g., between first surface 732a and second surface 732b) of virtual representation 704b shown in FIG. 7F. In some embodiments, the first surface oriented in the first direction has one or more characteristics of the first surface described above. In some embodiments, the second surface oriented in the second direction has one or more characteristics of the second surface described above. In some embodiments, the dimension includes a dimension of a shape that the first virtual object is represented as (e.g., including one or more shapes of the first virtual object as described with reference to step(s) 802. For example, the dimension is the length, width, or diameter of the surface relative to the three-dimensional environment. In some embodiments, the first surface and the second surface include the same dimensions (e.g., the first surface and the second surface correspond to two equal sides of a three-dimensional shape). In some embodiments, the first surface and the second surface correspond to opposite sides of a flat shape or object (e.g., such that the orientation (e.g., a direction of the first surface and/or second surface) of the first virtual object is identifiable relative to the three-dimensional environment). In some embodiments, the first value of the dimension is about 1.5, 2, 4, 6, 8, 10, 15, 20, 25 or 50 times larger than the first distance between the first surface and the second surface. Displaying a virtual object representing a pose of a viewpoint of a user of a computer system in a three-dimensional environment with a first flat surface oriented in a first direction and a second flat surface oriented in a second direction opposite from the first direction enables the virtual object to be displayed at an orientation representing the an orientation of the viewpoint of the user that can be distinguished (e.g., because of the flat surfaces) relative to the three-dimensional environment by a respective user of a respective computer system in communication with the computer system that is viewing the virtual object in the three-dimensional environment, thereby reducing errors in interaction during the communication session.

In some embodiments, displaying the first virtual object in the three-dimensional environment includes displaying the first virtual object as a three-dimensional virtual object that includes the first distance between the first surface and the second surface, such as shown by the width of the side surface of virtual representation 704b shown in FIG. 7F. In some embodiments, the first distance is 0.1, 0.5, 0.1, 0.2, 0.5, 1, 2, 3, 4, 5 or 10 cm. In some embodiments, the first distance corresponds to a depth of the first virtual object (e.g., the depth is displayed between the first surface and the second surface). For example, the first distance is associated with a dimension of a third surface of the first virtual object (e.g., the first virtual object is displayed as a three-dimensional coin (e.g., circular), and the third surface corresponds to a side surface of the coin spanning the circumference of the coin between the first surface (e.g., the front of the coin) and the second surface (e.g., the back of the coin)). In some embodiments, the first distance corresponds to a thickness of the first virtual object (e.g., between the first surface and the second surface). Displaying a virtual object representing a pose of a viewpoint of a user of a computer system with three-dimensions in a three-dimensional environment including a first surface oriented in a first direction, a second surface oriented in a second direction opposite from the first direction, and a distance between the first surface and the second surface that is less than a dimension (e.g., a width or diameter) of the first surface and the second surface represents the virtual object with a thickness that is smaller than the first surface and the second surface, enabling a respective user of a respective computer system in communication with the computer system to view the virtual object and distinguish the orientation of the viewpoint of the user relative to the three-dimensional environment, thereby reducing errors in interaction during the communication session.

In some embodiments, while displaying the first virtual object at the first pose in the three-dimensional environment, the computer system receives, from the second computer system, an indication corresponding to an audio input received by the second computer system from the second user, such as the audio input received by the second computer system from second user 708b shown in FIG. 7C. In some embodiments, the audio input is detected by one or more input devices (e.g., a microphone) of the second computer system. For example, the audio input is provided by the second user to share with one or more users (e.g., the first user) of one or more computer systems (e.g., the first computer system) in the communication session with the second computer system. In some embodiments, the indication corresponding to the audio input has one or more characteristics of the indication described with reference to step(s) 802.

In some embodiments, in response to receiving the indication corresponding to the audio input received by the second computer system, the computer system displays the first virtual object in the three-dimensional environment with an animation based on the audio input received by the second computer system, such as animation 720 shown in FIG. 7C. In some embodiments, displaying the animation includes displaying one or more virtual elements concurrently with the first virtual object (e.g., the one or more virtual elements are one or more lines displayed optionally with curvature displayed adjacent to one or more sides of the first virtual object). In some embodiments, the animation includes displaying the one or more virtual elements and ceasing to display the one or more virtual elements (e.g., the computer system displays movement of the one or more virtual elements and then ceases to display the one or more virtual elements). In some embodiments, the animation includes displaying movement and expansion (e.g., the space between the one or more virtual elements expands and/or the size of the one or more virtual elements expand in the three-dimensional environment) of the one or more virtual elements (e.g., in a direction away from the first virtual object) in the three-dimensional environment (e.g., the one or more virtual elements are displayed in a first position in the three-dimensional environment and are displaced to a second position in the three-dimensional environment before returning to the first position in the three-dimensional environment). In some embodiments, the animation includes displaying movement of the one or more virtual elements that corresponds to the audio input (e.g., the one or more virtual elements are moved in the three-dimensional environment by the computer system based on the amplitude of the audio input at different time periods (e.g., the computer system displays more movement of the one or more virtual elements if there is audio received by the second computer system of greater intensity (e.g., greater amplitude) compared to audio received by the second computer system of lower intensity). In some embodiments, the animation based on the audio input includes vibration and/or oscillation of the first virtual object based on the audio input (e.g., the first virtual object is displayed with oscillating movement corresponding to the amplitude of the audio input). In some embodiments, the animation based on the audio input is displayed concurrently with the animation that is independent of movement of the current viewpoint of the second user relative to the three-dimensional environment (e.g., as described above). In some embodiments, displaying the animation based on audio input includes ceasing display of the animation that is independent of the movement of the current viewpoint of the second user relative to the three-dimensional environment (e.g., in response to receiving the indication corresponding to the audio input received by the second computer system, the first computer system ceases displaying the animation that is independent of the movement of the current viewpoint of the second user relative to the three-dimensional environment). Displaying a virtual object representing a current viewpoint of a user of a computer system in a three-dimensional environment with an animation in response to an audio input received by the computer system provides visual feedback to a respective user of a respective computer system in communication with the computer system that audio output provided by the respective computer system corresponds to an audio input provided by the user of the computer system, thereby reducing errors in interaction during the communication session.

In some embodiments, displaying the first virtual object at the second pose in the three-dimensional environment includes displaying an animation corresponding to movement of the first virtual object from the first pose to the second pose based on the movement of the current viewpoint of the second user, wherein displaying the animation includes ceasing display of the first virtual object in the three-dimensional environment before the first virtual object reaches the second pose and subsequently redisplaying the first virtual object in the three-dimensional environment, such as animation 740 shown in FIG. 7H and the redisplaying of virtual representation 704b in FIGS. 7L and 7L1. In some embodiments, displaying the animation corresponding to movement that is based on the movement of the current viewpoint of the second user relative to the three-dimensional environment includes moving the first virtual object on a path in the three-dimensional environment from the first pose to the second pose that is based on a path of movement of the current viewpoint of the second user (e.g., including a first portion of the second user (e.g., the second user's head)) relative to the three-dimensional environment (e.g., and/or optionally the path of movement of the current viewpoint of the second user (e.g., the first portion of the second user) relative to the second user's physical environment). For example, if the path of movement of the current viewpoint of the second user relative to the three-dimensional environment includes a change in location of the current viewpoint of the second user relative to the three-dimensional environment and a change in orientation of the current viewpoint of the second user relative to the three-dimensional environment (e.g., relative to a reference location in the three-dimensional environment), displaying the animation corresponding to movement of the first virtual object from the first pose to the second pose includes displaying change in location of the first virtual object and a change in orientation of the first virtual object relative to the three-dimensional environment. In some embodiments, a distance and/or magnitude of movement of the first virtual object corresponds to a distance and/or magnitude of movement of the current viewpoint of the second user relative to the three-dimensional environment. In some embodiments, displaying the animation corresponding to movement of the first virtual object from the first pose to the second pose based on the movement of the current viewpoint of the second user includes displaying a smooth path of movement of the first virtual object. For example, the computer system translates the movement of the current viewpoint of the second user relative to the three-dimensional environment into smoothed movement of the first virtual object from the first pose to the second pose (e.g., by reducing noise and/or outlying detected movement (e.g., irregularities in movement, or movement of a minor nature compared to the overall movement) of the current viewpoint of the second user relative to the three-dimensional environment over a period of time). In some embodiments, in accordance with a determination that the movement of the current viewpoint of the second user exceeds a first threshold distance and/or magnitude relative to the three-dimensional environment, the computer system ceases display of the first virtual object in the three-dimensional environment before the first virtual object reached the second pose. In some embodiments, in accordance with a determination that the movement of the current viewpoint of the second user exceeds a second threshold distance and/or magnitude relative to the three-dimensional environment (e.g., optionally greater than the first threshold distance and/or magnitude), the first virtual object is subsequently redisplayed at an intermediate pose (e.g., between (e.g., relative to orientation and/or location) the first pose and the second pose in the three-dimensional environment). In some embodiments, ceasing to display the first virtual object in the three-dimensional environment includes gradually ceasing to display the first virtual object in the three-dimensional environment (e.g., the first virtual object gradually gains transparency in the three-dimensional environment over 0.1, 0.2, 0.5, 1, 2, 5 or 10 seconds until the first virtual object ceases to be displayed in the three-dimensional environment). In some embodiments, redisplaying the first virtual object in the three-dimensional environment includes gradually redisplaying the first virtual object in the three-dimensional environment (e.g., the first virtual object gradually gains opacity in the three-dimensional environment over 0.1, 0.2, 0.5, 1, 2, 5 or 10 seconds until the first virtual object is redisplayed in the three-dimensional environment with the same visual prominence as prior to the computer system displaying the animation). Displaying an animation while changing a location of a virtual object corresponding to a pose of a viewpoint of a user of a computer system in a three-dimensional environment that includes ceasing to display the virtual object in the three-dimensional environment and redisplaying the virtual object in the three-dimensional environment ensures that a respective user of a respective computer system in communication with the computer system is provided visual indication of a change of location (e.g., and/or orientation) of the viewpoint of the user without providing unnecessary distraction from the three-dimensional environment, thereby avoiding unnecessary consumption of computing resources and improving user device interaction.

In some embodiments, prior to ceasing display of the first virtual object in the three-dimensional environment, the computer system displays movement of the first virtual object away from the first pose that corresponds to the movement of the current viewpoint of the second user away from the first viewpoint, such as the movement of virtual representation 704b shown in FIG. 7H. In some embodiments, displaying movement of the first virtual object away from the first pose includes changing the position (e.g., location and/or orientation) of the first virtual object in the three-dimensional environment based on a path of movement of the current viewpoint of the second user between a viewpoint corresponding to the first pose of the first virtual object and a viewpoint corresponding to the second pose of the first virtual object. For example, movement of the first virtual object away from the first pose includes moving the first virtual object away from a first orientation associated with the first pose (e.g., movement of the first virtual object includes rotational movement of the first virtual object relative to the three-dimensional environment). For example, movement of the first virtual object away from the first pose includes moving the first virtual object away from a first location in the three-dimensional environment associated with the first pose (e.g., movement of the first virtual object includes lateral movement in the three-dimensional environment). In some embodiments, displaying the movement of the first virtual object away from the first pose includes displaying movement of the first virtual object while concurrently changing the visual prominence of the first virtual object relative to the three-dimensional environment. For example, the first virtual object is displayed with a first visual prominence in the three-dimensional environment at the first pose (e.g., including 85, 90, 95, 98, 99 or 100 percent opacity), and displaying movement of the first virtual object away from the first pose includes concurrently reducing the visual prominence of the first virtual object from the first visual prominence in the three-dimensional environment (e.g., by gradually (e.g., over 0.1, 0.5, 1, 2, 5 or 10 seconds) increasing the transparency of the first virtual object until the first virtual object ceases to be displayed in the three-dimensional environment). Displaying movement of a virtual object corresponding to a pose of a viewpoint of a user of a computer system in a three-dimensional environment away from a respective pose prior to ceasing display of the virtual object in the three-dimensional environment provides a visual indication to a respective user of a respective computer system in communication with the computer system of movement of the viewpoint of the user away from the respective pose without providing unnecessary distraction from the three-dimensional environment (e.g., which would otherwise be caused by displaying constant movement of the virtual object in the three-dimensional environment), thereby avoiding unnecessary consumption of computing resources and improving user device interaction.

In some embodiments, displaying movement of the first virtual object away from the first pose includes displaying the movement of the first virtual object with a non-linear velocity relative to the three-dimensional environment (e.g., as represented by the animation 740 shown in FIG. 7H). In some embodiments, the velocity of the first virtual object is not consistent during the movement of the first virtual object away from the first pose. For example, the computer system gradually accelerates the movement of the first virtual object (e.g., at the start of the animation) and subsequently gradually decelerates the movement of the first virtual object (e.g., prior to ceasing display of the first virtual object in the three-dimensional environment). In some embodiments, the movement of the first virtual object away from the first pose is controlled using a nonlinear function stored in a memory of the computer system. Displaying nonlinear movement of a virtual object corresponding to a pose of a viewpoint of a user of a computer system in a three-dimensional environment away from a first pose (e.g., and toward a second pose) prior to ceasing display of the virtual object in the three-dimensional environment provides a visual indication to a respective user of a respective computer system in communication with the computer system of movement of the viewpoint of the user away from the respective pose without providing unnecessary distraction from the three-dimensional environment (e.g., caused by sudden movement of the first virtual object at a linear velocity in the three-dimensional environment), thereby avoiding unnecessary consumption of computing resources and improving user device interaction.

In some embodiments, redisplaying the first virtual object in the three-dimensional environment includes displaying movement of the first virtual object toward the second pose that corresponds to movement of the current viewpoint of the user toward the second viewpoint, such as the movement of virtual representation 704b shown in FIGS. 7L and 7L1. In some embodiments, displaying movement of the first virtual object toward the second pose includes changing the position (e.g., location and/or orientation) of the first virtual object in the three-dimensional environment based on a path of movement of the current viewpoint of the user between a viewpoint corresponding to the first pose of the first virtual object and a viewpoint corresponding to the second pose of the first virtual object. For example, movement of the first virtual object toward the second pose includes moving the first virtual object toward a second orientation associated with the second pose (e.g., movement of the first virtual object includes rotational movement of the first virtual object relative to the three-dimensional environment). For example, movement of the first virtual object toward the second pose includes moving the first virtual object toward a second location in the three-dimensional environment associated with the second pose (e.g., movement of the first virtual object includes lateral movement in the three-dimensional environment). In some embodiments, displaying the movement of the first virtual object toward the first pose includes displaying movement of the first virtual object while concurrently changing the visual prominence of the first virtual object relative to the three-dimensional environment. For example, the animation includes gradually increasing the visual prominence of the first virtual object after ceasing display of the first virtual object (e.g., while moving the first virtual object toward the second pose, the computer system gradually (e.g., over 0.1, 0.5, 1, 2, 5, or 10 seconds) increases the opacity of the first virtual object until the first virtual object is displayed at the second pose (e.g., with the first visual prominence as described above). Displaying movement of a virtual object corresponding to a pose of a viewpoint of a user of a computer system in a three-dimensional environment toward a respective pose when redisplaying the virtual object in the three-dimensional environment provides a visual indication to a respective user of a respective computer system in communication with the computer system of movement of the viewpoint of the user toward the respective pose without providing unnecessary distraction from the three-dimensional environment (e.g., which would otherwise be caused by displaying constant movement of the virtual object in the three-dimensional environment), thereby avoiding unnecessary consumption of computing resources and improving user device interaction.

In some embodiments, displaying movement of the first virtual object toward the second pose includes displaying the movement of the first virtual object with a non-linear velocity relative to the three-dimensional environment (e.g., a velocity that changes over time) (e.g., as represented by the movement of virtual representation 704b in FIGS. 7L and 7L1). In some embodiments, the velocity of the first virtual object is not consistent during the movement of the first virtual object toward the second pose. For example, the computer system gradually accelerates the movement of the first virtual object (e.g., while redisplaying the first virtual object in the three-dimensional environment) and subsequently gradually decelerates the movement of the first virtual object (e.g., prior to displaying the first virtual object at the second pose in the three-dimensional environment). In some embodiments, the movement of the first virtual object toward the second pose is controlled using a nonlinear function stored in a memory of the computer system. Displaying nonlinear movement of a virtual object corresponding to a pose of a viewpoint of a user of a computer system in a three-dimensional environment toward a respective pose while redisplaying the virtual object in the three-dimensional environment provides a visual indication to a respective user of a respective computer system in communication with the computer system of movement of the viewpoint of the user toward the respective pose without providing unnecessary distraction from the three-dimensional environment (e.g., caused by sudden movement of the first virtual object at a linear velocity in the three-dimensional environment), thereby avoiding unnecessary consumption of computing resources and improving user device interaction.

In some embodiments, the animation includes, after ceasing display of the first virtual object in the three-dimensional environment, in accordance with a determination that the movement of the current viewpoint of the second user from the first viewpoint to the second viewpoint exceeds a threshold distance relative to the three-dimensional environment, displaying the first virtual object at one or more intermediate poses in the three-dimensional environment between the first pose and the second pose, wherein the one or more intermediate poses are associated with one or more poses of the current viewpoint of the second user during the movement of the current viewpoint of the second user, such as shown by the display of virtual representation 704b at the intermediate pose in FIG. 7J. In some embodiments, the threshold distance relative to the three-dimensional environment is 0.1, 0.2, 0.5, 1, 2, 5 or 10 meters relative to the three-dimensional environment. In some embodiments, the first virtual object is displayed at one or more intermediate poses in the three-dimensional environment in accordance with a determination that the movement of the current viewpoint of the second user exceeds a threshold magnitude relative to the three-dimensional environment (e.g., 0.1, 0.2, 0.5, 1, 2, 5 or 10 meters relative to a location in the three-dimensional environment associated with the first pose). In some embodiments, the number of intermediate poses that the first virtual object is displayed at in the three-dimensional environment is based on the distance (e.g., or optionally magnitude) of the movement of the current viewpoint of the second user. For example, if the threshold distance relative to the three-dimensional environment is 2 meters, and the movement of the current viewpoint of the second user exceeds 4 meters of movement relative to the three-dimensional environment, the first virtual object is displayed at a first intermediate pose and a second intermediate pose in the three-dimensional environment. In some embodiments, the one or more intermediate poses are associated with one or more locations in the three-dimensional environment that corresponds to one or more locations of the current viewpoint of the second user during the movement of the current viewpoint of the second user relative to the three-dimensional environment. In some embodiments, the one or more intermediate poses are associated with one or more orientations in the three-dimensional environment that correspond to one or more orientations of the current viewpoint of the second user during the movement of the current viewpoint of the second user relative to the three-dimensional environment. In some embodiments, the one or more intermediate poses have one or more locations and/or orientations of the first virtual object during the movement of the current viewpoint of the second user relative to the three-dimensional environment (e.g., the first virtual object is displayed at a respective intermediate pose in the three-dimensional environment when the current viewpoint of the user is at a location and/or orientation relative to the three-dimensional environment that corresponds to the respective intermediate pose during the movement of the current viewpoint of the user). Displaying a virtual object corresponding to a pose of a viewpoint of a user of a computer system at one or more intermediate poses (e.g., between a first pose and a second pose) in a three-dimensional environment in response to movement of the viewpoint of the user from a first pose to a second pose that exceeds a threshold amount ensures that a respective user of a respective computer system in communication with the computer system is provided visual feedback of movement of the viewpoint of the user (e.g., by displaying the virtual object at the one or more intermediate poses) without providing unnecessary distraction from the three-dimensional environment, thereby avoiding unnecessary consumption of computing resources and improving user device interaction.

In some embodiments, displaying the animation includes, while the first virtual object is not displayed in the three-dimensional environment, detecting an event that includes less than a threshold amount of movement (e.g., including one or more characteristics of the threshold amount of movement as described with reference to step(s) 802) of the current viewpoint of the second user for longer than a time threshold (e.g., 0.1, 0.2, 0.5, 1, 2, 5 or 10 second(s)), and in response to detecting the event, redisplaying the first virtual object in the three-dimensional environment at a respective pose corresponding to the current viewpoint of the second user, such as shown by the redisplay of virtual representation 704b as a result of the current viewpoint of second user 708b moving by less than a threshold amount in FIGS. 7L and 7L1-7M. In some embodiments, the event includes the second user ceasing movement of the current viewpoint of the second user relative to the three-dimensional environment. In some embodiments, the respective pose corresponding to the current viewpoint of the second user is the second pose in the three-dimensional environment. In some embodiments, redisplaying the first virtual object in the three-dimensional environment includes one or more characteristics of redisplaying the first virtual object in the three-dimensional environment as described above. In some embodiments, the threshold amount of movement has one or more characteristics of the thresholds described above (e.g., distance, magnitude, speed and/or change in orientation thresholds). For example, the event includes detecting movement of the current viewpoint of the second user that does not exceed the distance and/or magnitude threshold relative to the three-dimensional environment. For example, the event includes detecting movement of the current viewpoint of the second user that does not exceed the speed threshold. For example, the even includes detecting movement of the current viewpoint of the second user that does not exceed the change in orientation threshold relative to the three-dimensional environment. Redisplaying a virtual object corresponding to a pose of a viewpoint of a user of a computer system in response to detecting less than a threshold amount of movement of a viewpoint of the user ensures that a respective user of a respective computer system in communication with the computer system is provided visual feedback of movement of the viewpoint of the user after the viewpoint of the user has settled at a respective pose, which avoids providing unnecessary distraction from the three-dimensional environment (e.g., caused by displaying movement of the virtual object in the three-dimensional environment without the viewpoint of the user settling at a new respective pose), thereby avoiding unnecessary consumption of computing resources and improving user device interaction.

In some embodiments, while displaying the first virtual object in the three-dimensional environment, the computer system receives, from the second computer system, an indication corresponding to an audio input received by the second computer system from the second user, such as the indication of audio input received by first computer system 101 in FIG. 7J. In some embodiments, the indication corresponding to the audio input has one or more characteristics of indications received by the first computer system described above. In some embodiments, the audio input received by the second computer system has one or more characteristics of the audio input received by the second computer system described above.

In some embodiments, in response to receiving the indication corresponding to the audio input received by the second computer system, in accordance with a determination that the first virtual object is displayed at the first pose, the computer system provides audio output corresponding to the audio input received by the second computer system that is spatialized to the first pose of the first virtual object in the three-dimensional environment, such as the audio output provided by first computer system in FIG. 7C. In some embodiments, providing audio output that is spatialized to the first pose in the three-dimensional environment includes providing audio output that is generated such as if emanating from a location in the three-dimensional environment associated with, corresponding to, or the same as the first pose of the first virtual object. In some embodiments, providing audio output that is spatialized to the first pose in the three-dimensional environment includes providing audio output that is generated such as if emanating from an orientation in the three-dimensional environment associated with, corresponding to, or the same as the first pose of the first virtual object (e.g., if a first surface of the first virtual object is oriented away from the current viewpoint of the first user, the audio output is generated as if it has less volume and/or amplitude compared to if the first surface of the first virtual object is oriented toward the current viewpoint of the first user).

In some embodiments, in accordance with a determination that the first virtual object is displayed at the second pose, the computer system provides audio output corresponding to the audio input received by the second computer system that is spatialized to the second pose of the first virtual object in the three-dimensional environment, such as the audio output provided by first computer system in FIG. 7J. In some embodiments, providing audio output that is spatialized to the second pose in the three-dimensional environment includes providing audio output that is generated such as if emanating from a location in the three-dimensional environment associated with, corresponding to, or the same as the second pose of the first virtual object. In some embodiments, providing audio output that is spatialized to the second pose in the three-dimensional environment includes providing audio output that is generated such as if emanating from an orientation in the three-dimensional environment associated with, corresponding to, or the same as the second pose of the first virtual object (e.g., if a first surface of the first virtual object is oriented away from the current viewpoint of the first user, the audio output is generated as if it has less volume and/or amplitude compared to if the first surface of the first virtual object is oriented toward the current viewpoint of the first user). In some embodiments, audio output is spatialized such as if emanating from a location and/or orientation associated with, corresponding to, or the same as the current pose of the first virtual object (e.g., if the first virtual object is at a third pose different from the first pose and the second pose in the three-dimensional environment, the audio output is generated as if emanating from a location and/or orientation associated with, corresponding to, or the same as the third pose of the first virtual object). In some embodiments, the audio output spatialized to the first pose is different from the audio output spatialized to the second pose based on the difference in position (e.g., location and/or orientation) of the first pose compared to the second pose relative to the three-dimensional environment (e.g., the audio output spatialized to the first pose is generated as if it has different volume and/or amplitude compared to the audio output spatialized to the second pose). Spatializing an audio output on a respective computer system corresponding to an audio input received by a user of a computer system that the respective computer system is in communication with to a location associated with a virtual object representing a viewpoint of the user of the computer system provides consistent visual and audio feedback to a respective user of the respective computer system of a location of the viewpoint of the user relative to the three-dimensional environment without causing unnecessary confusion (e.g., by spatializing the audio output to a different location in the three-dimensional environment from the virtual object), thereby avoiding errors in interaction.

In some embodiments, while displaying the first virtual object at the second pose in the three-dimensional environment, the computer system receives, from the second computer system, a second indication (e.g., having one or more characteristics similar or the same the indication described with reference to step(s) 802), different from the indication, corresponding to the pose of the current viewpoint of the second user relative to the three-dimensional environment, such as an indication corresponding to movement of orientation 710b in FIG. 7F. For example, the computer system optionally moves the first virtual object that is displayed at the second pose in response to receiving subsequent one or more indications of the pose of the user of the second user changing.

In some embodiments, in response to receiving the second indication in accordance with a determination that movement of the current viewpoint of the second user relative to the three-dimensional environment from the second viewpoint to a third viewpoint, different from the second viewpoint (e.g., the third viewpoint having one or more characteristics of the first viewpoint and/or the second viewpoint, and optionally corresponding to a different position and/or orientation relative to the three-dimensional environment of the second user), satisfies the one or more criteria, including the criterion satisfied when the movement from the second viewpoint to the third viewpoint exceeds the threshold relative to the three-dimensional environment, the computer system displays the first virtual object at a third pose, different from the second pose, such as an updated pose of virtual object 704b in FIG. 7F. For example, the threshold(s) associated with changing of the current viewpoint described herein optionally apply to the movement of the second user from the second viewpoint to the third viewpoint, relative to the second viewpoint (e.g., the current viewpoint of the user when the second indication is received). Accordingly, the computer system optionally updates the pose of the first virtual object in accordance with a determination that the one or more criteria are satisfied, similar or the same to as described with reference to displaying the first virtual object with the second pose described with reference to step(s) 802.

In some embodiments, in response to receiving the second indication and in accordance with a determination that the movement of the current viewpoint of the user from the second viewpoint to the third viewpoint does not satisfy the one or more criteria, the computer system maintains display of the first virtual object at the second pose in the three-dimensional environment, such as the maintain of visual representation 704 in FIG. 7E. For example, similar or the same as described with reference to maintaining display of the first virtual object at the first pose in the three-dimensional environment described with reference to step(s) 802. Updating or maintaining a pose of the first virtual object in accordance with satisfaction of the one or more criteria with respect to the second pose of the first virtual object facilitates selective updating of a current pose of the first virtual object, thus visually indicating a current orientation and/or movement of the second user and reducing the need to consume power to update the pose of the first virtual object in response to erroneous changes in pose of the second user.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIG. 9 is a flowchart illustrating an exemplary method 900 of displaying different representations of movement of a respective virtual representation of a user based on the respective virtual representation being a virtual representation of a first type or a virtual representations of a second type in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a first computer system in communication with a display generation component, one or more input devices, and a second computer system. In some embodiments, the first computer system has one or more of the characteristics of the computer system(s) described with reference to methods 800, 1100 and/or 1200. In some embodiments, the input device(s) has one or more of the characteristics of the input device(s) described with reference to methods 800, 1100 and/or 1200. In some embodiments, the display generation component has one or more of the characteristics of the display generation component described with reference to methods 800, 1100 and/or 1200. In some embodiments, the second computer system has one or more characteristics of the first computer system (e.g., and is in communication with a display generation component and one or more input devices including one or more characteristics of the display generation component and the one or more input devices described with reference to the first computer system).

In some embodiments, while in a communication session with the second computer system (902a), the first computer system displays (902b), via the display generation component, a virtual representation (e.g., including one or more characteristics of the first virtual object described with reference to method 800) of a pose (e.g., location and/or orientation) of a current viewpoint of a user of the second computer system relative to a three-dimensional environment at a first location in the three-dimensional environment, such as virtual representation 704a or virtual representation 704b shown in FIG. 7B. In some embodiments, the three-dimensional environment has one or more characteristics of three-dimensional and/or virtual environments described with reference to method 800, 1100 and/or 1200. In some embodiments, the communication session has one or more characteristics of the communication described with reference to method 800. In some embodiments, the virtual representation is displayed at a position in the three-dimensional environment that corresponds to the current viewpoint of the user of the second computer system. For example, the position of the virtual representation includes an orientation (e.g., based on spherical or polar coordinates) relative to the three-dimensional environment (e.g., relative to a reference location in the three-dimensional environment) that is based on the orientation and/or location of the current viewpoint of the user of the second computer system relative to the three-dimensional environment. For example, the position of the virtual representation includes an orientation relative to the current viewpoint of a user of the first computer system that is based on the orientation of the current viewpoint of the second viewpoint of the second computer system relative to the current viewpoint of the user of the first computer system.

In some embodiments, while displaying the virtual representation of the pose (e.g., location and/or orientation) of the current viewpoint of the user of the second computer system at the first location in the three-dimensional environment, the first computer system receives (902c), from the second computer system, an indication corresponding to a pose of the current viewpoint of the user relative to the three-dimensional environment (e.g., the indication corresponds to a change in pose of the current viewpoint of second user 708b shown in overhead view 706 in FIGS. 7E-7K1). In some embodiments, the indication has one or more characteristics of the indication described with reference to method 800. In some embodiments, the pose of the current viewpoint of the user is a second pose of the current viewpoint of the user that the user has moved to from a first pose of the current viewpoint of the user. For example, movement from the first pose of the current viewpoint of the user to the second pose of the current viewpoint of the user corresponds to movement of the current viewpoint of the user from a first viewpoint relative to the three-dimensional environment to a second viewpoint relative to the three-dimensional environment (e.g., including one or more characteristics of movement of the current viewpoint of the second user as described with reference to method 800). For example, movement from the first pose of the current viewpoint of the user to the second pose of the current viewpoint of the user includes physical movement of at least a portion of the user relative to the user's physical environment. In some embodiments, the change in the current viewpoint of the user is caused by an input received by the second computer system corresponding to a request by the user to change their current viewpoint relative to the three-dimensional environment (e.g., the input is a touch-input provided on a touch-sensitive surface of the second computer system, or the input is an audio input (e.g., a voice command) provided by the user of the second computer system).

In some embodiments, in response to receiving the indication (902d), in accordance with a determination that the virtual representation of the user of the second computer system is a virtual representation of a first type (e.g., virtual representation 704b as shown in FIG. 7B), the first computer system displays (902e), in the three-dimensional environment, a first representation (e.g., animation) of movement of the virtual representation of the user of the second computer system corresponding to a change of the current viewpoint of the user of the second computer system from a first pose (e.g., position and/or orientation) in the three-dimensional environment to a second pose (e.g., position and/or orientation) in the three-dimensional environment, such as the representation of movement of virtual representation 704b in FIGS. 7E-7M. Movement of the virtual representation of the first type optionally includes movement of the virtual representation of the user of the second computer system from the first location (e.g., associated with the first pose) in the three-dimensional environment to a second location (e.g., associated with the second pose) in the three-dimensional environment. In some embodiments, the virtual representation of the first type has one or more characteristics of the first virtual object described with reference to method 800. In some embodiments, the first representation of movement of the virtual representation has one or more characteristics of displaying the movement of the first virtual object in the three-dimensional environment as described with reference to method 800 (e.g., including one or more characteristics of movement of the first virtual object from the first pose to the second pose in the three-dimensional environment as described with reference to method 800). In some embodiments, displaying the first representation of movement of the virtual representation of the first type from the first pose to the second pose includes not modifying one or more visual characteristics of the virtual representation of the first type during movement of the virtual representation of the first type from the first pose to the second pose (e.g., the virtual representation of the first type is displayed in the shape of a coin, and the virtual representation maintains its displayed shape during the first representation of movement). In some embodiments, the first representation of movement of the virtual representation includes moving the virtual representation in the three-dimensional environment if the change of the current viewpoint of the user of the second computer system from the first pose to the second pose satisfies one or more criteria. For example, the one or more criteria include a criterion that is satisfied when the change of the current viewpoint of the user from the first pose to the second pose is greater than or equal to a threshold amount of change relative to the three-dimensional environment (e.g., including a threshold magnitude of movement of the current viewpoint relative to the three-dimensional environment (e.g., as described with reference to method 800), speed of movement of the current viewpoint relative to the three-dimensional environment (e.g., as described with reference to method 800), distance of movement of the current viewpoint relative to the three-dimensional environment (e.g., as described with reference to method 800) and/or change in orientation of the current viewpoint relative to the three-dimensional environment (e.g., as described with reference to method 800)). In some embodiments, the first representation of movement of the virtual representation does not include continuous movement of the virtual representation from the first pose to the second pose. For example, the first representation of movement of the virtual representation includes ceasing display of the virtual representation at the first pose in the three-dimensional environment and redisplaying the virtual representation at the second pose in the three-dimensional environment (e.g., or includes ceasing display of the virtual representation in the three-dimensional environment for at least a portion of the movement of the virtual representation from the first pose to the second pose in the three-dimensional environment). In some embodiments, displaying the first representation of movement of the virtual representation includes displaying a first animation in the three-dimensional environment of the virtual representation moving from the first pose toward the second pose (e.g., based on a path of movement of the current viewpoint of the user). In some embodiments, after displaying the first animation, the computer system optionally ceases display of the virtual representation in the three-dimensional environment (e.g., optionally by gradually (e.g., over a period of time of 0.1, 0.2, 0.5, 1, 2, 5 or 10 seconds) increasing the transparency of the virtual representation until the virtual representation is no longer visible to the user (e.g., 100 percent transparency)). In some embodiments, after ceasing display of the virtual representation in the three-dimensional environment, the computer system displays a second animation of the virtual representation moving toward the second pose in the three-dimensional environment (e.g., along the path of movement of the virtual representation from the first pose to the second pose). Displaying the second animation optionally includes gradually (e.g., over a period of time of 0.1, 0.2, 0.5, 1, 2, 5 or 10 seconds) increasing the opacity of the virtual representation in the three-dimensional environment.

In some embodiments, in accordance with a determination that the virtual representation of the user of the second computer system is a virtual representation of a second type different from the first type (e.g., virtual representation 704a), the first computer system displays (902f), in the three-dimensional environment, a second representation (e.g., animation), different from the first representation, of movement of the virtual representation of the user of the second computer system corresponding to the change of the current viewpoint of the user of the second computer system from the first pose (e.g., position and/or orientation) in the three-dimensional environment to the second pose (e.g., position and/or orientation) in the three-dimensional environment, such as the representation of movement of virtual representation 704a shown in FIGS. 7E-7M. Movement of the virtual representation of the second type optionally includes movement of the virtual representation of the user of the second computer system from the first location (e.g., associated with the first pose) in the three-dimensional environment to a second location (e.g., associated with the second pose) in the three-dimensional environment. In some embodiments, the virtual representation of the second type is an avatar associated with the user of the second computer system (e.g., optionally created and/or customized by the user of the second computer system and/or corresponding to one or more physical characteristics of the user of the second computer system). For example, the user of the second computer system customizes one or more visual characteristics (e.g., including one or more visual characteristics different from color (e.g., including size, shape, physical features (e.g., facial features), and/or clothing) of the virtual representation of the second type. In some embodiments, movement of the virtual representation of the second type including displaying the virtual representation of the second type with one or more dynamic visual characteristics during the movement of the virtual representation of the second type from the first pose to the second pose (e.g., the virtual representation of the second type is an avatar including one or more visual characteristics based on one or more physical characteristics (e.g., face, head, torso, arms and/or legs) of a person and/or animal, and the one or more visual characteristics move during the movement of the virtual representation from the first pose to the second pose (e.g., arms and/or legs of the avatar move as the virtual representation is moved from the first pose to the second pose, and/or the avatar changes facial expression as the virtual representation is moved from the first pose to the second pose). In some embodiments, displaying the second representation of movement of the virtual representation includes maintaining the display of the virtual representation in the three-dimensional environment while concurrently moving the virtual representation from the first pose to the second pose (e.g., including optionally displaying movement of the virtual representation along a path movement between the first pose and the second pose that corresponds to the path of movement of the current viewpoint of the user of the second computer system relative to the three-dimensional environment). For example, while displaying the second representation of movement of the virtual representation, the computer system displays the virtual representation in one or more positions in the three-dimensional environment that it the virtual representation is not displayed in when the computer systems displays the first representation of movement (e.g., because the computer system ceases display of the virtual representation during at least a portion of the movement of the virtual representation from the first pose to the second pose when displaying the first representation of movement of the virtual representation). In some embodiments, displaying the second representation of movement of the virtual representation includes displaying movement of the virtual representation from the first pose to the second pose that corresponds to physical movement of the user of the second computer system relative to a physical environment of the user of the second computer system. For example, the second representation of movement of the virtual representation includes moving the virtual representation based on a change in spatial arrangement of one or more physical portions (e.g., head and/or torso) of the user of the second computer system relative to their physical environment. In some embodiments, displaying the second representation of movement of the virtual representation includes movement of the virtual representation that is optionally uninterrupted and/or of a consistent speed. In some embodiments, displaying the second representation of movement of the virtual representation includes smoothed movement (e.g., movement that includes reduced noise and/or outlying detected movement of the viewpoint of the user of the second computer system) of the virtual representation from the first pose to the second pose. For example, movement of the virtual representation is based on movement of one or more physical portions of the user of the second computer system that is filtered by the computer system (e.g., movement of the virtual representation does not include interruptions and/or irregularities in movement, optionally of a minor nature (e.g., an outlying movement (e.g., an opposite direction of movement and/or different speed of movement) that is less than a distance threshold (e.g., 0.1, 0.2, 0.5, 1, 5, or 10 cm), orientation threshold (e.g., −15, −10, −5, 5, 10 or 15 degrees) and/or duration threshold (e.g., an amount of movement with a duration of less than 0.1, 0.2, 0.5, 0.1, 0.5 or 1 second)) compared to the overall movement of the one or more portions of the user. Displaying different representations of movement of a virtual representation representing a current viewpoint of a user of a computer system in a three-dimensional environment based on whether the virtual representation is a virtual representation of a first type or a second type enables a respective computer system in a communication session with the computer system to represent movement of the current viewpoint of the user in the three-dimensional environment in a manner that does not provide unnecessary distraction and/or is appropriate based on the nature of the communication session and reduces user input errors that would be otherwise caused by unnecessary distraction, thereby reducing errors in interaction and improving user device interaction.

In some embodiments, displaying the first representation of movement of the virtual representation of the user of the second computer system includes displaying a first degree of movement of the virtual representation of the user that corresponds to the change of the current viewpoint of the user of the second computer system from the first pose in the three-dimensional environment to the second pose in the three-dimensional environment, such as the degree of movement of virtual representation 704b shown in FIGS. 7D-7M. In some embodiments, displaying the second representation of movement of the virtual representation of the user of the second computer system includes displaying a second degree of movement, greater than the first degree of movement, of the virtual representation of the user that corresponds to the change of the current viewpoint of the user of the second computer system from the first pose in the three-dimensional environment to the second pose in the three-dimensional environment, such as the degree of movement of virtual representation 704a shown in FIGS. 7A-7M. In some embodiments, the first degree of movement corresponds to greater distance, magnitude, speed and/or orientation of movement of the virtual representation of the user compared to the second degree of movement. In some embodiments, the first degree of movement and the second degree of movement include the same distance and/or magnitude of movement, but different speeds of movement (e.g., the first degree of movement of the virtual representation of the user corresponds to movement from a first location in the three-dimensional environment to a second location in the three-dimensional environment at a first speed, and the second degree of movement of the virtual representation of the user corresponds movement from the first location in the three-dimensional environment to the second location in the three-dimensional environment at a second speed greater than the first speed). In some embodiments, the first degree of movement of the virtual representation of the user corresponds to no movement of the virtual representation of the user (e.g., because movement of the current viewpoint of the user does not exceed a threshold as described with reference to method 800), and the second degree of movement of the virtual representation of the user corresponds to movement. In some embodiments, the first degree of movement of the virtual representation of the user includes constant movement in the three-dimensional environment from the first pose to the second pose, and the second degree of movement of the virtual representation does not include constant movement in the three-dimensional environment (e.g., the virtual representation of the user ceases to be displayed in the three-dimensional environment while displaying the first degree of movement of the virtual representation of the user). Displaying a first degree of movement of a virtual representation of a first type representing a current viewpoint of a user of a computer system in a three-dimensional environment and a second degree of movement of a virtual representation of a second type representing the current viewpoint of the user of the computer system enables a respective computer system in a communication session with the computer system to represent movement of the current viewpoint of the user in the three-dimensional environment in a manner that does not provide unnecessary distraction and/or is appropriate based on the nature of the communication session and reduces user input errors that would be otherwise caused by unnecessary distraction, thereby reducing errors in interaction and improving user device interaction.

In some embodiments, displaying the first representation of movement of the virtual representation of the user of the second computer system includes, while changing the virtual representation of the user of the second computer system from the first pose in the three-dimensional environment to the second pose in the three-dimensional environment, ceasing display of the virtual representation of the user of the second computer system in the three-dimensional environment and redisplaying the virtual representation of the user of the second computer system in the three-dimensional environment, such as ceasing display of virtual representation 704b shown in FIGS. 7I and 7K and 7K1, and redisplaying virtual representation 704b shown in FIGS. 7J and 7L. In some embodiments, displaying the second representation of movement of the virtual representation of the user of the second computer system, while changing the virtual representation of the user of the second computer system from the first pose in the three-dimensional environment to the second pose in the three-dimensional environment, does not include ceasing display of the virtual representation of the user of the second computer system in the three-dimensional environment (e.g., as shown by computer system maintaining display of virtual representation 704a in FIGS. 7I and 7K and 7K1). In some embodiments, ceasing display of the virtual representation of the user and redisplaying the virtual representation of the user in the three-dimensional environment corresponds to ceasing display of the virtual representation of the user at the first pose in the three-dimensional environment and redisplaying the virtual representation of the user at the second pose in the three-dimensional environment. In some embodiments, ceasing display of the virtual representation of the user in the three-dimensional environment includes displaying an animation corresponding to movement of the virtual representation of the user away from the first pose in the three-dimensional environment (e.g., including one or more characteristics of displaying movement of the first virtual object away from the first pose as described with reference to method 800). In some embodiments, redisplaying the virtual representation of the user in the three-dimensional environment includes displaying an animation corresponding to movement of the virtual representation of the user toward the second pose in the three-dimensional environment (e.g., including one or more characteristics of displaying movement of the first virtual object toward the second pose as described with reference to method 800). In some embodiments, the second representation of movement of the virtual representation of the user includes maintaining the display of the virtual representation of the user while changing the virtual representation of the user from the first pose in the three-dimensional environment to the second pose in the three-dimensional environment. In some embodiments, the second representation of movement of the virtual representation of the user includes moving the virtual representation of the user along a path in the three-dimensional environment that corresponds to a path of movement of the current viewpoint of the user relative to the three-dimensional environment while concurrently maintaining display of the virtual representation of the user in the three-dimensional environment. Displaying movement of a virtual representation of a current viewpoint of a user of a computer system from a first pose to a second pose in a three-dimensional environment, or ceasing to display the virtual representation at the first pose and redisplaying the virtual representation at the second pose (e.g., not displaying movement of the virtual representation between the first pose to the second pose) based on whether the virtual representation is a virtual representation of a first type or a second type enables a respective computer system in a communication session with the computer system to represent movement of the current viewpoint of the user in the three-dimensional environment in a manner that does not provide unnecessary distraction and/or is appropriate based on the nature of the communication session and reduces user input errors that would be otherwise caused by unnecessary distraction, thereby reducing errors in interaction and improving user device interaction.

In some embodiments, while in the communication session with the second computer system and while displaying the virtual representation of the pose of the current viewpoint of the user of the second computer system, the computer system displays, via the display generation component, a virtual representation (e.g., including one or more characteristics of the first virtual object described with reference to method 800) of a pose (e.g., location and/or orientation) of a current viewpoint of a user of a third computer system, different from the first computer system and the second computer system, relative to a three-dimensional environment at a second location in the three-dimensional environment, such as virtual representation 704b displayed in three-dimensional environment 702 in FIG. 7B corresponding to a pose of the second user. For example, the virtual representation of the pose of the third user, the second location, and the three-dimensional environment of the third user have one or more characteristics that are similar or the same to similar poses, location, and/or three-dimensional environments described with reference to method 800 and/or step(s) 902. For example, the computer system optionally concurrently displays a plurality of representation of poses of users (e.g., participants) of the communication session, a respective user using a respective computer system (e.g., other than the first and/or the second computer system) to access the communication session.

In some embodiments, while displaying the virtual representation of the pose of the current viewpoint of the user of the third computer system at the second location in the three-dimensional environment, the computer system receives, from the third computer system, an indication corresponding to a pose of the current viewpoint of the user of the third computer system relative to the three-dimensional environment, such as a change in pose of the current viewpoint of second user 708b as shown in overhead view 706 in FIGS. 7E-7K. For example, the indication corresponding to the pose of the current viewpoint of the user of the third computer system has one or more characteristics similar or the same such as those to described with reference to the pose of the current viewpoint of the user of the second computer system with reference to step(s) 902.

In some embodiments, in response to receiving the indication, in accordance with a determination that the virtual representation of the user of the third computer system is the first type of virtual representation, the computer system displays, in the three-dimensional environment, a respective first representation of movement of the virtual representation of the user of the third computer system, corresponding to a change of the current viewpoint of the user of the third computer system, from a third pose in the three-dimensional environment to a fourth pose in the three-dimensional environment, such as representations of movement of virtual representation 704b in FIGS. 7E-7M. For example, a plurality of virtual representation of users of computer systems, optionally displayed concurrently, optionally are the first type of virtual representation described with reference to step(s) 902. Additionally or alternatively, respective representations of movement of a respective virtual representation of the first type optionally have one or more characteristics similar or the same as representations of movement described with reference to method 800 and/or step(s) 902. In some embodiments, the third pose and/or the fourth pose of the user of the third computer system have one or more characteristics of the first pose and/or the second pose described with reference to step(s) 902.

In some embodiments, in accordance with a determination that the virtual representation of the user of the third computer system is the second type of virtual representation, different from the first type, the computer system displays, in the three-dimensional environment, a respective second representation (e.g., having one or more characteristics similar or the same as those described with reference to the respective second representation of movement of the virtual representation of the user of the second computer system), different from the respective first representation, of movement of the virtual representation of the user of the third computer system, corresponding to the change of the current viewpoint of the user of the third computer system, from the third pose in the three-dimensional environment to the fourth pose in the three-dimensional environment (e.g., representing a change in pose of the third user, instead of the second user), such as the representation of movement of virtual representation 704a shown in FIGS. 7E-7M. In some embodiments, the computer system concurrently displays representation of users of computer systems concurrently, and displays representation of movement to updated positions within the three-dimensional environment concurrently and/or at times when the pose of users of corresponding representation change. For example, the computer system optionally displays the representation of users of the communication session moving at different times, or at a same time, with respective movement patterns and/or animations associated with the movement (e.g., representing the movement) in accordance with the type of virtual representation and/or in accordance with when information indicating such movement is provided. Thus, in some embodiments, the computer system displays representation of users of respective computer system concurrently, and independently display representation of movement of such representations concurrently, to facilitate spatial communication between participants of the real-time communication session. Displaying a plurality of representation of users accessing the communication session reduces the need for separate communication sessions between the users, and facilitates sharing of a three-dimensional environment, thus reducing the need for processing and power consumption required to separately communicate and/or virtually represent movement of such users.

In some embodiments, displaying the first representation of movement of the virtual representation of the user of the second computer system includes, in accordance with a determination that the change of the current viewpoint of the user of the second computer system does not exceed a threshold amount, displaying a first degree of movement of the virtual representation of the user of the second computer system relative to the three-dimensional environment without ceasing display of the virtual representation of the user of the second computer system in the three-dimensional environment (e.g., as shown by the degree of movement of virtual representation 704b in FIGS. 7E-7G). In some embodiments, the threshold amount has one or more characteristics of the threshold relative to the three-dimensional environment as described with reference to method 800. For example, the threshold amount corresponds to a threshold distance, threshold magnitude, threshold change in orientation and/or threshold speed relative to the three-dimensional environment. In some embodiments, displaying the first degree of movement of the virtual representation of the user includes one or more characteristics of displaying the first degree of movement of the virtual representation of the user as described above.

In some embodiments, in accordance with a determination that the change of the current viewpoint of the user of the second computer system exceeds the threshold amount, ceasing display of the virtual representation of the user of the second computer system in the three-dimensional environment (e.g., as shown by ceasing display of virtual representation 704b in FIGS. 7I and 7K and 7K1 due to the movement of the current viewpoint of second user 708b). In some embodiments, ceasing display of the virtual representation of the user in the three-dimensional environment includes one or more characteristics of ceasing display of the virtual representation of the user in the three-dimensional environment described above.

In some embodiments, displaying the second representation of movement of the virtual representation of the user of the second computer system includes displaying a second degree of movement, greater than the first degree of movement, of the virtual representation of the user of the second computer system relative to the three-dimensional environment without ceasing display of the virtual representation of the user of the second computer system in the three-dimensional environment, independent of whether the change of the current viewpoint of the user of the second computer system exceeds the threshold amount of movement (e.g., as shown by the degree of movement of virtual representation 704a in FIGS. 7E-7G that does not include ceasing display of virtual representation 704a in three-dimensional environment 702. In some embodiments, displaying the second degree of movement of the virtual representation of the user includes one or more characteristics of displaying the second degree of movement of the virtual representation of the user as described above. In some embodiments, displaying the second degree of movement of the virtual representation of the user independent of whether the change of the current viewpoint of the user of the second computer system exceeds the threshold amount of movement includes displaying movement of the virtual representation of the user when movement of the current viewpoint of the user does not exceed the threshold amount relative to the three-dimensional environment. In some embodiments, displaying the second degree of movement of the virtual representation of the user independent of whether the change of the current viewpoint of the user of the second computer system exceeds the threshold amount of movement includes displaying movement of the virtual representation of the user when the movement of the current viewpoint the user exceeds the threshold amount relative to the three-dimensional environment. Displaying different representations of movement of a virtual representation representing a current viewpoint of a user of a computer system in a three-dimensional environment based on whether a threshold change of the current viewpoint of the user is detected enables a respective computer system in a communication session with the computer system to represent movement of the current viewpoint of the user in the three-dimensional environment in a manner that does not provide unnecessary distraction and/or is appropriate based on the nature of the communication session and reduces user input errors that would be otherwise caused by unnecessary distraction, thereby reducing errors in interaction and improving user device interaction.

In some embodiments, displaying the first representation of movement of the virtual representation of the user of the second computer system includes, in accordance with a determination that the change of the current viewpoint of the user of the second computer system includes movement in a first direction relative to the three-dimensional environment, forgoing displaying movement of the virtual representation of the user of the second computer system in a direction corresponding to the first direction relative to the three-dimensional environment, such as computer system 101a forgoing movement of virtual representation 704b in FIGS. 7C-7D in response to the change of the current viewpoint of second user 708b. In some embodiments, the first direction is a vertical direction relative to the three-dimensional environment. In some embodiments, the first direction is a vertical direction relative to a current viewpoint of a user of the first computer system. In some embodiments, displaying the first representation of movement of the virtual representation of the user does not include movement of the virtual representation of the user corresponding to a change in vertical position of the current viewpoint of the user relative to the three-dimensional environment. In some embodiments, displaying the first representation of movement of the virtual representation includes displaying movement in two directions (e.g., corresponding to movement in depth relative to a current viewpoint of a user of the first computer system and lateral movement relative to the current viewpoint of the user of the first computer system) in the three-dimensional environment different from the first direction (e.g., corresponding to vertical movement relative to the current viewpoint of the user of the first computer system). In some embodiments, in accordance with a determination that the change of the current viewpoint of the user includes movement in a second direction different from the first direction relative to the three-dimensional environment, the computer system displays movement of the virtual representation of the user in a direction corresponding to the second direction relative to the three-dimensional environment. In some embodiments, in accordance with a determination that the change of the current viewpoint of the user includes movement in a first direction and a second direction (e.g., and optionally a third direction) different from the first direction relative to the three-dimensional environment, the computer system displays movement of the virtual representation in a direction corresponding to the second direction relative to the three-dimensional environment (e.g., and optionally in a direction corresponding to the third direction relative to the three-dimensional environment) and not in a direction corresponding to the first direction relative to the three-dimensional environment.

In some embodiments, displaying the second representation of movement of the virtual representation of the user of the second computer system includes, in accordance with the determination that the change of the current viewpoint of the user of the second computer system includes the movement in the first direction relative to the three-dimensional environment, displaying movement of the virtual representation of the user of the second computer system in the direction corresponding to the first direction relative to the three-dimensional environment, such as the movement of virtual representation 704a in FIGS. 7C-7D in response to the change of the current viewpoint of second user 708b. In some embodiments, displaying the second representation of movement of the virtual representation of the user includes movement of the virtual representation of the user corresponding to a change in vertical position of the current viewpoint of the user relative to the three-dimensional environment. In some embodiments, displaying the second representation of movement of the virtual representation of the user includes displaying movement in three directions (e.g., corresponding to lateral movement, vertical movement, and movement in depth relative to the current viewpoint of the user of the first computer system) in the three-dimensional environment. In some embodiments, in accordance with a determination that the change of the current viewpoint of the user includes movement in the first direction and a second direction (e.g., and optionally a third direction) relative to the three-dimensional environment, the computer system displays movement of the virtual representation of the user in a direction corresponding to the first direction relative to the three-dimensional environment and in a direction corresponding to the second direction relative to the three-dimensional environment (e.g., and optionally in a direction corresponding to the third direction relative to the three-dimensional environment). Displaying movement of a virtual representation representing a current viewpoint of a user of a computer system in a first direction in a three-dimensional environment in accordance with a change of the current viewpoint of the user relative to the three-dimensional environment based on whether the virtual representation is a virtual representation of a first type or a second type enables a respective computer system in a communication session with the computer system to represent movement of the current viewpoint of the user in the three-dimensional environment in a manner that does not provide unnecessary distraction and/or is appropriate based on the nature of the communication session and reduces user input errors that would be otherwise caused by unnecessary distraction, thereby reducing errors in interaction and improving user device interaction.

In some embodiments, while displaying the virtual representation of the user of the second computer system in the three-dimensional environment and while not receiving, from the second computer system, an indication corresponding to a change in the pose of the current viewpoint of the user relative to the three-dimensional environment, in accordance with a determination that the virtual representation of the user of the second computer system is the virtual representation of the first type, the first computer system displays an animation including periodic movement of the virtual representation of the user of the second computer system, such as animation 714 of virtual representation 704b shown in FIG. 7B. In some embodiments, the periodic movement of the virtual representation of the user is independent of movement of the current viewpoint of the user relative to the three-dimensional environment (e.g., a change in the pose of the current viewpoint of the user relative to the three-dimensional environment). In some embodiments, displaying the animation including periodic movement of the virtual representation of the user of the second computer system includes one or more characteristics of displaying the animation of the first virtual object that is independent of movement of the current viewpoint of the second user relative to the three-dimensional environment as described with reference to method 800. For example, displaying the animation includes displaying the virtual representation oscillating about the current location of the user relative to the three-dimensional environment (e.g., including one or more characteristics of displaying the first virtual object oscillating about the current location of the current viewpoint of the second user relative to the three-dimensional environment as described with reference to method 800). In some embodiments, periodic movement of the virtual representation of the user includes displaying movement (e.g., oscillation of the virtual representation of the user) in the three-dimensional environment every 0.1, 0.2, 0.5, 1, 2, 5, or 10 second(s). In some embodiments, the animation includes constant movement of the virtual representation of the user (e.g., the virtual representation constantly oscillates about a location of the current viewpoint of the user in the three-dimensional environment). In some embodiments, the animation is not displayed while displaying the first representation of movement in the three-dimensional environment (e.g., the animation is not displayed while changing aspatial arrangement of the virtual representation relative to a current viewpoint of the first user).

In some embodiments, in accordance with a determination that the virtual representation of the user of the second computer system is the virtual representation of the second type, the first computer system displays the virtual representation of the user of the second computer system without displaying movement of the virtual representation of the user in the three-dimensional environment, such as virtual representation 704a being displayed without animation 714 in FIG. 7B. In some embodiments, the first computer system does not display the virtual representation of the user with the animation including periodic movement of the virtual representation of the user. In some embodiments, movement of the virtual representation of the user in the three-dimensional environment is based on movement of the current viewpoint of the user relative to the three-dimensional environment (e.g., the first computer system does not display movement of the virtual representation of the user that is independent of a change in pose of the current viewpoint of the user relative to the three-dimensional environment). Displaying periodic movement of a virtual representation of a current viewpoint of a user displayed in a three-dimensional environment that is independent of a change in the current viewpoint of the user increases comfort of a respective user of a respective computer system in communication with the computer system by displaying movement of the virtual representation when the virtual representation is not changing location and/or orientation in the three-dimensional environment (e.g., by preventing the virtual representation from appearing locked in a position in the three-dimensional environment relative to a viewpoint of the respective user), thereby improving user device interaction.

In some embodiments, while displaying the virtual representation of the user of the second computer system, the first computer system receives an indication of user input (e.g., corresponding to the third user's virtual representation change criteria being satisfied as shown in FIG. 7O). In some embodiments, receiving the indication of user input corresponds to detecting a second input at the first computer system. For example, the second input corresponds to a request to change a spatial arrangement of a first virtual object of one or more virtual objects displayed in the three-dimensional environment (e.g., including one or more characteristics of the first input described with reference to method 1100). In some embodiments, the second input corresponds to a request to change the virtual representation of the user from a virtual representation of the first type to a virtual representation of the second type. For example, a user of the first computer system selects a selectable option (e.g., through attention directed to the selectable option and/or a performed air gesture) displayed in the three-dimensional environment that is selectable to change the virtual representation of the user from the virtual representation of the first type to the virtual representation of the second type. In some embodiments, the second input corresponds to an audio input (e.g., a voice command), a touch-input (e.g., through a touch-sensitive surface in communication with the first computer system), and/or an input through a keyboard and/or mouse in communication with the first computer system. In some embodiments, receiving the indication includes one or more characteristics of receiving the indication as described with reference to step(s) 902. In some embodiments, the indication is received from the second computer system. In some embodiments, the indication corresponds to an input provided by the user of the second computer system. For example, the user input corresponds to a request made by the user of the second computer system to change a spatial arrangement of a first virtual object of one or more virtual objects displayed in a second three-dimensional environment (e.g., including one or more characteristics of the second three-dimensional environment described with reference to method 1100) displayed by the second computer system. In some embodiments, receiving the indication includes one or more characteristics of receiving the indication as described with reference to step(s) 902. In some embodiments, the user input corresponds to a request to change a spatial arrangement of a first virtual object of the one or more virtual objects (e.g., including one or more characteristics of the first input described with reference to method 1100).

In some embodiments, in response to receiving the indication of the user input, the first computer system changes the display of the virtual representation of the user of the second computer system from the virtual representation of the first type to the virtual representation of the second type, such as shown by the change of display from virtual representation 726b in second alternative view 730b in FIG. 7N to virtual representation 726a in second alternative view 730b in FIG. 7O in response to the third user's virtual representation change criteria being satisfied in FIG. 7O. In some embodiments, while the second computer system is receiving the user input (e.g., while the first computer system receives the first input as described with reference to method 1100), the first computer system displays the virtual representation of the user as the virtual representation of the second type. In some embodiments, while displaying the virtual representation of the user as the virtual representation of the second type, the first computer system changes the spatial arrangement of the virtual representation of the user (e.g., relative to a current viewpoint of a user of the first computer system) in accordance with the indication (e.g., in accordance with the user input received by the second computer system). In some embodiments, in accordance with the first computer system not receiving the indication of user input while displaying the virtual representation of the user, the first computer system maintains the display of the virtual representation of the user as the virtual representation of the first type. In some embodiments, in accordance with the first computer system receiving a user input (e.g., including one or more characteristics of the user input received by the second computer system described above), the first computer system changes the display of the virtual representation of the user from the virtual representation of the first type to the virtual representation of the second type. Displaying different types of a virtual representation of a current viewpoint of a user of a computer system that are associated with different representations of movement of the virtual representation in the three-dimensional environment based on user input provides a user of a respective computer system in communication with the computer system discretion in selecting a preferable type of virtual representation to be displayed in the three-dimensional environment and enables the respective computer system to represent movement of the current viewpoint of the user in a manner that does not provide unnecessary distraction and/or is appropriate based on the nature of the communication, thereby reducing errors in interaction and improving user device interaction.

In some embodiments, while displaying the virtual representation of the user of the second computer system, the first computer system receives an indication that one or more criteria are satisfied independent of user input (e.g., as represented by the satisfaction of third user's virtual representation change criteria as shown in FIG. 7O). In some embodiments, in response to receiving the indication that one or more criteria are satisfied independent of user input, the computer system changes the display of the virtual representation of the user of the second computer system from the virtual representation of the first type to the virtual representation of the second type, such as shown by the change of display from virtual representation 726b in second alternative view 730b in FIG. 7N to virtual representation 726a in second alternative view 730b in FIG. 7O in response to the third user's virtual representation change criteria being satisfied in FIG. 7O. In some embodiments, the indication is received by the second computer system. In some embodiments, the one or more criteria are associated with information collected by one or more input devices of the second computer system (e.g., the information corresponds to movement, location and/or orientation (e.g., position relative to the three-dimensional environment) tracking of one or more portions (e.g., head, eyes and/or torso) of the user of the second computer system. In some embodiments, the one or more criteria are satisfied in accordance with a determination that the second computer system detects loss of tracking of the location and/or orientation of the one or more portions of the user of the second computer system (e.g., the second computer system does not detect the location and/or orientation of the one or more portions of the user of the second computer system). In some embodiments, in response to the second computer system detecting the tracking loss, the indication is transmitted to the first computer system (e.g., and optionally one or more computer systems in the communication session with the first computer system and the second computer system). In some embodiments, in accordance with the first computer system ceasing to receive one or more indications corresponding to a current pose of the current viewpoint of the second user relative to the three-dimensional environment (e.g., the one or more indications are received by the first computer system periodically and/or an indication is not received within a threshold period of time), the first computer system changes the display of the virtual representation of the user of the second computer system from the virtual representation of the first type to the virtual representation of the second type. Changing the type of a virtual representation of a current viewpoint of a user of a computer system that is displayed in a three-dimensional environment based on the satisfaction of one or more criteria independent of user input enables a respective computer system in communication with the computer system to display a type of the virtual representation that is least distracting based on the nature of the communication session when movement of the virtual representation in the three-dimensional environment based on user input is not anticipated, and reduces errors in interaction that would be otherwise caused by unnecessary distraction, thereby improving user device interaction.

In some embodiments, while displaying the virtual representation of the user of the second computer system, the first computer system receives an indication of user input (e.g., as represented by the virtual representation change criteria being satisfied in FIG. 7B). In some embodiments, receiving the indication of user input includes one or more characteristics of receiving the indication of the user input described above. In some embodiments, the user input corresponds to an input received by the first computer system (e.g., and has one or more characteristics of the second input described above). For example, the input received by the first computer system corresponds to a request to change the virtual representation of the user from the virtual representation of the second type to the virtual representation of the first type. In some embodiments, the user input corresponds to an input received by the second computer system (e.g., and has one or more characteristic of the input provided by the user of the second computer system described above). In some embodiments, the indication of the user input is received by the second computer system and corresponds to detecting termination of the user input (e.g., including one or more characteristics of detecting termination of the first input as described with reference to method 1100).

In some embodiments, in response to receiving the indication of user input, the first computer system changes the display of the virtual representation of the user of the second computer system from the virtual representation of the second type to the virtual representation of the first type, such as shown by the change of display from virtual representation 704a in FIG. 7A in first alternative view 730a to virtual representation 704b in FIG. 7A in first alternative view 730a. In some embodiments, the first computer system changes the display of the virtual representation of the user from the virtual representation of the second type to the virtual representation of the first type in response to the second computer system detecting termination of the user input (e.g., including one or more characteristics of detecting termination of the first input as described with reference to method 1100). In some embodiments, the first computer system ceases changing a spatial arrangement of the virtual representation of the user (e.g., in accordance with the user input) when displaying the virtual representation of the first type (e.g., the first computer system does not display movement of the virtual representation of the user in accordance with the user input in response to receiving the indication). Displaying different types of a virtual representation of a current viewpoint of a user of a computer system that are associated with different representations of movement of the virtual representation in a three-dimensional environment based on user input provides a user of a respective computer system in communication with the computer system discretion in selecting a preferable type of virtual representation to be displayed in the three-dimensional environment and enables the respective computer system to represent movement of the current viewpoint of the user in a manner that does not provide unnecessary distraction and/or is appropriate based on the nature of the communication, thereby reducing errors in interaction and improving user device interaction.

In some embodiments, while displaying the virtual representation of the user of the second computer system, the first computer system receives an indication that one or more criteria are satisfied independent of user input (e.g., as represented by the virtual representation change criteria being satisfied in FIG. 7B). In some embodiments, in response to receiving the indication that one or more criteria are satisfied independent of user input, the first computer system changes the display of the virtual representation of the user of the second computer system from the virtual representation of the second type to the virtual representation of the first type, such as shown by the change of display from virtual representation 704a in FIG. 7A in first alternative view 730a to virtual representation 704b in FIG. 7A in first alternative view 730a. In some embodiments, the indication is received by the second computer system. In some embodiments, the one or more criteria have one or more characteristics of the one or more criteria that are satisfied independent of user input as described above. For example, in some embodiments, the one or more criteria are satisfied in accordance with a determination that the second computer system detects loss of tracking of the location and/or orientation of the one or more portions of the user of the second computer system. In some embodiments, in accordance with the first computer system ceasing to receive one or more indications corresponding to a current pose of the current viewpoint of the second user relative to the three-dimensional environment (e.g., the one or more indications are received by the first computer system periodically and/or an indication is not received within a threshold period of time), the first computer system changes the display of the virtual representation of the user of the second computer system from the virtual representation of the second type to the virtual representation of the first type. Changing the type of a virtual representation of a current viewpoint of a user of a computer system that is displayed in a three-dimensional environment based on the satisfaction of one or more criteria independent of user input enables a respective computer system in communication with the computer system to display a type of the virtual representation that is least distracting based on the nature of the communication session when movement of the virtual representation in the three-dimensional environment based on user input is not anticipated, and reduces errors in interaction that would be otherwise caused by unnecessary distraction, thereby improving user device interaction.

In some embodiments, in response to receiving the indication, in accordance with a determination that the virtual representation of the user of the second computer system is a virtual representation of a third type different from the first type and the second type (e.g., such as virtual representation 740 shown in FIG. 7P), the first computer system displays the virtual representation of the user of the second computer system at a third pose in the three-dimensional environment, wherein the third pose of the virtual representation of the user of the second computer system in the three-dimensional environment is independent of the pose of the current viewpoint of the user of the second computer system relative to the three-dimensional environment, such as shown by virtual representation 740 being displayed at the pose in three-dimensional environment 702 that is independent of the location of the current viewpoint of user 744b relative to three-dimensional environment 702 in FIG. 7Q. In some embodiments, displaying the virtual representation of the user at the third pose in the three-dimensional environment includes maintaining display of the virtual representation of the user at the third pose in the three-dimensional environment (e.g., the virtual representation of the user is displayed at the third pose in the three-dimensional environment prior to receiving the indication corresponding to the pose of the current viewpoint of the user relative to the three-dimensional environment). In some embodiments, the virtual representation of the third type has one or more characteristics of the first virtual object as described with reference to method 800. For example, the virtual representation of the third type includes a shape (e.g., a three-dimensional shape), such as a circle (e.g., a coin). For example, displaying the virtual representation of the third type includes displaying an annotation (e.g., an indication) below the virtual representation of the third type corresponding to an identifier (e.g., a name) of the user of the second computer system. In some embodiments, the shape and/or size of a respective virtual representation of the third type relative to the three-dimensional environment corresponds to the shape and/or size of a respective virtual representation of the first type relative to the three-dimensional environment). In some embodiments, a respective pose of the virtual representation of the third type relative to the three-dimensional environment does not correspond to a respective pose of the user of the second computer system relative to the three-dimensional environment (e.g., the virtual representation of the third type does not represent a current location and/or orientation of the current viewpoint of the user of the second computer system relative to the three-dimensional environment). In some embodiments, displaying the virtual representation of the third type in the three-dimensional environment includes displaying the animation that is independent of the movement of the current viewpoint of the second user relative to the three-dimensional environment as described with reference to the first virtual object in method 800 (e.g., the virtual representation of the third type oscillates about a location in the three-dimensional environment associated with the third pose). In some embodiments, displaying the virtual representation of the third type in the three-dimensional environment does not include displaying the animation that is independent of the movement of the current viewpoint of the second user relative to the three-dimensional environment. In some embodiments, displaying the virtual representation of the third type in the three-dimensional environment does not include displaying the animation that is based on audio input received by the second computer system as described with reference to the first virtual object in method 800 (e.g., displaying the virtual representation of the first type in the three-dimensional environment includes displaying the animation that is based on audio input received by the second computer system). Displaying either a virtual representation of a user of a computer system in a three-dimensional environment that represents movement of a current viewpoint of the user or displaying a virtual representation of the user of the computer system at a pose that is independent of the current viewpoint of the user enables a respective computer system in a communication session with the computer system to display a type of virtual representation of the user of the computer system that is appropriate based on whether the detection of movement of the current viewpoint of the user is anticipated, and informs a user of the respective computer system viewing the three-dimensional environment whether the detection of movement of the current viewpoint of the user of the computer system is anticipated, thereby reducing errors in interaction and improving user device interaction.

In some embodiments, the virtual representation of the third type includes an indication corresponding to a current status of the user of the second computer system in the communication session, such as indication 742 displayed with virtual representation 740 in FIG. 7P. In some embodiments, while displaying the virtual representation of the user of the second computer system (e.g., of the first type or the second type), the first computer system receives an indication (e.g., from the second computer system in the communication session) corresponding to a change in the current status of the user of the second computer system in the communication session. In some embodiments, the current status includes a current connectivity (e.g., network connectivity) of the user of the second computer system in the communication session. In some embodiments, the current status includes a current tracking capability of one or more portions (e.g., eyes, head, arms, hands and/or torso) of the user of the second computer system (e.g., the one or more portions are tracked by one or more input devices of the second computer system having one or more characteristics of the one or more input devices of the first computer system). In some embodiments, the current status includes a status regarding whether the user of the second computer system permits the location and/or orientation of the current viewpoint of the user to be represented in the three-dimensional environment in the communication session (e.g., the user of the second computer system establishes whether the current location of their current viewpoint can be represented in the communication session (e.g., through a settings user interface associated with the second computer system and/or the communication session)). In some embodiments, the current status includes a status regarding whether the user of the second computer system is interacting with a user interface not shared in the communication session (e.g., a system user interface of the second computer system, a menu associated with settings of the communication session and/or one or more applications associated with the second computer system that are not shared in the communication session). For example, the user of the second computer system interacts with a user interface for establishing a new communication session (e.g., a real-time communication session (e.g., optionally with one or more participants of the communication session)). In some embodiments, in response to receiving the indication corresponding to the change in the current status of the user of the second computer system in the communication session, in accordance with a determination that the change in the current status of the user of the second computer system in the communication session satisfies one or more criteria (e.g., the current status corresponds to a loss of connectivity, tracking loss of one or more portions of the user and/or interaction with a user interface (e.g., that is optionally not shared in the communication session)), the first computer system displays the virtual representation of the user of the second computer system of the third type (e.g., the first computer system changes the display of the virtual representation of the user of the second computer system (e.g., from the virtual representation of the first type or the virtual representation of the second type) to the virtual representation of the third type). In some embodiments, the indication includes information that is based on the one or more criteria that are satisfied. For example, the indication includes information (e.g., text) regarding the current connectivity status of the user of the second computer system. For example, the indication includes information regarding whether one or more input devices of the second computer system can track movement of the one or more portions of the user of the second computer system. In some embodiments, the indication corresponds to a virtual annotation that is displayed concurrently with the virtual representation of the third type. For example, the indication is displayed at a location in the three-dimensional environment that is above, below or to the side of the virtual representation of the third type from the current viewpoint of a user of the first computer system. In some embodiments, in accordance with the virtual representation of the user of the second computer system being the virtual representation of the first type or the second type, the first computer system forgoes displaying the indication corresponding to the current status of the user of the second computer system in the communication session. Displaying a virtual representation of a user of a computer system at a pose in a three-dimensional environment that is independent from a current viewpoint of the user of the computer system relative to the three-dimensional environment with an indication corresponding to a current status of a user of the computer system informs a user of a respective computer system that is in communication with the computer system of why the virtual representation of the user of the computer system is being displayed at the pose in the three-dimensional environment (e.g., because the detection of movement of the current viewpoint of the user relative to the three-dimensional environment is not anticipated), thereby reducing errors in interaction and improving user device interaction.

In some embodiments, displaying the virtual representation of the user of the second computer system at the third pose in the three-dimensional environment includes forgoing displaying a representation of movement (e.g., the first representation of movement or the second representation of movement) of the virtual representation of the user of the second computer system corresponding to the change of the current viewpoint of the user relative to the three-dimensional environment, such as first computer system 101 forgoing displaying a representation of movement of virtual representation 740 in FIGS. 7P-7R based on the movement of the current viewpoint of user 744b relative to three-dimensional environment 702. For example, displaying the virtual representation of the user of the second computer system at the third pose in the three-dimensional environment includes maintaining a location and/or orientation of the virtual representation of the user of the second computer system relative to the three-dimensional environment in response to receiving the indication from the second computer system (e.g., the third pose optionally does not correspond to (e.g., does not have a location and/or orientation relative to the three-dimensional environment that is based on) the pose of the user of the second computer system included in the indication received from the second computer system). For example, displaying the virtual representation of the user of the second computer system at the third pose in the three-dimensional environment does not include ceasing display of the virtual representation of the user of the second computer system in the three-dimensional environment (e.g., and redisplaying the virtual representation of the user of the second computer system at a different location and/or orientation relative to the three-dimensional environment). For example, displaying the virtual representation of the user of the second computer system at the third pose in the three-dimensional environment does not include displaying movement of the virtual representation of the user of the second computer system from a first location and/or orientation relative to the three-dimensional environment to a second location and/or orientation, different from the first location and/or orientation, relative to the three-dimensional environment (e.g., the movement from the first location and/or orientation to the second location and/or orientation in the three-dimensional environment corresponds to movement that is based on a change of the current viewpoint of the user relative to the three-dimensional environment). In some embodiments, while the first computer system forgoes display of the representation of movement of the virtual representation of the user of the second computer system corresponding to the change of the current viewpoint of the user relative to the three-dimensional environment, the first computer system displays (e.g., or maintains display of) the virtual representation of the third type with the animation that is independent of the movement of the current viewpoint of the user as described above (e.g. and as described with reference to the first virtual object in method 800). For example, the virtual representation of the third type is displayed oscillating about a location in the three-dimensional environment associated with the third pose (e.g., the oscillation of the virtual representation of the third type does not correspond to the change of the current viewpoint of the user relative to the three-dimensional environment. In some embodiments, while the first computer system forgoes display of the representation of movement of the virtual representation of the user of the second computer system corresponding to the change of the current viewpoint of the user relative to the three-dimensional environment, the first computer system forgoes displaying the animation that is independent of the movement of the current viewpoint of the user. In some embodiments, while the first computer system forgoes display of the representation of movement of the virtual representation of the user of the second computer system corresponding to the change of the current viewpoint of the user relative to the three-dimensional environment, the first computer system displays (e.g., or maintains display of) the virtual representation of the third type with the animation that is based on audio input received by the second computer system as described above (e.g., and with reference to the first virtual object in method 800). In some embodiments, while the first computer system forgoes display of the representation of movement of the virtual representation of the user of the second computer system corresponding to the change of the current viewpoint of the user relative to the three-dimensional environment, the first computer system forgoes display of the virtual representation of the third type animation that is based on audio input received by the second computer system. In some embodiments, in response to receiving a second indication corresponding to a second pose of the current viewpoint of the user relative to the three-dimensional environment (e.g., after receiving the indication corresponding to the pose of the current viewpoint of the user relative to the three-dimensional environment), in accordance with a determination that the virtual representation of the user of the second computer system is the virtual representation of the third type, the first computer system maintains display of the virtual representation of the user of the second computer system at the third pose in the three-dimensional environment (e.g., and/or forgoes displaying a representation of movement of the virtual representation of the user of the second computer system that is based on the second indication received from the second computer system). Displaying either a virtual representation of a user of a computer system in a three-dimensional environment that represents movement of a current viewpoint of the user or displaying a virtual representation of the user of the computer system that does not represent movement of the current viewpoint of the user enables a respective computer system in a communication session with the computer system to display a type of virtual representation of the user of the computer system that is appropriate based on whether the detection of movement of the current viewpoint of the user is anticipated, and informs a user of the respective computer system viewing the three-dimensional environment whether the detection of movement of the current viewpoint of the user of the computer system is anticipated, thereby reducing errors in interaction and improving user device interaction.

In some embodiments, displaying the virtual representation of the user of the second computer system of the third type includes, in accordance with a current viewpoint of a user of the first computer system having a first spatial arrangement (e.g., position and/or orientation) relative to the virtual representation of the user of the second computer system of the third type, displaying a first surface of the virtual representation of the user of the second computer system of the third type oriented in a first direction relative to the current viewpoint of the user of the first computer system in the three-dimensional environment, such as the orientation of first surface 732a of virtual representation 740 relative to the current viewpoint of user 744a shown in FIG. 7Q. In some embodiments, the first surface of the virtual representation of the user of the second computer system has one or more characteristics of the first surface of the first virtual object as described with reference to method 800. In some embodiments, the first spatial arrangement corresponds to a first position (e.g., location and/or orientation) of the virtual representation of the user relative to the current viewpoint of the user of the first computer system. In some embodiments, in accordance with the current viewpoint of the user of the first computer system having the first spatial arrangement relative to the virtual representation of the user of the second computer system of the third type, the first computer system displays the virtual representation of the user of the second computer system of the third type with a first size (e.g., surface area of the first surface and/or volume of the virtual representation of the user) relative to the current viewpoint of the user of the first computer system. In some embodiments, the first direction relative to the current viewpoint of the user of the first computer system corresponds to a direction that is directed at the current viewpoint of the user of the first computer system (e.g., a viewing angle from the user of the first computer system is perpendicular (e.g., or within 0.1, 0.2, 0.5, 1, 2, 5, 10, 15 or 25 degrees of perpendicular) to the first surface of the virtual representation of the user of the second computer system).

In some embodiments, displaying the virtual representation of the user of the second computer system of the third type includes, in accordance with a current viewpoint of the user of the first computer system having a second spatial arrangement (e.g., position and/or orientation), different from the first spatial arrangement, relative to the virtual representation of the user of the second computer system of the third type, displaying the first surface of the virtual representation of the user of the second computer system of the third type oriented in the first direction relative to the current viewpoint of the user of the first computer system in the three-dimensional environment, such as the orientation of first surface 732a of virtual representation 740 relative to the current viewpoint of user 744a shown in FIG. 7R. In some embodiments, the second spatial arrangement corresponds to a second position, different from the first position, of the virtual representation of the user of the second computer system relative to the current viewpoint of the user of the first computer system. In some embodiments, in accordance with the current viewpoint of the user of the first computer system having the second spatial arrangement relative to the virtual representation of the user of the second computer system of the third type, the first computer system displays the virtual representation of the user of the second computer system with the first size relative to the current viewpoint of the user of the first computer system. In some embodiments, the virtual representation of the user of the second computer system of the third type is displayed at different poses (e.g., location and/or orientation) relative to the three-dimensional environment based on the spatial arrangement of the current viewpoint of the user of the first computer system relative to the virtual representation. For example, in accordance with the current viewpoint of the user of the first computer system having the first spatial arrangement relative to the virtual representation of the user of the second computer system, the first computer system displays the virtual representation of the user of the second computer system of the third type at a first respective pose (e.g., location and/or orientation) relative to the three-dimensional environment. For example, in accordance with the current viewpoint of the user of the first computer system having the second spatial arrangement relative to the virtual representation of the user of the second computer system, the first computer system displays the virtual representation of the user of the second computer system of the third type at a second respective pose (e.g., location and/or orientation), different from the first respective pose, relative to the three-dimensional environment. Displaying a virtual representation of a user of a computer system in a three-dimensional environment that does not represent a current pose of a viewpoint of a user relative to the three-dimensional environment at the same orientation relative to the current viewpoint of a user of a respective computer system in communication with the computer system when the current viewpoint of the user of the respective computer system is at different viewpoints informs the user of the respective computer system that the detection of movement of the current viewpoint of the user of the computer system is not anticipated regardless of the current spatial arrangement of the current viewpoint of the user relative to the virtual representation of the user in the three-dimensional environment (e.g., because the virtual representation of the user is always visible to the user of the respective computer system), thereby reducing errors in interaction and improving user device interaction.

In some embodiments, displaying the first representation of movement of the virtual representation of the user of the second computer system includes displaying the virtual representation of the user of the second computer system at a first height relative to the three-dimensional environment corresponding to a height of the current viewpoint of the user of the second computer system relative to the three-dimensional environment, such as the height of virtual representation 704b relative to three-dimensional environment 702 shown during the representation of movement of virtual representation 704b shown in FIGS. 7E-7M. In some embodiments, in accordance with the indication corresponding to a change in a height of the current viewpoint of the user relative to the three-dimensional environment, the first representation of movement of the virtual representation of the user of the second computer system of the first type includes a change in the height of the virtual representation of the user that is based on the change in the height of the current viewpoint of the user relative to the three-dimensional environment. In some embodiments, displaying the virtual representation of the user of the second computer system with the first representation of movement does not include changing the height of the virtual representation of the user relative to the three-dimensional environment based on a change in the height of the current viewpoint of the user relative to the three-dimensional environment (e.g., as described above with reference to forgoing displaying movement of the virtual representation of the user of the second computer system in a direction corresponding to the first direction relative to the three-dimensional environment). In some embodiments, in accordance with a change in the current viewpoint of the user of the first computer system relative to the three-dimensional environment that includes a change in height of the current viewpoint of the user of the first computer system relative to the three-dimensional environment, the first computer system displays (e.g., maintains display of) the virtual representation of the first type at the first height relative to the three-dimensional environment that corresponds to the height of the current viewpoint of the user of the second computer system relative to the three-dimensional environment.

In some embodiments, displaying the second representation of movement of the virtual representation of the user of the second computer system includes displaying the virtual representation of the user of the second computer system at the first height relative to the three-dimensional environment corresponding to the height of the current viewpoint of the user of the second computer system relative to the three-dimensional environment, such as the height of virtual representation 704a relative to three-dimensional environment 702 shown during the representation of movement of virtual representation 704a shown in FIGS. 7E-7M. In some embodiments, in accordance with the indication corresponding to a change in the height of the current viewpoint of the user relative to the three-dimensional environment, the second representation of movement of the virtual representation of the user of the second computer system of the second type includes a change in the height of the virtual representation of the user that is based on the change in the height of the current viewpoint of the user relative to the three-dimensional environment. In some embodiments, displaying the second representation of movement of the virtual representation of the user includes displaying the virtual representation of the user of the second computer system at a height that is different from a height that the virtual representation of the user is displayed during the first representation of movement (e.g., the height of the virtual representation of the user that is displayed during the second representation of movement corresponds to a height of the current viewpoint of the user of the second computer system relative to the three-dimensional environment and the height of the virtual representation of the user that is displayed during the first representation of movement does not correspond to the height of the current viewpoint of the user of the second computer system relative to the three-dimensional environment). In some embodiments, in accordance with a change in the current viewpoint of the user of the first computer system relative to the three-dimensional environment that includes a change in height of the current viewpoint of the user of the first computer system relative to the three-dimensional environment, the first computer system displays (e.g., maintains display of) the virtual representation of the second type at the first height relative to the three-dimensional environment that corresponds to the height of the current viewpoint of the user of the second computer system relative to the three-dimensional environment.

In some embodiments, displaying the virtual representation of the user of the second computer system at the third pose in the three-dimensional environment includes displaying the virtual representation of the user of the second computer system at a second height relative to the three-dimensional environment that is based on a height of a current viewpoint of a user of the first computer system relative to the three-dimensional environment, such as the height of virtual representation 740 relative to three-dimensional environment 702 shown in FIG. 7P. In some embodiments, the virtual representation of the second computer system of the third type is displayed at the second height relative to the three-dimensional environment independent of the current pose of the virtual representation of the second computer system of the third type. For example, in accordance with the virtual representation of the third type being displayed at a fourth pose, different from the third pose, relative to the three-dimensional environment, the first computer system displays the virtual representation of the third type at the second height that is based on the height of the current viewpoint of the user of the first computer system relative to the three-dimensional environment. In some embodiments, in accordance with a change in the current viewpoint of the user of the first computer system relative to the three-dimensional environment that includes a change in height of the current viewpoint of the user of the first computer system relative to the three-dimensional environment, the first computer system displays the virtual representation of the third type at a third height, different from the first height, relative to the three-dimensional environment that is based on the height of the current viewpoint of the user of the first computer system relative to the three-dimensional environment. In some embodiments, in accordance with the change in the current viewpoint of the user of the first computer system relative to the three-dimensional environment that includes the change in height of the current viewpoint of the user of the first computer system relative to the three-dimensional environment, the first computer system maintains display of the virtual representation of the third type at the first height relative to the three-dimensional environment. Displaying a virtual representation of a user of a computer system at different heights relative to the three-dimensional environment based on the virtual representation of the user being a respective type of virtual representation informs a user of a respective computer system in communication with the computer system whether movement of the current viewpoint of the user of the computer system can be detected and/or represented in the three-dimensional environment (e.g., by displaying the virtual representation at a height that is based on a current viewpoint of the user relative to the three-dimensional environment when movement of the current viewpoint of the user is able to be detected and/or represented, or at a height that is based on a current viewpoint of the user of the respective computer system when movement of the current viewpoint of the user is not able to be detected and/or represented), thereby reducing errors in interaction and improving user device interaction.

In some embodiments, displaying the virtual representation of the user of the second computer system at the third pose in the three-dimensional environment includes displaying the virtual representation of the user of the second computer system at a first height relative to the three-dimensional environment that is based on a height of a current viewpoint of a user of the first computer system relative to the three-dimensional environment, such as the height of virtual representation 740 relative to three-dimensional environment 702 shown in FIG. 7P. In some embodiments, while displaying the virtual representation of the user of the second computer system in the three-dimensional environment, the first computer system displays a virtual representation of a user of a third computer system in the communication session in the three-dimensional environment (e.g., such as virtual representation 750 shown in FIG. 7S), including in accordance with a determination that the virtual representation of the user of the third computer system is a virtual representation of the third type, displaying the virtual representation of the user of the third computer system at the first height relative to the three-dimensional environment that is based on the height of the current viewpoint of the user of the first computer system relative to the three-dimensional environment, such as shown by the height of virtual representation 740 and virtual representation 750 in FIG. 7S. In some embodiments, displaying the virtual representation of the user of the second computer system at the first height relative to the three-dimensional environment includes one or more characteristics of displaying the virtual representation of the user of the second computer system at the second height relative to the three-dimensional environment as described above. In some embodiments, the virtual representation of the user of the third computer system has one or more characteristics of the virtual representation of the user of the second computer system as described above. In some embodiments, the virtual representation of the user of the second computer system and the virtual representation of the user of the third computer system are displayed at different orientations relative to the three-dimensional environment (e.g., the virtual representation of the user of the second computer system and the virtual representation of the user of the third computer system both include the first surface that is oriented in the first direction relative to the current viewpoint of the user of the first computer system as described above). In some embodiments, in accordance with a determination that the virtual representation of the user of the second computer system is the virtual representation of the third type and the virtual representation of the user of the third computer system is the virtual representation of the first type or the second type, the first computer system displays the virtual representation of the user of the second computer system at the first height relative to the three-dimensional environment and displays the virtual representation of the user of the third computer system at a second height, different from the first height, relative to the three-dimensional environment that corresponds to a height of the current viewpoint of the user of the third computer system relative to the three-dimensional environment. In some embodiments, while displaying the virtual representation of the user of the second computer system of the first type at a respective height relative to the three-dimensional environment that is based on a current viewpoint of the user of the second computer system relative to the three-dimensional environment, the virtual representation of the user of the third computer system of the third type is displayed in the three-dimensional environment at the respective height relative to the three-dimensional environment (e.g., the virtual representation of the third type is displayed in the three-dimensional environment at a height that is based on a height of the virtual representation of the first type in the three-dimensional environment). In some embodiments, while displaying the virtual representation of the user of the second computer system of the first type at a respective height relative to the three-dimensional environment, the virtual representation of the user of the third computer system of the third type is displayed in the three-dimensional environment at the first height, different from the respective height, relative to the three-dimensional environment (e.g., the virtual representation of the third type is displayed at a height that is independent of a respective height of the virtual representation of the first type). In some embodiments, while displaying a virtual representation the third type at the first height relative to the three-dimensional environment, the first computer system detects a change in a current viewpoint of the user of the first computer system, and, in response to detecting the change in the current viewpoint of the user of the first computer system, the first computer system displays the virtual representation of the third type at a second height, different from the first height, relative to the three-dimensional environment that is based on the change in the current viewpoint of the user of the first computer system. In some embodiments, after displaying the virtual representation of the third type at the second height relative to the three-dimensional environment, the first computer system displays a second virtual representation of the third type (e.g., of a different user) in the three-dimensional environment at the second height. In some embodiments, while displaying a virtual representation the third type at the first height relative to the three-dimensional environment, the first computer system detects a change in a current viewpoint of the user of the first computer system, and, in response to detecting the change in the current viewpoint of the user of the first computer system, the first computer system maintains display of the virtual representation of the third type at the first height relative to the three-dimensional environment. In some embodiments, after detecting the change in the current viewpoint of the user of the first computer system, the first computer system displays a second virtual representation of the third type (e.g., of a different user) in the three-dimensional environment at the first height (e.g., the first computer system displays the second virtual representation of the third type at a respective height relative to the three-dimensional environment that is based on a height of the virtual representation of the third type that is displayed in the three-dimensional environment). Displaying a plurality of virtual representations of users of a plurality of computer systems at different heights relative to the three-dimensional environment based on the plurality of virtual representations of the users being virtual representations of a respective type informs a user of a respective computer system in communication with the plurality of computer systems whether movement of the current viewpoint of the users of the plurality of computer systems can be detected and/or represented in the three-dimensional environment (e.g., by displaying the plurality of virtual representations at one or more heights that are based on the respective viewpoints of the users of the plurality of computer systems relative to the three-dimensional environment when movement of the respective viewpoints is able to be detected and/or represented, or at a height that is based on a current viewpoint of the user of the respective computer system when movement of the respective viewpoints is not able to be detected and/or represented), thereby reducing errors in interaction and improving user device interaction.

It should be understood that the particular order in which the operations in method 900 have been described is merely exemplary and is not intended to indicate that the described order is the only order in which the operations could be performed. One of ordinary skill in the art would recognize various ways to reorder the operations described herein.

FIGS. 10A-10AA illustrate examples of a first computer system reducing a visual prominence of one or more virtual representations while changing a spatial arrangement of a virtual object shared in a communication session. FIGS. 10A-10AA illustrate examples of the first computer system displaying different visual feedback in the three-dimensional environment in accordance with a virtual object being shared or not shared in the communication session.

FIG. 10A illustrates a first computer system (e.g., an electronic device) 101a displaying, via a display generation component (e.g., display generation component 120a of FIG. 1), a three-dimensional environment 1002a from a viewpoint of a first user (e.g., user 1042a) of the first computer system 101a (e.g., facing the back wall of the physical environment in which first computer system 101a is located). In some embodiments, first computer system 101a includes a display generation component (e.g., a touch screen) and a plurality of image sensors (e.g., image sensors 314 of FIG. 3). The image sensors optionally include one or more of a visible light cameras, an infrared camera, a depth sensor, or any other sensor the first computer system 101a would be able to use to capture one or more images of a user or a part of the user (e.g., one or more hands of the user) while the user interacts with the computer system 101a. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

In FIGS. 10A-10AA, first computer system 101a is shown in a communication session (e.g., including one or more characteristics of the communication session described with reference to methods 1100 and/or 1200) with a second computer system 101b. In some embodiments, second computer system 101b includes one or more characteristics of first computer system 101a. In some embodiments, first computer system 101a is a head-mounted display that displays three-dimensional environment 1002a (e.g., as an AR, VR, MR, XR or AR environment). In some embodiments, second computer system 101b is a head-mounted display that displays three-dimensional environment 1002b (e.g., as an AR, VR, MR, XR or AR environment). In some embodiments, second computer system 101b is a computer system of a plurality of computer systems in the communication session with first computer system 101a. In FIG. 10A, second computer system 101b is shown displaying (e.g., via display generation component 120b), three-dimensional environment 1002b from a viewpoint of a second user (e.g., user 1042b) of the second computer system 101b. In some embodiments, three-dimensional environments 1002a and 1002b correspond to a three-dimensional environment (e.g., a virtual environment) that is shared in the communication session. For example, three-dimensional environment 1002a corresponds to the three-dimensional environment shared in the communication session from a viewpoint of the first user of first computer system 101a and three-dimensional environment 1002b corresponds to the three-dimensional environment shared in the communication session from a viewpoint of the second user of second computer system 101b. In some embodiments, three-dimensional environment 102a corresponds to the three-dimensional environment described with reference to methods 1100 and/or 1200. In some embodiments, three-dimensional environment 1002b corresponds to the second three-dimensional environment described with reference to methods 1100 and/or 1200.

In FIGS. 10A-10AA, an overhead view 1040 is shown representing three-dimensional environment 1002a. Overhead view 1040 includes representations of a first user 1042a of first computer system 101a, a second user 1042b of second computer system 101b, and a third user 1042c of a third computer system (e.g., of a plurality of computer systems) in the communication session with first computer system 101a. In some embodiments, the representations of first user 1042a, second user 1042b and third user 1042c in overhead view 1040 correspond to positions (e.g., location and/or orientation (e.g., orientation is represented by arrows extending from the representations of the users in overhead view 1040)) of the current viewpoints of first user 1042a, second user 1042b and third user 1042c relative to the three-dimensional environment 1002a. In some embodiments, the representations of first user 1042a, second user 1042b, and third user 1042c in overhead view 1040 correspond to virtual representations (e.g., virtual representations 1012a-1012c) of the users relative to the shared virtual environment (e.g., changes in the display of virtual representations 1012a-1012c are shown in overhead view 1040 in FIGS. 10A-10AA). In FIGS. 10A-10AA, a change in spatial arrangement (e.g., caused by movement) of one or more virtual objects (e.g., shared virtual object 1006a and/or non-shared virtual object 1004) relative to three-dimensional environment 1002a is represented in overhead view 1040. Further, in FIGS. 10A-10AA, three-dimensional environment 1002b displayed by second computer system 101b is updated to reflect a perspective of second user 1042b viewing the three-dimensional environment shared in the communication based on the location and/or orientation of second user 1042b shown in overhead view 1040. For example, in accordance with first user 1042a moving (e.g., through user input) virtual representation 1012b (e.g., representing the current viewpoint of second user 1042b) in three-dimensional environment 1002a to a greater distance relative to the current viewpoint of first user 1042a, the position of second user 1042b is updated in overhead view 1040, and three-dimensional environment 1002b is updated to reflect the movement initiated by first user 1042a relative to the three-dimensional environment shared in the communication session from the perspective of second user 1042b.

In some embodiments, three-dimensional environment 1002a and three-dimensional environment 1002b are partially or fully immersive virtual environments viewable by the users of the plurality of computer systems in the communication session. In FIGS. 10A-10AA, an immersive portion 1010 is shown in three-dimensional environment 1002a and three-dimensional environment 1002b. In some embodiments, three-dimensional environment 1002a and three-dimensional environment 1002b include optical passthrough of physical environments of first user 1042a and second user 1042b, respectively. For example, three-dimensional environment 1002a and three-dimensional environment 1002b are partially immersive virtual environments that include immersive portion 1010 and one or more portions different from immersive portion 1010 including one or more objects from a physical environment (e.g., walls and/or furniture) that are visible (e.g., from the current viewpoint of first user 1042a or second user 1042b). In some embodiments, three-dimensional environment 1002a and three-dimensional environment 1002b are fully immersive virtual environments (e.g., do not include optical passthrough of physical environments of first user 1042a and second user 1042b).

As shown in FIG. 10A, one or more virtual representations are displayed in three-dimensional environment 1002a and three-dimensional environment 1002b. In some embodiments, the user interfaces illustrated in FIG. 10A (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10A (e.g., on display generation component 120b) and described below are implemented on a second head-mounted display that displays three-dimensional environment 1002b (e.g., as an AR, VR, MR, XR or AR environment) to second user 1042b. In three-dimensional environment 1002a, a virtual representation 1012b of second user 1042b and a virtual representation 1012c of third user 1042c are displayed. In three-dimensional environment 1002b, a virtual representation 1012a of first user 1042a and virtual representation 1012c are displayed. In some embodiments, virtual representations 1012a-1012c are avatars (e.g., including one or more characteristics of an avatar as described with reference to method 800, 900, 1100 and/or 1200). In some embodiments, virtual representations 1012a-1012c have one or more characteristics of the virtual representation of the second type as described with reference to method 900. In some embodiments, in FIG. 10A, virtual representations 1012a-1012c are displayed with a first amount of visual prominence. For example, the first amount of visual prominence includes a first amount of opacity, color, saturation, brightness and/or sharpness (e.g., relative to three-dimensional environment 1002a or three-dimensional environment 1002b).

In FIG. 10A, a virtual object 1006a is displayed in three-dimensional environment 1002a and three-dimensional environment 1002b (e.g., and is shown in overhead view 1040). In some embodiments, virtual object 1006a is shared in the communication session (e.g., and visible from the perspective of first user 1042a, second user 1042b and third user 1042c relative to the three-dimensional environment shared in the communication session). In some embodiments, virtual object 1006a includes one or more characteristics of the first virtual object as described with reference to method 1100 and/or the first virtual object that is shared with the one or more computer systems in the communication session as described with reference to method 1200. In three-dimensional environment 1002a, virtual object 1006a is displayed by first computer system 101a with a virtual indication 1020. In some embodiments, virtual indication 1020 corresponds to visual feedback displayed in three-dimensional environment 1002a informing first user 1042a that virtual object 1006a is shared in the communication session (e.g., first user 1042a shared virtual object 1006a with second user 1042b and third user 1042c in the communication session). In some embodiments, virtual indication 1020 is selectable (e.g., through a selection input as described with reference to method 1200) to cease sharing virtual object 1006a in the communication session (e.g., as shown and described with reference to FIGS. 10U-10V). In three-dimensional environment 1002b, virtual indication 1020 is not displayed with virtual object 1006a (e.g., optionally because first user 1042a shares virtual object 1006a in the communication session and controls whether to share or not shared virtual object 1006a). Optionally, virtual indication 1020 is displayed with virtual object 1006a in three-dimensional environment 1002b (e.g., to inform second user 1042b that virtual object 1006a is shared content in the communication session). As shown in FIG. 10A, virtual object 1006a is displayed with a virtual element 1018. In some embodiments, virtual element 1018 has one or more characteristics of the element that is selectable to change the spatial arrangement of first virtual object relative to the first viewpoint of the first user as described with reference to method 1100. For example, virtual element 1018 is selectable (e.g., through a selection input performed by first user 1042a) to change the spatial arrangement of virtual object 1006a (e.g., relative to the current viewpoint of first user 1042a and/or relative to three-dimensional environment 1002a).

As shown in FIG. 10A, a virtual object 1004 is displayed in three-dimensional environment 1002a (e.g., and not in three-dimensional environment 1002b), and is represented in overhead view 1040. In some embodiments, virtual object 1004 is not shared in the communication session (e.g., and is visible from the current viewpoint of first user 1042a and not from the current viewpoint of second user 1042b or third user 1042c). In some embodiments, virtual object 1004 has one or more characteristics of the one or more non-shared virtual objects as described with reference to method 1100 and/or the first virtual object that is not shared with the one or more computer systems in the communication session as described with reference to method 1200. In FIG. 10A, virtual object 1004 is displayed with selectable option 1030a and selectable option 1030b. In some embodiments, selectable option 1030a is selectable by first user 1042a (e.g., through a selection input) to change a size of virtual object 1004 relative to three-dimensional environment 1002a. In some embodiments, selectable option 1030a has one or more characteristics of the selectable option displayed with the first virtual object that is selectable to change the size of the first virtual object relative to the three-dimensional environment as described with reference to method 1200. In some embodiments, selectable option 1030b is selectable by first user 1042a (e.g., through a selection input) to cease display of virtual object in three-dimensional environment 1002a. In some embodiments, selectable option 1030b has one or more characteristics of the selectable option displayed with first virtual object that is selectable to cease display of the first virtual object in three-dimensional environment as described with reference to method 1200. In FIG. 10A, virtual object 1004 is displayed with a virtual element 1016. In some embodiments, virtual element 1016 is selectable to change a spatial arrangement of virtual object 1004 relative to the current viewpoint of first user 1042a and has one or more characteristics of virtual element 1018 displayed with virtual object 1006a. As shown in FIG. 10A, virtual object 1006a is not displayed with selectable option 1030a and selectable option 1030b. Further, virtual object 1004 is not displayed with virtual indication 1020 in three-dimensional environment 1002a (e.g., because virtual object 1004 is not shared in the communication session).

In FIG. 10A, first user 1042a performs an input corresponding to a request to change a spatial arrangement of virtual object 1006a relative to the current viewpoint of first user 1042a in three-dimensional environment 1002a. As shown in FIG. 10A, the input includes attention (e.g., gaze 1024 (e.g., represented by a black circle in FIG. 10A)) directed to virtual element 1018. In some embodiments, while gaze 1024 is directed to virtual element 1018, first user 1042a performs an air gesture (e.g., including one or more air gestures described with reference to methods 800, 900, 1100 and/or 1200) with hand 1008a. In some embodiments, the input shown in FIG. 10A corresponds to selection of virtual element 1018. In some embodiments, the input shown in FIG. 10A has one or more characteristics of the first input corresponding to the request to change the spatial arrangement of the first virtual object of the one or more virtual objects as described with reference to method 1100.

FIG. 10A1 illustrates similar and/or the same concepts as those shown in FIG. 10A (with many of the same reference numbers). It is understood that unless indicated below, elements shown in FIG. 10A1 that have the same reference numbers as elements shown in FIGS. 10A-10AA have one or more or all of the same characteristics. FIG. 10A1 includes computer systems 101a/b, which includes (or is the same as) display generation components 120a/b. In some embodiments, computer systems 101a/b and display generation components 120a/b have one or more of the characteristics of computer system 101 shown in FIGS. 10A-10AA and display generation component 120 shown in FIGS. 1 and 3, respectively, and in some embodiments, computer system 101 and display generation component 120 shown in FIGS. 10A-10AA have one or more of the characteristics of computer systems 101a/b and display generation components 120a/b shown in FIG. 10A1.

In FIG. 10A1, display generation components 120a/b include one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation components 120a/b to enable eye tracking of the user's left and right eyes. Display generation components 120a/b also include external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 10A-10AA.

In FIG. 10A1, display generation components 120a/b are illustrated as displaying content that optionally corresponds to the content that is described as being displayed and/or visible via display generation component 120 with reference to FIGS. 10A-10AA. In some embodiments, the content is displayed by a single display (e.g., display 510 of FIG. 5) included in display generation components 120a/b. In some embodiments, display generation components 120a/b include two or more displays (e.g., left and right display panels for the left and right eyes of the user, respectively, as described with reference to FIG. 5) having displayed outputs that are merged (e.g., by the user's brain) to create the view of the content shown in FIG. 10A1.

Display generation components 120a/b have a field of view (e.g., a field of view captured by external image sensors 314b and 314c and/or visible to the user via display generation component 120) that corresponds to the content shown in FIG. 10A1. Because display generation components 120a/b are optionally head-mounted devices, the field of view of display generation components 120a/b is optionally the same as or similar to the field of view of the user.

In FIG. 10A1, the user is depicted as performing an air pinch gesture (e.g., with hand 1008a) to provide an input to computer system 101a to provide a user input directed to content displayed by computer systems 101a/b. Such depiction is intended to be exemplary rather than limiting; the user optionally provides user inputs using different air gestures and/or using other forms of input as described with reference to FIGS. 10A-10AA.

In some embodiments, computer systems 101a/b responds to user inputs as described with reference to FIGS. 10A-10AA.

In the example of FIG. 10A1, because the user's hand is within the field of view of display generation component 120a, it is visible within the three-dimensional environment. That is, the user can optionally see, in the three-dimensional environment, any portion of their own body that is within the field of view of display generation components 120a/b. It is understood than one or more or all aspects of the present disclosure as shown in, or described with reference to FIGS. 10A-10AA and/or described with reference to the corresponding method(s) are optionally implemented on computer systems 101a/b and display generation components 120a/b in a manner similar or analogous to that shown in FIG. 10A1.

FIG. 10B illustrates first computer system 101a displaying virtual representation 1012b and virtual representation 1012c with a reduced visual prominence and a boundary 1022 in three-dimensional environment 1002a in response to the input provided by first user 1042a in FIG. 10A. In some embodiments, the user interfaces illustrated in FIG. 10B (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10B (e.g., on display generation component 120b) and described below are implemented on a second head-mounted display that displays three-dimensional environment 1002b (e.g., as an AR, VR, MR, XR or AR environment) to second user 1042b. In some embodiments, reducing the visual prominence of virtual representation 1012b and virtual representation 1012c includes one or more characteristics of reducing the visual prominence of the one or more virtual representations of the one or more users relative to the three-dimensional environment as described with reference to method 1100. For example, displaying virtual representation 1012b and virtual representation 1012c with the reduced visual prominence includes displaying virtual representation 1012b and virtual representation 1012c with a greater amount of transparency or with a reduced amount of brightness, color, saturation and/or sharpness. As shown in FIG. 10B, in response to the input provided by first user 1042a, second computer system 101b displays virtual representation 1012a with the reduced amount of visual prominence from the perspective of second user 1042b (e.g., second computer system 101b receives an indication from first computer system 101a corresponding to the input received by first user 1042a). Optionally, in response to the input provided by first user 1042a, second computer system 101b maintains display of virtual representation 1012a with the first amount of visual prominence (e.g., and virtual representation 1012a with the second representation of movement (e.g., as described with reference to method 900) in three-dimensional environment 1002b from the perspective of second user 1042b).

In FIG. 10B, in response to the input provided by first user 1042a in FIG. 10A, first computer system 101a changes the visual appearance of three-dimensional environment 1002a. In some embodiments, changing the visual appearance of three-dimensional environment 1002a includes one or more characteristics of displaying the three-dimensional environment with the second visual appearance from the first viewpoint of the first user as described with reference to method 1100. For example, changing the visual appearance of three-dimensional environment 1002a includes reducing the brightness of three-dimensional environment 1002a from the current viewpoint of first user 1042a. As shown in FIG. 10B, changing the visual appearance of three-dimensional environment 1002a includes changing the visual appearance of virtual representations 1012b-1012c relative to the current viewpoint of first user 1042a. In some embodiments, first computer system 101a changes the visual appearance of virtual object 1006a and virtual object 1004 when changing the visual appearance of three-dimensional environment 1002a. In some embodiments, changing the visual appearance of three-dimensional environment 1002a includes changing the visual appearance of immersive portion 1010 and/or one or more object visible from the current viewpoint of first user 1042a through optical passthrough of the physical environment of first user 1042a.

As shown in FIG. 10B, first computer system 101a displays a boundary 1022 in three-dimensional environment 1002a. Boundary 1022 is displayed surrounding virtual objects in three-dimensional environment 1002a that are shared in the communication session (e.g., virtual representation 1012b, virtual representation 1012c and virtual object 1006a). For example, the size (e.g., of the perimeter) of boundary 1022 is based on the shared spatial arrangement of virtual representation 1012b, virtual representation 1012c and virtual object 1006a. In some embodiments, boundary 1022 is displayed to surround virtual objects that are shared in the communication session (e.g., virtual representation 1012b (e.g., or optionally virtual representation 1014b shown and described with reference to FIG. 10D), virtual representation 1012c (e.g., or optionally virtual representation 1014c shown and described with refence to FIG. 10D) and virtual object 1006a) and virtual objects that are not shared in the communication session (e.g., virtual object 1004). For example, the size (e.g., of the perimeter) of boundary 1022 is based on the shared spatial arrangement of virtual representation 1012b, virtual representation 1012c, virtual object 1006a and virtual object 1004. In some embodiments, boundary 1022 is displayed on a respective surface in virtual environment 1002a visible from the current viewpoint of first user 1042a. For example, the surface is a physical surface (e.g., floor and/or ground) from a physical environment of first user 1042a that is visible in three-dimensional environment 1002a through optical passthrough. For example, the surface is a virtual surface (e.g., representing a floor and/or ground of a virtual environment) that is displayed by first computer system 101a. As shown in FIG. 10B, second computer system 101b does not display boundary 1022 in three-dimensional environment 1002b from the perspective of second user 1042b in response to the request to change the spatial arrangement of virtual object 1006a received by first computer system 101a.

FIG. 10C illustrates first computer system 101a ceasing display of virtual representation 1012b and virtual representation 1012c in three-dimensional environment 1002a in response to the input provided by first user 1042a in FIG. 10A. In some embodiments, the user interfaces illustrated in FIG. 10C (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10C (e.g., on display generation component 120b) and described below are implemented on a second head-mounted display that displays three-dimensional environment 1002b (e.g., as an AR, VR, MR, XR or AR environment) to second user 1042b. In some embodiments, ceasing display of virtual representation 1012b and virtual representation 1012c in three-dimensional environment 1002a includes one or more characteristics of ceasing to display the one or more virtual representations of the one or more users in the three-dimensional environment as described with reference to method 1100. As shown in FIG. 10C, in response to the input provided by first user 1042a in FIG. 10A, second computer system 101b ceases display of virtual representation 1012a in three-dimensional environment 1002b from the perspective of second user 1042b (e.g., second computer system 101b receives an indication from first computer system 101a corresponding to the input received by first user 1042a). Optionally, in response to the input provided by first user 1042a, second computer system 101b maintains display of virtual representation 1012a in three-dimensional environment 1002b (e.g., and displays virtual representation 1012a with the second representation of movement (e.g., as described with reference to method 900) in three-dimensional environment 1002b from the perspective of second user 1042b).

FIG. 10D illustrates first computer system 101a changing the respective virtual representations of second user 1042b and third user 1042c displayed in three-dimensional environment 1002a to virtual representation 1014b and virtual representation 1014c. In some embodiments, the user interfaces illustrated in FIG. 10D (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10D (e.g., on display generation component 120b) and described below are implemented on a second head-mounted display that displays three-dimensional environment 1002b (e.g., as an AR, VR, MR, XR or AR environment) to second user 1042b. In some embodiments, virtual representation 1014b and virtual representation 1014c have one or more characteristics of virtual representation 704b as shown and described with reference to FIGS. 7A-7M. In some embodiments, virtual representation 1014b and virtual representation 1014c have one or more characteristics of the first virtual object as described with reference to method 800 and/or the virtual representation of the first type as described with reference to method 900. In some embodiments, virtual representation 1014b corresponds to a virtual representation of second user 1042b, and virtual representation 1014c corresponds to a virtual representation of third user 1042c. As shown in FIG. 10D, in response to the input provided by first user 1042a in FIG. 10A, second computer system 101b changes the display of the respective virtual representation of first user 1042a to virtual representation 1014a. In some embodiments, virtual representation 1014a has one or more characteristics of virtual representation 1014b and virtual representation 1014c. In some embodiments, while displaying virtual representation 1014a in three-dimensional environment 1002b, second computer system 101b displays virtual representation 1014a with the first representation of movement (e.g., as described with reference to method 900) in accordance with the current viewpoint of first user 1042a changing spatial arrangement relative to the current viewpoint of second user 1042b. Optionally, in response to the input provided by first user 1042a, second computer system 101b maintains display of virtual representation 1012a in three-dimensional environment 1002b and does not change the display of virtual representation 1012a to virtual representation 1014a (e.g., and displays virtual representation 1012a with the second representation of movement (e.g., as described with reference to method 900) in three-dimensional environment 1002b from the perspective of second user 1042b).

In FIG. 10D (e.g., and in FIGS. 10B and 10C), first user 1042a continues to provide the input initiated in FIG. 10A to change the spatial arrangement of virtual object 1006a relative to the current viewpoint of first user 1042a. In some embodiments, the input shown in FIG. 10B includes hand movement relative to three-dimensional environment 1002a. For example, user 1042a provides hand movement (e.g., while maintaining an air gesture (e.g., air pinch)) in a direction of depth relative to the current viewpoint of first user 1042a in three-dimensional environment 1002a (e.g., to move virtual object 1006a in the direction of depth relative to the current viewpoint of first user 1042a in three-dimensional environment 1002a).

FIG. 10E illustrates first computer system 101a changing the spatial arrangement of virtual object 1006a relative to the current viewpoint of first user 1042a in three-dimensional environment 1002a in response to the input provided by first user 1042a in FIG. 10D. In some embodiments, the user interfaces illustrated in FIG. 10E (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10E (e.g., on display generation component 120b) and described below are implemented on a second head-mounted display that displays three-dimensional environment 1002b (e.g., as an AR, VR, MR, XR or AR environment) to second user 1042b. As shown in FIG. 10E, first computer system 101a changes the spatial arrangement of boundary 1022 and the virtual objects displayed within boundary 1022 (e.g., virtual object 1004, virtual representation 1014b and virtual representation 1014c) concurrently with virtual object 1006a relative to the current viewpoint of first user 1042a in three-dimensional environment 1002a in response to the input provided by first user 1042a in FIG. 10D. In three-dimensional environment 1002a, boundary 1022 includes a portion 1028a that is displayed with a different visual appearance compared to as shown in FIGS. 10B-10D. In some embodiments, the visual prominence (e.g., including opacity) of boundary 1022 is reduced by first computer system 101a in three-dimensional environment 1002a as boundary 1022 is moved to a greater distance relative to the current viewpoint of first user 1042a (e.g., including one or more characteristics of changing the visual prominence of the boundary relative to the three-dimensional environment in response to changing the distance of the boundary from the first viewpoint of the first user as described with reference to method 1100). As shown in FIG. 10E, in response to the change in spatial arrangement of virtual object 1006a (e.g., and virtual representation 1014b) relative to the current viewpoint of first user 1042a, second computer system 101b changes the spatial arrangement (e.g., moves to an updated pose) of virtual representation 1014a relative to the current viewpoint of second user 1042b. For example, as shown in overhead view 1040, first user 1042a is at a greater distance to the right of second user 1042b as a result of the change in spatial arrangement of virtual object 1006a relative to the current viewpoint of first user 1042a compared to FIG. 7D. Accordingly, virtual representation 1014a is displayed at (e.g., is moved to) a location in three-dimensional environment 1002b that is at a greater distance to the right relative to the current viewpoint of second user 1042b.

In FIG. 10E, first user 1042a provides an input to change the spatial arrangement of virtual object 1006a relative to the current viewpoint of first user 1042a. In some embodiments, the input shown in FIG. 10E is a continuation of the input initiated in FIG. 10A and continued in FIG. 10D (e.g., and FIGS. 10B-10C). In some embodiments, the input shown in FIG. 10E includes hand movement relative to three-dimensional environment 1002a. For example, user 1042a provides hand movement (e.g., while maintaining an air gesture (e.g., air pinch)) in relative to the current viewpoint of first user 1042a in three-dimensional environment 1002a. In some embodiments, the input corresponds to a request to pivot virtual object 1006a (e.g., and virtual representations 1014-1014c and virtual object 1004) about a location in three-dimensional environment 1002a corresponding to the current viewpoint of first user 1042a (e.g., the hand movement is lateral movement relative to three-dimensional environment 1002a and/or arced (e.g., movement of hand 1008a in a curved trajectory) relative to three-dimensional environment 1002a (e.g., toward a left side relative to the current viewpoint of first user 1042a, as represented by an arrow shown adjacent to hand 1008a)). In some embodiments, the input shown in FIG. 10E has one or more characteristics of the input from the first portion of the first user without including input from the second portion of the first user as described with reference to method 1100.

FIG. 10F illustrates virtual object 1006a pivoted about a location in three-dimensional environment 1002a corresponding to the current viewpoint of first user 1042a in response to the input provided by first user 1042a in FIG. 10F. In some embodiments, the user interfaces illustrated in FIG. 10F (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10F (e.g., on display generation component 120b) and described below are implemented on a second head-mounted display that displays three-dimensional environment 1002b (e.g., as an AR, VR, MR, XR or AR environment) to second user 1042b. In some embodiments, pivoting the virtual object 1006a in three-dimensional environment 1002a has one or more characteristics of pivoting the first virtual object and the first portion of the one or more virtual objects that are shared in the communication session with the one or more computer systems about the first location in the three-dimensional environment corresponding to the first viewpoint of the first user as described with reference to method 1100. As shown in FIG. 10F, boundary 1022, and the virtual objects displayed within boundary 1022 (e.g., virtual object 1004, virtual representation 1014b and virtual representation 1014c) are pivoted (e.g., using the same distance and/or relative path of movement as virtual object 1006a) about the location in three-dimensional environment 1002a corresponding to the current viewpoint of first user 1042a. Optionally, virtual objects displayed in three-dimensional environment 1002a that are not shared in the communication session (e.g., virtual object 1004) are not pivoted with virtual object 1006a in response to the input provided by first user 1042a in FIG. 10E (e.g., virtual object 1004 does not change spatial arrangement in response to a request to change the spatial arrangement of virtual object 1004a). As shown in FIG. 10F, in response to the change in spatial arrangement of virtual object 1006a (e.g., and virtual representation 1014b) relative to the current viewpoint of first user 1042a, second computer system 101b changes the spatial arrangement (e.g., moves to an updated pose) relative to the current viewpoint of second user 1042b. For example, as shown in overhead view 1040, first user 1042a is at a new orientation in the shared three-dimensional environment relative to the current viewpoint of second user 1042b as a result of the change in spatial arrangement of virtual object 1006a relative to the current viewpoint of first user 1042a (e.g., compared to as shown in FIG. 10E). Accordingly, virtual representation 1014a is displayed at a new orientation (e.g., an updated pose) in three-dimensional environment 1002b in accordance with the input provided by first user 1042a to change the spatial arrangement of virtual object 1006a in three-dimensional environment 1002a.

As shown in FIG. 10F, as a result of changing the spatial arrangement of boundary 1022 relative to the current viewpoint of first user 1042a, a portion 1028b of boundary 1022 spatially conflicts (e.g., is located in three-dimensional environment 1002a at a same location as) an object (e.g., a wall) that is visible in three-dimensional environment 1002a. For example, the object is visible in three-dimensional environment 1002a as optical passthrough of the physical environment of first user 1042a. In accordance with the spatial conflict between the object and portion 1028b of boundary 1022, portion 1028b is displayed with a reduced visual prominence (e.g., including one or more characteristics of the reduced visual prominence of portion 1028a shown and described with reference to FIG. 10E).

In FIG. 10F, first user 1042a provides an input to change the spatial arrangement of virtual object 1006a relative to the current viewpoint of first user 1042a. In some embodiments, the input shown in FIG. 10F is a continuation of the input initiated in FIG. 10A and continued in FIGS. 10D-10E. In some embodiments, the input shown in FIG. 10F includes hand movement relative to three-dimensional environment 1002a. For example, user 1042a provides hand movement (e.g., while maintaining an air gesture (e.g., air pinch)) in relative to the current viewpoint of first user 1042a in three-dimensional environment 1002a. In some embodiments, the input corresponds to a request to move virtual object 1006a in a first dimension (e.g., including one or more characteristics of the respective dimension as described with reference to method 1200) in three-dimensional environment 1002a (e.g., corresponding to a vertical direction) from the current viewpoint of first user 1042a (e.g., the hand movement is vertical movement relative to three-dimensional environment 1002a (e.g., as represented by an arrow shown adjacent to hand 1008a).

FIG. 10G illustrates computer system 101a forgoing movement of virtual object 1006a in the first dimension relative to three-dimensional environment 1002a in response to the input provided by first user 1042a in FIG. 10F. In some embodiments, the user interfaces illustrated in FIG. 10G (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10G (e.g., on display generation component 120b) and described below are implemented on a second head-mounted display that displays three-dimensional environment 1002b (e.g., as an AR, VR, MR, XR or AR environment) to second user 1042b. In some embodiments, first computer system 101a does not permit movement of virtual object 1006a in the first dimension relative to three-dimensional environment 1002a. As shown in FIG. 10G, in response to first computer system 101a forgoing movement of virtual object 1006a in the first dimension relative to three-dimensional environment 1002a in response to the input provided by first user 1042a in FIG. 10F, first computer system 101a forgoes movement (e.g., maintains the position (e.g., current pose (e.g., location and/or orientation))) of virtual representation 1014b and virtual representation 1014c (e.g., and optionally virtual object 1004) relative to three-dimensional environment 1002a. First computer system 101a does not change the spatial arrangement of boundary 1022 in response to the input provided in FIG. 10F (e.g., because the spatial arrangement of virtual object 1006a, virtual representation 1014b and virtual representation 1014c does not change in response to the input provided in FIG. 10F). As shown in FIG. 10G, second computer system 101b forgoes displaying a change in pose of virtual representation 1014a from the perspective of second user 1042b (e.g., because the spatial arrangement between the current viewpoint of first user 1042a and the current viewpoint of second user 1042b relative to the three-dimensional environment shared in the communication session does not change as a result of the input received by first computer system 101a in FIG. 10F).

As shown in FIG. 10G, first user 1042a ceases to provide the input corresponding to the request to change the spatial arrangement of virtual object 1006a relative to the current viewpoint of first user 1042a. For example, first user 1042a ceases to direct gaze 1024 to virtual element 1018, ceases the air gesture (e.g., air pinch) performed by hand 1008a and/or ceases the hand movement performed by hand 1008a.

FIG. 10H illustrates first computer system 101a changing the visual appearance of three-dimensional environment 1002a in response to first user 1042a ceasing to provide the input corresponding to the request to change the spatial arrangement of virtual object 1006a. In some embodiments, the user interfaces illustrated in FIG. 10H (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10H (e.g., on display generation component 120b) and described below are implemented on a second head-mounted display that displays three-dimensional environment 1002b (e.g., as an AR, VR, MR, XR or AR environment) to second user 1042b. As shown in FIG. 10H, first computer system 101a displays three-dimensional environment 1002a with the visual appearance shown in FIG. 10A (e.g., before the change in spatial arrangement of virtual object 1006a was initiated by first user 1042a). For example, changing the visual appearance of three-dimensional environment 1002a includes one or more characteristics of displaying the three-dimensional environment with the first visual appearance as described with reference to method 1100. FIG. 10H further illustrates first computer system 101a redisplaying virtual representation 1012b and virtual representation 1012c in three-dimensional environment 1002a (e.g., first computer system 101a changes the display of the respective virtual representations of second user 1042b and third user 1042c from virtual representations 1014b-1014c to virtual representations 1012b-1012c in response to first user 1042a ceasing to provide the input corresponding to the request to change the spatial arrangement of virtual object 1006a). As shown in FIG. 10H, first computer system 101a redisplays virtual representation 1012b and virtual representation 1012c at updated positions (e.g., location and/or orientation) in three-dimensional environment 1002a in accordance with the change of spatial arrangement of virtual object 1006a relative to the current viewpoint of first user 1042a (e.g., first computer system 101a maintains the spatial relationship of virtual representation 1012b and virtual representation 1012c when the spatial arrangement of virtual object 1006a is changed relative to the current viewpoint of first user 1042a. In FIG. 10H, second computer system 101b redisplays virtual representation 1012a (e.g., changes the respective virtual representation of first user 1042a from virtual representation 1014a to virtual representation 1012a) in three-dimensional environment 1002b from the perspective of second user 1042b. In some embodiments, the position (e.g., location and/or orientation) of virtual representation 1012a corresponds to the pose of virtual representation 1014a shown in FIG. 10G (e.g., corresponding to the location of the current viewpoint of first user 1042a from the perspective of second user 1042b viewing the three-dimensional environment shared in the communication session). In some embodiments, in response to first user 1042a ceasing to provide the input to change the spatial arrangement of virtual object 1006a, virtual representations 1012a-1012c are displayed with the first amount of visual prominence (e.g., as shown and described with reference to FIG. 10A).

As shown in FIG. 10H, first user 1042a performs an input corresponding to a request to change the spatial arrangement (e.g., move) of virtual object 1004 in three-dimensional environment 1002a from the current viewpoint of first user 1042a. For example, the input includes gaze 1024 direct to virtual element 1016 while concurrently performing an air gesture (e.g., an air pinch) with hand 1008a. In some embodiments, the input shown in FIG. 10H corresponds to selection of virtual element 1016. In some embodiments, the input shown in FIG. 10H corresponds to a request to move virtual object 1004 in the first dimension in three-dimensional environment 1002a (e.g., in a vertical direction relative to the current viewpoint of first user 1042a). For example, the input includes hand movement (e.g., performed with hand 1008 while concurrently maintaining the air gesture) corresponding to movement relative to the first dimension in three-dimensional environment 1002a (e.g., first user 1042a moves hand 1008 vertically relative to their current viewpoint).

FIG. 10I illustrates first computer system 101a moving virtual object 1004 in the first dimension in three-dimensional environment 1002a in response to the input provided by first user 1042a in FIG. 10H. In some embodiments, the user interfaces illustrated in FIG. 10I (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10A (e.g., on display generation component 120b) and described below are implemented on a second head-mounted display that displays three-dimensional environment 1002b (e.g., as an AR, VR, MR, XR or AR environment) to second user 1042b. In some embodiments, first computer system 101a permits movement of virtual object 1004 in the first dimension in three-dimensional environment 1002a (e.g., because virtual object 1004 is not shared in the communication session). As shown in FIG. 10I, first computer system 101a provides different visual feedback when displaying the change in spatial arrangement of virtual object 1004 compared to changing the spatial arrangement of virtual object 1006a (e.g., as shown in FIGS. 10B-10G). For example, first computer system 101a forgoes changing the visual appearance of three-dimensional environment 1002a. For example, first computer system 101a does not display boundary 1022. For example, first computer system 101a maintains display of virtual representation 1012b and virtual representation 1012c with the first amount of visual prominence.

As shown in FIG. 10I, first user 1042a provides an input corresponding to a request to change the spatial arrangement of virtual object 1004. In some embodiments, the input shown in FIG. 10I is a continuation of the input provided by first user 1042a in FIG. 10H (e.g., user 1042a maintains the air gesture performed by hand 1008a and continues hand movement relative to three-dimensional environment 1002a). In some embodiments, the input shown in FIG. 10I corresponds to a request to move virtual object 1004 in a second dimension and a third dimension different from the first dimension (e.g., laterally and in a direction of depth relative to the current viewpoint of first user 1042a). For example, the hand movement performed by hand 1008a includes movement relative to three-dimensional environment 1002a in a lateral direction and a direction of depth relative to the current viewpoint of first user 1042a.

FIG. 10J illustrates movement of virtual object 1004 in three-dimensional environment 1002a in response to the input provided by first user 1042a in FIG. 10I. In some embodiments, the user interfaces illustrated in FIG. 10J (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10J (e.g., on display generation component 120b) and described below are implemented on a second head-mounted display that displays three-dimensional environment 1002b (e.g., as an AR, VR, MR, XR or AR environment) to second user 1042b. As shown in overhead view 1040, virtual object 1004 is moved laterally and to a greater distance from the current viewpoint of first user 1042a compared to as shown in FIG. 10I. In FIG. 10J, first computer system 101a maintains virtual object 1004 with the same display size relative to the current viewpoint of first user 1042a. As shown in overhead view 1040, first computer system 101a increases the size of virtual object 1004 relative to three-dimensional environment 1004a as virtual object 1004 is moved to a greater distance relative to the current viewpoint of first user 1042a (e.g., causing the display size of virtual object 1004 to be maintained from the current viewpoint of first user 1042a).

FIG. 10K illustrates first user 1042a providing an input corresponding to a request to change the spatial arrangement of virtual representation 1012b in three-dimensional environment 1002a from to the current viewpoint of first user 1042a. In some embodiments, the user interfaces illustrated in FIG. 10K (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10K (e.g., on display generation component 120b) and described below are implemented on a second head-mounted display that displays three-dimensional environment 1002b (e.g., as an AR, VR, MR, XR or AR environment) to second user 1042b. As shown in FIG. 10K, the input includes gaze 1024 directed to virtual representation 1012b. In some embodiments, the input includes an air gesture performed by hand 1008a. In response to the input provided by first user 1042a, first computer system 101a displays a visual indication 1026 in three-dimensional environment 1002a at a location below virtual representation 1012b from the current viewpoint of first user 1042a. In some embodiments, visual indication 1026 is displayed on a surface visible in three-dimensional environment 1002a (e.g., including one or more characteristics of the surface boundary 1022 is displayed on as shown and described with reference to FIG. 10B). In some embodiments, displaying visual indication 1026 has one or more characteristics of displaying the visual indication corresponding to the request to change the spatial arrangement of the first virtual object in the three-dimensional environment at the respective spatial arrangement relative to the first virtual object in the three-dimensional environment as described with reference to method 1100. In some embodiments, indication 1026 is displayed by first computer system 101a in response to attention (e.g., gaze 1024) directed to virtual representation 1012b (e.g., to indicate to first user 1042a that first user 1042a is permitted to change the spatial arrangement of virtual representation 1012b (e.g., and optionally that changing the spatial arrangement of virtual representation 1012b will cause first computer system 101a to display the same visual feedback displayed when changing the spatial arrangement of virtual object 1006a as shown and described with reference to FIGS. 10B-10G)).

FIG. 10L illustrates first computer system 101a changing the display of the respective virtual representations of second user 1042b and third user 1042c and displaying boundary 1022 in response to the input provided by first user 1042a in FIG. 10K. In some embodiments, the user interfaces illustrated in FIG. 10L (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10L (e.g., on display generation component 120b) and described below are implemented on a second head-mounted display that displays three-dimensional environment 1002b (e.g., as an AR, VR, MR, XR or AR environment) to second user 1042b. In FIG. 10L, the respective virtual representation of second user 1042b is changed to virtual representation 1014b and the respective virtual representation of third user 1042c is changed to virtual representation 1014c. As shown in FIG. 10L, first computer system 101a maintains display of visual indication 1026 in three-dimensional environment 1002a. Optionally, first computer system 101a ceases display of visual indication 1026 when changing the spatial arrangement of the respective virtual representation of second user 1042b. In some embodiments, first computer system 101a displays the same visual feedback in three-dimensional environment 1002a as changing the spatial arrangement of virtual object 1006a (e.g., display of boundary 1022 and/or change of visual appearance of three-dimensional environment 1002a) in response to the input provided by first user 1042a to change the spatial arrangement of virtual representation 1012b relative to the current viewpoint of first user 1042a because virtual representation 1014b is shared in the communication session (e.g., with first computer system 101a and the third computer system (e.g., associated with third user 1042c)). In FIG. 10L, second computer system 101b changes the display of the respective virtual representation of first user 1042a to virtual representation 1014a in three-dimensional environment 1002b from the perspective of second user 1042b in accordance with the input provided by first user 1042a to change the spatial arrangement of virtual representation 1014.

As shown in FIG. 10L, an input is provided by first user 1042a to change the spatial arrangement of virtual representation 1014b relative to the current viewpoint of first user 1042a. In some embodiments, the input shown in FIG. 10L is a continuation of the input shown in 10K (e.g., to change the spatial arrangement of virtual representation 1012b). In some embodiments, the input shown in FIG. 10L includes hand movement (e.g., while concurrently maintaining the air gesture (e.g., air pinch)) relative to three-dimensional environment 1002a. In some embodiments, the input shown in FIG. 10L corresponds to a request to pivot virtual representation 1014b (e.g., and consequently boundary 1022 and the objects displayed within boundary 1022) about a location corresponding to the current viewpoint of first user 1042a. In some embodiments, the input includes lateral (e.g., to the right) and/or arced (e.g., along a curved trajectory) hand movement relative to three-dimensional environment 1002a from the current viewpoint of first user 1042a.

FIG. 10M illustrates first computer system 101a pivoting virtual representation 1014b in three-dimensional environment 1002a in response to the input provided by first user 1042a in FIG. 10L. In some embodiments, the user interfaces illustrated in FIG. 10M (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10M (e.g., on display generation component 120b) and described below are implemented on a second head-mounted display that displays three-dimensional environment 1002b (e.g., as an AR, VR, MR, XR or AR environment) to second user 1042b. In some embodiments, first computer system 101a uses a different pivot radius (e.g., corresponding to the second pivot radius described with reference to method 1100) for pivoting virtual representation 1014b in three-dimensional environment 1002a compared to the pivot radius (e.g., corresponding to the first pivot radius described with reference to method 1100) used to pivot virtual object 1006a in three-dimensional environment 1002a (e.g., due to the difference in distance of virtual object 1006a relative to the current viewpoint of first user 1042a and virtual representation 1014b relative to the current viewpoint of first user 1042a). In some embodiments, pivoting virtual representation 1014b in three-dimensional environment 1002a includes pivoting boundary 1022 and the virtual objects displayed within boundary 1022 (e.g., virtual object 1006a, virtual representation 1014c and optionally virtual object 1004) in three-dimensional environment 1002a from the current viewpoint of first user 1042a (e.g., corresponding to the same distance and/or path of movement of virtual representation 1014b). As shown in FIG. 10M, first computer system 101a maintains a shared spatial arrangement of virtual object 1006a, virtual representation 1014b and virtual representation 1014c (e.g., and optionally virtual object 1004) when changing the spatial arrangement of virtual representation 1014b (e.g., and thus the spatial arrangement of virtual representation 1012b upon detecting termination of the input) relative to the current viewpoint of first user 1042a. In FIG. 10M, second computer system 101b changes a current pose (e.g., orientation and/or location) of virtual representation 1014a in three-dimensional environment 1002b from the perspective of second user 1042b in accordance with the change in spatial arrangement between the current viewpoint of first user 1042a and the current viewpoint of second user 1042b caused by the input provided by first user 1042a to change the spatial arrangement of virtual representation 1012b relative to the current viewpoint of first user 1042a.

As shown in FIG. 10M, first user 1042a provides an input to change the spatial arrangement of virtual representation 1014b in three-dimensional environment 1002a relative to the current viewpoint of first user 1042a. In some embodiments, the input shown in FIG. 10M is a continuation of the input shown in FIG. 10L (e.g., the input shown in FIG. 10M is an input to further pivot the virtual representation 1014b (e.g., and thus virtual representation 1012b upon ceasing to provide the input) relative to the current viewpoint of first user 1042a). In some embodiments, the input shown in FIG. 10M has one or more characteristics of the input shown and described with reference to FIG. 10L.

FIG. 10N illustrates continued movement of virtual representation 1014b (e.g., and virtual representation 1014c, virtual object 1006a and virtual object 1004) in response to the input provided by first user 1042a in FIG. 10M. In some embodiments, the user interfaces illustrated in FIG. 10N (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10N (e.g., on display generation component 120b) and described below are implemented on a second head-mounted display that displays three-dimensional environment 1002b (e.g., as an AR, VR, MR, XR or AR environment) to second user 1042b. As shown in FIG. 10N, second computer system 101b changes a current pose (e.g., orientation and/or location) of virtual representation 1014a in virtual environment 1002b from the perspective of second user 1042b in accordance with the continued change in spatial arrangement between the current viewpoint of first user 1042a and the current viewpoint of second user 1042b caused by the input provided by first user 1042a to change the spatial arrangement of virtual representation 1012b relative to the current viewpoint of first user 1042a. In overhead view 1040 shown in FIG. 10N, the current viewpoint of third user 1042c changes relative to the three-dimensional environment shared in the communication session (e.g., the spatial relationship between the current viewpoint of third user 1042c and virtual object 1006a changes in overhead view 1040 shown in FIG. 10N compared to as shown in FIG. 10M). In accordance with the change in spatial arrangement of the current viewpoint of third user 1042c relative to the three-dimensional environment shared in the communication session, second computer system 101b changes the position (e.g., location) of virtual representation 1012c in three-dimensional environment 1002b from the current viewpoint of second user 1042b. In some embodiments, second computer system 101b displays the second representation of movement of virtual representation 1012c to the updated position relative to three-dimensional environment 1002b (e.g., including one or more characteristics of displaying the second representation of movement as described with reference to method 900). Optionally, second computer system 101b changes the respective virtual representation of third user 1042c to virtual representation 1014c and displays the first representation of movement of virtual representation 1014c (e.g., including one or more characteristics of displaying the first representation of movement as described with reference to method 900). In accordance with the change in spatial arrangement of the current viewpoint of third user 1042c relative to the three-dimensional environment shared in the communication session, first computer system 101a forgoes changing the current pose of virtual representation 1014c relative to three-dimensional environment 1002a from the current viewpoint of first user 1042a while continuing to receive the input corresponding to the request by first user 1042a to change the spatial arrangement of virtual representation 1012b in three-dimensional environment 1002a relative to the current viewpoint of first user 1042a. In some embodiments, in accordance with first computer system 101a detecting termination of the input corresponding to the request to change the spatial arrangement of virtual representation 1012b (e.g., first user 1042a ceases to provide the input), first computer system 101a changes the pose of virtual representation 1014c (e.g., or optionally virtual representation 1012c that first computer system 101a displays in three-dimensional environment 1002a after receiving the input) in accordance with the change in spatial arrangement of the current viewpoint of third user 1042c relative to the three-dimensional environment shared in the communication session.

FIG. 10O illustrates first computer system 101a changing the pose of virtual representation 1014c in three-dimensional environment 1002a from the current viewpoint of first user 1042a while changing the spatial arrangement of virtual representation 1014b (e.g., and boundary 1022 and the objects displayed within boundary 1022) in three-dimensional environment 1002a from the current viewpoint of first user 1042a. In some embodiments, the user interfaces illustrated in FIG. 10O (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10O (e.g., on display generation component 120b) and described below are implemented on a second head-mounted display that displays three-dimensional environment 1002b (e.g., as an AR, VR, MR, XR or AR environment) to second user 1042b. FIG. 10O particularly shows an alternative embodiment that includes first computer system 101a changing the pose of virtual representation 1014c in accordance with the change in spatial arrangement of the current viewpoint of third user 1042c relative to the three-dimensional environment shared in the communication session while receiving the input corresponding to the request to change the spatial arrangement of virtual representation 1012b (e.g., compared to forgoing changing the spatial arrangement of virtual representation 1014c (e.g., and thus virtual representation 1012c upon termination of the input) while receiving the input as shown and described with reference to FIG. 10N).

FIG. 10P illustrates first computer system 101a changing the visual appearance of three-dimensional environment 1002a in response to first user 1042a ceasing to provide the input corresponding to the request to change the spatial arrangement of virtual representation 1012b. In some embodiments, the user interfaces illustrated in FIG. 10P (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10P (e.g., on display generation component 120b) and described below are implemented on a second head-mounted display that displays three-dimensional environment 1002b (e.g., as an AR, VR, MR, XR or AR environment) to second user 1042b. As shown in FIG. 10P, first computer system 101a displays three-dimensional environment 1002a with the visual appearance shown in FIG. 10J (e.g., before the input to change the spatial arrangement of virtual representation 1012b was initiated by first user 1042a). For example, changing the visual appearance of three-dimensional environment 1002a includes one or more characteristics of displaying the three-dimensional environment with the first visual appearance as described with reference to method 1100. FIG. 10P further illustrates first computer system 101a redisplaying virtual representation 1012b and virtual representation 1012c in three-dimensional environment 1002a (e.g., first computer system 101a changes the display of the respective virtual representations of second user 1042b and third user 1042c from virtual representations 1014b-1014c to virtual representations 1012b-1012c in response to first user 1042a ceasing to provide the input corresponding to the request to change the spatial arrangement of virtual representation 1012b).

As shown in FIG. 10P, first computer system 101a redisplays virtual representation 1012b and virtual representation 1012c at updated positions (e.g., location and/or orientation) in three-dimensional environment 1002a in accordance with the input to change the spatial arrangement of virtual representation 1012b. In FIG. 10P, second computer system 101b redisplays virtual representation 1012a (e.g., changes the respective virtual representation of first user 1042a from virtual representation 1014a to virtual representation 1012a) in three-dimensional environment 1002b from the perspective of second user 1042b. In some embodiments, the position (e.g., location and/or orientation) of virtual representation 1012a corresponds to the pose of virtual representation 1014a shown in FIG. 10O (e.g., corresponding to the location of the current viewpoint of first user 1042a from the perspective of second user 1042b viewing the three-dimensional environment shared in the communication session). In some embodiments, in response to first user 1042a ceasing to provide the input to change the spatial arrangement of virtual representation 1012b, virtual representations 1012a-1012c are displayed with the first amount of visual prominence (e.g., as shown and described with reference to FIG. 10A).

FIG. 10Q illustrates an alternative view of three-dimensional environment 1002a and three-dimensional environment 1002b that includes a virtual object 1006b. In some embodiments, virtual object 1006b is shared in the communication session (e.g., and is visible from the perspective of first user 1042a and second user 1042b relative to the three-dimensional environment that is shared in the communication session). In some embodiments, the user interfaces illustrated in FIG. 10Q (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10Q (e.g., on display generation component 120b) and described below are implemented on a second head-mounted display that displays three-dimensional environment 1002b (e.g., as an AR, VR, MR, XR or AR environment) to second user 1042b. In some embodiments, virtual object 1006b has one or more characteristics of virtual object 1006a (e.g., as shown and described with reference to FIGS. 10A-10P). As shown in FIG. 10Q, virtual object 1006b has a different size and shape relative to three-dimensional environments 1002a and 1002b. In some embodiments, virtual object 1006b corresponds to different shared content compared to virtual object 1006a. In FIG. 10Q, virtual representations 1012a-1012c are shown in addition to a virtual representation 1012d. In some embodiments, virtual representation 1012d corresponds to a virtual representation of a fourth user 1042d (e.g., as shown in overhead view 1040 in FIG. 10Q) of a fourth computer system in the communication session with first computer system 101a, second computer system 101b, and the third computer system. In some embodiments, fourth user 1042d views the three-dimensional environment that is shared in the communication session from a different perspective compared to first user 1042a, second user 1042b and/or third user 1042c. In some embodiments, the representation of fourth user 1042d in overhead view 1040 represents a location and/or orientation of a current viewpoint of fourth user 1042d relative to the three-dimensional environment shared in the communication session (e.g., relative to three-dimensional environment 1002a from the perspective of first user 1042a). In some embodiments, the representation of fourth user 1042d in overhead view 1040 represents a location and/or orientation of a respective virtual representation (e.g., virtual representation 1012d or virtual representation 1014d (e.g., as shown in FIG. 10S)) relative to the three-dimensional environment 1002a. As shown in FIG. 10Q, virtual object 1006b and virtual representations 1012b-1012d are displayed in three-dimensional environment 1002a from the perspective of first user 1042a (e.g., based on the spatial relationship of first user 1042a with second user 1042b, third user 1042c, fourth user 1042d, and virtual object 1006b as shown in overhead view 1040). As shown in FIG. 10Q, virtual object 1006b, and virtual representations 1012a, 1012c and 1012d are displayed in three-dimensional environment 1002b from the perspective of second user 1042b (e.g., based on the spatial relationship of second user 1042b with first user 1042a, third user 1042c, fourth user 1042d, and virtual object 1006b as shown in overhead view 1040).

In FIG. 10Q, first user 1042a directs an input corresponding to attention (e.g., through gaze 1024) to a region of three-dimensional environment 1002a below virtual object 1006b relative to the current viewpoint of user 1042a. In some embodiments, the region of three-dimensional environment 1002a below virtual object 1006b has one or more characteristics of the region of three-dimensional environment, outside of the first virtual object, that has a predefined spatial relationship relative to the first virtual object in the three-dimensional environment as described with reference to method 1100.

FIG. 10R illustrates first computer system 101a displaying affordance 1032 in three-dimensional environment 1002a in response to the input provided by first user 1042a in FIG. 10Q. In some embodiments, the user interfaces illustrated in FIG. 10R (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10R (e.g., on display generation component 120b) and described below are implemented on a second head-mounted display that displays three-dimensional environment 1002b (e.g., as an AR, VR, MR, XR or AR environment) to second user 1042b. In some embodiments, displaying affordance 1032 includes one or more characteristics of displaying the first visual feedback in three-dimensional environment that indicates that the spatial arrangement of the first virtual object relative to the first viewpoint of the first user can be changes in response to further input as described with reference to method 1100. In some embodiments, affordance 1032 is selectable to change the spatial arrangement of virtual object 1006b (e.g., and virtual representations 1012b-1012d) in three-dimensional environment 1002a relative to the current viewpoint of first user 1042a. In some embodiments, affordance 1032 is displayed on a surface visible in three-dimensional environment 1002a (e.g., including one or more characteristics of the surface that boundary 1022 is displayed on as described with reference to FIG. 10B).

In FIG. 10R, first user 1042a performs an input corresponding to a request to change the spatial arrangement of virtual object 1006b in three-dimensional environment 1002a from the current viewpoint of first user 1042a. In some embodiments, the input shown in FIG. 10R corresponds to further input (e.g., as described above and with reference to method 1100). As shown in FIG. 10R, the input includes gaze 1024 directed to affordance 1032. In some embodiments, first user 1042a performs an air gesture (e.g., including one or more air gestures described with reference to methods 800, 900, 1100 and/or 1200) with hand 1008b. In some embodiments, hand 1008b corresponds to a second hand (e.g., different from hand 1008a) of first user 1042a.

FIG. 10S illustrates first computer system 101a displaying visual feedback in three-dimensional environment 1002a in response to the input provided by first user 1042a in FIG. 10R. In some embodiments, the user interfaces illustrated in FIG. 10S (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10S (e.g., on display generation component 120b) and described below are implemented on a second head-mounted display that displays three-dimensional environment 1002b (e.g., as an AR, VR, MR, XR or AR environment) to second user 1042b. For example, first computer system 101a changes the visual appearance of three-dimensional environment 1002a (e.g., including one or more characteristics of changing the visual appearance of three-dimensional environment 1002a as described with reference to FIG. 10B. For example, as shown in FIG. 10S, first computer system 101a displays boundary 1022 in three-dimensional environment 1002a (e.g., including one or more characteristics of displaying boundary 1022 in three-dimensional environment 1002a as described with reference to FIG. 10B). In some embodiments, boundary 1022 includes a different size (e.g., perimeter) relative to three-dimensional environment 1002a as shown in FIG. 10B due to the difference in the shared spatial relationship (e.g., and size) of the virtual objects displayed in three-dimensional environment 1002a in FIG. 10S compared to the shared spatial relationship (e.g., and size) of the virtual objects displayed in three-dimensional environment 1002a in FIG. 10B (e.g., or optionally FIGS. 10C-10D). As shown in FIG. 10S, the respective virtual representations of second user 1042b, third user 1042c, and fourth user 1042d are changed to virtual representations 1014b-1014d. In some embodiments, virtual representation 1014d corresponds to a virtual representation of fourth user 1042d and has one or more characteristics of virtual representations 1014a-1014c. In some embodiments, displaying the visual feedback in three-dimensional environment 1002a in response to the input provided by first user 1042a in FIG. 10R includes displaying a virtual representation of three-dimensional environment 1002a in three-dimensional environment 1002a. As shown in FIG. 10S, first computer system 101a displays virtual representation 1034 in three-dimensional environment 1002a (e.g., optionally on the surface visible in three-dimensional environment 1002a). In some embodiments, virtual representation 1034 has one or more characteristics of the virtual representation of the three-dimensional environment including one or more virtual elements corresponding to one or more current spatial arrangements of one or more virtual objects relative to the three-dimensional environment as described with reference to method 1100. As shown in FIG. 10S, second computer system 101b changes the display of the respective virtual representation of first user 1042a to virtual representation 1014a in response to the input received by first computer system 101a in FIG. 10R (e.g., first computer system 101a sends an indication to second computer system 101b corresponding to the input received by first computer system 101a).

As shown in FIG. 10S, first user 1042a provides an input corresponding to a request to change the spatial arrangement of virtual object 1006b in three-dimensional environment 1002a from the current viewpoint of first user 1042a. In some embodiments, the input shown in FIG. 10S corresponds to further input provided by first user 1042a from the input provided by first user 1042a in FIG. 10R. In some embodiments, the input shown in FIG. 10S includes first user 1042a maintaining gaze 1024 (e.g., at the location in three-dimensional environment 1002a corresponding to affordance 1032 and/or virtual representation 1034) and the air gesture with hand 1008b while performing hand movement with hand 1008a (e.g., the input shown in FIG. 10S is a two-hand input). In some embodiments, the input shown in FIG. 10S has one or more characteristics of the first input including input from the first portion of the first user and the second portion of the first user as described with reference to method 1100. In some embodiments, the input shown in FIG. 10S corresponds to a request to pivot virtual object 1006b about a location in three-dimensional environment corresponding to the current viewpoint of first user 1042a (e.g., as described with reference to the input shown in FIG. 10E).

FIG. 10T illustrates first computer system 101a pivoting virtual object 1006b in three-dimensional environment 1002a from the current viewpoint of first user 1042a in response to the input provided by first user 1042a in FIG. 10S. In some embodiments, the user interfaces illustrated in FIG. 10T (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10T (e.g., on display generation component 120b) and described below are implemented on a second head-mounted display that displays three-dimensional environment 1002b (e.g., as an AR, VR, MR, XR or AR environment) to second user 1042b. As shown in FIG. 10T, pivoting virtual object 1006b in three-dimensional environment 1002a includes pivoting boundary 1022 and the objects displayed within boundary 1022 (e.g., virtual representations 1014b-1014d) with virtual object 1006b (e.g., corresponding to the same distance and/or path of movement of virtual object 1006). As shown in FIG. 10T, pivoting virtual object 1006b in three-dimensional environment 1002a from the current viewpoint of first user 1042a includes maintaining a shared spatial arrangement of the virtual objects displayed within boundary 1022 (e.g., virtual representations 1014b-1014d and virtual object 1006b) while changing the spatial arrangement of virtual object 1006b in accordance with the input provided by first user 1042a. In FIG. 10T, the spatial arrangement of virtual elements included in virtual representation 1034 (e.g., the virtual elements correspond to representations of the virtual objects displayed in three-dimensional environment 1002a) are updated by first computer system 101a to represent the current positions (e.g., location and/or orientation) of the virtual objects displayed in three-dimensional environment 1002a from the current viewpoint of first user 1042a (e.g., virtual representation 1034 is updated to reflect the change in spatial arrangement of the virtual objects displayed in three-dimensional environment 1002a caused by the input provided by first user 1042a). As shown in FIG. 10T, second computer system 101b displays virtual representation 1014a at an updated pose in three-dimensional environment 1002b from the perspective of second user 1042b in accordance with the change in spatial arrangement between the current viewpoint of first user 1042a and the current viewpoint of second user 1042b caused by the input provided by first user 1042a to change the spatial arrangement of virtual object 1006b relative to the current viewpoint of first user 1042a. In FIG. 10T, first user 1042a ceases to provide the input corresponding to the request to change the spatial arrangement of virtual object 1006b in three-dimensional environment 1002a from the current viewpoint of first user 1042a (e.g., first user 1042a ceases to provide the air gesture with hand 1008b and/or hand movement with hand 1008a).

FIG. 10U illustrates first computer system 101a changing the visual appearance of three-dimensional environment 1002a in response to first user 1042a ceasing to provide the input in FIG. 10T. In some embodiments, the user interfaces illustrated in FIG. 10U (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10U (e.g., on display generation component 120b) and described below are implemented on a second head-mounted display that displays three-dimensional environment 1002b (e.g., as an AR, VR, MR, XR or AR environment) to second user 1042b. As shown in FIG. 10U first computer system 101a displays three-dimensional environment 1002a with the visual appearance shown in FIG. 10Q. In some embodiments, changing the visual appearance of three-dimensional environment 1002a includes one or more characteristics of displaying the three-dimensional environment with the first visual appearance as described with reference to method 1100. FIG. 10U shows first computer system 101a redisplaying virtual representations 1012b-1012d in three-dimensional environment 1002a. As shown in FIG. 10U, second computer system 101b redisplays virtual representation 1012a in accordance with first computer system 101a ceasing to detect the input corresponding to the request to change the spatial arrangement of virtual object 1006b in three-dimensional environment 1002a from the current viewpoint of first user 1042a. In FIG. 10U, first user 1042a provides an input corresponding to selection of virtual indication 1020 to ceasing sharing virtual object 1006b in the communication session. As shown in FIG. 10U, the input includes gaze 1024 directed to virtual indication 1020. In some embodiments, first user 1042a performs an air gesture (e.g., air pinch) with hand 1008a while concurrently directing gaze 1024 to virtual indication 1020.

FIG. 10V illustrates first computer system 101a ceasing to share virtual object 1006b in the communication session in response to the input corresponding to selection of virtual indication 1020 performed by first user 1042a in FIG. 10U. In some embodiments, the user interfaces illustrated in FIG. 10V (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10V (e.g., on display generation component 120b) and described below are implemented on a second head-mounted display that displays three-dimensional environment 1002b (e.g., as an AR, VR, MR, XR or AR environment) to second user 1042b. As shown in FIG. 10V, first computer system 101a ceases to display virtual object 1006b in three-dimensional environment 1002a and second computer system 101b ceases to display virtual object 1006b in three-dimensional environment 1002b in response to the input provided by first user 1042a in FIG. 10U. Optionally, first computer system 101a maintains display of virtual object 1006b in three-dimensional environment 1002a and second computer system 101b ceases to display virtual object 1006b in three-dimensional environment 1002b in response to the input provided by first user 1042a in FIG. 10U (e.g., first computer system 101a displays virtual object 1006b as a virtual object that is not shared in the communication session (e.g., including one or more characteristics of virtual object 1004 shown and described with reference to FIGS. 10A-10P). In FIG. 10V, the spatial arrangement of the current viewpoint of third user 1042c changes relative to the three-dimensional environment shared in the communication session (e.g., as shown in overhead view 1040 by the change in spatial arrangement of the current viewpoint of third user 1042c relative to the current viewpoints of first user 1042a, second user 1042b and fourth user 1042d as previously shown in overhead view 1040 in FIG. 10U). As shown in FIG. 10V, in response to the change in spatial arrangement of the current viewpoint of third user 1042c, a position of virtual representation 1012c is updated in three-dimensional environment 1002a by first computer system 101a and in three-dimensional environment 1002b by second computer system 101b (e.g., the third computer systems sends an indication to first computer system 101a and second computer system 101b corresponding to the change in spatial arrangement of the current viewpoint of third user 1042c relative to the three-dimensional environment shared in the communication session).

FIG. 10W illustrates first computer system 101a displaying visual feedback in three-dimensional environment 1002a in response to an input provided by first user 1042a corresponding to a request to change a spatial arrangement of virtual representation 1012c in three-dimensional environment 1002a from the current viewpoint of first user 1042a. In some embodiments, the user interfaces illustrated in FIG. 10W (e.g., on display generation component 120a) and described below are implemented on a first head-mounted display that displays three-dimensional environment 1002a (e.g., as an AR, VR, MR, XR, or AR environment) to first user 1042a. In some embodiments, the user interfaces illustrated in FIG. 10W (e.g., on display generation component 120b) and described below are implemented on a second head-mounted display that displays three-dimensional environment 1002b (e.g., as an AR, VR, MR, XR or AR environment) to second user 1042b. As shown in FIG. 10W, displaying the visual feedback includes reducing the visual prominence of virtual representations 1012b-1012d relative to three-dimensional environment 1002a (e.g., including one or more characteristics of reducing the visual prominence of virtual representations 1012b-1012c as shown and described with reference to FIG. 10B. In some embodiments, three-dimensional environment 1002a is displayed with the changed visual appearance (e.g., as shown and described with reference to FIG. 10B) in response to the input provided by first user 1042a corresponding to the request to change the spatial arrangement of virtual representation 1012c in three-dimensional environment 1002a from the current viewpoint of first user 1042a. As shown in FIG. 10W, visual indication 1026 is displayed in three-dimensional environment 1002a below virtual representation 1012c (e.g., including one or more characteristics of display visual indication 1026 in three-dimensional environment 1002a as described with reference to FIG. 10K). In FIG. 10W, second computer system 101b reduces the visual prominence of virtual representation 1012a in response to the input provided by first user 1042a corresponding to the request to change the spatial arrangement of virtual representation 1012c (e.g., first computer system 101a sends an indication to second computer system 101b corresponding to the input provided by first user 1042a).

As shown in FIG. 10W, boundary 1022 is displayed in three-dimensional environment 1002a by first computer system 101a. In some embodiments, boundary 1022 is displayed with a size based on the locations of the current viewpoints of first user 1042a, second user 1042b, third user 1042c and fourth user 1042d relative to the three-dimensional environment shared in the communication session (e.g., based on the locations of virtual representations 1012a-1012d relative to the three-dimensional environment shared in the communication session). For example, boundary 1022 is displayed in three-dimensional environment 1002a to surround the current locations of virtual representations 1012b-1012c (e.g., and a location corresponding to the current viewpoint of first user 1042a). In FIG. 10W, boundary 1022 is displayed as a larger size compared to as previously shown in FIG. 10T based on the shared spatial relationship of the current viewpoints of first user 1042a, second user 1042b, third user 1042c and fourth user 1042d being larger in FIG. 10W compared to the shared spatial relationship of the current viewpoints of first user 1042a, second user 1042b, third user 1042c and fourth user 1042d in FIG. 10T (e.g., due to the change in spatial arrangement of the current viewpoint of third user 1042c as shown and described with reference to FIG. 10V). Particularly, overhead view 1040 includes a schematic representation 1022-1 of the size of boundary 1022 as displayed in FIG. 10T (e.g., before the change in spatial arrangement of the current viewpoint of third user 1042c) and a schematic representation 1022-2 of the size of boundary 1022 as displayed in FIG. 10W (e.g., after the change in spatial arrangement of the current viewpoint of third user 1042c).

FIG. 10X illustrates boundary 1022 displayed at an orientation in three-dimensional environment 1002a that is based on an orientation of virtual object 1006a in three-dimensional environment 1002a. As shown in FIG. 10X, user 1042a provides an input corresponding to a request to change the spatial arrangement of virtual object 1006a in three-dimensional environment 1002a. For example, as shown in FIG. 10X, the input includes gaze 1024 (e.g., represented by an eye in FIG. 10X) directed to virtual element 1018 while an air gesture (e.g., air pinch) is performed by hand 1008a. In some embodiments, the input includes movement of hand 1008a relative to three-dimensional environment 1002a while the air gesture is performed, and first computer system 101a moves the plurality of virtual objects displayed within boundary 1022 (e.g., virtual representations 1012b-1012c and virtual object 1006a) in accordance with the movement of hand 1008a. In some embodiments, while the spatial arrangement of virtual object 1006a is changed, first computer system 101a maintains display of boundary at an orientation that is based on the orientation of virtual object 1006a in three-dimensional environment 1002a during the change in spatial arrangement of virtual object 1006a. In some embodiments, first computer system 101a displays boundary 1022 at the orientation in three-dimensional environment 1002a that is based on the orientation of virtual object 1006a in accordance with a determination that virtual object 1006a is shared in the communication session. In some embodiments, in accordance with a determination that virtual object 1006a is not shared in the communication session (e.g., and one or more virtual objects different from virtual object 1006a (e.g., and different from virtual representations 1012b-1012c) that are displayed in three-dimensional environment 1002a are not shared in the communication session), first computer system 101a displays boundary 1022 at an orientation in three-dimensional environment 1002a that is based on a current viewpoint of user 1042a (e.g., as shown and described with reference to FIG. 10Y). As shown in FIG. 10X, while the input corresponding to the request to change the spatial arrangement of virtual object 1006a in three-dimensional environment 1002a is detected, first computer system 101a changes the visual appearance of three-dimensional environment 1002a and displays virtual representations 1012b-1012c with a reduced amount of visual prominence (e.g., as shown and described with reference to FIG. 10B).

In some embodiments, in response to user 1042a initiating the input corresponding to the request to change the spatial arrangement of virtual object 1006a, first computer system 101a displays boundary 1022 in a region of three-dimensional environment 1002a that does not include the location corresponding to the current viewpoint of user 1042a (e.g., from the perspective of user 1042a viewing three-dimensional environment 1002a, a portion of the perimeter of the boundary that is at a location in three-dimensional environment 1002a closest to user 1042a is visible). In FIG. 10X, a portion of the perimeter of boundary 1022 is displayed surrounding a region of three-dimensional environment 1002a that does not include one or more locations associated with the plurality of virtual objects (e.g., virtual object 1006a and virtual representations 1012b-1012c) displayed within boundary 1022. As shown in overhead view 1040, a reference line 1050 is displayed separating a first portion of boundary 1022 that surrounds a region of three-dimensional environment 1002a including the plurality of virtual objects from a second portion of boundary 1022 that surrounds the region of three-dimensional environment 1002a that does not include the plurality of virtual objects (e.g., reference line 1050 schematically represents where the portion of the perimeter boundary 1022 that is closest to the current viewpoint of user 1042a would displayed in three-dimensional environment 1002a in accordance with boundary 1022 only surrounding the region of three-dimensional environment 1002a that includes the plurality of virtual objects and not the region of three-dimensional environment 1002a that does not include the plurality of virtual objects). In some embodiments, in accordance with virtual object 1006a (e.g., and thus boundary 1022 and virtual representations 1012b-1012c) being moved toward the location in three-dimensional environment 1002a corresponding to the current viewpoint of user 1042a (e.g., as a result of the input provided by user 1042a), user 1042a can be included within the second portion of boundary 1022 that does not include the plurality of virtual objects (e.g., when user 1042a is included within boundary 1022, from the perspective of user 1042a viewing three-dimensional environment 1002a, the portion of the perimeter of the boundary that is at a location in three-dimensional environment 1002a closest to user 1042a is not visible).

As shown in FIG. 10X, a virtual element 1052 is displayed in three-dimensional environment 1002a. In some embodiments, virtual element 1052 is selectable (e.g., through a user input including gaze and/or an air gesture directed to virtual element 1052) to permit movement of virtual object 1006a relative to the communication session (e.g., relative to three-dimensional environment 1002b displayed by second computer system 101b and viewed from the perspective of user 1042b, and/or in a three-dimensional environment corresponding to three-dimensional environment 1002a displayed by a third computer system in the communication session and viewed from the perspective of user 1042c). In some embodiments, virtual element 1052 has one or more characteristics of the virtual element that is selectable to change the current status of the virtual element as described with reference to method 1200. In some embodiments, based on a current status of virtual element 1052, movement of virtual object 1006a is permitted relative to the communication session. As shown in FIG. 10X, a current status of virtual element 1052 is “OFF” (e.g., in some embodiments, virtual element 1052 does not include text, and the virtual element 1052 is displayed with different colors based on the current status of virtual element 1052). Accordingly, the change in spatial arrangement of virtual object 1006a corresponds to movement of virtual object 1006a relative to three-dimensional environment 1002a (e.g. relative to the current viewpoint of user 1042a) and does not correspond to movement of virtual object 1006a relative to the communication session (e.g., from the perspective of user 1042b, virtual object 1006a does not move in three-dimensional environment 1002b in accordance with the input provided by user 1042a in FIG. 10X). In some embodiments, the current status of virtual element 1052 does not affect movement of one or more virtual objects displayed in three-dimensional environment 1002a not shared in the communication session (e.g., such as virtual object 1004 shown and described with reference to FIGS. 10A-10P). For example, movement of a virtual object (e.g., in response to an input corresponding to a request to change the spatial arrangement of the object provided by user 1042a) that is not shared in the communication session does not correspond to movement of the virtual object relative to the communication session (e.g., because the virtual object is not visible in three-dimensional environment 1002b viewed from the perspective of user 1042b and/or in a three-dimensional environment viewed from the perspective of user 1042c). In some embodiments, first computer system 101a does not display virtual element 1052 in three-dimensional environment 1002a (e.g., virtual object 1006a is permitted to be moved or not moved relative to the communication session based on the type of virtual object 1006a, or based on an input user 1142a provides through a system user interface of the communication session or of first computer system 101a). In some embodiments, movement of virtual object 1006a is not permitted relative to the communication session in FIGS. 10A-10P (e.g., virtual object 1006a does not move in three-dimensional environment 1002b in accordance with movement of virtual object 1006a in three-dimensional environment 1002a). In some embodiments, movement of virtual object 1006a is permitted based on an air gesture that is performed by user 1042a during the input corresponding to the request to change the spatial arrangement of virtual object 1006a in three-dimensional environment 1002a (e.g., as described with reference to permitting movement of the first virtual object relative to the communication session in accordance with the first input corresponding to a first air gesture and forgoing permitting movement of the first virtual object relative to the communication session in accordance with the first input corresponding to a second air gesture different from the first air gesture in method 1200).

FIG. 10Y illustrates boundary 1022 displayed at an orientation in three-dimensional environment 1002a that is based on the current viewpoint of user 1042a relative to three-dimensional environment 1002a. Particularly, as shown in FIG. 10Y, boundary 1022 is displayed at an orientation that is directed toward the current viewpoint of user 1042a in three-dimensional environment 1002a (e.g., the orientation of boundary 1022 (e.g., relative to three-dimensional environment 1002a and/or relative to the current viewpoint of user 1042a) that is directed toward the current viewpoint of user 1042a as shown in FIG. 10Y is different from the orientation of boundary 1022 (e.g., relative to three-dimensional environment 1002a and/or relative to the current viewpoint of user 1042a) that is based on the orientation of virtual object 1006a as shown in FIG. 10X). For example, as shown in overhead view 1040, a portion of the perimeter of boundary 1022 that is displayed at a location in three-dimensional environment 1002a closest to the current viewpoint of user 1042a is displayed at an orientation that is perpendicular to (e.g., or within 0.1, 0.2, 0.5, 1, 2, 5, 10, 15, 20 or 25 degrees of perpendicular to) to a reference line 1054 extending from the current viewpoint of user 1042a toward the center of the region of three-dimensional environment 1002a surrounded by boundary 1022 (e.g., reference line 1054 corresponds to the vector extending from the location in three-dimensional environment corresponding to the first viewpoint of the first user to the location in three-dimensional environment corresponding to the center of the boundary as described with reference to method 1100). In some embodiments, the reference line 1054 is independent of an orientation of the current viewpoint of user 1042a relative to three-dimensional environment 1002a. For example, reference line 1054 (e.g., corresponding to the vector described with reference to method 1100) extends from a location in three-dimensional environment 1002a corresponding to the center of boundary 1022 to the location in three-dimensional environment 1002a corresponding to the current viewpoint of user 1042a (e.g., boundary 1022 is displayed in three-dimensional environment 1002a at an orientation that is directed toward a location of the current viewpoint of user 1042a independent of the boundary 1022 being displayed at a location in three-dimensional environment 1002a centered with a current viewing angle of user 1042a).

In FIG. 10Y, the portion of the perimeter of the boundary 1022 that is displayed surrounding the region of three-dimensional environment 1002a that does not include one or more locations associated with the plurality of virtual objects (e.g., virtual representations 1012b-1012c) extends toward the current viewpoint of user 1042a (e.g., from the perspective of user 1042a). As shown in FIG. 10Y, upon boundary 1022 being displayed in three-dimensional environment 1002a in response to user 1042a initiating the change in spatial arrangement of virtual representation 1012c, a portion of the perimeter of the boundary 1022 that is displayed closest to the current viewpoint of user 1042a is visible from the current viewpoint of user 1042a. In some embodiments, in accordance with virtual representation 1012c (e.g., and thus boundary 1022 and virtual representation 1012b) being moved toward the location in three-dimensional environment 1002a corresponding to the current viewpoint of user 1042a (e.g., in accordance with the input provided by user 1042a), user 1042a can be included within boundary 1022 (e.g., within the portion of the boundary shown below reference line 1050 (e.g., such that the portion of the perimeter of the boundary 1022 that is displayed closest to the current viewpoint of user 1042a is not visible from the current viewpoint of user 1042a).

As shown in FIG. 10Y, user 1042a provides an input corresponding to a request to change a spatial arrangement of virtual representation 1012c in three-dimensional environment 1002a (e.g., the input is initiated by gaze 1024 being directed to virtual representation 1012c while an air gesture is performed with hand 1008a). In some embodiments, first computer system 101a changes the spatial arrangement of virtual representation 1012c by moving virtual representation 1012c concurrently with virtual representation 1012b and boundary 1022 in accordance with movement performed by hand 1008a relative to three-dimensional environment 1002a during the input. In some embodiments, while first computer system 101a moves virtual representation 1012c (e.g., and virtual representation 1012b and boundary 1022) in three-dimensional environment 1002a, the orientation of boundary 1022 relative to the current viewpoint of user 1042a is maintained (e.g., the portion of the perimeter of the boundary 1022 that is displayed at the location in three-dimensional environment 1002a closest to the current viewpoint of user 1042a continues to be displayed at an orientation that is perpendicular to reference line 1054 while first computer system 101a changes the spatial arrangement of virtual representation 1012c in three-dimensional environment 1002a). As shown in FIG. 10Y, while changing the spatial arrangement of virtual representation 1012c, first computer system 101a changes the visual appearance of three-dimensional environment 1002a and reduces the visual prominence of virtual representations 1012b-1012c. Further, visual indication 1026 is displayed below virtual representation 1012c from the current viewpoint of user 1042a on the surface visible in three-dimensional environment 1002a (e.g., as shown and described with reference to FIG. 10K). In FIG. 10Y, a current status of virtual element 1052 does not permit movement of virtual representation 1012c relative to the communication session (e.g., in some embodiments, movement of a respective virtual representation representing a user in the communication session is not permitted relative to the communication session). Accordingly, from the perspective of user 1042b viewing three-dimensional environment 1002b, virtual representation 1012c is not moved relative to three-dimensional environment 1002b in accordance with the input provided by user 1042a corresponding to the change in spatial arrangement of virtual representation 1012c in three-dimensional environment 1002a. In some embodiments, in accordance with a virtual object different from virtual representations 1012b-1012c that is shared in the communication session not being displayed in three-dimensional environment 1002a, first computer system 101a forgoes displaying virtual element 1052 in three-dimensional environment 1002a.

FIG. 10Z illustrates virtual element 1052 being displayed with a current status that permits movement of virtual object 1006a relative to the communication session. As shown in FIG. 10Z, a current status of virtual element 1052 is “ON” (e.g., in some embodiments, virtual element 1052 does not include text, and the virtual element 1052 is displayed with different colors based on the current status of virtual element 1052). Accordingly, an input corresponding to a request to change a spatial arrangement of virtual object 1006a in three-dimensional environment 1002a corresponds to movement of virtual object 1006a relative to the three-dimensional environment 1002a (e.g., from the current viewpoint of user 1042a) and relative to the communication session (e.g., corresponding to movement of virtual object 1006a in three-dimensional environment 1002b displayed by second computer system 101b and viewed from the perspective of user 1042b and/or movement of virtual object 1006a in a three-dimensional environment displayed by a third computer system in the communication session and viewed from the perspective of user 1042c). As shown in FIG. 10Z, user 1042a provides an input corresponding to a request to change the spatial arrangement of virtual object 1006a relative to three-dimensional environment 1002a. For example, the input includes gaze 1024 directed to virtual element 1018, and an air gesture (e.g., air pinch) is performed concurrently with vertical hand movement using hand 1008a.

FIG. 10AA illustrates movement of virtual object 1006a occurring relative to the communication session in response to the input provided by user 1042a in FIG. 10Z. As shown in FIG. 10AA, the movement of virtual object 1006a includes vertical movement in three-dimensional environment 1002a from the current viewpoint of user 1042a. In some embodiments, in accordance with the current status of virtual element 1052 not permitting movement of virtual object 1006a relative to the communication session, the first computer system 101a does not permit vertical movement of virtual object 1006a (e.g., which is shared in the communication session) in three-dimensional environment 1002a from the current viewpoint of user 1042a (e.g., since the current status of virtual element 1052 in FIG. 10Z permits movement of virtual object 1006a relative to three-dimensional environment 1002a, first computer system 101a permits vertical movement of virtual object 1006a in three-dimensional environment 1002a from the current viewpoint of user 1042a). As shown in FIG. 10AA, in accordance with the movement of virtual object 1006a being permitted relative to the communication session, first computer system 101a forgoes changing the visual appearance of three-dimensional environment 1002a and forgoes reducing the visual prominence of virtual representations 1042b-1042c. Further, as shown in FIG. 10AA, in accordance with the movement of virtual object 1006a being permitted relative to the communication session, first computer system 101a forgoes displaying boundary 1022 in three-dimensional environment 1002a. In FIG. 10AA, from the perspective of user 1042b viewing three-dimensional environment 1002b, virtual object 1006a is moved in the vertical direction in three-dimensional environment 1002b from the current viewpoint of user 1042b in accordance with the input provided by user 1042a in FIG. 10Z (e.g., from the perspective of user 1042c viewing a three-dimensional environment displayed by a third computer system in the communication session, virtual object 1006a is moved in the vertical direction in the three-dimensional environment in accordance with the input provided by user 1042a in FIG. 10Z).

FIG. 11 is a flowchart illustrating an exemplary method 1100 of reducing a visual prominence of one or more virtual representations while changing a spatial arrangement of a virtual object shared in a communication session. In some embodiments, the method 1100 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1100 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1100 are, optionally, combined and/or the order of some operations is, optionally, changed.

In some embodiments, method 1100 is performed at a first computer system in communication with a display generation component and one or more input devices. In some embodiments, the first computer system has one or more of the characteristics of the computer system(s) described with reference to methods 800, 900 and/or 1200. In some embodiments, the input device(s) has one or more of the characteristics of the input device(s) described with reference to methods 800, 900 and/or 1200. In some embodiments, the display generation component has one or more of the characteristics of the display generation component described with reference to methods 800, 900 and/or 1200. In some embodiments, the second computer system has one or more characteristics of the first computer system (e.g., and is in communication with a display generation component and one or more input devices including one or more characteristics of the display generation component and the one or more input devices described with reference to the first computer system).

In some embodiments, while in a communication session with one or more computer systems other than the first computer system (1102a) (e.g., the one or more computer systems are in communication with one or more respective display generation components and one or more respective input devices), the first computer system displays (1102b), via the display generation component, a three-dimensional environment from a first viewpoint of a first user of the first computer system, wherein the three-dimensional environment includes one or more virtual objects including one or more virtual representations of one or more users of the one or more computer systems, such as three-dimensional environment 1002a displayed by first computer system 101a in FIGS. 10A and 10A1. In some embodiments, the three-dimensional environment has one or more characteristics of three-dimensional and/or virtual environments described with reference to method 800, 900 and/or 1200. In some embodiments, the communication session has one or more characteristics of the communication described with reference to method 800, 900 and/or 1200. In some embodiments, the one or more virtual objects are associated with media (e.g., from one or more respective applications) that include audio and/or video content (e.g., such as from a movie and/or television show from a streaming service application, and/or an online video from a video sharing service or social media application), images and/or text (e.g., from a web browsing application), or interactive content (e.g., such as from video and/or virtual game media). In some embodiments, the one or more virtual objects are visible to the one or more users of the one or more computer systems from one or more viewpoints of the one or more users relative to the three-dimensional environment (e.g., the one or more computer systems display the one or more virtual objects in their three-dimensional environments from their corresponding viewpoints). In some embodiments, the one or more virtual representations include one or more characteristics of a virtual representation of the first type and/or a virtual representation of the second type as described with reference to method 900. In some embodiments, prior to receiving an input corresponding to a request to change a spatial arrangement of a virtual object of the one or more virtual objects in the three-dimensional environment (e.g., as described below with reference to the first virtual object), the one or more virtual representations are displayed in the three-dimensional environment as one or more virtual representations of the second type (e.g., the one or more virtual representations are avatars (e.g., optionally created by the one or more users, and/or optionally including one or more visual characteristics of people (e.g., corresponding to one or more physical characteristics of the one or more users) and/or animals). In some embodiments, the one or more computer systems display a virtual representation of the first user in the three-dimensional environment from one or more viewpoints of the one or more users (e.g., the virtual representation of the first user is visible to the one or more users of the one or more computer systems and is optionally not visible from the first viewpoint of the first user).

In some embodiments, while displaying the three-dimensional environment from the first viewpoint of the first user, the first computer system receives (1102c), via the one or more input devices, a first input corresponding to a request to change a spatial arrangement of a first virtual object of the one or more virtual objects from a first spatial arrangement relative to the first viewpoint of the first user to a second spatial arrangement relative to the first viewpoint of the first user in the three-dimensional environment, such as the input received by first user 1042a to change the spatial arrangement of virtual object 1006a in FIGS. 10A and 10A1. In some embodiments, the first input corresponds to a request to move the first virtual object from a first location in the three-dimensional environment to a second location, different from the first location, in the three-dimensional environment relative to the first viewpoint of the first user. For example, moving the first virtual object from the first location to the second location in the three-dimensional environment includes changing the distance of the first virtual object relative to the first viewpoint of the user (e.g., the second spatial arrangement includes a different depth from the first viewpoint of the first user compared to the first spatial arrangement). For example, moving the first virtual object from the first location to the second location in the three-dimensional environment includes moving the first virtual object laterally relative to the first viewpoint of the first user (e.g., the second spatial arrangement includes a different lateral position (e.g., more leftward or rightward relative to the first viewpoint of the first user compared to the first spatial arrangement) such that the viewing angle of the first user to the first virtual content in the three-dimensional environment changes compared to the first spatial arrangement). In some embodiments, changing the spatial arrangement of the first virtual object includes changing the orientation of the first virtual object relative to the first viewpoint of the first user in the three-dimensional environment (e.g., relative to polar or spherical coordinates relative to a reference location in the three-dimensional environment (e.g., the reference location corresponding to a location of the first viewpoint of the first user in the three-dimensional environment)). In some embodiments, the first input includes attention of the first user directed to the first virtual object (e.g., or optionally toward an affordance associated with the first virtual object) in the three-dimensional environment (e.g., the first user directs gaze toward the first virtual object (e.g., optionally for a threshold period of time (e.g., 0.1, 0.2, 0.5, 1, 2, 5 or 10 seconds))). In some embodiments, the first input includes the first user performing a hand air gesture while attention of the first user is concurrently directed to the first virtual object (e.g., an air tap, air pinch, air drag and/or air long pinch (e.g., optionally over a threshold period of time (e.g., 0.1, 0.5, 1, 2, 5 or 10 seconds)). The user optionally performs hand movement while concurrently performing the above-described hand air gesture (e.g., moving their hand while in an air pinch hand shape in a direction relative to the three-dimensional environment (e.g., toward a location in the three-dimensional environment) to which the first user desires to move the first virtual object in the three-dimensional environment). In some embodiments, the first input includes the first user directing the first input (e.g., through attention directed to the first virtual object and/or the hand air gesture and/or movement described above) toward a location and/or object in the three-dimensional environment different from the first virtual object or the location of the first virtual object in the three-dimensional environment (e.g., at a virtual representation of the one or more virtual representation, and/or at a virtual object different from the first virtual object displayed in the three-dimensional environment). In some embodiments, the change in the spatial arrangement of the first virtual object relative to the first viewpoint of the first user (e.g., the distance and/or direction of the movement) is a result of movement of the first virtual object in the three-dimensional environment corresponding to the performed hand movement (e.g., the distance and/or direction of the hand movement) relative to the three-dimensional environment. In some embodiments, the first input corresponds to a touch input on a touch-sensitive surface in communication with the first computer system (e.g., a trackpad or a touch screen). In some embodiments, the first input corresponds to an input provided through a keyboard and/or mouse in communication with the first computer system. In some embodiments, the first input corresponds to an audio input (e.g., a verbal command) provided by the first user. In some embodiments, the request to change the spatial arrangement of the first virtual object relative to the first viewpoint of the first user does not include a request to change the spatial arrangement of the first virtual object relative to one or more viewpoints of the one or more users.

In some embodiments, while (optionally in response to) receiving the first input (1102d), the first computer system reduces (1102e) a visual prominence of the one or more virtual representations of the one or more users relative to the three-dimensional environment, such as shown by changing the display of virtual representations 1012b and 1012c to virtual representations 1014b and 1014c in FIG. 10D. In some embodiments, reducing the visual prominence of the one or more virtual representations of the one or more users relative to the three-dimensional environment includes reducing the opacity, brightness, sharpness, and/or color saturation of the one or more virtual representations. For example, prior to receiving the first input, the one or more virtual representations are displayed with 100 percent (e.g., or greater than a threshold percentage, such as greater than 75, 80, 85, 90, or 95 percent) opacity, brightness, sharpness and/or color saturation, and while receiving the first input, the one or more virtual representation are displayed with less than 100 percent (e.g., or less than the threshold percentage) opacity, brightness, sharpness and/or color saturation. In some embodiments, reducing the visual prominence of the one or more virtual representations includes changing the size and/or shape of the one or more virtual representations of the one or more users (e.g., changing the one or more virtual representations from one or more virtual representations of a second type (e.g., as described with reference to method 900) to one or more virtual representations of the first type (e.g., as described with reference to method 900)). In some embodiments, while receiving the first input, the first computer system reduces the visual prominence of the three-dimensional environment relative to the first viewpoint of the user (e.g., the three-dimensional environment is displayed with reduced color saturation and/or brightness while changing the spatial arrangement of the first virtual object in the three-dimensional environment). In some embodiments, the one or more computer systems do not reduce the visual prominence of one or more virtual representations (e.g., including a virtual representation of the first user) relative to the three-dimensional environment (e.g., from one or more viewpoints of the one or more users) in response to the first input received by the first computer system. In some embodiments, after receiving the first input (e.g., after the user ceases performing hand movement and/or the hand air gesture (e.g., when the user ceases performing the hand air pinch pose with their hand)), the one or more virtual representations are displayed by the first computer system with the visual prominence displayed prior to receiving the first input (e.g., 100 percent (e.g., or greater than the threshold percentage) of opacity, brightness, sharpness and/or color saturation).

In some embodiments, the first computer system changes (1102f) the spatial arrangement of the first virtual object relative to the first viewpoint of the first user in accordance with the first input while the one or more virtual representations of the one or more users have the reduced visual prominence relative to the three-dimensional environment, such as shown by the change in spatial arrangement of virtual object 1006a in three-dimensional environment 1002a while displaying virtual representation 1014b and virtual representation 1014c. In some embodiments, the one or more computer systems do not change the spatial arrangement of the first virtual object relative to one or more viewpoints of the one or more users in response to the first input. In some embodiments, the one or more computer systems change the spatial arrangement of a virtual representation of the first user in the three-dimensional environment (e.g., from one or more viewpoints of the one or more users) in response to the first computer system changing the spatial arrangement of the first virtual object relative to the first viewpoint of the first user. For example, movement of the virtual representation of the first user in the three-dimensional environment (e.g., a change in spatial arrangement of the virtual representation of the first user) from the one or more viewpoints of the one or more users is based on the movement of the first virtual object (e.g., the change in spatial arrangement of the first virtual object) relative to the first viewpoint of the first user. In some embodiments, the one or more computer systems maintain the location and/or orientation of the first virtual object relative to the three-dimensional environment while the first computer system changes the spatial arrangement of the first virtual object relative to the first viewpoint of the first user in response to the first input. In some embodiments, changing the spatial arrangement of the first virtual object while receiving the first input includes moving the first virtual object based on the hand movement of the first user described above (e.g., the first virtual object is moved in the three-dimensional environment with a magnitude, direction, path, and/or velocity of movement that is based on the hand movement magnitude, direction, path, and/or velocity associated with the first input). In some embodiments, changing the spatial arrangement of the first virtual object relative to the first viewpoint of the first user includes changing the spatial arrangement of the one or more virtual objects different from the first virtual object (e.g., if the one or more virtual objects different from the first virtual object are shared with the one or more computer systems in the communication session) and/or the one or more virtual representations of the one or more users relative to the first viewpoint of the first user (e.g., by the same magnitude, direction, path, and/or velocity as the movement of the first virtual object relative to the first viewpoint). For example, while receiving the first input, the first computer system changes the spatial arrangement of the one or more virtual objects different from the first virtual objects and/or one or more virtual representations (e.g., while displaying the one or more virtual representations with the reduced visual prominence) concurrently with the spatial arrangement of the first virtual object relative to the first viewpoint of the first user. In some embodiments, after receiving the first input (e.g., after the user completes the hand movement and/or ceases performing the hand air gesture (e.g., when the user ceases performing the hand pinch pose with their hand)), the first computer system ceases to change the spatial arrangement of the first virtual object (e.g., and optionally the one or more virtual objects different from the first virtual object and/or one or more virtual representations) relative to the first viewpoint of the first user (e.g., the first computer system ceases to move the first virtual object and/or the one or more virtual representations in the three-dimensional environment). Reducing the visual prominence of one or more virtual representations in a three-dimensional environment while changing the spatial arrangement of content relative to the viewpoint of a user reduces the amount of prominent motion that is displayed in the three-dimensional environment during the change in spatial arrangement of the content, provides visual feedback to the user that the change in spatial arrangement is occurring in the three-dimensional environment, and reduces spatial conflicts displayed between the one or more virtual representations and other virtual objects displayed in the three-dimensional environment during the change in the spatial arrangement of the content, thereby minimizing the risk of motion sickness to the user, reducing errors in interaction and improving user device interaction.

In some embodiments, the first virtual object is shared content that is shared with the one or more computer systems in the communication session, such as shown by virtual object 1006a being displayed in three-dimensional environment 1002a and three-dimensional environment 1002b in FIGS. 10A and 10A1. In some embodiments, sharing the content with the one or more computer systems in the communication session corresponds to the content being visible in the three-dimensional environment to the one or more users of the one or more computer systems (e.g., from one or more viewpoints of the one or more users). In some embodiments, the content is associated with media, including one or more characteristics of the media associated with the one or more virtual objects as described with reference to step(s) 1102. In some embodiments, the first computer system displays one or more non-shared virtual objects in the three-dimensional environment concurrently with the first virtual object from the first viewpoint of the first user (e.g., the one or more non-shared virtual objects are one or more virtual objects including one or more characteristics of the one or more shared virtual objects that are visible to the first user and not visible to the one or more other users of the one or more computer systems (e.g., are not displayed by the one or more computer systems in one or more three-dimensional environments displayed by the one or more computer systems). Reducing the visual prominence of one or more virtual representations in a three-dimensional environment while changing the spatial arrangement relative to the viewpoint of a user of content shared with one or more computer systems in a communication session reduces the amount of prominent motion that is displayed in the three-dimensional environment during the change in spatial arrangement of the content, provides visual feedback to the user that the change in spatial arrangement is occurring in the three-dimensional environment, and reduces spatial conflicts displayed between the one or more virtual representations and other virtual objects (e.g., shared in the communication session) displayed in the three-dimensional environment during the change in the spatial arrangement of the content, thereby minimizing the risk of motion sickness to the user, reducing errors in interaction and improving user device interaction.

In some embodiments, the first virtual object is a virtual representation of a user of the one or more users, such as virtual representation 1012b shown in three-dimensional environment 1002a in FIG. 10K. In some embodiments, prior to receiving the first input, the virtual representation is a virtual representation of the second type as described with reference to method 900. In some embodiments, while receiving the first input, the computer system changes the display of the virtual representation from a virtual representation of a second type (e.g., including one or more characteristics of the virtual representation of the second type described with reference to method 900) to a virtual representation of a first type (e.g., including one or more characteristics of a virtual representation of the first type as described with reference to method 900). Reducing the visual prominence of one or more virtual representations in a three-dimensional environment while changing the spatial arrangement of a virtual representation of the one or more virtual representations relative to the viewpoint of a user reduces the amount of prominent motion that is displayed in the three-dimensional environment during the change in spatial arrangement of the content, provides visual feedback to the user that the change in spatial arrangement is occurring in the three-dimensional environment, and reduces spatial conflicts displayed between the one or more virtual representations and other virtual objects displayed in the three-dimensional environment during the change in the spatial arrangement of the content, thereby minimizing the risk of motion sickness to the user, reducing errors in interaction and improving user device interaction.

In some embodiments, the one or more virtual objects include a plurality of virtual objects that have a shared spatial arrangement (e.g., orientation and/or position) relative to each other, such as the shared spatial arrangement of virtual representations 1014b and 1014c and virtual object 1006a in three-dimensional environment 1002a shown in FIG. 10D. In some embodiments, while receiving the first input, the first computer system maintains the shared spatial arrangement of the plurality of virtual objects relative to each other while changing the spatial arrangement of the first virtual object relative to the first viewpoint of the first user from the first spatial arrangement relative to the first viewpoint of the first user to the second spatial arrangement relative to the first viewpoint of the first user, such as maintaining the shared spatial arrangement of virtual representation 1014b and 1014c and virtual object 1006a while changing the spatial arrangement of virtual object 1006a in FIGS. 10D-10F. In some embodiments, the shared spatial arrangement includes a plurality of distances of the plurality of virtual objects relative to each other in the three-dimensional environment (e.g., from the first viewpoint of the first user). In some embodiments, the shared spatial arrangement includes a plurality of orientations of the plurality of virtual objects relative to each other in the three-dimensional environment (e.g., from the first viewpoint of the first user). In some embodiments, the plurality of virtual objects is a portion of the one or more virtual objects displayed in the three-dimensional environment that are shared with the one or more computer systems in the communication session (e.g., including one or more characteristics of shared content as described above). In some embodiments, the plurality of virtual objects includes the one or more virtual representations of the one or more users of the one or more computer systems included in the three-dimensional environment. In some embodiments, the plurality of virtual objects include one or more virtual objects shared with the one or more computer systems in the communication session and one or more virtual objects not shared with the one or more computer systems (e.g., the one or more virtual objects that are not shared with the one or more computer systems are visible in the three-dimensional environment from the first viewpoint of the first user but not from the one or more viewpoints of the one or more users of the one or more computer systems). The plurality of virtual objects optionally has the shared spatial arrangement in the three-dimensional environment from one or more viewpoints of the one or more users of the one or more computer systems. The plurality of virtual objects optionally does not have the shared spatial arrangement in the three-dimensional environment from one or more viewpoints of the one or more users of the one or more computer systems. Changing the spatial arrangement of content relative to a viewpoint of a user while maintaining a shared spatial arrangement of the content with one or more virtual object displayed in a three-dimensional environment reduces spatial conflicts displayed between the one or more virtual objects and while changing the spatial arrangement of the content, thereby reducing errors in interaction and improving user device interaction.

In some embodiments, in a view of the communication session from a perspective of a second user of the one or more users, while the first input is being received by the first computer system, a spatial arrangement of a virtual representation of the first user of the first computer system relative to a second three-dimensional environment is changing in accordance with the changing spatial arrangement of the first virtual object relative to the first viewpoint of the first user, such as shown by the change in spatial arrangement of virtual representation 1014a in three-dimensional environment 1002b in FIGS. 10D-10F. In some embodiments, the second three-dimensional environment is displayed by and/or visible via a second computer system of the one or more computer systems in the communication session with the first computer system. In some embodiments the second three-dimensional environment has one or more characteristics of the three-dimensional environment (e.g., the second three-dimensional environment is the three-dimensional environment displayed from a current viewpoint of the second user by the second computer system). In some embodiments, the second computer system receives information (e.g., through one or more indications having one or more characteristics of the indication described with reference to methods 800 and/or 900) corresponding to the change in the spatial arrangement of the first virtual object relative to the first viewpoint of the first user. In some embodiments, the spatial arrangement of the virtual representation of the first user is changed based on the information received from the first computer system. In some embodiments, the spatial arrangement of a virtual representation of the first user changes in the one or more three-dimensional environments displayed by the one or more computer systems in the communication session with the first computer system. In some embodiments, changing the spatial arrangement of the virtual representation of the first user in the second three-dimensional environment does not include changing the spatial arrangement of one or more virtual objects (e.g., including shared content) displayed in the second three-dimensional environment different from the virtual representation of the first user. For example, in accordance with the first computer system changing the spatial arrangement of the first virtual object (e.g., the first virtual object is shared content, and/or one or more virtual objects that are shared content are moved in the three-dimensional environment concurrently with the first virtual object) to be a greater distance from the first viewpoint of the first user in the three-dimensional environment, the second computer system changes the spatial arrangement of the virtual representation of the first user to be a greater distance from a second viewpoint of the second user relative to the second three-dimensional environment. In some embodiments, the virtual representation of the first user has one or more characteristics of the one or more virtual representations of the one or more users described with reference to step(s) 1102. In some embodiments, the virtual representation of the first user is a virtual representation of a first type (e.g., as described with reference to method 900). In some embodiments, the virtual representation of the first user is a virtual representation of a second type (e.g., as described with reference to method 900). Changing the spatial arrangement of the virtual representation of the first user optionally includes changing the virtual representation of the first user from a virtual representation of the second type to a virtual representation of the first type while concurrently moving the virtual representation of the first user relative to the second three-dimensional environment. In some embodiments, changing the spatial arrangement of the virtual representation of the first user includes displaying the virtual representation of the first user with the first representation of movement as described with reference to method 900. Changing a spatial arrangement of a virtual representation of a respective user of a respective computer system in a three-dimensional environment displayed by a computer system in communication with the respective computer system in accordance with the respective user changing a spatial arrangement of content shared in the communication session provides visual feedback to a user of the computer system that the change in spatial arrangement of the content is occurring relative to the perspective of the respective user, thereby reducing errors in interaction during the communication session and improving user device interaction.

In some embodiments, the first virtual object is a virtual representation of a user of the one or more users, such as virtual representation 1012b displayed in three-dimensional environment 1002a in FIG. 10K. In some embodiments, after (e.g., in response to) receiving the first input, in accordance with a determination that the virtual representation of the user has a spatial arrangement relative to the first viewpoint of the first user that exceeds a spatial arrangement threshold, the first computer system displays the virtual representation of the user with a visual prominence greater than the reduced visual prominence relative to the three-dimensional environment, such as the visual prominence of virtual representation 1012b shown in FIG. 10P after first user 1042a ceases to provide the input shown in FIGS. 10K-100. In some embodiments, the spatial arrangement threshold corresponds to a distance (e.g., 0.5, 0.1, 0.2, 0.5, 1, 2, or 5 m) of the first virtual object from the first viewpoint of the first user in the three-dimensional environment. In some embodiments, displaying the virtual representation of the virtual representation of the user with the visual prominence greater than the reduced visual prominence relative to the three-dimensional environment includes displaying the virtual representation of the user with a visual prominence that the virtual representation of the user is displayed with prior to receiving the first input. In some embodiments, displaying the virtual representation of the user with the visual prominence greater than the reduced visual prominence relative to the three-dimensional environment includes changing the display of the virtual representation of the user from a virtual representation of the first type (e.g., as described with reference to method 900) to a virtual representation of the second type (e.g., as described with reference to method 900). In some embodiments, displaying the virtual representation of the user with the visual prominence greater than the reduced visual prominence includes redisplaying the virtual representation of the user in the three-dimensional environment (e.g., after ceasing to display the virtual representation of the user in the three-dimensional environment while receiving the first input). In some embodiments, displaying the virtual representation of the user with the visual prominence greater than the reduced visual prominence includes displaying the virtual representation of the user with greater opacity, brightness, and/or color relative to the three-dimensional environment.

In some embodiments, in accordance with a determination that the virtual representation of the user has a spatial arrangement relative to the first viewpoint of the first user that does not exceed the spatial arrangement threshold, the first computer system displays the visual representation of the user with the reduced visual prominence relative to the three-dimensional environment (e.g., first computer system 101a changes the display of virtual representation 1012c (e.g., shown in FIG. 10P) to virtual representation 1014c in accordance with the spatial arrangement of virtual representation 1012c not exceeding the spatial arrangement threshold). In some embodiments, displaying the virtual representation of the user with the reduced prominence relative to the three-dimensional environment includes maintaining the visual prominence of the virtual representation of the user displayed while receiving the first input (e.g., the virtual representation of the user is displayed with the reduced visual prominence while receiving the first input (e.g., while changing the spatial arrangement of the first virtual object in accordance with the first input)). In some embodiments, in accordance with a determination that the first virtual object is a virtual object of the one or more virtual objects different from the one or more virtual representations of the one or more users, the first virtual object is displayed the visual prominence greater than the reduced visual prominence relative to the three-dimensional environment independent of the spatial arrangement threshold (e.g., the first virtual object is displayed with the visual prominence greater than the reduced visual prominence when the spatial arrangement of the virtual representation of the user relative to the first viewpoint of the first user exceeds the spatial arrangement threshold and when the spatial arrangement of the virtual representation of the user relative to the first viewpoint of the first user does not exceed the spatial arrangement threshold). Reducing the visual prominence of a visual representation in a three-dimensional environment in accordance with the visual representation not exceeding a spatial arrangement threshold (e.g., relative to a viewpoint of a user viewing the three-dimensional environment) reduces spatial conflicts displayed between the virtual representation and one or more virtual objects displayed in the three-dimensional environment different from the virtual representation, thereby reducing errors in interaction and improving user device interaction.

In some embodiments, in a view of the communication session from a perspective of a second user of the one or more users, while the first input is being received by the first computer system, a visual prominence of a virtual representation of the first user of the first computer system is reduced relative to a second three-dimensional environment (e.g., visible via a second computer system associated with the second user), such as shown by the reduction of prominence of virtual representation 1012a in three-dimensional environment 1002b shown in FIG. 10W. In some embodiments, the second three-dimensional environment has one or more characteristics of the second three-dimensional environment described above. In some embodiments, reducing the visual prominence of the virtual representation of the first user of the first computer system relative to the second three-dimensional environment includes one or more characteristics of reducing the visual prominence of the first virtual object relative to the three-dimensional environment while receiving the first input as described with reference to step(s) 1102. In some embodiments, reducing the visual prominence of the virtual representation of the first user includes increasing the transparency of the virtual representation of the first user, ceasing to display the virtual representation of the first user, or changing the display of the virtual representation of the first user from a virtual representation of the second type (e.g., as described with reference to method 900) to a virtual representation of the first type (e.g., as described with reference to method 900). In some embodiments, reducing the visual prominence of the virtual representation of the first user of the first computer system relative to the second three-dimensional environment includes one or more characteristics of reducing the visual prominence of the one or more virtual representations of the one or more users relative to the three-dimensional environment as described below. Reducing the visual prominence in a three-dimensional environment displayed by a computer system of a virtual representation of a respective user of a respective computer system in communication with the computer system in accordance with the respective user changing a spatial arrangement of content shared in the communication session relative to the respective user's viewpoint provides visual feedback to a user of the computer system that the change in spatial arrangement of the content is occurring and provides minimal distraction from the three-dimensional environment and/or the communication session, thereby reducing consumption of computing resources, reducing errors in interaction and improving user device interaction.

In some embodiments, reducing the visual prominence of the one or more virtual representations of the one or more users relative to the three-dimensional environment includes increasing a transparency of the one or more virtual representations of the one or more users relative to the three-dimensional environment, such as shown by the increase of transparency of virtual representation 1012b and 1012c in three-dimensional environment 1002a in FIG. 10B. In some embodiments, the transparency of the one or more virtual representations of the one or more users relative to the three-dimensional environment is increased by 5, 10, 20, 30, 40, 50, 60, 70, 80, 90 or 100 percent from the transparency of the one or more virtual representations displayed prior to receiving the first input. In some embodiments, prior to receiving the first input, the one or more virtual representations of the one or more users are displayed with 100 percent opacity (e.g., or 80, 85, 90 or 85 percent opacity). In some embodiments, the first computer system gradually increases the transparency of the one or more virtual representation of the one or more users (e.g., the transparency is increased from the transparency displayed prior to receiving the first input over 0.1, 0.5, 1, 2, 5 or 10 seconds). In some embodiments, the virtual representations of the one or more users are displayed with the increased transparency in the three-dimensional environment once the change in spatial arrangement of the first virtual object is initiated (e.g., not gradually). In some embodiments, reducing the visual prominence of the one or more virtual representations of the one or more users relative to the three-dimensional environment includes reducing the color and/or brightness of the one or more virtual representations of the one or more users relative to the three-dimensional environment (e.g., optionally while increasing the transparency of the one or more virtual representations of the one or more users relative to the three-dimensional environment). Increasing transparency of one or more virtual representations in a three-dimensional environment while changing the spatial arrangement of content relative to the viewpoint of a user reduces the amount of prominent motion that is displayed in the three-dimensional environment during the change in spatial arrangement of the content, provides visual feedback to the user that the change in spatial arrangement is occurring in the three-dimensional environment, and reduces spatial conflicts displayed between the one or more virtual representations and other virtual objects displayed in the three-dimensional environment during the change in the spatial arrangement of the content, thereby minimizing the risk of motion sickness to the user, reducing errors in interaction and improving user device interaction

In some embodiments, reducing the visual prominence of the one or more virtual representations of the one or more users relative to the three-dimensional environment includes ceasing to display the one or more virtual representations of the one or more users in the three-dimensional environment, such as shown by first computer system 101a ceasing display of virtual representations 1012b and 1012c in FIG. 10C. In some embodiments, ceasing to display the one or more virtual representations of the one or more users in the three-dimensional environment includes gradually ceasing to display the one or more virtual representations of the one or more users in the three-dimensional environment. For example, the computer system gradually (e.g., over a period of time (e.g., 0.1, 0.5, 1, 2, 5, or 10 seconds)) increases the transparency (e.g., including one or more characteristics of increasing the transparency of the one or more virtual representations of the one or more users relative to the three-dimensional environment as described above) of the one or more virtual representations until the one or more virtual representations of the one or more users cease to be displayed in the three-dimensional environment from the first viewpoint of the first user. In some embodiments, the virtual representations of the one or more users cease to be displayed in the three-dimensional environment once the change in spatial arrangement of the first virtual object is initiated (e.g., not gradually). Ceasing to display one or more virtual representations in a three-dimensional environment while changing the spatial arrangement of content relative to the viewpoint of a user reduces the amount of prominent motion that is displayed in the three-dimensional environment during the change in spatial arrangement of the content, provides visual feedback to the user that the change in spatial arrangement is occurring in the three-dimensional environment, and reduces spatial conflicts displayed between the one or more virtual representations and other virtual objects displayed in the three-dimensional environment during the change in the spatial arrangement of the content, thereby minimizing the risk of motion sickness to the user, reducing errors in interaction and improving user device interaction

In some embodiments, reducing the visual prominence of the one or more virtual representations of the one or more users relative to the three-dimensional environment includes changing the display of the one or more virtual representations of the one or more users from one or more virtual representations of a first type to one or more virtual representations of a second type, such as shown by the display of virtual representations 1014b and 1014c in FIG. 10D. In some embodiments, the one or more virtual representations of the first type include one or more characteristics of a virtual representation of the second type described with reference to method 900. For example, the one or more virtual representations of the first type correspond to one or more avatars of the one or more users displayed in the three-dimensional environment (e.g., including one or more characteristics of avatars described with reference to method 900). In some embodiments, the one or more virtual representations of the second type include one or more characteristics of a virtual representation of the first type described with reference to method 900. For example, the one or more virtual representations of the second type are one or more virtual representations of a three-dimensional shape (e.g., a coin). In some embodiments, the one or more virtual representations of the second type include one or more characteristics of the first virtual object described with reference to method 800. In some embodiments, changing the spatial arrangement of the first virtual object relative to the first viewpoint of the first user includes changing the spatial arrangement of the one or more virtual representations relative to the first viewpoint of the first user in accordance with the first input (e.g., while receiving the first input, the one or more virtual representations are moved relative to the first viewpoint of the first user, and the movement of the one or more virtual representations corresponds to movement of the first virtual object relative to the three-dimensional environment in accordance with the first input). Changing the type of one or more virtual representations displayed in a three-dimensional environment while changing the spatial arrangement of content relative to the viewpoint of a user reduces the amount of prominent motion that is displayed in the three-dimensional environment during the change in spatial arrangement of the content (e.g., by displaying a type of virtual representation that represents less motion in the three-dimensional environment) and provides visual feedback to the user that the change in spatial arrangement is occurring in the three-dimensional environment, thereby minimizing the risk of motion sickness to the user, reducing errors in interaction and improving user device interaction.

In some embodiments, reducing the visual prominence of the one or more virtual representations of the one or more users relative to the three-dimensional environment includes reducing the visual prominence of a plurality of virtual representations of a plurality of users relative to the three-dimensional environment, such as shown by the reduction in prominence of virtual representation 1012b-1012d in three-dimensional environment 1002a in FIG. 10W. In some embodiments, reducing the visual prominence of the plurality of virtual representations of the plurality of users relative to the three-dimensional environment includes one or more characteristics of reducing the visual prominence of the one or more virtual representations of the one or more users as described above (e.g., increasing transparency, ceasing display, and/or changing the display of the plurality of virtual representations of the plurality of users). Reducing the visual prominence of a plurality of virtual representations in a three-dimensional environment while changing the spatial arrangement of content relative to the viewpoint of a user reduces the amount of prominent motion that is displayed in the three-dimensional environment during the change in spatial arrangement of the content, provides visual feedback to the user that the change in spatial arrangement is occurring in the three-dimensional environment, and reduces spatial conflicts displayed between the plurality of virtual representations and other virtual objects displayed in the three-dimensional environment during the change in the spatial arrangement of the content, thereby minimizing the risk of motion sickness to the user, reducing errors in interaction and improving user device interaction.

In some embodiments, the first computer system detects termination of the first input (e.g., after reducing a visual prominence of the one or more virtual representations of the one or more users relative to the three-dimensional environment and/or after changing the spatial arrangement of the first virtual object relative to the first viewpoint of the first user in accordance with the first input), such as the termination of the input provided by first user 1042a corresponding to the request to change the spatial arrangement of virtual object 1006a shown in FIG. 10G. In some embodiments, in response to detecting the termination of the first input, the first computer system increases the visual prominence of the one or more virtual representations of the one or more users to an amount of visual prominence that is greater than the reduced visual prominence, such as the visual prominence of virtual representation 1012b shown in FIG. 10H. In some embodiments, the amount of visual prominence that is greater than the reduced visual prominence corresponds to a visual prominence of the one or more virtual representations of the one or more users relative to the three-dimensional environment displayed prior to receiving the first input. In some embodiments, increasing the visual prominence of the one or more virtual representations includes decreasing the transparency of the one or more virtual representations of the one or more users (e.g., increasing the opacity of the one or more virtual representations of the one or more users). In some embodiments, increasing the visual prominence of the one or more virtual representation includes redisplaying the one or more virtual representations of the one or more users in the three-dimensional environment (e.g., the one or more virtual representations are redisplayed at a different location in the three-dimensional environment in accordance with the first input). In some embodiments, increasing the visual prominence of the one or more virtual representations of the one or more users includes changing the one or more virtual representations of the one or more users from one or more virtual representations of a second type (e.g., including one or more characteristics of a virtual representation of a first type as described with reference to method 900 and/or the first virtual object described with reference to method 800) to one or more virtual representations of the first type (e.g., including one or more characteristics of a virtual representation of a second type as described with reference to method 900). Increasing the visual prominence of one or more virtual representations in a three-dimensional environment after reducing the visual prominence of the one or more virtual representations in the three-dimensional environment while changing the spatial arrangement of content relative to the viewpoint of a user provides different visual feedback to the user when the change in spatial arrangement is occurring and when the change in spatial arrangement is terminated in the three-dimensional environment, thereby reducing errors in interaction and improving user device interaction.

In some embodiments, in response to detecting termination of the first input, the first computer system increases the visual prominence of a plurality of virtual representations of a plurality of users to an amount of visual prominence that is greater than the reduced visual prominence, such as the visual prominence of virtual representations 1012b-1012c shown in FIG. 10H. In some embodiments, detecting termination of the first input corresponds to the first computer system ceasing to receive the first input (e.g., the first user of the first computer system ceases providing the first input to the first computer system). In some embodiments, the first user ceases to provide an air gesture (e.g., including one or more characteristics of the air gesture described with reference to step(s) 1102 and/or one or more characteristics of the first air gesture or the second air gesture described below). For example, the air gesture includes an air pinch (e.g., contact of a thumb of a hand of the first user and a finger of the hand of the first user (e.g., optionally for a threshold period of time (e.g., 0.1, 0.5, 1, 2, 5 or 10 seconds))), and detecting the termination of the first input corresponds to detecting that the first user ceases performing the air pinch (e.g., the thumb and the finger cease contact). For example, the air gesture includes performing an air pinch while currently moving a hand (e.g., the hand performing the air pinch or a second hand of the first user) relative to the three-dimensional environment, and detecting termination of the first input includes detecting that the first user ceases the movement of the hand relative to the three-dimensional environment. In some embodiments, increasing the visual prominence of the plurality of virtual representations of the plurality of users includes one or more characteristics of increasing the visual prominence of the one or more virtual representations of the one or more users as described above. In some embodiments, the amount of visual prominence that is greater than the reduced visual prominence has one or more characteristics of the amount of visual prominence that is greater than the reduced visual prominence as described above. Increasing the visual prominence of a plurality of virtual representations in a three-dimensional environment after reducing the visual prominence of the plurality of virtual representations in the three-dimensional environment while changing the spatial arrangement of content relative to the viewpoint of a user provides different visual feedback to the user when the change in spatial arrangement is occurring and when the change in spatial arrangement is terminated in the three-dimensional environment, thereby reducing errors in interaction and improving user device interaction.

In some embodiments, the first virtual object is shared content (e.g., including one or more characteristics of the shared content described above) that is shared with the one or more computer systems in the communication session, such as shown by virtual object 1006a being displayed in three-dimensional environment 1002a and three-dimensional environment 1002b in FIGS. 10A and 10A1. In some embodiments, after receiving the first input, the first computer system receives a second input corresponding to a request to change a spatial arrangement of a second virtual object of the one or more virtual objects from a third spatial arrangement relative to the first viewpoint of the first user to a fourth spatial arrangement relative to the first viewpoint of the first user, such as the input provided by first user 1042a in FIG. 10H corresponding to a request to change the spatial arrangement of virtual object 1004 in three-dimensional environment 1002a. In some embodiments, the second virtual object of the one or more virtual objects has one or more characteristics of the first virtual object of the one or more virtual objects as described above. In some embodiments, the second virtual object has one or more characteristics of the first virtual object described with reference to method 1200. In some embodiments, the third spatial arrangement relative to the first viewpoint of the first user and the fourth spatial arrangement relative to the first viewpoint of the first user have one or more characteristics of the first spatial arrangement relative to the first viewpoint of the first user and the second spatial arrangement relative to the first viewpoint of the first user as described above. In some embodiments, the third spatial arrangement and fourth spatial arrangement correspond to different distances and/or orientations relative to the first viewpoint of the first user compared to the first spatial arrangement and the second spatial arrangement. In some embodiments, the second input has one or more characteristics of the first input described above and/or below. In some embodiments, the second input has one or more characteristics of the first input corresponding to the request to move the first virtual object from the first location to the second location relative to the first viewpoint of the first user in the three-dimensional environment as described with reference to method 1200.

In some embodiments, while receiving the second input, in accordance with a determination that the second virtual object is not shared with the one or more computer systems in the communication session, the first computer system maintains the visual prominence of the one or more virtual representations of the one or more users relative to the three-dimensional environment, such as shown by first computer system 101a maintaining the visual prominence of virtual object 1004 in FIGS. 10H-10J. In some embodiments, the second virtual object has one or more characteristics of the one or more non-shared virtual objects displayed in the three-dimensional environment described above. In some embodiments, maintaining the visual prominence of the one or more virtual representations of the one or more users relative to the three-dimensional environment includes maintaining a visual prominence of the one or more virtual representations of the one or more users relative to the three-dimensional environment displayed prior to receiving the second input. In some embodiments, the visual prominence has one or more characteristics of the amount visual prominence greater than the reduced visual prominence as described above.

In some embodiments, the first computer system changes the spatial arrangement of the second virtual object relative to the first viewpoint of the first user in accordance with the second input while the one or more virtual representations of the one or more users have the maintained visual prominence relative to the three-dimensional environment, such as shown by the visual prominence of virtual representations 1012b and 1012c while changing the spatial arrangement of virtual object 1004 in FIGS. 10H-10J. In some embodiments, while receiving the second input, the computer system displays visual feedback in the three-dimensional environment while changing the spatial arrangement of the second virtual object relative to the first viewpoint of the first user (e.g., including one or more characteristics of displaying second visual feedback in the three-dimensional environment while moving the first virtual object from the first location to the second location relative to the first viewpoint of the first user in the three-dimensional environment as described with reference to method 1200). In some embodiments, changing the spatial arrangement of the second virtual object while receiving the second input includes moving the first virtual object relative to the first viewpoint of the first user based on hand movement (e.g., the second virtual object is moved in the three-dimensional environment with a magnitude, direction, path and/or speed of movement that is based on the hand movement magnitude, direction, path and/or velocity associated with the second input). In some embodiments, changing the spatial arrangement of the second virtual object relative to the first viewpoint of the first user does not include changing the spatial arrangement of one or more virtual objects displayed in the three-dimensional environment different from the second virtual object and/or the one or more virtual representations of the one or more users relative to the first viewpoint of the first user in accordance with the second input (e.g., only the second virtual object changes spatial arrangement relative to the three-dimensional environment based on the second input). In some embodiments, in response to detecting termination of the second input (e.g., including one or more characteristics of detecting termination of the first input as described above), the first computer system ceases to change the spatial arrangement of the second virtual object relative to the first viewpoint of the first user. Reducing the visual prominence of one or more virtual representations in a three-dimensional environment while changing the spatial arrangement of shared content relative to the viewpoint of a user and maintaining the visual prominence of the one or more virtual representations in the three-dimensional environment while changing the spatial arrangement of non-shared content provides visual feedback that the change in spatial arrangement is occurring, visual feedback of whether the content is shared or not, and reduces the prominent motion that is displayed in the three-dimensional environment only when it is necessary (e.g., because the one or more virtual representations concurrently change spatial arrangement with shared content and not with non-shared content), thereby minimizing the risk of motion sickness to the user, reducing errors in interaction, and conserving computing resources.

In some embodiments, the first input includes an air gesture performed by the first user (e.g., by a first portion of the first user), such as the air gesture performed by hand 1008a shown in FIGS. 10A and 10A1. In some embodiments, the first portion of the first user is a hand of the first user. In some embodiments, the air gesture includes an air tap, air pinch, air drag, and/or air long pinch (e.g., an air pinch performed for at least a threshold period of time (e.g., 0.1, 0.5, 1, 2, 3, 5, or 10 seconds). In some embodiments, the air gesture includes performing an air pinch with the first portion of the first user and moving the first portion (e.g., performing an air drag) relative to the three-dimensional environment (e.g., in one or more directions and/or paths relative to the three-dimensional environment corresponding to a requested change in spatial arrangement of the first virtual object) while concurrently maintaining the air pinch shape. In some embodiments, the air gesture is performed by a first portion (e.g., a first hand) of the first user and a second portion (e.g., a second hand) of the first user. For example, the air gesture includes an air pinch performed by the first portion of the first user and hand movement relative to the three-dimensional environment performed by the second portion of the first user while maintaining the air pinch performed by the first portion of the first user. Reducing the visual prominence of one or more virtual representations in a three-dimensional environment and changing the spatial arrangement of content relative to the viewpoint of a user in response to a user input that includes an air gesture performed by the user ensures that the intent of the user is to change the spatial arrangement of the content prior to changing the spatial arrangement of the content and reducing the visual prominence of the one or more virtual representations, thereby reducing errors in interaction and improving user device interaction.

In some embodiments, the first input includes attention of the first user directed to a first location in the three-dimensional environment associated with the first virtual object, such as shown by gaze 1024 of first user 1042a directed to a region of three-dimensional environment 1002a below virtual object 1006b in FIG. 10Q. In some embodiments, attention of the first user directed to the first location in the three-dimensional environment corresponds to attention of the first user directed to the first virtual object. In some embodiments, attention of the first user directed to a first location in the three-dimensional environment corresponds to gaze of the first user directed to the first location in the three-dimensional environment. For example, the gaze is directed to the first location in the three-dimensional environment for at least a threshold period of time (e.g., 0.1, 0.5, 1, 2, 3, 5 or 10 seconds). In some embodiments, the first computer system determines that attention of the first user is directed to the first location in the three-dimensional environment based on an audio input (e.g., a verbal command) provided by the first user, touch-input (e.g., on a touch-sensitive surface of the first computer system) provided by the first user, and/or an input made through a keyboard and/or mouse in communication with the first computer system by the first user. Reducing the visual prominence of one or more virtual representations in a three-dimensional environment and changing the spatial arrangement of content relative to the viewpoint of a user in response to a user input that includes attention of a user directed to a location in the three-dimensional environment associated with the content ensures that the intent of the user is to change the spatial arrangement of the content prior to changing the spatial arrangement of the content and reducing the visual prominence of the one or more virtual representations, thereby reducing errors in interaction and improving user device interaction.

In some embodiments, the first location in the three-dimensional environment corresponds to a region of the three-dimensional environment, outside of the first virtual object, that has a predefined spatial relationship (e.g., orientation and/or position) relative to the first virtual object in the three-dimensional environment, such as the region of three-dimensional environment 1002a below virtual object 1006b that gaze 1024 is directed to in FIG. 10Q. In some embodiments, the region of the three-dimensional environment is a region of the three-dimensional environment adjacent to the first virtual object. In some embodiments, the region of the three-dimensional environment is a region of the three-dimensional environment below the first virtual object in the three-dimensional environment from the first viewpoint of the first user. In some embodiments, the region of the three-dimensional environment is a region of the three-dimensional environment above the first virtual object in the three-dimensional environment from the first viewpoint of the first user. In some embodiments, the region of the three-dimensional environment is a region of the three-dimensional environment on a left or right side of the first virtual object in the three-dimensional environment from the first viewpoint of the first user. In some embodiments, having a predefined spatial relationship relative to the first virtual object in the three-dimensional environment corresponds to the first location being a location relative to the first virtual object that is associated (e.g., based on information stored in a memory of the first computer system) with performing an input corresponding to a request to change the spatial arrangement of the first virtual object (e.g., the input including one or more characteristics of the first input). For example, the spatial arrangement of the first virtual object is changed relative to the three-dimensional environment while receiving the first input in accordance with a determination that the first input is directed to the first location in the three-dimensional environment. In some embodiments, in accordance with a determination that the first input is not directed to the first location in the three-dimensional environment (e.g., the first input is directed to a second location in the three-dimensional environment that does not have the predefined spatial relationship relative to the first virtual object), the computer system forgoes reducing the visual prominence of the one or more virtual representations of the one or more users relative to the three-dimensional environment and forgoes changing the spatial arrangement of the first virtual object relative to the first viewpoint of the first user. In some embodiments, the predefined spatial relationship is a standard spatial relationship (e.g., set by the first computer system and stored in a memory of the first computer system) between a respective virtual object (e.g., of the one or more virtual objects displayed in the three-dimensional environment that are shared content with the one or more computer systems in the communication session) and a respective region in the three-dimensional environment that an input (e.g., that has one or more characteristics of the first input) can be directed to for changing the spatial arrangement of the respective virtual object. For example, after receiving the first input, the first computer system receives a second input corresponding to a request to change a spatial arrangement of a second virtual object of the one or more virtual objects, and, in accordance with a determination that the second input includes attention directed to a second location that has the predefined spatial relationship relative to the second virtual object in the three-dimensional environment, the first computer system changes the spatial arrangement of the second virtual object relative to the first viewpoint of the first user in accordance with the second input while the one or more virtual representations of the one or more users have the reduced visual prominence relative to the three-dimensional environment. Reducing the visual prominence of one or more virtual representations in a three-dimensional environment and changing the spatial arrangement of content relative to the viewpoint of a user in response to a user input that includes attention of a user directed to a location in the three-dimensional environment with a predefined spatial relationship with the content ensures that the intent of the user is to change the spatial arrangement of the content prior to changing the spatial arrangement of the content and reducing the visual prominence of the one or more virtual representations, thereby reducing errors in interaction and improving user device interaction.

In some embodiments, in response to detecting the attention of the first user directed to the first location in the three-dimensional environment, the first computer system displays first visual feedback in the three-dimensional environment that indicates that the spatial arrangement of the first virtual object relative to the first viewpoint of the first user can be changed in response to further input, such as shown by affordance 1032 displayed in three-dimensional environment 1002a in FIG. 10R. In some embodiments, displaying the first visual feedback includes displaying a virtual object in the three-dimensional environment indicating that the spatial arrangement of the first virtual object relative to the first viewpoint of the first user can be changed in response to further input (e.g., in response to continuing the first input (e.g., by performing an air gesture and/or hand movement)). For example, the virtual object is a selectable object (e.g., affordance) displayed in the three-dimensional environment (e.g., optionally adjacent to the first virtual object). In some embodiments, the virtual object is displayed at the first location in the three-dimensional environment. In some embodiments, the virtual object is selectable by maintaining attention directed to the first location while concurrently performing an air gesture (e.g., an air pinch gesture as described above). In some embodiments, the first computer system displays the first visual feedback in the three-dimensional environment in accordance with a determination that the first virtual object is shared with the one or more computer systems in the communication session. In some embodiments, in accordance with a determination that the first virtual object is not shared with the one or more computer systems in the communication session, the first computer system forgoes displaying the first visual feedback in the three-dimensional environment. In some embodiments, in accordance with a determination that the attention of the first user is directed to a location different from the first location in the three-dimensional environment (e.g., a region of the three-dimensional environment that does not have the predefined spatial relationship (e.g., as described above) relative to the first virtual object), the first computer system forgoes displaying the first visual feedback in the three-dimensional environment. Displaying visual feedback in a three-dimensional environment in response to a user input that includes attention of a user directed to a location in the three-dimensional environment that has a predefined spatial relationship with content in the three-dimensional environment prior to reducing the visual prominence of one or more virtual representations in the three-dimensional environment and changing the spatial arrangement of the content relative to the viewpoint of the user provides visual feedback to the user that the user input was received, and provides the user an opportunity to confirm that their intent prior to changing the spatial arrangement of the content and reducing the visual prominence of the one or more virtual representations in the three-dimensional environment, thereby reducing errors in interaction and improving user device interaction.

In some embodiments, the first visual feedback includes a second virtual object displayed relative to a surface in the three-dimensional environment, such as affordance 1032 displayed on the surface visible in three-dimensional environment 1002a in FIG. 10R. In some embodiments, the second virtual object has one or more characteristics of the virtual object displayed in the three-dimensional environment indicating that the spatial arrangement of the first virtual object relative to the first viewpoint of the first user can be changed in response to further input as described above. In some embodiments, the second virtual object corresponds to affordance displayed in the three-dimensional environment. For example, the affordance is displayed with a relative shape (e.g., a ring, a circle, a rectangle, or a diamond). In some embodiments, the surface is visible at the first location (e.g., the region with the predefined spatial relationship with the first virtual object) in the three-dimensional environment. In some embodiments, the surface is a physical surface from the first user's physical environment that is visible from the first viewpoint of the first user as passthrough of the first user's physical environment. In some embodiments, the surface is a representation of the physical surface from the first user's physical environment visible from the first viewpoint of the first user in the three-dimensional environment. In some embodiments, the surface is a virtual surface that is displayed by the first computer system in the three-dimensional environment. In some embodiments, the surface is (e.g., or is a virtual representation of) a floor and/or ground visible from the first viewpoint of the first user below the first virtual object. In some embodiments, the surface is a virtual surface or a representation of a surface that is arranged in the three-dimensional environment parallel to a floor and/or ground in the physical environment of the first user (e.g., the surface is displayed within a distance (e.g., 0.1, 0.5, 0.1, 0.2, 0.5 or 1 m) of the floor and/or ground). In some embodiments, the surface is a flat surface, and the second virtual object is displayed on the flat surface (e.g., on a top side of the flat surface relative to the first viewpoint of the first user). For example, the second virtual object is optionally displayed with a flat visual appearance (e.g., the second virtual object is not displayed with depth and/or thickness from the first viewpoint of the first user) while displayed relative to the surface in the three-dimensional environment. Displaying a virtual object on a surface in a three-dimensional environment in response to a request to change a spatial arrangement of content relative to a viewpoint of a user provides visual feedback that the request to change the spatial arrangement of the content was received, provides the user the opportunity to confirm their intent to change the spatial arrangement of the content relative to the viewpoint of the user, and conserves available display space in the three-dimensional environment by displaying the virtual object on an already visible surface, thereby reducing errors in interaction and improving user device interaction.

In some embodiments, the first visual feedback includes a virtual representation of the three-dimensional environment, including one or more virtual elements corresponding to one or more current spatial arrangements of one or more virtual objects relative to the three-dimensional environment, such as virtual representation 1034 displayed in three-dimensional environment 1002a in FIG. 10S. In some embodiments, the virtual representation of the three-dimensional environment is displayed at the first location in the three-dimensional environment. In some embodiments, the virtual representation of the three-dimensional environment is displayed after displaying the second virtual object (e.g., as described above) in the three-dimensional environment (e.g., the virtual representation of the three-dimensional environment replaces the second virtual object at the first location in the three-dimensional environment. For example, the second virtual object is displayed prior to initiating the change of the spatial arrangement of the first virtual object relative to the first viewpoint of the first user, and the virtual representation of the three-dimensional environment is displayed while changing the spatial arrangement of the first virtual object relative to the first viewpoint of the first user. In some embodiments, the one or more virtual elements corresponds to one or more schematic representations of the one or more virtual objects (e.g., including the one or more virtual representations of the one or more users) displayed in the three-dimensional environment. In some embodiments, the one or more virtual elements are displayed with a shared spatial arrangement relative to each other, and the shared spatial arrangement corresponds to a schematic representation of a shared spatial arrangement of the one or more virtual objects in the three-dimensional environment (e.g., having one or more characteristics of the shared spatial arrangement of the one or more virtual objects described above). In some embodiments, while receiving the first input (e.g., while changing the spatial arrangement of the first virtual object in accordance with the first input), the first computer system maintains display of the virtual representation of the three-dimensional environment in the three-dimensional environment (e.g., at the first location in the three-dimensional environment). Displaying a virtual representation of a three-dimensional environment in the three-dimensional environment in response to a user input that includes attention of a user directed to a location in the three-dimensional environment that has a predefined spatial relationship with content in the three-dimensional environment prior to reducing the visual prominence of one or more virtual representations in the three-dimensional environment and changing the spatial arrangement of the content relative to the viewpoint of the user provides the user an opportunity to confirm their intent prior to changing the spatial arrangement of the content and reducing the visual prominence of the one or more virtual representations, thereby reducing errors in interaction and improving user device interaction.

In some embodiments, while receiving the first input, the first computer system changes a visual appearance of the one or more virtual elements included in the virtual representation of the three-dimensional environment while concurrently changing the spatial arrangement of the first virtual object relative to the first viewpoint of the first user, such as the change in spatial arrangement of the one or more virtual elements included in virtual representation 1034 in FIG. 10T compared to FIG. 10S. In some embodiments, changing the visual appearance of the one or more virtual elements included in the virtual representation of the three-dimensional environment includes changing the location and/or orientation of the one or more virtual elements included in the virtual representation of the three-dimensional environment to schematically represent the change in spatial arrangement of the first virtual object (e.g., and optionally at least a portion of the one or more virtual objects (e.g., because the at least the portion of the one or more virtual objects changes spatial arrangement in the three-dimensional environment concurrently with the first virtual object in accordance with the first input) in the three-dimensional environment from the first viewpoint of the first user. In some embodiments, in accordance with one or more virtual objects being displayed with a reduced visual prominence (e.g., the one or more virtual representations of the one or more users) while the first computer system changes the spatial arrangement of the first virtual object relative to the first viewpoint of the first user, the reduced visual prominence of the one or more virtual object is reflected (e.g., schematically) in the virtual representation of the three-dimensional environment. For example, if a virtual object of the one or more virtual objects ceases to be displayed in the three-dimensional environment while receiving the first input, a respective virtual element of the one or more virtual elements representing the respective virtual object will cease to be displayed in the virtual representation of the three-dimensional environment. For example, in accordance with the first computer system changing the one or more virtual representations of the one or more users from one or more virtual representations of a first type to one or more virtual representations of a second type (e.g., as described above), a portion of the one or more virtual elements representing the one or more virtual representations of the one or more users change size and/or appearance in the virtual representation of the three-dimensional environment. Displaying a virtual representation of a three-dimensional environment in the three-dimensional environment in response to a user input that includes a request to change a spatial arrangement of content in the three-dimensional environment provides a user an opportunity confirm their intent prior to changing the spatial arrangement of the content, and changing a visual appearance of one or more virtual elements included in the virtual representation of the three-dimensional environment while changing the spatial arrangement of the content provides visual feedback that the change in spatial arrangement of the content is occurring in the three-dimensional environment, thereby reducing errors in interaction and improving user device interaction.

In some embodiments, while displaying the three-dimensional environment from the first viewpoint of the first user and before receiving the first input, the first computer system displays the three-dimensional environment with a first visual appearance from the first viewpoint of the first user, wherein the first visual appearance is not based on the first spatial arrangement of the first virtual object, such as the visual appearance of three-dimensional environment 1002a shown in FIGS. 10A and 10A1. In some embodiments, while receiving the first input, the first computer system displays the three-dimensional environment with a second visual appearance, different from the first visual appearance, from the first viewpoint of the first user, wherein the second visual appearance is not based on the second spatial arrangement of the first virtual object, such as the visual appearance of three-dimensional environment 1002a shown in FIG. 10B. In some embodiments, displaying the three-dimensional environment with the first visual appearance includes displaying the three-dimensional environment with a visible appearance relative to the current viewpoint of the first user that includes visible features other than the first spatial arrangement of the first virtual object relative to the current viewpoint of the first user (e.g., the first visual appearance of the three-dimensional environment is independent of the first spatial arrangement of the first virtual object). In some embodiments, displaying the three-dimensional environment with the second visual appearance includes displaying the three-dimensional environment with a visible change in appearance relative to the current viewpoint of the first user (e.g., compared to displaying the three-dimensional environment with the first visual appearance) that is different from the change in spatial arrangement of the first virtual object relative to the current viewpoint of the user (e.g., the second visual appearance of the three-dimensional environment is independent of the second spatial arrangement of the first virtual object. In some embodiments, displaying the three-dimensional environment with the first visual appearance includes displaying the one or more virtual objects in the three-dimensional environment with an amount of opacity greater than displaying the three-dimensional environment with the second visual appearance (e.g., displaying the second visual appearance includes reducing the opacity of the one or more virtual objects displayed in the three-dimensional environment by 1, 5, 10, 25, 50, 75, 95, or 100 percent). In some embodiments, displaying the three-dimensional environment with the first visual appearance includes displaying the three-dimensional environment (e.g., and one or more objects visible in the three-dimensional environment) with a first saturation and/or one or more first colors and displaying the three-dimensional environment with the second visual appearance includes a second saturation amount, different from the first saturation amount, and/or one or more second colors, different from the one or more first colors. In some embodiments, displaying the three-dimensional environment with the second visual appearance includes displaying the three-dimensional environment (e.g., and one or more objects visible in the three-dimensional environment) with a darker appearance compared to displaying the three-dimensional environment with the first visual appearance. In some embodiments, displaying the three-dimensional environment with the second visual appearance includes displaying the three-dimensional environment (e.g., and one or more objects visible in the three-dimensional environment with reduced sharpness (e.g., increased blurring) compared to displaying the three-dimensional environment with the first visual appearance. In some embodiments, in accordance with a determination that the first virtual object is not shared content with the one or more computer systems in the communication session with the first computer system, the first computer system maintains display of the three-dimensional environment with the first visual appearance from the first viewpoint of the first user while receiving the first input (e.g., the first computer system forgoes displaying the three-dimensional environment with the second visual appearance). Changing the visual appearance of a three-dimensional environment while changing the spatial arrangement of content relative to a viewpoint of a user provides visual feedback to the user that the change in spatial arrangement of the content is occurring in the three-dimensional environment, thereby reducing errors in interaction and improving user device interaction.

In some embodiments, displaying the three-dimensional environment with the second visual appearance includes displaying the three-dimensional environment with a reduced brightness compared to displaying the three-dimensional environment with the first visual appearance, such as the reduced brightness of three-dimensional environment 1002a shown in FIG. 10B. In some embodiments, displaying the three-dimensional environment with a reduced brightness includes reducing the brightness of the three-dimensional environment by 1, 2, 5, 10, 25, 50, 75 or 95 percent compared to the brightness associated with the first visual appearance of the three-dimensional environment. In some embodiments, reducing the brightness of the three-dimensional environment includes reducing the brightness of the one or more virtual objects displayed in the three-dimensional environment. In some embodiments, reducing the brightness of the three-dimensional environment includes reducing the brightness of one or more objects from the first user's physical environment visible in the three-dimensional environment (e.g., through passthrough). Reducing the brightness of the visual appearance of a three-dimensional environment while changing the spatial arrangement of content relative to a viewpoint of a user reduces the amount of prominent motion that is displayed in the three-dimensional environment (e.g., motion with an increased amount of brightness relative to the viewpoint of the user) during the change in spatial arrangement of the content and provides visual feedback to the user that the change in spatial arrangement is occurring in the three-dimensional environment, thereby minimizing the risk of motion sickness to the user, reducing errors in interaction and improving user device interaction.

In some embodiments, displaying the three-dimensional environment with the second visual appearance includes displaying the one or more virtual objects included in the three-dimensional environment with the second visual appearance, such as displaying portion 1010 of three-dimensional environment 1002a and/or virtual representations 1012b and 1012c with the changed visual appearance in FIG. 10B. In some embodiments, displaying the one or more virtual objects included in the three-dimensional environment with the second visual appearance includes reducing the brightness of the one or more virtual objects (e.g., including one or more characteristics of reducing the brightness of the three-dimensional environment as described above). In some embodiments, displaying the three-dimensional environment with the second visual appearance includes displaying one or more regions of the three-dimensional environment that are not associated with the one or more virtual objects with the second visual appearance (e.g., the one or more virtual objects displayed in the three-dimensional environment and other portions of the three-dimensional environment that are not occupied by the one or more virtual objects are displayed with the second visual appearance. For example, the three-dimensional environment includes an immersive (e.g., or partially immersive) virtual environment (e.g., the virtual environment does not include the one or more virtual objects), and the virtual environment is displayed with the second visual appearance. Changing the visual appearance of a three-dimensional environment, including one or more virtual objects displayed in the three-dimensional environment, while changing the spatial arrangement of content relative to a viewpoint of a user provides visual feedback to the user that the change in spatial arrangement is occurring in the three-dimensional environment, thereby reducing errors in interaction and improving user device interaction.

In some embodiments, displaying the three-dimensional environment with the second visual appearance includes displaying one or more representations of one or more objects in a physical environment of the first user with the second visual appearance, such as displaying optical passthrough of the physical environment of first user 1042a with the changed visual appearance as shown in FIG. 10B. In some embodiments, the one or more representations of one or more objects in a physical environment of the first user are one or more physical objects (e.g., walls of a room and/or furniture) in a physical environment of the first user. In some embodiments, the one or more physical objects are visible in the three-dimensional environment through passthrough of the first user's physical environment. In some embodiments, the one or more representations of the one or more objects in the physical environment are one or more virtual representations of the one or more objects generated by the first computer system and displayed in the three-dimensional environment. In some embodiments, displaying the one or more representations of the one or more objects with the second visual appearance includes reducing the brightness of the one or more representations (e.g., including one or more characteristics of reducing the three-dimensional environment as described above). Changing the visual appearance of a three-dimensional environment, including one or more representations of one or more objects in a physical environment of a user visible in the three-dimensional environment, while changing the spatial arrangement of content relative to a viewpoint of a user provides visual feedback to the user that the change in spatial arrangement is occurring in the three-dimensional environment, thereby reducing errors in interaction and improving user device interaction.

In some embodiments, displaying the three-dimensional environment with the second visual appearance includes displaying a boundary around the at least the first portion of the one or more virtual objects, such as boundary 1022 displayed in three-dimensional environment 1002a in FIG. 10B. In some embodiments, the first portion of the one or more virtual objects includes the first virtual object. For example, the first virtual object is displayed at a center of a region of the three-dimensional environment surrounded by a border (e.g., descried below) of the boundary. In some embodiments, the boundary includes a border displayed (e.g., on a surface as described below) around the first portion of the one or more virtual objects. For example, the boundary does not include virtual features within the border (e.g., the first portion of the one or more virtual objects and one or more regions of the three-dimensional environment displayed within the border are visible to the first user from the first viewpoint). In some embodiments, the border of the boundary is displayed with a visual appearance that contrasts the three-dimensional environment (e.g., a surface visible in the three-dimensional environment that the boundary is displayed relative to). For example, the boundary is displayed with a dark color (e.g., black). Optionally, at least one or more portions of the boundary are opaque (e.g., from the first viewpoint of the first user). For example, the boundary is displayed with a light color (e.g., white). Optionally, at least one or more portions of the boundary are opaque. Displaying a boundary around content in a three-dimensional environment while changing the spatial arrangement of the content relative to a viewpoint of a user provides visual feedback that the change in spatial arrangement of the content is initiated, informs the user of the content that will change spatial arrangement relative to the viewpoint of the user, and synchronizes the motion of the content shown within the boundary while changing the spatial arrangement of the content, thereby minimizing the risk of motion sickness to the user, reducing errors in interaction and improving user device interaction.

In some embodiments, the boundary is displayed in the three-dimensional environment in accordance with a determination that the at least the first portion of the one or more virtual objects is shared content that is shared with the one or more computer systems in the communication session, such as shown by boundary 1022 being displayed in three-dimensional environment 1002a in accordance with the determination that virtual object 1006a is shared in the communication session in FIG. 10B. In some embodiments, the boundary is displayed around the first portion of the one or more virtual objects and a second portion of the one or more virtual objects that are not shared content with the one or more computer systems in the communication session. In some embodiments, the boundary is not displayed around the second portion of the one or more virtual objects that are not shared content with the one or more computer systems in the communication session. In some embodiments, the boundary is displayed around the second portion of the one or more virtual objects depending on one or more locations of the second portion of the one or more virtual objects in the three-dimensional environment. For example, if a respective virtual object of the second portion of the one or more virtual objects is displayed within a region of the three-dimensional environment that the border of the boundary is displayed around prior to detecting of the first input, the boundary is displayed around the respective virtual object (e.g., displaying the boundary around the first portion of the one or more virtual objects does not include changing a spatial arrangement (e.g., relative to the three-dimensional environment) of one or more virtual objects not included in the first portion of the one or more virtual objects). Displaying a boundary around content in a three-dimensional environment while changing the spatial arrangement of the content relative to a viewpoint of a user in accordance with the content being shared with one or more computer systems in a communication session provides visual feedback that the change in spatial arrangement of the content is initiated, that the content that is changing spatial arrangement relative to the viewpoint of the user is shared in the communication session, and synchronizes the motion of the content shown within the boundary while changing the spatial arrangement of the content, thereby minimizing the risk of motion sickness to the user, reducing errors in interaction and improving user device interaction.

In some embodiments, the boundary is displayed relative to a surface (e.g., virtually or in passthrough) in the three-dimensional environment, such as the display of boundary 1022 on the surface visible in three-dimensional environment 1002a as shown in FIG. 10B. In some embodiments, the surface has one or more characteristics of the surface the second virtual object is displayed relative to as described above. In some embodiments, the first computer system detects the surface that is visible in the three-dimensional environment (e.g., the surface is a physical surface visible in the three-dimensional environment as passthrough of the first user's physical environment). In some embodiments, the surface is a virtual surface (e.g., displayed in a virtual environment (e.g., an immersive or partially immersive virtual environment) displayed in the three-dimensional environment. In some embodiments, the surface is visible in a region of the three-dimensional environment below the first virtual object from the first viewpoint of the first user (e.g., the surface corresponds to a floor and/or ground visible (e.g., virtually or in passthrough) in the three-dimensional environment). In some embodiments, the surface is a flat surface, and the boundary is displayed on the flat surface (e.g., on a top side of the flat surface relative to the first viewpoint of the first user). In some embodiments, the boundary is arranged in the three-dimensional environment parallel to a floor and/or ground in the physical environment of the first user (e.g., the boundary is displayed within a distance (e.g., 0.1, 0.5, 0.1, 0.2, 0.5 or 1 m) of the floor and/or ground). Displaying a boundary around shared content and relative to a surface in a three-dimensional environment while changing the spatial arrangement of the shared content relative to a viewpoint of a user provides visual feedback that the change in spatial arrangement of the shared content is initiated, informs the user of the content that will change spatial arrangement relative to the viewpoint of the user as a result of the user input, synchronizes the motion of the shared content shown within the boundary while changing the spatial arrangement of the shared content, and reduces the prominence of the movement of the boundary by displaying it relative to a reference region in the three-dimensional environment, thereby minimizing the risk of motion sickness to the user, reducing errors in interaction and improving user device interaction.

In some embodiments, in accordance with the at least the first portion of the one or more virtual objects in the three-dimensional environment having a first shared spatial arrangement, the first computer system displays the boundary with a first size based on the first shared spatial arrangement, such as shown by the size of boundary 1022 displayed in three-dimensional environment 1002a in FIG. 10T. In some embodiments, the first size of the boundary corresponds to a first area (e.g., a first dimension (e.g., width) by a second dimension (e.g., height)) of the boundary relative to the three-dimensional environment (e.g., or relative to the first viewpoint of the first user). In some embodiments, the first shared spatial arrangement has one or more characteristics of the shared spatial arrangement described above. In some embodiments, the first shared spatial arrangement includes one or more first orientations of the one or more virtual objects relative to each other in the three-dimensional environment (e.g., from the first viewpoint of the first user). In some embodiments, the first shared spatial arrangement includes one or more first distances of the one or more virtual objects relative to each other in the three-dimensional environment (e.g., from the first viewpoint of the first user). In some embodiments, displaying the one or more virtual objects with the first shared spatial arrangement includes displaying the one or more virtual objects within a first region of the three-dimensional environment (e.g., the volume of the region of the three-dimensional environment is defined by the shared distances and/or orientations between the one or more virtual objects). In some embodiments, the size of the boundary is based on the area of the first region of the three-dimensional environment (e.g., the boundary is displayed around the first region of the three-dimensional environment to surround the one or more virtual objects included in the first region). In some embodiments, while changing the spatial arrangement of the first virtual object relative to the first viewpoint of the first user in accordance with the first input, the first computer system changes the spatial arrangement of the one or more virtual objects relative to the first viewpoint of the first user in accordance with the first input while maintaining the first shared spatial arrangement of the one or more virtual objects and while maintaining the display of the boundary (e.g., with the first size based on the first shared spatial arrangement) around the one or more virtual objects.

In some embodiments, in accordance with the at least the first portion of the one or more virtual objects in the three-dimensional environment having a second shared spatial arrangement, different from the first shared spatial arrangement, the first computer system displays the boundary with a second size, different from the first size, based on the second shares spatial arrangement, such as shown by the size of boundary 1022 displayed in three-dimensional environment 1002a in FIG. 10W compared to the size of boundary 1022 displayed in three-dimensional environment 1002a in FIG. 10T. In some embodiments, the second size of the boundary corresponds to a second area (e.g., a first dimension (e.g., width) by a second dimension (e.g., height)) of the boundary relative to the three-dimensional environment (e.g., or relative to the first viewpoint of the first user). In some embodiments, the second shared spatial arrangement has one or more characteristics of the shared spatial arrangement described above. In some embodiments, the second shared spatial arrangement includes one or more second orientations (e.g., different from the one or more first orientations) of the one or more virtual objects relative to each other in the three-dimensional environment (e.g., from the first viewpoint of the first user). In some embodiments, the second shared spatial arrangement includes one or more second distances (e.g., different from the one or more first distances) of the one or more virtual objects relative to each other in the three-dimensional environment (e.g., from the first viewpoint of the first user). In some embodiments, displaying the one or more virtual objects with the second shared spatial arrangement includes displaying the one or more virtual objects within a second region (e.g., different from the first region) of the three-dimensional environment (e.g., the volume of the region of the three-dimensional environment is defined by the shared distances and/or orientations between the one or more virtual objects). In some embodiments, the size of the boundary is based on the area of the second region of the three-dimensional environment (e.g., the boundary is displayed around the second region of the three-dimensional environment to surround the one or more virtual objects included in the second region). In some embodiments, while changing the spatial arrangement of the first virtual object relative to the first viewpoint of the first user in accordance with the first input, the first computer system changes the spatial arrangement of the one or more virtual objects relative to the first viewpoint of the first user in accordance with the first input while maintaining the second shared spatial arrangement of the one or more virtual objects and while maintaining the display of the boundary (e.g., with the second size based on the second shared spatial arrangement) around the one or more virtual objects. Displaying a boundary with a relative size based on a shared spatial arrangement of a plurality of shared content that the boundary is displayed around in a three-dimensional environment while changing the spatial arrangement of the plurality of shared content relative to a viewpoint of a user provides visual feedback that the change in spatial arrangement of the plurality of shared content is initiated, informs the user of the content that will change spatial arrangement relative to the viewpoint of the user as a result of the user input, and synchronizes the motion of the plurality shared content shown within the boundary while changing the spatial arrangement of the shared content (e.g., by maintaining the shared spatial arrangement of the plurality of shared content within the boundary while the boundary is moved in the three-dimensional environment in accordance with the user input), thereby minimizing the risk of motion sickness to the user, reducing errors in interaction and improving user device interaction.

In some embodiments, displaying the boundary around the first portion of the one or more virtual objects includes displaying the boundary around one or more locations in the three-dimensional environment corresponding to one or more available viewpoint locations, for participants in the communication session, corresponding to the shared content in the three-dimensional environment, such as boundary 1022 displayed around the locations corresponding to the current viewpoints of users 1042a-1042d in three-dimensional environment 1002a as shown in FIG. 10S. In some embodiments, in accordance with the shared content being first shared content in the three-dimensional environment, the one or more available viewpoint locations correspond to one or more first available viewpoint locations. In some embodiments, the boundary is displayed with a first size relative to the three-dimensional environment based on a shared spatial arrangement of the first available viewpoint locations in the three-dimensional environment. For example, the first size of the boundary corresponds to a size of a perimeter (e.g., the border) of the boundary that surrounds the first available viewpoint locations in the three-dimensional environment (e.g., the first size of the boundary is such that the perimeter of the boundary is 0.1, 0.5, 0.1, 0.2, 0.3, 0.5, or 1 m outside of the first available viewpoint locations in the three-dimensional environment (e.g., the first available viewpoint locations are located within the boundary in the three-dimensional environment)). In some embodiments, in accordance with the shared content being second shared content in the three-dimensional environment different from the first shared content, the one or more available viewpoint locations correspond to one or more second available viewpoint locations different from the one or more first available viewpoint locations in the three-dimensional environment. In some embodiments, the boundary is displayed with a second size, different from the first size, relative to the three-dimensional environment based on a shared spatial arrangement of the second available viewpoint locations in the three-dimensional environment. For example, the second size of the boundary corresponds to a size of a perimeter (e.g., the border) of the boundary that surrounds the second available viewpoint locations in the three-dimensional environment (e.g., the second size of the boundary is such that the perimeter of the boundary is 0.1, 0.5, 0.1, 0.2, 0.3, 0.5, or 1 m outside of the second available viewpoint locations in the three-dimensional environment (e.g., the second available viewpoint locations are located within the boundary in the three-dimensional environment)). In some embodiments, the first shared content includes a first amount of available viewpoint locations, and the second shared content includes a second amount different from the first amount of available viewpoint locations. In some embodiments, the one or more available viewpoint locations in the three-dimensional environment correspond to one or more locations of the one or more virtual representations of the one or more users in the three-dimensional environment. In some embodiments, the one or more users select a viewpoint location of a plurality of viewpoint locations to view the shared content from. In some embodiments, a current viewpoint location of a respective user of the one or more users may be changed in response to a user input received by a respective computer system associated with the respective user (e.g., the user input corresponding to a request by the respective user to change the current viewpoint of the respective user to a different available viewpoint location of the one or more available viewpoint locations). In some embodiments, a respective virtual object (e.g., associated with a shared application in the communication session) includes one or more pre-defined locations relative to the respective virtual object for displaying one or more virtual representations of one or more users of one or more computer systems in the communication session (e.g., a template of one or more locations for displaying one or more virtual representations is associated with the respective virtual object). In some embodiments, the pre-defined locations associated with the respective virtual object do not correspond to one or more locations of one or more current viewpoints of the one or more users relative to the three-dimensional environment. In some embodiments, different respective virtual objects (e.g., associated with different shared applications in the communication session) include different pre-defined locations for displaying the one or more virtual representations of the one or more users. In some embodiments, the shape and/or size of the boundary is based on the one or more pre-defined locations for displaying the one or more virtual representations relative to the respective virtual object (e.g., if the pre-defined locations in the three-dimensional environment have a first shared spatial arrangement, the boundary is displayed with a first size and/or shape based on the first shared spatial arrangement, and if the pre-defined locations in the three-dimensional environment have a second shared spatial arrangement, different from the first shared spatial arrangement, the boundary is displayed with a second size and/or shape, different from the first size, based on the second shared spatial arrangement). Displaying a boundary around one or more available viewpoint locations corresponding to shared content in a three-dimensional environment while changing the spatial arrangement of the shared content relative to a viewpoint of a user provides visual feedback that the change in spatial arrangement of the shared content is initiated, informs the user of the content that will change spatial arrangement relative to the viewpoint of the user as a result of the user input, and synchronizes motion of one or more objects displayed within a region of the three-dimensional environment associated with the shared content, thereby minimizing the risk of motion sickness to the user, reducing errors in interaction and improving user device interaction.

In some embodiments, displaying the boundary around the first portion of the one or more virtual objects includes, in accordance with a first portion of the boundary being displayed at a first distance from the first viewpoint of the first user in the three-dimensional environment, displaying the first portion of the boundary with a first visual prominence, and in accordance with a second portion of the boundary being displayed at a second distance, greater than the first distance, from the first viewpoint of the first user in the three-dimensional environment, displaying the second portion of the boundary with a second visual prominence that is less than the first visual prominence, such as shown by the difference in visual prominence of portion 1028a of boundary 1022 compared to the remaining portion of boundary 1022 in FIG. 10E. In some embodiments, the first portion of the boundary and the second portion of the boundary are different portions of the border of the boundary (e.g., the first portion of the boundary is a more front portion (e.g., less distance relative to the first viewpoint of the first user) of the boundary and the second portion is a more back portion (e.g., greater distance relative to the first viewpoint of the first user) of the boundary). In some embodiments, displaying the boundary with the first visual prominence includes displaying the boundary with a greater amount of opacity compared to displaying the boundary with the second visual prominence. For example, displaying the boundary with the second visual prominence includes displaying the second portion of the boundary with a reduced amount of opacity compared to the first portion of the boundary displayed with the first visual prominence. In some embodiments, displaying the boundary includes gradually reducing the opacity of the boundary based on a relative distance of a respective portion of the boundary from the first viewpoint of the first user in the three-dimensional environment (e.g., a front portion (e.g., a portion of the boundary that is displayed at a closest distance from the first viewpoint of the first user in the three-dimensional environment) includes a greater gradient of opacity (e.g., 0.1, 0.5, 0.1, 0.2, 0.3, 0.5, or 0.7 gradient) compared to a back portion (e.g., a portion of the boundary that is displayed at a farther distance from the first viewpoint of the first user in the three-dimensional environment (e.g., the back portion is displayed with an opacity of 0.1, 0.5, 0.1, 0.2, 0.3, 0.5, 0.7 less gradient than the front portion))). Displaying a boundary around shared content in a three-dimensional environment with different amounts of visual prominence while changing the spatial arrangement of the shared content relative to a viewpoint of a user provides visual feedback that the change in spatial arrangement of the shared content is initiated, informs the user of the content that will change spatial arrangement relative to the viewpoint of the user, synchronizes the motion of the shared content shown within the boundary while changing the spatial arrangement of the shared content, and provides the user perspective of the position of the boundary relative to their viewpoint while changing the spatial arrangement of the shared content, thereby minimizing the risk of motion sickness to the user, reducing errors in interaction and improving user device interaction.

In some embodiments, while changing the spatial arrangement of the first virtual object relative to the first viewpoint of the first user, the first computer system changes a distance of the boundary from the first viewpoint of the first user in accordance with the change in the spatial arrangement of the first virtual object relative to the first viewpoint of the first user, such as shown by the change in spatial arrangement of boundary 1022 relative to the current viewpoint of first user 1042a in FIGS. 10D-10E. In some embodiments, changing the distance of the boundary from the first viewpoint of the first user includes increasing the distance of the boundary from the first viewpoint of the first user. In some embodiments, changing the distance of the boundary from the first viewpoint of the first user includes decreasing the distance of the boundary from the first viewpoint of the first user.

In some embodiments, in response to changing the distance of the boundary from the first viewpoint of the first user, the first computer system changes a visual prominence of the boundary relative to the three-dimensional environment, such as shown by the change in visual prominence of portion 1028a of boundary 1022 relative to three-dimensional environment 1002a in FIG. 10E. In some embodiments, in accordance with the distance of the boundary from the first viewpoint of the first user being decreased while changing the spatial arrangement of the first virtual object, changing the visual prominence of the boundary includes increasing the visual prominence of the boundary relative to the three-dimensional environment. For example, increasing the visual prominence of the boundary relative to the three-dimensional environment includes increasing the opacity of the boundary. In some embodiments, in accordance with the distance of the boundary from the first viewpoint of the first user being increased while changing the spatial arrangement of the first virtual object, changing the visual prominence of the boundary includes reducing the visual prominence of the boundary relative to the three-dimensional environment. For example, reducing the visual prominence of the boundary relative to the three-dimensional environment includes decreasing the opacity of the boundary. Displaying a boundary around shared content and changing the visual prominence of the boundary in a three-dimensional environment based on a distance of the boundary from a viewpoint of a user while changing the spatial arrangement of the shared content relative to the viewpoint of the user provides visual feedback that the change in spatial arrangement of the shared content is initiated, informs the user of the content that will change spatial arrangement relative to the viewpoint of the user, synchronizes the motion of the shared content shown within the boundary while changing the spatial arrangement of the shared content, and provides the user perspective of the distance of the boundary and the shared content relative to their viewpoint, thereby minimizing the risk of motion sickness to the user, reducing errors in interaction and improving user device interaction.

In some embodiments, while changing the spatial arrangement of the first virtual object relative to the first viewpoint of the first user, the first computer system changes a spatial arrangement between the boundary and an object visible in the three-dimensional environment, such as the change in spatial arrangement of boundary 1022 and the wall visible in three-dimensional environment 1002a in FIGS. 10E-10F. In some embodiments, the object is a virtual object of the one or more virtual objects displayed in the three-dimensional environment. In some embodiments, the object is a virtual representation of the one or more virtual representations displayed in the three-dimensional environment. In some embodiments, the object is a representation of a physical object from the first user's physical environment (e.g., a wall of a room or furniture). In some embodiments, the object that is visible is a physical object visible through pass through of the first user's physical environment.

In some embodiments, while changing the spatial arrangement between the boundary and the object visible in the three-dimensional environment, in accordance with a determination that the at least a portion of the boundary has a spatial conflict with the object relative to the first viewpoint of the first user, the first computer system changes a visual prominence of the at least the portion of the boundary, such as shown by the change in visual prominence of portion 1028b of boundary 1022 in FIG. 10F. In some embodiments, the spatial conflict corresponds to a location of the at least the portion of the boundary in the three-dimensional environment corresponding to a location of the object relative to the three-dimensional environment (e.g., or relative to a physical environment visible to the first user (e.g., the object is a physical object in the physical environment of the first user)). In some embodiments, changing the visual prominence of the at least the portion of the boundary includes one or more characteristics of changing the visual prominence of the boundary relative to the three-dimensional environment as described above. For example, the at least the portion of the boundary is displayed with a reduced visual prominence (e.g., less opacity) compared to one or more portions of the boundary different from the at least the portion of the boundary (e.g., the one or more portions of the boundary do not have a spatial conflict with one or more objects visible in the three-dimensional environment). In some embodiments, in accordance with a determination that at least a second portion of the boundary different from the at least the portion of the boundary has a spatial conflict with one or more objects (e.g., optionally different from the object) relative to the first viewpoint of the first user concurrently with the at least the portion of the boundary, the first computer system changes the visual prominence of the at least the second portion of the boundary and the at least the portion of the boundary. Displaying a boundary around shared content in a three-dimensional environment while changing the spatial arrangement of the shared content relative to a viewpoint of a user and changing the visual prominence of the boundary when at least a portion of the boundary has a spatial conflict with an object relative to the viewpoint of the user informs the user of the content that will change spatial arrangement relative to the viewpoint of the user, synchronizes the motion of the shared content shown within the boundary while changing the spatial arrangement of the shared content, and reduces spatial conflicts displayed in the three-dimensional environment during the change in the spatial arrangement of the shared content, thereby minimizing the risk of motion sickness to the user, reducing errors in interaction and improving user device interaction.

In some embodiments, displaying the boundary around the at the first portion of the one or more virtual objects includes displaying a first portion of the boundary around a first region of the three-dimensional environment that includes one or more locations corresponding to the at least the first portion of the one or more virtual objects, wherein the first region of the three-dimensional environment is at a first distance from the first viewpoint of the user, such as the portion of boundary 1022 surrounding virtual representations 1012b-1012c and virtual object 1006a (e.g., above reference line 1050 in overhead view 1040) in FIG. 10X. In some embodiments, the first portion of the boundary surrounds the first region of the three-dimensional environment. In some embodiments, a size of the first portion of the boundary corresponds to a shared spatial arrangement of the at least the first portion of the one or more virtual objects in the three-dimensional environment (e.g., relative to the first viewpoint of the first user). In some embodiments, the shared spatial arrangement of the at least the first portion of the one or more virtual objects has one or more characteristics of the first shared spatial arrangement of the second shared spatial arrangement of the at least the first portion of the one or more virtual object as described above. In some embodiments, the first region of the three-dimensional environment is based on a volume of the three-dimensional environment that is defined by the shared distances and/or orientations between the one or more locations corresponding to the at least the first portion of the one or more virtual objects. In some embodiments, displaying the first portion of the boundary around the first region of the three-dimensional environment includes displaying a perimeter of the first portion of the boundary that is outside of the one or more locations corresponding to the at least the first portion of the one or more virtual objects by 0.1, 0.5, 0.1, 0.2, 0.3, 0.5, or 1 m relative to the three-dimensional environment. In some embodiments, the first portion of the boundary includes a first side of the perimeter of the boundary that is at the greatest distance from the first viewpoint of the user in the three-dimensional environment (e.g., and not a second side of the perimeter of the boundary, opposite the first side of the perimeter of the boundary, that is at a closest distance from the first viewpoint of the user in the three-dimensional environment).

In some embodiments, displaying the boundary around the at least the first portion of the one or more virtual objects includes displaying a second portion of the boundary around a second region of the three-dimensional environment that does not include the one or more locations corresponding to the at least the first portion of the one or more virtual objects, wherein the second region of the three-dimensional environment is at a second distance, less than the first distance, from the first viewpoint of the user, such as the portion of boundary 1022 surrounding the region of three-dimensional environment 1002a that does not include virtual representations 1012b-1012c and virtual object 1006a (e.g., below reference line 1050 in overhead view 1040) in FIG. 10X. In some embodiments, the first portion of the boundary and the second portion of the boundary correspond to the entire boundary (e.g., the first portion of the boundary and the second portion of the boundary correspond to entire perimeter of the boundary). In some embodiments, the second portion of the boundary surrounds the second region of the three-dimensional environment. In some embodiments, the second region of the three-dimensional environment includes one or more locations corresponding to one or more virtual objects different from the at least the first portion of the one or more virtual objects (e.g., one or more locations of one or more virtual objects not shared in the communication session). In some embodiments, the second region of the three-dimensional environment includes one or more locations in the three-dimensional environment that do not correspond to one or more virtual objects in the three-dimensional environment (e.g., the second region of the three-dimensional environment is empty space of the three-dimensional environment, includes a virtual surface (e.g., a virtual floor), or includes one or more objects and/or surfaces visible in passthrough of the physical environment of the first user (e.g., a floor)). In some embodiments, the second portion of the boundary includes a second side, opposite of the first side, of the perimeter of the boundary that is at a closest distance from the first viewpoint of the user in the three-dimensional environment (e.g., and does not include the first side of the perimeter of the boundary). In some embodiments, in accordance with the change in spatial arrangement of the first virtual object including movement of the at least the first portion of the one or more virtual objects by more than a threshold distance toward a location in the three-dimensional environment corresponding to the first viewpoint of the first user, the location of the three-dimensional environment corresponding to the first viewpoint of the first user is included in the second region of the three-dimensional environment (e.g., and is included within the second portion of the boundary). In some embodiments, a first distance (e.g., by 0.1, 0.5, 0.1, 0.2, 0.3, 0.5, or 1 m) is displayed between the one or more locations corresponding to the at least the first portion of the one or more virtual objects (e.g., corresponding to the shared spatial arrangement of the at least the first portion of the one or more virtual objects in the three-dimensional environment) and a first side of the perimeter of the boundary that is displayed farthest from the first viewpoint of the user. In some embodiments, a second distance, greater than the first distance, is displayed between the one or more locations corresponding to the at least the first portion of the one or more virtual object and a second side of the perimeter of the boundary, opposite and parallel to the first side of the perimeter of the boundary, that is displayed closest to the first viewpoint of the user (e.g., the second side of the perimeter of the boundary is displayed extended toward the first viewpoint of the user in the three-dimensional environment). Displaying a first portion of a boundary around content in a three-dimensional environment and a second portion of a boundary that is at a closer distance to a viewpoint of a user than the first portion of the boundary around a region of the three-dimensional environment that does not include the content informs the user that they are permitted to perform a change in spatial arrangement of the content that can include moving the content to a closer distance to the viewpoint of the user, thereby reducing errors in interaction and improving user device interaction.

In some embodiments, displaying the boundary around the at least the first portion of the one or more virtual objects includes displaying a first portion of a perimeter of the boundary perpendicular to a vector extending from a location in the three-dimensional environment corresponding to the first viewpoint of the first user to a location in the three-dimensional environment corresponding to a center of the boundary, such as the portion of the perimeter of boundary 1022 that is displayed closest to the current viewpoint of user 1042a that is displayed perpendicular to reference line 1050 (e.g., extending from the location of the current viewpoint of user 1042a toward the center of boundary 1022) in FIG. 10Y. In some embodiments, the first portion of the perimeter of the boundary includes a first side of the perimeter that at a distance that is closest to the location in the three-dimensional environment corresponding to the first viewpoint of the user and/or a second side of the perimeter (e.g., that is opposite and parallel to the first side of the perimeter) that is at a distance that is greatest from the location in the three-dimensional environment corresponding to the first viewpoint of the user. In some embodiments, the first portion of the perimeter of the boundary is displayed within 0.1, 0.2, 0.5, 1, 2, 5, 10, 15, 20, or 25 degrees of perpendicular to the vector extending from the location in the three-dimensional environment corresponding to the first viewpoint of the first user to the location in the three-dimensional environment corresponding to the center of the boundary. In some embodiments, the center of the boundary corresponds is based on the shared spatial relationship between the at least the first portion of the one or more virtual objects in the three-dimensional environment (e.g., the center of the boundary is aligned (e.g., from the first viewpoint of the first user) with a center of a region of the three-dimensional environment corresponding to the shared spatial relationship between the at least the first portion of the one or more virtual objects in the three-dimensional environment). In some embodiments, the vector extending from the location in the three-dimensional environment corresponding to the first viewpoint of the first user to the location in the three-dimensional environment corresponding to the center of the boundary is not displayed and/or represented in the three-dimensional environment from the first viewpoint of the first user. In some embodiments, while changing the spatial arrangement of the first virtual object relative to the first viewpoint of the first user in accordance with the first input, the first computer system changes the orientation of the boundary relative to the three-dimensional environment to maintain display of the first portion of the perimeter of the boundary perpendicular to the vector extending from the location in the three-dimensional environment corresponding to the first viewpoint of the first user to the location in the three-dimensional environment corresponding to the center of the boundary (e.g., while displaying the boundary and changing the spatial arrangement of the first virtual object, the first computer system maintains the orientation of the boundary relative to the first viewpoint of the first user). Displaying a boundary in a three-dimensional environment around content while changing the spatial arrangement of the content relative to a viewpoint of a user at an orientation that is based on the viewpoint of the user synchronizes the motion of the content during the change of spatial arrangement by providing a consistent orientation of a portion of the perimeter of the boundary relative to the viewpoint of the user during the change in spatial arrangement of the content, thereby minimizing the risk of motion sickness to the user.

In some embodiments, displaying the boundary around the at least the first portion of the one or more virtual objects includes, in accordance with the at least the first portion of the one or more virtual objects including shared content that is shared with the one or more computer systems in the communication session, displaying the boundary at a first orientation in the three-dimensional environment that is based on an orientation of the shared content in the three-dimensional environment, such as the orientation that boundary 1022 is displayed at (e.g., when virtual object 1006a is displayed) in three-dimensional environment 1002a in FIG. 10X. In some embodiments, the one or more virtual objects that are shared content include one or more characteristics of the first virtual object that is shared in the communication session as described above and/or with reference to method 1200. Displaying the boundary at the first orientation in the three-dimensional environment that is based on the orientation of the shared content in the three-dimensional environment optionally does not include displaying the first portion of the perimeter of the boundary perpendicular to the vector extending from the location in the three-dimensional environment corresponding to the first viewpoint of the first user to the location in the three-dimensional environment corresponding to the center of the boundary as described above. In some embodiments, one or more portions of the perimeter of the boundary are displayed parallel to one or more portions of at least a virtual object (e.g., the first virtual object) of the at least the first portion of the one or more virtual objects that is shared in the communication session. For example, displaying the one or more portions of the perimeter of the boundary parallel to the one or more portions of the at least the virtual object that is shared in the communication session includes displaying the first portion of the perimeter of the boundary at an orientation that is not perpendicular to (e.g., or not with of 0.1, 0.2, 0.5, 1, 2, 5, 10, 15, 20, or 25 degrees of perpendicular to) the vector extending from the location in the three-dimensional environment corresponding to the first viewpoint of the first user to the location in the three-dimensional environment corresponding to the center of the boundary (e.g., as described above).

In some embodiments, displaying the boundary around the at least the first portion of the one or more virtual object includes, in accordance with the at least the first portion of the one or more virtual objects not including content that is shared with the one or more computer systems in the communication session, displaying the boundary at a second orientation, different from the first orientation, that includes displaying a first portion of a perimeter of the boundary perpendicular to a vector extending from a location in the three-dimensional environment corresponding to the first viewpoint of the first user to a location in the three-dimensional environment corresponding to a center of the boundary, such as the orientation that boundary 1022 is displayed at (e.g., when virtual object 1006a is not displayed) in three-dimensional environment 1002a in FIG. 10Y. In some embodiments, the first portion of the one or more virtual objects include one or more characteristics of the first virtual object that is not shared with the one or more computer systems in the communication session. In some embodiments, the first portion of the one or more virtual objects correspond to virtual representations of users of the one or more computer systems in the communication session with the first computer system (e.g., including one or more characteristics of the first virtual object and/or virtual representations described with reference to methods 800 and/or 900). In some embodiments, displaying the first portion of the perimeter of the boundary perpendicular to the vector extending from the location in the three-dimensional environment corresponding to the first viewpoint of the first user to a location in the three-dimensional environment corresponding to the center of the boundary includes one or more characteristics of displaying the first portion of the perimeter of the boundary perpendicular to the vector extending from the location in the three-dimensional environment corresponding to the first viewpoint of the first user to the location in the three-dimensional environment corresponding to the center of the boundary as described above. Displaying a boundary in a three-dimensional environment around content while changing the spatial arrangement of the content relative to a viewpoint of a user at different orientations based on whether the content is shared in a communication session provides visual feedback to a user whether the change in spatial arrangement involves changing a spatial arrangement of content that is shared in the communication session and informs the user how to improve the orientation of the content that is shared in the communication session relative to their viewpoint (e.g., in order to improve interaction with the content that is shared in the communication session), thereby reducing errors in interaction and improving user device interaction.

In some embodiments, in response to detecting termination of the first input, the first computer system displays, via the display generation component, the three-dimensional environment with the first visual appearance from the first viewpoint of the first user, such as shown by the visual appearance of three-dimensional environment 1002a in FIG. 10H in response to first user 1042a ceasing to provide the input corresponding to the request to change the spatial arrangement of virtual object 1006a. In some embodiments, detecting termination of the first input includes one or more characteristics of detecting termination of the first input as described above. In some embodiments, displaying the three-dimensional environment with the first visual appearance from the first viewpoint of the first user includes one or more characteristics of displaying the three-dimensional environment with the first visual appearance from the first viewpoint of the first user as described above. In some embodiments, in response to detecting termination of the first input, the first computer system displays the three-dimensional environment with an increased visual prominence (e.g., displaying the three-dimensional environment with the increased visual prominence is optionally different from the first visual appearance). For example, displaying the three-dimensional environment with the increased visual prominence includes increasing the brightness, color, saturation, opacity and/or sharpness of the three-dimensional environment (e.g., including one or more objects displayed in the three-dimensional environment). Changing the visual appearance of a three-dimensional environment in response to termination of a change in spatial arrangement of content relative to a viewpoint of a user provides visual feedback to the user that the change in spatial arrangement of the content is terminated in the three-dimensional environment, thereby reducing errors in interactions and improving user device interaction.

In some embodiments, changing the spatial arrangement of the first virtual object relative to the first viewpoint of the first user in accordance with the first input includes, in accordance with a determination that the first input includes input from a first portion of the first user without including input from a second portion of the first user, pivoting the first virtual object and a first portion of the one or more virtual objects that are shared in the communication session with the one or more computer systems about a first location in the three-dimensional environment corresponding to the first viewpoint of the first user, such as shown by the pivoting of virtual object 1006a and virtual representations 1014b and 1014c in three-dimensional environment 1002a shown in FIGS. 10E-10F. In some embodiments, the first portion of the first user corresponds to a first hand of the first user and the second portion of the first user corresponds to a second hand of the first user. In some embodiments, determining that the first input includes input from the first portion of the first user without including input from the second portion of the first user includes detecting an air gesture (e.g., including one or more characteristics of an air gesture as described above) performed by the first portion of the first user and not detecting an air gesture performed by the second portion of the first user. In some embodiments, the air gesture performed by the first portion of the first user corresponds to an air pinch and movement of the first portion of the first user relative to the three-dimensional environment while maintaining the air pinch shape. In some embodiments, in accordance with a determination that the first input includes input from the second portion of the first user without including input from the first portion of the first user, the first computer system pivots the first virtual object and the first portion of the one or more virtual objects about the first location in the three-dimensional environment (e.g., the first input can be provided by a left hand of the user or the right hand of the user). In some embodiments, pivoting the first virtual object and the first portion of the one or more virtual objects about the first location in the three-dimensional environments includes maintaining a shared spatial arrangement between the first virtual object and the first portion of the one or more virtual objects (e.g., the first portion of the one or more virtual object including a shared spatial arrangement relative to each other (e.g., including one or more characteristics of the shared spatial arrangement as described above)) while pivoting the first virtual object and the first portion of the one or more virtual objects about the first location. In some embodiments, pivoting the first virtual object and the first portion of the one or more virtual objects about the first location in the three-dimensional environment corresponds to the first virtual object and the one or more virtual objects moving around the first user from the first viewpoint of the first user. In some embodiments, pivoting the first virtual object and the first portion of the one or more virtual objects about the first location in the three-dimensional environment includes using a pivot radius that extends from the viewpoint of the user to the first virtual object (e.g., the first pivot radius has one or more characteristic of the first pivot radius described below). Changing the spatial arrangement of content relative to the viewpoint of a user by pivoting the content about a location in the three-dimensional environment in response to user input from a first portion of a user and not a second portion of the user ensures that the intent of the user is to change the spatial arrangement of the content prior to changing the spatial arrangement of the content and provides the user discretion in choosing how to change the spatial arrangement of the content in the three-dimensional environment, thereby reducing errors in interaction and improving user device interaction.

In some embodiments, changing the spatial arrangement of the first virtual object relative to the first viewpoint of the first user in accordance with the first input includes, in accordance with a determination that the first input includes input from the first portion of the first user and the second portion of the first user, changing the spatial arrangement of the first virtual object relative to the first viewpoint of the first user includes pivoting the first virtual object and the first portion of the one or more virtual objects about a respective location in the three-dimensional environment, different from the first location, wherein in accordance with a determination that the first input is directed to the first virtual object, the respective location corresponds to a second location in the three-dimensional environment associated with the first virtual object in the three-dimensional environment, such as shown by the pivoting of virtual object 1006b and virtual representations 1014b-1014d about the location of affordance 1032 and/or virtual representation 1034 in response to the input that includes hand 1008a and hand 1008b as shown in FIG. 10S.

In some embodiments, in accordance with a determination that the first input is directed to a second virtual object of the one or more virtual objects, the respective location corresponds to a third location in the three-dimensional environment associated with the second virtual object in the three-dimensional environment, such as the location of virtual representation 1012c in three-dimensional environment 1002a shown in FIG. 10W. In some embodiments, the input from the first portion of the first user and the second portion of the first user corresponds to input provided by a first hand of the first user and a second hand of the first user. In some embodiments, the first portion and/or second portion of the first user performs an air gesture (e.g., including one or more characteristics of the one or more air gestures described above). For example, the first input includes, with the first portion of the first user, performing an air pinch, and with the second portion of the first user (e.g., while maintaining the air pinch with the first portion of the first user), performing hand movement (e.g., optionally independent of performing an air gesture with the second portion of the first user, or optionally while performing an air gesture with the second portion of the first user) relative to the three-dimensional environment. In some embodiments, the first computer system pivots the first virtual object and the first portion of the one or more virtual objects about the respective location in the three-dimensional environment in accordance with the hand movement performed by the second portion of the first user. In some embodiments, pivoting the first virtual object about the respective location in the three-dimensional environment includes using a pivot radius that extends from the respective location in the three-dimensional environment to a location in the three-dimensional environment corresponding to the first viewpoint of the first user (e.g., including one or more characteristics of the first location corresponding to the first viewpoint of the first user as described above). In some embodiments, pivoting the first virtual object and the first portion of the one or more virtual objects about the respective location in the three-dimensional environment includes maintaining a shared spatial arrangement between the first virtual object and the first portion of the one or more virtual objects (e.g., the first portion of the one or more virtual objects including a shared spatial arrangement relative to each other (e.g., including one or more characteristics of the shared spatial arrangement as described above)) while pivoting the first virtual object and the first portion of the one or more virtual objects about the respective location. In some embodiments, directing the first input to the first virtual object corresponds to attention directed to the first virtual object (e.g., through gaze (e.g., optionally for a threshold period of time (e.g., 0.1, 0.5, 1, 2, 5 or 10 second(s)))). In some embodiments, directing the first input to the second virtual object corresponds to attention directed to the second virtual object (e.g., through gaze (e.g., optionally for a threshold period of time (e.g., 0.1, 0.5, 1, 2, 5 or 10 second(s)))). In some embodiments, the second virtual object has one or more characteristics of the second virtual object displayed at the first location in response to attention directed to the first location as described above. In some embodiments, the second virtual object has one or more characteristics of the second virtual object displayed at the first location in response to attention directed to the first location as described above. In some embodiments, the third location corresponds to a region in the virtual environment with a predefined spatial relationship with the first virtual object (e.g., including one or more characteristics of the first location with the predefined spatial relationship with the first virtual object as described above). In some embodiments, in accordance with the determination that the first input including input from the first portion and the second portion of the first user is directed to the first virtual object, the first computer system changes the spatial arrangement of the first portion of the one or more virtual objects relative to the first viewpoint of the first user. Pivoting the first virtual object about a location associated with the first virtual object optionally includes changing the orientation of the first virtual object while receiving the first input and not changing the location of the first virtual object in the three-dimensional environment relative to the first viewpoint of the first user (e.g., changing the spatial arrangement of the first virtual object relative to the first viewpoint of the first user includes changing the orientation of the first virtual object relative to the first viewpoint of the first user and optionally does not include changing the distance of the first virtual object from the first viewpoint of the first user). In some embodiments, in accordance with the determination that the first input including input from the first portion and the second portion of the first user is directed to the first virtual object, the first computer system maintains the spatial arrangement (e.g., location and/or orientation) of the first virtual object relative to the first viewpoint of the first user while changing the spatial arrangement of the first portion of the one or more virtual objects about the first location relative to the first viewpoint of the first user. In some embodiments, in accordance with the determination that the first input including input from the first portion and the second portion of the first user is directed to the second virtual object, the first computer system changes the spatial arrangement of the first virtual object and the first portion of the one or more virtual objects relative to the first viewpoint of the first user. In some embodiments, the second virtual object is not included in the first portion of the one or more virtual objects and pivoting the second virtual object about a location associated with the second virtual object optionally includes changing the orientation of the second virtual object while receiving the first input and not changing the location of the second virtual object in the three-dimensional environment relative to the first viewpoint of the first user. In some embodiments, in accordance with the determination that the first input including input from the first portion and the second portion of the first user is directed to the second virtual object, the first computer system maintains the spatial arrangement (e.g., location and/or orientation) of the second virtual object relative to the first viewpoint of the first user while changing the spatial arrangement of the first virtual object and the first portion of the one or more virtual objects about the second location relative to the first viewpoint of the first user. Changing the spatial arrangement of content relative to the viewpoint of a user by pivoting the content about a first location in the three-dimensional environment in response to user input from a first portion of a user and a second portion of the user that is different from a second location in the three-dimensional environment that the content is pivoted about in response to user input from the first portion of the user and not the second portion of the user ensures that the intent of the user is to change the spatial arrangement of the content prior to changing the spatial arrangement of the content and provides the user discretion in choosing how to change the spatial arrangement of the content in the three-dimensional environment, thereby reducing errors in interaction and improving user device interaction.

In some embodiments, the first virtual object is a virtual object of the one or more virtual objects different from the one or more virtual representations of the one or more users and the first input is directed to the first virtual object, such as the input directed to virtual object 1006a shown in FIGS. 10A and 10A1. In some embodiments, the first virtual object is displayed concurrently with an element that is selectable to change the spatial arrangement of the first virtual object relative to the first viewpoint of the first user. In some embodiments, directing the first input to the first virtual object includes attention that is directed to the element displayed concurrently with the first virtual object. In some embodiments, the element is a part of the first virtual object. In some embodiments, the element is displayed as a rectangular bar (e.g., with rounded edges) directly below the first virtual object. In some embodiments, the element is not displayed with the one or more representations of the one or more users. In some embodiments, directing the first input to the first virtual object and/or the element selectable to change the spatial arrangement of the first virtual object includes directing gaze toward the first virtual object and/or the element while performing an air gesture (e.g., with a hand (e.g., or optionally two hands) of the first user (e.g., including an air pinch, long air pinch or air tap). Reducing the visual prominence of one or more virtual representations in a three-dimensional environment and changing the spatial arrangement of content relative to the viewpoint of a user in response to a user input that is directed to the content ensures that the intent of the user is to change the spatial arrangement of the content prior to changing the spatial arrangement of the content and reducing the visual prominence of the one or more virtual representations, thereby reducing errors in interaction and improving user device interaction.

In some embodiments, the first virtual object is a first virtual representation of the one or more virtual representations of the one or more users, and the first input is directed to the first virtual representation, such as the input directed to virtual representation 1012b shown in FIG. 10K. In some embodiments, directing the input to the first virtual representation includes directing gaze toward the first virtual representation while performing an air gesture (e.g., with a hand (e.g., or optionally two hands) of the first user (e.g., the air gesture includes an air tap, air pinch, air drag and/or air long pinch)). In some embodiments, while receiving the first input, the first virtual representation is displayed as a virtual representation of a first type (e.g., including one or more characteristics of a virtual representation of a first type as described with reference to method 900). In some embodiments, prior to receiving the first input, the first virtual representation is displayed as a virtual representation of a second type (e.g., including one or more characteristics of a virtual representation of the second type as described with reference to method 900). Reducing the visual prominence of one or more virtual representations in a three-dimensional environment and changing the spatial arrangement of a first virtual representation of the one or more virtual representations relative to the viewpoint of a user in response to a user input that is directed to the first virtual representation ensures that the intent of the user is to change the spatial arrangement of the first virtual representation prior to changing the spatial arrangement of the first virtual representation and reducing the visual prominence of the one or more virtual representations, thereby reducing errors in interaction and improving user device interaction.

In some embodiments, while receiving the first input, the first computer system displays a visual indication corresponding to the request to change the spatial arrangement of the first virtual object in the three-dimensional environment at a respective spatial arrangement relative to the first virtual object in the three-dimensional environment, such as visual indication 1026 displayed in three-dimensional environment 1002a in FIG. 10K. In some embodiments, the visual indication is a virtual shape (e.g., a dot or a circle) displayed in the three-dimensional environment. In some embodiments, the visual indication is displayed with a visual appearance that contrasts (e.g., is displayed with different color and/or brightness than) the three-dimensional environment (e.g., the visual indication is visible from the first viewpoint of the first user (e.g., when the three-dimensional environment is displayed with the first visual appearance and/or the second visual appearance as described above). In some embodiments, the respective spatial arrangement of the visual indication is adjacent to the first virtual object. In some embodiments, the respective spatial arrangement of the visual indication is below the first virtual object relative to the first viewpoint of the first user. In some embodiments, the respective spatial arrangement of the visual indication is above the first virtual object relative to the first viewpoint of the first user. In some embodiments, in accordance with a determination that the first virtual object is not a virtual representation of the one or more virtual representations and the first input is directed to the first virtual object, the visual indication is not displayed in the three-dimensional environment. In some embodiments, in accordance with a determination that the first input does not include directed attention to the first virtual object, the visual indication is not displayed in the three-dimensional environment. Displaying a visual indication in a three-dimensional environment relative to a virtual representation that a user has requested to change the spatial arrangement of relative to their viewpoint provides visual feedback that the request to change the spatial arrangement was received and provides the user the opportunity to confirm their intent prior to changing the spatial arrangement of the virtual representation, thereby reducing errors in interaction and improving user device interaction.

In some embodiments, the visual indication is displayed on a surface that is visible in the three-dimensional environment below the first virtual object relative to the first viewpoint of the first user, such as the surface that is visible in three-dimensional environment 1002a that visual indication 1026 is displayed on in FIG. 10K. In some embodiments, the surface is a physical surface from the first user's physical environment that is visible from the first viewpoint of the first user as passthrough of the first user's physical environment. In some embodiments, the surface is a representation of the physical surface from the first user's physical environment visible from the first viewpoint of the first user in the three-dimensional environment. In some embodiments, the surface is a virtual surface that is displayed by the first computer system in the three-dimensional environment. In some embodiments, the surface is (e.g., or is a virtual representation of) is a floor and/or ground visible from the first viewpoint of the first user below the first virtual object. In some embodiments, the surface is a flat surface, and the visual indication is displayed on the flat surface (e.g., on a top side of the flat surface relative to the first viewpoint of the first user). In some embodiments, the location of the visual indication on the surface is based on the location of the first virtual object in the three-dimensional environment. For example, the visual indication is displayed at a longitudinal position in the three-dimensional environment that corresponds to a longitudinal center of the first virtual object (e.g., the visual indication is displayed aligned with the center of the first virtual object and at a location below the first virtual object). Displaying a visual indication on a surface that is visible in a three-dimensional environment in response to a user input corresponding to a request to change the spatial arrangement of a virtual representation relative to a viewpoint of a user provides visual feedback that the request to change the spatial arrangement was received, provides the user an opportunity to confirm their intent prior to changing the spatial arrangement of the virtual representations, and conserves available display space in the three-dimensional environment by displaying the visual indication on an already visible surface, thereby reducing errors in interaction and improving user device interaction.

In some embodiments, while receiving the first input corresponding to the request to change the spatial arrangement of the first virtual object in the three-dimensional environment, the first computer system forgoes displaying a visual indication corresponding to a request to change a spatial arrangement of a virtual object in the three-dimensional environment at the respective spatial arrangement relative one or more virtual representations of the one or more users different from the first virtual representation, such as visual indication 1026 being displayed relative to virtual representation 1012b and not relative to virtual representation 1012c in FIG. 10K. In some embodiments, a different type of visual indication (e.g., including one or more different visual characteristics such as color, size, shape and/or brightness) from the visual indication displayed at the respective spatial arrangement relative to the first virtual representation is not displayed with the one or more virtual representations different from the first virtual representation. For example, in response to and/or while receiving the first input, the first computer system forgoes displaying one or more virtual objects (e.g., visual indications and/or virtual elements) with the one or more virtual representations different from the first virtual representation that were not previously displayed in the three-dimensional environment prior to receiving the first input. Displaying a visual indication in a three-dimensional environment relative to a first virtual representation and not relative to one or more virtual representations different from the first virtual representation in response to a user input corresponding to a request to change the spatial arrangement of the first virtual representation relative to a viewpoint of a user provides visual feedback that the request to change the spatial arrangement was received, provides visual feedback of the virtual representation that the request to change the spatial arrangement was directed to, and provides the user an opportunity to confirm their intent prior to changing the spatial arrangement of the first virtual representation, thereby reducing errors in interaction and improving user device interaction.

In some embodiments, while displaying the three-dimensional environment from the first viewpoint of the first user, the first computer system receives, via the one or more input devices, a second input corresponding to a request to change the spatial arrangement of the first virtual object of the one or more virtual objects relative to the first viewpoint of the first user in the three-dimensional environment, such as the input provided by first user 1042a in FIG. 10K. In some embodiments, the second input has one or more characteristics of the first input (e.g., as described above).

In some embodiments, in response to detecting the second input, in accordance with a determination that the first virtual object is a virtual representation of the one or more virtual representations of the one or more users and the second input satisfies one or more first criteria, including a criterion that is satisfied when the first input includes a first air gesture, the first computer system changes the spatial arrangement of the first virtual object relative to the first viewpoint of the first user in accordance with the second input, such as shown by the change in spatial arrangement of virtual representation 1012b shown in FIGS. 10K-10P. In some embodiments, changing the spatial arrangement of the first virtual object relative to the first viewpoint of the first user in accordance with the second input includes one or more characteristics of changing the spatial arrangement of the first virtual object relative to the first viewpoint of the first user in accordance with the first input as described above. In some embodiments, the first air gesture is an air pinch, long air pinch (e.g., an air pinch that exceeds a threshold period of time (e.g., 0.1, 0.5, 1, 2, 5 or 10 seconds), air tap and/or air drag.

In some embodiments, in accordance with a determination that the first virtual object is shared content with the one or more computer systems in the communication session and is not a virtual representation of a user and the first input satisfies the one or more first criteria, the first computer system forgoes changing the spatial arrangement of the first virtual object relative to the first viewpoint of the first user in accordance with the second input (e.g., such as first user 1042a directing the input shown in FIG. 10S with hands 1008a and 1008b to virtual object 1006a shown in FIGS. 10A and 10A1). In some embodiments, the first computer system forgoes changing the spatial arrangement of the first virtual object relative to the first viewpoint of the first user (e.g., the first computer system does not change the spatial arrangement of the first virtual object by an amount (e.g., distance, magnitude, change in orientation and/or speed) that is not based on the second input).

In some embodiments, in accordance with a determination that the first virtual object is shared content with the one or more computer systems in the communication session and is not a virtual representation of a user and the first input satisfies one or more second criteria, different from the one or more first criteria, including a criterion that is satisfied when the first input includes a second air gesture, different from the first air gesture, the first computer system changes the spatial arrangement of the first virtual object relative to the first viewpoint of the first user in accordance with the second input, such as shown by the input performed by first user 1042a in FIGS. 10A and 10A1 and the change in spatial arrangement of virtual object 1006a in FIGS. 10D-10F. In some embodiments, the second air gesture is an air pinch, long air pinch (e.g., an air pinch that exceeds at threshold period of time (e.g., 0.1, 0.5, 1, 2, 5 or 10 seconds), air tap and/or air drag. In some embodiments, the first air gesture is an air pinch that does not exceed a threshold period of time (e.g., 0.1, 0.5, 1, 2, 5 or 10 seconds) and the second air gesture is an air pinch that exceeds the threshold period of time. In some embodiments, the first air gesture is an air pinch that does exceed the threshold period of time and the second air gesture is an air pinch that does not exceed the threshold period of time. In some embodiments, the first air gesture does not include movement (e.g., or movement below a threshold amount relative to the three-dimensional environment), and the second air gesture includes movement (e.g., movement above a threshold amount relative to the three-dimensional environment). In some embodiments, the first air gesture includes movement (e.g., movement above a threshold amount relative to the three-dimensional environment), and the second air gesture does not include movement (e.g., or movement below a threshold amount relative to the three-dimensional environment).

In some embodiments, in accordance with a determination that the first virtual object is a virtual representation of the one or more virtual representations of the one or more users and the first input satisfies the one or more second criteria, the first computer system forgoes changing the spatial arrangement of the first virtual object relative to the first viewpoint of the user in accordance with the second input (e.g., such as first user 1042a directing the input shown in FIGS. 10A and 10A1 with hand 1008a to virtual representation 1012c shown in FIG. 10R). In some embodiments, the first computer system forgoes changing the spatial arrangement of the first virtual object relative to the first viewpoint of the first user (e.g., the first computer system does not change the spatial arrangement of the first virtual object by an amount (e.g., a distance, magnitude, change in orientation and/or speed) that is not based on the second input. Changing a spatial arrangement of content in a three-dimensional environment in accordance with a user input that includes a first air gesture, and changing a spatial arrangement of a virtual representation different from the content in the three-dimensional environment in accordance with a user input that includes a second air gesture different from the first air gesture ensures that the intent of the user is to change the spatial arrangement of the content or the virtual representation, thereby reducing errors in interaction and improving user device interaction.

In some embodiments, changing the spatial arrangement of the first virtual object includes, in accordance with a determination that the first input is directed to a respective virtual representation of the one or more virtual representations of the one or more users, pivoting the first virtual object and a first portion of the one or more virtual objects that is shared with the one or more computer systems in the communication session about a first location in the three-dimensional environment corresponding to the first viewpoint of the first user using a first pivot radius that extends from the first viewpoint of the user to the respective virtual representation, such as with the pivot radius shown while pivoting virtual representations 1014b and 1014c and virtual object 1006a in FIGS. 10L-10N. In some embodiments, directing the first input to the respective virtual representation includes attention (e.g., from the first user) directed to the respective virtual representation (e.g., through gaze) while concurrently performing an air gesture (e.g., including one or more characteristics of the first air gesture and/or second air gesture described above). In some embodiments, the first pivot radius has a value relative to the three-dimensional environment based on a distance of the respective virtual representation from the first viewpoint of the first user in the three-dimensional environment. For example, if the respective virtual representation is a first distance from the first viewpoint of the first user in the three-dimensional environment the first pivot radius includes a first value based on the first distance, and if the respective virtual representation is a second distance, different from the first distance, from the first viewpoint of the first user in the three-dimensional environment, the first pivot radius includes a second value, different from the first value, based on the second distance.

In some embodiments, in accordance with a determination that the first input is directed to a respective virtual object of the one or more virtual objects, different from the one or more virtual representations of the one or more users, that is shared with the one or more computer systems in the communication session, the first computer system pivots the first virtual object and the first portion of the one or more virtual objects that is shared with the one or more computer systems in the communication session about the first location using a second pivot radius that extends from the first viewpoint of the user to the respective virtual object, such as with the pivot radius shown while pivoting virtual representations 1014b and 1014c and virtual object 1006a in FIGS. 10E-10F. In some embodiments, pivoting the first virtual object and the first portion of the one or more virtual objects about the first location using the first pivot radius includes moving the first portion of the one or more virtual objects along a curved paths of movement that correspond to a curved path of movement of the first virtual object. In some embodiments, pivoting the first virtual object and the first portion of the one or more virtual objects using the second pivot radius includes moving the first virtual object and the first portion of the one or more virtual objects along curved paths of movement that correspond to a curved path of movement of the respective virtual object (e.g., the curved path of movement of the respective virtual object is different from a curved path of movement of the first virtual object due to the difference in length of the first pivot radius (e.g., corresponding to a distance of the first virtual object from the first viewpoint of the first user) compared to the second pivot radius (e.g., corresponding to a distance of the second virtual object from the first viewpoint of the first user)). In some embodiments, directing the first input to the respective virtual object includes attention (e.g., from the first user) directed to the respective virtual object (e.g., through gaze) while concurrently performing an air gesture (e.g., including one or more characteristics of the first air gesture and/or second air gesture described above). In some embodiments, the second pivot radius has a value relative to the three-dimensional environment based on a distance of the respective virtual object from the first viewpoint of the first user in the three-dimensional environment (e.g., as described above with reference to the first pivot radius). In some embodiments, the second pivot radius is different from the first pivot radius (e.g., based on a difference in distance of the respective virtual representation and the respective virtual object from the first viewpoint of the first user). In some embodiments, in accordance with a determination that the first input is directed to the respective virtual object (e.g., the first virtual object) and the respective virtual object is not shared with the one or more computer systems in the communication session, the first computer system forgoes pivoting the first virtual object and the first portion of the one or more virtual objects about the first location. In some embodiments, changing the spatial arrangement of the first virtual object does not include pivoting the first virtual object and/or the first portion of the one or more virtual objects about the first location in the three-dimensional environment in accordance with a determination that the first input is directed to the first virtual object and the first virtual object is not shared with the one or more computer systems. Pivoting one or more objects about a location of a viewpoint of a user using a pivot radius that extends to a first object in accordance with a user input being directed to the first object, and pivoting the one or more objects about the location of the user using a pivot radius that extends to a second object in accordance with the user input being directed to the second object provides different visual feedback depending on the object that the user input is directed to, and provides motion of the one or more objects in the three-dimensional environment that is controllable based on the user input, thereby minimizing the risk of motion sickness to the user, reducing errors in interaction and improving user device interaction.

In some embodiments, while receiving the first input, in accordance with a determination that the first virtual object is a virtual representation of the one or more virtual representations of the one or more users, the first computer system displays a boundary around the one or more virtual representations of the one or more users in the three-dimensional environment, such as boundary 1022 shown in FIG. 10S. In some embodiments, displaying the boundary around the one or more virtual representations includes one or more characteristics of displaying the boundary around the at least the first portion of the one or more virtual objects as described above.

In some embodiments, in accordance with a determination that a spatial distribution of one or more locations in the three-dimensional environment corresponding to one or more current viewpoints of the one or more users in the three-dimensional environment is a first spatial distribution, the boundary has a first size, such as the size of boundary 1022 displayed in three-dimensional environment 1002a in FIG. 10T. In some embodiments, in accordance with a determination that the spatial distribution of the one or more locations in the three-dimensional environment corresponding to the one or more current viewpoints of the one or more users in the three-dimensional environment is a second spatial distribution, different from the first spatial distribution, the boundary has a second size different from the first size, such as the size of boundary 1022 displayed in three-dimensional environment 1002a in FIG. 10W. In some embodiments, the boundary has a size that is based on the one or more locations of the one or more current viewpoints of the one or more users in the three-dimensional environment (e.g., the locations of the one or more current viewpoints of the one or more users are included within the boundary (e.g., are arranged inside the perimeter of the boundary)). For example, the second size of the boundary is different from the first size of the boundary because the one or more locations of the one or more current viewpoints of the one or more users in the three-dimensional environment are different (e.g., and the boundary is a different size and/or shape because of the differences in the one or more locations of the one or more current viewpoints of the one or more users in the three-dimensional environment). In some embodiments, the spatial distribution of the one or more locations in the three-dimensional environment corresponding to the one or more current viewpoints of the one or more users in the three-dimensional environment corresponds to a spatial distribution of the one or more virtual representations of the one or more users displayed in the three-dimensional environment. In some embodiments, the spatial distribution (e.g., and thus the size of the boundary) changes based on movement of the one or more current viewpoints of the one or more users in the three-dimensional environment (e.g., movement of a respective viewpoint of a respective user causes movement of a respective virtual representation of the respective user in the three-dimensional environment (e.g., causing a change in the spatial distribution of the one or more virtual representations in the three-dimensional environment)). In some embodiments, the one or more virtual representations are arranged in one or more locations in the three-dimensional environment corresponding to one or more available viewpoints associated with the three-dimensional environment. For example, the three-dimensional environment includes a plurality of available viewpoints for viewing one or more virtual objects shared in the communication session from. In some embodiments, the location of the one or more available viewpoints in the three-dimensional environment is based on the one or more virtual objects that are shared in the communication session (e.g., a first respective virtual object that is shared in the communication session is associated with one or more available viewpoints at one or more first locations in the three-dimensional environment, and a second respective virtual object that is shared in the communication session is associated with one or more available viewpoints at one or more second locations in the three-dimensional environment different from the one or more first locations). In some embodiments, the size of the boundary corresponds to the spatial distribution of the one or more available viewpoints in the three-dimensional environment. Displaying a boundary around one or more virtual representations in a three-dimensional environment with a size based on a spatial distribution of one or more viewpoints of one or more users while changing the spatial arrangement of a first virtual representation of the one or more virtual representations relative to a viewpoint of a first user provides visual feedback that the change in spatial arrangement of the first virtual representation is initiated, ensures that the one or more virtual representations are displayed within the boundary (e.g., because the one or more virtual representations represent the locations of the one or more viewpoints of the one or more users), informs the first user of the one or more virtual representations that will change spatial arrangement relative to the viewpoint of the first user, and synchronizes motion of the one or more virtual representations displayed within the boundary during the change of the spatial arrangement of the first virtual representation, thereby minimizing the risk of motion sickness to the user, reducing errors in interaction and improving user device interaction.

In some embodiments, the first virtual object is a virtual representation of a second user of a second computer system of the one or more computer systems, such as virtual representation 1014c displayed in three-dimensional environment 1002a in FIG. 10M. In some embodiments, while receiving the first input, the first computer system receives information from the second computer system corresponding to an updated pose of a current viewpoint of the second user relative to the three-dimensional environment (e.g., corresponding to the change in spatial arrangement of the current viewpoint of third user 1042c shown in FIG. 10N). In some embodiments, receiving the information from the second computer system includes one or more characteristics of receiving an indication from a second computer system corresponding to a pose of a current viewpoint of a user relative to the three-dimensional environment as described with reference to methods 800 and/or 900. In some embodiments, the first virtual object is displayed at a location and/or orientation in the three-dimensional environment corresponding to a first pose of the current viewpoint of the second user prior to receiving the first input, and the updated pose corresponds to a second pose of the current viewpoint of the second user different from the first pose of the current viewpoint of the second user.

In some embodiments, in response to receiving the information from the second computer system, the first computer system changes the spatial arrangement of the first virtual object relative to the first viewpoint of the first user in accordance with the first input and in accordance with the received information from the second computer system, such as shown by the change in spatial arrangement of virtual representation 1014c in FIG. 10O in accordance with the change in spatial arrangement of the current viewpoint of third user 1042c. In some embodiments, changing the spatial arrangement of the first virtual object in accordance with the received information from the second computer system corresponds to changing the display of the first virtual object to a location and/or orientation in the three-dimensional environment corresponding to the second pose of the current viewpoint of the second user different from the first pose of the current viewpoint of the second user. Changing the spatial arrangement of the first virtual object relative to the first viewpoint of the first user in accordance with the received information optionally includes changing a location and/or orientation of the first virtual object while concurrently pivoting the first virtual object about a location in the three-dimensional environment corresponding to the first viewpoint of the first user. In some embodiments, while receiving the first input, the first computer system receives information from a third computer system corresponding to an updated pose of a current viewpoint of a third user relative to the three-dimensional environment, and in response to receiving the information from the third computer system, the first computer system changes the spatial arrangement of the first virtual object relative to the first viewpoint of the first user in accordance with the first input and changes a spatial arrangement of a virtual representation of the third user relative to the first viewpoint of the first user in accordance with the received information from the third computer system. For example, changing the spatial arrangement of the virtual representation of the third user relative to the first viewpoint of the first user includes changing a location and/or orientation of the virtual representation of the third user relative to the first viewpoint of the first user while concurrently changing the spatial arrangement of the first virtual object relative to the first viewpoint of the first user. Changing the spatial arrangement of, from the first viewpoint of a first user, a virtual representation of a second viewpoint of a second user in a three-dimensional environment in accordance with a user input provided by the first user and a change in pose of the second viewpoint of the second user relative to the three-dimensional environment provides visual feedback of an updated viewpoint of the second user to the first user while the first user is changing the spatial arrangement of the virtual representation of the second viewpoint and provides the first user an opportunity to reconsider the requested change in spatial arrangement of the virtual representation based on the updated viewpoint of the second user while providing the user input, thereby improving user device interaction.

In some embodiments, the first virtual object is a virtual representation of a second user of a second computer system of the one or more computer systems, such as virtual representation 1014c displayed in three-dimensional environment 1002a in FIG. 10M. In some embodiments, while receiving the first input, the first computer system changes the spatial arrangement of the first virtual object relative to the first viewpoint of the first user in accordance with the first input and not in accordance with information corresponding to an updated pose of a current viewpoint of the second user relative to the three-dimensional environment (e.g., corresponding to the change in spatial arrangement of the current viewpoint of third user 1042c shown in FIG. 10N). In some embodiments, information corresponding to an updated pose of a current viewpoint of the second user relative to the three-dimensional environment is received from the second computer system. In some embodiments, receiving the information from the second computer system includes one or more characteristics of receiving the information from the second computer system as described above. In some embodiments, the information corresponding to the updated pose of the current viewpoint of the second user is received from the second computer system while the first computer system is receiving the first input (e.g., while the first computer system is changing the spatial arrangement of the first virtual object relative to the first viewpoint of the first user in accordance with the first input). In some embodiments, the information corresponding to the updated pose of the current viewpoint of the second user is received from the second computer system after the first computer system receives the first input (e.g., after the first computer system changes the spatial arrangement of the first virtual object relative to the first viewpoint of the first user in accordance with the first input). In some embodiments, the updated pose of the current viewpoint of the second user has one or more characteristics of the updated pose of the current viewpoint of the second user as described above. In some embodiments, changing the spatial arrangement of the first virtual object relative to the first viewpoint of the first user in accordance with the first input and not in accordance with the received information from the second computer system includes one or more characteristics of changing the spatial arrangement of the first virtual object relative to the first viewpoint of the first user in accordance with the first input as described with reference to step(s) 1102 (e.g., while the one or more virtual representations of the one or more users have the reduced visual prominence relative to the three-dimensional environment).

In some embodiments, after receiving the first input, the first computer system changes the spatial arrangement of the first virtual object relative to the first viewpoint of the first user in accordance with the information corresponding to the updated pose of the current viewpoint of the second user relative to the three-dimensional environment, such as shown by the change in spatial arrangement of virtual representation 1012c in FIG. 10P in accordance with the change in spatial arrangement of the current viewpoint of third user 1042c in FIG. 10N. In some embodiments, in accordance with the first computer receiving the information from the second computer system corresponding to the updated pose of the current viewpoint of the second user while the first computer system is receiving the first input (e.g., while the first computer system is changing the spatial arrangement of the first virtual object relative to the first viewpoint of the first user in accordance with the first input), the first computer system forgoes changing the spatial arrangement of the first virtual object relative to the first viewpoint of the first user in accordance with the received information from the second computer system while changing the spatial arrangement of the first virtual object in accordance with the first input (e.g., the first computer system changes the spatial arrangement of the first virtual object relative to the first viewpoint of the first user in accordance with the received information from the second computer system after the spatial arrangement of the first virtual object is changed relative to the first viewpoint of the first user in accordance with the first input). In some embodiments, in accordance with the first computer system receiving the information from the second computer system corresponding to the updated pose of the current viewpoint of the second user after or before the first computer system receives the first input, or more generally while the first computer system is not receiving an input to change a spatial arrangement of the one or more virtual objects (e.g., after the first computer system changes the spatial arrangement of the first virtual object relative to the first viewpoint of the first user in accordance with the first input), the first computer system changes the spatial arrangement of the first virtual object relative to the first viewpoint of the first user in accordance with the received information from the second computer system (e.g., without delaying such a change). In some embodiments, the first computer system does not change the spatial arrangement of the first virtual object in response to receiving the information from the second computer system (e.g., the first computer system changes the spatial arrangement of the first virtual object in response to detecting termination of the first input). In some embodiments, changing the spatial arrangement of the first virtual object in accordance with the received information from the second computer system corresponds to changing a location and/or orientation of the first virtual object in the three-dimensional environment to a location and/or orientation corresponding to the updated pose of the current viewpoint of the second user. In some embodiments, changing the spatial arrangement of the first virtual object relative to the first viewpoint of the first user in accordance with the received information after the first input is received includes changing the spatial arrangement of the first virtual object after the first computer system has ceased changing the spatial arrangement of the first virtual object in accordance with the first input. In some embodiments, while receiving the first input, the first computer system receives information from a third computer system corresponding to an updated pose of a current viewpoint of a third user relative to the three-dimensional environment, and in response to receiving the information from the third computer system, after receiving the first input, the first computer system changes the spatial arrangement of a virtual representation of the third user relative to the first viewpoint of the first user in accordance with the received information from the third computer system. For example, changing the spatial arrangement of the virtual representation of the third user relative to the first viewpoint of the first user does not include changing a location and/or orientation of the virtual representation of the third user relative to the first viewpoint of the first user while concurrently changing the spatial arrangement of the first virtual object relative to the first viewpoint of the first user. In some embodiments, changing the spatial arrangement of the first virtual object relative to the first viewpoint of the first user in accordance with the updated pose of the current viewpoint of the second user includes displaying a representation of movement of the first virtual object in the three-dimensional environment based on what type of virtual representation the virtual representation of the second user is (e.g., the first computer system displays a first representation of movement of the virtual representation of the second user in accordance with the virtual representation of the second user being a virtual representation of the first type (e.g., as described with reference to method 900) and/or displays a second representation of movement of the virtual representation of the second user in accordance with the virtual representation of the second user being a virtual representation of the second type (e.g., as described with reference to method 900)). Changing the spatial arrangement of, from a first viewpoint of a first user, a virtual representation of a second viewpoint of a second user in a three-dimensional environment based on a change in pose of the second viewpoint of the second user relative to the three-dimensional environment after receiving a user input corresponding to a request to change the spatial arrangement of the virtual representation from the viewpoint of the first user reduces the amount of prominent motion of the virtual representation in the three-dimensional environment while changing the spatial arrangement of the virtual representation in accordance with the user input, thereby minimizing the risk of motion sickness to the first user and improving user device interaction.

It should be understood that the particular order in which the operations in method 1100 have been described is merely exemplary and is not intended to indicate that the described order is the only order in which the operations could be performed. One of ordinary skill in the art would recognize various ways to reorder the operations described herein.

FIG. 12 is a flowchart illustrating an exemplary method 1200 of displaying different visual feedback while moving a virtual object in accordance with the virtual object being shared or not shared in a communication session in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at a first computer system in communication with a display generation component and one or more input devices. In some embodiments, the first computer system has one or more of the characteristics of the computer system(s) described with reference to methods 800, 900 and/or 1100. In some embodiments, the input device(s) has one or more of the characteristics of the input device(s) described with reference to methods 800, 900 and/or 1100. In some embodiments, the display generation component has one or more of the characteristics of the display generation component described with reference to methods 800, 900 and/or 1100. In some embodiments, the second computer system includes one or more characteristics of the first computer system (e.g., and is in communication with a display generation component and one or more input devices including one or more characteristics of the display generation component and the one or more input devices described with reference to the first computer system).

In some embodiments, while in a communication session with one or more computer systems other than the first computer system (1202a) (e.g., the one or more computer systems are in communication with one or more respective display generation components and one or more respective input devices), the first computer system displays (1202b), via the display generation component, a three-dimensional environment including a first virtual object (e.g., including one or more characteristics of the first virtual object described with reference to method 1100), such as three-dimensional environment 1002a shown in FIGS. 10A and 10A1 including virtual object 1006a and virtual object 1004. In some embodiments, the three-dimensional environment includes one or more characteristics of three-dimensional and/or virtual environments described with reference to method 800, 900 and/or 1100. In some embodiments, the communication session includes one or more characteristics of the communication described with reference to method 800, 900 and/or 1100. In some embodiments, the first virtual object includes one or more characteristics of the one or more virtual (e.g., the first virtual object) described with reference to method 1100.

In some embodiments, while displaying the three-dimensional environment including the first virtual object at a first location relative to a first viewpoint of a first user of the first computer system, the first computer system detects (1202c), via the one or more input devices, a first input corresponding to a request to move the first virtual object from the first location to a second location, different from the first location, relative to the first viewpoint of the user in the three-dimensional environment, such as the first input provided by first user 1042a in FIGS. 10A and 10A1. In some embodiments, displaying the first virtual object from the first viewpoint of the first user includes displaying the first virtual object in a location in the three-dimensional environment that is visible to the first user (e.g., within the user's field of view of the three-dimensional environment from the first viewpoint). In some embodiments, the first input corresponding to a request to move the first virtual object from the first location to a second location relative to the first viewpoint of the user in the three-dimensional environment includes one or more characteristics of the first input corresponding to a request to change the spatial arrangement of the first virtual object described with reference to method 1100. For example, the first input includes attention directed (e.g., through gaze) to the first virtual object at the first location in the three-dimensional environment and performing a hand air gesture and/or hand movement (e.g., moving a hand in an air pinch shape, while gaze is optionally directed to the first virtual object, toward the second location in the three-dimensional environment). In some embodiments, the first input includes attention directed by the first user (e.g., and optionally the hand gesture and/or hand movement) to a location in the three-dimensional environment different from the first location (e.g., to a virtual object different from the first virtual object, a virtual representation of a user in the communication session, and/or an affordance associated with the first virtual object displayed in the three-dimensional environment).

In some embodiments, while (optionally in response to) detecting the first input (e.g., while the first user performs the hand gesture and/or movement), in accordance with a determination that that the first virtual object is shared with the one or more computer systems in the communication session, the first computer system displays (1202d) first visual feedback in the three-dimensional environment while moving the first virtual object from the first location to the second location relative to the first viewpoint of the first user in the three-dimensional environment (e.g., while moving the first virtual object in accordance with the first input, such as moving the first virtual object with a direction based on a direction of the first input, moving the first virtual object by an amount based on an amount of the first input, and/or moving the first virtual object with a speed based on a speed of the first input), such as the visual feedback displayed in three-dimensional environment 1002a when changing the spatial arrangement of virtual object 1006a in FIGS. 10B-10G. In some embodiments, the first virtual object includes one or more characteristics of the one or more virtual objects (e.g., including the first virtual object) as described with reference to method 1100. For example, the first virtual object is visible to one or more users of the one or more computer systems in the communication session with the first computer system. In some embodiments, displaying first visual feedback in the three-dimensional environment includes one or more characteristics of reducing the visual prominence of one or more virtual representations (e.g., representing the one or more users of the one or more computer systems) displayed by the first computer system in the three-dimensional environment as described with reference to method 1100. For example, displaying the first visual feedback includes changing the display of the one or more virtual representations from one or more virtual representations of the second type (e.g., including one or more characteristics of the one or more virtual representations of the second type described with reference to method 900) to one or more virtual representations of the first type (e.g., including one or more characteristics of the one or more virtual representations of the first type described with reference to method 900). In some embodiments, displaying the first visual feedback in the three-dimensional environment includes reducing the visual prominence of the three-dimensional environment relative to the first viewpoint of the first user (e.g., reducing the brightness, opacity, sharpness and/or color saturation of the three-dimensional environment (e.g., and optionally of one or more virtual objects, such as the first virtual object, displayed in the three-dimensional environment). In some embodiments, displaying the first visual feedback in the three-dimensional environment while moving the first virtual object includes displaying a virtual boundary in the three-dimensional environment surrounding the first virtual object (e.g., and optionally one or more virtual representations displayed in the three-dimensional environment) as described with reference to method 1100. In some embodiments, displaying the first visual feedback in the three-dimensional environment includes moving the one or more virtual representations (e.g., and optionally one or more virtual objects different from the first virtual object) concurrently with the first virtual object in the three-dimensional environment relative to the viewpoint of the user of the first computer system (e.g., as described with reference to method 1100). In some embodiments, the one or more computer systems optionally do not display the first visual feedback in the three-dimensional environment from the one or more viewpoints of the one or more users in response to the first input detected by the first computer system. In some embodiments, displaying the first visual feedback includes pivoting or rotating the first virtual object (e.g., and optionally one or more virtual representations and/or one or more virtual object different from the first virtual object displayed in the three-dimensional environment) about an axis normal to a ground plane at the location of the first viewpoint of the user relative to the three-dimensional environment. For example, pivoting or rotating the first virtual object (e.g., and optionally one or more virtual representations and/or one or more virtual objects different from the first virtual object displayed in the three-dimensional environment) about the axis includes using a radius of rotation to the axis that extends to the location in the three-dimensional environment that the first input was directed to (e.g., the location of the first virtual object, the location of an affordance associated with the first virtual object, or a location of a virtual representation or a virtual object different from the first virtual object displayed in the three-dimensional environment). In some embodiments, in response to receiving the first input, the first computer system moves the current viewpoint of the first user relative to the shared three-dimensional environment and maintains the first virtual object at the first location in the three-dimensional environment. In some embodiments, while the first computer system displays the first visual feedback, the one or more computer systems in communication with the first computer system move the location of a virtual representation representing the current viewpoint of the first user (e.g., relative to one or more viewpoints of one or more users of the one or more computer systems) and maintains the display of the first virtual object at the first location in the shared three-dimensional environment. In some embodiments, when the first computer system ceases detection of the first input (e.g., when the first user ceases performing the hand air gesture/movement associated with the first input), the first visual feedback is no longer displayed in the three-dimensional environment (e.g., the first visual feedback is no longer displayed in the three-dimensional environment when movement of the first virtual object to the second location relative to the first viewpoint of the first user in the three-dimensional environment is completed).

In some embodiments, in accordance with a determination that the first virtual object is not shared with the one or more computer systems in the communication session (e.g., the first virtual object is private to the user of the first computer system), the first computer system displays (1202e) second visual feedback, different from the first visual feedback, in the three-dimensional environment while moving the first virtual object from the first location to the second location relative to the first viewpoint of the first user in the three-dimensional environment (e.g., while moving the first virtual object in accordance with the first input, such as moving the first virtual object with a direction based on a direction of the first input, moving the first virtual object by an amount based on an amount of the first input, and/or moving the first virtual object with a speed based on a speed of the first input), such as the visual feedback displayed while changing the spatial arrangement of virtual object 1004 in FIGS. 10H-10J. In some embodiments, the first virtual object is not displayed in the three-dimensional environment by the one or more computer systems (e.g., from one or more viewpoints of the one or more users). In some embodiments, displaying the second visual feedback in the three-dimensional environment while moving the first virtual object includes maintaining (e.g., does not include reducing) the visual prominence of the first virtual object (e.g., and optionally of one or more virtual representations and/or one or more virtual objects different from the first virtual object) in the three-dimensional environment from the first viewpoint of the first user. In some embodiments, displaying the second visual feedback in the three-dimensional environment while moving the first virtual object includes maintaining (e.g., does not include reducing) the visual prominence of the three-dimensional environment. In some embodiments, displaying the second visual feedback while moving the first virtual object includes displaying movement of the first virtual object in the three-dimensional environment and not displaying movement of one or more virtual representations and/or one or more virtual objects different from the first virtual object displayed in the three-dimensional environment. In some embodiments, displaying the second visual feedback while moving the first virtual objects includes maintaining (e.g., does not include changing) the display of one or more virtual representations (e.g., of one or more users of the one or more computer systems) from one or more virtual representations of the second type to the one or more virtual representations of the first type. In some embodiments, in response to receiving the first input, the first computer system changes the location and/or orientation of the first virtual object relative to the three-dimensional environment and maintains the first viewpoint of the user relative to the three-dimensional environment. In some embodiments, the one or more computer systems optionally do not display the second visual feedback in the three-dimensional environment (e.g., from the one or more viewpoints of the one or more users) in response to the first input detected by the first computer system. In some embodiments, when the first computer system ceases detection of the first input (e.g., when the first user ceases performing the hand air gesture/movement associated with the first input), the second visual feedback is no longer displayed in the three-dimensional environment (e.g., the second visual feedback is no longer displayed in the three-dimensional environment when movement of the first virtual object to the second location relative to the first viewpoint of the first user in the three-dimensional environment is completed). Providing different visual feedback in response to a request to move a virtual object in a three-dimensional environment based on whether the virtual object is shared or not shared in a communication session provides feedback to a user of a respective computer system in the communication session regarding whether the virtual object that the user requests to move is shared or not shared in the communication session, thereby avoiding errors in interaction and improving user device interaction.

In some embodiments, displaying the first visual feedback in the three-dimensional environment includes changing a visual appearance of the three-dimensional environment outside of the first virtual object (e.g., such as the change in appearance of portion 1010 of three-dimensional environment 1002a in FIG. 10B) and displaying the second visual feedback in the three-dimensional environment does not include changing the visual appearance of the three-dimensional environment outside of the first virtual object, such as computer system 101a not displaying the changed appearance of three-dimensional environment 1002a (e.g., as shown in FIG. 10B) in FIG. 10H. In some embodiments, changing the visual appearance of the three-dimensional environment outside of the first virtual object includes one or more characteristics of displaying the three-dimensional environment with the second visual appearance from the first viewpoint of the first user as described with reference to method 1100. For example, displaying the first visual feedback in the three-dimensional environment includes displaying the three-dimensional environment (e.g., and one or more objects (e.g., optionally different from the first virtual object) visible in the three-dimensional environment with a darker appearance compared to displaying the second visual feedback. In some embodiments, displaying the second visual feedback includes displaying the three-dimensional environment (e.g., and the one or more objects visible in the three-dimensional environment) with one or more colors not associated with displaying the first visual feedback, and/or displaying the three-dimensional environment with a greater saturation compared to displaying the first visual feedback. In some embodiments, displaying the first visual feedback in the three-dimensional environment includes displaying the three-dimensional environment with reduced sharpness compared to displaying the second visual feedback. Displaying a three-dimensional environment with different visual appearances in response to a request to move a virtual object in the three-dimensional environment based on whether the virtual object is shared or not shared in a communication session provides feedback to a user of a respective computer system in the communication session regarding whether the virtual object that the user requests to move is shared or not shared in the communication session, thereby avoiding errors in interaction and improving user device interaction.

In some embodiments, changing the visual appearance of the three-dimensional environment includes changing a visual appearance of one or more virtual objects, including the first virtual object, displayed in the three-dimensional environment, such as changing the visual appearance of virtual representations 1012b and 1012c in FIG. 10B. In some embodiments, changing the visual appearance of the one or more virtual objects includes one or more characteristics of displaying the one or more virtual objects included in the three-dimensional environment with the second visual appearance as described with reference to method 1100. In some embodiments, the one or more virtual objects are displayed with a reduced visual prominence (e.g., the one or more virtual objects are displayed with reduced color, saturation and/or brightness, and/or with increased transparency). In some embodiments, the one or more virtual objects are displayed with a darker appearance compared to displaying the second visual feedback. In some embodiments, the one or more virtual objects are displayed with reduced sharpness compared to displaying the one or more virtual objects with the second visual feedback. In some embodiments, in accordance with the one or more virtual object being one or more virtual representations of one or more users in the three-dimensional environment, the first computer system changes the virtual representations of the one or more users from one or more virtual representations of a first type (e.g., as described with reference to method 900) to one or more virtual representations of a second type (e.g., as described with reference to method 900). Displaying one or more virtual objects in a three-dimensional environment with different visual appearances in response to a request to move a respective virtual object in a three-dimensional environment based on whether the respective virtual object is shared or not shared in a communication session provides feedback to a user of a respective computer system in the communication session regarding whether the respective virtual object that the user requests to move is shared or not shared in the communication session, thereby avoiding errors in interaction and improving user device interaction.

In some embodiments, changing the visual appearance of the three-dimensional environment includes changing a visual appearance of one or more portions of a physical environment of the first user visible in the three-dimensional environment, such as changing the visual appearance of optical passthrough of the physical environment of first user 1042a visible in three-dimensional environment 1002a in FIG. 10B. In some embodiments, changing the visual appearance of the one or more portions of the physical environment of the first user visible in the three-dimensional environment includes one or more characteristics of displaying the one or more representations of the one or more objects in the physical environment of the first user with the second visual appearance as described with reference to method 1100. In some embodiments, the one or more portions of the physical environment correspond to one or more physical objects in the physical environment of the first user (e.g., walls of a room and/or furniture). In some embodiments, the one or more portions of the physical environment are visible in the three-dimensional environment through passthrough of the first user's physical environment. In some embodiments, changing the visual appearance of the one or more portions of the physical environment includes displaying the one or more portions of the physical environment with a reduced visual prominence (e.g., the one or more portions of the physical environment are displayed with reduced color, saturation and/or brightness). In some embodiments, the one or more portions of the physical environment are displayed with a darker appearance compared to displaying the one or more portions of the physical environment with the second visual feedback. Displaying one or more portions of a physical environment visible in a three-dimensional environment with different visual appearances in response to a request to move a virtual object in the three-dimensional environment based on whether the virtual object is shared or not shared in a communication session provides feedback to a user of a respective computer system in the communication session regarding whether the virtual object that the user requests to move is shared or not shared in the communication session, thereby avoiding errors in interaction and improving user device interaction.

In some embodiments, while displaying the three-dimensional environment including the first virtual object and before detecting the first input, in accordance with a determination that the first virtual object is not shared with the one or more computer systems in the communication session, the first computer system displays a first virtual element with the first virtual object that is selectable to move the first virtual object relative to the first viewpoint of the first user in three-dimensional environment, such as virtual element 1016 displayed with virtual object 1004a in FIGS. 10A and 10A1. In some embodiments, in accordance with a determination that the first virtual object is shared with the one or more computer systems in the communication sessions, the first computer system forgoes displaying the first virtual element with the first virtual object, such as not displaying virtual element 1016 with virtual object 1006b in FIG. 10Q. In some embodiments, the first virtual element is a selectable option (e.g., affordance) that is displayed adjacent to (e.g., above, below or to the side of) the first virtual object. In some embodiments, the first virtual element is displayed as a rectangular bar (e.g., with rounded edges) below the first virtual object (e.g., with a predefined spatial relationship with the first virtual object). In some embodiments, selection of the first virtual element corresponds to detection of a selection input directed to the first virtual element. In some embodiments, the selection input includes attention of the user directed to the first virtual element (e.g., through gaze directed to the first virtual element for a threshold period of time (e.g., 0.1, 0.2, 0.5, 1, 2, 5 or 10 seconds) and/or performing an air gesture (e.g., an air tap, air drag, air pinch or air long pinch)). In some embodiments, the selection input includes an air pinch of the thumb and a finger (e.g., optionally for a threshold period of time (e.g., 0.1, 0.2, 0.5, 1, 2 or 5 seconds), an input on a touch-sensitive surface (e.g., a touchpad) in communication with the computer system, a force-sensitive input (e.g., a click of a touchpad), a capacitive touch input (e.g., a swipe of a finger on a touch-sensitive display)), an audio input (e.g., a voice command) and/or an input provided with a mouse and/or keyboard in communication with the computer system. In some embodiments, moving the first virtual object includes directing gaze and an air gesture to the first virtual element and performing hand movement (e.g., while maintaining the air gesture) relative to the three-dimensional environment. In some embodiments, the first virtual element is not visible from a perspective of a second user of a second computer systems in the communication session with the first computer system (e.g., the first virtual element is not displayed in a second three-dimensional environment (e.g., including one or more characteristics of the second three-dimensional environment described with reference to method 1100) because the first virtual object is not displayed in the second three-dimensional environment when the first virtual object is not shared in the communication session). Displaying a virtual object in a three-dimensional environment that is not shared in a communication session with a virtual element for moving the virtual object and displaying a virtual object in a three-dimensional environment that is shared in the communication session without the virtual element for moving the virtual object provides feedback to a user of a respective computer system in the communication session regarding whether a virtual object is shared or not shared in the communication session prior to the user providing an input to move the virtual object, thereby avoiding errors in interaction and improving user device interaction.

In some embodiments, displaying the first virtual element with the first virtual object includes displaying the virtual element with the first virtual object independent of whether the attention of the first user is directed to a location associated with the first virtual object in the three-dimensional environment, such as displaying virtual element 1016 with virtual object 1004 while attention of first user 1042a (e.g., through gaze 1024) is not directed to virtual object 1004 as shown in FIGS. 10A and 10A1. In some embodiments, displaying the first virtual element with the first virtual object includes displaying the virtual element with the first virtual object when attention of the first user is directed to the current location of the first virtual object in the three-dimensional environment and when the attention of the first user is not directed to the current location of the first virtual object in the three-dimensional environment. In some embodiments, after moving the first virtual object to the second location relative to the first viewpoint of the first user in the three-dimensional environment in accordance with the first input, the first virtual object is displayed at the second location in the three-dimensional environment when attention of the first user is directed to the second location and when the attention of the first user is not directed to the second location. Displaying a virtual element in a three-dimensional environment with a virtual object that is not shared in a communication session independent of whether attention of a user of a respective computer system in the communication session is directed to a location in the three-dimensional environment associated with the virtual object provides persistent visual feedback to the user that the virtual object is not shared and informs the user of whether the virtual object is shared prior to providing an input to move the virtual object in the three-dimensional environment, thereby avoiding errors in interaction and improving device interaction.

In some embodiments, while displaying the three-dimensional environment including the first virtual object and before detecting the first input, in accordance with a determination that the first virtual object is shared with the one or more computer systems (e.g., including one or more characteristics of shared content that is shared with the one or more computer systems in the communication session as described with reference to method 1100) in the communication session, the first computer system displays a first virtual element with the first virtual object that is selectable to move one or more virtual objects, including the first virtual object, relative to the first viewpoint of the first user in the three-dimensional environment (e.g., including one or more characteristics of the element that is selectable to change the spatial arrangement of the first virtual object relative to the first viewpoint of the first user as described with reference to method 1100), such as affordance 1032 displayed with virtual object 1006b in FIG. 10R.

In some embodiments, in accordance with a determination that the first virtual object is not shared with the one or more computer systems in the communication session, the first computer system forgoes displaying the first virtual element with the first virtual object, such as first computer system 101a not displaying affordance 1032 with virtual object 1004 in FIG. 10H. In some embodiments, in response to detecting an input directed to the first virtual element, the first computer system moves the one or more virtual objects, including the first virtual object, relative to the first viewpoint of the first user in the three-dimensional environment. For example, selection of the first virtual element includes performing a selection input directed to the first virtual element (e.g., including one or more characteristics of a selection input described above). In some embodiments, selecting the first virtual element corresponds to attention of the first user directed (e.g., through gaze (e.g., optionally for a threshold period of time (e.g., 0.1, 0.5, 1, 2, 5 or 10 seconds))) at the first virtual element while concurrently performing an air gesture (e.g., having one or more characteristics of the air gesture described above) and hand movement relative to the three-dimensional environment (e.g., the hand movement corresponds to a direction of movement of the one or more virtual objects and the first virtual object relative to the first viewpoint of the first user in the three-dimensional environment). In some embodiments, the first virtual element has one or more characteristics of the first virtual element as described above. In some embodiments, displaying the first virtual element in the three-dimensional environment includes one or more characteristics of displaying first visual feedback in the three-dimensional environment that indicates that the spatial arrangement of the first virtual object relative to the viewpoint of the first user can be changed in response to further input as described with reference to method 1100. In some embodiments, the first virtual element has one or more characteristics of the second virtual object displayed relative to the surface in the three-dimensional environment as described with reference to method 1100. Displaying a virtual object in a three-dimensional environment that is shared in a communication session with a virtual element for moving the virtual object and displaying a virtual object in a three-dimensional environment that is not shared in the communication session without the virtual element for moving the virtual object provides feedback to a user of a respective computer system in the communication session regarding whether a respective virtual object is shared or not shared in the communication session prior to the user providing an input to move the respective virtual object, thereby avoiding errors in interaction and improving user device interaction.

In some embodiments, displaying the first virtual element with the first virtual object includes displaying the first virtual element with the first virtual object when attention of the first user is directed to a location associated with the first virtual object in the three-dimensional environment, and not displaying the virtual element with the first virtual object when attention of the first user is not directed to the location associated with the first virtual object in the three-dimensional environment, such as shown by displaying affordance 1032 in three-dimensional environment 1002a in FIG. 10R in response to the attention directed to the location associated with affordance 1032 in FIG. 10Q. In some embodiments, displaying the first virtual element with the first virtual object includes displaying the first virtual element with the first virtual object when attention of the first user is directed to the current location of the first virtual object in the three-dimensional environment and not displaying the first virtual element with the first object when attention of the first user is not directed to the current location of the first virtual object in the three-dimensional environment. In some embodiments, after moving the first virtual object to the second location relative to the first viewpoint of the first user in the three-dimensional environment, displaying the first virtual element with the first virtual object includes displaying the virtual element with the first virtual object when attention of the first user is directed to the second location in the three-dimensional environment and not displaying the virtual element with the first virtual object when attention of the first user is not directed to the second location in the three-dimensional environment. Displaying a virtual element that is shared in a communication session with a virtual object in a three-dimensional environment in response attention of a user being directed to a location of the virtual object in the three-dimensional environment provides visual feedback that the virtual object is shared and informs the user of whether the virtual object is shared prior to requesting movement of the virtual object in the three-dimensional environment, thereby avoiding errors in interaction and improving user device interaction.

In some embodiments, displaying the first visual feedback in the three-dimensional environment includes displaying movement of one or more virtual objects, different from the first virtual object, relative to the first viewpoint of the first user in the three-dimensional environment in accordance with the first input, such as the movement of virtual representation 1014b and 1014c with virtual object 1006a shown in FIGS. 10D-10F. In some embodiments, the one or more virtual objects have one or more characteristics of the first portion of the one or more virtual objects displayed in the three-dimensional environment as described with reference to method 1100. In some embodiments, the one or more virtual objects are shared with the one or more computer systems in the communication session. In some embodiments, the one or more virtual object are not shared with the one or more computer systems in the communication session. In some embodiments, the one or more virtual objects include a first portion of one or more virtual objects that are shared with the one or more computer systems in the communication session and a second portion of one or more virtual objects that are not shared with the one or more computer systems in the communication session. In some embodiments, the one or more virtual objects include one or more virtual representations of one or more users of the one or more computer systems (e.g., including one or more characteristics of virtual representations described with reference to methods 800, 900 and/or 1100). In some embodiments, displaying the first visual feedback includes reducing the visual prominence of the one or more virtual objects (e.g., including one or more characteristics of reducing the visual prominence of the one or more virtual objects as described with reference to method 1100) while displaying the movement of the one or more virtual objects relative to the first viewpoint of the first user. In some embodiments, displaying movement of the one or more virtual objects includes displaying movement of the one or more virtual objects while changing the spatial arrangement of the first virtual object in accordance with the first input (e.g., the first virtual object and the one or more virtual objects are moved in the same manner (e.g., same distance, magnitude and/or speed of movement)). In some embodiments, displaying movement of the one or more virtual objects includes pivoting the one or more virtual objects (e.g., and optionally the first virtual object) about a first location in the three-dimensional environment corresponding to the first viewpoint of the first user (e.g., as described with reference to method 1100). In some embodiments, moving the first virtual object relative to the first viewpoint of the first user in the three-dimensional environment includes maintaining a shared spatial arrangement of the first virtual object and the one or more virtual objects while moving first virtual object relative to the first viewpoint of the first user in the three-dimensional environment.

In some embodiments, displaying the second visual feedback in the three-dimensional environment includes displaying movement of the first virtual object relative to the first viewpoint of the first user in the three-dimensional environment in accordance with the first input without including movement of one or more virtual objects other than the first virtual object relative to the first viewpoint of the first user in the three-dimensional environment, such as the movement of virtual object 1004 shown in FIGS. 10H-10J that does not include movement of virtual representations 1012b and 1012c in three-dimensional environment 1002a. In some embodiments, the one or more virtual objects are displayed at one or more locations and/or orientations relative to the first viewpoint of the first user, and, while receiving the first input, the first computer system maintains display of the one or more virtual objects at the one or more locations and/or orientations relative to the first viewpoint of the first user. In some embodiments, moving the first virtual object relative to the first viewpoint of the first user in the three-dimensional environment in accordance with the first input includes changing the spatial arrangement of the first virtual object relative to the one or more virtual objects in the three-dimensional environment as a result of the movement of the first virtual object (e.g., prior to receiving the first input, the first virtual object has a first spatial relationship with the one or more virtual objects, and after receiving the first input, the first virtual object has a second spatial relationship with the one or more virtual objects different from the first spatial relationship). Displaying movement of one or more virtual objects, including a respective virtual object, displayed in a three-dimensional environment in response to a request to move the respective virtual object in the three-dimensional environment based on whether the respective virtual object is shared or not shared in a communication session provides feedback to a user of a respective computer system in the communication session regarding whether the respective virtual object that the user requests to move is shared or not shared in the communication session and enables a spatial relationship between virtual objects that are shared in the communication session to be maintained despite movement of the respective virtual object in response to the request to move the respective virtual object in the three-dimensional environment, thereby avoiding errors in interaction and improving user device interaction.

In some embodiments, while displaying, via the display generation component, a virtual representation of a second user of a second computer system of the one or more computer systems at a third location relative to the first viewpoint of the first user in the three-dimensional environment, the first computer system detects, via the one or more input devices, a second input corresponding to a request to move the virtual representation of the second user from the third location to a fourth location, different from the third location, relative to the first viewpoint of the first user in the three-dimensional environment, such as the input provided by first user 1042a directed to virtual representation 1012b in FIG. 10K. In some embodiments, the virtual representation of the second user includes one or more characteristics of virtual representations described with reference to method 800, 900 and/or 1100. In some embodiments, the virtual representation of the second user is a virtual representation of the first type as described with reference to method 900. In some embodiments, the second input has one or more characteristics of the first input described with reference to step(s) 1202. In some embodiments, the second input includes attention of the first user directed to the virtual representation of the second user (e.g., through gaze and/or an air gesture directed to the virtual representation of the second user).

In some embodiments, while (optionally in response to) detecting the first input (e.g., while the first user performs the hand gesture and/or movement), the first computer system displays the first visual feedback in the three-dimensional environment while moving the virtual representation of the second user from the third location to the fourth location relative to the first viewpoint of the first user in the three-dimensional environment, such as the visual feedback displayed in three-dimensional environment 1002a in FIG. 10L in response to the input provided by first user 1042a in FIG. 10K. In some embodiments, displaying the first visual feedback in the three-dimensional environment while moving the virtual representation of the second user relative to the first viewpoint of the first user in the three-dimensional environment includes one or more characteristics of displaying the first visual feedback while moving the first virtual object relative to the first viewpoint of the first user in the three-dimensional environment. In some embodiments, displaying the first visual feedback includes changing the display of the virtual representation of the second user from the virtual representation of the first type to a virtual representation of a second type (e.g., including one or more characteristics of a virtual representation of a second type as described with reference to method 900). In some embodiments, moving the virtual representation of the second user from the third location to the fourth location relative to the first viewpoint of the first user in the three-dimensional environment includes one or more characteristics of moving the first virtual object from the first location to the second location relative to the first viewpoint of the first user in the three-dimensional environment as described with reference to step(s) 1202. Displaying different visual feedback in response to a request to move a virtual object in a three-dimensional environment when the virtual object is a virtual representation of a user in a communication session compared to a virtual object that is not shared in the communication session provides feedback to a respective user of a respective computer system in the communication session that the virtual representation that the user requests to move is shared in the communication session, thereby avoiding errors in interaction and improving user device interaction.

In some embodiments, displaying the first visual feedback in the three-dimensional environment includes reducing a visual prominence (e.g., brightness, opacity, size, and/or shape) of one or more virtual representations of one or more users of the one or more computer systems displayed in the three-dimensional environment, such as the reduced visual prominence of virtual representations 1012b and 1012c shown in FIG. 10B. In some embodiments, reducing the visual prominence of the one or more virtual representations of the one or more users includes one or more characteristics of reducing the visual prominence of the one or more virtual representations of the one or more users as described with reference to method 1100. In some embodiments, moving the first virtual object from the first location to the second location in the three-dimensional environment includes one or more characteristics of changing the spatial arrangement of the first virtual object relative to the first viewpoint of the first user while the one or more virtual representations of the one or more users have the reduced visual prominence relative to the three-dimensional environment as described with reference to method 1100. Reducing the visual prominence of one or more virtual representations in a three-dimensional environment while moving a virtual object relative to the viewpoint of a user reduces the amount of prominent motion that is displayed in the three-dimensional environment during the movement of the virtual object, provides visual feedback to a user that the movement of the virtual object is occurring in the three-dimensional environment, and reduces spatial conflicts displayed between the one or more virtual representations and other virtual objects displayed in the three-dimensional environment during the movement of the virtual object, thereby minimizing the risk of motion sickness to the user, reducing errors in interaction and improving user device interaction.

In some embodiments, while displaying the three-dimensional environment including the first virtual object, the first computer system displays a first virtual element that is selectable to move the first virtual object relative to the first viewpoint of the first user in the three-dimensional environment, wherein the first input includes input directed to the first virtual element, such as the input directed to virtual element 1018 that is displayed with virtual object 1006a in FIGS. 10A and 10A1. In some embodiments, the first virtual element has one or more characteristics of the first virtual element described above. In some embodiments, in response to directing an input corresponding to selection of the first virtual element, the first computer system moves the first virtual object relative to the first viewpoint of the first user in the three-dimensional environment. For example, selection of the first virtual element includes performing a selection input directed to the first virtual element (e.g., including one or more characteristics of a selection input described above). In some embodiments, selecting the first virtual element corresponds to attention of the first user directed (e.g., through gaze (e.g., optionally for a threshold period of time (e.g., 0.1, 0.5, 1, 2, 5 or 10 seconds))) at the first virtual element while concurrently performing an air gesture (e.g., having one or more characteristics of an air gesture described above) and hand movement relative to the three-dimensional environment (e.g., the hand movement corresponds to a direction of movement of the first virtual object relative to the first viewpoint of the first user in the three-dimensional environment). In some embodiments, the first virtual element is displayed with the first virtual object in accordance with a determination that the first virtual object is shared with the one or more computer systems in the communication session. In some embodiments, the first virtual element is displayed with the first virtual object in accordance with a determination that the first virtual object is not shared with the one or more computer systems in the communication session. In some embodiments, a virtual element that is selectable to move a respective virtual object relative to the first viewpoint of the first user is displayed with the respective virtual object independent of whether the respective virtual object is shared with the one or more computer systems in the communication session or not shared with the one or more computer systems in the communication session (e.g., the first virtual object is shared in the communication session and is displayed in the three-dimensional environment with the first virtual element, and a second virtual object that is not shared in the communication session is displayed concurrently with the first virtual object in the three-dimensional environment with the first virtual element). Displaying a virtual element that is selectable to move a respective virtual object with a first virtual object that is shared in a communication session and with a second virtual object that is not shared in a communication session provides a consistent method of interaction to a user of a respective computer system in the communication session for moving respective virtual objects in the three-dimensional environment independent of whether the respective virtual objects are shared or not, thereby improving user device interaction.

In some embodiments, while displaying the three-dimensional environment including the first virtual object, in accordance with a determination that the first virtual object is not shared with the one or more computer systems in the communication session, the first computer system displays a selectable option with the first virtual object that is selectable to cease display of the first virtual object in the three-dimensional environment, such as selectable option 1030b displayed with virtual object 1004 in FIGS. 10A and 10A1. In some embodiments, the selectable option is included within the first virtual object (e.g., in a corner of the first virtual object from the first viewpoint of the user). In some embodiments, the selectable option is a virtual element (e.g., affordance) displayed in the three-dimensional environment concurrently with the first virtual object. In some embodiments, selecting the selectable option includes performing a selection input directed to the selectable option (e.g., including one or more characteristics of the selection input described above). In some embodiments, in response to an input corresponding to selection of the selectable option, the first computer system ceases to display the first virtual object in the three-dimensional environment.

In some embodiments, in accordance with a determination that the first virtual object is shared with the one or more computer systems in the communication session, the first computer system forgoes displaying the selectable option with the first virtual object that is selectable to cease display of the first virtual object in the three-dimensional environment, such as selectable option 1030b not being displayed with virtual object 1006a in FIGS. 10A and 10A1. In some embodiments, in accordance with the first virtual object being shared by a user of the one or more computer systems other than the first computer system in the communication session, the first user is not permitted to cease display of the first virtual object in the three-dimensional environment. In some embodiments, the first virtual object is displayed with a visual indication indicating that the first virtual object is shared with the one or more computer systems in the communication session (e.g., as described below). In some embodiments, the visual indication is selectable to cease sharing the first virtual object with the one or more computer systems (e.g., in accordance with the first user sharing the first virtual object with the one or more computer systems in the communication session). In some embodiments, after ceasing to share the first virtual object with the one or more computer systems, the first computer system displays the selectable option that is selectable to cease display of the first virtual object in the three-dimensional environment. Displaying a selectable option to cease display of a virtual object in a three-dimensional environment based on whether the virtual object is shared in a communication session or not shared in a communication session ensures that the selectable option is only displayed when a respective user of a respective computer system in the communication session can cease display of the virtual object (e.g., because the respective user cannot cease display of the virtual object if the virtual object is shared in the communication session), thereby conserving computing resources and improving user device interaction.

In some embodiments, while displaying the three-dimensional environment including the first virtual object, in accordance with a determination that the first virtual object is not shared with the one or more computer systems in the communication session, the first computer system displays a selectable option with the first virtual object that is selectable to change a size of the first virtual object relative to the three-dimensional environment, such as selectable option 1030a displayed with virtual object 1004 in FIGS. 10A and 10A1. In some embodiments, the selectable option is included within the first virtual object (e.g., in a corner of the first virtual object from the first viewpoint of the user). In some embodiments, the selectable option is a virtual element (e.g., affordance) displayed in the three-dimensional environment concurrently with the first virtual object. In some embodiments, selecting the selectable option includes performing a selection input directed to the selectable option (e.g., including one or more characteristics of the selection input described above). In some embodiments, in response to an input corresponding to selection of the selectable option, the first computer system changes the size of the first virtual object relative to the three-dimensional environment. For example, the first computer system expands the size of the first virtual object relative to the three-dimensional environment. For example, the first computer system reduces the size of the first virtual object relative to the three-dimensional environment. In some embodiments, the input corresponding to selection of the selectable option includes performing an air gesture (e.g., an air pinch or one or more air gestures described above). In some embodiments, the air gesture is performed for a threshold period of time (e.g., 0.1, 0.2, 0.5, 1, 2, 5 or 10 seconds). In some embodiments, the input corresponding to selection of the selectable option includes hand movement (e.g., while attention (e.g., gaze) is directed to the selectable option and/or while performing the air gesture (e.g., air pinch)) in a direction relative to the three-dimensional environment. In some embodiments, while receiving the input corresponding to selection of the selectable option, the first virtual object is resized based on the direction of hand movement relative to the three-dimensional environment. In some embodiments, in response to detecting termination of the input corresponding to selection of the selectable option (e.g., the first user ceases to perform the air gesture and/or the hand movement), the first computer system displays the first virtual object with a size relative to the three-dimensional environment based on the hand movement.

In some embodiments, in accordance with a determination that the first virtual object is shared with the one or more computer systems in the communication session, the first computer system forgoes displaying the selectable option with the first virtual object that is selectable to change the size of the first virtual object relative to the three-dimensional environment, such as selectable option 1030a not being displayed with virtual object 1006a in FIGS. 10A and 10A1. In some embodiments, in accordance with the first virtual object being shared with the one or more computer systems in the communication session, the first user is not permitted to change the size of the first virtual object relative to the three-dimensional environment. In some embodiments, in accordance with the first virtual object ceasing to be shared with the one or more computer systems in the communication session (e.g., in response to selection of the visual indication indicating that the first virtual object is shared with the one or more computer systems as described below), the selectable option that is selectable to change the size of the first virtual object relative to the three-dimensional environment is displayed by the first computer system. Displaying a selectable option to change the size of a virtual object in a three-dimensional environment based on whether the virtual object is shared in a communication session or not shared in a communication session ensures that the selectable option is only displayed when a respective user of a respective computer system in the communication session can change the size of the virtual object (e.g., because the respective user cannot change the size of the virtual object if the virtual object is shared in the communication session), thereby conserving computing resources and improving user device interaction.

In some embodiments, while detecting the first input, in accordance with the determination that the first virtual object is not shared with the one or more computer systems in the communication session, the first computer system permits movement of the first virtual object in multiple dimensions, including a respective dimension, relative to the first viewpoint of the first user in the three-dimensional environment, such as shown by the movement of virtual object 1004 in the first dimension relative to three-dimensional environment 1002a in FIGS. 10H-10I. In some embodiments, permitting movement of the first virtual object in multiple dimensions including a respective dimension includes permitting movement of the first virtual object in a horizontal direction, vertical direction, and a direction of depth relative to the first viewpoint of the first user in the three-dimensional environment. In some embodiments, in accordance with the first input corresponding to a request to move the first virtual object in the respective dimension, the first computer system moves the first virtual object in the respective dimension in accordance with the first input relative to the first viewpoint of the first user in the three-dimensional environment. In some embodiments, in accordance with the first input corresponding to a request to move the first virtual object in the respective dimension and in at least one of a first dimension and a second dimension, the first computer system moves the first virtual object in the respective dimension and the at least one of the first dimension and the second dimension in accordance with the first input relative to the first viewpoint of the first user in the three-dimensional environment.

In some embodiments, in accordance with the determination that the first virtual object is shared with the one or more computer systems in the communication session, the first computer system permits movement of the first virtual object in multiple dimensions, not including the respective dimension, relative to the first viewpoint of the first user in the three-dimensional environment, such as shown by computer system 101a forgoing movement of virtual object 1006a in the first dimension relative to three-dimensional environment 1002a in FIG. 10G in response to the input provided by first user 1042a in FIG. 10F. In some embodiments, permitting movement of the first virtual object in multiple dimensions not including a respective dimension includes permitting movement of the first virtual object in the horizontal direction and direction of depth (e.g., and not the vertical direction), the horizontal direction and the vertical direction (e.g., and not the direction of depth), or the vertical direction and the direction of depth (e.g., and not the horizontal direction) relative to the first viewpoint of the first user in the three-dimensional environment. In some embodiments, in accordance with the first input corresponding to a request to move the first virtual object in the respective dimension, the first computer system forgoes moving the first virtual object in the respective dimension in accordance with the first input. In some embodiments, in accordance with the input corresponding to a request to move the first virtual object in the respective dimension and at least one of a first dimension and a second dimension, the first computer system moves the first virtual object in the at least one of the first dimension and the second dimension in accordance with the first input and not in the respective dimension relative to the first viewpoint of the first user in the three-dimensional environment. Preventing movement of a virtual object that is shared in a communication session in a respective dimension relative to a three-dimensional environment enables a respective computer system in the communication session to display the virtual object at a position relative to the respective dimension in the three-dimensional environment that is consistent with one or more other computer systems in the communication session such that a respective user of the respective computer system is provided interaction with the virtual object that is consistent with the interaction of one or more users of the one or more computer systems with the virtual object, thereby reducing errors in interaction and improving user device interaction.

In some embodiments, the respective dimension is a vertical dimension relative to the first viewpoint of the first user in the three-dimensional environment, such as shown by the vertical movement of virtual object 1004 in FIGS. 10H-101. In some embodiments, permitting movement in the respective dimension includes permitting vertical movement of the first virtual object relative to the first viewpoint of the first user in the three-dimensional environment. In some embodiments, in accordance with the first input corresponding to a request to move the first virtual object in the vertical direction (e.g., corresponding to a direction of height relative to the first viewpoint of the first user, and/or a direction in the three-dimensional environment perpendicular to a ground and/or floor displayed and/or visible in the three-dimensional environment), the first virtual object is moved in the vertical direction in accordance with the first input. In some embodiments, in accordance with the first input corresponding to a request to move the first virtual object in the vertical direction and/or the horizontal direction and/or the direction of depth, the first virtual object is moved in the vertical direction and/or the horizontal direction and/or the direction of depth relative to the first viewpoint of the first user in the three-dimensional environment. In some embodiments, not permitting movement in the respective dimensions includes not permitting vertical movement of the first virtual object relative to the first viewpoint of the first user in the three-dimensional environment. In some embodiments, in accordance with the first virtual object being shared with the one or more computer systems in the communication session and in accordance with the first input corresponding to a request to move the first virtual object in the vertical direction, the first computer system forgoes moving the first virtual object in the vertical direction. In some embodiments, in accordance with the first virtual object being shared with the one or more computer systems in the communication session and in accordance with the first input corresponding to a request to move the first virtual object in the vertical direction and the horizontal direction, the first virtual object is moved in the horizontal direction in accordance with the first input and not the vertical direction relative to the first viewpoint of the first user in the three-dimensional environment. In some embodiments, in accordance with the first virtual object being shared with the one or more computer systems and in accordance with the first input corresponding to a request to move the first virtual object in the vertical direction and the direction of depth, the first virtual object is moved in the direction of depth in accordance with the first input and not in the vertical direction relative to the first viewpoint of the first user in the three-dimensional environment. Preventing movement of a virtual object that is shared in a communication session in a vertical dimension relative to a three-dimensional environment enables a respective computer system in the communication session to display the virtual object at a height in the three-dimensional environment that is consistent with one or more other computer systems in the communication session such that a respective user of the respective computer system is provided interaction with the virtual object that is consistent with the interaction of one or more users of the one or more computer systems with the virtual object, thereby reducing errors in interaction and improving user device interaction.

In some embodiments, displaying the second visual feedback in the three-dimensional environment includes changing a size of the first virtual object relative to the three-dimensional environment based on a distance of the first virtual object from the first viewpoint of the first user, such as shown by the change of size of virtual object 1004 shown in overhead view 1040 in FIGS. 10I-10J. In some embodiments, the movement of the first virtual object from the first location to the second location relative to the first viewpoint of the first user in the three-dimensional environment causes a change in a spatial arrangement of the first virtual object relative to the first viewpoint of the first user from a first spatial arrangement to a second spatial arrangement different from the first spatial arrangement. In some embodiments, the first spatial arrangement corresponds to a first distance of the first virtual object from the first viewpoint of the first user, and the second spatial arrangement corresponds to a second distance of the first virtual object from the first viewpoint of the first user. In some embodiments, in accordance with the first distance being greater than the second distance, changing the size of the first virtual object relative to the three-dimensional environment corresponds to reducing the size of the first virtual object relative to the three-dimensional environment. In some embodiments, in accordance with the second distance being greater than the first distance, changing the size of the first virtual object relative to the three-dimensional environment corresponds to expanding the size of the first virtual object relative to the three-dimensional environment. In some embodiments, displaying the second visual feedback in the three-dimensional environment includes maintaining a display size of the first virtual object relative to the first viewpoint of the first user in the three-dimensional environment (e.g., independent of the distance of the first virtual object from the first viewpoint of the first user).

In some embodiments, displaying the first visual feedback in the three-dimensional environment does not include changing the size of the first virtual object relative to the three-dimensional environment based on the distance of the first virtual object from the first viewpoint of the first user, such as shown by first computer system 101a not changing the size of virtual object 1006a relative to three-dimensional environment 1002a in FIGS. 10D-10F. In some embodiments, displaying the first visual feedback in the three-dimensional environment includes maintaining the size of the first virtual object relative to the three-dimensional environment (e.g., maintaining the size of the first virtual object includes maintaining a respective size of the first virtual object that the first virtual object is displayed with in the three-dimensional environment prior to receiving the first input). In some embodiments, displaying the first visual feedback in the three-dimensional environment includes displaying movement of one or more virtual objects, different from the first virtual object, relative to the first viewpoint of the first user in the three-dimensional environment in accordance with the first input (e.g., as described above). In some embodiments, in accordance with a determination that the one or more virtual objects are shared with the one or more computer systems in the communication session, displaying the first visual feedback in the three-dimensional environment does not include changing the size of the one or more virtual objects relative to the three-dimensional environment based on the distance of the one or more virtual objects from the first viewpoint of the first user. In some embodiments, in accordance with a determination that the one or more virtual objects are not shared with the one or more computer systems in the communication session, displaying the first visual feedback in the three-dimensional environment does include changing the size of the one or more virtual objects relative to the three-dimensional environment based on the distance of the one or more virtual objects from the first viewpoint of the first user. In some embodiments, displaying the first visual feedback in the three-dimensional environment includes changing a display size of the first virtual object relative to the first viewpoint of the first user based on the distance of the first virtual object from the first viewpoint of the first user (e.g., in accordance with the distance of the first virtual object increasing relative to the first viewpoint of the first user in the three-dimensional environment, the first virtual object is displayed with a reduced display size relative to the first viewpoint of the first user, and/or in accordance with the distance of the first virtual object decreasing relative to the first viewpoint of the first user in the three-dimensional environment, the first virtual object is displayed with an increased display size relative to the first viewpoint of the first user). Changing the size of a virtual object relative to a three-dimensional environment in response to a request to move a virtual object in the three-dimensional environment when the virtual object is shared in a communication session and not changing the size of the virtual object relative to the three-dimensional environment when the virtual object is not shared in the communication session provides feedback to a user of a respective computer system in the communication session regarding whether the virtual object that the user requests to move is shared or not in the communication session, and provides the user interaction with shared content in the communication session that is consistent with the interaction of one or more users of one or more computer systems in the communication session with the shared content, thereby avoiding errors in interaction and improving user device interaction.

In some embodiments, while displaying the three-dimensional environment including the first virtual object, in accordance with a determination that the first virtual object is shared with the one or more computer systems in the communication session, the first computer system displays a visual indication with the first virtual object indicating that the first virtual object is shared with the one or more computer systems in the communication session with the first computer system, such as visual indication 1020 displayed with virtual object 1006a in FIGS. 10A and 10A1. In some embodiments, the visual indication is displayed adjacent to the first virtual object in the three-dimensional environment (e.g., above, below, or to a side of the first virtual object from the first viewpoint of the first user). In some embodiments, the visual indication corresponds to an icon representing that the first virtual object is shared with the one or more computer systems in the communication session. In some embodiments, the visual indication corresponds to affordance that is selectable by the first user (e.g., as described below). In some embodiments, the visual indication includes an annotation (e.g., text) that represents that the first virtual object is shared with the one or more computer systems in the communication session with the first computer system. In some embodiments, from the perspective of one or more users of the one or more computer systems in the communication session, the visual indication is displayed with the first virtual object in one or more respective three-dimensional environments displayed by the one or more computer systems (e.g., the one or more respective three-dimensional environments have one or more characteristics of the three-dimensional environment (e.g., the one or more respective three-dimensional environments correspond to the three-dimensional environment viewed from the respective viewpoints of the one or more users).

In some embodiments, in accordance with a determination that the first virtual object is not shared with the one or more computer systems in the communication session, the first computer system forgoes displaying the visual indication with the first virtual object, such as shown by first computer system 101a not displaying virtual object 1004 with visual indication 1020 in FIGS. 10A and 10A1. In some embodiments, a second virtual object is displayed concurrently with the first virtual object in the three-dimensional environment and the second virtual object is shared with the one or more computer systems in the communication session. In some embodiments, the second virtual object is displayed with the visual indication in the three-dimensional environment and the first virtual object is not displayed with the visual indication in the three-dimensional environment. Displaying a visual indication indicating that a respective virtual object is shared in a communication session with a virtual object in a three-dimensional environment based on whether the virtual object is shared or not shared in a communication session provides feedback to a user of a respective computer system in the communication session regarding whether the virtual object is shared or not shared in the communication session and enables the visual indication to only be displayed in the three-dimensional environment when it is necessary to be displayed, thereby avoiding errors in interaction, improving user device interaction, and conserving computing resources.

In some embodiments, the first virtual object is shared with the one or more computer systems in the communication session (e.g., virtual object 1006b shown in FIG. 10Q). In some embodiments, while displaying the three-dimensional environment including the first virtual object with the visual indication, the first computer system detects a second input corresponding to selection of the visual indication displayed with the first virtual object, such as the input provided by first user 1042a in FIG. 10U. In some embodiments, the second input has one or more characteristics of a selection input (e.g., as described above) directed to the visual indication (e.g., including gaze and/or an air gesture and/or hand movement).

In some embodiments, in response to detecting the second input, the first computer system ceases to share the first virtual object with the one or more computer systems in the communication session, such as shown by first computer system 101a ceasing to share virtual object 1006b in FIG. 10V. In some embodiments, in response to selection of the visual indication, the first computer system maintains display of the first virtual object in the three-dimensional environment from the first viewpoint of the first user (e.g., the first virtual object is not viewable from the perspective of one or more users of one or more computer systems in the communication session). In some embodiments, in response to selection of the visual indication, the first computer system displays the first virtual object with the selectable option that is selectable to cease display of the first virtual object (e.g., as described above) and/or with the selectable option to change the size of the first virtual object relative to the three-dimensional environment (e.g., as described above). In some embodiments, in response to selection of the visual indication, the first computer system ceases display of the first virtual object in the three-dimensional environment (e.g., and from the perspective of one or more users of one or more computer systems in the communication session). In some embodiments, from the perspective of one or more users of one or more computer systems in the communication session with the first computer system, the visual indication is displayed in one or more three-dimensional environments (e.g., corresponding to the three-dimensional environment) with the first virtual object and is not selectable to cease sharing the first virtual object in the communication session (e.g., the visual indication is only selectable by the first user because the first user is sharing the first virtual object in the communication session). In some embodiments, from the perspective of the one or more users of the one or more computer systems in the communication session, the visual indication is displayed in the one or more three-dimensional environments with the first virtual object and is selectable to cease sharing the first virtual object in the communication session (e.g., all users in the communication session are permitted to cease sharing of the first virtual object in the communication session). Displaying a visual indication with a virtual object that is shared in a communication session that is selectable to cease sharing the virtual object in the communication session provides a respective user of a respective computer system in the communication session feedback that the virtual object is shared in the communication session and discretion regarding whether to share the virtual object in the communication session or not, thereby avoiding errors in interaction and improving user device interaction.

In some embodiments, while displaying the three-dimensional environment including the first virtual object, the first computer system displays a second virtual object in the three-dimensional environment concurrently with the first virtual object, wherein the first virtual object is shared with the one or more computer systems in the communication session and the second virtual object is not shared with the one or more computer systems in the communication session, such as shown by first computer system 101a concurrently displaying virtual object 1006a and virtual object 1004 in three-dimensional environment 1002a in FIGS. 10A and 10A1. In some embodiments, in a view of the communication session from a perspective of a second user of a second computer system of the one or more computer systems in the communication session, the first virtual object is displayed in a second three-dimensional environment (e.g., including one or more characteristics of the second three-dimensional environment described with reference to method 1100) and the second virtual object is not displayed in the second three-dimensional environment. In some embodiments, while displaying the three-dimensional environment including the first virtual object and the second virtual object, the first computer system detects a second input corresponding to a request to move a respective virtual object (e.g., the first virtual object or the second virtual object) relative to the first viewpoint of the user in the three-dimensional environment. In accordance with the second input being directed to the first virtual object, the first computer system optionally displays the first visual feedback in the three-dimensional environment while moving the first virtual object relative to the first viewpoint of the first user in the three-dimensional environment. In accordance with the second input being directed to the second virtual object, the first computer systems optionally displays the second visual feedback in the three-dimensional environment while moving the second virtual object relative to the first viewpoint of the first user in the three-dimensional environment. Displaying a first virtual object that is shared in a communication session in a three-dimensional environment with a second virtual object that is not shared in the communication session provides a respective user of a respective computer system in the communication discretion in interacting with content in the three-dimensional environment that is not shared in the communication session while simultaneously participating in the communication session, thereby improving user device interaction

In some embodiments, displaying the first visual feedback includes displaying movement of the second virtual object relative to the first viewpoint of the first user in the three-dimensional environment in accordance with the first input, such as the movement of virtual object 1004 shown in FIGS. 10D-10F while changing the spatial arrangement of virtual object 1006a. In some embodiments, displaying movement of the second virtual object relative to the first viewpoint of the first user in the three-dimensional environment in accordance with the first input includes one or more characteristics of displaying movement of the one or more virtual objects, different from the first virtual object, relative to the first viewpoint of the first user in the three-dimensional environment in accordance with the first input as described above. For example, displaying movement of the second virtual object relative to the first viewpoint of the first user in the three-dimensional environment includes maintaining a spatial arrangement between the first virtual object and the second virtual object while moving the first virtual object relative to the first viewpoint of the first user in the three-dimensional environment in accordance with the first input. In some embodiments, while receiving an input corresponding to a request to move the second virtual object in the three-dimensional environment, in accordance with the second virtual object being shared with the one or more computer systems in the communication session, the first computer system displays the first visual feedback while moving the second virtual object in the three-dimensional environment, wherein displaying the first visual feedback includes displaying movement of the second virtual object and the first virtual object relative to the first viewpoint of the first user in the three-dimensional environment in accordance with the input. Displaying movement in a three-dimensional environment of a virtual object that is not shared in a communication session while displaying movement of a respective virtual object that is shared in the communication session in response to a request to move the respective virtual object in the three-dimensional environment provides feedback to a user of a respective computer system in the communication session that the respective virtual object is shared in the communication session and enables a spatial relationship between the respective virtual object and the virtual object to be maintained despite the movement of the respective virtual object, thereby avoiding errors in interaction and improving user device interaction.

In some embodiments, displaying the second visual feedback does not include displaying movement of the first virtual object relative to the first viewpoint of the first user in the three-dimensional environment in accordance with the first input, such as shown by movement of virtual object 1004 not including movement of virtual object 1006a in FIGS. 10H-10J. In some embodiments, displaying the second visual feedback includes maintaining display of the first virtual object at the first location in the three-dimensional environment. In some embodiments, displaying the second visual feedback includes maintaining display of one or more virtual objects different from the first virtual object and the second virtual object at one or more locations that the one or more virtual objects are displayed at prior to detecting the first input. In some embodiments, in accordance with the first virtual object being not shared with the one or more computer systems in the communication session, only the first virtual object is moved relative to the first viewpoint of the first user in the three-dimensional environment in accordance with the first input (e.g., movement of one or more virtual objects different from the first virtual objects is not caused by (e.g., is independent of) the first input corresponding to the request to move the first virtual object). In some embodiments, while receiving an input corresponding to a request to move the second virtual object in the three-dimensional environment, in accordance with the second virtual object not being shared with the one or more computer systems in the communication session, the first computer system displays the second visual feedback while moving the second virtual object in the three-dimensional environment, wherein displaying the second visual feedback includes displaying movement of the second virtual object relative to the first viewpoint of the first user in the three-dimensional environment and does not include displaying movement of the first virtual object relative to the first viewpoint of the first user in the three-dimensional environment. Displaying movement in a three-dimensional environment of a virtual object that is not shared in a communication session while not displaying movement in the three-dimensional environment of a respective virtual object that is shared in the communication session provides a user discretion in changing a spatial arrangement of the virtual object without changing the spatial arrangement of the content that is shared with one or more computer systems in the communication session, thereby improving user device interaction.

In some embodiments, while moving the first virtual object away from the first location relative to the first viewpoint of the first user in the three-dimensional environment in accordance with the first input, in accordance with a determination that a location of the first virtual object corresponds to a movement limit in the three-dimensional environment, the first computer system ceases movement of the first virtual object past the movement limit in response to detecting further movement input for moving the first virtual object past the movement limit, such as first computer system 101a ceasing movement of virtual object 1006a in FIG. 10G in response to the input provided by first user 1042a in FIG. 10F. In some embodiments, the first computer systems ceases movement of the first virtual object past the movement limit independent of whether the first virtual object is share or not shared in the communication session. In some embodiments, the movement limit corresponds to the bounds of the three-dimensional environment (e.g., the three-dimensional environment is a respective size (e.g., a respective volume), and movement outside of the respective size of the three-dimensional environment is not permitted). In some embodiments, the movement limit corresponds to a threshold distance of movement (e.g., 1, 10, 20, 25, 30, 40, 50, 60, 70, 75, 80, 90 or 100 m) relative to the first location in the three-dimensional environment (e.g., movement that exceeds the threshold distance of movement from the first location in the three-dimensional environment is not permitted). In some embodiments, the movement limit corresponds to a relative region of the three-dimensional environment in the field of view of the first user from the first viewpoint (e.g., movement to a region of the three-dimensional environment not in the field of view of the first user from the first viewpoint is not permitted). In some embodiments, detecting further movement input for moving the first virtual object includes continuing to detect the first input corresponding to a request to move the first virtual object from the first location to the second location. For example, the second location is a location in the three-dimensional environment that is past the movement limit, and while moving the first virtual object from the first location to the second location, the movement limit is reached. In some embodiments, in accordance with the first virtual object being shared with the one or more computer systems in the communication session, ceasing movement of the first virtual object includes ceasing to display the first visual feedback in the three-dimensional environment. In some embodiments, in accordance with the first virtual object not being shared with the one or more computer systems in the communication session, ceasing movement of the first virtual object includes ceasing to display the second visual feedback in the three-dimensional environment. In some embodiments, ceasing movement of the first virtual object includes displaying an animation corresponding to the movement of the first virtual object reaching the movement limit. For example, the animation includes displaying resistance of movement of the first virtual object in the three-dimensional environment while the further movement input is received (e.g., the speed of movement of the first virtual object is reduced to not correspond with the further movement input (e.g., the speed of the hand movement associated with the further movement input does not correspond to the speed of movement of the first virtual object once the movement limit is reached)), and, after receiving the further movement input (e.g., the air gesture and/or the hand movement associated with the first input is no longer detected (e.g., the first user releases an air pinch shape with their hand)), the first virtual object is moved toward an opposite direction of the further movement input (e.g., in an opposite direction of the hand movement associated with the further movement input) such that the first virtual object is displayed at a location in the three-dimensional environment within the movement limit. Ceasing movement of a virtual object in a three-dimensional environment in response to an input to further move the virtual object that exceeds a movement limit provides feedback to a user that the user is requesting to move the virtual object to a location in the three-dimensional environment that is not permitted for interaction with the virtual object, and provides the user an opportunity to change the input to move the virtual object to an acceptable location in the three-dimensional environment, thereby avoiding errors in interaction and improving user device interaction.

In some embodiments, while moving the first virtual object away from the first location relative to the first viewpoint of the first user in the three-dimensional environment in accordance with the first input, in accordance with a determination that a location of the first virtual object corresponds to a movement limit (e.g., the movement limit has one or more characteristics of the movement limit described above) in the three-dimensional environment, the first computer system moves the first virtual object past the movement limit in response to detecting further movement input for moving the first virtual object past the movement limit (e.g., the further movement input for moving the first virtual object past the movement limit has one or more characteristics of the further movement input for moving the first virtual object past the movement limit as described above). In some embodiments, while moving the first virtual object past the movement limit in response to detecting the further movement input for moving the first virtual object past the movement limit, the first computer system displays resistance of movement of the first virtual object in the three-dimensional environment (e.g., including one or more characteristics of displaying resistance of movement of the first virtual object in the three-dimensional environment while the further movement input is received as described above) (e.g., first computer system 101a moves virtual object 1006a in the first dimension in response to the input provided by user 1042a in FIG. 10F).

In some embodiments, after moving the first virtual object past the movement limit, the first computer system detects an end of the first input, such as the termination of the input corresponding to the request to change the spatial arrangement of virtual object 1006a shown in FIG. 10G. In some embodiments, detecting the end of the first input corresponds to the first computer system ceasing to receive the first input (e.g., the first user of the first computer system ceases providing the first input to the first computer system). In some embodiments, detecting an end of the first input corresponds to detecting that the first user ceases performing an air gesture (e.g., the first user provides an air pinch during the first input, and detecting the end of the first input includes detecting that the thumb and the finger of the first user ceases contact). In some embodiments, detecting an end of the first input corresponds to ceasing to detect hand movement relative to the three-dimensional environment.

In some embodiments, in response to detecting the end of the first input while the first virtual object is outside of the movement limit, the first computer system displays the first virtual object at a location within the movement limit, such as shown by the display of virtual object 1006a at the location in three-dimensional environment 1002a in FIG. 10H. (e.g., moving the first virtual object back to a location that is within the movement limit, optionally a location that is at or near a boundary of the movement limit near where the first virtual object was located outside of the movement limit when the end of the first input was detected). In some embodiments, displaying the first virtual object at a location within the movement limit includes displaying movement of the first virtual object toward or in an opposite direction of the further movement input (e.g., in an opposite direction of the hand movement associated with the further movement limit). Displaying a virtual object in a three-dimensional environment within a movement limit of the three-dimensional environment after moving the virtual object past the movement limit in response to a user input corresponding to a request to move the virtual object in the three-dimensional environment provides feedback to a user that the user is requesting to move the virtual object to a location in the three-dimensional environment that is not permitted for interaction with the virtual object, and provides the user an opportunity to change the input to move the virtual object to an acceptable location in the three-dimensional environment, thereby avoiding errors in interaction and improving user device interaction.

In some embodiments, while detecting the first input and in accordance with the determination that the first virtual object is shared with the one or more computer systems in the communication session, in accordance with a determination that movement of the first virtual object relative to the communication session is permitted, in a view of the communication session from a perspective of a second user of a second computer system of the one or more computer systems, the first virtual object is moving relative to a second three-dimensional environment in accordance with the movement of the first virtual object from the first location to the second location relative to the first viewpoint of the first user in the three-dimensional environment, such as virtual object 1006a moving in three-dimensional environment 1002b in accordance with movement of virtual object 1006a being permitted in the communication session in FIGS. 10Z-10AA. In some embodiments, movement of the first virtual object relative to the communication session includes movement (e.g., movement of position and/or orientation) of the first virtual object relative to the first viewpoint of the first user in the three-dimensional environment and relative to a second three-dimensional environment viewed from the perspective of the second user of the second computer system in accordance with the first input (e.g., the second three-dimensional environment has one or more characteristics of the three-dimensional environment and is displayed by the second computer system (e.g., and is visible by the second user)). In some embodiments, movement of the first virtual object relative to the communication session includes movement of the first virtual object relative to one or more viewpoints (e.g., in a respective three-dimensional environment corresponding to the three-dimensional environment) of the one or more users of the one or more computer systems in the communication session with the first computer system (e.g., including relative to a current viewpoint of the user of the second computer system). In some embodiments, in accordance with the movement of the first virtual object relative to the communication session being permitted, the first computer system displays the second visual feedback in the three-dimensional environment while moving the first virtual object from the first location to the second location relative to the first viewpoint of the first user in the three-dimensional environment. In some embodiments, the movement of the first virtual object relative to the communication session is permitted based on user input (e.g., in response to detection of a user input, movement of the first virtual object relative to the communication session is permitted). In some embodiments, the movement of the first virtual object relative to the communication session is in accordance with the first virtual object being shared content of a first type (e.g., in accordance with the first virtual object being a virtual game shared in the communication session, movement of the first virtual object relative to the communication session is not permitted). In some embodiments, the movement of the first virtual object relative to the communication session is permitted in accordance with the movement of the first virtual object relative to the communication session being permitted by the one or more users of the one or more computer systems in the communication session with the first computer system. In some embodiments, in accordance with the movement of the first virtual object relative to the communication session being permitted, the first virtual object moves from the perspective of the second user in the second three-dimensional environment by the same amount (e.g., relative to velocity, distance, magnitude and/or change in orientation of the movement) compared to the movement of the first virtual object in the three-dimensional environment from the first viewpoint of the first user.

In some embodiments, while detecting the first input and in accordance with the determination that the first virtual object is shared with the one or more computer systems in the communication session, in accordance with a determination that movement of the first virtual object relative to the communication session is not permitted, in the view of the communication session from the perspective of the second user of the second computer system of the one or more computer systems, the first virtual object does not move relative to the second three-dimensional environment in accordance with the movement of the first virtual object from the first location to the second location relative to the first viewpoint of the first user in the three-dimensional environment, such as virtual object 1006a not moving in three-dimensional environment 1002b in accordance with movement of virtual object 1006a not being permitted in the communication session as shown in FIGS. 10A-10P. In some embodiments, in accordance with the determination that the movement of the first virtual object relative to the communication session is not permitted, the movement of the first virtual object has one or more characteristics of the change in spatial arrangement of the first virtual object relative to the first viewpoint of the first user as described with reference to method 1100. In some embodiments, in accordance with the determination that the movement of the first virtual object relative to the communication session is not permitted, the first computer system displays the first visual feedback in the three-dimensional environment while moving the first virtual object from the first location to the second location relative to the first viewpoint of the first user in the three-dimensional environment. In some embodiments, in accordance with the movement of the first virtual object relative to the communication session not being permitted, the first virtual object maintains its position (e.g., location and/or orientation) relative to the second three-dimensional environment from the perspective of the second user while the first virtual object moves from the first location to the second location relative to the first viewpoint of the first user in the three-dimensional environment. In some embodiments, in accordance with the movement of the first virtual object relative to the communication session not being permitted, the first computer system displays movement of the first virtual object relative to the first viewpoint of the first user in the three-dimensional environment in accordance with the first input and, from the perspective of the second user of the second computer system, movement of the first virtual object is not displayed relative to the second three-dimensional environment. In some embodiments, in accordance with the movement of the first virtual object relative to the communication session not being permitted, movement of the first virtual object is not displayed relative to the one or more viewpoints of the one or more users of the one or more computer systems in the communication session with the first computer system (e.g., including relative to the current viewpoint of the user of the second computer system. Initiating the display of movement of a virtual object in a communication session from the perspective of one or more users in the communication session in accordance with movement of the virtual object relative to the communication session being permitted ensures that the intent of a respective user of a respective computer system in the communication session is to move the virtual object relative to the communication session prior to initiating the display of the movement of the virtual object from the perspective of the one or more users, and provides an option to the respective user to display movement of the virtual object relative to the viewpoint of the respective user and not from the perspectives of the one or more users in the communication session, thereby avoiding errors in interaction and improving user device interaction.

In some embodiments, while displaying the three-dimensional environment including the first virtual object, the first computer system displays a virtual element in the three-dimensional environment that is selectable to change a current status of the virtual element, such as virtual element 1052 displayed in three-dimensional environment 1002a in FIGS. 10X-10AA. In some embodiments, while detecting the first input, in accordance with the determination that the first virtual object is shared with the one or more computer systems in the communication session, in accordance with the current status of the virtual element being a first status (e.g., such as the status of virtual element 1052 shown in FIGS. 10Z-10AA), the computer system permits movement of the first virtual object relative to the communication session, and in accordance with the current status of the virtual element being a second status (e.g., such as the status of virtual element 1052 shown in FIGS. 10X-10Y), different from the first status, the computer system forgoes permitting movement of the first virtual object relative to the communication session. In some embodiments, the computer system displays the virtual element in the three-dimensional environment in accordance with a determination that a respective virtual object included in the three-dimensional environment is shared with the one or more computer systems in the communication session (e.g., in accordance with a determination that the three-dimensional environment does not include a respective virtual object that is included in the communication session, the first computer system forgoes displaying the virtual element in the three-dimensional environment). In some embodiments, the virtual element is a virtual affordance (e.g., button and/or toggle) that displays visual feedback based on the current status. For example, in accordance with the virtual element having the first status, the virtual element is displayed with first visual feedback (e.g., the virtual element is displayed with a first color, and/or includes the text “ON” or “OFF”). For example, in accordance with the virtual element having the second status, the virtual element is displayed with second visual feedback (e.g., the virtual element is displayed with a second color, different from the first color, and/or includes different text (e.g., in accordance with the first status including “ON” text, the virtual element is displayed with “OFF” text when the current status is the second status, and, in accordance with the first status include “OFF” text, the virtual element is displayed with “ON” text when the current status is the second status)). In some embodiments, the virtual element is selectable through a selection input (e.g., including one or more characteristics of the selection input as described above). For example, the selection input includes gaze directed to the virtual element while an air gesture is concurrently performed. In some embodiments, the virtual element is displayed in the three-dimensional environment outside of the first virtual object (e.g., the virtual element is not included within the first virtual object from the first viewpoint of the first user). For example, the virtual element is displayed in a corner of a display area of the three-dimensional environment from the first viewpoint of the first user. Initiating the display of movement of a virtual object in a communication session from the perspective of one or more users in the communication session based on a current status of a virtual element ensures that the intent of a respective user of a respective computer system in the communication session is to move the virtual object relative to the communication session prior to initiating the display of the movement of the virtual object from the perspective of the one or more users, and provides the respective user discretion as to whether to display movement of the virtual object relative to the perspectives of the one or more users in the communication session, thereby avoiding errors in interaction and improving user device interaction.

In some embodiments, while detecting the first input and in accordance with the determination that the first virtual object is shared with the one or more computer systems in the communication session, in accordance with the first input corresponding to a first air gesture (e.g., such as the air gesture performed with hands 1008a and 1008b in FIG. 10S) the first computer system permits movement of the first virtual object relative to the communication session, and in accordance with the first input corresponding to a second air gesture different from the first air gesture (e.g., such as the air gesture performed by hand 1008a in FIG. 10E), the first computer system forgoes permitting movement of the first virtual object relative to the communication session. For example, the first air gesture is performed using a first portion of the first user (e.g., a first hand). For example, the first air gesture is performed using the first portion of the first user and a second portion of the first user (e.g., a second hand). In some embodiments, the first air gesture includes an air pinch, air tap, air drag or air long pinch (e.g., an air pinch for a threshold period of time (e.g., 0.1, 0.2, 0.5, 1, 2, 5 or 10 seconds). For example, an air pinch is performed by one or both portions of the first user (e.g., concurrently). For example, while performing the air pinch (e.g., after a threshold period of time (e.g., 0.1, 0.2, 0.5, 1, 2, 5 or 10 seconds), the first air gesture includes movement of the first portion and/or the second portion of the first user relative to the three-dimensional environment (e.g., corresponding to the requested movement of the first virtual object relative to the three-dimensional environment (e.g., and relative to the communication session)). In some embodiments, movement of the first virtual object from the perspective of the second user of the second computer system in the second three-dimensional environment corresponds to the movement of the first portion and/or second portion of the first user associated with the first air gesture. In some embodiments, the first computer system does not permit movement of the first virtual object relative to the communication session in accordance with the first input corresponding to an air gesture performed by the first portion of the first user and not the second portion of the first user. In some embodiments, the first computer system does not permit movement of the first virtual object relative to the communication session in accordance with the first input corresponding to an air gesture performed by the second portion of the first user and not the first portion of the first user. In some embodiments, the first computer system does not permit movement of the first virtual object relative to the communication session in accordance with the first input including an air gesture (e.g., performed by the first portion and/or second portion of the first user) that does not exceed the threshold period of time (e.g., an air pinch gesture that is held for less than the above-described threshold period of time, followed by movement of the air pinch gesture). In some embodiments, the first computer system does not permit movement of the first virtual object relative to the communication session in accordance with the first input including an air gesture that is different from the first air gesture (e.g., the first air gesture is an air pinch, and the second air gesture is an air tap). Initiating the display of movement of a virtual object in a communication session from the perspective of one or more users in the communication session based on a type of air gesture performed by a respective user of a respective computer system in the communication session ensures that the intent of the respective user is to move the virtual object relative to the communication session prior to initiating the display of the movement of the virtual object from the perspective of the one or more users, and provides the respective user discretion as to whether to display the movement of the virtual object relative to the perspective of the one or more users in the communication session when initiating the display of movement of the virtual object, thereby avoiding errors in interaction and improving user device interaction.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIGS. 13A-13F illustrate examples of a computer system providing visual feedback indicating audio provided by a participant of a communication session in accordance with some embodiments.

FIG. 13A illustrates a computer system 101a (e.g., an electronic device) displaying, via a display generation component (e.g., display generation component 120 of FIG. 1), a three-dimensional environment 1302 from a viewpoint of a user 1314 (e.g., facing the wall of the physical environment in which computer system 101 is located, as shown in the overhead view presented in legend 1319 of three-dimensional environment 1302). In some embodiments, computer system 101a includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the user interfaces illustrated and described below are implemented at head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user). In some embodiments, the user interfaces illustrated and described below are implemented at a computer system or device that does not include one or more sensors to detect movement of the user's hands and/or attention.

Computer system 101b, presented in the overhead view legend 1317, optionally is used by a participant of a communication session within a three-dimensional environment 1316 of the participant (e.g., a same or different physical environment that user 1314 is in during the communication session) that the user of computer system 101a is participating in. In some embodiments, computer system 101b has one or more characteristics similar or the same as one or more characteristics of computer system 101a, such as inclusion of a display generation component, one or more image sensors and/or one or more sensors to collect spatial data.

It is understood that the communication session described herein optionally is a real-time, or nearly real-time communication session mapping a three-dimensional environment 1302 of the user 1314 to three-dimensional environment 1316 of the user 1324, including real-time or nearly real-time communication of images (e.g., video) and/or audio provided by the user 1314 and the user 1324 to respective computer systems used to participant in the communication session. In some embodiments, the respective computer systems determine and/or provide information such as spatial data for another computer system (e.g., one or more servers) to map spatial data between the respective three-dimensional environments of user 1314 and user 1324. In some embodiments, in accordance with information provided by another computer system participating in the communication session, the computer systems 101a and 101b determines a mapping between three-dimensional environment 1302 and three-dimensional environment 1316, placing virtual content (e.g., virtual objects, visual representations of the other participants, and/or virtual textures overlaying physical portions of the three-dimensional environment) at same relative positions within the three-dimensional environment to simulate a sharing of a physical space, and sharing of physical objects and/or textures corresponding to the virtual content at same positions in the simulated, shared physical space. Similarly, the respective computer systems optionally display visual representations of other participants in the communication session at positions assigned to the other participants (e.g., similar or the same as described with reference to methods 800, 900, and/or 1400).

As shown in FIG. 13A, computer system 101a captures one or more images of the physical environment around computer system 101a (e.g., operating environment 100), including one or more objects in the physical environment around computer system 101a. In some embodiments, computer system 101a displays representations of the physical environment in three-dimensional environment 1302. For example, three-dimensional environment 1302 includes a representation of one or more physical objects in the physical environment of user 1314.

In FIG. 13A, three-dimensional environment 1302 also includes a virtual object 1304 (e.g., corresponding to virtual object 1304 in the top-down view of three-dimensional environment 1302 illustrated in legend 1319). In some embodiments, virtual object 1304 is a visual representation of a current viewpoint of user 1324 that is using computer system 101b to participate in a communication session with computer system 101. For example, as described with reference to methods 800 and/or 900, the computer system optionally displays a visual representation of the current viewpoint of user 1324 relative to three-dimensional environment 1316 of the user 1324. In some embodiments, the computer system 101a displays information associated with user 1324 of computer system 101b. For example, virtual object 1304 includes an annotation 1308, including initials associated with the user 1324 (e.g., initials of the user's name) and a nametag 1306 displayed beneath virtual object 1304.

In some embodiments, computer system 101a displays visual feedback corresponding to audio provided by user 1324. For example, in FIG. 13A computer system 101 displays visual feedback 1312 corresponding to audio such as speech and/or noises provided by user 1324 and communicated from computer system 101b. Visual feedback 1312 extends from an edge of a front-face of virtual object 1304 toward an internal border 1310 of visual feedback (e.g., the border(s) herein illustrative of different visual appearance(s) of visual feedback 1312), and overlaying the front-face of virtual object 1304, similar or the same as described further with reference to methods 800, 900 and/or 1400. In some embodiments, visual feedback 1312 is a simulated lighting effect, simulating a glowing light that is emanating from virtual object 1304 and/or cast onto the front surface of virtual object 1304. As described further with reference to method 1400, and/or with reference to the visual feedback such as the “simulated glow effect” and/or “simulated lighting effect” herein, the computer system 101a optionally displays—or forgoes display—of a directional bias of visual feedback 1312 to indicate a direction of attention of user 1324 relative to the current orientation of virtual object 1304. For example, in FIG. 13A, computer system 101a determines and/or obtains information that current orientation 1318 of virtual object 1304 (illustrated in legend 1319) is parallel to (e.g., is less than a threshold degree of offset from) the direction of attention 1320 of user 1324. To reflect an agreement between the current orientation 1318 of virtual object 1304 and the direction of attention (e.g., direction of the user's gaze, head, and/or torso relative to three-dimensional environment 1316, mapped to a direction relative to three-dimensional environment 1302), visual feedback 1312 is displayed uniformly, or nearly uniformly within the front-face of virtual object 1304. In some embodiments, the width of border 1310 (e.g., the portion(s) of virtual object 1304 consumed by visual feedback starting from an edge of virtual object 1304 toward border 1310) changes from a first width to a second width in accordance with a determination that the audio provided by user 1324 is a first or second level of audio (e.g., a volume of the audio). In some embodiments, the computer system 101a ceases display of visual feedback 1312 in accordance with a determination that user 1324 is not providing audio. In some embodiments, while not displaying the visual feedback, computer system 101a obtains information indicating audio is provided by user 1324, and in response, initiates display of and/or animates a growing or reducing of the size of visual feedback 1312 (e.g., increasing in width as the volume of the audio exceeds a zero-volume and/or generally increases, and decreasing in width as the volume of the audio decreases). As illustrated in FIGS. 13B and 13C, the computer system 101a optionally changes the visual feedback 1312 (e.g., with a directional bias) in accordance with changes in the direction of attention.

It is understood that computer system 101b optionally displays visual representations of other participants of the communication session, such as virtual object 1328—corresponding to user 1314 of computer system 101a—that has one or more characteristics of virtual object 1304, the one or more characteristics based on the current viewpoint of user 1314 relative to three-dimensional environment 1302. Additionally or alternatively, computer system 101b optionally presents visual feedback (e.g., indicative of audio provided by user 1314) corresponding to viewpoint 1326 and/or orientation 1332 relative to three-dimensional environment 1316 illustrated in overhead view legend 1317 of three-dimensional environment 1316. It is further understood that description herein of virtual objects, visual feedback presented with such virtual objects, and changing of the orientation and/or position of the virtual objects and/or changing of the visual feedback associated with such virtual objects, similar or the same to as described with reference to virtual object 1304, additionally or alternatively applies to other virtual objects displayed by computer system 101a, computer system 101b (based on information obtained by computer system 101b), and/or additional or alternative computer systems that are participating in the communication session with computer system 101a and/or computer system 101b, optionally concurrently (or nearly concurrently).

In some embodiments, computer system 101a displays additional or alternative virtual object(s). Such virtual object(s) optionally are a user interface of an application containing content (e.g., a plurality of selectable options), three-dimensional objects (e.g., virtual clocks, virtual balls, virtual cars, etc.) or any other element displayed by computer system 101a that is not included in the physical environment of display generation component 120. For example, in FIG. 13A, such virtual object(s) optionally are a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 1302, such as the content described below with reference to method 1400.

In some embodiments, virtual objects are displayed in three-dimensional environment 1302 with respective orientations relative to a viewpoint of user 1314 (e.g., prior to receiving input interacting with the virtual objects, in three-dimensional environment 1302). As shown in FIG. 13A, the virtual object 1304 optionally has a first orientation in the three-dimensional environment 1302 (e.g., the front-facing surface of the virtual object 1304 that faces the viewpoint of user 1314 is flat relative to the viewpoint of user 1314). It should be understood that the orientation of the object in FIG. 13A is merely exemplary and that other orientations are possible.

From FIG. 13A to FIG. 13B, computer system 101a obtains information that the direction of attention 1320 in FIG. 13B is partially offset relative to a current orientation 1318 of virtual object 1304, and updates visual feedback 1312 to include a directional bias. For example, a border of 1334 in FIG. 13B is different from the border 1310 of visual feedback 1312 in FIG. 13A, indicating that portions of virtual object 1304 consumed by the visual feedback on left one or more portions of a front-face of virtual object 1304 are relatively larger than right one or more portions of the front face of virtual object 1304. Such a changing in visual feedback 1312—at times referred to herein as a “directional bias” of the visual feedback 1312—optionally includes increasing an area and/or volume of a portion of virtual object 1304 consumed by the visual feedback. For example, in FIG. 13B, the direction of attention 1336 changes to correspond to a portion of three-dimensional environment 1302 that is relatively to the left of a reference point (e.g., a center) of virtual object 1304, as illustrated in the legend 1319. In some embodiments, in accordance with a determination that the direction of attention 1336 has changed less than a threshold amount (e.g., has rotated less than 3, 5, 7, 10, 12.5, 15, 17.5, 20, 25, or 30 degrees relative to the reference point), the computer system forgoes rotating of virtual object 1304. For example, an angle formed on a plane parallel to a floor of the three-dimensional environment 1302 illustrated in the overhead legend 1319, between direction of attention 1336 and the current orientation 1318 of virtual object 1304 optionally is less than the threshold amount (e.g., threshold angle). In FIG. 13B, computer system 101a optionally changes the visual feedback 1312, such as increasing an area of the front-face of virtual object 1304 consumed (e.g., including) visual feedback 1312, in response to obtaining information such as an indication of audio from user 1324, to indicate the degree of offset between direction of attention 1336 and the current orientation 1318 of virtual object 1304. It is understood that the visual feedback optionally changes in magnitude, such as an increase in a portion (e.g., a left portion in FIG. 13B, relative to the reference point) of the virtual object 1304 that includes visual feedback 1312. For example, the computer system 101a optionally increases the degree to which border 1334 extends towards the reference point of virtual object 1304, optionally including one or more visual peaks. In some embodiments, visual characteristics such as brightness, saturation, contrast, and/or an opacity of the visual feedback 1312 is increased at the portion of virtual object 1304 that corresponds to the direction of attention of the user (e.g., direction of attention 1336).

In some embodiments, the computer system forgoes modification, and/or decreases a magnitude of the visual feedback 1312 at one or more portions of the virtual object 1304 that does not correspond to the direction of attention of the user relative to the reference point of virtual object 1304. For example, in FIG. 13B, computer system 101a optionally decreases a width, area, and/or volume of visual feedback 1312 displayed at (e.g., overlaying and/or consuming) one or more right-portions of virtual object 1304 relative to the reference point of virtual object 1304 (e.g., the center).

From FIG. 13B to FIG. 13C, the current viewpoint of user 1324 changes relative to three-dimensional environment 1316 while user 1324 is providing information (e.g., an indication of audio) to computer system 101a, and computer system 101a updates visual feedback 1312 to visually indicate an updated degree of offset of direction of attention 1340 relative to the current orientation of virtual object 1304. For example, direction of attention 1340 illustrated in the overhead view legend 1319 in FIG. 13C indicates that the current viewpoint of the user 1324 has rotated relatively to the right of the current orientation 1318 of the virtual object 1304 (e.g., as observed from the current viewpoint of user 1314). Computer system 101 updates border 1338 of visual feedback 1312 in FIG. 13C, to visually indicate the direction of attention has changed (e.g., less than the threshold amount of change in direction of attention described with reference to FIG. 13B) away from the reference point. Similarly as described with reference to FIG. 13B, in FIG. 13C, computer system 101a forgoes movement (e.g., rotation) of virtual object 1304 in response to obtaining information that the direction of attention 1340 is offset from the current orientation 1318 of virtual object 1304, due to the degree of offset relative to current orientation 1318 in FIG. 13C being less than a threshold degree of offset. Similar or the same as described with reference to border 1334 in FIG. 13B, border 1338 of visual feedback 1312 optionally indicates a change in magnitude and/or directional bias of the visual feedback 1312 configured to visually indicate the degree and/or magnitude of offset between the direction of attention 1340 and the current orientation 1318 of virtual object 1304. In FIG. 13C, the border 1338 is relatively greater in magnitude along the right one or more portions of visual feedback 1312 (e.g., relative to a reference point (e.g., center) of virtual object 1304), compared to left one or more portions of visual feedback 1312, to visually indicate that direction of attention 1340 corresponds to a position within three-dimensional environment 1302 to the right of the current orientation 1318. As illustrated in the overhead view legend 1319, the direction of attention 1320 in FIG. 13C—corresponding to the current viewpoint and/or direction of attention of user 1324 in overhead legend 1317—optionally is offset (e.g., rotated) away from the current orientation 1318 of virtual object 1304.

In some embodiments, computer system 101a displays changes in visual feedback 1312 while the direction of attention of user 1324 changes, and while maintaining an orientation of the virtual object 1304, until the direction of attention changes an amount greater than a threshold amount. For example, computer system 101a optionally maintains the current orientation 1318 of virtual object 1304 from FIGS. 13A-13C, while changing the magnitude of the visual feedback 1312 from FIGS. 13A-13C with a directional bias to indicate a current degree of offset between the current orientation 1318 and the direction of attention of user 1324. It is understood that description of changing the directional bias presented herein merely exemplary, and optionally includes changing the directional bias along two or more dimensions of the virtual object 1304 (e.g., upwards or downwards relative to the reference point of virtual object 1304, such as a center of virtual object 1304 and/or a center of a front face of virtual object 1304, and/or along a depth of the virtual object relative to the three-dimensional environment 1302).

From FIG. 13C to FIG. 13D, computer system 101a detects a change in direction of attention of user 1324 that exceeds a threshold amount of change, and updates the current orientation 1344 of the virtual object 1304 in accordance with the change in direction of attention of user 1324. For example, in FIG. 13D, computer system 101a rotates virtual object 1304 such that the front-face of virtual object 1304 is off-angle (e.g., no longer perpendicular, in overhead view legend 1319) relative to the current viewpoint of user 1314) in response to obtaining information that the current viewpoint of user 1324 (and/or the direction of attention of user 1324) has changed an amount greater than the threshold amount described herein (e.g., has rotated greater than 3, 5, 7, 10, 12.5, 15, 17.5, 20, 25, or 30 degrees relative to the reference point). In FIG. 13D, as illustrated in the legend 1319 and legend 1317, the current orientation 1344 of virtual object 1304 matches (e.g., is parallel to) the direction of attention 1346a of the user 1324. In some embodiments, until computer system 101a detects that the direction of attention 1346a in FIG. 13D has remained unchanged, or nearly unchanged for a period of time greater than a threshold period of time (e.g., 0.5, 1, 1.5, 2, 2.5, 3, 5, or 10 seconds), computer system 101a continues to update the current orientation 1344 in accordance with changes to direction of attention 1346a. In some embodiments, while the current orientation 1344 of virtual object 1304 matches the direction of attention 1346a, computer system 101a displays visual feedback 1312 with a uniform, or nearly uniform appearance, such as with border 1342 that is similar or the same as border 1310 illustrated in FIG. 13A, presented as visual feedback 1312 was overlaying a physical object-corresponding to virtual object 1314—that has been physically rotated in three-dimensional environment 1302 in FIG. 13D. For example, the border 1342 of visual feedback 1312 in FIG. 13D optionally has a uniform, or nearly uniform width that increases or decreases in response to changes in a level of audio provided by user 1324). In some embodiments, computer system 101a displays virtual object 1304 tracking changes in viewpoint and/or direction of attention of user 1324, at least until one or more criteria are satisfied, such that the current orientation of virtual object 1304 change in real-time, or nearly real-time, in accordance with changes to the viewpoint and//or direction of attention of user 1324.

From FIG. 13D to FIG. 13E, computer system 101a determines that virtual object 1304 satisfies one or more criteria, including a criterion that is satisfied when the direction of attention of the user has remained unchanged—or nearly unchanged—for a period of time greater than the threshold period of time described with reference to FIG. 13D. In response to the satisfaction of the one or more criteria, computer system 101a optionally determines that the current orientation 1344 of virtual object has come to rest, and optionally indicates changes in direction of attention of user 1324 having a degree of offset less than a threshold degree of offset using visual feedback 1312, optionally without rotating virtual object 1304. For example, computer system 101a in FIG. 13D obtains information that direction of attention 1349 of the user 1324 is a first degree of offset, relatively to a left of the reference point visible to user 1314 (e.g., to the left of the center of the front-face of virtual object 1304, as observed by user 1314), and displays visual feedback 1312 with a border 1350, visually indicating that the direction of attention 1349 is to a left of the current orientation 1344 of the front-face of virtual object 1304 in response to obtaining information indicating audio has been provided by user 1324. Such changes in visual appearance of the visual feedback 1312 optionally have one or more characteristics of the visual appearance of visual feedback 1312 described with reference to FIG. 13B, based on the updated, current orientation 1344 of virtual object 1304 in FIG. 13E. In FIG. 13D, and throughout FIGS. 13A-13F, it is understood that the virtual object 1304 optionally is moveable relative to three-dimensional environment 1302. For example, in response to obtaining information that the current viewpoint of the user 1324 has moved relative to the three-dimensional environment (e.g., along one or more dimensions (e.g., axes) of three-dimensional environment 1316 and/or 1302, different from a dimension (e.g., axis of rotation) that computer system 101a uses to determine directional biasing of visual feedback 1312), the computer system optionally moves the virtual object 1304 in accordance with the changes in the current viewpoint of the user 1324, similar or the same as described with reference to methods 800 and/or 900. For example, translational indicators 1348 optionally is indicative of the movement of virtual object 1304 within the three-dimensional environment 1302, optionally while a spatial relationship between the current orientation 1344 of virtual object 1304 and the direction of attention 1349 in FIG. 13E are maintained.

From FIG. 13E to FIG. 13F, computer system 101a obtains information indicating that the direction of attention of user 1324 has changed relative to the current orientation of virtual object 1304, and computer system 101a obtains information indicative of audio provided by user 1324. Similar to as described with reference to FIG. 13C, computer system 101a in FIG. 13F displays visual feedback 1312 with a border 1352 indicating that the direction of attention 1354 has a degree of offset relative to the current orientation 1344 of the virtual object 1304, in particular, relatively to a right side of the current orientation 1344 as illustrated in the legend 1319. In response to obtaining the information indicating the relatively subtle change in direction of attention and the indication of audio, computer system 101a maintains the current orientation 1344 in FIG. 13F (e.g., relative to FIG. 13E), and optionally displays a right-side directional bias of visual feedback 1312, indicating the degree of offset.

Thus, in some embodiments, the computer system 101a obtains information (e.g., while audio information is being provided by another participant) indicating a change in direction of attention and/or viewpoint of another participant of the real-time communication session. In some embodiments, in response to obtaining the information, and in accordance with a determination that the change in direction of attention exceeds a threshold amount of change (e.g., greater than a 5, 7.5, 10, 12.5, 15, 17.5, 20, 25, or 30 degrees rotating along an axis perpendicular to a floor of the three-dimensional environment), the computer system updates a current orientation of a virtual object that is a visual representation of the participant, and displays visual feedback indicating the audio with a first visual appearance. In some embodiments, in response to obtaining the information, and in accordance with a determination that the change in direction does not exceed the threshold amount of change, the computer system maintains the current orientation of the virtual object, while displaying the visual feedback with a second visual appearance, including a directional bias that was not included in the first visual appearance. In some embodiments, the computer system updates the current orientation of the virtual object in response to obtaining the information by ana interval of rotation (e.g., intervals of 5, 10, 15, 20, 25, 30, 35, 40, or 45 degrees) relative to the current orientation in accordance with the determination that the change in direction of the participant exceeds the threshold change. For example, the computer system optionally rotates the virtual object in 5 degree intervals (e.g., 5, 10 15, 20, or 25 degrees away from a current orientation of the virtual object, in accordance with a determination that the offset between the direction of attention and the current orientation of the virtual object is closest to a respective interval of rotation). In some embodiments, in response to obtaining the information, and in accordance with the determination that the change in direction does not exceed the threshold change, the computer system directionally biases the visual feedback. For example, when the change in direction of attention of the participant changes from 0-4 degrees away from the current orientation of the virtual object, the computer system directionally biases the feedback in accordance with a determination that the interval of rotation of the virtual object is 5 degrees.

In some embodiments, computer system 101a displays the visual representations with an ambient oscillation animation, such as oscillating upwards away from a floor of the three-dimensional environment, and downwards toward the floor of the three-dimensional environment. In some embodiments, the oscillation animation is displayed while the computer system 101a is not obtaining information indicating audio provided by user 1324. In some embodiments, in response to obtaining such information indicating audio, the computer system decelerates the oscillation animation, until virtual object 1304 comes to rest. In some embodiments, the virtual object 1304 remains at rest (e.g., the computer system forgoes the oscillation animation) until information indicating audio provided by user 1324 is no longer being obtained, at which time computer system 101a resumes the oscillation animation.

FIG. 14 is a flowchart illustrating an exemplary method 1400 of displaying visual feedback indicating audio provided by a participant of a communication session in accordance with some embodiments. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, a method 1400 is performed at a computer system in communication with one or more input devices and a display generation component, such as computer system 101 in FIG. 13A. For example, the computer system, the one or more input devices, and/or the display generation component have one or more characteristics of the computer system(s), the one or more input devices, and/or the display generation component(s) described with reference to methods 800, 900, 1100, and/or 1200.

In some embodiments, while a user of the computer system is participating in a communication session (1402a), such as a communication session between computer system 101a and computer system 101b in FIG. 13A, with a first participant of the communication session, such as user 1324 in FIG. 13A, the computer system displays (1402b), via the display generation component, a visual representation of the first participant within a three-dimensional environment, such as virtual object 1304 in FIG. 13A, wherein the visual representation is a first type of visual representation (e.g., a type of visual representation described with reference to methods 800 and/or 900), and wherein the visual representation has a first spatial arrangement (e.g., position and/or orientation) relative to a current viewpoint of the user of the computer system, such as a spatial arrangement between virtual object 1304 and the current viewpoint of the user 1314 in FIG. 13A. In some embodiments, while displaying the visual representation of the first participant within the three-dimensional environment, the computer system obtains (1402c) first information including an indication of audio provided to the communication session by the first participant, such as information provided by user 1324 in FIG. 13A. For example, the communication session has one or more characteristics of the communication session(s) described with reference to methods 800, 900, 1100, and/or 1200, and the three-dimensional environment has one or more characteristics of the three-dimensional environment(s) described with reference to methods 800, 900, 1100, and/or 1200. In some embodiments, respective computer systems participating in the communication session display a visual representations of other participants of the communication session. For example, the computer system (e.g., the first) optionally displays a visual representation of the first participant having one or more characteristics of the visual representation of participants described with reference to methods 800, 900, 1100, and/or 1200 at a position currently assigned to and/or corresponding to the first participant. In such embodiments, the visual representation optionally is a first type of representation that includes or corresponds to a polygonal representation of the user (e.g., a sphere, a virtual coin, a prism, and/or accompanied by information associated with the first participant), similar or the same as described further with reference to method 800. In some embodiments, the visual representation is a second type of representation that includes or corresponds to an expressive representation, such as an avatar including portions of the representation that move relative to one another, including but not limited to virtual body parts that move relative to one another, similar or the same as described further with reference to method 900. In some embodiments, the second computer system detects and/or facilitates detection of audio provided by the first participant, such as the user speaking, making noise, and/or singing (e.g., via a microphone at the second computer system). In response to detecting the audio, the second computer system optionally communicates information such as a digitized recording of the user's speech, noise, and/or singing to the first computer system (optionally via a server or other intervening device).

In some embodiments, in response to obtaining the first information and in accordance with a determination that information obtained about a direction of attention of the first participant satisfies one or more first criteria (1402d), such information about the direction of attention 1320 in FIG. 13A and/or the direction of attention 1336 in FIG. 13B, the computer system maintains (1402e) display of the visual representation of the first participant, wherein the visual representation is the first type of visual representation, and the visual representation has the first spatial arrangement relative to the current viewpoint of the user of the computer system, such as the maintained display of virtual object 1304 in FIG. 13B. For example, the computer system maintains display the first visual representation of the first type at a same position and/or orientation relative to the current viewpoint of the user and/or relative to the three-dimensional environment in response to obtaining the information. In some embodiments, the current viewpoint of the user relative to the three-dimensional environment is maintained before, in response to, and/or after the obtaining the information. In some embodiments, maintaining display of the visual representation of the first participant includes maintaining a position of the visual representation relative to a first one or more axes (e.g., an X and Z axis defining a plane parallel to a floor of the three-dimensional environment and/or parallel to eyes of the user) and oscillating and/or otherwise moving the visual representation along a second set of one or more axes (e.g., a Y axis extending perpendicular to the plane parallel to the floor described previously).

For example, the computer system optionally obtains first information indicative of speech and/or sound of the first participant. In some embodiments, the computer system performs one or more operations to visually indicate the first information and/or the direction of attention of the first participant, the direction of attention included in the first information and/or determined in accordance with current or previous knowledge of the direction of attention of the first participant separate from the first information. In some embodiments, the second computer system detects a direction of a head, torso, one or more eyes, one or more fingers, limbs, a directional input applied to an input device (e.g., a trackpad, a joystick, and/or a non-touch sensitive surface monitored by the computer system via one or more input devices) and/or some combination thereof to determine the direction of the attention of the first participant. In some embodiments, the first information indicates and/or the computer system uses the first information to determine the direction of attention relative to a reference orientation of the first participant. The reference orientation optionally is an orientation of the visual representation of the first participant relative to the three-dimensional environment, optionally different from the current direction of attention of the first participant. For example, the reference orientation optionally is a position and/or orientation of the first participant relative to the three-dimensional environment when the first participant first enters the communication session, when the first participant first is displayed relative at the computer system, when the first participant provides an input (e.g., pressing of a button, a voice command, and/or an air gesture performed by one or more body parts of the user described further herein), and/or when the first participant remains corresponding to (e.g., the first participant has not changed) their current viewpoint for a period of time greater than a threshold period of time (e.g., 0.1, 0.5, 0.75, 1, 1.25, 1.5, 2, 3, or 5 seconds). In some embodiments, the reference orientation corresponds to a current orientation of the visual representation of the first participant relative to the three-dimensional environment. In some embodiments, the second computer system detects and/or determines the direction of attention of the first participant in a similar or same manner as described with reference to the computer system herein.

In some embodiments, in accordance with a determination that the information indicates attention of the first participant satisfies one or more criteria, including a criterion satisfied when the direction of the attention is within a threshold angle (e.g., 0, 1, 2, 5, 7.5, 10, 12.5, 15, 17.5, or 20 degrees) of the current orientation of the visual representation of the first participant in the three-dimensional environment (e.g., a vector extending perpendicularly from a front surface of the visual representation, such as described with reference to method 800), the computer system displays respective visual feedback while maintaining display of the visual representation at its current/prior position and/or orientation. For example, an angle of the direction of attention is optionally determined based on a two vectors: a first vector extending between the position of the visual representation and a position where the attention is directed to (e.g., where attention of the first participant is currently or recently targeting) relative to the three-dimensional environment, and a second vector extending from the center of the front surface of the visual representation of the first participant (e.g., based on the reference orientation of the first participant described above, such as starting from a center of the visual representation, and extending outward along a line centered with the front surface of the visual representation, and/or parallel to a floor of the three-dimensional environment of the first participant). In some embodiments, the angle between the vectors is projected onto a plane (e.g., a plane parallel to a floor of the three-dimensional environment and/or parallel to the eyes of the user, and/or parallel to a plane perpendicular to a floor of the three-dimensional environment), and the projection is compared to the threshold angle by the computer system. In some embodiments, the computer system detects a plurality of projected angles based on the direction of attention projected on to different respective planes, and presents visual feedback in accordance with the plurality of projected angles. It is understood that description of embodiments herein with reference to angles of direction of attention of the first participant optionally apply to the projected angles, dependent upon context of description.

In some embodiments, in response to obtaining the first information and in accordance with a determination that information obtained about a direction of attention of the first participant satisfies one or more first criteria (1402d), in accordance with a determination that the information obtained about the direction of attention of the first participant indicates that the direction of the attention of the first participant is a first direction, such as direction of attention 1320 in FIG. 13A, the computer system presents (1402f) first visual feedback associated with the audio provided by the first participant relative to the visual representation of the first participant, wherein the first visual feedback has a first visual appearance (e.g., has a first directional bias in a first feedback direction that corresponds to the first direction of the attention of the first participant), such as visual feedback 1312 as shown in FIG. 13A. For example, the computer system optionally presents visual feedback that varies in appearance based on the direction of the attention of the first participant (e.g., relative to the current orientation of the visual representation of the first participant). In some embodiments, the first visual feedback includes a first simulated lighting and/or a first glow animation effect (the glow animation having one or more characteristics of the “glow effect” described with reference to step(s) 1402). In some embodiments, the computer system displays the first visual feedback including the glow effect along a portion of an internal periphery of the visual representation in accordance with the direction of attention relative to the reference orientation. For example, the computer system optionally displays the three-dimensional (e.g., spatial) coin-shaped visual representation and optionally displays a glowing effect applied to interior and/or exterior areas and/or borders of a first circular face of the coin, where the first circular face is oriented generally in a similar direction to the direction of attention of the first participant (similar or the same as described with reference to method 800 regarding a correspondence between a position and/or orientation of the first participant, and a corresponding position and/or orientation of a visual representation of the first participant). In some embodiments, portions of the coin subject to simulated illumination by the computer system vis-à-vis the glowing effect correspond to the direction of the attention. For example, when the first participant's attention is directed to a portion of the shared three-dimensional environment that is relatively to the right of the orientation of the visual representation of the first participant, the computer system displays the first visual feedback (e.g., the glowing effect) on one or more right-of-center portions of the first circular face of the coin (e.g., relative to the current orientation of the visual representation of the first participant). Thus, the computer system optionally presents visual feedback (e.g., a glowing effect) on a side of the visual representation to indicate an attention direction without requiring display of a representation of eyes of the user (e.g., eyes gazing in a direction of attention of the user), and visually indicates subtle shifts (e.g., shifts less than the above-described threshold amounts) in direction of attention away from the orientation of the visual representation of the first participant without requiring rotation of the visual representation.

In some embodiments, in response to obtaining the first information and in accordance with a determination that information obtained about a direction of attention of the first participant satisfies one or more first criteria (1402d), in accordance with a determination that the information obtained about the direction of attention of the first participant indicates that the direction of the attention of the first participant is a second direction, different from the first direction, such as direction of attention 1336 in FIG. 13B, the computer system presents (1402g) second visual feedback associated with the audio provided by the first participant relative to the visual representation of the first participant, wherein the second visual feedback has a second visual appearance (e.g., has a second directional bias in a second feedback direction that corresponds to the second direction of the attention of the first participant and is different from the first directional bias), different from the first visual appearance, such as visual feedback 1312 as shown in FIG. 13B. For example, in accordance with a determination that the attention (e.g., gaze, head, and/or body position) of the first participant corresponds to a second direction (e.g., relatively to a left side of a center of the orientation of the visual representation of the first participant), the computer system optionally displays a glowing effect applied to one or more left-of-center portions of the coin-shaped visual representation (e.g., relative to the current orientation of the visual representation of the first participant), and optionally forgoes display of the glowing effect applied to the one or more right-of-center portions of the coin-shaped visual representation.

In some embodiments, the visual feedback is displayed overlaying one or more borders, within a body or surrounding the visual representation of the first participant. In some embodiments, the one or more portions of the visual feedback are displayed along an entirety of a border of the visual feedback, and a magnitude of the visual feedback is biased (e.g., greater in magnitude) on a side of the visual representation corresponding to the direction of attention. For example, the computer system optionally displays the visual representation with the glowing effect along all portions and/or edges of the visual representation, where areas and/or volumes of the visual representation including the visual feedback and matching a direction of attention relative to a center of the visual representation are relatively greater than one or more respective areas and/or volumes of the visual representation not matching the direction of attention (e.g., when attention of the first participant extends to the left of center of the visual representation, the right portions of the first circular face of the coin-shaped visual representation are greater consumed by the glowing effect). It is understood that description of embodiments referencing the first participant optionally applies to embodiments including one or more other participants participating in the communication session, and that description referencing representations of the first participant optionally applies to embodiments including representations of the one or more other participants. Displaying visual feedback based on a direction of attention of the first participant indicates a spatial relationship between a target of the first participant's attention and the current orientation of the representation of the first participant, thus reducing the need for rotation of the visual representation to convey relatively modest changes in direction of attention of the first participant, thereby reducing processing required to perform operations displaying the change in direction of attention.

In some embodiments, in response to obtaining the first information and in accordance with the determination that the one or more first criteria are satisfied (for example, as described further with reference to step(s) 1402), such as the information corresponding to direction of attention 1336 in FIG. 13B and/or direction of attention 1340 in FIG. 13B, in accordance with a determination that an offset corresponding to the direction of attention relative to a current orientation of the visual representation is a first degree of offset, such as an angle and/or offset between direction of attention 1336 and the current orientation 1318 in FIG. 13B, the computer system displays the first visual feedback with a third visual appearance indicating the first degree of offset, such as the visual appearance of visual feedback 1312 in FIG. 13B. For example, the computer system optionally determines a difference in position, orientation, and/or pose of one or more parts of the user's body, a difference in position and/or orientation of an indication of the direction of attention (e.g., a contact on a surface (e.g., a touch-sensitive or non-touch sensitive surface)), and/or a cursor controlled by a peripheral device (e.g., a stylus, pointing device, mouse, and/or wearable device) relative to the current orientation of the visual representation of the participant (e.g., relative to a reference vector, such as a vector extending from a center of the visual representation, optionally parallel to a floor of the three-dimensional environment, and/or optionally normal to a surface included in the visual representation (e.g., a face of a virtual coin and/or polygon visible to the user having the current viewpoint) and/or a surface of a bounding volume (e.g., rectangular prism) that is optionally not displayed, and optionally surrounds the dimensions of the visual representation), as described further with reference to step(s) 1402, and displays a magnitude of visual feedback corresponding to a degree of the difference. For example, the computer system optionally detects that an angle of direction of attention (described with reference to step(s) 1402) correspond is a first value, corresponding to a first degree of offset, and displays the third visual appearance (e.g., the first visual feedback including a visual effect, such as a simulated glowing effect, with a first magnitude and/or direction relative to a portion (e.g., center and/or border) of the visual representation).

It is understood that the directional bias of the visual feedback described herein optionally corresponds to the direction of attention of the user relative to the current orientation of the visual representation of the participant, and consequentially, the degree of offset indicated by the visual feedback. For example, the directional biasing of the visual feedback optionally includes increasing a magnitude of visual feedback in a direction corresponding to the direction of the attention. As an example, when attention of the user is directed to a position in the three-dimensional environment, based on the angle formed between the direction of attention of the user and the current orientation of the visual representation of the participant described with reference to step(s) 1402 (e.g., the angle corresponding to a degree of offset), the computer system displays a magnitude of visual feedback that is based on the angle (e.g., a relatively greater magnitude when the angle is relatively larger, and a relatively smaller magnitude when the angle is relatively smaller) overlaying, including, and/or surrounding a region of the visual representation intersecting that vector. For example, in accordance with a determination that the vector corresponding to the direction of attention is to a first perceived lateral side of a reference point (e.g., a line vertically bisecting or otherwise dividing a polygonal face of the visual representation of the participant), the computer system optionally displays a simulated glowing effect consuming a greater area and/or volume relative to the reference point (first perceived lateral side of the visual representation), as compared to the simulated glowing effect consuming an area and/or volume on a second perceived lateral side of the visual representation that opposes the first perceived lateral side (e.g., relative to the bisecting and/or diving line). In some embodiments, the third visual appearance includes displaying the first visual feedback with a magnitude that is different from (e.g., greater or less than) displaying the first visual feedback with the third visual appearance.

In some embodiments, in response to obtaining the first information and in accordance with the determination that the one or more first criteria are satisfied in accordance with a determination that the offset corresponding to the direction of attention relative to the current orientation of the visual representation is a second degree of offset, different from the first degree of offset, such as a further off-angle and/or offset between direction of attention 1336 and the current orientation 1318 in FIG. 13B, the computer system displays the first visual feedback with a fourth visual appearance indicating the second degree of offset, different from the third visual appearance. For example, the computer system optionally displays a second magnitude of the visual feedback (e.g., glowing effect) that is different from (e.g., greater or less than) the first magnitude of the glowing effect to visually indicate the different (e.g., greater or lesser) degree of the offset (e.g., the second degree of offset), and optionally in accordance with a determination that a direction of the second degree of the offset is the same as described with reference to the first degree of offset. Thus, in some embodiments, the computer system displays a magnitude of visual feedback that indicates the degree of offset between the direction of attention of the participant, and the current orientation of the visual representation of the participants. It is understood that description of “right” or “left” portions of the visual representation of the participant and/or the three-dimensional environment are merely exemplary terms of convenience, and not in any way limiting. For example, a relatively “right” portion of the visual representation is optionally understood as a portion of the visual representation of the participant to the right side of a reference point (optionally not displayed). Displaying the visual representation of the participant with a visual appearance indicative of a degree of offset between the direction of attention and the current orientation of the visual representation of the participant reduces processing required to animate rotation of the visual representation based on changes to the degree of offset.

In some embodiments, the first visual feedback includes a first simulated glowing effect, and the second visual feedback includes a second simulated glowing effect, such as a simulated glowing effect included in visual feedback 1312 such as shown in FIG. 13A. In some embodiments, the glow effect includes an annular (e.g., ring-shaped) glow effect applied to a circular and/or elliptical face of a coin-shaped visual representation of the participant, similar or the same as described with reference to methods 800 and/or 900, in accordance with a determination that the degree of offset is less than a threshold offset (e.g., less than 0.1, 0.2, 0.3, 0.5, or 1 degree between the direction of attention and the current orientation of the visual representation of the participant). In some embodiments, the first visual feedback includes a simulated lighting effect, such as one or more virtual light sources (e.g., displayed, or not displayed in the three-dimensional environment) directed toward the visual representation of the participant. For example, the computer system optionally displays a simulated lighting effect creating a simulated glowing effect, mimicking the appearance of one or more light sources placed within and/or behind the visual representation relative to a current viewpoint of the user, causing the visual representation to have a simulated glow.

In some embodiments, the magnitude (e.g., virtual area and/or volume where the glowing effect is displayed) is expanded along one or more dimensions of the visual representation of the participant to indicate the degree of offset. For example, in accordance with a determination that the direction of the attention is relatively left of a center of the visual representation (e.g., the circular and/or elliptical front face of the coin), and the degree of the offset is the first degree of offset, the glowing effect is expanded to consume a first area and/or volume of the visual representation of the participant. In some embodiments, the growth of the glow effect is proportional and/or otherwise based on the degree of the offset. For example, the computer system optionally displays a left-half of a front face of the visual representation consumed by a first magnitude (e.g., 5, 10, 15, 20, 25, 30, or 50% of the area of the front face of the visual representation) of the glow effect when the direction of the attention is the first degree of offset relative to the left of the current orientation of the visual representation, and optionally displays the glow effect consuming an annular portion of a right-half of the front face of the visual representation.

In some embodiments, the first visual feedback and the second visual feedback respectively indicate that the direction of attention of the participant is directionally biased (e.g., toward or away from) a corresponding portion of the visual representation of the participant. For example, the first visual feedback optionally includes a first directional bias toward a first portion of the visual representation of the participant. The first portion optionally corresponds to a portion of a simulated surface of the virtual object (e.g., a half and/or another portion of a face of a planar surface of the visual representation of the participant, such as a left or right half of a face (e.g., the front face), and/or an upper or lower half of the face). Displaying the visual representation of the participant with a simulated glowing effect provides visual feedback concerning the orientation of the participant relative to the three-dimensional environment without further requiring movement of the visual representation, thus reducing processing and/or power consumption required to convey changes in the orientation.

In some embodiments, a respective simulated glowing effect includes displaying the respective simulated glowing effect extending from an edge of the visual representation of the participant (e.g., the edge, a portion of the environment surrounding the edge and included or outside of the visual representation) toward a center portion of the visual representation of the participant, such as extending from an edge of virtual object 1304 to the border 1310 of visual feedback 1312 in FIG. 13A. For example, the computer system optionally displays a portion of the visual representation of the participant with the glowing effect extending in one or more direction generally directed toward a portion (e.g., a center) of the visual representation, such as a face of a surface of the visual representation. In some embodiments, the degree to which a portion of the visual feedback (e.g., glowing effect) extends toward the center portion of the visual representation is based on one or more factors such as the direction of the offset of attention relative to the current orientation of the visual representation, the degree of the offset, a level of audio indicated by the information received from the participant, and/or one or more transformations applied to the information (e.g., similar to an equalizer visualization indicating a relative increase of one or more frequencies included in audio received from the participant). For example, in accordance with a determination that the visual feedback will be displayed with the first visual appearance, the computer system optionally displays the visual feedback extending a first amount (e.g., a length across a face (e.g., front face) of a surface included in the visual representation) toward a center of the visual representation. In accordance with a determination that the visual feedback will be displayed with a second visual appearance the computer system optionally displays the visual feedback extending a second amount, different form the first amount, toward the center of the visual representation. In some embodiments, the amount (e.g., magnitude) of the extension toward the center of the visual representation corresponds (e.g., proportionally, inversely proportionally, and/or some other suitable combination) based on the degree of offset between the direction of attention and the current orientation of the visual representation of the participant. In some embodiments, the simulated glow effect is displayed with a uniform visual appearance of a simulated glow (e.g., with a same brightness, saturation, and/or opacity). In some embodiments, the simulated glow effect is displayed with a non-uniform appearance of the simulated glow. For example, the simulated glow optionally is a displayed with a first level of visual prominence (e.g., brightness, saturation, opacity, and/or color) at first one or more portions of the simulated glow (e.g., along a first radius and/or range of radii with respect to a center of the face of the visual representation), and displayed with a second level of visual prominence, different from the first level of visual prominence (e.g., less than or greater than the first level) at second one or more portions of the simulated glow (e.g., along a second radius and/or range of radii, greater or less than the first radius and/or first range of radii). Displaying the simulated glowing effect extending from the edge of the visual representation draws user attention toward the simulated glowing effect, providing visual feedback concerning the orientation of the participant relative to the visual representation of the participant.

In some embodiments, a respective simulated glowing effect includes displaying the respective simulated glowing effect at an edge of the visual representation of the participant, such as at and/or along an edge of virtual object 1312 in FIG. 13A. For example, the first visual feedback and/or the second visual feedback optionally include displaying a first glowing effect applied along one or more portions of the edge of the visual representation, such as along one or more edges of a face of a polygonal visual representation of the participant (e.g., a front face). It is understood, however, that the simulated glowing effect optionally is not limited to being displayed within the simulated dimensions of the visual representation of the participant. For example, the simulated glowing effect optionally includes displaying one or more portions of the three-dimensional environment surrounding the one or more portions of the edge of the visual representation with a diffuse glowing effect, optionally concurrently with the displaying of the glowing effect along the edge of the visual representation itself. In some embodiments, the portions of the three-dimensional environment concurrently displayed with the simulated glowing effect correspond to the one or more portions of the visual representation displayed with the simulated glowing effect. For example, when left one or more portions of the visual representation (e.g., relative to a line diving the visual representation) are displayed with the simulated glowing effect, the computer system optionally displays the simulated glowing effect surrounding the left one or more portions of the visual representation, and does not display the simulated glowing effect surrounding the right one or more portions of the visual representation (or displays the right-side simulated glowing effect with a relatively smaller magnitude of the glowing effect, compared to the left one or more portions). Displaying the simulated glowing effect(s) along one or more portions of an edge of the visual representation improves visibility of the visual feedback and/or directional bias modifying the simulated glowing effect(s).

In some embodiments, the first visual appearance includes displaying a first portion of the visual representation of the participant corresponding to the first direction with a first magnitude of the first visual feedback, such as displaying a visual peak included in visual feedback 1312 in FIG. 13B (e.g., along a left side of visual feedback 1312) and displaying a second portion of the visual representation of the participant corresponding to the second direction with a second magnitude of the first visual feedback, different from (e.g., less than) the first magnitude, such as lacking a visual peak included in a portion of visual feedback 1312 in FIG. 13B (e.g., along a right side of visual feedback 1312). For example, similar as described with reference to the “degree of offset” between the direction of attention of the participant relative to the current orientation of the visual representation of the participant, the computer system optionally displays one or more portions of the visual representation of the participant with relatively different (e.g., greater or lesser) magnitudes of visual feedback in accordance with a determination that the direction of attention corresponds to the one or more portions of the visual representation. As an additional example, when displaying the visual representation of the participant with the first visual appearance, the computer system optionally displays the visual feedback overlaying and/or consuming a first one or more portion of the visual representation, such as a simulated glowing effect including one or more visual peaks (e.g., where a first portion of the glowing effect extends from an edge of the visual representation toward the center of the visual representation, (or vice-versa) further than an adjacent portion of the simulated glowing effect), respective peaks optionally corresponding to the first and/or second portion of the visual representation. In some embodiments, displaying the first visual appearance includes displaying a first portion of the visual representation (e.g., a left-hand portion of a face of the visual representation, corresponding to where the direction of attention of the user is generally oriented toward) with a magnitude of the glowing effect that is greater than a magnitude of glowing effect applied to a second portion (e.g., a right-hand portion of the face of the visual representation), the portion corresponding to (e.g., generally in the direction of) the direction of attention relative to the current orientation of the visual representation of the participant.

In some embodiments, the second visual appearance includes displaying the first portion of the visual representation with a third magnitude of the second visual feedback and displaying the second portion of the visual representation with a fourth magnitude of the second visual feedback, different from (e.g., greater than) the fourth magnitude, such as magnitudes of visual feedback included in visual feedback 1312 in FIG. 13C. For example, the computer system optionally displays a glowing effect with one or more visual peaks on the second portion of the visual representation and optionally forgoes display of the glow effect including similar one or more visual peaks on the first portion of the visual representation to display the visual representation with the second visual appearance. In some embodiments, the first and second portions of the visual representation correspond to different portions of the visual representation (e.g., a face of the visual representation) defined relative to a reference point included in the visual representation (e.g., a center, edge, and/or center of a face of the visual representation). In some embodiments, displaying the first portion of the visual representation with a magnitude of visual feedback that is greater than a magnitude of visual feedback at a second portion of the visual representation includes forgoing display of the visual feedback at the second portion of the visual representation, and/or displaying another form of visual feedback (e.g., a different simulated lighting effect, graphical indication, and/or textual indication) at the second portion of the visual representation.

In some embodiments, the magnitude of visual feedback includes a relative area and/or volume of the visual representation that includes the visual feedback. In some embodiments, the magnitude of the visual feedback includes the magnitude (e.g., value) of one or more visual characteristics (e.g., a degree of opacity of a glowing effect, a color, a brightness, a saturation, a simulated lighting effect, and/or a blurring effect), such as the visual characteristics of the visual representation of the participant and/or a simulated glow effect applied (e.g., overlaid) over the visual representation. In some embodiments, displaying the visual representation of the participant with the first visual appearance and with the second visual appearance both include displaying visual feedback at one or more first portions (e.g., a relatively thin annular portion interior to an edge (e.g., face) of the visual representation of the participant), generally indicating that an indication of audio has been received from the participant, and displaying the first or the second visual appearance respectively include displaying visual feedback at one or more second or one or more third portions of the visual representation of the participant, respectively. Displaying the visual representation of the participant with a visual appearance including respective portions of visual feedback displayed with respective magnitudes provides visual feedback concerning the orientation of the participant relative to the three-dimensional environment without further requiring movement of the visual representation, thus reducing processing and/or power consumption required to convey changes in the orientation of the participant.

In some embodiments, the spatial relationship arrangement of the visual representation of the participant relative to the current viewpoint of the user includes a current orientation of the visual representation relative to the three-dimensional environment of the user of the computer system (for example, the current orientation of the visual representation as described with reference to step(s) 1402 and further herein), such as the current orientation 1318 of virtual object 1304 in FIG. 13A, the information obtained about the direction of attention of the participant indicates the direction of attention of the participant relative to the current orientation of the visual representation, such as information about direction of attention 1320 in FIG. 13A. For example, the information optionally includes data (e.g., spatial data), requests for performance of operations, and/or any other suitable information to inform the computer system about the orientation of the participant relative to the three-dimensional environment of the participant, and consequentially, relative to the three-dimensional environment of the user (e.g., in accordance with a mapping between the three-dimensional environment of the participant to a shared three-dimensional environment of the communication session and/or to the three-dimensional environment of the user). In some embodiments, the information is used by the computer system to determine the direction of the attention of the participant and/or is used to determine a degree of offset (described further herein) between the direction of attention and the current orientation of the visual representation of the participant. Establishing direction of attention relative to the current orientation of the visual representation as observed by the user via the computer system facilitates presenting of visual feedback of the orientation of the participant to the user.

In some embodiments, Presenting the first visual appearance of the visual representation of the participant includes displaying a directional biasing of the first visual feedback relative to the visual representation of the participant, such as directional biasing of visual feedback 1312 as shown in FIG. 13B. For example, the directional biasing optionally includes displaying one or more first portions of the visual feedback overlaying and/or consuming underlying portions of the one or more first portions of the visual representation, the one or more first portions of the visual representation corresponding to the direction of attention of the user, and optionally includes not displaying one or more second portions of the visual feedback that do not correspond to the direction of attention (or displaying the one or more second portions with a magnitude of visual feedback—described further herein—relatively less than a magnitude of the visual feedback displayed at the one or more first portions of the visual representation).

In some embodiments, presenting the second visual appearance of the visual representation of the participant includes displaying the second visual feedback without a directional biasing relative to the visual representation of the participant, such as directional biasing of visual feedback 1312 as shown in FIG. 13C. For example, the computer system optionally displays visual feedback (e.g., a glow effect) consuming an annular portion of a circular or elliptical face of a polygonal representation of the participant and/or along an edge of a face of the visual representation, such as an annular portion incident with an edge of a face of the visual representation. As an example, the second visual appearance optionally includes displaying the glow effect applied along the edge, extending from the edge toward a portion (e.g., center) of the visual representation to portions of the face that are a uniform, or nearly uniform distance from the edge (e.g., 0.1, 0.5, 0.075, 0.1, 0.2, 0.3, 0.4, 0.5, 1, or 1.5 m). In some embodiments, in accordance with a determination that the participant is providing information corresponding to audio, the computer system displays the annular portion of the visual feedback with the directional biasing described herein. In some embodiments, in accordance with a determination that the participant is not providing information corresponding to the audio, the computer system forgoes display of the visual feedback (e.g., the annular portion of the visual feedback) entirely. Displaying the visual representation of the participant with a visual appearance indicative of a degree of offset between the direction of attention visually indicates the presence or lack of offset between the direction of attention of the user relative to the current orientation of the visual representation of the participant.

In some embodiments, in response to the obtaining of the first information including the indication of the audio, in accordance with a determination that the one or more first criteria are satisfied, and in accordance with the determination that the direction of attention of the participant is the first direction (for example, as described further with reference to step(s) 1402), in accordance with a determination that the indication of audio indicates a first magnitude of the audio, the computer system displays the first glowing effect with a first magnitude, such as first magnitude of visual feedback 1312 in FIG. 13A based on a first magnitude of audio provided by user 1324. For example, the indication of audio optionally includes and/or corresponds to a recording of audio detected by one or more microphones in communication with a second computer system that the participant is using to access the communication session with the one or more participants. In some embodiments, the computer system determines a magnitude of visual feedback indicating a level of the recording of the audio. For example, the computer system optionally determines and/or receives an indication that a volume of the first audio (e.g., a magnitude of the audio) corresponds to a first level of audio, and optionally displays visual feedback in accordance with the indication of audio. For example, in accordance with a determination that the magnitude is a first, relatively larger magnitude, the computer system optionally displays the first glowing effect with a first magnitude of visual feedback, such as including a peak of the glowing effect (e.g., similar to the same as describe herein with respect to one or more peaks of the glowing effect) having a first size.

In some embodiments, in response to the obtaining of the first information including the indication of the audio, in accordance with a determination that the one or more first criteria are satisfied, and in accordance with the determination that the direction of attention of the participant is the first direction, in accordance with a determination that the indication of the audio indicates a second magnitude of the audio, different from the first magnitude of the audio, the computer system displays the first glowing effect with a second magnitude, different from the first magnitude, such as second magnitude of visual feedback 1312 in FIG. 13A based on a second magnitude of audio provided by user 1324. For example, in accordance with a determination that the magnitude is a second, relatively smaller magnitude compared to the first magnitude of the audio, the computer system optionally displays the first glowing effect including a peak of the glowing effect (e.g., similar to the same as describe herein with respect to one or more peaks of the glowing effect) having a second size, relatively smaller than the first size. In some embodiments, the computer system applies one or more functions to the audio prior to determining a magnitude of the audio, such as one or more functions filtering and/or suppressing contributions of loud and/or erroneous audio not corresponding to a voice of the user before determining the magnitude of the audio. In some embodiments, the magnitude of the glowing effect is based on a combination of the degree to which the magnitude of audio changes and/or the degree to which the direction of attention of the user is different from the current orientation of the visual representation of the user. For example, a relative percentage of a portion of the visual representation of the participant that is consumed by the glowing effect (e.g., within a first portion such as a left half of a face of a coin representing the participant, or within a second portion such as a right half of the face of the coin) is optionally based on (e.g., proportional to) the magnitude of the audio relative to a reference magnitude and/or the degree of the offset (e.g., the glow effect consumes a relatively greater portion of the face of the coin on a side corresponding to the side of the direction of attention, and based on a relatively greater offset between the current orientation of the coin and the direction of attention). Displaying visual feedback such as the first glowing effect with a magnitude corresponding to a magnitude of audio provides visual feedback indicating that the participant is speaking, thus preventing erroneous user input increasing volume of media content and/or speaking while the participant is providing audio.

In some embodiments, in response to obtaining the indication of audio, in accordance with a determination that a first visual characteristic of the visual representation of the participant is a first value, presenting the visual representation of the participant with the first visual appearance includes displaying a second visual characteristic of the first visual feedback with a second value. For example, the indication of audio described further with reference to audio and/or indications of audio provided by the participant (e.g., via a second computer system that the participant is using to participate in the communication session with the user and the one or more participants). For example, the computer system optionally changes—or does not change—a color, saturation, brightness, hue, opacity, and/or border of the visual first feedback (e.g., glowing effect) based on a similarity to a color, saturation, brightness, hue, opacity, and/or border of the visual representation of the participant (e.g., to more distinctly present the visual feedback relative to the visual representation of the participant). As an example, in accordance with a determination that a color included in the visual representation of the participant is similar (e.g., a similarity score computed between the color included in the visual representation and a first color included in the visual feedback is within a threshold score), the computer system optionally forgoes display of the visual feedback having the first color, and displays the visual feedback having a second color, different from the first color (e.g., having a similarity score that is greater than the threshold score). It is understood that differences in color space, Euclidean score, and/or another suitable metric quantifying the difference between the two colors optionally are applicable to compare visual similarity of visual characteristics, dependent upon context. In some embodiments, displaying the second visual characteristic of the first visual feedback with the second value includes displaying the first visual feedback with a default, or first determined value, such as when the visual feedback is by default and/or determined to be sufficiently distinct from the visual representation of the participant.

In some embodiments, in response to obtaining the indication of audio, in accordance with a determination that the first visual characteristic of the visual representation of the participant is a third value, different from the first value, presenting the visual representation of the participant with the first visual appearance includes displaying the second visual characteristic of the first visual feedback with a fourth value, different from the third value. For example, the computer system optionally displays the second visual characteristic of the visual feedback with the fourth value, optionally different from the third value (e.g., with a gray color instead of a white color), in accordance with a determination that the first visual characteristic of the visual representation of the participant is the third value (e.g., also a white color). It is understood that description of embodiments with respect to the first visual feedback optionally apply to additional or alternative visual feedback (e.g., the second visual feedback, and/or another set of visual feedback displayed by the computer system). For example, presenting the second visual feedback optionally includes displaying a visual characteristic with a respective value that is based on a visual characteristic of the visual representation to visually distinguish the visual feedback from the visual representation. Additionally or alternatively, the computer system optionally changes—or does not change-a plurality of visual characteristics in some combination based on one or more visual characteristics of the visual representation. Displaying visual characteristics of the visual feedback based on visual characteristics of the visual representation visually distinguishes the visual feedback relative to the visual representation, reducing the likelihood that the computer system detects erroneous input provided due to a lack of awareness about whether the visual feedback is being presented, thereby reducing power and processing required to detect and perform operations based on the erroneous input.

In some embodiments, in response to obtaining the information (for example, as described with reference to step(s) 1402), in accordance with a determination that the one or more first criteria are not satisfied (e.g., as described with reference to step(s) 1402), the computer system changes a spatial arrangement of the visual representation of the participant relative to the three-dimensional environment in accordance with the first information, such as changing current orientation 1318 of virtual object 1304 from FIG. 13C to FIG. 13D, wherein the visual representation of the participant has a second spatial relationship, different from the first spatial relationship, relative to the current viewpoint of the user at a conclusion of the changing in accordance with the second information, including having a current orientation relative to the three-dimensional environment corresponding to the direction of the attention of the participant relative to the three-dimensional environment, such as the current orientation 1344 of virtual object 1308 in FIG. 13D. For example, similar or the same as described with reference to method 800 and/or 900, the computer system optionally displays the visual representation of the participant with a pose (e.g., moves the visual representation) in accordance with information obtained by the computer system (e.g., from the participant, optionally via a second computer system) satisfies one or more criteria, such as detecting a change of current viewpoint of the participant (e.g., the second user described with reference to methods 800 and/or 900) exceeds a threshold change (e.g., of angular movement). It is understood that the spatial relationship described with reference to the present method optionally correspond to the changing of pose and/or movement of the visual representation described with reference to methods 800 and/or 900, and the one or more characteristics of the changing in viewpoint of the second user described with reference to methods 800 and/or 900 apply to the direction of attention (e.g., the changing of the direction of attention). Displaying the visual representation with a spatial relationship based on changing of direction of attention of the participant visually indicates an orientation of the participant's attention, thus reducing the need for additional or alternative feedback indicating a subject of the participant's attention, and thereby processing required to present such alternative feedback.

In some embodiments, while displaying the visual representation of the participant with the second spatial relationship relative to the current viewpoint of the user, the computer system obtains second information, different from the first information, including a respective indication of audio provided to the communication session by the participant, such as an indication of audio provided by user 1324 while virtual object 1304 has current orientation 1344 as shown in FIG. 13D. For example, the second information having one or more characteristics similar or the same as information including an indication of audio described with reference to step(s) 1402. In some embodiments, the visual representation of the participant is displayed with the second spatial relationship in response to detecting changes in the participant's viewpoint relative to their three-dimensional environment, similar or the same as described with reference to methods 800 and/or 900.

In some embodiments, in response to obtaining the second information, and in accordance with a determination that second information associated with the direction of attention of the participant satisfies the one or more first criteria (for example, the one or more first criteria described with reference to step(s) 1402, the computer system maintains display of the visual representation of the participant having the second spatial arrangement relative to the current viewpoint of the user, such as the information and the maintaining of display of virtual object 1304 as shown in FIG. 13D, FIG. 13E, and/or FIG. 13F. For example, the computer system maintains display of the visual representation of the participant at the second spatial arrangement, similar or the same as described with maintaining display of the visual representation at the first spatial arrangement with reference to step(s) 1402.

In some embodiments, in response to obtaining the second information, and in accordance with a determination that second information associated with the direction of attention of the participant satisfies the one or more first criteria, such as direction of attention 1349 as shown in FIG. 13E, in accordance with a determination that the second information obtained about the direction of attention of the participant indicates that the direction of the attention of the participant is a third direction, the computer system presents third visual feedback (e.g., having one or more characteristics similar or the same as the first visual feedback) associated with the audio provided by the participant relative to the visual representation of the participant, wherein the third visual feedback has a third visual appearance (e.g., has a third directional bias in a third feedback direction that corresponds to the third direction of the attention of the participant), such as visual feedback 1312 in FIG. 13E. For example, the computer system optionally displays the third visual feedback including a visual feedback (e.g., the simulated glowing effect) when the visual representation is displayed with an updated orientation relative to the current viewpoint of the user. In some embodiments, the third visual feedback is displayed based on the spatial relationship between the current viewpoint of the user and a portion (e.g., the front face) of the visual representation.

In some embodiments, in response to obtaining the second information, and in accordance with a determination that second information associated with the direction of attention of the participant satisfies the one or more first criteria, in accordance with a determination that the second information obtained about the direction of attention of the participant indicates that the direction of the attention of the participant is a fourth direction, different from the third direction, such as direction of attention 1354 in FIG. 13F, the computer system presents fourth visual feedback associated with the audio provided by the participant relative to the visual representation of the participant, wherein the fourth visual feedback has a fourth visual appearance (e.g., does not have a directional bias, or has a fourth directional bias in a fourth feedback direction that corresponds to the fourth direction of the attention of the participant and is different from the third directional bias), different from the first visual appearance, such as visual feedback 1312 as shown in FIG. 13F. For example, similar or the same as described with reference to the information, direction of attention, and corresponding visual appearance of the visual feedback. Displaying the visual feedback with a visual appearance based on the direction of attention of the participant while the visual representation of the participant has the second spatial relationship visually indicates the direction of attention without requiring one or more inputs changing the viewpoint of the user to improve visibility of the visual representation, thereby reducing processing and power required to detect and perform operations based on the one or more inputs.

In some embodiments, while the user of the computer system is participating in the communication session with a second participant of the communication session, the computer system displays, via the display generation component, a visual representation of the second participant within the three-dimensional environment, such as a type of visual representation other than virtual object 1304 in FIG. 13F, wherein the visual representation of the second participant is a second type of visual representation (e.g., a type of visual representation described with reference to methods 800 and/or 900), different from the first type of visual representation, and wherein the visual representation has a second spatial arrangement (e.g., position and/or orientation) relative to the current viewpoint of the user of the computer system (e.g., the second spatial arrangement having one or more characteristics similar or the same as the first spatial arrangement described herein), such as a spatial arrangement between current viewpoint of user 1314 in FIG. 13F and the second type of visual representation.

In some embodiments, while displaying the visual representation of the second participant of the second type, the computer system obtains second information associated with the second participant, and in some embodiments, in response to obtaining the second information associated with the second participant, and in accordance with a determination that the second information indicates a direction of attention of the second participant, the computer system moves the visual representation of the second participant in accordance with the second information (optionally independent of whether the direction of attention of the second participant satisfies the one or more first criteria), such as movement of virtual object 1304 indicated by translation indicators 1348 in FIG. 13E. For example, the second type of visual representation optionally is an expressive visual representation, and movement of the second type of visual representation includes moving one or more portions of the corresponding visual representation (e.g., simulated body parts and/or facial features) relative to one another. In some embodiments, in response to obtaining information indicating audio provided by a participant of the communication session, and in accordance with a determination that a visual representation that represents such a participant is the second type of visual representation, the computer system forgoes display of visual feedback associated with the first type of visual representation (e.g., forgoes display of a simulated glow effect), and displays an alternative form of visual feedback indicating the audio (e.g., movement, such as movement of a mouth of an anthropomorphic avatar). Moving the second type of visual representation of the second participant in accordance with the second information visually indicates a position and/or orientation of the second participant relative to the three-dimensional environment, thus reducing processing required to detect and/or perform operations initiated in response to detection of erroneous input directed to a previous position and/or orientation of the second participant prior to obtaining the second information.

In some embodiments, the visual representation of the participant and the visual representation of the second participant are displayed concurrently, such as displaying virtual object 1314 in FIG. 13A, and another type of visual representation. For example, the computer system optionally concurrently displays the visual representation of the participant and the visual representation of the second participant and respective positions and/or orientations (e.g., within a viewport of the user). As described herein, the computer system optionally displays visual feedback at respective visual representations corresponding to the type of visual representation that provides audio information (e.g., the visual representation of the first participant that is the first type of visual representation is displayed with a simulated glow effect in response to obtaining audio information from the first participant, and the visual representation of the second participant that is the second type of visual representation is displayed with movement (e.g., of a mouth) in response to obtaining audio information from the second participant). Displaying visual representations of the participant and the second participant facilitates concurrent interaction with both participants, reducing processing required to communicate with both participants in separate communication sessions.

In some embodiments, while displaying the visual representation of the second participant of the second type, the computer system obtains third information including a request to change the type of the visual representation of the second participant. In some embodiments, in response to obtaining the third information, the computer system ceases display of the visual representation of the second participant as the second type of visual representation, and the computer system displays, via the display generation component, the visual representation of the second participant as the first type of visual representation. For example, similar or the same as described with reference to methods 800 and/or 900, the computer system optionally displays a type of visual representation of a participant of the communication session in accordance with requests (e.g., user input) provided by the participant. It is understood that the ability to be represented by the first or the second type of visual representation described with reference to the present method (e.g., a coin or another representation such as an avatar) is available to some or all of the participants of the communication system.

In some embodiments, while the user of the computer system is participating in the communication session with the participant and a second participant of the communication session, different from the participant, and while displaying the visual representation of the participant that is the first type of the visual representation (e.g., the first type of visual representation as described further herein), such as virtual object 1304 in FIG. 13A, the computer system displays, via the display generation component, a visual representation of the second participant, different from the visual representation of the participant, within the three-dimensional environment, wherein the visual representation of the second participant is the first type of visual representation, such as similar to virtual object 1304 in FIG. 13As. For example, the computer system optionally displays a plurality of visual representations of the respective participants of the communication session, optionally concurrently. In some embodiments, respective visual representations of the first type have one or more characteristics similar or the same as those described with reference to methods 800 and/or 900, such as an annotation and/or identifying information (e.g., initials, communication address, and/or name) corresponding to the respective participant corresponding to the respective visual representations. In some embodiments, respective visual representations of the plurality of visual representations of the communication session of the first type are displayed as the first type of visual representation based on user input, requests, and/or satisfaction of one or more criteria described with reference to method 800 and/or 900. Additionally or alternatively, the computer system optionally displays visual feedback at a respective visual representation in response to obtaining information provided by a participant corresponding to a respective visual representation (e.g. information obtained from a computer system the participant is using to access the communication session), similar or the same as described with reference to step(s) 1402 and further herein. Displaying visual representations of the participant and the second participant facilitates concurrent interaction with both participants, reducing processing required to communicate with both participants in separate communication sessions.

It should be understood that the particular order in which the operations in method 1400 have been described is merely exemplary and is not intended to indicate that the described order is the only order in which the operations could be performed. One of ordinary skill in the art would recognize various ways to reorder the operations described herein.

FIGS. 15A-15M illustrate examples of a computer system providing feedback indicating spatial positions of communication session participants in accordance with some embodiments.

FIG. 15A illustrates a computer system displaying, via a display generation component (e.g., display generation component 120 of FIG. 1), a three-dimensional environment 1502 from a viewpoint of the user 1504 of the computer system 101. In some embodiments, computer system 101 includes a display generation component (e.g., a touch screen) and a plurality of image sensors (e.g., image sensors 314a, 314b, and/or 314c of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. For example, in FIGS. 15A-15M, a portion of three-dimensional environment 1502 visible to the user is indicated by a set of dashed lines extending from computer system 101, indicative of the viewport (e.g., a current viewport) of the user 1504. In some embodiments, the user interfaces illustrated and described below are implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 15A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1502.

In FIG. 15A, three-dimensional environment 1502 also includes one or more virtual objects 1506 (“Media”). Virtual object 1506 optionally is and/or includes a user interface of a media application, for example, optionally including displayed media such as text, photos, and/or video. In some embodiments, computer system 101 concurrently displays one or more controls associated with virtual object 1506. As an example, affordance 1505 optionally is selectable to initiate movement of virtual object 1506 from its current position to an updated position (e.g., at times used interchangeably with “virtual position”) within three-dimensional environment 1502 in FIG. 15A. Reference to “selection” inputs optionally correspond to and/or includes inputs provided by the user using air gestures (e.g., an air pinching gesture including contacting of two fingers, an air pointing gesture of one or more fingers, and/or an air swiping of one or more fingers), voice inputs requesting selection, attention (e.g., gaze) of the user, and/or selection provided via a computing peripheral (e.g., a stylus, an oblong pointing device, and/or a mouse) directed to a visual element such as an affordance. As a further example, affordance 1503 is optionally displayed concurrently with virtual object 1506, and optionally is selectable to initiate display of one or more additional controls to cease display of virtual object 1506, share virtual object 1506 with other participants, and/or change one or more dimensions of virtual object 1506 in FIG. 15A. As illustrated by glyph 1508, virtual object 1506 optionally includes audio played at a first level 1510-1 in FIG. 15A. For example, computer system 101 optionally generates sound corresponding to currently playing video displayed within virtual object 1506. It is understood that the sound illustrated by glyph 1508 optionally corresponds to one or more levels of audio of additional or alternative content played by computer system 101.

In some embodiments, representation of the user's physical environment and virtual content such as virtual objects are displayed with positions and/or orientations relative to a viewpoint of user 1504, as illustrated in the overhead view of three-dimensional environment 1502. For example, virtual object 1506 is displayed at a first position and a first orientation relative to the viewpoint of user 1504 of computer system 101. As described further herein, the user 1504 optionally has a view of three-dimensional environment 1502 corresponding to what is presented to via a viewport. For example, in the overhead view of three-dimensional environment 1502, viewport 1570 optionally corresponds to portions of the three-dimensional environment and/or virtual content that is visible (e.g., displayed) via computer system using display generation component 120. It is understood that additional or alternative virtual objects and/or virtual object 1506 optionally are displayed with different positions and/or orientations relative to the viewpoint of user 1504, and/or that similar to physical objects, an orientation and/or size of virtual content optionally changes in response to change in the viewpoint of user 1504.

In some embodiments, computer system 101 participates in a communication session between one or more participants. In some embodiments, such a communication session is a real-time, or nearly real-time communication session in which representation of participants of the communication session are displayed. Some embodiments of the disclosure presented herein refer to participants occupying a position of three-dimensional environment 1502; it is understood such description optionally additionally or alternatively refers to representations of participants occupying a virtual position within three-dimensional environment 1502. For example, computer system 101 optionally displays a representation as described further with reference to at least methods 800, 900, 1400, and/or 1600 within three-dimensional environment, such as an expressive spatial and virtual avatar having one or more body parts that move mimicking physical movement of a corresponding participant, a prism, a virtual coin, and/or another virtual three-dimensional shape, and/or a “non-spatial” representation of a participant that optionally is two-dimensional, or nearly two-dimensional, such as a virtual object framing video communicated by a computer system participant. It can be appreciated that computer system 101 optionally displays one or more of such representations of participants when respective virtual positions of the one more representations are within a viewport 1570 (e.g., in FIG. 15A) of computer system 101, and optionally does not display one or more representations when respective virtual positions are not within viewport 1570. It can further be appreciated that the presence and/or movement of such participants to updated positions within three-dimensional environment 1502 can be of interest to user 1504, such as participants when spawn (e.g., will correspond to) a position within three-dimensional environment and/or move to updated positions (e.g., will walk to). To heighten user awareness of the positions of the participants relative to the viewpoint of user 1504, computer system 101 optionally presents feedback, as illustrated in the examples that follow.

From FIG. 15A to. FIG. 15B, computer system 101 obtains information that a first participant will correspond to a position within three-dimensional environment 1502. As illustrated in the overhead view of three-dimensional environment 1502 in FIG. 15B, first representation 1530—representative of a first participant of the communication session other than user 1504—joins the communication session at an initial position within three-dimensional environment 1502, thus “spawning” at the initial position. To visually and audibly indicate the spawning, computer system 101 optionally plays a first tone 1516a indicated on staff 1514 and displays such a simulated glow 1512 in FIG. 15B. As described further with reference to method 1600, computer system 101 optionally displays a simulated glow effect including a color and/or fill pattern overlaying a portion of the viewport, the glow effect corresponding to a relative spatial relationship between a viewpoint of user 1504 and the position that the first participant will correspond to. As illustrated in the overhead view of three-dimensional environment 1502 in FIG. 15B, the position of first representation 1530 is relatively behind and to a left of a center of the viewpoint of user 1504. Accordingly, glow 1512 is displayed consuming a left portion of the viewport and/or display generation component 120 in FIG. 15B. In FIG. 15B, first tone 1516a is generated as if emanating from the initial position of first representation 1530. For example, as described further with reference to method 1600, computer system 101 optionally changes one or more characteristics of audio to simulate the effect of an audio source in three-dimensional environment 1502 playing sounds relative to a viewpoint of user 1504, thus mimicking a spatial quality of a physical sound source placed at a same physical position in a physical environment of user 1504. As shown in FIG. 15B, computer system 101 generates first tone 1516a “spatialized” to position 1536 in three-dimensional environment 1502. It is understood that staff 1514 is merely representative of concept of audible feedback provided—at times referred to herein as “spawning feedback” from a position within three-dimensional environment 1502. As described further with reference to method 1600, computer system 101 optionally generates (e.g., plays) a different tone, a chord, an arpeggio, word(s), and/or sound(s) included in the spawning feedback. In some embodiments, computer system 101 at least partially or entirely suppresses currently playing audio to improve audibility of the audio feedback. For example, as illustrated by glyph 1508, audio corresponding to media played by virtual object 1506 optionally is decreased to a second level 1510-2 in FIG. 15B.

From FIG. 15B to FIG. 15C, computer system 101 optionally obtains information that a second participant and a third participant will correspond to updated positions within three-dimensional environment 1502. For example, computer system 101 optionally obtains information that a second representation 1538 of the second participant will spawn at a position 1540, and in accordance with a determination that position 1540 is relatively to the left of the viewpoint of user 1504, displays glow 1512 on a left portion of the viewport in FIG. 15C. In some embodiments, glow FIG. 15C is displayed after ceasing display of glow 1512 in FIG. 15B, thus computer system 101 displays two separate glowing events. As illustrated in staff 1514, computer system 101 optionally generates second tone 1516b, such as a next note in a chord relative to first tone 1516a. As described further with reference to method 1600, it is understood that second tone 1516b optionally is a second chord, second arpeggio, second set of word(s) and/or other audible notification different than those described with reference to FIG. 15B. In some embodiments, the various tones are played successively and/or with modest crossover between the tones, thus generating an arpeggio lending a sense of continuity to the changing of positions of the participants. In FIG. 15C, computer system 101 continues to suppress the level of audio generated corresponding to media included in virtual object 1506 (optionally without express input requesting as such).

In some embodiments, computer system 101 temporally staggers presentation of feedback indicating positions that multiple participants will correspond to. For example, from FIG. 15B to FIG. 15C, third representation 1542 of a third participant joins the communication session, and/or moves within three-dimensional environment 1502. In some embodiments, the third participant joins the communication session and/or moves within three-dimensional environment 1502 to an updated position within a threshold amount of time (e.g., 0, 0.1, 0.5, 0.1, 0.25, 0.5, 0.75, 1, 1.25, 1.5, 2, 3, 5, or 10 seconds) of presenting glow 1512 in FIG. 15B indicating the position of the second representation 1538. Accordingly, to clearly distinguish events related to positions of the respective participants, computer system 101 forgoes presentation of feedback indicating the position of third representation 1542 in FIG. 15C. It is understood, however, that in some embodiments, computer system 101 optionally presents concurrent feedback and/or feedback in rapid succession (e.g., independently of when feedback was last presented) when multiple participants will correspond to updated positions within three-dimensional environment 1502 within a threshold amount of time. From FIG. 15C to FIG. 15D, after the threshold period of time has elapsed, computer system 101 generates third tone 1516c as if emanating from position 1544c in FIG. 15D, thus separately indicating that the third participant will and/or currently corresponds to position 1544c. In some embodiments, the third tone 1516c is displayed in response to obtaining that the third participant moves of their own volition (e.g., the third participant physically moves and/or provides a request to mimic physical movement within three-dimensional environment 1502). In FIG. 15D, computer system 101 detects an air gesture performed by a hand 1507 of user 1504 while attention 1509 is directed to affordance 1505, thus optionally initiating a movement of virtual object 1506.

In FIGS. 15A-15D, feedback is generated by computer system 101, especially feedback that indicates that a participant will correspond to specific position within the three-dimensional environment 1502. In FIG. 15E-1, feedback is generated by computer system indicating a region of three-dimensional environment 1502 that participants will correspond to, relative to the viewpoint of user 1504. It is understood that the feedback model described with reference to FIG. 15E-1 optionally is used in addition or alternative to the feedback model described with reference to FIGS. 15A-15D, such as during different communication sessions, in accordance with a system and/or user setting, and/or in accordance with a determination that an environment shared with the communication session has one or more characteristics (e.g., the environment is a particular shared environment, a number of participants are participating in and/or will join the environment, and/or the environment includes virtual content that benefits from particular one or more feedback models). The various feedback models illustrated herein are described further at least with reference to method 1600.

From FIG. 15D to FIG. 15E-1, in response to leftward movement of hand 1507, computer system 101 updates a position and orientation of virtual object 1506, relatively leftward and rotated counterclockwise (relative to the overhead view of three-dimensional environment 1502) in FIG. 15E-1. Additionally, as described further with reference to methods 1100 and/or 1200, computer system 101 optionally updates a spatial arrangement of virtual objects including representations of participants of the real-time communication session concurrent with the moving and rotating of the virtual objects. In FIG. 15E-1, for example, the position corresponding to first representation 1530 rotates about the viewpoint of user 1504 to an updated position. In some embodiments, computer system 101 determines a plurality of regions of the three-dimensional environment, and in accordance with a determination that a participant will correspond to a particular region, provides feedback indicating the current and/or future correspondence to the particular region. For example, first representation 1530 optionally occupies such a particular position within region 1522a (e.g., a first subdivision of three-dimensional environment 1502 relative to the viewpoint of user 1504) and/or optionally occupies a plurality of positions, the majority of which fall within region 1522a. To indicate that a participant is and/or will be at a position within region 1522a, computer system 101 optionally generates audio as if emanating from position 1546a, included in region 1522a. Position 1546a optionally has a spatial relationship between the viewpoint of user 1504, three-dimensional environment 1502, and/or region 1522a, such as an angular relationship relative to a center of the viewpoint (e.g., is situated along an axis extending through the shoulders of user 1504), and a distance from the center of the viewpoint. Thus, computer system 101 presents feedback at a location corresponding to a particular region that is defined relative to the user viewpoint, and optionally forgoes feedback precisely indicating a position of the first participant. In some embodiments, in accordance with a determination that a plurality of representation of participants will correspond to a same region within the three-dimensional environment, computer system 101 generates first feedback to indicate presence of the group of representations of participants. For example, in accordance with a determination that two participants will simultaneously or in rapid succession join region 1522a, computer system 101 optionally generates a single set of feedback (e.g., simulated glow effect and/or audio played from position 1546a), and/or forgoes separately generating feedback for each participant (e.g., forgoes twice-displaying the simulated glow effect and/or playing audio twice from position 1546a). In some embodiments, the computer system 101 also presents glow feedback (e.g., corresponding to the glow 1512) in FIG. 15E-1 indicating the position of first representation 1530.

In FIG. 15E-1, computer system 101 has obtained information that the second representation 1538 will correspond to a position beyond a physical boundary (e.g., a wall) of the three-dimensional environment of user 1504. In some embodiments, computer system 101 forgoes presentation of feedback corresponding to the updated position of second representation 1538 in accordance with a determination that the position of the participant is beyond such a boundary. In some embodiments, computer system 101 provides feedback regardless of boundaries, including audio modified as if emanating from position 1546b (such as second tone 1516b in FIG. 15E-1), corresponding to a second region 1522b of the three-dimensional environment 1502 relative to the viewpoint of user 1504. In some embodiments, position 1546b relative to the viewpoint of user 1504 has one or more characteristics similar or the same as those described with reference to region 1522a. For example, position 1546b and position 1546a are equidistant from the center of the viewpoint, and respectively have different angles (relative to the top-down view) of the center of the viewpoint (e.g., is backwards along an axis extending through the center of the viewpoint of the user). In some embodiments, the computer system 101 also presents glow feedback (e.g., corresponding to the glow 1512, and/or glow feedback extending at least partially across a horizontal dimension of display generation component 120) in FIG. 15E-1 indicating the position of second representation 1538.

In FIG. 15E-1, computer system 101 further has obtained information that the third participant corresponding to third representation 1542 will correspond to a third region 1522b of the three-dimensional environment. Accordingly, computer system 101 in FIG. 15E-1 displays third representation 1542, optionally including an anthropomorphic avatar and/or non-spatial representation of the corresponding participant. As an example, third representation 1542 optionally has one or more characteristics similar or the same as those described with reference to representation of users and/or participants of communication sessions discussed with respect to methods 800, 900, 1100, 1200, 1400, 1600, and/or 1800 herein. Third representation 1542, for example, optionally has one or more virtual body parts that move in accordance with input (e.g., movement of the participant and/or input directed to a physical or virtual affordance such as a trackpad and/or a virtual movement control) provided by the participant corresponding to third representation 1542. In some embodiments, computer system 101 forgoes generating feedback including a simulated glow effect and/or audio modified as if emanating from position 1546b within region 1522b, because the position of the third participant is within the viewport of computer system 101. In some embodiments, the computer system 101 presents feedback independently of whether the representation 1542 is within the viewport. For example, the computer system optionally generates audio as if emanating from position 1546b, relatively ahead of center of the viewpoint of user 1504. Similar to the other positions corresponding to the other regions of three-dimensional environment 1502, position 1546b optionally has one or more characteristics similar or the same as the other positions (e.g., is also equidistant from the center of the user's viewpoint), and optionally has one or more different characteristics (e.g., has a different angular relationship relative to the top-down view of three-dimensional environment 1502). For example, position 1546b is situated at a position parallel to a line extending through a center of the viewpoint of user 1504, straight ahead of the viewpoint of user 1504.

FIG. 15E-2 illustrates an additional or alternative rotation of the viewpoint of the user 1504 relative to as shown in FIG. 15D, and feedback generated by computer system 101. Similar to as described with reference to FIG. 15E-1, computer system 101 optionally presents feedback relative to one or more regions of three-dimensional environment 1502 that are defined relative to the viewpoint of user 1504. For example, region 1522c (analogous to region 1522a) optionally is a first region of the three-dimensional environment 1502. In FIG. 15E-2, viewport 1570 is oriented differently from as shown in FIG. 15E-1 due to the user's 1504 movement, thus causing a display of virtual object 1506 in a relatively central portion of the viewpoint, and also changing the which portion(s) of three-dimensional environment 1502 are included in different regions associated with providing feedback to user 1504. In FIG. 15E-2, the participant corresponding to representation 1530 spawns within region 1522c. Accordingly, computer system 101 in FIG. 15E-2 generates audio as if emanating from position 1546c, which is optionally a same distance away from a center of the viewpoint of user 1504 as the position 1546a, and optionally has a different angular relationship (e.g., relative to the overhead view of three-dimensional environment 1502 illustrated in FIG. 15E-2). It is noted that in FIG. 15E-2, computer system 101 forgoes presentation of audio emanating from position 1546a illustrated in FIG. 15E-1. Further in FIG. 15E-2, because representation 1538 corresponds to a similar region of the three-dimensional environment 1530 in FIG. 15E-2, computer system 101 forgoes separately generating audio indicating that representation 1538 also corresponds to region 1522c (e.g., in accordance with a determination that representation 1538 spawns and/or corresponds to region 1522c within a threshold amount of time as representation 1530 (e.g., 0, 0.1, 0.5, 0.1, 0.5, 1, 1.5, 2, 3, 5, or 10 seconds)). In FIG. 15E-2, computer system 101 also presents feedback indicating that representation 1542 will correspond to a region 1522d of three-dimensional environment 1502. For example, similar to as described herein, computer system 101 generates audio as if emanating from position 1546d because representation 1542 will correspond to the region 1522d. Position 1546d is optionally defined relative to the viewpoint of user 1504, such as a position equidistant similar to the other positions (e.g., 1546a-c), and optionally at an updated angle that relative to the viewpoint of user 1504 (e.g., along an axis to the right of the user's viewpoint, such as extending through the shoulders of the user).

FIG. 15F illustrates an additional feedback model, in which spatial feedback is generated to indicate positions that participants will correspond to, optionally irrespective of whether such positions are within or outside of the viewport of computer system 101. For example, in FIG. 15F, computer system 101 generates glow 1512 and/or 1520, and generates audio feedback in response to obtaining information that first representation 1530, second representation 1538, and/or fourth representation 1548 will correspond to positions with three-dimensional environment 1502 similar to as described with reference to FIGS. 15A-D. In FIG. 15F, computer system 101 optionally has obtained information that a fourth participant corresponding to fourth representation 1548 in the overhead view of three-dimensional environment 1502 will correspond to a position 1554 (e.g., has joined the communication session at the position, has moved to the position, and/or was moved in accordance with a request from another computer system). In response to obtaining such information, computer system 101 optionally generates fourth tone 1516e as if emanating from position 1554, similar to as described with references to spatialization of the other tones included in staff 1514 described with reference to FIGS. 15A-D. In FIG. 15F, the fourth tone 1516 is an octave above the first tone 1516a, thus completing an arpeggio of tones in staff 1514. In some embodiments, in accordance with a determination that the fourth participant will correspond to the position 1554 after a threshold amount of time has elapsed since last-presenting feedback indicative of a spawning of a participant (e.g., since last generating tone 1516c), computer system 101 optionally forgoes generation of fourth tone 1516e (e.g., the octave), and instead generates tone 1516f. Thus, computer system 101 optionally indicates that a first grouping of participants spawn in relatively rapid succession by successively playing ascending or descending tones, and optionally restarts a sequence of audio feedback such as restarting at a first of the successive tones when a new participant spawns a relatively longer time after a previous participant spawned. In some embodiments, computer system 101 generates tone 1516f instead of fourth tone 1516e independent of timing of spawning to provide a sense of completion (e.g., to indicate that no additional participants can or will join the communication session). In FIG. 15F, computer system 101 detects attention 1526 directed to affordance 1503, and/or detects an air gesture performed by hand 1507, and in response initiates display of additional controls associated with virtual object 1506 and/or performs operations corresponding to the additional controls, optionally without displaying the additional controls.

From FIG. 15F to FIG. 15G, computer system 101 displays button 1528—selectable to initiate a sharing of virtual object 1506 with the communication session—and displays button 1529—selectable to cease display of virtual object 1506—at positions close to a border of virtual object 1506 in response to the air gesture detected in FIG. 15F. Attention 1531 and attention 1532, respectively illustrative of selection input directed toward button 1528 and button 1529, are detected by computer system 101.

From FIG. 15G to FIG. 15H, computer system 101 shares virtual object 1506 with the communication session and updates a spatial relationship of elements of the communication session in response to the inputs obtained in FIG. 15G, such as the sharing button 1528. In some embodiments, computer system 101 updates a spatial template of participants of the communication session in response to one or more events, such as the sharing of virtual object 1506. Between FIG. 15G and FIG. 15H, computer system 101 optionally and temporarily ceases display of representation of the participants of the communication session in response to the sharing of virtual object 1506. Computer system 101 in FIG. 15H displays virtual object 1506 at an updated position and/or with an updated scale within three-dimensional environment 1502, and optionally rearranges the spatial relationship between the representations of participants. For example, first representation 1530, second representation 1538, third representation 1542, and fourth representation 1548 in FIG. 15H are arranged along an arc, with the viewpoint of user 1504 situated at a relative center of the arc, and the participants respectively oriented toward a face of virtual object 1506 including content (e.g., media). To indicate such an updated spatial arrangement, the computer system 101 optionally generates glow effect(s) (e.g., glow 1512 and/or 1520) and/or audio at positions corresponding to the positions of the representations, similar to described with reference to FIGS. 15A-D. It is understood that the various feedback models described herein optionally are applied in response to the updating of the spatial arrangement of elements of the communication session.

From FIG. 15G to FIG. 15I, computer system 101 ceases display of virtual object 1506 in response to input directed to button 1529 and/or in response to similar input requesting ceasing display of virtual object 1506 obtained while displayed as shown in FIG. 15H. In FIG. 15I, computer system 101 rearranges representations of participants in a conversational template, in which representation of participants are relatively oriented toward one another. For example, as illustrated in FIG. 15I in the top-down view of three-dimensional environment 1502, first representation 1530, second representation 1538, third representation 1542, and fourth representation 1548 are arranged in a ring-shaped template. The representations optionally have one or more characteristics of the representations described herein, such as one or more characteristics similar or the same to third representation 1542 described with reference to FIG. 15E-1. To indicate the updated positions of the representations relative to the viewpoint of user 1504, computer system 101 optionally generates feedback at the positions of the representations, respectively, and/or displays a glow effect 1566. In FIG. 15I, the glow effect is displayed within a relatively central portion of display generation component 120, surrounding the representation of the participants. It is understood that the simulated glow effect optionally is displayed at any suitable position relative to display generation component 120 to draw user attention toward the general region(s) and/or positions of three-dimensional environment at which participants will correspond to. In some embodiments, computer system 101 changes a spatial template in response to obtaining information indicative of additional or alternative events (e.g., voice commands, selection of other buttons, entry or exiting of participants from the communication session, and/or sharing of virtual content).

In some embodiments, computer system 101 presents feedback such as “non-localized” audio when a representation of a participant will no longer be included in a three-dimensional environment of a user. In some embodiments, after presenting such feedback, computer system 101 forgoes presentation of such feedback for a duration of time (e.g., a “cooldown” period of time), independently of whether a participant will cease inclusion of their representation in the three-dimensional environment during the cooldown period. In some embodiments, after the duration of time has elapsed, computer system 101 again presents feedback when another representation will no longer be included in the three-dimensional environment of the user. For example, from FIG. 15I to FIG. 15J, computer system 101 obtains information that a participant requested a ceasing of inclusion of a representation within the three-dimensional environment 1502. For example, in FIG. 15J, second representation 1538 is no longer displayed, and representation 1558 is displayed in response to obtaining similar information. It is understood that ceasing inclusion of a representation within the three-dimensional environment-dependent upon context-optionally includes an exiting of the communication session, a request to display a placeholder representation that has different characteristics (e.g., a non-spatial representation replacing a spatial representation similar or the same as described with reference to methods 800, 900, and/or 1400) previously displayed representation of a same participant, and/or that a network of computer systems satisfies one or more criteria (e.g., network latency criteria) described further with reference to methods 800 and/or 900.

From FIG. 15J to FIG. 15K, computer system 101 obtains information that a plurality of participants will cease inclusion of their corresponding representation in three-dimensional environment 1502. For example, similar to as described with reference to FIG. 15I, computer system 101 optionally ceases display of spatial representations of the participants. In some embodiments, computer system 101 forgoes generation of feedback indicating that the plurality of participants will and/or have ceased inclusion of their corresponding representations in accordance with a determination that one or more criteria are satisfied, such as including a criterion satisfied when a period of time less than a threshold has passed since last-presenting feedback indicating a similar ceasing of a similar representation. For example, in FIG. 15K, glyph 1545 illustrates progression of a period of time 1546 that has elapsed since presenting the feedback in FIG. 15J. In FIG. 15K, period of time 1546 is less than threshold 1549 in FIG. 15K. Accordingly, as indicated by icon 1567, computer system 101 optionally forgoes generation of audio (e.g., non-localized audio, described further with reference to method 1600). Thus, computer system 101 optionally does not play additional audio, thereby preventing a cacophonous and/or distracting feedback.

In FIG. 15L, computer system 101 obtains information that a participant will cease inclusion of their corresponding representation in three-dimensional environment 1502. In some embodiments, the computer system again generates feedback (e.g., audio) when a participant will cease inclusion of their corresponding representation, and in accordance with a determination that a period of time 1546 has elapsed-greater than a threshold period of time—of last-presenting feedback indicating that a representation will cease to be included in the three-dimensional environment (and/or a threshold period of time). For example, in FIG. 15L, icon 1568 indicates that non-localized audio is generated when representation 1564 is displayed and/or will be displayed, replacing fourth representation 1548 illustrated in FIG. 15K, due to the period of time 1546 in FIG. 15L being greater than threshold 1549 in FIG. 15L. As described previously, the period of time 1546 in FIG. 15L is optionally indicative of an amount of time from which a participant ceased inclusion of a corresponding spatial representation in the communication session (e.g., corresponding to representation 1558 in FIG. 15J, and/or corresponding to representation 1560 and/or representation 1562 in FIG. 15K). In some embodiments, the feedback accompanying display of representation 1564 is similar or the same as the feedback accompanying display of representation 1558 in FIG. 15J. For example, computer system 101 optionally generates a same set of audio (e.g., non-localized audio), and/or a same simulated glowing effect. In some embodiments, the feedback accompany displaying of representation 1564 is different from previously presented feedback, such as a generating of a non-localized tone that is different from a non-localized tone generated when indicating a different participant previously spawned within three-dimensional environment 1502.

From FIG. 15L to FIG. 15M, computer system 101 obtains information that participants will correspond to positions within the three-dimensional environment, and replaces display of non-spatial representations of the participants with spatial representations of the participants. In FIG. 15M, computer system 101 replaces the non-spatial representations (e.g., illustrated in FIG. 15L) with spatial representations (e.g., described further with reference to the FIGS. 15A-15J). In particular, computer system 101 displays first representation 1530, second representation 1538, third representation 1542, and fourth representation 1548 within three-dimensional environment 1502 in FIG. 15M at positions within the three-dimensional environment (e.g., positions the same, or different from their previous corresponding positions within the three-dimensional environment, such as at their respective, previous positions within a spatial template). In some embodiments, computer system 101 displays glow effect 1566 such as illustrated in FIG. 15M to indicate the transition of representations of the participants from a non-spatial to a spatial representation. In some embodiments, computer system 101 generates audio, such as localized audio feedback, as if emanating from the positions of the spatial representation in FIG. 15M as illustrated in the overhead view of three-dimensional environment 1502 indicated by the “X” centered on the positions of first representation 1530, second representation 1538, third representation 1542, and fourth representation 1548 in response transitioning from non-spatial to spatial representations. Additionally, computer system 101 optionally generates non-localized audio indicated by icon 1568 in FIG. 15M to indicate that one or more participants correspond to positions within the three-dimensional environment 1502. For example, the audio optionally has one or more characteristics (e.g., is a tone, several tones, a chord, and/or arpeggios) similar or the same as described with reference to the notes indicated in staff 1514 in the FIGS. 15B-15F. In some embodiments, the audio optionally has one or more different characteristics, such as characteristics not modifying the audio to include head-related transfer function modifications mimicking the time delays caused by sound source(s) that generate the audio to localized positions.

FIG. 16 is a flowchart illustrating an exemplary method of providing feedback indicating spatial positions of communication session participants in accordance with some embodiments. In some embodiments, the method 1600 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, method 1600 is performed at a computer system, such as computer system 101 in FIG. 15A, in communication with one or more input devices, such as the image sensor(s) 314a, 314b, and/or 314c, and a display generation component, such as display generation component 120. For example, the computer system, the one or more input devices, and/or the display generation component have one or more characteristics of the computer system(s), the one or more input devices, and/or the display generation component(s) described with reference to methods 800, 900, 1100, 1200, and/or 1400.

In some embodiments, while a user of the computer system is participating in a communication session with one or more participants, and the user has a current viewpoint relative to a three-dimensional environment of the computer system, such as a viewpoint of user 1504 in FIG. 15A optionally indicated by the dimensions of viewport 1570 in the overhead view of three-dimensional environment 1502, the computer system obtains (1602a) information that a position of a first participant in the communication session will correspond to a first position, such as position 1536, within the three-dimensional environment of the computer system relative to the current viewpoint of the user, such as a position of representation 1530 as shown in FIG. 15B. For example, the communication session has one or more characteristics of the communication session(s) described with reference to methods 800, 900, 1100, 1200, and/or 1400, and the three-dimensional environment has one or more characteristics of the three-dimensional environment(s) described with reference to methods 800, 900, 1100, 1200, and/or 1400. In some embodiments, the user uses the computer system that is a first computer system to participate in the communication session, and the participant uses a second computer system different from the first computer system to participate in the communication session. In some embodiments the user has a respective current viewpoint (e.g., position and/or orientation) relative to the three-dimensional environment that is a first environment, and the participant has a respective current viewpoint relative to their three-dimensional environment that is a second three-dimensional environment. In some embodiments, during the communication session, the first and the second computer systems exchange and/or obtain information indicative of positions of the user and the participant relative to a shared three-dimensional environment, the shared three-dimensional environment optionally including a virtual environment and/or virtual content that is mapped to respective positions within the first three-dimensional environment and the second three-dimensional environment, thus providing a mutual understanding of the user and the participant relative to an environment similar to when the user and the participant share a physical environment. In some embodiments, respective computer systems participating in the communication session display a visual representations of other participants of the communication session. For example, the computer system (e.g., the first) optionally displays a visual representation of the participant having one or more characteristics of the visual representation of participants described with reference to methods 800, 900, 1100, 1200, and/or 1400 at a position currently assigned to and/or corresponding to the participant.

In some embodiments, the computer system obtains information that the first participant will correspond to a first position within the three-dimensional environment. In some embodiments, prior to obtaining the information, the first participant does not yet correspond to the first position (e.g., is not displayed at, and/or would not be displayed at the first position if the current viewpoint of the user included the first position). For example, the computer system optionally obtains an indication that the first participant will join the communication session at the first position (e.g., in response to the second computer system providing input and/or approval joining the communication session) or obtains an indication that the first participant will move to the first position while the first participant is currently participating (e.g., already joined) the communication session. In some embodiments, the information includes data, metadata, and/or requests to perform operations at the computer system.

In some embodiments, in response to obtaining the information (1602b) in accordance with a determination that one or more first criteria are satisfied, including a criterion that is satisfied when the position corresponding to the first participant is outside of a viewport of the computer system, such as outside of viewport 1570 in FIG. 15B, the computer system presents (1602c) first feedback associated with the first position of the first participant, wherein the first feedback indicates a spatial relationship between the current viewpoint of the user and the first position, such as the glow 1512 in FIG. 15B and/or the audio generated as if emanating from position 1536. In some embodiments, such feedback is different from displaying a representation of the first participant at the first position in the three-dimensional environment. For example, the computer system optionally presents visual and/or audio feedback indicating the first position relative to the current viewpoint in accordance with a determination that the one or more criteria are satisfied (e.g., before and/or at a same time when the first participant corresponds to the first position), such as including a criterion that is satisfied when a respective (e.g., the first, or another) position corresponding to the first participant is within a first range of positions relative to the current viewpoint of the user. As an additional example, when the first position is within a first range of positions corresponding to one or more regions relative to the current viewpoint of the user such as one or more regions outside of a viewport of the user, the computer system optionally displays one or more virtual elements such as an animated glowing effect overlaying the user's view of the three-dimensional environment. Additionally or alternatively, the first feedback optionally includes displaying a visual indication describing and/or pointing toward the first position relative to the current viewpoint. In some embodiments, the first feedback includes displaying virtual content such as a glowing effect and/or the visual indication at a region of the user's field-of-view of the three-dimensional environment corresponding to the first position, as described further herein. For example, in accordance with a determination the first position is left of a center of the viewport, the computer system optionally displays a glowing effect consuming a left-portion of the user's field-of-view (FOV) from their current viewpoint. In accordance with a determination that the first position is right of a center of the viewport, the computer system optionally forgoes display of the glowing effect at the left-portion of the user's FOV, and optionally displays the glowing effect consuming a right-portion of the user's FOV from their current viewpoint. In some embodiments, the computer system presents audio such as a notification sound and/or a voice corresponding to the first participant included in the first feedback. For example, the computer system optionally plays a notification chime having one or more characteristics of the audio that cause the audio to be generated as if emanating from the first position relative to the current viewpoint of the user (e.g., “spatializing” and/or “spatialization” including the audio being modified in amplitude, filtered, and/or delayed to provide a perceived spatial quality to the user of the computer system). Thus, in some embodiments, the computer system presents visual and/or audio feedback indicating the first position of the first participant relative to current viewpoint of the user, thereby informing the user about an updated position of the first participant. In some embodiments, the first range of positions correspond to any position within the three-dimensional environment. In some embodiments, the first range of positions include positions outside the viewport. In some embodiments, the first range of positions is one of a plurality of ranges of positions, the plurality of range of positions defining different regions of the three-dimensional environment relative to the current viewpoint of the user (e.g., one or planar or volumetric wedges, or other planar or volumetric shapes that are optionally not displayed and that optionally have a pointed end incident with the current viewpoint of the user). In some embodiments, after (e.g., in response to) obtaining the first information, in accordance with a determination that the one or more criteria are satisfied and that the current viewpoint of the user includes the first position (e.g., within the viewport), the computer system displays a visual representation of the participant corresponding to (e.g., at) the first position. In some embodiments, the computer system displays the visual representation of the participant concurrently, shortly before, and/or shortly after providing the first feedback.

It is understood that embodiments described herein referencing the first participant optionally applies to additional or alternative participants. For example, the computer system optionally presents second feedback having one or more characteristics of the first feedback in accordance with a determination that one or more criteria are satisfied, including a criterion satisfied when a second participant, different from the first participant, will correspond to the first position or a different position in the three-dimensional environment. Additionally or alternatively, it is understood embodiments described herein referencing the first position optionally apply to other positions within the three-dimensional environment that satisfy the criterion. For example, the computer system optionally presents the first feedback in accordance with a determination that the first participant (or another participant) will correspond to a second position within the first range of positions.

In some embodiments, the glowing effect includes displaying one or more fill patterns overlaying the user's view of the three-dimensional environment, such as one or more solid color fills. In some embodiments, the fill pattern(s) are displayed with a degree of opacity (e.g., 0.1, 5, 10, 15, 25, 40, 50, 60, 75, or 85% opacity) such that the user can continue to view the three-dimensional environment through the glowing effect. In some embodiments, the glowing effect is displayed with a gradient of opacity, where a relatively central portion of the glowing effect is displayed with a first degree of opacity, and an edge of the glowing effect is displayed with a second degree of opacity, greater than or less than the first degree of opacity, and portions of the glowing effect intermediate to the central portion and the edge of the glowing effect displayed with a continuum (or near continuum) opacity gradient. In some embodiments, the first range of position include a region within a simulated threshold distance (e.g., 0.1, 0.25, 0.5, 1, 2.5, 5, or 10 m) of the current viewpoint of the user.

In some embodiments, in response to obtaining the information (1602b), in accordance with a determination that the one or more first criteria are not satisfied, the computer system forgoes (1602d) presenting of the first feedback, such as not displaying glow 1512 in FIG. 15B. For example, when the first position is not within the first range of positions, such as when the first participant will correspond to a position within viewport, the computer system optionally forgoes presenting of the first feedback, such as forgoing display of the glowing effect, visual indication, and/or forgoing playing of audio notifying the user of the first position. In some embodiments, after (e.g., in response to) obtaining the first information, in accordance with a determination that the one or more criteria are not satisfied and that the current viewpoint of the user includes the first position (e.g., within the viewport at the current viewpoint), the computer system displays a visual representation of the participant corresponding to (e.g., at) the first position. In some embodiments, after (e.g., in response to) obtaining the first information, in accordance with a determination that the current viewpoint of the user does not include the first position, the computer system forgoes display of the visual representation of the participant at the first position.

In some embodiments, after (e.g., in response to) obtaining second information, different from the first information, and in accordance with a determination that the one or more criteria are satisfied with respect to a second position that the first participant will correspond to as indicated by the second information, the second position different from the first position, the computer system presents second feedback, different from the first feedback, indicating a spatial relationship between the current viewpoint of the user and the second position. Similar or the same as described with reference to the first feedback, the second feedback optionally is different from displaying the visual representation of the first participant at the second position, and the second feedback optionally is presented shortly before, concurrently with, and/or shortly after displaying the first representation of the participant at the second position in accordance with a determination that the second position is optionally within the current viewpoint (e.g., within the viewport at the current viewpoint) of the participant. Presenting first feedback when one or more criteria are satisfied improves user awareness of a spatial relationship between the user and the first position, thereby reducing processing and power required to detect and perform operations in response to inputs otherwise required to determine the spatial relationship.

In some embodiments, presenting the first feedback includes playing audio corresponding to the first participant, such as the audio generated as if emanating from position 1536 in FIG. 15B. For example, as described with reference to step(s) 1602, the first feedback optionally include audio, such as audio detected by one or more microphones included in the second computer system including the user's voice and/or other sounds generated by the user. In some embodiments, the playing of the audio corresponding to the first participant includes changing one or more characteristics of audio obtained from the second computer system to mimic an effect of placing an audio source that generates the playing audio within a position corresponding to the first participant, such as a position within the three-dimensional environment that the first participant moves to, spawns at, and/or is assigned to. Playing audio emphasizes spatial relationship changes between the current viewpoint of the user and the position corresponding to the first participant, thereby reducing the likelihood that the user provides erroneous inputs due to ambiguities in the spatial relationship and reducing processing required to detect such inputs.

In some embodiments, the audio corresponding to the first participant is generated as if emanating from the first position within the three-dimensional environment, such as if emanating from position 1536 in FIG. 15B. For example, as described with reference to step(s) 1602, the computer system optionally plays the first audio with one or more characteristics configured to mimic a physical audio source having a position within the three-dimensional environment, thus optionally generating audio as if using a simulated audio source placed at the first position within the three-dimensional environment. A relative magnitude of audio at one or more frequencies and/or groups of frequencies is optionally changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the first participant will correspond to a second position, different from the first, and that the one or more first criteria are satisfied, the computer system presents feedback including generating audio as if emanating from the second position. Generating the audio as if the audio was generated by a physical audio source reinforces the user's understanding of the first position relative to the user's current viewpoint.

In some embodiments, while the user of the computer system is participating in the communication session with one or more participants, the computer system obtains second information that a position of a second participant, different from the first participant, in the communication session will correspond to a second position within the three-dimensional environment of the computer system relative to the current viewpoint of the user, such as information indicating that second representation 1538 will be correspond to a position as shown in FIG. 15C. For example, the second information has one or more characteristics of the information, the second participant has one or more characteristics of the first participant (e.g., the second participant uses a respective computer system to participate in the communication session), and a spatial relationship between the second position and the current viewpoint of the user has one or more characteristics of a spatial relationship between the first position and the current viewpoint of the user, respectively described further with reference to step(s) 1602.

In some embodiments, in response to obtaining the second information, (optionally in accordance with a determination that a position corresponding to the second participant satisfies the one or more first criteria), and in accordance with a determination that one or more second criteria are satisfied, including a criterion that is satisfied when the position of the first participant will correspond to the first position and the position of the second participant will correspond to the second position within a threshold amount of time (e.g., 0.1, 0.5, 0.1, 0.25, 0.5, 0.75, 1, 1.25, 1.5, 1.75, 2, 3, or 5 seconds) of one another (e.g., the second information is obtained within the threshold amount of time of obtaining the information), such as first representation 1530 corresponding to a position as shown in FIG. 15B and second representation 1538 corresponding to a position as shown in FIG. 15C, the computer system presents second feedback, different from the first feedback, associated with the second position of the second participant, more than the threshold amount of time after presenting the first feedback, wherein the second feedback indicates a spatial relationship between the second position and the current viewpoint of the user, such as a glow 1512 in FIG. 15C and/or audio generated as if emanating from position 1540 in FIG. 15C. For example, the computer system optionally presents feedback for a plurality of participants (e.g., each participant) that respectively correspond to positions within the three-dimensional environment of the user. As an example, the computer system optionally presents second feedback having one or more characteristics of the first feedback described with reference to step(s) 1602. In some embodiments, the second feedback is presented in accordance with a determination that the second position satisfies the one or more criteria described with reference to step(s) 1602, such as in accordance with a determination the second position is outside the viewport of the user. In some embodiments, in accordance with a determination that the second position is within the viewport of the user, the computer system forgoes presentation of the second feedback.

In some embodiments, the computer system presents or forgoes immediate presentation of the second feedback in accordance with a determination the one or more second criteria are satisfied, such as a criterion satisfied when the position of the first participant will correspond to an updated position soon after the first feedback is presented. For example, the computer system optionally presents the second feedback indicating a spatial relationship between the current viewpoint of the user and the second position in accordance with a determination that the second information is obtained within a threshold time (e.g., 0.1, 0.5, 0.1, 0.25, 0.5, 0.75, 1, 1.25, 1.5, 1.75, 2, 3, or 5 seconds) of obtaining the information. In accordance with the determination that the second one or more criteria are not satisfied, the computer system optionally delays presentation of the second feedback (e.g., by 0.1, 0.5, 0.1, 0.25, 0.5, 0.75, 1, 1.25, 1.5, 1.75, 2, 3, or 5 seconds) and optionally proceeds to present the second feedback after the delay. Presenting the second feedback when the one or more second criteria are satisfied reduces the likelihood that the computer system provides an excess of feedback, reducing cognitive burden of the user and reducing processing required to present feedback when the one or more second criteria are not satisfied.

In some embodiments, the first feedback includes audio and visual feedback indicating the spatial relationship between the current viewpoint of the user and the first position relative to the current viewpoint of the user, such as glow 1512 and/or the audio generated as if emanating from position 1536 in FIG. 15B. For example, presenting the first feedback optionally includes generating audio (e.g., spatialized audio described herein). In some embodiments, presenting the first feedback additionally or alternatively includes presenting visual feedback, such as displaying a simulated glow effect overlaying a portion of the viewport (e.g., “consuming” the portion of the viewport). In some embodiments, the generated audio and the simulated glow effect are presented concurrently or in rapid succession. In some embodiments, the simulated glow effect has one or more characteristics of the simulated glow effect(s) described with reference to method 1400. For example, displaying the simulated glow effect optionally includes displaying a color and/or pattern fill that is optionally at least partially transparent. In some embodiments, the size and/or position of the simulated glow effect relative to the viewport visually indicates the spatial relationship between a position that a participant will correspond to and the current viewpoint the user, such as the spatial relationship between the first position and the current viewpoint. For example, when the first position is to the right of the user's current viewpoint (e.g., a center of the viewport), the computer system optionally displays the glow effect consuming one or more portions right of center of the viewport, and optionally does not display the glow effect consuming one or more portions left of the center of the viewport. As an additional example, when the first portion is to the left of the user's current viewpoint (e.g., a center of the viewport), the computer system optionally displays the glow effect consuming one or more portions left of center of the viewport, and optionally does not display the glow effect consuming one or more portions right of the center of the viewport. Presenting audio and visual feedback indicating the spatial relationship between the user's viewpoint and the first position offers multiple modalities of feedback, thus improving feedback for the visually or hearing impaired and drawing increased attention to the spatial relationship, thereby improving user awareness concerning the spatial relationship and reducing user input required to gain an understanding of the spatial relationship.

In some embodiments, the first feedback includes a simulated glowing effect displayed at a respective portion of the current viewport of the user, such as the viewport 1570 as shown in FIG. 15A, wherein a spatial relationship of the respective portion relative to the viewport corresponds to the spatial relationship between the current viewpoint of the user and the first position, such as a spatial relationship between position 1536 in FIG. 1536 and the viewpoint of user 1504 and/or the viewport 1570 and the glow 1512 as shown in FIG. 15A and/or FIG. 15B. For example, the simulated glowing effect has one or more characteristics of the simulated glowing effect described with reference to method 1400. Additionally or alternatively, the simulated glowing effect has one or more characteristics described with reference to step(s) 1602, and/or herein with reference to the simulated glowing effect “consuming” portion(s) of the viewport. For example, the respective portion of the current viewport optionally corresponds to left one or more regions of the viewport (e.g., a left upper and/or lower corner, left one or more portions such as extending from the left edge of the viewport, and/or other suitable positions of the viewport toward the left of a center of the viewport) of the viewport in accordance with a determination that the first position is relatively to a left of the current viewpoint user and/or the current viewport. As an additional example, the respective portion of the current viewport optionally corresponds to right one or more regions of the viewport (e.g., a right upper and/or lower corner, right one or more portions such as extending from the right edge of the viewport, and/or other suitable positions of the viewport toward the right of a center of the viewport) in accordance with a determination that the position corresponding to the first participant will be a second position, different from the first position, relatively to the right of a center of the viewport of the user. In some embodiments, the simulated glow effect has a magnitude that reflects a relative proximity of the first position. For example, in accordance with a determination that the first position is outside, and relatively to the right of the viewport of the user at a first distance from the user's current viewpoint, the computer system optionally presents a first magnitude (e.g., spatial profile) of the simulated glowing effect, such as a first distance and degree of curvature of an arc-shaped glowing effect extending from the right edge of the viewport toward the center of the viewport. In accordance with a determination that the first position is outside, relatively to the right of the viewport, and at a second distance, different from (e.g., greater or less than) the first distance, the computer system optionally presents a second magnitude of the simulated glowing effect, such as a second distance and/or second degree of curvature of the arc-shaped glowing effect extending from the right edge of the viewport (e.g., a greater distance and degree of curvature, or a smaller distance and degree of curvature). It is understood that the simulated glow effect is additionally or alternatively displayed in response to obtaining information indication that additional or alternative participants other than the first participant will correspond to a position within the three-dimensional environment (e.g., a position outside a viewport of the user). Displaying a simulated glowing effect indicating a spatial relationship between the viewpoint of the user and the first position reduces user input required to detect changes in user viewpoint to view the first position, thereby reducing processing required to detect and perform operations associated with the user input.

In some embodiments, while the user of the computer system is participating in the communication session and prior to obtaining the information that the position of the first participant will correspond to the first position within the three-dimensional environment, the computer system presents first audio, wherein the first audio is different from the first feedback, and the information is received while the first audio is being presented, such as the audio corresponding to virtual object 1506 indicated by glyph 1508 as shown in FIG. 15A. For example, the first audio optionally includes audio received from another participant (e.g., speaking and/or making noise) and/or audio included in media content played by the computer system.

In some embodiments, in response to obtaining the information, and in accordance with the determination that the one or more first criteria are satisfied, the computer system modifies one or more characteristics of the first audio, such as changing the level of the audio from as shown by glyph 1508 from as shown in FIG. 15A to as shown in FIG. 15B. For example, the computer system optionally changes characteristics of the first audio such as reducing a magnitude of the first audio (e.g., volume) and/or causing a muffling of the first audio in response to obtaining the information. In some embodiments, the one or more characteristics of the first audio are changed concurrently with the presenting of the first feedback, such as concurrently with playing of spatialized audio indicating a spatial relationship between the current viewpoint of the user and the first position. Modifying the one or more characteristics of the first audio draws attention to the first feedback that is presented, thereby reducing the likelihood that the first feedback goes unnoticed.

In some embodiments, presenting the first feedback includes playing first one or more tones, such as the first tone 1516a in FIG. 15B. For example, the computer system optionally plays one or more musical tones (e.g., first single note(s) or a first chord) corresponding to and/or included in presentation of the first feedback.

In some embodiments, while the user of the computer system is participating in the communication session with the one or more participants, and the user has the current viewpoint relative to the three-dimensional environment of the computer system, obtaining second information, different from the information, that a position of a second participant, different from the first participant, in the communication session will correspond to a second position within the three-dimensional environment of the computer system relative to the current viewpoint of the user, such as information that a participant corresponding to representation 1538 will correspond to position 1540 as shown in FIG. 15C. For example, the second information has one or more characteristics of the information, the second participant has one or more characteristics of the first participant, and the second position has one or more characteristics of the first position described with reference to step(s) 1602.

In some embodiments, in response to obtaining the second information, in accordance with a determination that one or more second criteria are satisfied (e.g., analogous to the one or more first criteria), including a criterion that is satisfied when a position corresponding to the second participant is outside of the viewport of the computer system, such as outside viewport as shown in FIG. 15A, the computer system presents second feedback indicating a spatial relationship between the current viewpoint and the second position, wherein presenting the second feedback includes playing second one or more tones, different from the first one or more tones, such as feedback including second tone 1516b in FIG. 15C. For example, the presenting of the second feedback has one or more characteristics similar or the same as those of presenting the first feedback. In some embodiments, presenting the second feedback includes playing one or more separate tones or playing a second chord, different from the first chord, thus audibly differentiating the first and the second feedback. Thus, in some embodiments, the computer system generates different sounds when different participants will correspond to positions within the three-dimensional environment. In some embodiments, the first and the second feedback respectively have different values for one or more characteristics, such as different respective pitches, different respective volumes, different respective frequency content, and/or different words that are “spoken” by the computer system corresponding to the participant associated with the respective feedback. Playing first or second tones in response to obtaining the information or the second information, respectively, distinguishes whether the first or a second participant will correspond to an updated position within the three-dimensional environment.

In some embodiments, the first one or more tones includes a first tone, the second one or more tones include a second tone, and the first tone and the second tone are separated by one or more musical intervals, such as first tone 1516a as shown in FIG. 15B relative to second tone 1516b as shown in FIG. 15C. For example, the first tone and the second tone are successive notes along a musical scale. Additionally or alternatively, the first one or more tones correspond to a first chord, and the second one or more tones correspond to a second chord, optionally with respective root notes along a scale (e.g., a chromatic scale or a diatonic scale). In some embodiments, the second one or more tones and/or chord is a note musically above or below the first tone and/or chord. In some embodiments, the first tone and the second tone are respective notes along an arpeggio (e.g., a root and third, a third and a fifth, a fifth and a seventh, a fifth and an octave, and/or another interval). In some embodiments, the computer system plays a plurality of musical notes corresponding to different participants. For example, the computer system optionally plays ascending notes of an arpeggiated chord, wherein the computer system plays a root of a chord when a first participant joins the communication and/or will correspond to a position in the three-dimensional environment, and the computer system plays an octave of the chord when a last joining participant joins the communication and/or will correspond to a position in the three-dimensional environment. In some embodiments, plays one or more tones intermediate to the root and the octave when participants join before the last participant joins (e.g., the communication session reaches a maximum number of communication session participants when the last participant joins). In some embodiments, the computer system plays a same tone when a respective participant joins and/or re-joins the communication session. In some embodiments, the computer system plays an initial tone when the respective participant joins the communication session, and plays an alternative tone when the respective participant re-joins the communication session after leaving the communication session. Playing separate tones to differentiate distinct participants that will correspond to respective positions within the three-dimensional environment reduces the likelihood the user is unaware of the respective positions of the participants, thus reducing the likelihood that the user needs to change their viewpoint to verify the positions of the participants.

In some embodiments, while the user of the computer system is participating in the communication session with the one or more participants, and the user has the current viewpoint relative to the three-dimensional environment of the computer system, obtaining third information, different from the information and different from the second information, that a position of a third participant, different from the first participant and different from the second participant, in the communication session will correspond to a third position within the three-dimensional environment of the computer system relative to the current viewpoint of the user, such as a participant corresponding to third representation 1542 in FIG. 15D will correspond to position 1544. For example, the third information, the third participant, and the third position have one or more characteristics similar or the same as those described with reference to the information, first participant, and the first participant respectively described with reference to step(s) 1602.

In some embodiments, in response to obtaining the third information in accordance with the determination that the one or more second criteria are satisfied (e.g., analogous to the one or more first criteria), such as one or more criteria that when satisfied can cause display of glow 1520 as shown in FIG. 15D, the computer system presents third feedback indicating a spatial relationship between the current viewpoint and the third position, wherein presenting the third feedback includes playing third one or more tones, different from the first one or more tones and different from the second one or more tones, such as displaying glow 1520 as shown in FIG. 15D and/or generating of third tone 1516d as shown in FIG. 15D. For example, the third feedback optionally has one or more characteristics similar or the same as those described with reference to the first feedback, and the third one or more tones have one or more characteristics similar or the same as the first one or more tones. In some embodiments, in response to obtaining the third information and in accordance with a determination that the one or more second criteria are not satisfied, the computer system forgoes presentation of the third feedback. Playing separate tones to differentiate distinct participants that will correspond to respective positions within the three-dimensional environment reduces the likelihood the user is unaware of the respective positions of the participants, thus reducing the likelihood that the user needs to change their viewpoint to verify the positions of the participants.

In some embodiments, while the user of the computer system is participating in the communication session with the one or more participants, the computer system obtains third information, different from the information and different from the second information, including an indication of a request to cease inclusion of a representation of the second participant, different from the first participant, in the three-dimensional environment, such as a request to cease inclusion of second representation 1538 received while second representation 1538 is displayed as shown in FIG. 15I. For example, the computer system optionally receives data, a request, and/or one or more commands to cease display and/or cease assignment of a spatial representation of the second participant in the three-dimensional environment. As an example, in response to obtaining the third information while the spatial representation (e.g., an avatar, and/or another type of spatial representation described with reference to methods 800, 900, and/or 1400) is displayed, the computer system optionally ceases display of the spatial representation of the second participant. In some embodiments, the representation of the second participant is not displayed before third information is displayed, and continues to not be displayed in response to obtaining the third information.

In some embodiments, in response to obtaining the third information, the computer system ceases inclusion of the representation of the second participant in the three-dimensional environment, such as the ceasing of display of second representation 1538 as shown in FIG. 15J. In some embodiments, in response to obtaining the third information, the computer system ceases display of the representation of the second participant, and/or replaces the representation of the second participant with an alternative representation of the second participant. Additionally or alternatively, the computer system optionally generates audio (e.g., spoken word(s), one or more tones, chords, arpeggios, and/or other audible indicators) that indicates that the first participant and/or another participant will cease inclusion of respective representations in the three-dimensional environment. For example, the alternative representation of the second participant corresponds to a non-spatial representation of the user that is displayed at a position within the three-dimensional environment, but does not rely upon spatial data obtained by a computer system used by the second participant to mimic movement of the representation of the second participant within the three-dimensional environment. As an example, the alternative representation of the second participant is optionally a tile including video and/or a placeholder image (e.g., initials, a portrait, and/or a name) corresponding to the second participant, such as a nearly two-dimensional window floating above a floor of the three-dimensional environment. In some embodiments, the alternative representation is displayed at a location within the three-dimensional environment that is grouped with additional representations with similar characteristics, such as additional nearly two-dimensional representation of other participants. For example, the computer system optionally displays a virtual canvas including a plurality of tiles including some or all of the alternative representations (e.g., non-spatial representation) of participants of the communication session. It is understood that dependent upon context, embodiments making reference to a position and/or positions apply to embodiments making reference to location and/or locations, and vice-versa.

In some embodiments, after the third information is obtained, the computer system obtains fourth information, different from the information, different from the second information, and different from the third information, that the position of the first participant in the communication session will correspond to a fourth position within the three-dimensional environment of the computer system relative to the current viewpoint of the user, such as information that the participant corresponding to representation 1558 as shown in FIG. 15J will correspond to a position within the three-dimensional environment. For example, after ceasing display and/or inclusion of the representation of the second participant (e.g., the spatial representation). For example, the fourth information has one or more characteristics of information (e.g., the information described with reference to step(s) 1602, the second information, and/or the third information) described herein, and the fourth position has one or more characteristics of the position(s) (e.g., the first, second, and/or third positions) described herein.

In some embodiments, in response to obtaining the fourth information, and in accordance with a determination that one or more second criteria, different from the one or more first criteria are satisfied, such as one or more criteria satisfied with respect to threshold 1549 as shown in FIG. 15L, the computer system presents fourth feedback, including playing the one or more first tones indicating a spatial relationship between the current viewpoint of the user and the fourth position, such as included in audio indicated by icon 1568 as shown in FIG. 15M. For example, the computer system optionally plays the first one or more tones in accordance with a determination that the fourth information indicates that the first participant will again correspond to a respective position within the three-dimensional environment. Thus, the computer system optionally plays a same set of one or more first tones when the first participant joins and/or re-joins the communication session, and/or in accordance with a determination that a participant transitions from being represented by a first type of representation (e.g., the non-spatial representation described previously) to a second type of representation. Thus, the one or more second criteria optionally include a criterion that is satisfied when that a participant that is associated (e.g., assigned) with one or more tones will correspond to a position within the three-dimensional environment (e.g., outside the viewport of the user). In some embodiments, the fourth feedback is presented in response to obtaining the fourth information and in accordance with a determination that the one or more first criteria, in addition to or in the alternative to the one or more second criteria, are satisfied.

It is understood that playing the first one or more tones indicating the spatial relationship between the current viewpoint of the user and the first position is optionally different from playing the first one or more tones indicating the spatial relationship between the current viewpoint of the user and the fourth position. For example, a same set of first one or more tones are optionally played in both scenarios, and a spatialization of the first one or more tones corresponding to the first position is different from a spatialization of the first one or more tones corresponding to the fourth position, such as configuring the one or more tones as if emanating from a virtual audio source having the first position within the three-dimensional environment. It is further understood that in some embodiments, the computer system plays a same audio segment (e.g., one or more tones and/or words, optionally with different characteristics such as a location of the spatialization) when a location of a corresponding participant will change. For example, the computer system optionally plays a C major chord when the location corresponding to the first participant will be a position outside the viewport of the user (e.g., a first position, a second position, a third position, and/or another suitable position), and the computer system optionally plays an E major chord when a location corresponding to a second participant will be a position outside the viewport of the user (e.g., a fourth, fifth, and/or sixth position). Presenting audio feedback when ceasing inclusion of representations of participants within the three-dimensional environment indicates that a position corresponding to the participants has changed, thus reducing the likelihood the user provides input attempting to locate the representation of the participants, and thereby reducing power consumption of the computer system. Additionally, playing first one or more tones when the first participant will correspond to a fourth position within the three-dimensional environment provides audible feedback specifying a position of the first participant, thus similarly reducing the likelihood that the user provides input attempting to locate the first participant and thereby reducing power consumption of the computer system.

In some embodiments, while the user of the computer system is participating in the communication session with the one or more participants, while the user has the current viewpoint relative to the three-dimensional environment of the computer system, and after presenting the second feedback (e.g., and/or after presenting the third feedback) the computer system obtains fourth information that a location of a fourth participant will correspond to a fourth position within the three-dimensional environment relative to the current viewpoint of the user.

In some embodiments, in response to obtaining the fourth information and in accordance with a determination that one or more third criteria are satisfied (e.g., analogous to the one or more first criteria), including a criterion that is satisfied when a period of time since presenting the second feedback has elapsed that is less than a threshold period of time (e.g., 0.1, 0.5, 0.1, 0.25, 0.5, 0.75, 1, 1.25, 1.5, 1.75, 2, 3, or 5 seconds), such as threshold 1549 as shown in FIG. 15K, the computer system presents fourth feedback, different from the first feedback, including playing fourth one or more tones, different from the first one or more tones, such as fourth tone 1516e as shown in FIG. 15F. As an example, the computer system optionally presents the fourth feedback described herein in accordance with a determination that the second feedback was presented at a time within a threshold time (e.g., 0.1, 0.5, 0.1, 0.25, 0.5, 0.75, 1, 1.25, 1.5, 1.75, 2, 3, or 5 seconds). For example, when presenting audio feedback for a succession of participants that somewhat rapidly will correspond to positions within the three-dimensional environment, the computer system optionally generates one or more tones for each participant joining within the threshold time, such as a series of ascending notes respectively played for each of the participant that is joining, starting with a first note. In such example(s), the computer system optionally presents feedback including playing a next-tone (e.g., and/or chord) along a sequence of the tones, such as along an arpeggio, providing a sense of the rapidity with which the succession of participants are corresponding to positions.

In some embodiments, in response to obtaining the fourth information and in accordance with a determination that the one or more third criteria are not satisfied, the computer system presents fifth feedback, different from the first feedback and the fourth feedback, including playing the first one or more tones, such as first tone 1516a and/or fifth tone 1516f as shown in FIG. 15F. In some embodiments, in accordance with a determination that a cooldown period (e.g., the threshold amount of time) has passed since presenting feedback (e.g., the fourth one or more tones), and in response to obtaining information that a participant will correspond to a position within the three-dimensional environment, the computer system plays the first one or more tones. For example, the computer system optionally plays the first one or more tones again indicating that the fourth participant will correspond to the fourth position, and further that the cooldown period has elapsed since presenting audio feedback corresponding to the succession of rapidly joining participants. For example, the computer system optionally initially plays a C when the first participant will join the communication session. After the threshold time has elapsed since initially playing the C, and in response to obtaining additional information that another participant (e.g., the fourth participant) will join the communication session, the computer system optionally plays the C again. Thus, in some embodiments, the computer system plays a succession of notes and/or chords, such as those with a first musical root ascending along a scale and/or arpeggio, when successive participants will correspond to positions in the three-dimensional environment (e.g., each within the threshold amount of time of the previous participant), and in some embodiments reverts to generating the first musical root along the scale and/or arpeggio in accordance with a determination that the threshold time has passed since last-presenting similar feedback. Playing the fourth one or more tones indicates that a threshold amount of time has elapsed and reduces the need for configuring more complex audio feedback schemes, thus reducing memory and/or processing required to determine and/or present the more complex audio feedback schemes.

In some embodiments, while the user and the first participant are participating in the communication session, the computer system obtains second information, different from the information, including an indication of a request to cease inclusion of a representation of the first participant in the three-dimensional environment, such as information obtained as shown in FIG. 15I associated with replacing second representation 1538 with representation 1558 from as shown in FIG. 15I to as shown in FIG. 15J. For example, the indication of the request to cease inclusion of the representation of the participant has one or more characteristics described here, such as those described with reference to a “spatial” and a “non-spatial” type of representation, and/or joining and/or leaving the communication session. As an example, the second information optionally indicates that the first participant will exit the communication session.

In some embodiments, in response to obtaining the second information, the computer system presents second feedback, different from the first feedback, including playing first audio associated with the ceasing of the inclusion of the representation of the first participant in the three-dimensional environment, such as audio indicated by icon 1564 as shown in 15J. For example, the musical tone(s), and/or one or more characteristics of the audio included in the second feedback are different from the first feedback. For example, the tones are musically distinct, the volume of the first and second feedback are different, a timbre of the first and second feedback are different, and/or a simulated instrument providing the tones are different. In some embodiments, the first audio is generated independently of whether the representation of the first participant is within the viewport of the user. Presenting the second feedback with distinct, first audio, provides feedback concerning the ceasing of the inclusion of the representation of the first participant, thus reducing the likelihood that the user erroneously directs their attention toward a previous position of the first participant, thereby reducing processing required by the computer system.

In some embodiments, presenting the first feedback includes playing second respective audio, wherein the second respective audio is generated as if the second respective audio is emanating from the first position, such as audio emanating from position 1536 as shown in FIG. 15B, and the first audio is not generated as if the first audio is emanating from a respective position within the three-dimensional environment associated with the first participant (e.g., the second respective audio is non-localized, described further herein), such as the audio indicated by icon 1564 as shown in FIG. 15J. For example, the computer system optionally spatializes the second respective audio as described with reference to step(s) 1602, and the computer system does not spatialize the first audio (e.g., the first audio is played in stereo, and characteristic(s) of the first audio are not changed to provide the perceived spatialization of the first audio). In some embodiments, the first audio is played independently of a position of the first participant when the second information is obtained. For example, the computer system optionally generates the first audio (optionally with a same set of characteristics such as volume, frequency content, pitch) in response to obtaining the second information, and while the location corresponding to the first participant is a first, second, and/or third position within the three-dimensional environment. Forgoing generating the first audio as if emanating from a position within the three-dimensional environment improves feedback concerning the nature of the change to the representation of the first participant, thus reducing the likelihood that the user erroneously provides input under the assumption that the representation of the first participant is included in the communication session, thereby reducing power consumption of the computer system.

In some embodiments, while the user of the computer system is participating in a second communication session, different from the communication session (and/or dependent upon context of the description, while the computer system is participating in the communication session described with reference to step(s) 1602 instead of the second communication session), with the one or more participants, such as a communication session associated with the display of the user interfaces associated with representations as shown in FIG. 15E-1, the computer system obtains second information that the position of the first participant in the second communication session will correspond to a second position within the three-dimensional environment of the computer system relative to the current viewpoint of the user, such as position of representation 1530 as shown in FIG. 15E-1 For example, the second communication session has one or more characteristic similar or the same as the communication session described with reference to step(s) 1602. In some embodiments, during the second communication session, a set of rules and/or determinations that dictate the presentation of feedback when participants will correspond to positions within the three-dimensional environment are at least in part different than those described with reference to step(s) 1602. In some embodiments, the second information and the second position have one or more characteristics similar or the same as one or more characteristics of the information and the first position, respectively, described with reference to step(s) 1602.

In some embodiments, in response to obtaining the second information in accordance with a determination that one or more second criteria are satisfied (e.g., including a criterion that is satisfied when the location corresponding to the first participant is not within the viewport of the user), including a criterion that is satisfied when the position corresponding to the first participant corresponds to first one or more positions of the three-dimensional environment, such as region 1522a, the computer system presents second feedback associated with the second position of the first participant, wherein the second feedback indicates a spatial relationship between the current viewpoint of the user and the first one or more positions, such as glow 1512 and/or audio emanating from position 1546a as shown in FIG. 15E-1. For example, the computer system optionally defines a plurality of regions of the three-dimensional environment relative to the user's viewpoint and provides the second feedback indicating which region the position corresponding to the first participant is within, such as a first region that includes the first one or more positions. In some embodiments, for example, the computer system defines two, three, or four regions, such as regions of the three-dimensional environment divided by lines intersecting with a center of the user's viewpoint. As an example, the computer system optionally defines a four-region division of the user's three-dimensional environment, defined by a pair of lines intersecting at the current viewpoint of the user, and forming equal angles between adjacent segments of the intersecting lines (the lines optionally not displayed). It is understood that such an example is not limiting, and that the relative angles between adjacent lines forming the regions of the three-dimensional environment optionally are different than those explicitly described. In some embodiments, the computer system presents feedback, such as a spatialized audio emanating from a virtual audio source placed at a respective portion of the region. For example, in accordance with a determination that the position of the participant will fall within a first region, the computer system optionally generates spatialized audio emanating from a first position within the first region, optionally different from the position that the first participant will correspond to. Additionally, in accordance with a determination that the position of the participant will fall within a second, different region, the computer system optionally generates the audio spatialized as if emanating from a second position within the second region, optionally different from the position that the first participant will correspond to in the second region. In some embodiments, the computer system additionally or alternatively displays a simulated glowing effect during the second communication, as described herein.

In some embodiments, in accordance with a determination that the one or more second criteria are not satisfied, the computer system forgoes presenting of the second feedback such as forgoing of display of glow 1512 and/or generation of audio emanating from position 1546a as shown in FIG. 15E-1. For example, the computer system optionally does not generate the spatial audio and/or does not display a simulated glowing effect in accordance with a determination that the position of the participant will not fall within the first one or more positions, and/or optionally generates different spatial audio and/or does display the simulated glowing effect with a second visual appearance in accordance with a determination that the position of the participant will fall within second one or more positions corresponding to a second region of the three-dimensional environment.

In some embodiments, in response to obtaining information that the position corresponding to the first participant will be a third position that is included in the first one or more positions of the three-dimensional environment, and in response to obtaining such information, the computer system presents the second feedback. In some embodiments, in response to obtaining information that such a position will be a fourth position included in the second one or more positions (and/or not included in the first one or more positions), the computer system presents third feedback, different from the first and second feedback indicative of a spatial relationship between the current viewpoint and the second one or more positions, such as generating audio as if emanating from a position included in the second one or more positions. Thus, the computer system optionally presents feedback such as spatialized audio feedback that indicates that the first participant and/or other participants will correspond to a first region—such as the first one or more positions—or a second region—such as the second one or more positions—in the three-dimensional environment relative to the current viewpoint of the user. Presenting second feedback when one or more second criteria are satisfied improves user awareness of a spatial relationship between the user and the second position, thereby reducing processing and power required to detect and perform operations in response to inputs otherwise required to determine the spatial relationship.

In some embodiments, presenting the second feedback includes playing audio corresponding to the first one or more positions, such as generating first tone 1516a as shown in FIG. 15B associated with ceasing inclusion of representation 1530 at the position of representation 1530 as shown in FIG. 15J For example, as described herein with reference to spatialization of the audio to correspond to a position within a region of the three-dimensional environment.

In some embodiments, while the user and one or more participants are participating in the communication session, the computer system obtains third information, different from the second information, including an indication of a request to cease inclusion of a representation of a second participant, different than the first participant, in the three-dimensional environment, such as information requesting ceasing of display of first representation 1530 obtained while displaying first representation 1530 as shown in FIG. 15I. For example, the third information has one or more characteristics similar or the same as one or more characteristics of information including an indication of a request to cease inclusion of a representation of the first participant, however, the third information is optionally associated with the second participant instead of the first participant.

In some embodiments, in response to obtaining the second information, and in accordance with a determination that one or more third criteria, different from the one or more second criteria are satisfied, the computer system presents third feedback, different from the first feedback and the second feedback, including playing first audio associated with the ceasing of the inclusion of the representation of the second participant in the three-dimensional environment, such as audio indicated by icon 1564 as shown in FIG. 15J, optionally including a first set of one or more tones. For example, the third one or more criteria has one or more characteristics similar or the same as one or more characteristics of one or more second criteria described with reference to the “cooldown period” described previously, however, the third one or more criteria are optionally associated with the second participant instead of the first participant. Additionally or alternatively, the one or more third criteria optionally include a criterion that is satisfied based on a cooldown period between successive participants ceasing inclusion of representation of the successive participants. Thus, the computer system optionally generates audio indicating a ceasing of inclusion of the representation of the second participant contingent upon satisfaction of the one or more third criteria. In some embodiments, the third one or more criteria include a criterion that is satisfied a participant requesting ceasing inclusion of their representation within the three-dimensional environment is the second participant.

In some embodiments, in accordance with a determination that the one or more third criteria are not satisfied, the computer system presents fourth feedback, different from the first feedback, including playing second audio associated with the ceasing of the inclusion of the second participant in the three-dimensional environment, such as audio indicated by icon 1564 as shown in FIG. 15J, optionally including a second set of one or more tones. For example, the computer system optionally plays first one or more tones (e.g., the first audio) or the second one or more tones (e.g., the second audio) in accordance with a determination that the ceasing of representation of the first participant is performed before the cooldown period has elapsed relative to when another representation of another participant was ceased. in some embodiments, when the participant requesting ceasing inclusion of their representation within the three-dimensional environment is a third participant, different from the second participant, the computer system generates different audio (e.g., one or more tones, chords, arpeggios, and/or words). It is understood that the computer system optionally generates unique audio associated with participants requesting ceasing inclusion of representations within the three-dimensional environment, and/or that within a window of time the computer system plays temporarily unique audio for different participants requesting such ceasing within the window of time. Presenting second feedback and the third feedback differentiate between users corresponding to locations within the three-dimensional environment from users ceasing inclusion of representations within the three-dimensional environment, thereby reducing the likelihood the user attempts to erroneously locate the users and reducing power consumption to detect the erroneous locating.

In some embodiments, the one or more third criteria include a criterion that is satisfied when a period of time greater than a threshold of time has passed since respective audio associated with ceasing of inclusion of a respective representation of a respective participant of the one or more participants in the three-dimensional environment was played, such as the period of time 1547 that is greater than threshold 1549 as shown in FIG. 15L. For example, the computer system optionally generates audio indicating the ceasing of inclusion of a representation of participant in accordance with a determination satisfaction of a criterion that is satisfied when a threshold amount of time (e.g., 0.1, 0.5, 0.1, 0.25, 0.5, 0.75, 1, 1.25, 1.5, 1.75, 2, 3, or 5 seconds) has elapsed since last-generating similar audio indicating the ceasing of inclusion of a different representation of a different participant.

In some embodiments, in accordance with a determination that the one or more third criteria are not satisfied, forgoing presenting of the third feedback, such as not generating audio indicated by icon 1566 as shown in FIG. 15K. For example, the computer system optionally does not generate audio indicating the second participant has left the communication session and/or has transitioned from being represented by a spatial representation to a non-spatial representation. Presenting third feedback contingent upon satisfaction of the one or more third criteria reduces the amount of feedback the computer system provides, thus reducing power consumption of the computer system.

In some embodiments, while the user of the computer system is participating in the second communication session, different from the communication session (and/or dependent upon context of the description, while the computer system is participating in the communication session described with reference to step(s) 1602 instead of the second communication session), with the one or more participants, such as a communication session associated with the display of the user interfaces associated with representations as shown in FIG. 15E-1 the computer system obtains third information that a position of a second participant in the second communication session will correspond to a third position within the three-dimensional environment of the computer system relative to the current viewpoint of the user, such as a position of representation 1548 as shown in FIG. 15F. In some embodiments, similar or the same as described with reference to the first participant, the computer system presents feedback indicating that a location of another (e.g., second, third, and/or fourth) participant will correspond to a position within the three-dimensional environment. For example, the third information, the second participant, and/or the third position have one or more characteristics similar or the same as the information, the first participant, and/or the first position described with reference to step(s) 1602. In some embodiments, the feedback for different participants is similar but distinct. For example, the computer system optionally plays audio (e.g., tones, chords, arpeggios, and/or words) that are unique for each participant. Additionally or alternatively, the computer system optionally plays the unique audio from a same position within a region that the corresponding participant will correspond to. For example, the computer system optionally plays a first chord when the first participant will join the communication session within a first region of the three-dimensional environment, the first chord played as if emanating from a first point within the first region. Additionally, the computer system optionally plays a second chord when the second participant will join the communication session within the first region, the second chord also played as if emanating from the first point within the first region.

In some embodiments, in response to obtaining the third information and in accordance with a determination that the one or more second criteria are satisfied (e.g., including a criterion that is satisfied when the location corresponding to the third participant is not within the viewport of the user), the computer system presents third feedback associated with the third position of the second participant, wherein the third feedback indicates a spatial relationship between the current viewpoint of the user and the first one or more positions, such as glow 1520 as shown in FIG. 15F and/or audio emanating from position 1554. For example, the third feedback has one or more characteristics of the first feedback described with reference to step(s) 1602. In some embodiments, the third feedback includes generating audio (e.g., one or more tones, chords, words, and/or arpeggios) that is unique to the second participant (e.g., is different from audio included in the first and/or second feedback indicative of the position of the first participant).

In some embodiments, the computer system obtains fourth information that a location of a third participant in the second communication session will correspond to a fourth position within the three-dimensional environment of the computer system relative to the current viewpoint of the user, such as information indicating that a participant corresponding to representation 1556 will be included in three-dimensional environment as shown in FIG. 15F. For example, the fourth information, the third participant, and/or the fourth position have one or more characteristics similar or the same as the information, the first participant, and/or the first position described with reference to step(s) 1602.

In some embodiments, in response to obtaining the fourth information and in accordance with a determination that the one or more second criteria are satisfied (e.g., including a criterion that is satisfied when the location corresponding to the third participant is not within the viewport of the user), presenting fourth feedback associated with the fourth position of the third participant, wherein the fourth feedback indicates a spatial relationship between the current viewpoint of the user and the first one or more positions, such as glow 1520 as shown in FIG. 15F. For example, the fourth feedback has one or more characteristics of the first feedback described with reference to step(s) 1602. In some embodiments, the fourth feedback includes generating audio (e.g., one or more tones, chords, words, and/or arpeggios) that is unique to the third participant (e.g., is different from audio included in the first and/or second feedback indicative of the position of the first participant and/or is different from audio included in the third feedback indicative of the position of the second participant).

In some embodiments, the computer system obtains fifth information, including an indication of a request to cease inclusion of a representation of the second participant in the three-dimensional environment, such as a request to cease display of second representation 1538 as shown from FIG. 15I to FIG. 15J. For example, the computer system optionally generates one or more tones associated with each participant that requests ceasing of inclusion of the representation of the corresponding participant. It is understood that the generating of tones, such as a pattern of the tones, a generating of distinct tones for each participant, information associated with the indication of the request to cease inclusion of representation of participants, are similar or the same as described with reference to the tones, chords, arpeggios, cooldown periods, and/or information described in association with the first feedback. Thus, the computer system optionally presents feedback indicating ceasing of inclusion of a representation of a participant in accordance with a determination that the ceasing does not occur within a cooldown period of another representation of a participant being ceased.

In some embodiments, in response to obtaining the fifth information, the computer system ceases inclusion of the representation of the second participant in the three-dimensional environment, such as the ceasing of inclusion of second representation 1538 as shown in FIG. 15J. For example, the computer system optionally ceases display of the representation of the second participant and/or ceases assignment of a spatial representation of the participant within the three-dimensional environment.

In some embodiments, after the fifth information is obtained, obtaining sixth information, that the position of the second participant will correspond to a fifth position within the three-dimensional environment of the computer system relative to the current viewpoint of the user, such as information indicating that representation 1538 will be displayed, used to display second representation 1538 as shown in FIG. 15M. For example, the fifth information has one or more characteristics similar or the same as one or more characteristics of the information described with reference to step(s) 1602, such as joining the communication session again and/or transitioning from a non-spatial to a spatial representation.

In some embodiments, in response to obtaining the sixth information, and in accordance with a determination that the one or more second criteria are satisfied, the computer system presents the third feedback, such as glow 1572 as shown in FIG. 15M. For example, the third feedback has one or more characteristics of feedback described herein with reference to the second communication session in the context of presenting feedback in accordance with “regions” of the three-dimensional environment. Thus, the computer system optionally presents the third feedback again, such as playing a same set of one or more tones when the second participant will correspond to the first one or more positions in a first instance and in a second instance. Presenting feedback when representation of participants will be included and/or no longer be included within the three-dimensional environment provides feedback concerning the location of the representation of the participants relative to the user's viewpoint, thus reducing erroneous user input directed to previous location of the representation of the participants, and thereby reducing power consumption of the representation of the participants.

In some embodiments after obtaining the second information, obtaining third information, different from the second information, corresponding to a request to cease inclusion of the first participant in the three-dimensional environment, such as a request to cease display of second representation 1538 as shown from FIG. 15I to FIG. 15J. For example, the third information has one or more characteristics similar or the same as the one or more characteristics of the second information.

In some embodiments, in response to obtaining the third information in accordance with a determination that one or more third criteria are satisfied, including a criterion that is satisfied when a threshold amount of time of (e.g., before) has elapsed after ceasing the inclusion of the first participant in the three-dimensional environment, such as the period of time 1547 as shown in FIG. 15L greater than threshold 1549, the computer system presents third feedback, wherein the third feedback indicates the ceasing of the inclusion of the first participant in the three-dimensional environment, such as the audio indicated by icon 1564 as shown in FIG. 15J. For example, as described above with reference to the “cooldown” period associated with representation of participants no longer being included in the three-dimensional environment above.

In some embodiments, in accordance with the determination that the one or more third criteria are not satisfied, forgoing presenting of the third feedback, such as not generating the audio, similar to as indicated by icon 1566 in FIG. 15K. For example, when a plurality of participants somewhat rapidly cease inclusion of their corresponding representations within the three-dimensional environment, the computer system optionally presents feedback once, as indicative of the group of representation of participants exiting and/or transitioning to a non-spatial representation. Presenting third feedback when one or more third criteria are satisfied reduces power consumption required to present the third feedback in every instance such as when the one or more third criteria are not satisfied.

In some embodiments, the second feedback includes playing first audio having one or more characteristics configured to simulate an audio source that is providing the audio located at a position corresponding to the first one or more positions of the three-dimensional environment, such as generating audio as if emanating from region 1522a at position 1546a as shown in FIG. 15E. For example, as described further herein with reference to the second communication session and the one or more regions of the three-dimensional environment of the user. In some embodiments, a “position corresponding to the first one or more positions” is and/or is included in a region of the three-dimensional environment. For example, the respective position of different regions is optionally a same distance, and/or optionally are at different angles formed between a vector extending from the center of the user's current viewpoint and a vector extending toward the respective position of a given region. In some embodiments, in response to obtaining information that a participant such as the first participant will correspond to second one or more positions such as a second region of the three-dimensional environment, the computer system presents feedback simulating an audio source providing audio at a position corresponding to the second one or more positions. Presenting spatialized audio at a respective position provides audible feedback indicating where the participant will correspond to, thus reducing power consumption of the computer system attempting to facilitate localization of the location that the participant will correspond to.

In some embodiments, while the user of the computer system is participating in the communication session with the one or more participants, the computer system obtains third information, different from the second information, that a position of a second participant, different from the first participant, in the communication session will correspond to a third position within the three-dimensional environment of the computer system relative to the current viewpoint of the user, such as representation 1538 joining the communication session at a position within region 1522a. For example, the third information has one or more characteristics of the second information, the third information associated with the second participant instead of the first participant. Similarly, the third position optionally has one or more characteristics similar or the same as the second position.

In some embodiments, in response to obtaining the third information, in accordance with a determination that the one or more second criteria are satisfied, including a criterion that is satisfied when the location corresponding to the first participant and the location corresponding to the second participant are included in second one or more positions of the three-dimensional environment, such as region 1522b as shown in FIG. 15E-1, the computer system presents third feedback, wherein presenting the second feedback includes playing first audio having one or more characteristics configured to simulate an audio source that is providing the audio located at a position corresponding to the second one or more positions of the three-dimensional environment, such as audio emanating from position 1546b as shown in FIG. 15E-1. For example, the computer system optionally generates first audio indicating that the first participant and the second participant will correspond to a same region (e.g., the second one or more positions) of the three-dimensional environment, and/or optionally forgoes providing separate audio to separately indicate as such. The first audio optionally has one or more characteristics of the audio feedback described herein (e.g., spatialization, tones, and/or relationships between musical intervals). In some embodiments, the one or more second criteria include a criterion that is satisfied when the first and the second participant will correspond to the first one or more positions of the three-dimensional environment within a threshold time of one another (e.g., 0.1, 0.5, 0.1, 0.25, 0.5, 0.75, 1, 1.25, 1.5, 1.75, 2, 3, or 5 seconds). Presenting a shared first audio indicating that the first and the second participant will correspond to the first one or more positions of the three-dimensional environment reduces power consumption required to separately provide feedback indicating changes to locations corresponding to the first and the second participant.

In some embodiments, the first one or more positions are associated with the current viewpoint of the user relative to the three-dimensional environment, such as associated with the viewpoint of user 1504 as shown in FIG. 15E-1 and/or FIG. 15E-2. For example, the first range of one or more positions optionally are defined relative to the user's current viewpoint, such as one or more regions of the three-dimensional environment defined by lines intersecting with the current viewpoint of the user as described further herein. In some embodiments, in response to detecting changes in the current viewpoint of the user, the computer system changes a location and/or region that the first one or more positions correspond to in accordance with the current viewpoint of the user. For example, the computer system optionally rotates and/or moves the lines and by respective magnitudes of rotation and/or movement of the current viewpoint of the user.

In some embodiments, in response to obtaining the second information and in accordance with the determination that the one or more second criteria are satisfied, in accordance with a determination that the current viewpoint is a first viewpoint relative to the three-dimensional environment, the computer system presents the first feedback wherein the first one or more locations correspond to a first location relative to the three-dimensional environment, such as the audio emanating from position 1546a due to the representation 1530 corresponding to region 1522a while the viewpoint of user 1504 is as shown in FIG. 15E-1. For example, the computer system optionally moves and/or rotates the lines defining the one or more regions of the three-dimensional environment following the changes of the current viewpoint, such as relative to the first viewpoint.

In some embodiments, in accordance with a determination that the current viewpoint is a second viewpoint, different from the first viewpoint, such as a viewpoint of user 1504 as shown in FIG. 15E-2, relative to the three-dimensional environment, the computer system presents the first feedback, wherein the first one or more locations correspond to a second location relative to the three-dimensional environment, such as generating audio emanating from position 1546e corresponding to region 1522e as shown in FIG. 15E-2. For example, the computer system optionally defines the lines defining the current viewpoint relative to the second, different viewpoint of the user. Defining the first one or more positions based on the current viewpoint of the user provides consistency of feedback, reducing the likelihood that the user is unaware of positions that participants will correspond to and reducing processing required to detect changes in user viewpoint attempting to locate the participants.

In some embodiments, the one or more first criteria are not satisfied when the location corresponding to the first participant is inside of the viewport of the computer system, such as the representation 1542 spawning within the viewport 1570 of the user 1504 as shown in FIG. 15E. For example, in accordance with a determination that the participant will correspond to a position within the user's viewport, the computer system forgoes presentation of feedback (e.g., spatialized audio, and/or simulated glow feedback) indicating that the participant will correspond to an updated location. Forgoing presentation of feedback in accordance with a determination that the location corresponding to the first participant will be inside of the viewport of the computer system reduces processing and power consumption required to both display the representation of the participant and present the feedback.

In some embodiments, while the user of the computer system is participating in a second communication session, different from the communication session, with the one or more participants, the computer system obtains second information that the position of the first participant in the second communication session will correspond to a second position within the three-dimensional environment of the computer system relative to the current viewpoint of the user, such as the communication session, the positions of representations, and/or information causing correspondence between the representation within three-dimensional environment 1502 as shown in FIG. 15F. For example, the second communication session has one or more characteristics similar or the same as the communication session described with reference to step(s) 1602. In some embodiments, during the second communication session, a set of rules and/or determinations that dictate the presentation of feedback when participants will correspond to positions within the three-dimensional environment are at least in part different than those described with reference to step(s) 1602. In some embodiments, the second information and the second position have one or more characteristics similar or the same as one or more characteristics of the information and the first position, respectively, described with reference to step(s) 1602.

In some embodiments, in response to obtaining the second information, the computer system presents second feedback associated with the second position of the first participant, wherein the second feedback indicates a spatial relationship between the current viewpoint of the user and the second position, such as the audio generated as shown in from position 1550, 1552, 1554, and/or 1556 as shown in FIG. 15F, and wherein the presenting of the second feedback, different from the first feedback, is performed independently of the spatial relationship between the current viewport of the user and the second position, such as generating audio corresponding to the positions described with reference to, and as shown in FIG. 15F. For example, the second feedback has one or more characteristics of the first feedback. In some embodiments, the computer system presents feedback irrespective of whether a position a participant will correspond to within the viewport of the user. For example, the computer system optionally presents feedback such as spatialized audio as if emanating from a position within the current viewport of the user, and/or displays a simulated glow effect at such a position. Presenting feedback independently of the spatial relationship between the current viewpoint and the second position reduces the likelihood that participants will correspond to locations in the three-dimensional environment, and reduces erroneous input directed to portions of the three-dimensional environment that do not desirably include the representation of participants.

In some embodiments, while the user and the first participant are participating in the communication session, the computer system displays a visual representation of the first participant with a first level of visual prominence at a respective position within the three-dimensional environment, such as a level of visual prominence of representation 1542 as shown in FIG. 15G, wherein the visual representation of the first participant has a first spatial arrangement relative to the current viewpoint of the user, such as the spatial relationship between representation 1542 and the viewpoint of user 1504 as shown in FIG. 15G. For example, the representation of the first participant has one or more characteristics of the representations described with reference to methods 800, 900, and/or 1400. The first spatial arrangement optionally includes the position and/or orientations of the representations of participants and/or virtual objects (e.g., including media content) relative to the current viewpoint of the user. In some embodiments, the level of visual prominence includes an opacity, brightness, saturation, blurring effect, and/or a form of the visual representation. In some embodiments, the computer system increases the level of visual prominence (e.g., increases opacity, brightness, saturation, magnitude of the blurring effect, and/or changes the form of the visual representation) and/or decreases the level of the visual prominence (e.g., decreases opacity, brightness, saturation, magnitude of the blurring effect, and/or changes the form of the visual representation).

In some embodiments, while displaying the visual representation of the first participant with the first level of visual prominence and while the visual representation of the first participant has the first spatial arrangement relative to the current viewpoint of the user, the computer system detects, via the one or more input devices, an indication of a request to share respective first content in the communication session, such as input using hand 1507 directed to button 1528 as shown in FIG. 15G. For example, the participant(s) and/or the user of the computer system provide inputs detected by the computer system requesting a sharing of media, virtual objects, and/or text with the communication session.

In some embodiments, in response to detecting the indication of the request, and while maintaining the current viewpoint of the user, the computer system displays, via the display generation component, the respective first content at an initial position within the three-dimensional environment, and with a first spatial relationship relative to the visual representation of the first participant displayed with the first level of visual prominence, such as the display of virtual object 1506 (e.g., the level of visual prominence and/or the spatial relationship) as shown in FIG. 15H. For example, the computer system optionally initiates display of the media, virtual object, and/or text.

In some embodiments, in response to detecting the indication of the request, and while maintaining the current viewpoint of the user, the computer system reduces a visual prominence of the visual representation of the first participant to a second level of visual prominence (e.g., optionally 0% opacity such as ceasing display of the first participant), different from the first level of visual prominence, such as decreasing the level of visual prominence of representation 1542 from as shown in FIG. 15G. For example, the second level of visual prominence includes ceasing display of one or more visual representation of the participants. In some embodiments, the computer system moves the representation of the participants. When ceasing display of the one or more visual representations of participants, it is understood that the computer system optionally temporarily ceases inclusion of visual representation of the participants in the three-dimensional environment. In some embodiments, the reducing of the visual prominence is performed before initiating display of the respective first content.

In some embodiments, in response to detecting the indication of the request, and while maintaining the current viewpoint of the user, the computer system presents second feedback, different from the first feedback, indicating the reduction of the visual prominence of the visual representation of the first participant from the first level of visual prominence to the second level of visual prominence (e.g., a non-localized audio feedback), such as corresponding to audio associated with icon 1564 as shown in FIG. 15J. For example, the second feedback optionally includes providing feedback as described with reference to ceasing inclusion of the representations of the participants described previously.

In some embodiments, after reducing the visual prominence of the visual representation of the first participant to the second level of visual prominence, the computer system displays, via the display generation component, the visual representation of the first participant with a third level of visual prominence, greater than the second level of visual prominence, and with a second spatial relationship relative to the current viewpoint of the user, different from the first spatial relationship, such as the spatial relationship of representation 1542 as shown in FIG. 15H, and/or a level of visual prominence different from as shown in FIG. 15G. For example, the computer system optionally displays the visual representations of the participant(s) with a third level of visual prominence (e.g., the same or different from the first level of visual prominence), and re-arranges the spatial relationship between the visual representations and the respective shared content, in some examples after displaying the respective first content. For example, the computer system optionally places the visual representations of the participants around in a semi-circle facing the respective content, side-by-side and facing the respective content, and/or otherwise oriented toward the respective first content.

In some embodiments, after reducing the visual prominence of the visual representation of the first participant to the second level of visual prominence, the computer system presents third feedback, different from the second feedback, indicating the second spatial relationship between the position corresponding to the first participant and the current viewpoint of the user, such as audio generated as if emanating from the position of representation 1542 as shown in FIG. 15H. In some embodiments, the third feedback has one or more characteristics of the feedback described herein, such as one or more tones, chords, and/or simulated glow feedback. In some embodiments, the third feedback includes playing spatialized audio indicative of the updated positions of the visual representations of the participants relative to the current viewpoint. Changing visual prominence of the visual representation of participants in response to sharing of the respective first content reduces user input(s) and processing required to explicitly request and/or move the visual representations and/or the respective first content.

In some embodiments, while displaying the respective first content at the initial position and while displaying the visual representation of the first participant with the third level of visual prominence and having the second spatial relationship relative to the current viewpoint of the user, such as the level of visual prominence of virtual object 1506 as shown in FIG. 15H, and/or such as displaying representation 1542 with a level of visual prominence that is different (or the same) as shown in FIG. 15G, the computer system detects, via the one or more input devices, an indication of a request to replace the respective first content with respective second content, different from the respective first content, such as an input directed to virtual object 1506 switching currently displayed content and/or replacing virtual object 1506 (e.g., while displayed as shown in FIG. 15H). For example, the indication of the request optionally includes user input and/or information obtained from other computer systems requesting a changing of media, text, shared virtual objects, and/or a changed application that is providing shared content (e.g., media content).

In some embodiments, in response to detecting the indication of the request to replace the respective first content, the computer system replaces the respective first content with the respective second content, such as replacing virtual object 1506 as shown in FIG. 15H with another virtual object and/or causing display of other included content within virtual object 1506. For example, ceasing display of the respective first content and initiating display of the respective second content. In some embodiments, in response to detecting the indication of the request to replace the respective first content, the computer system ceases display of the visual representation of the first participant, such as ceasing display of representation 1542 as shown in FIG. 15G. For example, similar or the same as described with reference to displaying the first participant with the second level of visual prominence. In some embodiments, the ceasing of the visual representation of the first participant is performed concurrent with the replacing of the respective first content with the respective second content, as described further below, and in some embodiments, the ceasing is performed before initiating display of the respective content described further below.

In some embodiments, after ceasing display of the visual representation of the first participant, the computer system displays, via the display generation component, the visual representation of the first participant with an updated spatial relationship relative to the current viewpoint of the user, such as the updating of spatial relationship between the viewpoint of user 1504 and representation 1542 from as shown in FIG. 15G to as shown in FIG. 15H. For example, similar or the same as described with reference to the second spatial relationship described previously.

In some embodiments, the computer system presents fourth feedback, different from the second feedback, indicating the updated spatial relationship between the first participant and the current viewpoint of the user, such as the glow 1512 and/or glow 1520 as shown in FIG. 15H. For example, similar or the same as described with reference to the third feedback described previously. Changing the spatial relationship of the visual representation of the participants relative to the changed, shared content reduces user input(s) required to manually change the spatial relationship.

In some embodiments, the information that the position of the first participant in the communication session will correspond to the first position within the three-dimensional environment of the computer system is associated with a request to update a spatial arrangement of elements of the communication session relative to the current viewpoint of the user, such as a request to display the representations of the participants and/or virtual object 1506 to updated positions and/or orientations, causing the spatial arrangement of elements as shown in FIG. 15H. In some embodiments, when one or more first criteria are satisfied relative to one or more first virtual objects such as the representations of participants, the computer system updates an arrangement of the one or more first virtual objects in response to an event (e.g., user input and/or information obtained from other participants) thus updating a spatial arrangement of elements of the communication session relative to the current viewpoint of the user. For example, the computer system optionally redefines respective position(s) and orientation(s) of a first set of one or more virtual objects relative to the current viewpoint-corresponding to a first updated spatial arrangement—in response to the event. In some embodiments, respective virtual objects are made visible (e.g., are displayed) when the virtual objects are displayed with the first updated spatial arrangement because such objects are moved in response to the event. For example, the first updated spatial arrangement optionally includes displaying and/or positioning the first set of one or more objects at a plurality of respective positions at least partially surrounding the current viewpoint, such that respective objects are optionally positioned at a fixed distance or a predetermined distance relative to the current viewpoint (e.g., based on and/or the same as the distance of the virtual objects relative to the current viewpoint while at the first spatial arrangement). In some embodiments, in response to displaying the one or more first virtual objects with the first updated spatial arrangement, the computer system displays a second set of one or more virtual objects with a second updated spatial arrangement (e.g., optionally the same as the second spatial arrangement) relative to the current viewpoint of the user. Updating the position of the first participant in accordance with a request to update the spatial arrangement of elements provides feedback when gross changes to the spatial arrangement occur, thus reducing input and thereby power consumption associated with attempts to orient the user as to the updated arrangement of elements.

In some embodiments, the information that the position of the first participant in the communication session will correspond to the first position within the three-dimensional environment of the computer system is associated with the first participant joining the communication session, such as the joining of the participant corresponding to representation 1530 as shown in FIG. 15B. For example, the information is similar or the same as described to inputs, indications of inputs, and/or other information associated with joining of communication sessions described with reference to methods 800 and/or 900. Providing feedback indicating the position of the first participant when the first participant will join the communication session reduces user input and thereby power consumption attempting to orient the user toward where the first participant will join.

In some embodiments, the information that the position of the first participant in the communication session will correspond to the first position within the three-dimensional environment of the computer system is associated with input for moving the first participant within a respective three-dimensional environment of the first participant, such as an input moving representation 1542 as shown in FIG. 15C. For example, the input has one or more characteristics similar or the same to those described with reference to methods 1100 and/or 1200. Providing feedback indicating updated positions that the first participant will correspond to in accordance with the inputs moving the first participant reduces user input and thereby power consumption attempting to understand the updated position of the first participant.

In some embodiments, the information that the position of the first participant in the communication session will correspond to the first position within the three-dimensional environment of the computer system is associated with a request to change a visual representation of the first participant from a first type of visual representation to a second type of visual representation in the communication session, such as a type of visual representation of representation 1542 as shown in FIG. 15E. For example, the information has one or more characteristics similar or the same as described with reference to operations changing between types of visual representations described with reference to methods 800, 900 and/or 1400. Providing feedback indicating the position of the first participant when the type of representation of the first participant changes reduces the likelihood that the user directs input that operates different from the user's expectation due to the change in the type of the representation, thereby reducing power consumption required to perform operations in response to such input.

In some embodiments, the information that the position of the first participant in the communication session will correspond to the first position within the three-dimensional environment of the computer system is associated with a request to change a spatial arrangement of elements of the communication session including one or more respective visual representations of the one or more participants of the communication session relative to each other, such as an input requesting arranging of such elements to an arrangement as shown in FIG. 15H. In some embodiments, the information includes a request that virtual locations of the users participating in the communication session be reset to virtual locations within a pre-defined template associated with the current quantity of users participating in the real-time communication session. In some embodiments, the first spatial arrangement includes an arrangement of the representation(s) of users participating in a multi-user communication session relative to each other, optionally corresponding to slots in a first pre-defined template that specifies a first quantity of virtual locations (e.g., slots at which respective users of the first quantity of users are placed) within the three-dimensional environment. In some embodiments, a template is associated with a shape (e.g., a circle having a particular radius, a square having sides of a particular length, an arc of a circle having a particular radius, a line, or another shape) having a perimeter on which a particular quantity of slots (e.g., virtual locations) are arranged and at which representations and/or viewpoints of users can be placed (e.g., automatically, by the computer system). For example, a first ring template optionally is associated with a circle of a first radius that includes a first quantity of slots (e.g., virtual locations) that can optionally be used to arrange a first quantity of representations and/or viewpoints of users along the perimeter of the circle. A second ring template optionally is associated with a circle of a second radius and/or a different quantity of slots virtual that can optionally be used to arrange a different quantity of representations and/or viewpoints of users. In some embodiments, the spatial arrangement includes a distance and/or facing direction of the representation of the second user relative to the viewpoint of the first user and/or relative to any additional users in the multi-communication session. For example, the first virtual location for the second user is optionally a first virtual distance from the first virtual location associated with the viewpoint of the first user, and/or the representation of the second user is optionally facing the viewpoint of the first user such that the representation of the second user appears to be facing the first user (e.g., as displayed via the display generation component of the first computer system). Optionally, the representation of the second user is not facing the representation of the first user but is instead facing the same virtual location (e.g., a focal point and/or center of the template) as the viewpoint of the first user. Optionally, the computer system associates (e.g., assigns) the first virtual location associated with the viewpoint of the user with a first physical location of the first user in a physical environment of the user (e.g., a physical location of the user when the representation of the second user is initially displayed). For example, at the time when the computer system initiates display of the representation of the first participant at the first virtual location for the second user and selects and/or changes the first virtual location associated with the viewpoint of the first user according to the first spatial arrangement, the computer system optionally associates the first virtual location associated with the viewpoint of the first user with the current physical location of the first user such that when the first user changes physical locations (e.g., by walking to another physical location) the viewpoint of the first user changes from the first virtual location associated with the viewpoint of the first user to a different virtual location based on the change in physical location. Providing feedback in response to changing of a spatial arrangement of participants of the communication session reduces user input, and thereby power consumption required to obtain information about updated positions and/or orientations of the participants.

In some embodiments, while the user is participating in the communication session, in response to obtaining the information and in accordance with the determination that the one or more first criteria are satisfied and prior to presenting the first feedback, the computer system presents first audio that is non-localized to the first position associated with the first participant, wherein the first audio is different from the first feedback, such as audio similar or the same as indicated by icon 1564 as shown in FIG. 15J. For example, the non-localization of the first audio optionally is similar or the same as described with reference to generating audio that is not modified to be perceived as emanating from a spatial position within the three-dimensional environment. In some embodiments, the computer system generates the first audio (e.g., tones, words, and/or chords) indicating that representations of participants will begin to be included in the three-dimensional environment. For example, the computer system optionally obtains an indication that spatial representations of participants of the communication session that are not present in the three-dimensional environment before the indication is obtained will begin to be included in the three-dimensional environment. In response to obtaining the indication, the computer system optionally presents the first audio, and optionally thereafter presents feedback (e.g., the first feedback) such as spatialized audio corresponding to the locations corresponding to the participants of the communication session. Generating first audio provides a proactive notice that representations of participants will be displayed in the three-dimensional environment, thus reducing the likelihood that the representation of participants will obscure representations of the user's three-dimensional environment.

In some embodiments, while a representation corresponding to the first participant is included in the three-dimensional environment, such as representation 1530 as shown in FIG. 15J, the computer system obtains second information, different from the information, including a request to cease inclusion of representations of participants in the communication session, such as a request to inclusion of the representations shown in FIG. 15J. For example, the representation optionally is a spatial avatar corresponding to the first participant. In some embodiments, the request to cease inclusion of representation of the participants includes ceasing display of spatial representations, initiating display of non-spatial representations, and/or exiting of the user from the communication session.

In some embodiments, in response to obtaining the second information, the computer system presents second audio, different from the first audio, that is non-localized to respective one or more positions associated with respective participants, including the first participant, such as audio similar or the same as indicated by icon 1568 as shown in FIG. 15M. For example, the computer system optionally generates non-localized audio indicating that the computer system will cease display of representation of the visual representation of the participants, cease spatial representations of such participants that are included in the three-dimensional environment, and/or that the user of the computer system will exit the communication session. In some embodiments, the second audio includes different tones, chords, arpeggios, and/or words that are different than those included in the first, non-localized audio. In some embodiments, the second audio is additionally or alternatively different from the audio presented by the computer system when a particular representation of a participant—and not all representations of participants-ceases to be included in the communication session and/or three-dimensional environment. Generating audio provides a proactive notice that representations of participants will no longer be included in the three-dimensional environment, thus reducing the likelihood that the representation of participants will not be displayed and reducing erroneous user inputs directed to where the representation of participants were displayed.

It should be understood that the particular order in which the operations in method 1600 have been described is merely exemplary and is not intended to indicate that the described order is the only order in which the operations could be performed. One of ordinary skill in the art would recognize various ways to reorder the operations described herein.

FIGS. 17A-17I illustrate examples of a computer system facilitating visual transitions of spatial representations of participants in a video communication session in accordance with some embodiments.

FIG. 17A illustrates a computer system 101 (e.g., an electronic device) displaying, via a display generation component (e.g., display generation component 120 of FIGS. 1 and 3), a three-dimensional environment 1702 from a viewpoint of a user 1708 (e.g., facing the back wall of the physical environment in which computer system 101 is located, as shown in the overhead/top-down view of the three-dimensional environment 1702).

In some embodiments, computer system 101 includes a display generation component 120. In FIG. 17A, the display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to the FIGS. 7, 10, 13, and 15 series.

As shown in FIG. 17A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1702 or the physical environment is visible via display generation component 120.

As discussed in more detail below, in FIG. 17A, display generation component 120 is illustrated as displaying content in the three-dimensional environment 1702. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 17A-17I.

Display generation component 120 has a field of view (e.g., a field of view captured by external image sensors 314b and 314c and/or visible to the user via display generation component 120) that corresponds to the content shown in FIG. 17A. Because display generation component 120 is optionally a head-mounted device, the field of view of display generation component 120 is optionally the same as or similar to the field of view of the user.

As mentioned above, the computer system 101 is configured to display content in the three-dimensional environment 1702 using the display generation component 120. For instance, computer system 101 is configured to execute a video communications application that allows for the user 1708 to communicate (via a video communication session) with one or more participants that are each using their own external computer systems to communicate with user 1708. As illustrated in FIG. 17A, and as part of the video communication session, computer system 101 displays a representation of each participant within three-dimensional environment 1702. In the example of FIG. 17A, user 1708 is engaged in a video communication session with two participants. As part of the video communication session, computer system 101 displays representation 1704a that is configured to represent the first participant within the three-dimensional environment 1702, and representation 1706a that is configured to represent the second participant within the three-dimensional environment 1702 (represented in the top-down view as 1704b and 1706b respectively). Representation 1704a is a placeholder representation that the computer system 101 displays in instances where there is no video data associated with a participant such as when the participant has their camera switched off or otherwise is not transmitting video data. In some embodiments, the placeholder representation includes a shape (such as a circle, square, triangle) and identifying information associated with the participant that the placeholder representation is meant to represent. For instance, as illustrated in FIG. 17A, representation 1704a (e.g., the placeholder representation) includes a circle that is inscribed with the initials “JD” of the participant named Jane Doe. Additionally, representation 1704a includes a name plate that has Jane Doe's full name inscribed on it. In some embodiments, representation 1704a is a three-dimensional representation. Optionally, representation 1704a can also be a two-dimensional representation that is displayed within three-dimensional environment 1702 by computer system 101.

In some embodiments, the second participant of the video communication, is represented using a three-dimensional representation that is rendered by computer system 101 based on video and/or camera data associated with the second participant as illustrated in FIG. 17A. In some embodiments, the second participant associated with representation 1706a uses their own computer system that is substantially similar to computer system 101 used by user 1708 and exchanges video and audio data with computer system 101, when the second participant and user 1708 are engaged in a video communication session. In some embodiments, the computer system of the second participant records video data associated with the second participant using one or more cameras that are part of the computer system. In some embodiments, the cameras are configured to capture the face of the participant as well as detect the movement of the second participant. In some embodiments, the computer system of the second participant that is associated with representation 1706a transmits video data that is based on the images captured by the cameras to computer system 101. Using the video data received from the computer system associated with the second participant, computer system 101 renders representation 1706a using a anthropomorphic shape (e.g., human) shaped representation (e.g., an avatar) that includes various features that are collectively configured to cause the representation to bear a resemblance to the real-world appearance of the second participant. For instance, representation 1706a can include facial features that resemble the second participant as well as a skin tone that is similar to the skin tone of the second participant.

In some embodiments, computer system 101 displays representations 1704a and 1706a according to one or more visual models. In some embodiments, a visual model refers to a set of visual characteristics that are collectively configured to indicate whether the representation is fully rendered or if the representation is still in the process of being rendered by the computer system. In the example of FIG. 17A, both representations 1704a and 1706a are displayed according to a “high-fidelity” visual model. With respect to representation 1706a, being displayed according the high-fidelity visual model means that the representation 1706a includes the facial features and skin tone associated with the second participant (that is based on video data associated with the second participant), and that the representation is displayed without noise (described in detail below) and using colors that are associated with the second participant. With respect to representation 1704a (e.g., the placeholder representation associated with the first participant), being displayed according to the high-fidelity visual model also means that representation 1704a is displayed without noise and is displayed according to the colors associated with the placeholder representation.

In some embodiments, the computer system 101 receives an indication to change the representation associated with the first participant. For instance, the first participant can activate one or more cameras on their computer system or otherwise indicate that they wish to represented using a representation that is similar to representation 1706a associated with the second participant (e.g., an avatar representation). In some embodiments, and in response to receiving the indication to change representation associated with the first participant, computer system 101 initiates a process that visually fades out representation 1704a and fades in a new representation that is based on video associated with the first participant as illustrated in FIG. 17B. As described below, the process of visually fading out the placeholder representation and visually fading in the anthropomorphic representation (e.g., an human-like avatar) is configured to provide the user 1708 of computer system 101 with a visual indication as to the status of displayed representation such that the user is able to visually ascertain when a displayed representation is fully based on the appearance of the participant that the representation is meant to represent or is otherwise in a transitory state wherein only some portions are representative of the participant's appearance.

As illustrated in FIG. 17B, in order to visually fade out placeholder representation 1704a, computer system 101 displays one or more portions of representation 1704a according to a “low-fidelity” visual model that is different from the high-fidelity visual model described above. In some embodiments, and as described in further detail below, the low-fidelity visual model includes the same visual characteristics as the high-fidelity visual model but the magnitude or values associated with those common visual characteristics are set to different levels (described in further detail below). In some embodiments, the process of visually fading out representation 1704a includes displaying one or more portions of representation 1704a according to the low-fidelity visual model while other portions of representation 1704a continue to be displayed according to the high-fidelity visual model and gradually transitioning more and more portions of the representation from being displayed according to the high-fidelity model to being displayed according to the low-fidelity until the entirety of the representation is displayed according to the low-fidelity model.

In some embodiments, the order in which the one or more portions of a displayed representation are transitioned from being displayed according to the high-fidelity visual model to being displayed according to the low-fidelity visual is based a portion's proximity to a center region of the displayed representation. For instance, as illustrated in FIG. 17B, a center portion 1710 of representation 1704a is displayed according to the high-fidelity visual model, while one or more peripheral portions 1712 are displayed according to the low-fidelity visual model. In some embodiments, as a result of being displayed according to the low-fidelity visual model, the one or more peripheral portions 1712 are displayed with some or all of the pixels of the peripheral portion being rendered with a random or pseudo-random colored pixel (such as pixel 1714) thereby giving the overall portions of the representation that are displayed according to the low-fidelity visual model a “noisy” appearance. In some embodiments, transitioning a particular portion of a displayed representation from being displayed according to the high-fidelity visual model to being displayed according the low-fidelity visual model includes gradually increasing the density of pixels displayed with noisy pixels until the density meets a pre-determined threshold that is associated with the low-fidelity visual model.

In some embodiments, in accordance with being displayed according to the low-fidelity visual model, the one or more peripheral portions 1712 are displayed with some or all of the pixels of the peripheral portion being rendered with one or more colors that are selected from a pre-determined color palette. Optionally, the pre-determined color palette includes colors that are not associated with a representation that is displayed according to the high-fidelity visual model. For instance, the one or more colors of the pre-determined color palette do not include skin tones (in contrast to the high-fidelity visual model which includes skin tones) thereby minimizing the likelihood that the user 1708 of computer system 101 will confuse the low-fidelity visual model for the high-fidelity visual model. In some embodiments, transitioning a particular portion of a displayed representation from being displayed according to the high-fidelity visual model to being displayed according the low-fidelity visual model includes gradually increasing the density of pixels displayed with pixels selected from the pre-determined color palette until the density meets a pre-determined threshold that is associated with the low-fidelity visual model.

In some embodiments, the order in which portions of the displayed representation are transitioned from being displayed according to the high-fidelity visual model to the low-fidelity visual model can be based on each portion's proximity to the center of the representation. For instance, the transition begins with the portions of the representation 1706a that are furthest from the center of the representation (such as peripheral portions 1712) and ends with the center portion 1710 finally being transitioned from the high-fidelity visual model to the low-fidelity visual model thus making the entirety of the representation 1704a displayed according to the low-fidelity visual model as illustrated in FIG. 17C. In some embodiments, by starting the transition from the portions of the representation that are furthest from the center and progressively transitioning portions from the periphery towards the center, the overall representation appears as though it is transitioning from the outside in. In some embodiments, the name plate 1718 (e.g., a rectangle that includes the full name of the participant) is considered a part of the overall representation 1704a and thus is transitioned from being displayed according to the high-fidelity visual model to the low-fidelity visual model based on its proximity to center portion 1710. Optionally, however, name plate 1718 can be treated as a separate representation, and thus can be transitioned from the high-fidelity visual model to the low-fidelity visual model independently and in accordance with the examples described above.

In some embodiments, and as illustrated in FIG. 17C, the transition from being displayed according high-fidelity visual model to the low-fidelity visual model concludes when all portions of the representation 1704a are displayed according to the low-fidelity visual model, thus meaning that a density of the noisy pixels (such as pixel 1714) in the representation 1704a are at a pre-determined level and the density of pixels displayed according the pre-determined color palette are also at a pre-determined level. In some embodiments, once the entirety of representation 1704a is displayed according to the low-fidelity visual model, computer system 101 ceases display of the placeholder representation 1704a and replaces the placeholder representation with an anthropomorphic representation 1720a as illustrated in FIG. 17D.

In the example of FIG. 17D, and as part of the process of transitioning out placeholder representation 1704a and replacing it with an avatar-like representation (described above), once the placeholder representation 1704a is fully transitioned to being displayed according to the low-fidelity visual model, computer system 101 displays representation 1720a (represented in the top-down view as 1720b and in the side view as 1720c respectively) according to the low-fidelity visual model. In some embodiments, computer system 101 displays representation 1720a using an anthropomorphic (e.g., human-like) shape. In some embodiments the size and shape of representation 1720a is based on one or more spatial characteristics of the participant associated with representation 1720a. For instance, the size and shape of the participant is determined using one or more cameras associated with the computer system of the participant, and that data is then processed and/or transmitted to computer system 101, which uses the data to render representation 1720a in a shape and size that is in accordance with the received spatial data of the participant associated with representation 1720a.

In some embodiments, and as described above, when computer system 101 initially displays representation 1720a within three-dimensional environment 1702, it does so according to the low-fidelity visual model described above. Initially, and as illustrated in FIG. 17D, all portions of representation 1720a are displayed according to the low-fidelity visual model. Thus, representation 1720a is displayed with some noise pixels according to the pre-determined density associated with the low-fidelity visual model, while some pixels are displayed according to pre-determined color palette at the pre-determined density associated with the low-fidelity visual model. As illustrated in the side view of the spatial representation 1720c, the back portion of the spatial representation (e.g., the side facing away from the user) is also displayed according to the low-fidelity visual mode. In some embodiments, once representation 1720a is displayed by computer system 101 within the three-dimensional environment 1702 according to the low-fidelity visual model, computer system 101 begins a transition process that gradually transitions representation 1720a from being displayed according to the low-fidelity visual model to being displayed according to the high-fidelity visual model as illustrated in FIG. 17E.

In the example of FIG. 17E, a center portion 1722a (represented in the top-down view as 1722b, and in the side view as 1722c) is initially transitioned from the low-fidelity visual model to the high-fidelity visual model while other portions (e.g., peripheral portions) are displayed according to the low-fidelity visual model (including the back portion of the spatial representation 1720c illustrated in the side view). In some embodiments, displaying center portion 1722a according to the high-fidelity visual model includes displaying facial features of the participant associated with representation 1720a, wherein the facial features are displayed by computer system 101 based on camera/video data recorded by the computer system associated with the participant. Additionally or alternatively, center portion 1722a when being displayed according to the high-fidelity visual model is colored according to a skin-tone associated with the participant associated with representation 1720a. In some embodiments, the skin-tone is based on the received camera/video data described above. In some embodiments, center portion 1722a is gradually transitioned from being displayed according to the low-fidelity visual model to being displayed according to the high-fidelity visual model (rather than being abruptly transitioned). Thus, in some embodiments, the noise pixel density described above is decreased until it is set at a pre-determined level associated with the high-fidelity visual model (e.g., at substantially zero). Similarly, in some examples, the density of colored pixels in center portion 1722a (colored according to the pre-determined color palette described above) is decreased until it is set at a pre-determined level associated with the high-fidelity visual model (e.g., at substantially zero).

In contrast to the examples of FIGS. 17A-C, where the transition from the high-fidelity visual model to the low-fidelity began at the periphery of a representation and gradually moved towards the center of the representation, in some embodiments, the transition from displaying a representation according to the low-fidelity visual model to the high-fidelity visual model begins at the center portion of the representation and gradually moves towards the periphery of the representation as illustrated in FIG. 17F. In the example of FIG. 17F, the size of the center portion 1722a has increased in size (since one or portions that were peripheral to the original center portion of FIG. 17E have now transitioned to the second visual model, thus increasing the size of the center portion that is displayed according to the second visual model). In some embodiments, one or more portions on the peripheral portions of representation 1720a, while not having been fully transitioned from being displayed according to low-fidelity model to being displayed according the high-fidelity, are within the transition process meaning that their one or more visual characteristics (such as noise and color) have been modified from their original values associated with the low-fidelity visual model to an intermediate value that is between the low-fidelity visual model and the high-fidelity visual model. For instance a density of noisy pixels (described above) can be lower than if portion 1722a were fully displayed according to the low-fidelity visual model, but still is higher compared to the density associated with the high-fidelity visual model. In some embodiments, while the center portion 1722a grows in size as more portions of representation 1720a are fully transitioned from being displayed according to low-fidelity visual model to being displayed according to the high-fidelity visual model, as shown in the side view, the back portion 1724 of spatial representation 1720c remains static (e.g., remains being displayed according to the low-fidelity visual model, while the center portion 1722c continues to expand as more portions are fully transitioned to the second visual model). In some embodiments, the transition from being displayed according to the low-fidelity visual model to being displayed according to the high-fidelity visual model can begin at the top of spatial representation 1720a and move down the front of the representation (in contrast to growing out from the center).

In some embodiments, whether the displayed representation 1720a is fully displayed according to the low-fidelity visual model, fully displayed according to the high-fidelity visual model, or in the process of transitioning between the low-fidelity and high-fidelity visual model, spatial representation moves in accordance with detected movement of the participant associated with representation 1720a as illustrated in FIG. 17G. In some embodiments, the external computer system associated with the participant associated with representation 1720a detects movement of one or more portions of the participant's body via a camera that is communicatively coupled to or a part of the computer system of the first participant. For instance, in the example of FIG. 17G, the computer system of the participant associated with representation 1720a records motion of the hand of the participant (e.g., the hand raises). In some embodiments, the computer system of the participant detects the motion of the hand and transmits an indication that the hand has moved (along with information associated with the movement of the hand such as distance and speed information). In response to receiving the indication that the hand has moved (including speed and distance information), computer system 101 displays spatial representation 1720a moving in accordance with the received indication and information. Thus, as illustrated in FIG. 17G, computer system modifies representation 1720a such that a portion 1726 corresponding to the hand of the anthropomorphic representation moves in accordance with the motion of the first participant. Additionally or alternatively, the computer system associated with the participant transmits its video/camera data to computer system 101, and the computer system processes the received video to determine if there is any motion of the first participant and moves hand portion 1726 accordingly.

In some embodiments, once substantially all of a front portion of representation has transitioned from being displayed according to the low-fidelity visual model to being displayed according to the high-fidelity visual model, computer system 101 begins transitioning one or more back portions from the low-fidelity visual model to the high-fidelity visual model based on the back portions' proximity to the front portion as illustrated in FIG. 17H. In the example of FIG. 17H, center portion 1722a, as part of the gradual transition from the low-fidelity visual model to the high-fidelity visual model has grown to now include substantially all of the front side of representation 1720a. In some embodiments, once the front portion has substantially fully transitioned to being displayed according to the high-fidelity visual model, computer system 101 begins to transition one or more back portions 1724 from being displayed according to the low-fidelity visual model to being displayed according to the high-fidelity visual model, beginning with the portions that are in closest proximity to the front portion (e.g., center portion 1722c) and gradually moving further back. Thus, in some embodiments, representation 1720a appears to user 1708 as it if it is being transition from the center out (as described above) and from the front to the back, until all of representation 1720a is displayed according to the high-fidelity visual model as illustrated in FIG. 17I.

In some embodiments, and as illustrated in FIG. 17I, the entirety of representation 1720a (including back portion 1724) have been fully transitioned from being displayed according to the low-fidelity visual model, to being displayed according to the high-fidelity visual model, thereby signaling the termination of the process to gradually transitions in (e.g., fade in) representation 1720a.

FIG. 18 is a flowchart illustrating an exemplary method of displaying visual transitions of spatial representations of a participant of a communication session in accordance with some embodiments. In some embodiments, the method 1800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

In some embodiments, method 1800 is performed at a computer system in communication with one or more input devices and a display generation component. For example, the computer system, the one or more input devices, and/or the display generation component have one or more characteristics of the computer system(s), the one or more input devices, and/or the display generation component(s) described with reference to methods 800, 900, 1100, 1200, 1400, and 1600.

In some embodiments, while a user of the computer system is participating in a communication session with one or more participants, (for example a video communication session in which the computer system displays one or more visual representations of the one or more participants, while emitting audio associated with the one or more participants; in some embodiments, the communication session and/or the one or more participants have one or more of the characteristics of the communication sessions and/or one or more participants described with reference to methods 800, 900, 1100, 1200, and 1400) and while a three-dimensional environment is visible via the display generation component (in some embodiments, the three-dimensional environment displayed by or visible via the computer system has one or more characteristics of the three-dimensional environment described with reference to methods 800, 900, 1100, 1200, and 1400), the computer system receives (1802a) an indication to display a first spatial representation of a first participant of the or more participants within the three-dimensional environment, such as the indication received to display representation 1720a in FIG. 17D. In some embodiments, a spatial representation refers to a three dimensional avatar that is displayed within a three dimensional environment and is meant to provide the user of the computer system with a visual representation of the participant that they are communicating with in the communication session. In some embodiments, the spatial representation takes the form of an object such as a spatial coin (described in further detail below). In some embodiments, the indication to display the first spatial representation can be transmitted by an external computer system that is associated with the first participant and is received by the computer system. For instance, if the first participant activates a camera on their computer system, the computer system of the first participant transmits an indication to the computer system (in the form of image data from the camera, or any type of electronic communication). The computer system in response to receiving the indication displays a spatial representation of the first participant in the three-dimensional environment. In some embodiments, the spatial representation has one or more characteristics of the virtual objects described with reference to methods 800, 900, 1100, and 1200.

In some embodiments, in response to receiving the indication to display the first spatial representation of the first participant in the three-dimensional environment, the computer system displays (1802b), via the display generation component, the first spatial representation of the first participant according to a first transition sequence within the three-dimensional environment, wherein the first transition sequence comprises displaying (1802c) the first spatial representation of the first participant within the three-dimensional environment according to a first visual model that defines one or more visual characteristics of the first spatial representation according to a first set of values when displayed according to the first visual model such as the display of representation 1720a in FIG. 17D.

In some embodiments the first transition sequence comprises gradually transitioning (1802d) the displayed first spatial representation of the first participant from being displayed according to the first visual model to being displayed according to a second visual model that defines the one or more visual characteristics of the first spatial representation according to a second set of values when displayed according to the second visual model, wherein the first set of values of the one or more visual characteristics are different from the second set of values of the one or more visual characteristics. An example transition from the first visual model to the second model is illustrated by the transition of representation 1720a illustrated in FIGS. 17D-I. In some embodiments, when the computer system introduces a spatial representation into the displayed three-dimensional environment, it does so according to a transition sequence that is configured to visually fade-in the spatial representation rather than abruptly display the spatial representation in the three-dimensional environment. In some embodiments, and as described in further detail below, the transition sequence includes displaying the spatial representation according to a low-fidelity visual model (e.g., first visual model) that is configured to be in the shape of the spatial representation but does not include one or more of the visual details associated with the first participant. For instance, the first visual model causes the spatial representation to appear multi-colored and noisy. In some embodiments the transition sequence is configured to transition the spatial representation from the multi-colored and noisy appearance (in accordance with the first visual model) to an appearance that reflects an appearance of the first participant (for instance to include facial features, skin tone, and other real-world features of the first participant). In some embodiments, the transition sequence begins with displaying the spatial representation according the first visual model, and then displays an increasing number of portions of the spatial representation according to the second visual model until the entirety of the spatial representation is displayed according to the second visual model (described in further detail below). In some embodiments, the first visual model includes one or more visual characteristics. For instance, the visual characteristics can include (but are not limited to): the color of the spatial representation, a noise level associated with spatial representation (described in further detail below), the source from which the appearance of the spatial representation is based on, and other visual characteristics that can be used to convey that the state of the spatial representation. In some embodiments, the first visual model includes setting each of the visual characteristics to a particular value (e.g., the first set of values). The term “value,” as used throughout the present disclosure, is not limited to numerical values or discrete values and instead more broadly refers to the state of any particular visual characteristic. For instance, the “value” of a particular visual characteristic can refer to particular pixels that are displayed at a specific portion of the spatial representation, the color of a specific portion or portions of the spatial representation, the source images that are used to render the visual appearance of the spatial representation, etc. In some embodiments, the transition sequence entails modifying the values of the one or more visual characteristics gradually from the values associated with the first visual model (e.g., the first set of values), until the values are in accordance with the second visual model (e.g., the second set of values). In some embodiments, the computer system modifies the values of the one or more visual characteristics from the first set of values associated with the first visual model, to the second set of values associated with the second visual model gradually (e.g., by changing the values over a period of time). In some embodiments, at least some of the values are abruptly changed from the value associated with the first visual model to the value associated with the second visual model. In some embodiments, the size and/or shape of the spatial representation is constant between the first visual model and the second model. Additionally or alternatively, the size and/or shape of the spatial representation changes as the spatial representation is transitioned from being displayed according to the first visual model to being displayed according to the second visual model. Gradually transitioning in the display of a spatial representation associated with a participant of a communication session minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, gradually transitioning the displayed first spatial representation of the first participant from being displayed according to the first visual model to being displayed according to a second visual model comprises ceasing to display a first portion of the first spatial representation according to the first visual model such as center portion 1722a in FIG. 17E. In some embodiments, gradually transitioning the displayed first spatial representation of the first participant from being displayed according to the first visual model to being displayed according to a second visual model comprises displaying the first portion of the first spatial representation according to the second visual model, while one or more portions other than the first portion of the first spatial representation are not displayed according to the second visual model such as representation 1720a in FIG. 17E. In some embodiments, the transition from displaying the spatial representation according to the first visual model to displaying the spatial representation according to the second visual model begins at a specific portion/region of the spatial representation (e.g., the first portion). For example, and as discussed in further detail below, the first portion could be the portion of the spatial representation corresponding to the face of an avatar. Additionally or alternatively, the first portion can be located at the bottom of the spatial representation, the top of the spatial representation, or at the center of a front side of the spatial representation.

In some embodiments, gradually transitioning the displayed first spatial representation of the first participant from being displayed according to the first visual model to being displayed according to a second visual model comprises gradually transitioning the one or more portions other than the first portion of the first spatial representation to being displayed according the second visual model, wherein an order in which the one or more portions are gradually transitioned to being displayed according to the second visual model is based on a location of each portion of the one or more portions other than the first portion as demonstrated by the transition of representation 1720a in FIGS. 17E-F. In some embodiments, the transition from displaying the spatial representation according to the first visual model to displaying the spatial representation according to the second visual model begins at a specific portion/region of the spatial representation (e.g., the first portion) as described above, and progresses to other portions of the spatial representation based on the location of the other portions. For instance, the order in which the other portions of the spatial representation are transitioned from the first visual model to the second visual model are based on the portion's proximity to the first portion.

Thus, and as an example, after the first portion has transitioned from the first visual model to the second visual model, the portions of the spatial representation that are closest to the first portion transition from the first visual model to the second model, while all other portions continue to be displayed according to the first visual model. Once the portions closest to the first portion have transitioned from the first visual model to the second visual model (or even while the portions closest to the first portion are in the process of transitioning) the remaining portions that have not been transitioned and are closest to the first portion begin the transition, and so on and so forth until the entirety of the spatial representation is displayed according to the second visual model. In some embodiments, the overall effect of transitioning the portions of the spatial representation as described above is to give an overall appearance that the displayed spatial representation starts being displayed according to the second visual model at a specific point (e.g., the first portion) on the spatial representation, and the region of the spatial representation that is displayed according to the second visual model continues to grow outward from the first portion until the entire spatial representation is displayed according to the second visual model. Starting a transition in the display of a spatial representation associated with a participant of a communication session from a specific portion, and transitioning other portions of the spatial representation based on their location minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, the first visual model is a low fidelity visual model (such as the visual model used to display representation 1720a in FIG. 17D), and the second visual model is a high fidelity visual model (such as the visual model used to display representation 1720a in FIG. 17I). In some embodiments, the low fidelity visual model (e.g., the first visual model) is configured to allow for the computer system to convey to the user that the displayed spatial representation is incomplete (perhaps due to image information pertaining to the first participant still being loaded onto the computer system). For instance, when the computer system displays the first spatial representation using the low fidelity visual model, the spatial representation appears noisy (e.g., some or all of the pixels that make up the spatial representation are randomly distributed so as to give an overall image of static or white noise), includes non-realistic colors (e.g., colors not associated with human skin), and can have streaks of color displayed in various random or pre-determined locations on the spatial representation. In some embodiments, the streaks of color that are part of the low fidelity visual model are selected from a pre-determined color palette that is stored by the computer system. In some embodiments, other visual characteristics associated with displaying the spatial representation according to the low-fidelity visual model include but are not limited to: displaying the spatial representation at a lower resolution, displaying the spatial representation at a pre-determined level of color saturation level, displaying the spatial representation at a pre-determined translucency level, and displaying the spatial representation at a pre-determined blurriness level. In some embodiments, the high fidelity visual model is configured to display the spatial representation in its final form. For instance, the noise and streaks of color described above with respect to the low fidelity visual model are not present (e.g., reduced to 0) in the high fidelity visual model. In some embodiments, other visual characteristics associated with displaying the spatial representation according to the high-fidelity visual model include but are not limited to: displaying the spatial representation at a higher resolution (as compared to the low-fidelity visual model), displaying the spatial representation at a pre-determined level of color saturation level, displaying the spatial representation at a pre-determined translucency level (e.g., less translucent than the low-fidelity visual model), and displaying the spatial representation at a pre-determined blurriness level (lower than the level associated with the low-fidelity visual model. In some embodiments, the high-fidelity visual model includes at least some portions that are configured to mimic the appearance of the participant that the spatial representation is meant to represent. For instance, the computer system displays image data associated with the real-world appearance of the first participant at a facial region of the spatial representation (e.g., the portion of the spatial representation that is in the location where a human face would be location). In some embodiments, other portions of the spatial representation that would be associated with a skin tone (e.g., the hands of the spatial representation) are displayed using a skin tone associated with the first participant, when the spatial representation is displayed according to the high fidelity visual model. Gradually transitioning in the display of a spatial representation associated with a participant of a communication session from a low fidelity visual model to a high fidelity visual model minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, the first spatial representation of the first participant includes a facial region (such as center portion 1722a in FIG. 17E), the one or more visual characteristics includes a visual appearance of the facial region, the visual appearance of the facial region of the second visual model is based on an image of a face associated with the first participant, and the visual appearance of the facial region of the first visual model is not based on an image of a face associated with the first participant. In some embodiments, the computer system uses image data associated with the first participant to generate the second visual model such that when the spatial representation is displayed by the computer system according to the second visual model, a facial region of the spatial representation mimics the real-world visual appearance of the first participant. The facial region includes a portion of the spatial representation that corresponds to the face of the first participant. In some embodiments, some or all of image data of the first participant is collected at some time prior to the display of the spatial representation in the three-dimensional environment. Additionally or alternatively, some or all of the image data is collected in real time by an external computer system associated the first participant, and transmitted to computer system of the user to be used by the computer system to create the second visual model. For instance, one or more cameras associated with the external computer system associated with the first participant captures real-time facial expressions of the first participant, transmits the image data to the computer system, which then uses the image data to render the facial region portion of the spatial representation. In some embodiments, the visual appearance of the facial region is not based on an image of the face associated with the first participant. Additionally or alternatively, when the spatial representation is displayed according to the first visual model, the facial region has one or more facial features of the avatar (e.g., spatial representation). Additionally or alternatively, when the spatial representation is displayed according to the first visual model, the facial region has less than the one or more facial features, or no facial features, of the avatar displayed. Displaying the facial region of a spatial region based on image data associated with the participant of the communication session that is associated with the spatial representation minimizes the likelihood of the user erroneously identifying which participant of the communication session is associated with the spatial representation, thus minimizing the occurrence of erroneous user input and thereby conserving computing resources associated with correcting erroneous input.

In some embodiments, the one or more visual characteristics includes a first color associated with one or more portions of the first spatial representation, wherein the first color of the second visual model is a skin tone color associated with the first participant (as described above with respect to representation 1720a and FIG. 17E), and wherein the first color of the low fidelity visual model is a color that is not based on the skin tone color associated with the first participant (such as described above with respect to representation 1720a and FIG. 17D). In some embodiments, the computer system when displaying the spatial representation according the second visual model (e.g., the high fidelity visual model) displays portions of the spatial representation that are associated with the first participant's skin (for instance portions of the spatial representation associated with the face, head, and hands of first participant) according to the skin tone associated with the first participant. In some embodiments, the skin tone of the first participant is included in the image data of the first participant described above. Additionally or alternatively, the skin tone is pre-selected by the first participant or the user of the computer system and is selected from one or more pre-defined skin tones (and may not be based on the actual real-world skin tone of the first participant). In some embodiments, when the computer system displays the spatial representation according to the second visual model, one or portions of the displayed spatial representation that are not associated with first participant's skin are displayed according to a non-skin tone. For instance, portions of the spatial representation associated with the clothing of the first participant are displayed using a non-skin tone color that is selected based on the image data associated with the first participant or that is pre-selected by the first participant and/or the user of the computer system. In some embodiments, when the computer system displays the spatial representation according to the first visual model, none of the portions of the displayed spatial representation are displayed using a skin tone that is associated with the first participant so as to convey to the user of the computer system that the spatial representation is not yet associated with the real world visual appearance of the first participant. For instance, and as described above, when the spatial representation is displayed according the first visual model, some or all portions of the spatial representation are displayed using colors that represent noise and/or displayed using a pre-selected color palette that is not associated with the first participant. Displaying portions of the spatial representation associated with the first participant's skin using a skin tone associated with the first participant minimizes the likelihood of the user erroneously identifying which participant of the communication session is associated with the spatial representation, thus minimizing the occurrence of erroneous user input and thereby conserving computing resources associated with correcting erroneous input.

In some embodiments, the first spatial representation includes a size and a shape, and wherein the size and shape of the first spatial representation are based on one or more spatial characteristics associated with the first participant such as the shape of representation 1720a described above with respect to FIG. 17D. In some embodiments, the size and shape of the spatial representation (whether being displayed according to the first visual model and/or the second visual model) is based on the spatial characteristics (e.g., the size and shape) of the first participant. For instance, the height of the spatial representation is based on the height of the first participant. Additionally or alternatively, the size of the spatial representation (e.g., the width and dimensions of the spatial representation) is based on the size of the first participant. In some embodiments, the spatial characteristics of the first participant are determined using image data associated with the first participant (e.g., recorded from a camera that records images of the first participant). Additionally or alternatively, the size and shape of the first participant are pre-selected either by the first participant (which is then transmitted to the computer system) or is pre-selected by the user of the computer system using the one or more input devices of the computer system. In some embodiments, the size and shape of the representation is based on a pre-determined size and shape associated with the type of representation being displayed. For instance, if the displayed representation is an anthropomorphic representation (e.g., an avatar), then the size of the shape of the displayed representation will be based on one or more pre-defined shapes and sizes associated with an avatar. In some embodiments, the size and shape of the spatial representation is the same when the representation is displayed according to either the first or second visual model. Alternatively, the size and shape of the spatial representation can be different when the spatial representation is displayed according to the first visual model versus when it is displayed according to the second visual model. Displaying the spatial representation according to a size and shape associated with the first participant minimizes the likelihood of the user erroneously identifying which participant of the communication session is associated with the spatial representation, thus minimizing the occurrence of erroneous user input and thereby conserving computing resources associated with correcting erroneous input.

In some embodiments, while displaying the first spatial representation of the first participant within the three-dimensional environment according to the first visual model or the second visual model, the computer system receives an indication that one or more portions of the body of the first participant have moved. In some embodiments, in response to receiving the indication that the one or more portions of the body of the first participant have moved, the computer system modifies display of the displayed first spatial representation of the first participant in accordance with the received indication that one or more portions of the body of the first participant have moved independent of whether the first spatial representation of the first participant is displayed according to the first visual model or the second visual model such as the movement of portion 1726 in FIG. 17G. In some embodiments, once the computer system displays the spatial representation within the three-dimensional, it will modify the display of the spatial representation to mimic any real-time movements of the first participant regardless of whether the spatial representation is being displayed according to the first visual model, or the second visual model, or at any point within the transition from being displayed from the first visual model to the second visual model. For instance, if the first participants moves their hand while the spatial representation is being displayed by the computer system, the computer system modifies the display of the spatial representation such that the portions of the spatial representation associated with the first participant's hand moves according to the movement of the first participant's hand. In some embodiments, the movements that can be tracked and replicated by the display of the spatial representation include but are not limited to, movement of the participant's head, changes in the facial features of the participant, movement of the participant's torso, movement of the participant's should, or any other portion of the user that moves. In some embodiments, the received indication that one or more portions of the body of the first participant have moved is in the form of real-time image data that is collected by an external computer system associated with the first participant and is transmitted to the computer system. Modifying the displayed spatial representation to mimic real-time movements of the participant associated with the spatial representation minimizes the likelihood of the user erroneously interpreting the physical state of the participant while engaged in the communication session, thus minimizing the occurrence of erroneous user input and thereby conserving computing resources associated with correcting erroneous input.

In some embodiments, the first spatial representation of the first participant comprises a center region, and gradually transitioning the displayed first spatial representation of the first participant from the first visual model to the second visual model comprises: ceasing to display the center region of the first spatial representation according to the first visual model such as center portion 1722a in FIG. 17E.

In some embodiments, after ceasing to display the center region of the first spatial representation according to the first visual model, the computer system displays the center region of the first spatial representation according to the second visual model, while one or more non-center regions of the first spatial representation are not displayed according to the second visual model such as center portion 1722a in FIG. 17E.

In some embodiments, the computer system gradually transitions the one or more non-center regions of the first spatial representation to being displayed according the second visual model as exemplified by the transition of representation 1720a illustrated in FIGS. 17D-F. In some embodiments, the gradual transition from displaying the spatial representation according to the first visual model to displaying the spatial representation according to the second visual model begins at a center region of the first spatial representation. For instance, the center region of the first spatial region is fully transitioned to being displayed according to the second visual model before other portions are fully transitioned. In some embodiments, the center region of the spatial representation refers to the geometric center of the spatial representation. Alternatively, the center region refers to the geometric center of the front side of the spatial representation. In some embodiments, the center region can be the area of the anthropomorphic representation associated with the face (e.g., the facial region). In some embodiments, the center region refers to any portion of the spatial representation where the transition begins as described above. In some embodiments, once the computer system fully transitions the center region from the first visual model to the second visual model, the computer system gradually transitions the remaining portions of the spatial representation in the same manner as the center region (albeit delayed with respect to the center region). In some embodiments, the order in which the non-center regions are transitioned from the first visual model to the second model is based on the proximity between each non-center region and the center region such that the regions closest to the center region are transitioned earlier than the regions that are farther away. In this way, the spatial region appears as if the center region is first to fully transition, and the portions of the spatial representation that are fully transitioned grow out from the center region. Starting a transition in the display of a spatial representation associated with a participant of a communication session from a center region, and transitioning other portions of the spatial representation after transitioning the center region minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, gradually transitioning the displayed first spatial representation of the first participant from being displayed according to the first visual model to being displayed according to the second visual model comprises beginning the transition from a portion of the first spatial representation that is closer to a viewpoint of the user and terminating the transition at a portion of the first spatial representation that is further from the viewpoint of the user such as illustrated by the transition of back portion 1724 or representation 1720a in FIG. 17H. In some embodiments, the gradual transition from displaying the spatial representation according to the first visual model to displaying the spatial representation according to the second visual model begins at the front of the spatial representation with respect to the viewpoint of the user (e.g., the portion of the spatial representation that is closes to the viewpoint of the user). For instance, the portion of the spatial representation that is closes to the viewpoint of the user is fully transitioned to being displayed according to the second visual model before portions of the spatial representation that are farther from the viewpoint of the user are fully transitioned. In some embodiments, once the computer system fully transitions the closest portion from the first visual model to the second visual model, the computer system gradually transitions the remaining portions (e.g., the further portions) of the spatial representation in the same manner as the center region (albeit delayed with respect to the center region). In some embodiments, the order in which the farther portions are transitioned from the first visual model to the second model is based on the proximity between each farther portion and the viewpoint of the user such that the portions closest to the viewpoint of the user are transitioned earlier than the regions that are farther away. In this way, the spatial representation appears as if the closest portions (e.g., the front) of the spatial transition is first to fully transition, and the portions of the spatial representation that are fully transitioned grow out from the closest portions with respect to the viewpoint of the user. In some embodiments, the “front” and “back” of the avatar can correspond to the spatial representation itself rather than the viewpoint of the user. For instance, in the example of an anthropomorphic representation (e.g., an avatar), the front of the spatial representation corresponds to the side of the representation where the face is located, while the back corresponds to the opposite side of the representation. Starting a transition in the display of a spatial representation associated with a participant of a communication session from the portion of the spatial representation that is closest to the viewpoint of the user and transitioning other portions of the spatial representation after transitioning the center region minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, gradually transitioning the displayed first spatial representation of the first participant from being displayed according to the first visual model to being displayed according to the second visual model comprises modifying a blur of at least a portion of the three-dimensional environment that is behind the displayed first spatial representation relative to the viewpoint of the user such as if a portion of the background of representation 1720a became blurrier as the representation transitioned towards being displayed according to the high-fidelity model in FIGS. 17D-I. In some embodiments, when the spatial representation is first displayed in the three-dimensional environment according to the first visual model, the portions of the three-dimensional environment that is behind the displayed spatial representation is displayed with no or minimal blur. As the displayed spatial representation is transitioned from the first visual model to the second visual model the amount of blur of the background (e.g., the portion of the three-dimensional environment that is behind the spatial representation) increases. Alternatively, when the spatial representation is first displayed in the three-dimensional environment according to the first visual model, the portions of the three-dimensional environment that is behind the displayed spatial representation is displayed with a pre-determined amount of blur. As the displayed spatial representation is transitioned from the first visual model to the second visual model the amount of blur of the background (e.g., the portion of the three-dimensional environment that is behind the spatial representation) decreases such that when the computer system displays the spatial representation according to the second model, the portion of the three-dimensional environment that is behind the spatial representation is displayed with minimal or no blur. In some embodiments, the term “blur” refers to clarity at which the portion of the three-dimensional environment behind the spatial representation is displayed by the computer system. Modifying the blur of one or more portions of the three-dimensional environment that is behind the spatial representation as the spatial representation is transitioned from being displayed according to the first visual model to the second visual model minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, the one or more visual characteristics include visual noise, and gradually transitioning the displayed first spatial representation of the first participant from being displayed according to the first visual model to being displayed according to the second visual model comprises gradually reducing a magnitude of the visual noise displayed on the first spatial representation such as reducing the density of noisy pixels 1714 in FIG. 17C. In some embodiments, and as described above, one of the visual characteristics associated with the first and second visual models is an amount (e.g., magnitude) of noise that is displayed as part of displaying the spatial representation within the three-dimensional environment. In some embodiments, the “noise” takes the form of displaying one or more pixels of the spatial representation using a random distribution of colors. In some embodiments, the “noise” is white noise (e.g., the color of the pixels is randomized across a given range). Additionally or alternatively, the noise is colored noise such that the distribution of the color of the pixels are centered around a particular color. In some embodiments, the magnitude of the noise (e.g., the amount of pixels displayed according to the noise color distribution) is the highest when the spatial representation is displayed according to the first visual model, and the magnitude is gradually reduced while the spatial representation is being transitioned from the first visual model to the second visual model. In some embodiments, the magnitude of the noise is minimal and/or non-existent when the spatial representation is displayed according to the second visual model. In some embodiments, the magnitude of the noise is adjusted by modifying one or more of (but not limited to): a density of noisy pixels displayed on the spatial representation, the brightness of the noisy pixels, and/or a size of the noisy pixels. Modifying the magnitude of the displayed noise as the spatial representation is transitioned from being displayed according to the first visual model to the second visual model minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, a shape of the displayed first spatial representation is based on an anthropomorphic representation of the first participant such as the shape of representation 1720a in FIG. 17D. In some embodiments, in order to mimic the real world appearance of the first participant, the spatial representation is displayed using an anthropomorphic shape (e.g., a human shape). In some embodiments, the anthropomorphic shape shares one or more characteristics described above with respect to FIGS. 7A-7E and methods 800, 900, 1100, and 1200. For instance, the spatial representation includes a head and arms, a torso, or any other portion that would be normally associated with the human form. In some embodiments, the spatial representation is displayed using an anthropomorphic shape regardless of whether the spatial representation is being displayed according to the first visual model or the second visual model. Displaying the spatial representation using an anthropomorphic shape minimizes the likelihood of erroneously portraying the spatial representation to the user of the computer system, thus minimizing the occurrence of erroneous user input and thereby conserving computing resources associated with correcting erroneous input.

In some embodiments, a shape of the displayed first spatial representation is based on a placeholder representation of the first participant such as the shape of representation 1704a in FIG. 17A. In some embodiments, the spatial representation takes the form of a placeholder representation that is configured to represent the first participant in the three-dimensional environment when the computer system associated with the first participant is not transmitting image data (e.g., because the camera of the first participant's computer system are not activated) or in the event that the computer system does not have adequate image data to render a spatial representation that is configured to mimic the physical real-world appearance of the first participant. In some embodiments, the place holder representation takes the form of a virtual object such as such as a circle (e.g., a coin), oval, square, diamond, triangle, sphere, cylinder, cube, cone or cuboid. In some embodiments, the virtual object used as a placeholder representation is configured to not be similar to the shape of the non-placeholder spatial representation (e.g., an avatar) such that when displayed by the computer there is a minimal risk that the user of the computer system will mistake the placeholder representation for being the actual spatial representation that is configured to mimic the physical real world appearance of the first participant. In some embodiments, the placeholder representation includes identifying information associated with the first participant including, for example, the name of the first participant. In some embodiments, the placeholder representation is initially displayed by the computer system according to the first visual model and is transitioned to being displayed according to the second visual model in accordance with the examples described above. In some embodiments, the placeholder representation includes one or more characteristics described above with respect to FIGS. 7A-7E and methods 800 and 900. Gradually transitioning in the display of a placeholder spatial representation associated with a participant of a communication session minimizes the likelihood of erroneously portraying the placeholder representation to the user of the computer system, such as before all data associated with displaying the placeholder representation is available, and avoids abrupt changes to the context of interaction of the user with the three-dimensional environment, thus minimizing the occurrence of erroneous user input and thereby conserving computing resources associated with correcting erroneous input.

In some embodiments, the computer system receives an indication to cease display of the first spatial representation of the first participant within the three-dimensional environment. In some embodiment, in response to receiving the indication to cease display of the first spatial representation of the first participant, the computer system initiates a process to cease display of the first spatial representation including displaying a second transition sequence within the three-dimensional environment such as the transition sequence illustrated with respect to representation 1704a in FIGS. 17A-C. In some embodiments, the second transition sequence comprises gradually transitioning the displayed first spatial representation of the first participant from being displayed according to the second visual model to being displayed according to the first visual model. In some embodiments, the process used to display the spatial representation within the three-dimensional environment (e.g., transitioning the displayed spatial representation from the first visual model to the second visual model) is reversed when the computer system receives an indication to cease display of the first spatial representation. In some embodiments, the second transition sequence transitions the spatial representation from being displayed according to the second visual model to being displayed according to the first visual model. Once the spatial representation is fully displayed according to the first visual model, the computer system ceases displaying the spatial representation within the three-dimensional model. In some embodiments, the second transition sequence includes displaying initially displaying peripheral portions of the spatial representation according to the first visual model (while other non-peripheral portions of the spatial representation are displayed according to the second visual model), and continuing to transition portions of the spatial representation in an order that is based on the portion's proximity to the peripheral portions. In this way, the transition from the second visual model to the first visual model appears as if it is beginning on the periphery of the spatial representation and is gradually being transitioned from the periphery to a center of the spatial representation. Gradually transitioning out the display of a spatial representation associated with a participant of a communication session minimizes the likelihood of erroneously portraying the spatial representation to the user of the computer system, such as in an instance where the computer system no longer has sufficient data associated with displaying the spatial representation, and avoids abrupt changes to the context of interaction of the user with the three-dimensional environment, thus minimizing the occurrence of erroneous user input and thereby conserving computing resources associated with correcting erroneous input.

In some embodiments, the received indication to display the first spatial representation of the first participant is based on the first participant joining the communication session such as if representation 1720a in FIG. 17D was displayed in response to the participant associated with the representation joining the communication session. In some embodiments, the first transition sequence described above, is initiated in response to a new participant joining a communication session (e.g., not part of the communication session prior to the joining). In some embodiments, an application associated with the communication session by default will display a spatial representation of a participant, as soon as the application receives an indication that a new participant has joined a communication session. Gradually transitioning in the display of a spatial representation associated with a participant of a communication session in response to a participant joining a communication session minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, the received indication to display the first spatial representation of the first participant is based on a request to modify a position of the first participant relative to one or more virtual elements in the communication session such as if representation 1720a in FIG. 17D was displayed in response to the user of the computer system adjusting a scene associated with the communication session. In some embodiments, when a spatial representation is part of a virtual scene (e.g., the spatial representation is positioned relative to one or more virtual elements), in response to detecting a request to modify a position of the scene (thereby moving the position of the first participant), the spatial representation is transitioned to a placeholder representation (described above). In some embodiments, transitioning the spatial representation to the placeholder representation is executed by the computer system according to the transition sequences described above. In some embodiments, once the computer system determines that position of the scene is no longer being modified, the computer system re-displays the spatial representation using the first transition sequence described above. In some embodiments, the process for modifying a position of the scene shares one or more characteristics with the process for modifying a position of the scene described above with respect to methods 1100 and 1200. Gradually transitioning in the display of a spatial representation associated with a participant of a communication session in response to a request to modify a position of the first participant relative to one or more virtual elements minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, the received indication to display the first spatial representation of the first participant is based on a request to change a representation type associated with the first participant such as changing the representation associated with a participant of a communication session from representation 1704a illustrated in FIG. 17A to representation 1720a illustrated in FIG. 17I. In some embodiments, the spatial representation is displayed by the computer system according to the first transition sequence (described above) in response to changing the representation of the first participant in the communication session from a first type (such as a two-dimensional representation or a text based representation) to a second type that is three-dimensional in nature (e.g., an avatar or virtual object as described above). In some embodiments, the computer system detects input from the user corresponding to a selection of a representation type, and changes the representation type based on the received input. Gradually transitioning in the display of a spatial representation associated with a participant of a communication session in response to a request to change the representation type associated with the first participant minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

In some embodiments, while displaying the first spatial representation of the first participant, the computer system receives an indication to display a second spatial representation of the first participant within the three-dimensional environment such as receiving an indication to display representation 1720a in FIG. 17I while displaying representation 1704a in FIG. 17A. In some embodiments, the first spatial representation is a placeholder representation as described above, while the second representation is an anthropomorphic representation (e.g., a three-dimensional avatar) of the first participant as described above. Additionally or alternatively, and as an example, the first spatial representation is a first anthropomorphic representation of the first participant, while the second spatial representation is a second anthropomorphic representation of the first participant that is different from the first anthropomorphic representation.

In some embodiments, in response to receiving the indication to display the second spatial representation of the first participant in the three-dimensional environment the computer system displays the first spatial representation of the first participant according to a second transition sequence within the three-dimensional environment, wherein the second transition sequence comprises gradually transitioning the displayed first spatial representation of the first participant from being displayed according to the second visual model to being displayed according to the first visual model such as the transition sequence with respect to representation 1704a in FIG. 17A-C. In some embodiments, prior to displaying the second spatial representation, the computer system transitions the first spatial representation from being displayed according to the second visual model to being displayed according to the second visual model so as to appear as if the first spatial representation is gradually fading out from the three-dimensional environment. In some embodiments, the second transition sequence (e.g., the transition from the second visual model to the first visual model) shares one or more characteristics of the second transition sequence described above.

In some embodiments, after the first spatial representation is displayed according to the first visual model, the computer system ceases display of the first spatial representation such as when representation 1704a is no longer displayed in FIG. 17D. In some embodiments, after ceasing display of the first spatial representation, the computer system displays a second spatial representation of the first participant according to a third transition sequence within the three-dimensional environment such as the transition sequence performed with respect to representation 1720a in FIGS. 17D-I, wherein the third transition sequence comprises displaying the second spatial representation of the first participant within the three-dimensional environment according to the first visual model. In some embodiments, the third transition sequence comprises gradually transitioning the displayed second spatial representation of the first participant from the first visual model to the second visual model. In some embodiments, the third transition sequence shares one or more characteristics of the first transition sequence described above. For instance, in accordance with the third transition sequence, the computer system initially displays the second spatial representation according to a low fidelity visual model (described above) and gradually transitions the spatial representation to a high fidelity representation in accordance with the one or more examples described above. Gradually transitioning out the display of a first spatial representation associated with a participant of a communication session and then gradually transitioning in the display of a second spatial representation associated with the participant of the communication session minimizes the likelihood of erroneously portraying the spatial representation to the user of the computer system, such as before all data associated with displaying the spatial representation is available, and avoids abrupt changes to the context of interaction of the user with the three-dimensional environment, thus minimizing the occurrence of erroneous user input and thereby conserving computing resources associated with correcting erroneous input.

It should be understood that the particular order in which the operations in method 1680 have been described is merely exemplary and is not intended to indicate that the described order is the only order in which the operations could be performed. One of ordinary skill in the art would recognize various ways to reorder the operations described herein.

In some embodiments, aspects/operations of methods 800, 900, 1100, 1200, 1400, 1600, and/or 1800 may be interchanged, substituted, and/or added between these methods. For example, the three-dimensional environments of methods 800, 900, 1100, 1200, 1400, 1600 and/or 1800, the virtual objects of methods 800, 900, 1100, 1200, 1400, 1600, and/or 1800, the virtual representations of methods 800, 900, 1100, 1200, 1400, 1600 and/or 1800 the communication sessions of methods 800, 900, 1100, 1200, 1400, 1600 and/or 1800, the attention (e.g., gaze) and attention-based inputs of methods 800, 900, 1100, 1200, 1400, 1600, and/or 1800, the techniques to move (e.g., change spatial arrangement of) virtual objects (e.g., and/or virtual representations) in 800, 900, 1100, 1200, 1400, 1600, and/or 1800, and/or techniques to change (e.g., reduce) the visual prominence of virtual representations in methods 800, 900, 1100, 1200, 1400, 1600, and/or 1600 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-164. (canceled)

165. A method comprising:
at a computer system in communication with one or more input devices and a display generation component:
while a user of the computer system is participating in a communication session with one or more participants, and the user has a current viewpoint relative to a three-dimensional environment of the computer system, obtaining information that a position of a first participant in the communication session will correspond to a first position within the three-dimensional environment of the computer system relative to the current viewpoint of the user; and
in response to obtaining the information:
in accordance with a determination that one or more first criteria are satisfied, including a criterion that is satisfied when the position corresponding to the first participant is outside of a viewport of the computer system, presenting first feedback associated with the first position of the first participant, wherein the first feedback indicates a spatial relationship between the current viewpoint of the user and the first position; and
in accordance with a determination that the one or more first criteria are not satisfied, forgoing presenting of the first feedback.

166. The method of claim 165, wherein presenting the first feedback includes playing audio corresponding to the first participant.

167. The method of claim 166, wherein the audio corresponding to the first participant is generated as if emanating from the first position within the three-dimensional environment.

168. The method of claim 165, further comprising:
while the user of the computer system is participating in the communication session with one or more participants, obtaining second information that a position of a second participant, different from the first participant, in the communication session will correspond to a second position within the three-dimensional environment of the computer system relative to the current viewpoint of the user; and
in response to obtaining the second information, and in accordance with a determination that one or more second criteria are satisfied, including a criterion that is satisfied when the position of the first participant will correspond to the first position and the position of the second participant will correspond to the second position within a threshold amount of time of one another, presenting second feedback, different from the first feedback, associated with the second position of the second participant, more than the threshold amount of time after presenting the first feedback, wherein the second feedback indicates a spatial relationship between the second position and the current viewpoint of the user.

169. The method of claim 165, wherein the first feedback includes audio and visual feedback indicating the spatial relationship between the current viewpoint of the user and the first position relative to the current viewpoint of the user.

170. The method of claim 165, wherein the first feedback includes a simulated glowing effect displayed at a respective portion of a current viewport of the user, wherein a spatial relationship of the respective portion relative to the viewport corresponds to the spatial relationship between the current viewpoint of the user and the first position.

171. The method of claim 165, further comprising:
while the user of the computer system is participating in the communication session and prior to obtaining the information that the position of the first participant will correspond to the first position within the three-dimensional environment, presenting first audio, wherein the first audio is different from the first feedback, and the information is received while the first audio is being presented; and
in response to obtaining the information, and in accordance with the determination that the one or more first criteria are satisfied, modifying one or more characteristics of the first audio.

172. The method of claim 165, wherein presenting the first feedback includes playing first one or more tones, the method further comprising:
while the user of the computer system is participating in the communication session with the one or more participants, and the user has the current viewpoint relative to the three-dimensional environment of the computer system, obtaining second information, different from the information, that a position of a second participant, different from the first participant, in the communication session will correspond to a second position within the three-dimensional environment of the computer system relative to the current viewpoint of the user; and
in response to obtaining the second information:
in accordance with a determination that one or more second criteria are satisfied, including a criterion that is satisfied when a position corresponding to the second participant is outside of the viewport of the computer system, presenting second feedback indicating a spatial relationship between the current viewpoint and the second position, wherein presenting the second feedback includes playing second one or more tones, different from the first one or more tones.

173. The method of claim 172, wherein the first one or more tones includes a first tone, the second one or more tones include a second tone, and the first tone and the second tone are separated by one or more musical intervals.

174. The method of claim 172, further comprising:
while the user of the computer system is participating in the communication session with the one or more participants, and the user has the current viewpoint relative to the three-dimensional environment of the computer system, obtaining third information, different from the information and different from the second information, that a position of a third participant, different from the first participant and different from the second participant, in the communication session will correspond to a third position within the three-dimensional environment of the computer system relative to the current viewpoint of the user; and
in response to obtaining the third information:
in accordance with the determination that the one or more second criteria are satisfied, presenting third feedback indicating a spatial relationship between the current viewpoint and the third position, wherein presenting the third feedback includes playing third one or more tones, different from the first one or more tones and different from the second one or more tones.

175. The method of claim 172, further comprising:
while the user of the computer system is participating in the communication session with the one or more participants:
obtaining third information, different from the information and different from the second information, including an indication of a request to cease inclusion of a representation of the second participant, different from the first participant, in the three-dimensional environment;
in response to obtaining the third information, ceasing inclusion of the representation of the second participant in the three-dimensional environment; and
after the third information is obtained:
obtaining fourth information, different from the information, different from the second information, and different from the third information, that the position of the first participant in the communication session will correspond to a fourth position within the three-dimensional environment of the computer system relative to the current viewpoint of the user; and
in response to obtaining the fourth information, and in accordance with a determination that one or more second criteria, different from the one or more first criteria are satisfied, presenting fourth feedback, including playing the one or more first tones indicating a spatial relationship between the current viewpoint of the user and the fourth position.

176. The method of claim 175, the method further comprising:
while the user of the computer system is participating in the communication session with the one or more participants, while the user has the current viewpoint relative to the three-dimensional environment of the computer system, and after presenting the second feedback obtaining fourth information that a location of a fourth participant will correspond to a fourth position within the three-dimensional environment relative to the current viewpoint of the user; in response to obtaining the fourth information:
in accordance with a determination that one or more third criteria are satisfied, including a criterion that is satisfied when a period of time since presenting the second feedback has elapsed that is less than a threshold period of time the computer system presents fourth feedback, different from the first feedback, including playing fourth one or more tones, different from the first one or more tones; and
in accordance with a determination that the one or more third criteria are not satisfied, the computer system presents fifth feedback, different from the first feedback and the fourth feedback, including playing the first one or more tones.

177. The method of claim 165, further comprising:
while the user and the first participant are participating in the communication session, obtaining second information, different from the information, including an indication of a request to cease inclusion of a representation of the first participant in the three-dimensional environment; and
in response to obtaining the second information, presenting second feedback, different from the first feedback, including playing first audio associated with the ceasing of the inclusion of the representation of the first participant in the three-dimensional environment.

178. The method of claim 177, wherein presenting the first feedback includes playing second respective audio, wherein the second respective audio is generated as if the second respective audio is emanating from the first position, and the first audio is not generated as if the first audio is emanating from a respective position within the three-dimensional environment associated with the first participant.

179. The method of claim 165, further comprising:
while the user of the computer system is participating in a second communication session, different from the communication session, with the one or more participants, obtaining second information that the position of the first participant in the second communication session will correspond to a second position within the three-dimensional environment of the computer system relative to the current viewpoint of the user; and
in response to obtaining the second information:
in accordance with a determination that one or more second criteria are satisfied, including a criterion that is satisfied when the position corresponding to the first participant corresponds to first one or more positions of the three-dimensional environment, presenting second feedback associated with the second position of the first participant, wherein the second feedback indicates a spatial relationship between the current viewpoint of the user and the first one or more positions; and
in accordance with a determination that the one or more second criteria are not satisfied, forgoing presenting of the second feedback.

180. The method of claim 179, wherein presenting the second feedback includes playing audio corresponding to the first one or more positions, the method further comprising:
while the user and one or more participants are participating in the communication session, obtaining third information, different from the second information, including an indication of a request to cease inclusion of a representation of a second participant, different than the first participant, in the three-dimensional environment;
in response to obtaining the second information:
in accordance with a determination that one or more third criteria, different from the one or more second criteria are satisfied, presenting third feedback, different from the first feedback and the second feedback, including playing first audio associated with the ceasing of the inclusion of the representation of the second participant in the three-dimensional environment. in accordance with a determination that the one or more third criteria are not satisfied, presenting fourth feedback, different from the first feedback, including playing second audio associated with the ceasing of the inclusion of the second participant in the three-dimensional environment.

181. The method of claim 180, wherein the one or more third criteria include a criterion that is satisfied when a period of time greater than a threshold of time has passed since respective audio associated with ceasing of inclusion of a respective representation of a respective participant of the one or more participants in the three-dimensional environment was played, the method further comprising:
in accordance with a determination that the one or more third criteria are not satisfied, forgoing presenting of the third feedback.

182. The method of claim 179, further comprising:
while the user of the computer system is participating in the second communication session, different from the communication session, with the one or more participants:
obtaining third information that a position of a second participant in the second communication session will correspond to a third position within the three-dimensional environment of the computer system relative to the current viewpoint of the user; in response to obtaining the third information and in accordance with a determination that the one or more second criteria are satisfied, presenting third feedback associated with the third position of the second participant, wherein the third feedback indicates a spatial relationship between the current viewpoint of the user and the first one or more positions;
obtaining fourth information that a location of a third participant in the second communication session will correspond to a fourth position within the three-dimensional environment of the computer system relative to the current viewpoint of the user;
in response to obtaining the fourth information and in accordance with a determination that the one or more second criteria are satisfied, presenting fourth feedback associated with the fourth position of the third participant, wherein the fourth feedback indicates a spatial relationship between the current viewpoint of the user and the first one or more positions,
obtaining fifth information, including an indication of a request to cease inclusion of a representation of the second participant in the three-dimensional environment;
in response to obtaining the fifth information, ceasing inclusion of the representation of the second participant in the three-dimensional environment; and
after the fifth information is obtained, obtaining sixth information, that the position of the second participant will correspond to a fifth position within the three-dimensional environment of the computer system relative to the current viewpoint of the user; and
in response to obtaining the sixth information, and in accordance with a determination that the one or more second criteria are satisfied, presenting the third feedback.

183. The method of claim 179, the method further comprising:
after obtaining the second information, obtaining third information, different from the second information, corresponding to a request to cease inclusion of the first participant in the three-dimensional environment;
in response to obtaining the third information:
in accordance with a determination that one or more third criteria are satisfied, including a criterion that is satisfied when a threshold amount of time of has elapsed after ceasing the inclusion of the first participant in the three-dimensional environment, presenting third feedback, wherein the third feedback indicates the ceasing of the inclusion of the first participant in the three-dimensional environment; and
in accordance with the determination that the one or more third criteria are not satisfied, forgoing presenting of the third feedback.

184. The method of claim 179, wherein the second feedback includes playing first audio having one or more characteristics configured to simulate an audio source that is providing the first audio located at a position corresponding to the first one or more positions of the three-dimensional environment.

185. The method of claim 179, further comprising:
while the user of the computer system is participating in the communication session with the one or more participants, obtaining third information, different from the second information, that a position of a second participant, different from the first participant, in the communication session will correspond to a third position within the three-dimensional environment of the computer system relative to the current viewpoint of the user; and
in response to obtaining the third information:
in accordance with a determination that the one or more second criteria are satisfied, including a criterion that is satisfied when a location corresponding to the first participant and a location corresponding to the second participant are included in second one or more positions of the three-dimensional environment, presenting third feedback, wherein presenting the second feedback includes playing first audio having one or more characteristics configured to simulate an audio source that is providing the first audio located at a position corresponding to the second one or more positions of the three-dimensional environment.

186. The method of claim 179, wherein the first one or more positions are associated with the current viewpoint of the user relative to the three-dimensional environment, the method further comprising:
in response to obtaining the second information and in accordance with the determination that the one or more second criteria are satisfied:
in accordance with a determination that the current viewpoint is a first viewpoint relative to the three-dimensional environment, presenting the first feedback wherein the first one or more positions correspond to a first location relative to the three-dimensional environment; and
in accordance with a determination that the current viewpoint is a second viewpoint, different from the first viewpoint, relative to the three-dimensional environment, presenting the first feedback presenting the first feedback, wherein the first one or more positions correspond to a second location relative to the three-dimensional environment.

187. The method of claim 165, wherein the one or more first criteria are not satisfied when a location corresponding to the first participant is inside of the viewport of the computer system.

188. The method of claim 165, further comprising:
while the user of the computer system is participating in a second communication session, different from the communication session, with the one or more participants, obtaining second information that the position of the first participant in the second communication session will correspond to a second position within the three-dimensional environment of the computer system relative to the current viewpoint of the user; and
in response to obtaining the second information, presenting second feedback associated with the second position of the first participant, wherein the second feedback indicates a spatial relationship between the current viewpoint of the user and the second position, and wherein the presenting of the second feedback, different from the first feedback, is performed independently of the spatial relationship between the current viewpoint of the user and the second position.

189. The method of claim 165, further comprising:
while the user and the first participant are participating in the communication session, displaying a visual representation of the first participant with a first level of visual prominence at a respective position within the three-dimensional environment, wherein the visual representation of the first participant has a first spatial arrangement relative to the current viewpoint of the user;
while displaying the visual representation of the first participant with the first level of visual prominence and while the visual representation of the first participant has the first spatial arrangement relative to the current viewpoint of the user, detecting, via the one or more input devices, an indication of a request to share respective first content in the communication session; and
in response to detecting the indication of the request, and while maintaining the current viewpoint of the user:
displaying, via the display generation component, the respective first content at an initial position within the three-dimensional environment, and with a first spatial relationship relative to the visual representation of the first participant displayed with the first level of visual prominence;
reducing a visual prominence of the visual representation of the first participant to a second level of visual prominence, different from the first level of visual prominence;
presenting second feedback, different from the first feedback, indicating the reduction of the visual prominence of the visual representation of the first participant from the first level of visual prominence to the second level of visual prominence, and
after reducing the visual prominence of the visual representation of the first participant to the second level of visual prominence:
displaying, via the display generation component, the visual representation of the first participant with a third level of visual prominence, greater than the second level of visual prominence, and with a second spatial relationship relative to the current viewpoint of the user, different from the first spatial relationship; and
presenting third feedback, different from the second feedback, indicating the second spatial relationship between the position corresponding to the first participant and the current viewpoint of the user.

190. The method of claim 189, further comprising:
while displaying the respective first content at the initial position and while displaying the visual representation of the first participant with the third level of visual prominence and having the second spatial relationship relative to the current viewpoint of the user, detecting, via the one or more input devices, an indication of a request to replace the respective first content with respective second content, different from the respective first content; and
in response to detecting the indication of the request to replace the respective first content:
replacing the respective first content with the respective second content;
ceasing display of the visual representation of the first participant; and
after ceasing display of the visual representation of the first participant:
displaying, via the display generation component, the visual representation of the first participant with an updated spatial relationship relative to the current viewpoint of the user; and
presenting fourth feedback, different from the second feedback, indicating the updated spatial relationship between the first participant and the current viewpoint of the user.

191. The method of claim 165, wherein the information that the position of the first participant in the communication session will correspond to the first position within the three-dimensional environment of the computer system is associated with a request to update a spatial arrangement of elements of the communication session relative to the current viewpoint of the user.

192. The method of claim 165, wherein the information that the position of the first participant in the communication session will correspond to the first position within the three-dimensional environment of the computer system is associated with the first participant joining the communication session.

193. The method of claim 165, wherein the information that the position of the first participant in the communication session will correspond to the first position within the three-dimensional environment of the computer system is associated with input for moving the first participant within a respective three-dimensional environment of the first participant.

194. The method of claim 165, wherein the information that the position of the first participant in the communication session will correspond to the first position within the three-dimensional environment of the computer system is associated with a request to change a visual representation of the first participant from a first type of visual representation to a second type of visual representation in the communication session.

195. The method of claim 165, wherein the information that the position of the first participant in the communication session will correspond to the first position within the three-dimensional environment of the computer system is associated with a request to change a spatial arrangement of elements of the communication session including one or more respective visual representations of the one or more participants of the communication session relative to each other.

196. The method of claim 165, further comprising:
while the user is participating in the communication session, in response to obtaining the information and in accordance with the determination that the one or more first criteria are satisfied and prior to presenting the first feedback, presenting first audio that is non-localized to the first position associated with the first participant, wherein the first audio is different from the first feedback.

197. The method of claim 196, the method further comprising:
while a representation corresponding to the first participant is included in the three-dimensional environment, obtaining second information, different from the information, including a request to cease inclusion of representations of participants in the communication session; and
in response to obtaining the second information, presenting second audio, different from the first audio, that is non-localized to respective one or more positions associated with respective participants, including the first participant.

198. A computer system in communication with a display generation component and one or more input devices, the computer system comprising:
one or more processors;
memory, and
one or more programs, wherein the one or more programs are stored in the memory and configured to be executed by the one or more processors, the one or more programs including instructions for:
while a user of the computer system is participating in a communication session with one or more participants, and the user has a current viewpoint relative to a three-dimensional environment of the computer system, obtaining information that a position of a first participant in the communication session will correspond to a first position within the three-dimensional environment of the computer system relative to the current viewpoint of the user; and
in response to obtaining the information:
in accordance with a determination that one or more first criteria are satisfied, including a criterion that is satisfied when the position corresponding to the first participant is outside of a viewport of the computer system, presenting first feedback associated with the first position of the first participant, wherein the first feedback indicates a spatial relationship between the current viewpoint of the user and the first position; and
in accordance with a determination that the one or more first criteria are not satisfied, forgoing presenting of the first feedback.

199. A non-transitory computer readable storage medium storing one or more programs, the one or more programs comprising instructions, which when executed by one or more processors of a computer system in communication with a display generation component and one or more input devices, cause the computer system to perform a method comprising:
while a user of the computer system is participating in a communication session with one or more participants, and the user has a current viewpoint relative to a three-dimensional environment of the computer system, obtaining information that a position of a first participant in the communication session will correspond to a first position within the three-dimensional environment of the computer system relative to the current viewpoint of the user; and
in response to obtaining the information:
in accordance with a determination that one or more first criteria are satisfied, including a criterion that is satisfied when the position corresponding to the first participant is outside of a viewport of the computer system, presenting first feedback associated with the first position of the first participant, wherein the first feedback indicates a spatial relationship between the current viewpoint of the user and the first position; and
in accordance with a determination that the one or more first criteria are not satisfied, forgoing presenting of the first feedback.

200-227. (canceled)
